(19) United States
(12) Patent Application Publication
(10) Pub. No.: US 2013/0029030 A1
(43) Pub. Date: Jan. 31, 2013

(54) METHOD FOR PROMOTION OF HEMOSTASIS AND/OR WOUND HEALING

(71) Applicant: Kristian Larsen, Vaerlose (DK)

(72) Inventor: Kristian Larsen, Vaerlose (DK)

(21) Appl. No.: 13/634,096

(22) PCT Filed: Mar. 14, 2011
(86) PCT No.: PCT/DK11/50082

§ 371 Date: Oct. 19, 2012

Related U.S. Application Data
(60) Provisional application No. 61/441,440, filed on Feb. 10, 2011.
(60) Provisional application No. 61/313,849, filed on Mar. 15, 2010.

(30) Foreign Application Priority Data
Mar. 15, 2010 (DK) PA 2010 70101
Feb. 10, 2011 (DK) PA 2011 70076

(51) Int. Cl. B05D 1/02

(52) U.S. Cl. 427/2.31

(57) ABSTRACT

The present invention relates to a matrix material comprising a pharmaceutical composition such as a matrix material with a pharmaceutical composition applied by ultrasonic spray technology on the surface. In one embodiment the pharmaceutical composition comprises thromb in. The invention further describes a method for making the matrix material which has a pharmaceutical composition coated onto the surface of the matrix material using ultrasonic spray technology. In one specific embodiment the invention also relates to the use of said matrix material for promotion of hemostasis and/or wound healing. The invention also relates to a kit-of-parts comprising a matrix with a pharmaceutical composition and a container with a peelable lid.

### FIELD OF INVENTION

The present invention relates to a device for promoting hemostasis and/or wound healing as well as to methods for making or using such a device. The device comprises one or more bioactive compounds for promoting hemostasis and/or wound healing. Said bioactive compounds are preferably applied to the surface of the device by ultrasonic spay technology. The surface of the device can be the surface of a matrix of the device, such as the surface of a sponge. The invention further relates to a kit of parts comprising said device for promotion of hemostasis and/or wound healing and a container for storage and/or preparation of said device.

### BACKGROUND OF INVENTION

The present invention relates to an improved device for promoting hemostasis and/or wound healing, and an improved method for making said device.

WO 2003/004072 discloses a method for coating a medical appliance, such as a stent, with a bubblejet printing head. The coating may comprise pharmaceutically active compounds and may e.g. be in the form of a polymer with a suspended drug or a non-thrombogenic agent.

Xu et al (Biomaterials Vol. 27, 2006, p. 3580-3588) discloses use of alternate inkjet printing of NT2 cells and fibrin gels (formed by the alternate printing of fibrinogen and thrombin), to create 3D cellular structures consisting of layers of neural cells.

U.S. Pat. No. 6,361,551 and U.S. Pat. No. 6,454,787 both relate to methods for depositing thrombin in solution or powder onto a hemostatic device, such as a sponge comprising collagen. The method of depositing thrombin comprises spraying thrombin in powder form onto the hemostatic device, or coating the device with a thrombin solution and subsequently drying the device of the invention by lyophilization or by conventional means.

U.S. Pat. No. 4,752,466 is directed to a thrombin aerosol. Thrombin is delivered in dry powdered form from a valve-actuated pressurized propellant-containing aerosol container. The thrombin has been lyophilized from an aqueous solution also comprising a thrombin-compatible synthetic polymer.

U.S. Pat. No. 6,472,162 and U.S. Pat. No. 7,056,722 both concern a thrombin-solution without particles. The particles have been removed by filtration so as to allow using the thrombin-solution as a spray.

U.S. Pat. No. 6,461,325 relates to a device for delivering fibrin and forming fibrin on a surface. The device delivers volumetric quantities of a first and a second biochemically reactive fluid comprising a spray unit for separately atomizing the first and second biochemically reactive fluids into an aerosol. The first or second biochemically reactive fluids may comprise thrombin.

U.S. Pat. No. 6,113,948 relates to soluble microparticles comprising thrombin or fibrinogen in free-flowing form. The microparticles can be mixed to give a dry powder to be used as a fibrin sealant that is activated only at a wound site. The microaprticles are produced by spray-drying.

US 2003/0175419 relates to methods for preparing biomimetic scaffolds by using at least two bio-ink solutions. The bio-ink solutions can be deposited individually or simultaneously. One bio-ink, which is structural, can comprise thrombin, and inkjet technology can be employed to deposit the bio-inks of the biomimetic scaffold. Another form of a bio-ink can comprise gelatin.

U.S. Pat. No. 6,416,739 discloses microcapsules comprising thrombin for therapeutic use.

U.S. Pat. No. 6,649,162 is related to a hemostatic sponge based on collagen and thrombin and a method for producing such a sponge as well as a wound coverage containing said sponge. Thrombin is homogenously distributed in the sponge.

WO 2009/109963 discloses a medical device based on collagen and thrombin as well as a method for producing such a device using a “roller apparatus” application procedure.

The prior art has not adressed sufficiently the issue of providing an improved matrix material, such as a sponge, comprising a pharmaceutical composition comprising one or more agents or bioactive agents, such as thrombin; wherein said composition is initially in fluid or liquid form and applied onto the surface of said matrix material by ultrasonic spay technology, thus in one embodiment obtaining an essentially uniform distribution of said fluid or liquid composition.

### SUMMARY OF THE INVENTION

In one aspect, the present invention relates to a method for coating of a matrix or the surface of a matrix with a pharmaceutical composition comprising one or more bioactive agents, said method comprising use of ultrasonic spray technology. In one embodiment, the method comprises the steps of a) providing a matrix material, and b) applying a pharmaceutical composition onto the surface of said matrix material using ultrasonic spray technology, and—optionally—c) drying the coated matrix.

In one aspect, the present invention relates to a device coated using the method described above.

In one aspect, the present invention relates to the use of a device manufactured according to the method described above to promote wound healing and/or hemostasis in an individual in need thereof.

In one aspect, the present invention relates to a kit of parts comprising a device coated using the method described above and further comprising at least one additional component. In one embodiment, the kit of parts comprises a container e.g. for sterile storage and/or preparation of said device. The container can be used to add liquid to the matrix material prior to use.

In one aspect the present invention relates to a matrix material comprising a surface and a plurality of open and interconnected cells, wherein the surface of said matrix comprises a pharmaceutical composition comprising one or more bioactive agents, such as thrombin, applied onto said surface of the matrix material using ultrasonic spray technology.

The invention further relates to a matrix material comprising a pharmaceutical composition, such as thrombin, which is applied onto the surface of said matrix material using ultrasonic spray technology.

The present invention further relates to a device comprising the matrix material and a pharmaceutical composition as described above.

The present invention also relates to a kit of parts comprising the device described above and at least one additional component. In one embodiment the kit of parts comprises a container e.g. for sterile storage and/or preparation of said device. The container can be used to add liquid to the matrix material prior to use.

In another aspect the present invention relates to a method for making the device described above comprising the steps of 1) providing a matrix material and 2) applying a pharmaceutical composition in fluid or liquid form comprising one or more bioactive agents onto the surface of said matrix material using ultra sonic spray technology.

In yet another aspect the present invention relates to the use of the device or kit of parts described above to promote wound healing and/or hemostasis in an individual in need thereof.

The present invention is directed in another aspect to a method for manufacturing a matrix material comprising a pharmaceutical composition comprising one or more agents or bioactive agents deposited on an accessible, external surface of said matrix material, said method comprising the steps of
i) providing a matrix material,
ii) providing an ultrasonic spray technology device comprising
   a. one ultrasonic spray nozzle, and one reservoir comprising one pharmaceutical composition comprising the one or more agents or bioactive agents in solubilised form, or in the form of a suspension, wherein the pharmaceutical composition is in fluid or liquid form, or
   b. one ultrasonic spray nozzle, and one or more reservoirs each comprising one or more pharmaceutical compositions comprising the one or more agents or bioactive agents in solubilised form, or in the form of a suspension, wherein the pharmaceutical composition is in fluid or liquid form, or
   c. one or more ultrasonic spray nozzles, and one reservoir comprising one or more pharmaceutical compositions comprising the one or more agents or bioactive agents in solubilised form, or in the form of a suspension, wherein the pharmaceutical composition is in fluid or liquid form, or
   d. one or more ultrasonic spray nozzles, and one or more reservoirs each comprising one or more pharmaceutical compositions comprising the one or more agents or bioactive agents in solubilised form, or in the form of a suspension, wherein the pharmaceutical composition is in fluid or liquid form,
   said reservoir(s) optionally being connected to a degassing device and operably connected with said one or more ultrasonic spray nozzles so that the fluid or liquid composition comprising the one or more agents or bioactive agents can be diverted from said reservoir to said one or more ultrasonic spray nozzles,
iii) actuating the one or more ultrasonic spray nozzles and diverting from each nozzle one or more droplets of the fluid or liquid composition comprising the one or more agents or bioactive agents to a predetermined location of the accessible, external surface of said matrix material,
   wherein, preferably, each droplet of the fluid or liquid composition contains a volume of liquid of less than about 100 nanoliters, such as less than about 80 nanoliters, for example less than about 60 nanoliters, such as less than about 40 nanoliters, for example less than about 20 nanoliters, such as less than about 10 nanoliters, for example less than about 1 nanoliter, such as less than about 0.8 nanoliters, for example less than about 0.6 nanoliters, such as less than about 0.4 nanoliters, for example less than about 0.2 nanoliters, such as less than about 0.1 nanoliters, for example less than about 0.08 nanoliters, such as less than about 0.06 nanoliters, for example less than about 0.04 nanoliters, such as less than about 0.02 nanoliters, for example less than about 0.015 nanoliters, such as less than about 0.010 nanoliters, for example less than about 0.005 nanoliters, such as less than about 0.004 nanoliters, for example less than about 0.002 nanoliters, such as less than about 0.001 nanoliters,
   wherein, preferably, the distance from each nozzle head to the predetermined location to be impacted, at the time of actuating the nozzle head and initialising the diversion of said droplet(s) of liquid composition comprising the one or more solubilised, bioactive agents from the nozzle head to a given, predetermined location, is essentially similar for each droplet of the fluid or liquid composition and is prefereably less than about 4 millimeters, such as less than about 3.5 millimeters, for example less than about 3 millimeters, such as less than about 2.5 millimeters, for example less than about 2 millimeters, such as less than about 1.5 millimeters, for example less than about 1.2 millimeters, such as less than about 1.0 millimeters, for example less than about 0.8 millimeters, such as less than about 0.6 millimeters, for example less than about 0.4 millimeters, such as less than about 0.2 millimeters, for example less than about 0.1 millimeters,
   wherein, the liquid portion of each droplet of the composition comprising the one or more solubilised agents or bioactive agents in one embodiment evaporates essentially on impacting the accessible, external surface of the matrix material, wherein said evaporation is determined at least by the kinetic energy of the liquid of the droplet, including the temperature of the liquid of the droplet, the temperature of the matrix material and the temperature of the environment in which the impacting of the droplet and the matrix material takes place
   wherein the method optionally comprises a drying step,
   wherein, preferably, the accessible and external surface of said matrix material has essentially the same physico-chemical properties before being impacted and after being impacted with the droplets of the composition comprising the one or more solubilised agents or bioactive agents, said physico-chemical properties comprising size, ability to absorb moisture, compressability, friction and dynamic viscosity.

The nozzle assembly may comprise two nozzles and the ultrasonic spray method may comprise two sequential rounds of application of a composition onto a matrix/sponge by ultrasonic spray technology.

The one or more bioactive agents can be thrombin or thrombin in combination with fibrinogen, or thrombin and fibrinogen in combination with Factor XIII, or thrombin and fibrinogen and Factor XIII in combination with tranexamic acid.

The one or more agents or bioactive agents may be comprised in the same fluid or liquid composition contained in the same reservoir and expelled from the same nozzle assembly comprising one or more ultrasonic spray nozzles, or the one or more bioactive agents may be comprised in separate fluid or liquid compositions contained in separate reservoirs and each different agent can be expelled from separate nozzle assemblies each comprising one or more ultrasonic spray nozzles.

There is also provided a spraying device comprising a) one or more nozzle assemblies each comprising one or more ultrasonic spray nozzles, and b) one or more reservoirs each comprising a fluid or liquid composition comprising the one or more bioactive agents in solubilised form, such as the bioactive agents and combinations thereof cited herein immediately above, wherein said reservoir is connected to a degassing device and operably connected with said one or more nozzle assemblies so that the liquid composition comprising the one or more solubilised, bioactive agents can be diverted from said reservoir to said one or more nozzle assemblies and released from said nozzle assemblies as droplets of a predetermined volume upon actuation of the ultrasonic spray nozzles of said nozzle assemblies.

In one embodiment, two or more fluid or liquid compositions each comprising one or more agents or bioactive agents may be applied at the same or different positions on the surface of said matrix material.

The two or more pharmaceutical compositions initially in fluid or liquid form may each comprise one or more bioactive agents which may be thrombin or thrombin in combination with fibrinogen, or thrombin and fibrinogen in combination with Factor XIII, or thrombin and fibrinogen and Factor XIII in combination with tranexamic acid.

It is understood, that application onto a surface of a matrix material by ultrasonic spray technology may comprise application on the surface of any side of the matrix material. Thus, all or some of the planes of the matrix material may be coated. In one embodiment, the matrix material is a cube comprising six (6) planes, in which one or more planes are coated, such as 1 plane, for example 2 planes, such as 3 planes, for example 4 planes, such as 5 planes, for example 6 planes.

In one embodiment, the one or more planes or surfaces to be coated has a surface area in the range of 5 cm² to 150 cm², such as from 5 cm² to 10 cm², for example from 10 cm² to 15 cm², such as from 15 cm² to 20 cm², for example from 20 cm² to 25 cm² such as from 25 cm² to 30 cm², for example from 30 cm² to 35 cm² such as from 35 cm² to 40 cm², for example from 40 cm² to 45 cm² such as from 45 cm² to 50 cm², for example from 50 cm² to 55 cm² such as from 55 cm² to 60 cm², for example from 60 cm² to 65 cm² such as from 65 cm² to 70 cm², for example from 70 cm² to 75 cm² such as from 75 cm² to 80 cm², for example from 80 cm² to 85 cm² such as from 85 cm² to 90 cm², for example from 90 cm² to 95 cm² such as from 95 cm² to 100 cm², for example from 100 cm² to 105 cm², such as from 105 cm² to 110 cm², for example from 110 cm² to 115 cm², such as from 115 cm² to 120 cm², for example from 120 cm² to 125 cm², such as from 125 cm² to 130 cm², for example from 130 cm² to 135 cm², such as from 135 cm² to 140 cm², for example from 140 cm² to 145 cm², such as from 145 cm² to 150 cm².

In a preferred embodiment, the one or more planes or surfaces to be coated has a surface area of 7 cm², 50 cm², or 100 cm².

In a further aspect there is provided a composition comprising either thrombin, or thrombin in combination with fibrinogen, or thrombin and fibrinogen in combination with Factor XIII, or thrombin and fibrinogen and Factor XIII in combination with tranexamic acid, wherein said composition further comprises a viscosity modulating agent and optionally further a surfactant, wherein said composition preferably has a dynamic viscosity (measured in centipoise, cps) of at least 4 cps, such as at least 6 cps, for example at least 8 cps, such as at least 10 cps, for example at least 12 cps, and preferably less than 100 cps, such as less than 80 cps, for example less than 60 cps, for example less than 40 cps, such as less than 20 cps, for example less than 15 cps.

In a further embodiment there is provided a composition comprising either thrombin, or thrombin in combination with fibrinogen, or thrombin and fibrinogen in combination with Factor XIII, or thrombin and fibrinogen and Factor XIII in combination with tranexamic acid, wherein said composition preferably further comprises a viscosity modulating agent and optionally further a surfactant, wherein said composition preferably has a surface tension of between 0.020 to 0.050 N/m; for example 0.020-0.022 N/m, such as 0.022-0.024 N/m, for example 0.024-0.026 N/m, such as 0.026-0.028 N/m, for example 0.028-0.030 N/m, such as 0.030-0.032 N/m, for example 0.032-0.034 N/m, such as 0.034-0.036 N/m, for example 0.036-0.038 N/m, such as 0.038-0.040 N/m, for example 0.040-0.042 N/m, such as 0.042-0.044 N/m, for example 0.044-0.046 N/m, such as 0.046-0.048 N/m, for example 0.048-0.050 N/m.

In another aspect the present invention relates to a matrix material comprising a surface and a plurality of open and interconnected cells, wherein at least part of the surface of said matrix is coated with thrombin either wholly or in discrete locations thereof by ultrasonic spray technology.

In one embodiment the pharmaceutical composition on the matrix is made by application of thrombin in the range from 0.5 IU/cm² to 50 IU/cm², such as from 0.5 IU/cm² to 1 IU/cm², for example from 1 IU/cm² to 2 IU/cm², such as from 2 IU/cm² to 3 IU/cm², for example from 3 IU/cm² to 4 IU/cm², such as from 4 IU/cm² to 5 IU/cm², for example from 5 IU/cm² to 6 IU/cm², such as from 6 IU/cm² to 7 IU/cm², for example from 7 IU/cm² to 8 IU/cm², such as from 8 IU/cm² to 9 IU/cm², for example from 9 IU/cm² to 10 IU/cm², such as from 10 IU/cm² to 11 IU/cm², for example from 11 IU/cm² to 12 IU/cm², such as from 12 IU/cm² to 13 IU/cm², for example from 13 IU/cm² to 14 IU/cm², such as from 14 IU/cm² to 15 IU/cm², for example from 15 IU/cm² to 16 IU/cm², such as from 16 IU/cm² to 17 IU/cm², for example from 17 IU/cm² to 18 IU/cm², such as from 18 IU/cm² to 19 IU/cm², for example from 19 IU/cm² to 20 IU/cm², such as from 20 IU/cm² to 21 IU/cm², for example from 21 IU/cm² to 22 IU/cm², such as from 22 IU/cm² to 23 IU/cm², for example from 23 IU/cm² to 24 IU/cm², such as from 24 IU/cm² to 25 IU/cm², for example from 25 IU/cm² to 26 IU/cm², such as from 26 IU/cm² to 27 IU/cm², for example from 27 IU/cm² to 28 IU/cm², such as from 28 IU/cm² to 30 IU/cm², for example from 30 IU/cm² to 32 IU/cm², such as from 32 IU/cm² to 34 IU/cm², for example from 34 IU/cm² to 36 IU/cm², such as from 36 IU/cm² to 38 IU/cm², for example from 38 IU/cm² to 40 IU/cm², such as from 40 IU/cm² to 42 IU/cm², for example from 42 IU/cm² to 44 IU/cm², such as from 44 IU/cm² to 46 IU/cm², for example from 46 IU/cm² to 48 IU/cm², such as from 48 IU/cm² to 50 IU/cm².

In one preferred embodiment the amount of thrombin applied onto the matrix by ultrasonic spray technology is in the range from 0.5 IU/cm² to 50 IU/cm², such as 1 IU/cm², for example 2 IU/cm², such as 3 IU/cm², for example 4 IU/cm², such as 5 IU/cm², for example 6 IU/cm², such as 7 IU/cm², for example 8 IU/cm², such as 9 IU/cm², for example 10 IU/cm², such as 12 IU/cm², for example 14 IU/cm², such as 16 IU/cm², for example 18 IU/cm², such as 20 IU/cm², for example 22 IU/cm², such as 24 IU/cm², for example 26 IU/cm², such as 28 IU/cm², for example 30 IU/cm², such as 32 IU/cm², for example 34 IU/cm², such as 36 IU/cm², for example 38 IU/cm², such as 40 IU/cm², for example 42 IU/cm², such as 44 IU/cm², for example 46 IU/cm², such as 48 IU/cm², for example 50 IU/cm².

A surprising hemostatic effect has been demonstrated for a matrix coated with a relatively low dose of thrombin by ultrasonic spray technology for use in one or more dry applications.

Storage of the matrix material in the container according to the present invention provides a sterile environment, and preparation of the matrix in the container may include the addition to the container of a suitable amount of any pharmaceutically acceptable liquid to moisten the matrix adequately.

Said container provides a means for easier addition of an appropiate and predetermined amount of liquid to the matrix, and it follows that the matrix will not be drained with excessive amounts of liquid to reduce the potential disadvantage of detachment of the pharmaceutical composition from the matrix into the excess liquid, and furthermore the moistened matrix material is easier to handle and apply to a wound or site of bleeding when not being excessively moistened. The container is very stable and hence simplifies storage of prepared product on uneven surfaces.

Essential procedural steps to be carried out when using the coated matrix comprise:
keeping the coated matrix sterile until immediately prior to use,
opening the container containing the coated matrix,
optionally applying moisture to the matrix, said moisture being preferably sterile and preferably salinated and preferably pH stabilized to physiological levels,
optionally kneading the moisturized coated matrix e.g. to remove air bubbles
placing the wetted or unwettet coated matrix directly over or on the source of the bleeding, and
applying adjunct manual compression until hemostasis is achieved.

The ultrasonic spray technology according to the present invention has several advantages e.g. compared to printing technology. First, use of printing technology for application of e.g. a thrombin solution onto a sponge often results in clogging of the printing device, i.e. clogging of the print nozzles. Clogging is not observed when a thrombin solution is applied onto a matrix such as a sponge using ultrasonic spray technology. Another obstacle with printing a solution containing thrombin is that thrombin show displays low stability in the solution used for printing. Ultrasonic spray technology allows flexibility regarding selection of the composition of the thrombin solution that is applied onto the matrix. Accordingly, a solution wherein thrombin is stable can be selected for application onto a sponge or another matrix when ultrasonic spray technology is used for coating. In contrast to a solution used for printing, an ultrasonic spray solution does not necessarily contain one or more excipients. Another advantage of the ultrasonic spray technology is that the device for ultrasonic spaying is easy to maintain and clean.

### DEFINITIONS

IU: In pharmacology, the International Unit or IU is a unit of measurement for the amount of a substance, based on measured biological activity or effect. The precise definition of one IU differs from substance to substance and is established by international agreement for each substance. There is no equivalence among different substances; for instance, one IU of vitamin E does not contain the same number of milligrams as one IU of vitamin A. To define an IU of a substance, the Committee on Biological Standardization of the World Health Organization provides a reference preparation of the substance, arbitrarily sets the number of IUs contained in that preparation, and specifies a biological procedure to compare other preparations of that substance to the reference preparation. The goal in setting the standard is that different preparations with the same biological effect will contain the same number of IUs.

Human thrombin activity is expressed in international units (IU) obtained by comparison towards the current WHO International Standard, using fibrinogen as substrate. The current WHO International Standard is named WHO 2nd International Standard for Thrombin 01/580 (In US: US FDA/CBER Thrombin Standard Lot K), and contains 110 IU by definition.

A degassing device is any device or structure used for alleviation of gaseous build-up in a liquid comprised in a reservoir.

“Hemostasis” is a term that refer to the physiologic process whereby bleeding is halted. It consists of multiple steps including 1) vasoconstriction to minimize vessel lumen diameter and slow bleeding, 2) platelet aggregation, 3) coagulation and 4) fibrinolysis whereby the blood clot is degraded.

Hemostatic agents are used herein interchangeably with the terms thrombogenic, thrombotic and pro-coagulant agents. Hemostatic agents are agents that induce blood clotting or hemostasis.

The term “blood clotting cascade” or “blood coagulation cascade” is part of secondary hemostasis and refers to the multi-step process whereby blood and vessel components react to stimuli by the enzymatic activation of coagulation factors sequentially, ultimately resulting in the formation of a solid blood clot comprising fibrin gel and platelets.

“Vasoconstriction” is a narrowing of the blood vessels resulting from contracting of the muscular wall of the vessels. When blood vessels constrict, the flow of blood is restricted or slowed. Factors causing vasoconstriction are called vasoconstrictor, also vasopressors or simply pressors. Vasoconstriction is mostly the result of increased intracellular concentration of calcium (Ca²⁺). However, specific mechanisms for generating an increased intracellular concentration of calcium depend on the vasoconstrictor. In any case, this calcium results in contraction of smooth muscle resulting in a constriction of the vessel.

“Thrombosis” refers to thrombus formation, and a “thrombus” is a blood clot i.e. the final step in the blood coagulation cascade of hemostasis. A thrombus is physiologic in cases of injury, but pathologic in case of thrombosis thus occurring in an intact blood vessel.

An “embolism” occurs when an object (the embolus, plural emboli) migrates from one part of the body (through circulation) and cause(s) a blockage (occlusion) of a blood vessel in another part of the body.

An “agent” is essesentially any substance, drug, compound, composition of matter which causes a reaction, typically a physical or a chemical reaction.

A “bioactive agent” is any agent, drug, compound, composition of matter or mixture which provides some pharmacologic, often beneficial, effect that can be demonstrated in-vivo or in vitro. As used herein, this term further includes any physiologically or pharmacologically active substance that produces a localized or systemic effect in an individual. Further examples of bioactive agents include, but are not limited to, agents comprising or consisting of an oligosaccharide, agents comprising or consisting of a polysaccharide, agents comprising or consisting of an optionally glycosylated peptide, agents comprising or consisting of an optionally glycosylated polypeptide, agents comprising or consisting of an oligonucleotide, agents comprising or consisting of a polynucleotide, agents comprising or consisting of a lipid, agents comprising or consisting of a fatty acid, agents comprising or consisting of a fatty acid ester and agents comprising or consisting of secondary metabolites. It may be used either prophylactically, therapeutically, in connection with treatment of an individual, such as a human or any other animal.

The terms “drug,” “medicament,” or “bioactive substance/agent” (i.e., biologically active substance/agent) as used herein include, biologically, physiologically, or pharmacologically active substances that act locally or systemically in the human or animal body.

The terms “treating”, “treatment” and “therapy” as used herein refer equally to curative therapy, prophylactic or preventative therapy and ameliorating therapy. The term includes an approach for obtaining beneficial or desired physiological results, which may be established clinically. For purposes of this invention, beneficial or desired clinical results include, but are not limited to, alleviation of symptoms, diminishment of extent of disease, stabilized (i.e., not worsening) condition, delay or slowing of progression or worsening of condition/symptoms, amelioration or palliation of the condition or symptoms, and remission (whether partial or total), whether detectable or undetectable. The term “palliation”, and variations thereof, as used herein, means that the extent and/or undesirable manifestations of a physiological condition or symptom are lessened and/or time course of the progression is slowed or lengthened, as compared to not administering compositions of the present invention.

A “treatment effect” or “therapeutic effect” is manifested if there is a change in the condition being treated, as measured by the criteria constituting the definition of the terms “treating” and “treatment.” There is a “change” in the condition being treated if there is at least 5% improvement, preferably 10% improvement, more preferably at least 25%, even more preferably at least 50%, such as at least 75%, and most preferably at least 100% improvement. The change can be based on improvements in the severity of the treated condition in an individual, or on a difference in the frequency of improved conditions in populations of individuals with and without treatment with the bioactive agent, or with the bioactive agent in combination with a pharmaceutical composition of the present invention.

“Pharmacologically effective amount”, “pharmaceutically effective amount” or “physiologically effective amount of a “bioactive agent” is the amount of an active agent present in a pharmaceutical composition as described herein that is needed to provide a desired level of active agent in the bloodstream or at the site of action in an individual (e.g., the lungs, the gastric system, the colorectal system, prostate, etc.) to be treated to give an anticipated physiological response when such composition is administered. The precise amount will depend upon numerous factors, e.g., the active agent, the activity of the composition, the delivery device employed, the physical characteristics of the composition, intended patient use (i.e., the number of doses administered per day), patient considerations, and the like, and can readily be determined by one skilled in the art, based upon the information provided herein. An “effective amount” of a bioactive agent can be administered in one administration, or through multiple administrations of an amount that total an effective amount, preferably within a 24-hour period. It can be determined using standard clinical procedures for determining appropriate amounts and timing of administration. It is understood that the “effective amount” can be the result of empirical and/or individualized (case-by-case) determination on the part of the treating health care professional and/or individual.

The terms “enhancing” and “improving” a beneficial effect, and variations thereof, as used herein, refers to the therapeutic effect of the bioactive agent against placebo, or an increase in the therapeutic effect of a state-of-the-art medical treatment above that normally obtained when a pharmaceutical composition is administered without the bioactive agent of this invention. “An increase in the therapeutic effects” is manifested when there is an acceleration and/or increase in intensity and/or extent of the therapeutic effects obtained as a result of administering the bioactive agent(s). It also includes extension of the longevity of therapeutic benefits. It can also manifest where a lower amount of the pharmaceutical composition is required to obtain the same benefits and/or effects when it is co-administered with bioactive agent(s) provided by the present invention as compared to the administration in a higher amount of the pharmaceutical composition in the absence of bioactive agent. The enhancing effect preferably, but not necessarily, results in treatment of acute symptoms for which the pharmaceutical composition alone is not effective or is less effective therapeutically. Enhancement is achieved when there is at least a 5% increase in the therapeutic effects, such as at least 10% increase in the therapeutic effects when a bioactive agent of the present invention is co-administered with a pharmaceutical composition compared with administration of the pharmaceutical composition alone. Preferably the increase is at least 25%, more preferably at least 50%, even more preferably at least 75%, most preferably at least 100%.

“Co-administering” or “co-administration” of bioactive agent(s), or bioactive agents and state-of-the-art medicaments, as used herein, refers to the administration of one or more bioactive agents of the present invention, or administration of one or more bioactive agents of the present invention and a state-of-the-art pharmaceutical composition within a certain time period. The time period is preferably less than 72 hours, such as 48 hours, for example less than 24 hours, such as less than 12 hours, for example less than 6 hours, such as less than 3 hours. However, these terms also mean that the bioactive agent and a therapeutic composition can be administered together.

The term “individual” refers to vertebrates, particular members of the mammalian species, and includes, but is not limited to domestic animals, such as cattle, horses, pigs, sheep, mink, dogs, cats, mice, guinea pigs, rabbits, rats; sports animals, such as horses, poly ponies, dogs, camels, and primates, including humans.

The term “kit of parts” as used in the present invention provides the matrix material according to the present invention, such as a matrix material coated with thrombin by ultrasonic spray technology, and at least one additional component. The additional component may in one embodiment be a container as specified herein. Accordingly, in one embodiment the kit comprises instructions for use of the matrix material.

The term “Wound” refers to cuts, incisions, abrasions, lacerations, amputations, burns induced by heat, ionizing radiation, ultraviolet radiation including sunlight, electricity, or chemical substances as well as to other forms of lesions such as ulcers, pressure sores and bedsores.

“Partial thickness wound” refers to wounds that encompass Grades I-III; examples of partial thickness wounds include burn wounds, pressure sores, venous stasis ulcers, and diabetic ulcers.

“Deep wound” is meant to include both Grade III and Grade IV wounds. The present invention contemplates treating all wound types, including deep wounds and chronic wounds.

“Chronic wound” refers to a wound that has not healed within 30 days.

“Alginate” refers to a linear co-polymer with homopolymeric blocks of (1-4)-linked R-D-mannuronate (M) and its C-5 epimer α-L-guluronate (G) residues, respectively, covalently linked together in different sequences or blocks.

“Hydrocolloid” refers to a colloid system in which the colloid-forming components are dispersed in water, but not cross-linked. A colloid system is a system or mixture in which two substances are interspersed between each other. A hydrocolloid has colloid particles spread throughout water and depending on the quantity of water available can take on different states, e.g: gel-like consistency or a sol (liquid). Hydrocolloids can be either irreversible (single state) or reversible. Examples include carrageenan, gelatin and pectin.

“Wound healing-promoting agent” is any agent capable of accelerating the wound healing process.

“Promote wound healing” and “accelerate wound healing,” and similar phrases, refer to either the induction of the formation of granulation tissue of wound contraction and/or the induction of epithelialization (i.e., the generation of new cells in the epithelium). Wound healing is conveniently measured by decreasing wound area.

A ‘hydrogel’ is a network of polymer chains that are water-insoluble, sometimes found as a colloidal gel in which water is the dispersion medium. Hydrogels are superabsorbent (they can contain over 99% water) natural or synthetic polymers. Hydrogels possess also a degree of flexibility very similar to natural tissue, due to their significant water content.

A ‘polymer’ is a substance composed of molecules with large molecular mass composed of repeating structural units, or monomers, connected by covalent chemical bonds. The word is derived from the Greek, polu, “many”; and meros, “part”. Well known examples of polymers include plastics, DNA and proteins. A simple example is polypropylene. While the term “polymer” in popular usage suggests “plastic”, polymers comprise a large class of natural and synthetic materials with a variety of properties and purposes. Natural polymer materials include shellac, amber and cellulose, which is the main constituent of wood and paper. There are three main classes of ‘biopolymers’: polysaccharides, polypeptides (proteins), and polynucleotides. A heteropolymer or copolymer is a polymer derived from two (or more) monomeric species, as opposed to a homopolymer where only one monomer is used.

‘Polysaccharides’ are relatively complex carbohydrates. They are polymers made up of many monosaccharides joined together by glycosidic bonds. They are therefore very large, often branched, macromolecules. They tend to be amorphous, insoluble in water, and have no sweet taste. When all the monosaccharides in a polysaccharide are the same type the polysaccharide is called a homopolysaccharide, but when more than one type of monosaccharide is present they are called heteropolysaccharides. Examples include storage polysaccharides such as starch and glycogen and structural polysaccharides such as cellulose and chitin. Polysaccharides have a general formula of Cₙ(H₂O)ₙ₋₁ where n is usually a large number between 200 and 2500. Considering that the repeating units in the polymer backbone are often six-carbon monosaccharides, the general formula can also be represented as (C₆H₁₀O₅)ₙ where n={40 . . . 3000}.

‘Peptides’ are short polymers formed from the linking, in a defined order, of α-amino acids. The link between one amino acid residue and the next is known as an amide bond or a peptide bond. Proteins are ‘polypeptide’ molecules (or consist of multiple polypeptide subunits). The distinction is that peptides are short and polypeptides/proteins are long.

‘Cross-links’ are bonds that link one polymer chain to another. They can be covalent bonds or ionic bonds. “Polymer chains” can refer to synthetic polymers or natural polymers (such as proteins). When the term “cross-linking” is used in the synthetic polymer science field, it usually refers to the use of cross-links to promote a difference in the polymers' physical properties. When “crosslinking” is used in the biological milieu, it can be in reference to its use as a probe to link proteins together to check protein-protein interactions, as well as other creative cross-linking methodologies.

A ‘drop’ or ‘droplet’ is a small volume of liquid or fluid, bounded completely or almost completely by free surfaces. The volume of a drop is not well-defined: it depends on the device and technique used to produce the drop and on the physical properties of the fluid. A droplet according to the present invention has been defined regarding size elsewhere (pico to nano litre range).

A ‘Surface’ according to the present invention refers to the outer layer or outer part of a matrix material, which is the part that may be accessible for coating and thus do not comprise the inner and inaccessible part of the material. By accessible is meant accessible for a coating technique according to the present invention—i.e. coating by ultrasonic spray technology. The surface in such a setting may be the outer few millimeters of the material, and may be uneven or porous. The surface in one setting may be one-dimensional.

‘Coating’ according to the present invention refers to the deposition of a fluid or liquid composition onto the surface of a matrix material, in which the fluid or liquid composition in the form of droplet(s) makes contact with the surface of the matrix material of interest, and the solvent or liquid component of the droplet subsequently evaporates to leave a solid or dry composition on the surface of the coated matrix material. The small volume of fluid or liquid composition and the rapid evaporation of the solvent or liquid component mean that essentially no swelling of the matrix material will occur.

“Ultrasonic spray technology” according to the present invention refers to the use of a technology which employs high-frequency (“ultra sonic” i.e. frequencies above the range of the human hearing, i.e. above 20 kHz) mechanical vibrations to nebulise a solution or a suspension. Following nebulisation, said suspension is discharged from the nebulising surface (or atomizing surface) and directed toward the object or surface intended to be coated with the solution or suspension. According to the present invention ultrasonic spray technology employs one or more ultrasonic spray nozzles grouped into one or more nozzle assemblies.

“Sterile storage” means that a compartment, container or box used for storage of the matrix material should facilitate a micro-environment made essentially free of infectious microorganisms at least to a degree which satisfies the intended use of the matrix material. To obtain sterility, a sterile matrix material could either be packed under sterile conditions, or a matrix material could be sealed within the packaging and subsequently be sterilised by methods known in the art, e.g. by radiation.

A pharmaceutical composition as used herein is a composition comprising one or more agents or bioactive agents, either in solid or dry form (after application by ultrasonic spray technology and evaporation) or in fluid or liquid form (prior to and during application by ultrasonic spray technology).

A fluid or liquid composition is a pharmaceutical composition in fluid or liquid form, used for application by ultrasonic spray technology onto the surface of a matrix material.

A solid composition is a pharmaceutical composition which was initially in fluid or liquid form, which has been applied by ultrasonic spray technology onto the surface of a matrix material, and wherein the liquid portion or solvent component of each droplet of the fluid or liquid composition comprising the one or more solubilised agents or bioactive agents has evaporated essentially on impacting the surface of the matrix material.

Centipoise, cps is a measure of dynamic viscosity and is defined in terms of SI-units as follows: 1 cps=10⁻³ Pa·s=0.01 kg·m⁻¹·s⁻¹.

### DESCRIPTION OF DRAWINGS

FIG. 1A illustrates an ultrasonic spray nozzle and FIG. 1B illustrates non-limiting examples of types of sprays.

FIGS. 2A and 2B illustrate a container without and with a matrix material, respectively. The bottom of the inner tray is marked (1), the sidewall is marked (2), the mark on the sidewall is marked (3), the inner tray notch is marked (4), the base is marked (5), the handle is marked (6), the sealing surface for the lid is marked (7) and the lid is marked (8).

FIGS. 3A and 3B illustrate a container containing a matrix material. The bottom of the inner tray is marked (1), the sidewall is marked (2), the mark on the sidewall is marked (3), the base is marked (5), the handle is marked (6), the sealing surface for the lid is marked (7) and the lid is marked (8).

FIG. 4 illustrates a preferred container for a matrix material termed Teacup100. The bottom of the inner tray is marked (1), the sidewall is marked (2), the mark on the sidewall is marked (3), the inner tray notch is marked (4), the base is marked (5), and the handle is marked (6). The length (200.4 mm) and width (130.35 mm) of the base is indicated.

FIG. 5 illustrates a preferred container for a matrix material termed Teacup50. The bottom of the inner tray is marked (1), the sidewall is marked (2), the mark on the sidewall is marked (3), the inner tray notch is marked (4), the base is marked (5), and the handle is marked (6). The length (137.3 mm) and width (130.35 mm) of the base is indicated.

FIG. 6 illustrates a preferred container for a matrix material termed Teacup12-7. The bottom of the inner tray is marked (1), the sidewall is marked (2), the mark on the sidewall is marked (3), the inner tray notch is marked (4), the base is marked (5), and the handle is marked (6). The length (97.4 mm) and width (130.35 mm) of the base is indicated.

FIG. 7 illustrates the coating of two different fluid or liquid compositions each comprising at least one agent or bioactive agent (composition A and composition B), wherein coating occurs at different positions for each composition onto the surface of a matrix material. The fluid or liquid compositions A and B may comprise agents or bioactive agents which are not compatible when comprised in the same fluid or liquid composition, and the ultrasonic spray technology allows for said incompatible agents or bioactive agents to be applied separately but in close proximity to each other, for example in alternating positions on the surface of a matrix material. FIG. 7A illustrates the coating of two different fluid or liquid compositions from a sideview; FIG. 7A is a topview of a matrix material which has been coated with compositions A and B in alternating positions on the surface of the matrix material by ultrasonic spray technology.

FIG. 8 is a schematic illustration of the workflow of the present invention, wherein a batch of matrices is coated with a pharmaceutical composition employing ultrasonic spray technology. Matrices are loaded onto the transport mechanism in load zone 1, either manually or automatically. By means of the transport mechanism, the matrices are transported into the spray chamber, where they are spray coated by the ultrasonic spray nozzles of the designated nozzle assembly. Following spray coating, the matrices are transported to the oven for drying, through optional transfer areas and load area 2. The coated matrices are dried in the oven and transported to the buffer zone. After a brief and optional cooling period, the coated matrices are packaged into purpose-made trays and thereafter packaged into alu-pouches.

FIG. 9 is a side-view of a spray nozzle assembly located in the spray chamber over the transport mechanism on which the matrices to be coated are transported. The spray mist is ejected horizontally from the individual spray nozzles and thereafter reoriented by air jets produced in and emitted by the spray redirector, resulting in a fan-like spray mist directed vertically downwards. The direction of movement is indicated underneath the transport mechanism.

FIG. 10 is a head-on view of the spray chamber along the direction of movement of the transport mechanism. It is illustrated how a spray nozzle assembly comprises more than one spray nozzle (here: two) which produce non-intersecting but overlapping spray beams. To ensure a uniform density of the spray mist to which the surface of the matrices are exposed, the spray nozzles are configures to produce a slight overlap of the individual spray beams (*) and to produce a combined spray mist which is a little wider than the width of the actual matrice (**).

FIG. 11 is an illustration of the system which allows change of reservoir of pharmaceutical composition while completely avoiding entry of air bubbles into the system of tubes which feeds the ultrasonic spray nozzles. A large diameter (¼″) soft rubber tube is employed for the initial stretch of supply line (R. When exchanging the empty reservoir-bag for a full reservoir-bag, the soft rubber tube is pinched immediately below the connection point between rubber tube and reservoir bag (P=point of pinching, C=connection between reservoir bag and liquid feeding system). When the full reservoir-bag has been safely joined to the rubber tube, air and residual fluid from the now-removed previous reservoir-bag left standing over the pinch in the rubber tube, is pushed backwards up into the new reservoir-bag.

FIG. 12 illustrates the application of a pharmaceutical composition onto a surface of a matrix material using ultrasonic spray technology, wherein the technique comprises two application rounds. In the first application round nozzle 1 and nozzle 2 are placed at position A and C, respectively, on the nozzle assembly. In the second application round nozzle 1 and nozzle 2 are placed at position B and D, respectively, on the nozzle assembly.

### DETAILED DESCRIPTION OF THE INVENTION

Embodiments of the present invention are disclosed herein below with a view of disclosing both the present invention and equivalents thereof which are within reach of a skilled person having read the present application.

Deposition of a Pharmaceutical Composition onto a Surface by Ultrasonic Spray Technology

The present invention in one embodiment relates to a medical device comprising a composition, such as a pharmaceutical composition, which is deposited onto the surface of the device, such as onto the surface of a matrix material of the device. The deposition of the composition is preferably achieved by application of the fluid or liquid composition onto the surface of the device by ultrasonic spray technology.

It follows that a fluid or liquid composition according to the present invention may be any liquid or gaseous composition, and covers any solution, suspension and emulsion. In one embodiment, the fluid or liquid composition is a particulate composition, which may be liquid, gaseous, solid or dry. A particulate composition may be employed if the size of the particles does not exceed the diameter of the ultrasonic spray nozzle from which the composition exits (see below).

Application of the composition onto the surface of the device by ultrasonic spray technology does not involve a direct contact between the one or more nozzles and the surface of the device.

### Ultrasonic Spray Technology

In one aspect, the present invention relates to a method of applying one or more pharmaceutical compositions such as a pharmaceutical composition comprising thrombin onto a device for promotion of hemostasis and/or wound healing by ultrasonic spray technology.

Ultrasonic spray technology comprises use of ultrasonic nozzle systems for application of thin film coatings onto a device according to the present invention.

Advantages of using ultrasonic nozzle systems for coating of the device according to the present invention compared to other coating techniques such as printing or spraying include dramatic reduction in overspray, savings in raw materials, water and energy usage, improved process and transfer efficiency, greater uniformity and reduced emissions.

Ultrasonic spray systems use high frequency sound vibrations and the nozzles atomize liquids to form a soft spray of micron-sized droplets.

### Nozzle Technology

The present invention relates in one embodiment to use of pressureless, ultrasonic atomizing nozzles. One feature that distinguishes pressureless, ultrasonic atomizing nozzles from most other spray nozzles is a soft, low-velocity spray, typically on the order of 3-5 inches per second. Other common atomization techniques, which use pressure in order to generate a spray, generally produce drops with velocities well over 100 times that generated by ultrasonic atomization. This velocity differential means that pressure sprays generate on the order of 10,000 as much kinetic energy as do ultrasonically atomized sprays. This striking contrast in spray energy has important, practical implications.
In coating applications, the unpressurized, low-velocity spray significantly reduces the amount of overspray since the drops tend to settle on the substrate, rather than bouncing off it. This translates into substantial material savings and reduction in emissions into the environment.
The spray can be controlled and shaped precisely by entraining the slow-moving spray in an ancillary air stream. Spray patterns from as small as 0.070 inches wide to as much as 1-2 feet wide can be generated using specialized types of spray-shaping equipment.

### Sequential Application Rounds by Ultrasonic Spray Technology

In one embodiment the present invention comprises sequential rounds of ultrasonic spraying of a composition onto a surface of a matrix material. Accordingly, more than one round of application by ultrasonic spray technology can be used such as 2, 3, 4, 5, 6, 7, 8, 9, 10 or more than 10 sequential application rounds can be used to apply a composition onto the surface of a matrix material.

Prior to the next application round the position of the one or more nozzles is shifted and/or the position of the matrix/sponge is shifted. Accordingly, the localization of the composition applied onto the matrix/sponge in the first round and in the second and/or further rounds differs. However, the areas of the matrix material that are covered by the composition in different application rounds can overlap to some extent such as by less than 50%, for example less than 40%, such as less than 30%, for example less than 20%, such as less than 10%, for example less than 5%, such as less than 1%.

In one embodiment the nozzle assembly comprises more than 1 nozzle such as 2, 3, 4, 5, 6, 7, 8, 9, 10 or more than 10 nozzles.

In one particular embodiment the nozzle assembly comprises two nozzles and the ultrasonic spray method comprises two sequential rounds of application of a composition onto a matrix/sponge by ultrasonic spray technology.

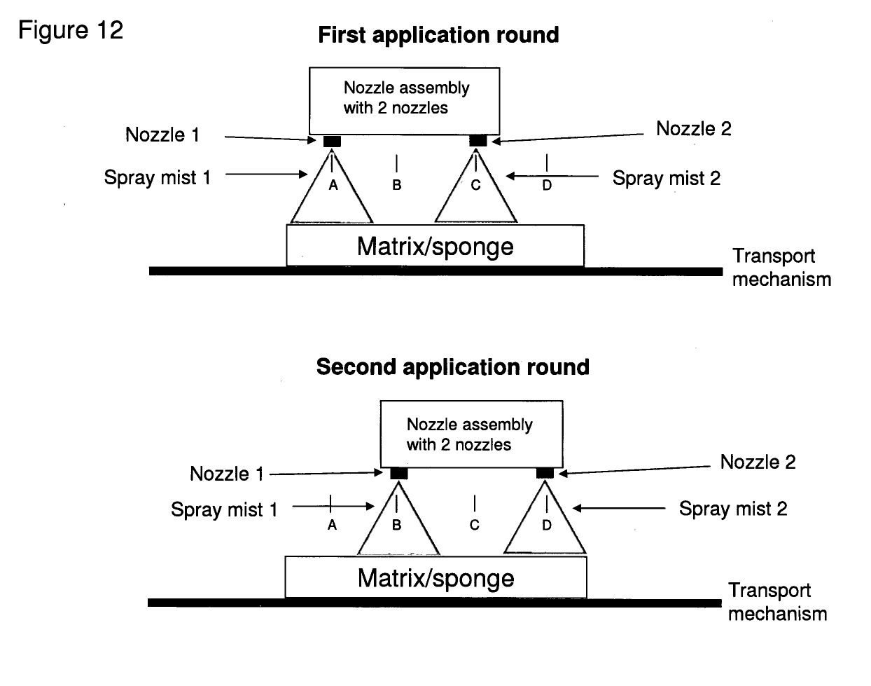

FIG. 12 illustrates application of a pharmaceutical composition onto a surface of a matrix material using ultrasonic spray technology, wherein the technique comprises two application rounds. In the first application round nozzle 1 and 2 are placed at position A and C, respectively. In the second application round the nozzle assembly is shifted resulting in nozzle 1 and 2 occupying positions B and D, respectively.

In a particular embodiment the position of the first nozzle and/or second nozzle and/or further nozzle is adjusted to reduce the spillage/waste of the composition—i.e. the amount of composition sprayed outside the matrix material is minimized/reduced. In one preferred embodiment the adjustment of the position of the first nozzle and/or second nozzle and/or further nozzle results in spillage/waste of less than 10% of the composition, such as less than 5%, for example less than 4%, such as less than 3%, for example less than 2%, such as less than 1%, for example less than 0.5% or such as less than 0.1%.

The advantages of use of more than one sequential application round and displacement of the nozzles comprise increased homogeniety of the composition on the surface of the matrix material and/or reduced spillage of the composition—i.e. the amount of composition sprayed outside the matrix material is reduced.

### Ultra-Low Flow Rate Capabilities

Since the ultrasonic atomization process does not rely on pressure, the amount of liquid atomized by a nozzle per unit time is primarily controlled by the liquid delivery system used in conjunction with a nozzle.

The flow rate range for the ultrasonic nozzles used in the present invention is in one embodiment from as low as a few microliters per second.

Depending on the specific nozzle and the type of liquid delivery system employed, the technology is capable of providing an extraordinary variety of flow/spray possibilities. The liquid delivery system employed can be selected from the group consisting of one or more gear pumps, one or more syringe pumps, one or more pressurized reservoirs, one or more peristaltic pumps, and one or more gravity feeds.

Drop-Size Range Selectivity

In general, the drops produced by ultrasonic atomization have a relatively narrow size distribution. In one embodiment the median drop sizes range from 18-68 microns (μm), depending on the operating frequency of the specific type of nozzle. As an example, for a nozzle with a median drop size diameter of approximately 40 microns, 99.9% of the drops will fall in the 5-200 micron diameter range.

### Ultrasonic Atomization

The phenomenon referred to as ultrasonic atomization has its roots in late 19th century acoustical physics, notably in the works of the ubiquitous Lord Kelvin. Simply stated, when a liquid film is placed on a smooth surface that is set into vibrating motion such that the direction of vibration is perpendicular to the surface, the liquid absorbs some of the vibrational energy, which is transformed into standing waves. These waves, known as capillary waves, form a rectangular grid pattern in the liquid on the surface with regularly alternating crests and troughs extending in both directions as shown in the photomicrograph to the left.

When the amplitude of the underlying vibration is increased, the amplitude of the waves increases correspondingly; that is, the crest become taller and troughs deeper. A critical amplitude is ultimately reached at which the height of the capillary waves exceeds that required to maintain their stability. The result is that the waves collapse and tiny drops of liquid are ejected from the tops of the degenerating waves normal to the atomizing surface.

### Ultrasonic Spray Nozzles

As their name implies, ultrasonic nozzles employ high frequency sound waves, those beyond the range of human hearing. In one embodiment disc-shaped ceramic piezoelectric transducers convert electrical energy into mechanical energy. The transducers receive electrical input in the form of a high frequency signal from a power generator and convert that into vibratory motion at the same frequency. Two titanium cylinders magnify the motion and increase the vibration amplitude at the atomizing surface.

Nozzles are configured such that excitation of the piezoelectric crystals creates a transverse standing wave along the length of the nozzle. The ultrasonic energy originating from the crystals located in the large diameter of the nozzle body undergoes a step transition and amplification as the standing wave as it traverses the length of the nozzle.

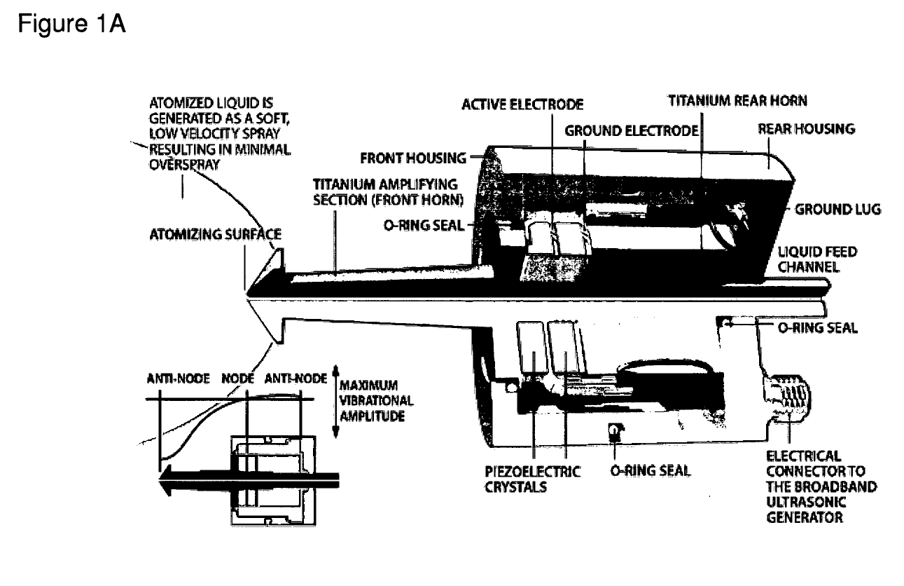

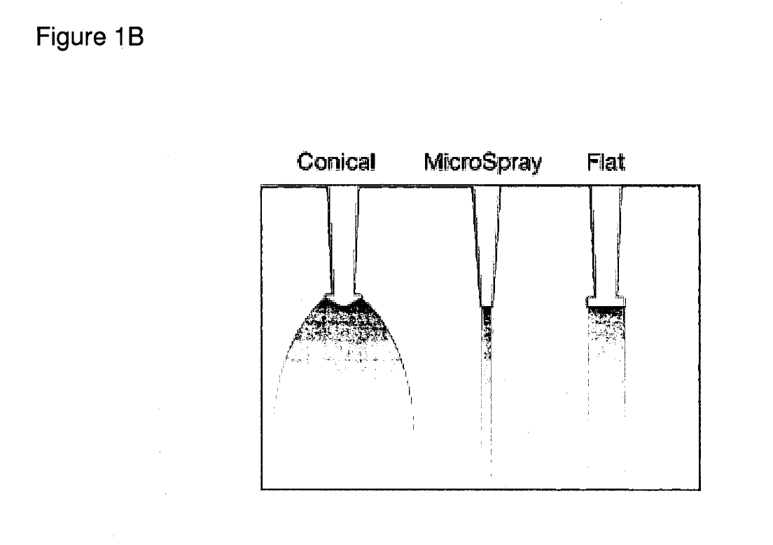

The nozzle is in one embodiment designed (as shown in FIG. 1A) such that a nodal plane is located between the crystals. For ultrasonic energy to be effective for atomization, the atomizing surface (nozzle tip) must be located at an anti-node, where the vibration amplitude is greatest. To accomplish this, the nozzle's length must be a multiple of a half-wavelength. Since wavelength is dependent upon operating frequency, nozzle dimensions are governed by frequency. In general, high frequency nozzles are smaller, create smaller drops, and consequently have smaller maximum flow capacity than nozzles that operate at lower frequencies.

The nozzle body is in one embodiment fabricated from titanium because of its good acoustical properties, high tensile strength, and excellent corrosion resistance. Liquid introduced onto the atomizing surface through a large, non-clogging feed tube running the length of the nozzle absorbs in one embodiment some of the vibrational energy, setting up wave motion in the liquid on the surface. For the liquid to atomize, the vibrational amplitude of the atomizing surface must be carefully controlled. Below the so-called critical amplitude, the energy is insufficient to produce atomized drops. If the amplitude is excessively high, the liquid is literally ripped apart, and large “chunks” of fluid are ejected, a condition known as cavitation. Only within a narrow band of input power is the amplitude ideal for producing the nozzle's characteristic fine, low velocity mist.

The fine control of input energy is what distinguishes ultrasonic atomizing nozzles from other ultrasonic devices such as welders, emulsifiers, and ultrasonic cleaners; these other devices rely on cavitation with input power of the order of hundreds to thousands of watts. In one embodiment, power levels are generally under 15 watts for ultrasonic atomization. Power is controlled by adjusting the output level on the power supply.

Since the atomization mechanism relies only on liquid being introduced onto the atomizing surface, the rate at which liquid is atomized depends solely on the rate at which it is delivered to the surface. Therefore, every ultrasonic nozzle has an inherently wide flow rate range. In theory, the “turn down” ratio (ratio of maximum to minimum flow rate possible) is infinite. In one embodiment, this ratio is limited to approximately 5:1 as result of design constraints.

### How Ultrasonic Nozzles Work

Every ultrasonic nozzle operates at a specific resonant frequency, which is determined primarily by the length of the nozzle.

In one embodiment the production nozzle is designed as shown in the cross-sectional view of a production nozzle in FIG. 1A. There are several features worth noting. The electrically active elements are contained within a sealed housing that protects the lead zirconate/titanate piezoelectric transducers, electrodes, and connecting wires from external contamination. Chemically impervious o-rings assure the integrity of the seal.

The housing provides a convenient location for mounting the nozzle in most applications since it is the only portion of the nozzle that is not ultrasonically active. For applications involving an interface to a vacuum chamber or another type of chemical reaction chamber, the housing can be fitted with or made an integral part of a mounting flange that bolts to an existing port on the reactor. Both the front and rear horns can be fabricated from a very high-strength titanium alloy (Ti-6AI-4V). This alloy also exhibits exceptional resistance to chemical attack. The housing can be fabricated from stainless steel. The electrical connector can be a hermetically sealed SMA connector fabricated from stainless steel. The o-ring seals between the titanium horns and the front and rear portions of the housing can be Kalrez (trademark of Dupont). The o-ring seal between the front and rear housings can be Viton (trademark of Dupont).

The liquid feed tube that runs the entire length of the nozzle can be an integral part of the front titanium horn. Thus, the liquid only comes into contact with titanium within the nozzle. In one embodiment the nozzle is supplied with a stainless steel compression fitting mounted on the rear of the liquid feed tube, which is mated to appropriate polymeric tubing.

The nozzle shown in FIG. 1A features a cone-shaped atomizing surface. Its purpose is to spread out the spray. Some applications require that the spray be very narrow. In those cases, the atomizing surface is sculptured into a flat or nearly-flat surface. Depending on the width requirements of the spray pattern and the required flow rate, the atomizing surface may have a very small diameter or an extended, flat section. Non limiting possibilities are shown in FIG. 1B.

### Input Power Ranqe

In one embodiment the atomization process is confined to a relatively narrow input power range. Below the critical power level, there is insufficient energy to cause atomization. The power range in which atomization proceeds normally is in one embodiment confined to a narrow region, approximately 1-2 watts above the critical power level.

The exact magnitude of power required depends on several factors. These include: a) Nozzle type, b) Liquid characteristics (e.g. viscosity, solids content) and c) Flow rate

Each nozzle type, because of its specific geometry and other factors, will generally have a different critical power level for the same liquid. For example, the critical power level of a 48 kHz nozzle, designed with a conical atomizing surface to deliver a wide spray pattern at substantial flow rates, will generally be in the neighbourhood of 3.5-4 watts of input power when atomizing water. Another nozzle, operating at the same frequency, but designed for microflow operation (a very small atomizing surface), may require only 2 watts to atomize water.

The type of liquid being atomized strongly influences the minimum power level. More viscous liquids or liquids with high solids content generally increase the minimum power requirement. For example, the 48 kHz nozzle with a conical atomizing surface mentioned in the last paragraph, might require at least 8 watts of input power if the liquid being atomized were a 20% solids-content, isopropanol based material.

The flow rate also plays a role in determining minimum power level. For a given nozzle, the higher the flow rate, the higher will be the power required, since the nozzle is working harder at higher flow rates.

### Temperature Limitations

The piezoelectric transducers that comprise the active elements of ultrasonic nozzles can be limited as to maximum operating temperature. The limit is characterized by the Curie point, defined as the temperature at which the piezoelectric property of a material vanishes, as a result of the loss of its permanent polarization. For the lead zirconate-titanate transducers used in ultrasonic nozzles, the Curie point is just over 300 degrees C. However, this does not mean that the transducers can be operated at temperatures anywhere near this limit, because the degradation in piezoelectric performance degrades gradually, not suddenly, with increasing operating temperature. A practical upper limit is approximately 150 degrees C. There is no lower temperature limit.

Methods have been developed for air or gas cooling so that it is possible to operate nozzles at elevated temperatures under certain circumstances. Another factor that must be included in the thermal equation is that the nozzles themselves generate some heat. It is possible for a nozzle operating at a high power and at a 100% duty cycle to experience a 30 degree C. temperature rise.

Drop Size and Distribution

Drop size in an ultrasonically produced spray can be governed by the frequency at which the nozzle vibrates, and/or by the surface tension and/or density of the liquid being atomized. However, frequency is often the predominant factor. Median drop size is in one embodiment inversely proportional to frequency to the ⅔ power. Thus, the higher the frequency, the smaller the median drop size.

In one embodiment the drop size distribution from ultrasonic nozzles follows a log-normal distribution curve. In simple terms, this distribution has the familiar bell-shape but on a logarithmic scale.

Various parameters can be used to characterize the mean and median drop size of a particular drop distribution. The number median diameter defines the 50% point in drop size—that is, one-half of the number of drops in the spray have diameters larger than this value while the other half have diameters smaller than this value. The number mean and weight mean diameters are average diameters. The number mean diameter is obtained by adding together the diameter of each drop in a spray sample and dividing that sum by the number of drops in the sample. The weight mean diameter is obtained by adding together the volume of each drop in a spray sample (volume is proportional to diameter cubed), taking the cube root of this sum, and finally dividing by the number of drops. The Sauter mean diameter is a specialized parameter used primarily in combustion applications. It measures the effective ratio of drop volume to surface area.

### Flow Rate Ranges

In one embodiment the present invention relates to a flow rate of a few microliters/min. The flow rate range of a specific nozzle is at least governed by three factors:
Orifice size
Atomizing surface area
Liquid characteristics

The more difficult a liquid is to atomize, the lower will be its maximum flow rate for a given nozzle.

Orifice size plays a principal role in determining both maximum and minimum flow rates. The maximum flow rate is related to the velocity of the liquid stream as it emerges onto the atomizing surface. The atomization process relies on the liquid stream spreading out onto this surface and creating capillary waves. At low stream velocity, surface forces are sufficiently strong to “attract” the liquid, and cause it to cling to the surface. As the velocity of the stream increases, a critical velocity is reached where the surface forces are overcome by the kinetic energy of the stream, causing the stream to become totally detached from the surface.

In one embodiment the critical velocity is on the order of 13 in./sec. As an example, for a nozzle with an orifice diameter of 0.100 in., this translates into a maximum flow rate of about 1.7 gph (ml/sec).

In theory, there is no lower flow rate limit for any orifice size since the process is independent of pressure. However, in practical terms, lower limits do exist. As the flow is reduced, a point is reached where the velocity becomes so low that the liquid emerges onto the atomizing surface in a non-uniform circumferential manner, causing the atomization pattern to become distorted. In some applications, where stable spray patterns are unimportant this distortion may be tolerable. In other applications, where the integrity of the pattern is vital the low-velocity stream distortions are unacceptable. As a practical matter in such cases, the minimum velocity of the stream from an orifice of a given size is in one embodiment about 20% that of the maximum velocity.

The amount of atomizing surface area available is the final factor influencing the maximum flow rate available from a given nozzle.

An atomizing surface of a given size obviously has a limitation as to how much liquid it can support and still create the film that is required to create capillary waves. If the quantity “dumped” onto the surface becomes too great, it overwhelms the capability of the surface to sustain the liquid film.

In one embodiment the maximum sustainable flow rate not only depends on the amount of real estate available, but also on the nozzle's operating frequency. Lower frequency nozzles can often support greater flow rates than higher frequency nozzles having the same atomizing surface area.

In summary, there are three factors that can determine maximum flow rate for a given nozzle. However, in every instance, only one of these factors will set the limit. If we are dealing with a hard-to-atomize material, for example, it is likely that the maximum flow rate will not depend on orifice size nor available surface area, but solely upon the atomizability of the liquid. Similarly, if we have a nozzle with an orifice whose capacity exceeds that of the available atomizing surface area, the surface area becomes the limiting factor. This interplay among the limiting factors is important in specifying a nozzle for a given application.

Compatibility with Various Liquids

The physical nature of a liquid plays a central role in the ultimate success of any atomization process. Factors such as viscosity, solids content, miscibility of components, and the specific rheological behaviour of a liquid can affect the outcome.

Pressure nozzles, both hydraulic and pneumatic, are generally unsatisfactory with materials that are abrasive or which tend to quickly solidify. In addition, it is usually necessary to operate such nozzles at high pressures, which produces overspray and consequent material loss.

Ultrasonic nozzles are even more “fussy”. Although they offer many potential benefits, such as a soft, low-velocity spray, micro-flow capabilities, extensive spray shaping capabilities, and total freedom from clogging, the very nature of the technology presents restrictions on the types of liquids that can be successfully atomized.

Unfortunately, there are no hard-and-fast rules governing the atomizability of a liquid using ultrasonics. We have encountered cases where liquids that were seemingly easy to atomize, would not; and conversely, we have come upon situations where we felt that ultrasonic atomization would be impossible, but the liquid atomized perfectly well.

The only guideline that applies to most materials is that the higher the viscosity or solids-content of a liquid, the lower will be the maximum flow rate that can be atomized with a given nozzle. Even though the power delivered to a nozzle is user-adjustable in order to accommodate various liquids, the application of higher power to hard-to-atomize liquids does not ensure that the nozzle will atomize at a flow rate near its rated capacity with water.

### Dual Liquid Feed

In one embodiment the Ultrasonic Nozzle Systems can have an optional dual liquid feed assembly installed.

Dual liquid feed option allows for even greater flexibility in the process, as two liquids can be mixed right at the nozzle's atomizating surface.

Advantages Associated with Use of Ultrasonic Nozzles

Ultrasonic atomization produces in one embodiment a tight and controllable drop size distribution.

Ultrasonic nozzles can be capable of micro-quantity dispensing.

Ultrasonic nozzles can produce low-velocity, spherical drops.

Dual liquid feed can avoid premature mixing of components.

Ultrasonic nozzles can be ideal for Micro-encapsulation

Frequencies are in one embodiment available from 25-120 kHz, depending on the drop size requirements.

### Spray Shaping

Since ultrasonic spray nozzles deliver such a soft, low-velocity spray, the spray envelope produced may not be suitable for a particular application without further shaping. In many applications, such as coating blood collection tubes, dispensing fragrances onto non-woven fabrics, and introducing chemicals into reaction chambers, the soft spray is perfectly suited “as is.”

However, for other applications, such as coating wide substrates, focusing the pattern into a very narrow, well-defined line, or producing a pattern with precise outlines, auxiliary means for spray shaping must be employed.

To produce wide sprays from a single nozzle, the nozzle can be mounted within a specially designed air-handler that uses low-velocity air to both shear the spray to the desired width, and propel it in the desired direction in a uniform wedge-shaped pattern. Auxiliary air can be used in order to shape the spray.

### Broadband Ultrasonic Generator

A Broadband Ultrasonic Generator can be used to deliver the high frequency electrical energy required to operate the ultrasonic atomizing nozzles. The power generator incorporates in one embodiment features that simplify process control and enhance the operation of our nozzle systems.
Operates in one embodiment over a frequency range of 25-120 kHz (frequency is user selectable for any nozzle within this range)
Uses in one embodiment advanced phase-locked-loop control technology to automatically lock onto a nozzle's specific operating frequency
Provides in one embodiment audible and/or visual alarms in the event of system malfunction
Contains in one embodiment an output for connection to a remote alarm
Can in one embodiment be triggered on/off by an external control signal
Contains in one embodiment an LCD power meter and power level control for setup and monitoring of nozzle operation
Contains in one embodiment an input for remote power control
Is in one embodiment available in two versions: such as a 100-240 VAC free-standing unit, and a 24 VDC modular system intended for use in multiple nozzle configurations

### Precision Ultrasonic Generator

A Precision Ultrasonic Generator can be ideal for high-precision applications using ultra-low flow rates and low power requirements. The Precision Generator delivers the high frequency electrical energy required to operate ultrasonic atomizing nozzles with high accuracy and fine control adjustments.

The generator incorporates in one embodiment features that simplify process control and enhance the operation of our nozzle systems.
Operates in one embodiment over a frequency range of 25-120 kHz (frequency is user selectable for any nozzle within this range)
Uses in one embodiment advanced phase-locked-loop control technology to automatically lock onto a nozzle's specific operating frequency
Provides in one embodiment audible and/or visual alarms in the event of system malfunction
Contains in one embodiment an output for remote monitoring of alarms
Can in one embodiment be triggered on/off by an external control signal
Contains in one embodiment an LCD power meter and power level control for setup and monitoring of nozzle operation to hundredths of a Watt
Contains in one embodiment an external power control input for remote power control

### Nozzle Assemblies and Nozzles of the Device

The ultrasonic spray technology according to the present invention in one embodiment employs one or more nozzle assemblies, wherein each nozzle assembly comprises one or more ultrasonic spray nozzles.

An ultrasonic spray nozzle is a mechanical device designed to control the characteristics of a fluid flow as said fluid exits (or enters) an enclosed chamber or pipe via an orifice. A nozzle is the element of the device that applies the fluid or liquid composition to the substrate or matrix material; thus being connected to one or more reservoirs comprising a fluid or liquid composition.

In one embodiment, one nozzle assembly with one ultrasonic spray nozzle is used. In one embodiment, one nozzle assembly with multiple individual ultrasonic spray nozzles is used. In one embodiment, two or more nozzle assemblies each with one ultrasonic spray nozzle are used. In one embodiment, two or more nozzle assemblies each with multiple individual ultrasonic spray nozzles are used.

In one embodiment, the distance between the nozzle centres of the two or more individual ultrasonic spray nozzles of the one or more nozzle assemblies is 41.5 mm. In one embodiment, the distance between the nozzle centres of the two or more individual ultrasonic spray nozzles of the one or more nozzle assemblies is in the range of 1.0 to 100.0 mm; such as 1.0-1.5 mm, for example 1.5-2.0 mm, such as 2.0-2.5 mm, for example 2.5-3.0 mm, such as 3.0-3.5 mm, for example 3.5-4.0 mm, such as 4.0-4.5 mm, for example 4.5-5.0 mm, such as 5.0-6.0 mm, for example 6.0-7.0 mm, such as 7.0-8.0 mm, for example 8.0-9.0 mm, such as 9.0-10.0 mm, for example 10.0-11.00 mm, such as 11.0-12.0 mm, for example 12.0-13.0 mm, such as 13.0-14.0 mm, for example 14.0-15.0 mm, such as 15.0-16.0 mm, for example 16.0-17.0 mm, such as 17.0-18.0 mm, for example 18.0-19.0 mm, such as 19.0-20.0 mm, for example 20.0-21.00 mm, such as 21.0-22.0 mm, for example 22.0-23.0 mm, such as 23.0-24.0 mm, for example 24.0-25.0 mm, such as 25.0-26.0 mm, for example 26.0-27.0 mm, such as 27.0-28.0 mm, for example 28.0-29.0 mm, such as 29.0-30.0 mm, for example 30.0-31.00 mm, such as 31.0-32.0 mm, for example 32.0-33.0 mm, such as 33.0-34.0 mm, for example 34.0-35.0 mm, such as 35.0-36.0 mm, for example 36.0-37.0 mm, such as 37.0-38.0 mm, for example 38.0-39.0 mm, such as 39.0-40.0 mm, for example 40.0-41.00 mm, such as 41.0-42.0 mm, for example 42.0-43.0 mm, such as 43.0-44.0 mm, for example 44.0-45.0 mm, such as 45.0-46.0 mm, for example 46.0-47.0 mm, such as 47.0-48.0 mm, for example 48.0-49.0 mm, such as 49.0-50.0 mm, for example 50.0-51.00 mm, such as 51.0-52.0 mm, for example 52.0-53.0 mm, such as 53.0-54.0 mm, for example 54.0-55.0 mm, such as 55.0-56.0 mm, for example 56.0-57.0 mm, such as 57.0-58.0 mm, for example 58.0-59.0 mm, such as 59.0-60.0 mm, for example 60.0-61.00 mm, such as 61.0-62.0 mm, for example 62.0-63.0 mm, such as 63.0-64.0 mm, for example 64.0-65.0 mm, such as 65.0-66.0 mm, for example 66.0-67.0 mm, such as 67.0-68.0 mm, for example 68.0-69.0 mm, such as 69.0-70.0 mm, for example 70.0-71.00 mm, such as 71.0-72.0 mm, for example 72.0-73.0 mm, such as 73.0-74.0 mm, for example 74.0-75.0 mm, such as 75.0-76.0 mm, for example 76.0-77.0 mm, such as 77.0-78.0 mm, for example 78.0-79.0 mm, such as 79.0-80.0 mm, for example 80.0-81.00 mm, such as 81.0-82.0 mm, for example 82.0-83.0 mm, such as 83.0-84.0 mm, for example 84.0-85.0 mm, such as 85.0-86.0 mm, for example 86.0-87.0 mm, such as 87.0-88.0 mm, for example 88.0-89.0 mm, such as 89.0-90.0 mm, for example 90.0-91.00 mm, such as 91.0-92.0 mm, for example 92.0-93.0 mm, such as 93.0-94.0 mm, for example 94.0-95.0 mm, such as 95.0-96.0 mm, for example 96.0-97.0 mm, such as 97.0-98.0 mm, for example 98.0-99.0 mm, such as 99.0-100.0 mm.

Each nozzle assembly may be connected to one or more reservoir(s) comprising a fluid or liquid composition. It follows, that the ultrasonic spray nozzles of any one nozzle assembly may be connected via the same channels to the same reservoir thus ejecting the same fluid or liquid composition, or the ultrasonic spray nozzles of any one nozzle assembly may be connected via separate channels to separate reservoirs thus ejecting separate fluid or liquid compositions.

In one embodiment, the ultrasonic spray nozzles are actuated by a high-voltage fire pulse. In one embodiment, the nozzle assembly head ejects droplets at a velocity in the range of 0.1-100 m/sec; such as 0.1-1 m/sec, for example 1-2 m/sec, such as 2-3 m/sec, for example 3-4 m/sec, such as 4-5 m/sec, for example 5-6 m/sec, such as 6-7 m/sec, for example 7-8 m/sec, such as 8-9 m/sec, for example 9-10 m/sec, such as 10-15 m/sec, for example 15-20 m/sec, such as 20-30 m/sec, for example 30-40 m/sec, such as 40-50 m/sec, for example 50-60 m/sec, such as 60-70 m/sec, for example 70-80 m/sec, such as 80-90 m/sec, for example 90-100 m/sec.

The ultrasonic spray nozzle diameter may be in the range of 1-1000 microns; such as 1-5 microns, for example 5-10 microns, such as 10-20 microns, for example 20-30 microns, such as 30-40 microns, for example 40-50 microns, such as 50-60 microns, for example 60-70 microns, such as 70-80 microns, for example 80-90 microns, such as 90-100 microns, for example 100-200 microns, such as 200-300 microns, for example 300-400 microns, such as 400-500 microns, for example 500-600 microns, such as 600-700 microns, for example 700-800 microns, such as 800-900 microns, for example 900-1000 microns.

A nozzle assembly may comprise any number of ultrasonic spray nozzles or addressable jets.

In one embodiment, the nozzle assembly contains means for selecting which ultrasonic spray nozzle(s) to activate at which point in time.

The nozzle assembly head(s) of the ultrasonic spray technology system may move with respect to the surface of the matrix material onto which a composition will be deposited.

### Distance Between the Ultrasonic Spray Nozzle(s) and the Surface

In one preferred embodiment of the invention, the ultrasonic spray nozzle(s) of the nozzle assembly head(s) and the surface of the substrate or matrix material are not in direct liquid contact, but the distance between surface and ultrasonic spray nozzle is kept at a minimum.

In one embodiment of the invention, the distance between the surface of the matrix material and the ultrasonic spray nozzle(s) is in the range 0.01 to 10.0 mm; for example 0.01-0.02 mm, such as 0.02-0.03, for example 0.03-0.04, such as 0.04-0.05, for example 0.05-0.06, such as 0.06-0.07, for example 0.07-0.08, such as 0.08-0.09, for example 0.1-0.2, such as 0.2-0.3, for example 0.3-0.4, such as 0.4-0.5, for example 0.5-0.6, such as 0.6-0.7, for example 0.7-0.8, such as 0.8-0.9, for example 0.9-1.0, such as 1.0-1.1, for example 1.1-1.2, such as 1.2-1.3, for example 1.3-1.4, such as 1.4-1.5, for example 1.5-1.6, such as 1.6-1.7, for example 1.7-1.8, such as 1.8-1.9, for example 1.9-2.0, such as 2.0-2.1, for example 2.1-2.2, such as 2.2-2.3, for example 2.3-2.4, such as 2.4-2.5, for example 2.5-2.6, such as 2.6-2.7, for example 2.7-2.8, such as 2.8-2.9, for example 2.9-3.0, such as 3.0-3.5, for example 3.5-4.0, such as 4.0-4.5, for example 4.5-5.0, such as 5.0-6.0, for example 6.0-7.0, such as 7.0-8.0, for example 8.0-9.0, such as 9.0-10.0 mm.

In one embodiment of the invention, the distance between the surface of the matrix material and the ultrasonic spray nozzle(s) is in the range of 10.0 to 100.0 mm; for example 10.0-11.00 mm, such as 11.0-12.0 mm, for example 12.0-13.0 mm, such as 13.0-14.0 mm, for example 14.0-15.0 mm, such as 15.0-16.0 mm, for example 16.0-17.0 mm, such as 17.0-18.0 mm, for example 18.0-19.0 mm, such as 19.0-20.0 mm, for example 20.0-21.00 mm, such as 21.0-22.0 mm, for example 22.0-23.0 mm, such as 23.0-24.0 mm, for example 24.0-25.0 mm, such as 25.0-26.0 mm, for example 26.0-27.0 mm, such as 27.0-28.0 mm, for example 28.0-29.0 mm, such as 29.0-30.0 mm, for example 30.0-31.00 mm, such as 31.0-32.0 mm, for example 32.0-33.0 mm, such as 33.0-34.0 mm, for example 34.0-35.0 mm, such as 35.0-36.0 mm, for example 36.0-37.0 mm, such as 37.0-38.0 mm, for example 38.0-39.0 mm, such as 39.0-40.0 mm, for example 40.0-41.00 mm, such as 41.0-42.0 mm, for example 42.0-43.0 mm, such as 43.0-44.0 mm, for example 44.0-45.0 mm, such as 45.0-46.0 mm, for example 46.0-47.0 mm, such as 47.0-48.0 mm, for example 48.0-49.0 mm, such as 49.0-50.0 mm, for example 50.0-51.00 mm, such as 51.0-52.0 mm, for example 52.0-53.0 mm, such as 53.0-54.0 mm, for example 54.0-55.0 mm, such as 55.0-56.0 mm, for example 56.0-57.0 mm, such as 57.0-58.0 mm, for example 58.0-59.0 mm, such as 59.0-60.0 mm, for example 60.0-61.00 mm, such as 61.0-62.0 mm, for example 62.0-63.0 mm, such as 63.0-64.0 mm, for example 64.0-65.0 mm, such as 65.0-66.0 mm, for example 66.0-67.0 mm, such as 67.0-68.0 mm, for example 68.0-69.0 mm, such as 69.0-70.0 mm, for example 70.0-71.00 mm, such as 71.0-72.0 mm, for example 72.0-73.0 mm, such as 73.0-74.0 mm, for example 74.0-75.0 mm, such as 75.0-76.0 mm, for example 76.0-77.0 mm, such as 77.0-78.0 mm, for example 78.0-79.0 mm, such as 79.0-80.0 mm, for example 80.0-81.00 mm, such as 81.0-82.0 mm, for example 82.0-83.0 mm, such as 83.0-84.0 mm, for example 84.0-85.0 mm, such as 85.0-86.0 mm, for example 86.0-87.0 mm, such as 87.0-88.0 mm, for example 88.0-89.0 mm, such as 89.0-90.0 mm, for example 90.0-91.00 mm, such as 91.0-92.0 mm, for example 92.0-93.0 mm, such as 93.0-94.0 mm, for example 94.0-95.0 mm, such as 95.0-96.0 mm, for example 96.0-97.0 mm, such as 97.0-98.0 mm, for example 98.0-99.0 mm, such as 99.0-100.0 mm.

In one embodiment of the invention, the distance between the surface of the matrix material and the ultrasonic spray nozzle(s) is in the range 0.01-10.0 mm, such as 0.02-10.0, for example 0.03-10.0, such as 0.04-10.0, for example 0.05-10.0, such as 0.06-10.0, for example 0.07-10.0, such as 0.08-10.0, for example 0.1-10.0, such as 0.2-10.0, for example 0.3-10.0, such as 0.4-10.0, for example 0.5-10.0, such as 0.6-10.0, for example 0.7-10.0, such as 0.8-10.0, for example 0.9-10.0, such as 1.0-10.0, for example 1.1-10.0, such as 1.2-10.0, for example 1.3-10.0, such as 1.4-10.0, for example 1.5-10.0, such as 1.6-10.0, for example 1.7-10.0, such as 1.8-10.0, for example 1.9-10.0, such as 2.0-10.0, for example 2.1-10.0, such as 2.2-10.0, for example 2.3-10.0, such as 2.4-10.0, for example 2.5-10.0, such as 2.6-10.0, for example 2.7-10.0, such as 2.8-10.0, for example 2.9-10.0, such as 3.0-10.0, for example 3.5-10.0, such as 4.0-10.0, for example 4.5-10.0, such as 5.0-10.0, for example 6.0-10.0, such as 7.0-10.0, for example 8.0-10.0, such as 9.0-10.0 mm.

In one embodiment of the invention, the distance between the surface of the matrix material and the ultrasonic spray nozzle(s) is in the range 0.01-0.02 mm, such as 0.01-0.03, for example 0.01-0.04, such as 0.01-0.05, for example 0.01-0.06, such as 0.01-0.07, for example 0.01-0.08, such as 0.01-0.09, for example 0.01-0.2, such as 0.01-0.3, for example 0.01-0.4, such as 0.01-0.5, for example 0.01-0.6, such as 0.01-0.7, for example 0.01-0.8, such as 0.01-0.9, for example 0.01-1.0, such as 0.01-1.1, for example 0.01-1.2, such as 0.01-1.3, for example 0.01-1.4, such as 0.01-1.5, for example 0.01-1.6, such as 0.01-1.7, for example 0.01-1.8, such as 0.01-1.9, for example 0.01-2.0, such as 0.01-2.1, for example 0.01-2.2, such as 0.01-2.3, for example 0.01-2.4, such as 0.01-2.5, for example 0.01-2.6, such as 0.01-2.7, for example 0.01-2.8, such as 0.01-2.9, for example 0.01-3.0, such as 0.01-3.5, for example 0.01-4.0, such as 0.01-4.5, for example 0.01-5.0, such as 0.01-6.0, for example 0.01-7.0, such as 0.01-8.0, for example 0.01-9.0, such as 0.01-10.0 mm.

In one embodiment, each droplet of the coating fluid or liquid composition traverses a distance from the ultrasonic spray nozzle(s) to the surface of a substrate or matrix material with a velocity that varies between each droplet within a range of 0.01% to a maximum of 10%; such as 0.01 to 0.1%, for example 0.1 to 1%, such as 1 to 2%, for example 2 to 3%, such as 3 to 4%, for example 4 to 5%, such as 5 to 6%, for example 6 to 7%, such as 7 to 8%, for example 8 to 9%, such as 9 to 10%.

### Droplet Size of the Fluid or Liquid Composition

When applying a fluid or liquid composition onto a surface of a matrix material by ultrasonic spray technology, the amount of liquid deposited per position on the matrix surface; i.e. the volume of each droplet, is in the pico liter (pL) to nano liter (nL) range. In one embodiment, the amount of liquid deposited per position on the matrix surface; i.e. the volume of each droplet is less than 100 mL, such as less than 90 mL, for example less than 80 mL, such as less than 70 mL, for example less than 60 mL, such as less than 50 mL, for example less than 40 mL, such as less than 30 mL, for example less than 20 mL, such as less than 10 mL, for example less than 1 mL or 1000 pL, such as less than 900 pL, for example less than 800 pL, such as less than 700 pL, for example less than 600 pL, such as less than 500 pL, for example less than 400 pL, such as less than 300 pL, for example less than 250 pL, such as less than 200 pL, for example less than 150 pL, such as less than 100 pL, for example less than 90 pL, such as less than 80 pL, for example less than 70 pL, such as less than 60 pL, for example less than 50 pL, such as less than 40 pL, for example less than 30 pL, such as less than 20 pL, for example less than 10 pL, such as less than 9 pL, for example less than 8 pL, such as less than 7 pL, for example less than 6 pL, such as less than 5 pL, for example less than 4 pL, such as less than 3 pL, for example less than 2 pL, such as less than 1 pL per position.

In one embodiment, the amount of liquid deposited per position on the surface of the matrix; i.e. the volume of each droplet, is in the range of 0.1 pL to 100 mL; such as 0.1-1 pL, for example 1-5 pL, such as 5-10 pL, for example 10-20 pL, such as 20-30 pL, for example 30-40 pL, such as 40-50 pL, for example 50-60 pL, such as 60-70 pL, for example 70-80 pL, such as 80-90 pL, for example 90-100 pL, such as 100-110 pL, for example 110-120 pL, such as 120-130 pL, for example 130-140 pL, such as 140-150 pL, for example 150-160 pL, such as 160-170 pL, for example 170-180 pL, such as 180-190 pL, for example 190-200 pL, such as 200-250 pL, for example 250-300 pL, such as 300-350 pL, for example 350-400 pL, such as 400-450 pL, for example 450-500 pL, such as 500-550 pL, for example 550-600 pL, such as 600-650 pL, for example 650-700 pL, such as 700-750 pL, for example 750-800 pL, such as 800-850 pL, for example 850-900 pL, such as 900-950 pL, for example 950-1000 pL or 1 nL, such as 1-2 nL, for example 2-3 nL, such as 3-4 nL, for example 4-5 nL, such as 5-6 nL, for example 6-7 nL, such as 7-8 nL, for example 8-9 nL, such as 9-10 nL, for example 10-15 nL, such as 15-20 nL, for example 20-25 nL, such as 25-30 nL, for example 30-35 nL, such as 35-40 nL, for example 40-45 nL, such as 45-50 nL, for example 50-60 nL, such as 60-70 nL, for example 70-80 nL, such as 80-90 nL, for example 90-100 nL.

In one embodiment, the amount of liquid deposited per position on the surface of the matrix; i.e. the volume of each droplet, is in the range of 0.1 pL-100 nL, for example 1 pL-100 nL, such as 5 pL-100 nL, for example 10 pL-100 nL, such as 20 pL-100 nL, for example 30 pL-100 nL, such as 40 pL-100 nL, for example 50 pL-100 nL, such as 60 pL-100 nL, for example 70 pL-100 nL, such as 80 pL-100 nL, for example 90 pL-100 nL, such as 100 pL-100 nL, for example 110 pL-100 nL, such as 120 pL-100 nL, for example 130 pL-100 nL, such as 140 pL-100 nL, for example 150 pL-100 nL, such as 160 pL-100 nL, for example 170 pL-100 nL, such as 180 pL-100 nL, for example 190 pL-100 nL, such as 200 pL-100 nL, for example 250 pL-100 nL, such as 300 pL-100 nL, for example 350 pL-100 nL, such as 400 pL-100 nL, for example 450 pL-100 nL, such as 500 pL-100 nL, for example 550 pL-100 nL, such as 600 pL-100 mL, for example 650 pL-100 nL, such as 700 pL-100 nL, for example 750 pL-100 nL, such as 800 pL-100 nL, for example 850 pL-100 nL, such as 900 pL-100 nL, for example 950 pL-100 nL, such as 1-100 nL, for example 2-100 nL, such as 3-100 nL, for example 4-100 nL, such as 5-100 nL, for example 6-100 nL, such as 7-100 nL, for example 8-100 nL, such as 9-100 nL, for example 10-100 nL, such as 15-100 nL, for example 20-100 nL, such as 25-100 nL, for example 30-100 nL, such as 35-100 nL, for example 40-100 nL, such as 45-100 nL, for example 50-100 nL, such as 60-100 nL, for example 70-100 nL, such as 80-100 nL, for example 90-100 nL.

In one embodiment, the amount of liquid deposited per position on the surface of the matrix; i.e. the volume of each droplet, is in the range of 0.1-1 pL, for example 0.1-5 pL, such as 0.1-10 pL, for example 0.1-20 pL, such as 0.1-30 pL, for example 0.1-40 pL, such as 0.1-50 pL, for example 0.1-60 pL, such as 0.1-70 pL, for example 0.1-80 pL, such as 0.1-90 pL, for example 0.1-100 pL, such as 0.1-110 pL, for example 0.1-120 pL, such as 0.1-130 pL, for example 0.1-140 pL, such as 0.1-150 pL, for example 0.1-160 pL, such as 0.1-170 pL, for example 0.1-180 pL, such as 0.1-190 pL, for example 0.1-200 pL, such as 0.1-250 pL, for example 0.1-300 pL, such as 0.1-350 pL, for example 0.1-400 pL, such as 0.1-450 pL, for example 0.1-500 pL, such as 0.1-550 pL, for example 0.1-600 pL, such as 0.1-650 pL, for example 0.1-700 pL, such as 0.1-750 pL, for example 0.1-800 pL, such as 0.1-850 pL, for example 0.1-900 pL, such as 0.1-950 pL, for example 0.1-1000 pL or 1 nL, such as 0.1 pL-2 nL, for example 0.1 pL-3 nL, such as 0.1 pL-4 nL, for example 0.1 pL-5 nL, such as 0.1 pL-6 nL, for example 0.1 pL-7 nL, such as 0.1 pL-8 nL, for example 0.1 pL-9 nL, such as 0.1 pL-10 nL, for example 0.1 pL-15 nL, such as 0.1 pL-20 nL, for example 0.1 pL-25 mL, such as 0.1 pL-30 nL, for example 0.1 pL-35 nL, such as 0.1 pL-40 nL, for example 0.1 pL-45 nL, such as 0.1 pL-50 nL, for example 0.1 pL-60 nL, such as 0.1 pL-70 nL, for example 0.1 pL-80 nL, such as 0.1 pL-90 nL, for example 0.1 pL-100 nL.

The droplet size for each droplet is in one embodiment preferably essentially identical, wherein the droplet size of any two droplets expelled from a ultrasonic spray nozzle according to the present invention may vary less that 10%, such as less than 8%, for example less than 6%, such as less than 4%, for example less than 2%, such as less than 1%. The droplet size of any two droplets expelled from a ultrasonic spray device according to the present invention may vary in the range of 0.1-10%, such as 0.1-1%, for example 1-2%, such as 2-3%, for example 3-4%, such as 4-5%, for example 5-6%, such as 6-7%, for example 7-8%, such as 8-9%, for example 9-10%.

The total volume of fluid or liquid composition to be deposited by coating by ultrasonic spray technology in the form of droplets in a preferred embodiment essentially does not result in any swelling of the matrix material.

Distance Between Droplets Deposited onto a Surface by Ultrasonic Spray Technology

When applying a fluid or liquid composition onto a surface of a matrix material, the droplets expelled from the ultrasonic spray nozzles of the nozzle assembly are preferably deposited onto said surface with a certain predetermined distance between every two droplets.

In one embodiment, the distance between every two droplets deposited by ultrasonic spray technology onto the matrix surface is less than 2 mm, such as less than 1.9 mm, for example less than 1.8 mm, such as less than 1.7 mm, for example less than 1.6 mm, such as less than 1.5 mm, for example less than 1.4 mm, such as less than 1.3 mm, for example less than 1.3 mm, such as less than 1.2 mm, for example less than 1.1 mm, such as less than 1.0 mm, for example less than 0.9 mm, such as less than 0.8 mm, for example less than 0.7 mm, such as less than 0.6 mm, for example less than 0.5 mm, such as less than 0.4 mm, for example less than 0.3 mm, such as less than 0.2 mm, for example less than 0.1 mm, such as less than 0.09 mm, for example less than 0.08 mm, such as less than 0.07 mm, for example less than 0.06 mm, such as less than 0.05 mm, for example less than 0.04 mm, such as less than 0.03 mm, for example less than 0.02 mm, such as less than 0.01 mm.

In one embodiment, the distance between every two droplets deposited by ultrasonic spray technology onto the matrix surface is in the range of 0.01 to 2 mm; for example 0.01-0.02 mm, such as 0.02-0.03 mm, for example 0.03-0.04 mm, such as 0.04-0.05 mm, for example 0.05-0.06 mm, such as 0.06-0.07 mm, for example 0.07-0.08 mm, such as 0.08-0.09 mm, for example 0.09-0.1 mm, such as 0.1-0.2 mm, for example 0.2-0.3 mm, such as 0.3-0.4 mm, for example 0.4-0.5 mm, such as 0.5-0.6 mm, for example 0.6-0.7 mm, such as 0.7-0.8 mm, for example 0.8-0.9 mm, such as 0.9-1.0 mm, for example 1.0-1.1 mm, such as 1.1-1.2 mm, for example 1.2-1.3 mm, such as 1.3-1.4 mm, for example 1.4-1.5 mm, such as 1.5-1.6 mm, for example 1.6-1.7 mm, such as 1.7-1.8 mm, for example 1.8-1.9 mm, such as 1.9-2.0 mm.

In one embodiment, the distance between every two droplets deposited by ultrasonic spray technology onto the matrix surface is in the range of 0.01-2.0 mm, such as 0.02-2.0 mm, for example 0.03-2.0 mm, such as 0.04-2.0 mm, for example 0.05-2.0 mm, such as 0.06-2.0 mm, for example 0.07-2.0 mm, such as 0.08-2.0 mm, for example 0.09-2.0 mm, such as 0.1-2.0 mm, for example 0.2-2.0 mm, such as 0.3-2.0 mm, for example 0.4-2.0 mm, such as 0.5-2.0 mm, for example 0.6-2.0 mm, such as 0.7-2.0 mm, for example 0.8-2.0 mm, such as 0.9-2.0 mm, for example 1.0-2.0 mm, such as 1.1-2.0 mm, for example 1.2-2.0 mm, such as 1.3-2.0 mm, for example 1.4-2.0 mm, such as 1.5-2.0 mm, for example 1.6-2.0 mm, such as 1.7-2.0 mm, for example 1.8-2.0 mm, such as 1.9-2.0 mm.

In one embodiment, the distance between every two droplets deposited by ultrasonic spray technology onto the matrix surface is in the range of 0.01-0.02 mm, such as 0.01-0.03 mm, for example 0.01-0.04 mm, such as 0.01-0.05 mm, for example 0.01-0.06 mm, such as 0.01-0.07 mm, for example 0.01-0.08 mm, such as 0.01-0.09 mm, for example 0.01-0.1 mm, such as 0.01-0.2 mm, for example 0.01-0.3 mm, such as 0.01-0.4 mm, for example 0.01-0.5 mm, such as 0.01-0.6 mm, for example 0.01-0.7 mm, such as 0.01-0.8 mm, for example 0.01-0.9 mm, such as 0.01-1.0 mm, for example 0.01-1.1 mm, such as 0.01-1.2 mm, for example 0.01-1.3 mm, such as 0.01-1.4 mm, for example 0.01-1.5 mm, such as 0.01-1.6 mm, for example 0.01-1.7 mm, such as 0.01-1.8 mm, for example 0.01-1.9 mm, such as 0.01-2.0 mm.

The distance between every two droplets deposited by ultrasonic spray technology onto the matrix surface is preferably essentially identical, wherein the distance may vary less that 10%, such as less than 8%, for example less than 6%, such as less than 4%, for example less than 2%, such as less than 1%. The droplet size of any two droplets expelled from an ultrasonic spray device according to the present invention may vary in the range of 0.1-10%, such as 0.1-1%, for example 1-2%, such as 2-3%, for example 3-4%, such as 4-5%, for example 5-6%, such as 6-7%, for example 7-8%, such as 8-9%, for example 9-10%.

### Droplet Evaporation

When tiny droplets of a fluid pharmaceutical composition comprising one or more bioactive agents is applied by ultrasonic spray technology onto the surface of a matrix or a device, a subsequent drying step, including a lyophilisation step, of the matrix or device is in one embodiment not required.

Thus, in one embodiment, the fluid droplets comprising one or more bioactive agents which are applied by ultrasonic spray technology onto the surface of a matrix or the surface of a device according to the present invention will not exceed a size that allows the droplets to evaporate within maximum 30 seconds, such as less than 25 seconds, for example less than 20 seconds, such as less than 15 seconds, for example less than 10 seconds, such as less than 5 seconds, for example less than 1 second after being applied by ultrasonic spray technology onto the surface of the matrix or the surface of the device.

In one embodiment, the fluid droplets comprising one or more bioactive agents which are applied by ultrasonic spray technology onto the surface of a matrix or the surface of a device according to the present invention will not exceed a size that allows the droplets to evaporate within 0.1-1 second, such as 1-2, for example 2-3, such as 3-4, for example 4-5, such as 5-6, for example 6-7, such as 7-8, for example 8-9, such as 9-10, for example 11-12, such as 12-13, for example 13-14, such as 14-15, for example 15-16, such as 16-17, for example 17-18, such as 18-19, for example 19-20, such as 20-25, for example 25-30 seconds after being applied by ultrasonic spray technology onto the surface of the matrix or the surface of the device.

The above-cited time for evaporation can be achieved by controlling droplet size, temperature of the droplet and temperature of the surface of the matrix or the device onto which the droplet is applied. Further, modifying the surface properties of the underlying matrix material (hydrophobicity, chemical heterogeneity, roughness) may alter evaporation time.

The evaporation of the fluid droplets on the surface of a substrate can in principle be aided in various ways. In principle the droplets can evaporate on the surface without dissolution of the surface, or the fluid can be a solvent for the surface and thus be absorbed in the surface, thereby effectively aiding in the evaporation process.

It is preferred that the droplets evaporate without dissolving or interacting with the surface of the matrix material or the device comprising said matrix material. Thus, as a consequence of the rapid evaporation of the fluid part of the droplet applied by ultrasonic spray technology onto the surface of the matrix, the matrix is coated with the pharmaceutical composition forming part of the droplet essentially without swelling and/or essentially without resulting in any other physical change of the surface structure of the matrix material or device.

When a droplet evaporates on the surface of a matrix material or device without dissolution of the surface material, different evaporation modes can be observed. A droplet can evaporate with the contact angle being essentially constant while the contact radius decreases (constant angle mode). Alternatively, the contact radius can remain essentially constant while the contact angle decreases, in which case the droplet becomes more flat over time (constant radius mode or pinning). Alternatively both of the above-mentioned modes can occur, in which case both the contact angle and the contact radius will change during evaporation (non-constant mode).

Usually, droplets evaporate in different modes. Thus, the use of tiny, uniformly sized droplets that evaporates rapidly upon contacting the surface of a matrix material or a device will add to the uniformity of coating of the compositions onto the surface of the matrix material or the device.

### Operating Temperature

The temperature of the fluid or liquid composition, or the temperature of the environment wherein the fluid or liquid composition is to be applied by ultrasonic spray technology, is in one embodiment the ambient temperature. In one embodiment, the temperature is in the range from sub-zero degrees celcius to 150 degrees celcius; such as −100° C. to −50° C., for example −50° C. to 0° C., such as 0-10° C., for example 10-20° C., such as 20-30° C., for example 30-40° C., such as 40-50° C., for example 50-60° C., such as 60-70° C., for example 70-80° C., such as 80-90° C., for example 90-100° C., such as 100-125° C., for example 125-150° C.

### Detailed Description of Ultrasonic Spray Coating of a Matrix

One aspect of the present invention is related to a method for coating of a matrix or the surface of a matrix with a pharmaceutical composition containing a bioactive agent, i.e. a pharmaceutically active solution or suspension, said method comprising the use of ultrasonic spray technology.

In one embodiment, all steps of the described method herein below and above are carried out under sterile conditions.

In one embodiment of the present invention, said matrix is or comprises a gelatin matrix.

In one embodiment of the present invention, said gelatin matrix is a gelatin sponge.

### Pharmaceutical Composition

In one embodiment, the pharmaceutical composition contains thrombin (12300-14800 IU/ml), calcium (Ca²⁺, 38-42 mM), albumin (16-26 mg/ml), mannitol (17.5-20-5 mg/ml), and acetate (17-20 mM).

In one embodiment, the concentration of thrombin in the pharmaceutical composition can be selected from the group of intervals consisting of from 2000 IU/ml to 3000 IU/ml, from 3000 IU/ml to 4000 IU/ml, from 4000 IU/ml to 5000 IU/ml, from 5000 IU/ml to 6000 IU/ml, from 6000 IU/ml to 7000 IU/ml, from 7000 IU/ml to 8000 IU/ml, from 8000 IU/ml to 9000 IU/ml, from 9000 IU/ml0, to 1000 IU/ml0, from 1000 IU/ml0 to 11000 IU/ml, from 11000 IU/ml to 12000 IU/ml, from 12000 IU/ml to 13000 IU/ml, from 13000 IU/ml to 14000 IU/ml, from 14000 IU/ml to 15000 IU/ml, from 15000 IU/ml to 16000 IU/ml, from 16000 IU/ml to 17000 IU/ml, from 17000 IU/ml to 18000 IU/ml, from 18000 IU/ml to 19000 IU/ml, from 19000 IU/ml to 20000 IU/ml, from 20000 IU/ml to 21000 IU/ml, from 21000 IU/ml to 22000 IU/ml, from 22000 IU/ml to 23000 IU/ml, from 23000 IU/ml to 24000 IU/ml, and from 24000 IU/ml to 25000 IU/ml.

In one embodiment, the concentration of calcium can be selected from the group of intervals consisting of from 20-25 mM, from 25-28 mM, from 28-31 mM, from 31-34 mM, from 34-36 mM, from 38-40 mM, from 40-42 mM, from 42-44 mM, from 44-47 mM, from 47-50 mM, from 50-53 mM, from 53-56 mM, from 53-59 mM, from 59-62 mM and from 62-66 mM.

In one embodiment, the concentration of albumin can be selected from the group of intervals consisting of from 5-8 mg/ml, from 8-11 mg/ml, from 11-14 mg/ml, from 14-17 mg/ml, from 17-20 mg/ml, from 20-23 mg/ml, from 23-26 mg/ml, from 26-29 mg/ml, from 39-32 mg/ml, from 32-35 mg/ml, from 35-38 mg/ml, from 35-42 mg/ml, from 42-46 mg/ml, and from 46-50 mg/ml.

In one embodiment, the concentration of mannitol can be selected from the group of intervals consisting of from 3-5 mM, from 5-8 mg/ml, from 8-11 mg/ml, from 11-14 mg/ml, from 14-17 mg/ml, from 17-20 mg/ml, from 20-23 mg/ml, from 23-26 mg/ml, from 26-29 mg/ml, from 39-32 mg/ml, from 32-35 mg/ml, from 35-38 mg/ml, from 35-42 mg/ml, from 42-46 mg/ml, and from 46-50 mg/ml.

In one embodiment, the concentration of acetate can be selected from the group of intervals consisting of from 5-8 mM, from 8-11 mM, from 11-14 mM, from 14-17 mM, from 17-20 mM, from 20-23 mM, from 23-26 mM, from 26-29 mM, from 39-32 mM, from 32-35 mM, from 35-38 mM, from 35-42 mM, from 42-46 mM, and from 46-50 mM.

In one embodiment, the pharmaceutical composition consists of thrombin formulated with L9 buffer solution (20 mM sodium acetate, 40 mM CaCl₂, 110 mM NaCl, 0.5% w/w human albumin, 2% w/w mannitol at pH 6.9-7.1).

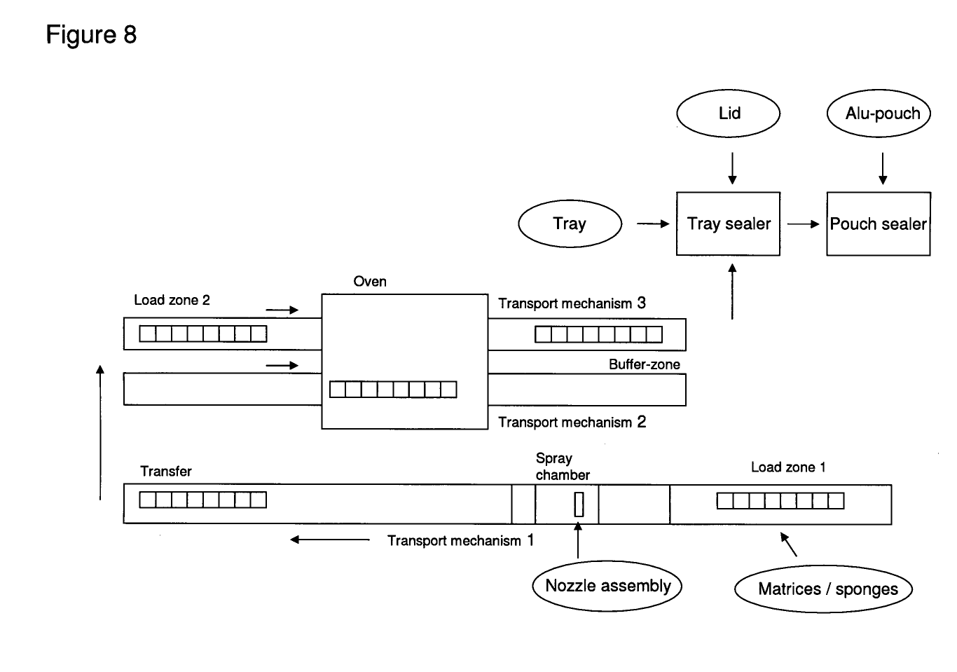

In one embodiment, the one or more matrices/sponges are loaded onto the transport mechanism of the production line (illustrated in FIG. 8) in the load zone by hand (“load zone 1” in FIG. 8). In one embodiment, the one or more matrices or sponges are loaded onto the transport mechanism or transport mechanisms of the production line in load zone 1 by an automated loading apparatus with or without live supervision.

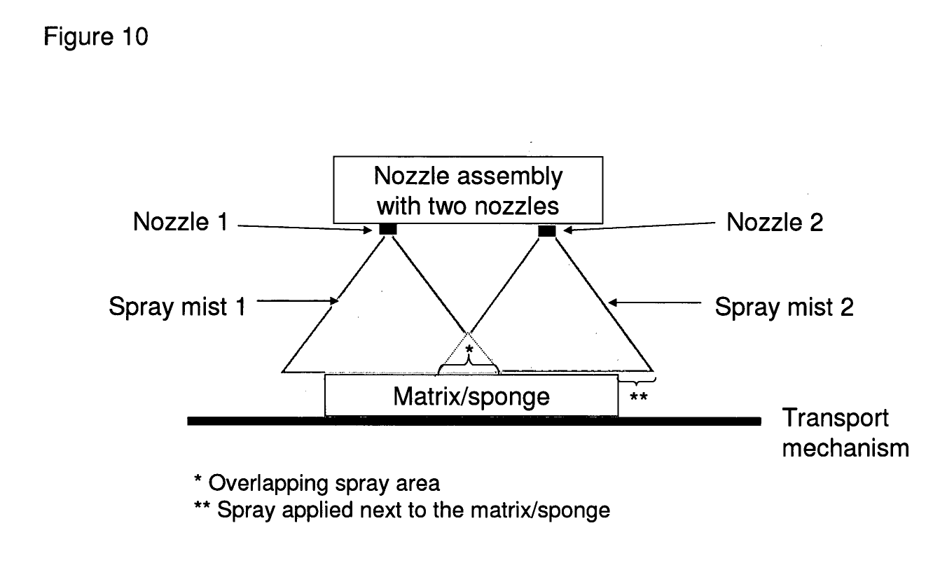

In one preferred embodiment of the present invention, all the transport mechanisms are vacuum conveyor belts (FIG. 10).

In one preferred embodiment, the matrices/sponges have a surface area of 7 cm², 50 cm² or 100 cm².

The one or more matrices are positioned on the transport mechanism in one single line or in several parallel lines, such as 2 parallel lines, for example 3 parallel lines, such as 4 parallel lines, for example 5 parallel lines. Optionally, the one or more matrices/sponges are positioned as described immediately above on the more than one transport mechanisms running in parallel, for example 2 transport mechanisms, such as 3 transport mechanisms, for example 4 transport mechanisms. In a preferred embodiment, the optimal application zone is at the centre of the transport mechanism and the optimal positioning of the sponges is achieved by aligning the positioned sponges with an “application zone guide”.

In one embodiment of the invention, the application zone is as far as possible away from the centre of the transport mechanisms.

The position and orientation of the one or more matrices/sponges may be controlled and if necessary corrected until the positioning conditions of the particular matrix/sponge size and type are satisfied. The correctly oriented and positioned matrices/sponges are then fixated to this position. In one embodiment, the position and orientation of the matrices/sponges are fixated by applying a square or rectangular heavy object such as a heavy metal object at either end of the row sponges positioned on the transport mechanism or transport mechanisms. In one embodiment, the correct position and orientation of the matrices/sponges to be coated is fixated using suction. In one embodiment, the correct position and orientation of the matrices/sponges to be coated is fixated using vacuum suction on a vacuum conveyor belt. In the following a row of correctly positioned and oriented matrices or sponges will be referred to as “a batch” of matrices or sponges.

Following positioning and fixation of a batch of matrices or sponges, the ultrasonic spray apparatus is activated and the transport mechanism(s) is (are) then activated. Optionally, the transport mechanism(s) is (are) activated and the ultrasonic spray apparatus is activated either manually or by a sensor placed in an appropriate distance of the ultrasonic spray heads. In one embodiment, an activating sensor is placed such that activation happens when the first matrix or sponge of a batch of matrices or sponges enter the spray chamber. In one embodiment, the ultrasonic spray apparatus is continuously active throughout a work period, which is defined as the period of time between two changes of liquid supply reservoirs containing the pharmaceutical composition.

### Velocity of Transport Mechanism

In one embodiment the velocity of the transport mechanism(s) can be selected from the group consisting of 0.76 m/min, 1.2 m/min, 2.36 m/min and 3.75 m/min.

In one embodiment the velocity of the transport mechanism(s) can be selected from the group consisting of 0.02 m/min to 0.04 m/min, 0.04 m/min to 0.06 m/min, 0.06 m/min to 0.08 m/min, 0.08 m/min to 0.10 m/min, 0.10 m/min to 0.12 m/min, 0.12 m/min to 0.14 m/min, 0.14 m/min to 0.16 m/min, 0.16 m/min to 0.18 m/min, 0.18 m/min to 0.20 m/min, 0.20 m/min to 0.22 m/min, 0.22 m/min to 0.24 m/min, 0.24 m/min to 0.26 m/min, 0.26 m/min to 0.28 m/min, 0.28 m/min to 0.30 m/min, 0.30 m/min to 0.32 m/min, 0.32 m/min to 0.34 m/min, 0.34 m/min to 0.36 m/min, 0.36 m/min to 0.38 m/min, 0.38 m/min to 0.40 m/min, 0.40 m/min to 0.42 m/min, 0.42 m/min to 0.44 m/min, 0.44 m/min to 0.46 m/min, 0.46 m/min to 0.48 m/min, 0.48 m/min to 0.50 m/min, 0.50 m/min to 0.52 m/min, 0.52 m/min to 0.54 m/min, 0.54 m/min to 0.56 m/min, 0.56 m/min to 0.58 m/min, 0.58 m/min to 0.60 m/min, 0.60 m/min to 0.62 m/min, 0.62 m/min to 0.64 m/min, 0.64 m/min to 0.66 m/min, 0.66 m/min to 0.68 m/min, 0.68 m/min to 0.70 m/min, 0.70 m/min to 0.72 m/min, 0.72 m/min to 0.74 m/min, 0.74 m/min to 0.76 m/min, 0.76 m/min to 0.78 m/min, 0.78 m/min to 0.80 m/min, 0.80 m/min to 0.82 m/min, 0.82 m/min to 0.84 m/min, 0.84 m/min to 0.86 m/min, 0.86 m/min to 0.88 m/min, 0.88 m/min to 0.90 m/min, 0.90 m/min to 0.92 m/min, 0.92 m/min to 0.94 m/min, 0.94 m/min to 0.96 m/min, 0.96 m/min to 0.98 m/min, 0.98 m/min to 1.00 m/min, 1.00 m/min to 1.02 m/min, 1.02 m/min to 1.04 m/min, 1.04 m/min to 1.06 m/min, 1.06 m/min to 1.08 m/min, 1.08 m/min to 1.10 m/min, 1.10 m/min to 1.12 m/min, 1.12 m/min to 1.14 m/min, 1.14 m/min to 1.16 m/min, 1.16 m/min to 1.18 m/min, 1.18 m/min to 1.20 m/min, 1.20 m/min to 1.22 m/min, 1.22 m/min to 1.24 m/min, 1.24 m/min to 1.26 m/min, 1.26 m/min to 1.28 m/min, 1.28 m/min to 1.30 m/min, 1.30 m/min to 1.32 m/min, 1.32 m/min to 1.34 m/min, 1.34 m/min to 1.36 m/min, 1.36 m/min to 1.38 m/min, 1.38 m/min to 1.40 m/min, 1.40 m/min to 1.42 m/min, 1.42 m/min to 1.44 m/min, 1.44 m/min to 1.46 m/min, 1.46 m/min to 1.48 m/min, 1.48 m/min to 1.50 m/min, 1.50 m/min to 1.52 m/min, 1.52 m/min to 1.54 m/min, 1.54 m/min to 1.56 m/min, 1.56 m/min to 1.58 m/min, 1.58 m/min to 1.60 m/min, 1.60 m/min to 1.62 m/min, 1.62 m/min to 1.64 m/min, 1.64 m/min to 1.66 m/min, 1.66 m/min to 1.68 m/min, 1.68 m/min to 1.70 m/min, 1.70 m/min to 1.72 m/min, 1.72 m/min to 1.74 m/min, 1.74 m/min to 1.76 m/min, 1.76 m/min to 1.78 m/min, 1.78 m/min to 1.80 m/min, 1.80 m/min to 1.82 m/min, 1.82 m/min to 1.84 m/min, 1.84 m/min to 1.86 m/min, 1.86 m/min to 1.88 m/min, 1.88 m/min to 1.90 m/min, 1.90 m/min to 1.92 m/min, 1.92 m/min to 1.94 m/min, 1.94 m/min to 1.96 m/min, 1.96 m/min to 1.98 m/min, 1.98 m/min to 2.00 m/min, 2.00 m/min to 2.02 m/min, 2.02 m/min to 2.04 m/min, 2.04 m/min to 2.06 m/min, 2.06 m/min to 2.08 m/min, 2.08 m/min to 2.10 m/min, 2.10 m/min to 2.12 m/min, 2.12 m/min to 2.14 m/min, 2.14 m/min to 2.16 m/min, 2.16 m/min to 2.18 m/min, 2.18 m/min to 2.20 m/min, 2.20 m/min to 2.22 m/min, 2.22 m/min to 2.24 m/min, 2.24 m/min to 2.26 m/min, 2.26 m/min to 2.28 m/min, 2.28 m/min to 2.30 m/min, 2.30 m/min to 2.32 m/min, 2.32 m/min to 2.34 m/min, 2.34 m/min to 2.36 m/min, 2.36 m/min to 2.38 m/min, 2.38 m/min to 2.40 m/min, 2.40 m/min to 2.42 m/min, 2.42 m/min to 2.44 m/min, 2.44 m/min to 2.46 m/min, 2.46 m/min to 2.48 m/min, 2.48 m/min to 2.50 m/min, 2.50 m/min to 2.52 m/min, 2.52 m/min to 2.54 m/min, 2.54 m/min to 2.56 m/min, 2.56 m/min to 2.58 m/min, 2.58 m/min to 2.60 m/min, 2.60 m/min to 2.62 m/min, 2.62 m/min to 2.64 m/min, 2.64 m/min to 2.66 m/min, 2.66 m/min to 2.68 m/min, 2.68 m/min to 2.70 m/min, 2.70 m/min to 2.72 m/min, 2.72 m/min to 2.74 m/min, 2.74 m/min to 2.76 m/min, 2.76 m/min to 2.78 m/min, 2.78 m/min to 2.80 m/min, 2.80 m/min to 2.82 m/min, 2.82 m/min to 2.84 m/min, 2.84 m/min to 2.86 m/min, 2.86 m/min to 2.88 m/min, 2.88 m/min to 2.90 m/min, 2.90 m/min to 2.92 m/min, 2.92 m/min to 2.94 m/min, 2.94 m/min to 2.96 m/min, 2.96 m/min to 2.98 m/min, 2.98 m/min to 3.00 m/min, 3.00 m/min to 3.02 m/min, 3.02 m/min to 3.04 m/min, 3.04 m/min to 3.06 m/min, 3.06 m/min to 3.08 m/min, 3.08 m/min to 3.10 m/min, 3.10 m/min to 3.12 m/min, 3.12 m/min to 3.14 m/min, 3.14 m/min to 3.16 m/min, 3.16 m/min to 3.18 m/min, 3.18 m/min to 3.20 m/min, 3.20 m/min to 3.22 m/min, 3.22 m/min to 3.24 m/min, 3.24 m/min to 3.26 m/min, 3.26 m/min to 3.28 m/min, 3.28 m/min to 3.30 m/min, 3.30 m/min to 3.32 m/min, 3.32 m/min to 3.34 m/min, 3.34 m/min to 3.36 m/min, 3.36 m/min to 3.38 m/min, 3.38 m/min to 3.40 m/min, 3.40 m/min to 3.42 m/min, 3.42 m/min to 3.44 m/min, 3.44 m/min to 3.46 m/min, 3.46 m/min to 3.48 m/min, 3.48 m/min to 3.50 m/min, 3.50 m/min to 3.52 m/min, 3.52 m/min to 3.54 m/min, 3.54 m/min to 3.56 m/min, 3.56 m/min to 3.58 m/min, 3.58 m/min to 3.60 m/min, 3.60 m/min to 3.62 m/min, 3.62 m/min to 3.64 m/min, 3.64 m/min to 3.66 m/min, 3.66 m/min to 3.68 m/min, 3.68 m/min to 3.70 m/min, 3.70 m/min to 3.72 m/min, 3.72 m/min to 3.74 m/min, 3.74 m/min to 3.76 m/min, 3.76 m/min to 3.78 m/min, 3.78 m/min to 3.80 m/min, 3.80 m/min to 3.82 m/min, 3.82 m/min to 3.84 m/min, 3.84 m/min to 3.86 m/min, 3.86 m/min to 3.88 m/min, 3.88 m/min to 3.90 m/min, 3.90 m/min to 3.92 m/min, 3.92 m/min to 3.94 m/min, 3.94 m/min to 3.96 m/min, 3.96 m/min to 3.98 m/min, 3.98 m/min to 4.00 m/min, 4.00 m/min to 4.02 m/min, 4.02 m/min to 4.04 m/min, 4.04 m/min to 4.06 m/min, 4.06 m/min to 4.08 m/min, 4.08 m/min to 4.10 m/min, 4.10 m/min to 4.12 m/min, 4.12 m/min to 4.14 m/min, 4.14 m/min to 4.16 m/min, 4.16 m/min to 4.18 m/min, 4.18 m/min to 4.20 m/min, 4.20 m/min to 4.22 m/min, 4.22 m/min to 4.24 m/min, 4.24 m/min to 4.26 m/min, 4.26 m/min to 4.28 m/min, 4.28 m/min to 4.30 m/min, 4.30 m/min to 4.32 m/min, 4.32 m/min to 4.34 m/min, 4.34 m/min to 4.36 m/min, 4.36 m/min to 4.38 m/min, 4.38 m/min to 4.40 m/min, 4.40 m/min to 4.42 m/min, 4.42 m/min to 4.44 m/min, 4.44 m/min to 4.46 m/min, 4.46 m/min to 4.48 m/min, 4.48 m/min to 4.50 m/min, 4.50 m/min to 4.52 m/min, 4.52 m/min to 4.54 m/min, 4.54 m/min to 4.56 m/min, 4.56 m/min to 4.58 m/min, 4.58 m/min to 4.60 m/min, 4.60 m/min to 4.62 m/min, 4.62 m/min to 4.64 m/min, 4.64 m/min to 4.66 m/min, 4.66 m/min to 4.68 m/min, 4.68 m/min to 4.70 m/min, 4.70 m/min to 4.72 m/min, 4.72 m/min to 4.74 m/min, 4.74 m/min to 4.76 m/min, 4.76 m/min to 4.78 m/min, 4.78 m/min to 4.80 m/min, 4.80 m/min to 4.82 m/min, 4.82 m/min to 4.84 m/min, 4.84 m/min to 4.86 m/min, 4.86 m/min to 4.88 m/min, 4.88 m/min to 4.90 m/min, 4.90 m/min to 4.92 m/min, 4.92 m/min to 4.94 m/min, 4.94 m/min to 4.96 m/min, 4.96 m/min to 4.98 m/min, 4.98 m/min to 5.00 m/min, 5.00 m/min to 5.02 m/min, 5.02 m/min to 5.04 m/min, 5.04 m/min to 5.06 m/min, 5.06 m/min to 5.08 m/min, 5.08 m/min to 5.10 m/min, 5.10 m/min to 5.12 m/min, 5.12 m/min to 5.14 m/min, 5.14 m/min to 5.16 m/min, 5.16 m/min to 5.18 m/min, 5.18 m/min to 5.20 m/min, 5.20 m/min to 5.22 m/min, 5.22 m/min to 5.24 m/min, 5.24 m/min to 5.26 m/min, 5.26 m/min to 5.28 m/min, 5.28 m/min to 5.30 m/min, 5.30 m/min to 5.32 m/min, 5.32 m/min to 5.34 m/min, 5.34 m/min to 5.36 m/min, 5.36 m/min to 5.38 m/min, 5.38 m/min to 5.40 m/min, 5.40 m/min to 5.42 m/min, 5.42 m/min to 5.44 m/min, 5.44 m/min to 5.46 m/min, 5.46 m/min to 5.48 m/min, 5.48 m/min to 5.50 m/min, 5.50 m/min to 5.52 m/min, 5.52 m/min to 5.54 m/min, 5.54 m/min to 5.56 m/min, 5.56 m/min to 5.58 m/min, 5.58 m/min to 5.60 m/min, 5.60 m/min to 5.62 m/min, 5.62 m/min to 5.64 m/min, 5.64 m/min to 5.66 m/min, 5.66 m/min to 5.68 m/min, 5.68 m/min to 5.70 m/min, 5.70 m/min to 5.72 m/min, 5.72 m/min to 5.74 m/min, 5.74 m/min to 5.76 m/min, 5.76 m/min to 5.78 m/min, 5.78 m/min to 5.80 m/min, 5.80 m/min to 5.82 m/min, 5.82 m/min to 5.84 m/min, 5.84 m/min to 5.86 m/min, 5.86 m/min to 5.88 m/min, 5.88 m/min to 5.90 m/min, 5.90 m/min to 5.92 m/min, 5.92 m/min to 5.94 m/min, 5.94 m/min to 5.96 m/min, 5.96 m/min to 5.98 m/min, 5.98 m/min to 6.00 m/min, 6.00 m/min to 6.02 m/min, 6.02 m/min to 6.04 m/min, 6.04 m/min to 6.06 m/min, 6.06 m/min to 6.08 m/min, 6.08 m/min to 6.10 m/min, 6.10 m/min to 6.12 m/min, 6.12 m/min to 6.14 m/min, 6.14 m/min to 6.16 m/min, 6.16 m/min to 6.18 m/min, 6.18 m/min to 6.20 m/min, 6.20 m/min to 6.22 m/min, 6.22 m/min to 6.24 m/min, 6.24 m/min to 6.26 m/min, 6.26 m/min to 6.28 m/min, 6.28 m/min to 6.30 m/min, 6.30 m/min to 6.32 m/min, 6.32 m/min to 6.34 m/min, 6.34 m/min to 6.36 m/min, 6.36 m/min to 6.38 m/min, 6.38 m/min to 6.40 m/min, 6.40 m/min to 6.42 m/min, 6.42 m/min to 6.44 m/min, 6.44 m/min to 6.46 m/min, 6.46 m/min to 6.48 m/min, 6.48 m/min to 6.50 m/min, 6.50 m/min to 6.52 m/min, 6.52 m/min to 6.54 m/min, 6.54 m/min to 6.56 m/min, 6.56 m/min to 6.58 m/min, 6.58 m/min to 6.60 m/min, 6.60 m/min to 6.62 m/min, 6.62 m/min to 6.64 m/min, 6.64 m/min to 6.66 m/min, 6.66 m/min to 6.68 m/min, 6.68 m/min to 6.70 m/min, 6.70 m/min to 6.72 m/min, 6.72 m/min to 6.74 m/min, 6.74 m/min to 6.76 m/min, 6.76 m/min to 6.78 m/min, 6.78 m/min to 6.80 m/min, 6.80 m/min to 6.82 m/min, 6.82 m/min to 6.84 m/min, 6.84 m/min to 6.86 m/min, 6.86 m/min to 6.88 m/min, 6.88 m/min to 6.90 m/min, 6.90 m/min to 6.92 m/min, 6.92 m/min to 6.94 m/min, 6.94 m/min to 6.96 m/min, 6.96 m/min to 6.98 m/min, 6.98 m/min to 7.00 m/min, 7.00 m/min to 7.02 m/min, 7.02 m/min to 7.04 m/min, 7.04 m/min to 7.06 m/min, 7.06 m/min to 7.08 m/min, 7.08 m/min to 7.10 m/min, 7.10 m/min to 7.12 m/min, 7.12 m/min to 7.14 m/min, 7.14 m/min to 7.16 m/min, 7.16 m/min to 7.18 m/min, 7.18 m/min to 7.20 m/min, 7.20 m/min to 7.22 m/min, 7.22 m/min to 7.24 m/min, 7.24 m/min to 7.26 m/min, 7.26 m/min to 7.28 m/min, 7.28 m/min to 7.30 m/min, 7.30 m/min to 7.32 m/min, 7.32 m/min to 7.34 m/min, 7.34 m/min to 7.36 m/min, 7.36 m/min to 7.38 m/min, 7.38 m/min to 7.40 m/min, 7.40 m/min to 7.42 m/min, 7.42 m/min to 7.44 m/min, 7.44 m/min to 7.46 m/min, 7.46 m/min to 7.48 m/min, 7.48 m/min to 7.50 m/min, 7.50 m/min to 7.52 m/min, 7.52 m/min to 7.54 m/min, 7.54 m/min to 7.56 m/min, 7.56 m/min to 7.58 m/min, 7.58 m/min to 7.60 m/min, 7.60 m/min to 7.62 m/min, 7.62 m/min to 7.64 m/min, 7.64 m/min to 7.66 m/min, 7.66 m/min to 7.68 m/min, 7.68 m/min to 7.70 m/min, 7.70 m/min to 7.72 m/min, 7.72 m/min to 7.74 m/min, 7.74 m/min to 7.76 m/min, 7.76 m/min to 7.78 m/min, 7.78 m/min to 7.80 m/min, 7.80 m/min to 7.82 m/min, 7.82 m/min to 7.84 m/min, 7.84 m/min to 7.86 m/min, 7.86 m/min to 7.88 m/min, 7.88 m/min to 7.90 m/min, 7.90 m/min to 7.92 m/min, 7.92 m/min to 7.94 m/min, 7.94 m/min to 7.96 m/min, 7.96 m/min to 7.98 m/min, 7.98 m/min to 8.00 m/min, 8.00 m/min to 9.00 m/min, 9.00 m/min to 10.00 m/min, 10.00 m/min to 12.00 m/min, and 12.00 m/min to 15.00 m/min, or any combination of these velocity intervals.

In one embodiment, the density or thickness of coating on the matrices is regulated by regulating the speed of the transport mechanism(s), thus regulating the time during which the surface of the matrices to be coated are exposed to spray mist.

In the following, only one transport mechanism is described. However, it is understood from the description immediately above, that the present invention is not limited to one transport mechanism, but it is within the scope of the invention to employ two or more transport mechanisms in parallel for example 3, such as 4.

After travelling a distance, such as a distance of from 3 to 15 cm, the first matrix of a batch enters the spray chamber (“spray chamber” FIG. 8). In one embodiment, the ultrasonic spray apparatus is activated when the first matrix or sponge of a batch of matrices or sponges enter the spray chamber. In one embodiment, the ultrasonic spray apparatus is active before the first matrix or sponge of a batch enters the spray chamber.

In the spray chamber, each matrix in a batch of matrices entering the spray chamber on the transport mechanism is spray coated i.e. receives a coat of the pharmaceutical composition.

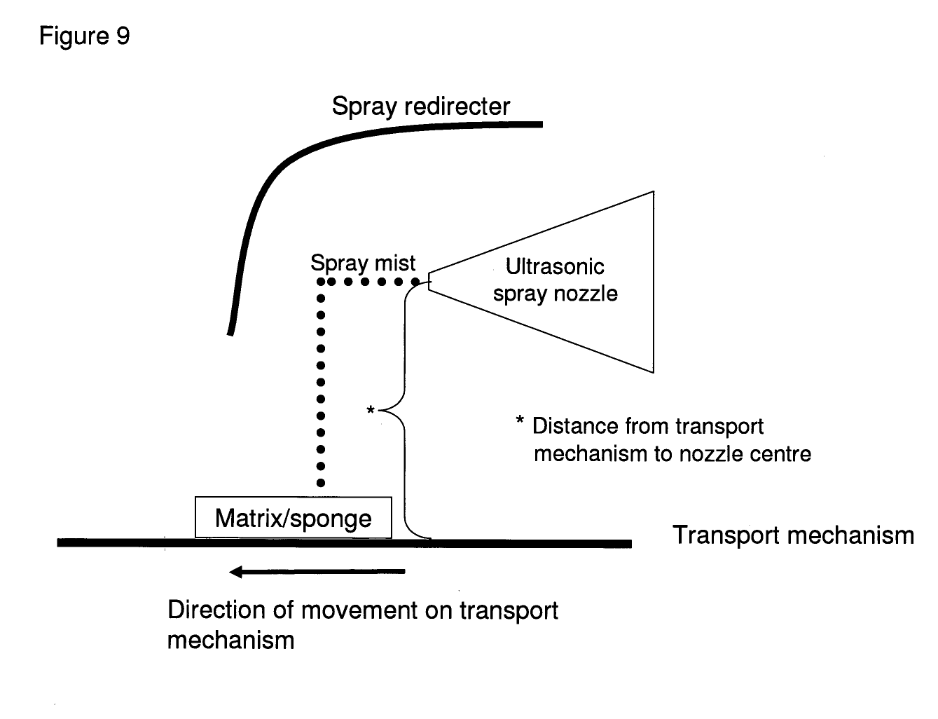

In the spray chamber, the ultrasonic spray apparatus delivers the atomized spray mist by means of a spray nozzle assembly consisting of two or more independent spray nozzles (e.g. spray nozzle 1 and spray nozzle 2—an illustration with two spray nozzles is shown in FIGS. 9 and 10). Each one or more spray nozzles of a nozzle assembly has independent supply lines i.e. independent liquid feed tubes and independent supply reservoirs. In a preferred embodiment, the two or more independent supply reservoirs supplying the individual ultrasonic spray nozzles (e.g. ultrasonic spray nozzles 1 and 2) contain pharmaceutical compositions. In one embodiment, the two or more independent supply reservoirs supplying the individual ultrasonic spray nozzles (e.g. ultrasonic spray nozzles 1 and 2) contain different pharmaceutical compositions.

### Flow Rate 1

In one embodiment, each of the independent supply lines delivers the pharmaceutical composition separately to each spray nozzle with a controlled flow rate by means of a pump. In one preferred embodiment, each supply line is acted upon by a separate pump.

In one embodiment, the first flow rate (Flow rate 1) regarding pharmaceutical compositions delivered to spray nozzle 1 can be 1.4 ml/min or 5.37 ml/min.

The first flow rate (Flow rate 1) can in one embodiment be selected from the group consisting of 0.02 ml/min to 0.04 ml/min, 0.04 ml/min to 0.06 ml/min, 0.06 ml/min to 0.08 ml/min, 0.08 ml/min to 0.10 ml/min, 0.10 ml/min to 0.12 ml/min, 0.12 ml/min to 0.14 ml/min, 0.14 ml/min to 0.16 ml/min, 0.16 ml/min to 0.18 ml/min, 0.18 ml/min to 0.20 ml/min, 0.20 ml/min to 0.22 ml/min, 0.22 ml/min to 0.24 ml/min, 0.24 ml/min to 0.26 ml/min, 0.26 ml/min to 0.28 ml/min, 0.28 ml/min to 0.30 ml/min, 0.30 ml/min to 0.32 ml/min, 0.32 ml/min to 0.34 ml/min, 0.34 ml/min to 0.36 ml/min, 0.36 ml/min to 0.38 ml/min, 0.38 ml/min to 0.40 ml/min, 0.40 ml/min to 0.42 ml/min, 0.42 ml/min to 0.44 ml/min, 0.44 ml/min to 0.46 ml/min, 0.46 ml/min to 0.48 ml/min, 0.48 ml/min to 0.50 ml/min, 0.50 ml/min to 0.52 ml/min, 0.52 ml/min to 0.54 ml/min, 0.54 ml/min to 0.56 ml/min, 0.56 ml/min to 0.58 ml/min, 0.58 ml/min to 0.60 ml/min, 0.60 ml/min to 0.62 ml/min, 0.62 ml/min to 0.64 ml/min, 0.64 ml/min to 0.66 ml/min, 0.66 ml/min to 0.68 ml/min, 0.68 ml/min to 0.70 ml/min, 0.70 ml/min to 0.72 ml/min, 0.72 ml/min to 0.74 ml/min, 0.74 ml/min to 0.76 ml/min, 0.76 ml/min to 0.78 ml/min, 0.78 ml/min to 0.80 ml/min, 0.80 ml/min to 0.82 ml/min, 0.82 ml/min to 0.84 ml/min, 0.84 ml/min to 0.86 ml/min, 0.86 ml/min to 0.88 ml/min, 0.88 ml/min to 0.90 ml/min, 0.90 ml/min to 0.92 ml/min, 0.92 ml/min to 0.94 ml/min, 0.94 ml/min to 0.96 ml/min, 0.96 ml/min to 0.98 ml/min, 0.98 ml/min to 1.00 ml/min, 1.00 ml/min to 1.02 ml/min, 1.02 ml/min to 1.04 ml/min, 1.04 ml/min to 1.06 ml/min, 1.06 ml/min to 1.08 ml/min, 1.08 ml/min to 1.10 ml/min, 1.10 ml/min to 1.12 ml/min, 1.12 ml/min to 1.14 ml/min, 1.14 ml/min to 1.16 ml/min, 1.16 ml/min to 1.18 ml/min, 1.18 ml/min to 1.20 ml/min, 1.20 ml/min to 1.22 ml/min, 1.22 ml/min to 1.24 ml/min, 1.24 ml/min to 1.26 ml/min, 1.26 ml/min to 1.28 ml/min, 1.28 ml/min to 1.30 ml/min, 1.30 ml/min to 1.32 ml/min, 1.32 ml/min to 1.34 ml/min, 1.34 ml/min to 1.36 ml/min, 1.36 ml/min to 1.38 ml/min, 1.38 ml/min to 1.40 ml/min, 1.40 ml/min to 1.42 ml/min, 1.42 ml/min to 1.44 ml/min, 1.44 ml/min to 1.46 ml/min, 1.46 ml/min to 1.48 ml/min, 1.48 ml/min to 1.50 ml/min, 1.50 ml/min to 1.52 ml/min, 1.52 ml/min to 1.54 ml/min, 1.54 ml/min to 1.56 ml/min, 1.56 ml/min to 1.58 ml/min, 1.58 ml/min to 1.60 ml/min, 1.60 ml/min to 1.62 ml/min, 1.62 ml/min to 1.64 ml/min, 1.64 ml/min to 1.66 ml/min, 1.66 ml/min to 1.68 ml/min, 1.68 ml/min to 1.70 ml/min, 1.70 ml/min to 1.72 ml/min, 1.72 ml/min to 1.74 ml/min, 1.74 ml/min to 1.76 ml/min, 1.76 ml/min to 1.78 ml/min, 1.78 ml/min to 1.80 ml/min, 1.80 ml/min to 1.82 ml/min, 1.82 ml/min to 1.84 ml/min, 1.84 ml/min to 1.86 ml/min, 1.86 ml/min to 1.88 ml/min, 1.88 ml/min to 1.90 ml/min, 1.90 ml/min to 1.92 ml/min, 1.92 ml/min to 1.94 ml/min, 1.94 ml/min to 1.96 ml/min, 1.96 ml/min to 1.98 ml/min, 1.98 ml/min to 2.00 ml/min, 2.00 ml/min to 2.02 ml/min, 2.02 ml/min to 2.04 ml/min, 2.04 ml/min to 2.06 ml/min, 2.06 ml/min to 2.08 ml/min, 2.08 ml/min to 2.10 ml/min, 2.10 ml/min to 2.12 ml/min, 2.12 ml/min to 2.14 ml/min, 2.14 ml/min to 2.16 ml/min, 2.16 ml/min to 2.18 ml/min, 2.18 ml/min to 2.20 ml/min, 2.20 ml/min to 2.22 ml/min, 2.22 ml/min to 2.24 ml/min, 2.24 ml/min to 2.26 ml/min, 2.26 ml/min to 2.28 ml/min, 2.28 ml/min to 2.30 ml/min, 2.30 ml/min to 2.32 ml/min, 2.32 ml/min to 2.34 ml/min, 2.34 ml/min to 2.36 ml/min, 2.36 ml/min to 2.38 ml/min, 2.38 ml/min to 2.40 ml/min, 2.40 ml/min to 2.42 ml/min, 2.42 ml/min to 2.44 ml/min, 2.44 ml/min to 2.46 ml/min, 2.46 ml/min to 2.48 ml/min, 2.48 ml/min to 2.50 ml/min, 2.50 ml/min to 2.52 ml/min, 2.52 ml/min to 2.54 ml/min, 2.54 ml/min to 2.56 ml/min, 2.56 ml/min to 2.58 ml/min, 2.58 ml/min to 2.60 ml/min, 2.60 ml/min to 2.62 ml/min, 2.62 ml/min to 2.64 ml/min, 2.64 ml/min to 2.66 ml/min, 2.66 ml/min to 2.68 ml/min, 2.68 ml/min to 2.70 ml/min, 2.70 ml/min to 2.72 ml/min, 2.72 ml/min to 2.74 ml/min, 2.74 ml/min to 2.76 ml/min, 2.76 ml/min to 2.78 ml/min, 2.78 ml/min to 2.80 ml/min, 2.80 ml/min to 2.82 ml/min, 2.82 ml/min to 2.84 ml/min, 2.84 ml/min to 2.86 ml/min, 2.86 ml/min to 2.88 ml/min, 2.88 ml/min to 2.90 ml/min, 2.90 ml/min to 2.92 ml/min, 2.92 ml/min to 2.94 ml/min, 2.94 ml/min to 2.96 ml/min, 2.96 ml/min to 2.98 ml/min, 2.98 ml/min to 3.00 ml/min, 3.00 ml/min to 3.02 ml/min, 3.02 ml/min to 3.04 ml/min, 3.04 ml/min to 3.06 ml/min, 3.06 ml/min to 3.08 ml/min, 3.08 ml/min to 3.10 ml/min, 3.10 ml/min to 3.12 ml/min, 3.12 ml/min to 3.14 ml/min, 3.14 ml/min to 3.16 ml/min, 3.16 ml/min to 3.18 ml/min, 3.18 ml/min to 3.20 ml/min, 3.20 ml/min to 3.22 ml/min, 3.22 ml/min to 3.24 ml/min, 3.24 ml/min to 3.26 ml/min, 3.26 ml/min to 3.28 ml/min, 3.28 ml/min to 3.30 ml/min, 3.30 ml/min to 3.32 ml/min, 3.32 ml/min to 3.34 ml/min, 3.34 ml/min to 3.36 ml/min, 3.36 ml/min to 3.38 ml/min, 3.38 ml/min to 3.40 ml/min, 3.40 ml/min to 3.42 ml/min, 3.42 ml/min to 3.44 ml/min, 3.44 ml/min to 3.46 ml/min, 3.46 ml/min to 3.48 ml/min, 3.48 ml/min to 3.50 ml/min, 3.50 ml/min to 3.52 ml/min, 3.52 ml/min to 3.54 ml/min, 3.54 ml/min to 3.56 ml/min, 3.56 ml/min to 3.58 ml/min, 3.58 ml/min to 3.60 ml/min, 3.60 ml/min to 3.62 ml/min, 3.62 ml/min to 3.64 ml/min, 3.64 ml/min to 3.66 ml/min, 3.66 ml/min to 3.68 ml/min, 3.68 ml/min to 3.70 ml/min, 3.70 ml/min to 3.72 ml/min, 3.72 ml/min to 3.74 ml/min, 3.74 ml/min to 3.76 ml/min, 3.76 ml/min to 3.78 ml/min, 3.78 ml/min to 3.80 ml/min, 3.80 ml/min to 3.82 ml/min, 3.82 ml/min to 3.84 ml/min, 3.84 ml/min to 3.86 ml/min, 3.86 ml/min to 3.88 ml/min, 3.88 ml/min to 3.90 ml/min, 3.90 ml/min to 3.92 ml/min, 3.92 ml/min to 3.94 ml/min, 3.94 ml/min to 3.96 ml/min, 3.96 ml/min to 3.98 ml/min, 3.98 ml/min to 4.00 ml/min, 4.00 ml/min to 4.02 ml/min, 4.02 ml/min to 4.04 ml/min, 4.04 ml/min to 4.06 ml/min, 4.06 ml/min to 4.08 ml/min, 4.08 ml/min to 4.10 ml/min, 4.10 ml/min to 4.12 ml/min, 4.12 ml/min to 4.14 ml/min, 4.14 ml/min to 4.16 ml/min, 4.16 ml/min to 4.18 ml/min, 4.18 ml/min to 4.20 ml/min, 4.20 ml/min to 4.22 ml/min, 4.22 ml/min to 4.24 ml/min, 4.24 ml/min to 4.26 ml/min, 4.26 ml/min to 4.28 ml/min, 4.28 ml/min to 4.30 ml/min, 4.30 ml/min to 4.32 ml/min, 4.32 ml/min to 4.34 ml/min, 4.34 ml/min to 4.36 ml/min, 4.36 ml/min to 4.38 ml/min, 4.38 ml/min to 4.40 ml/min, 4.40 ml/min to 4.42 ml/min, 4.42 ml/min to 4.44 ml/min, 4.44 ml/min to 4.46 ml/min, 4.46 ml/min to 4.48 ml/min, 4.48 ml/min to 4.50 ml/min, 4.50 ml/min to 4.52 ml/min, 4.52 ml/min to 4.54 ml/min, 4.54 ml/min to 4.56 ml/min, 4.56 ml/min to 4.58 ml/min, 4.58 ml/min to 4.60 ml/min, 4.60 ml/min to 4.62 ml/min, 4.62 ml/min to 4.64 ml/min, 4.64 ml/min to 4.66 ml/min, 4.66 ml/min to 4.68 ml/min, 4.68 ml/min to 4.70 ml/min, 4.70 ml/min to 4.72 ml/min, 4.72 ml/min to 4.74 ml/min, 4.74 ml/min to 4.76 ml/min, 4.76 ml/min to 4.78 ml/min, 4.78 ml/min to 4.80 ml/min, 4.80 ml/min to 4.82 ml/min, 4.82 ml/min to 4.84 ml/min, 4.84 ml/min to 4.86 ml/min, 4.86 ml/min to 4.88 ml/min, 4.88 ml/min to 4.90 ml/min, 4.90 ml/min to 4.92 ml/min, 4.92 ml/min to 4.94 ml/min, 4.94 ml/min to 4.96 ml/min, 4.96 ml/min to 4.98 ml/min, 4.98 ml/min to 5.00 ml/min, 5.00 ml/min to 5.02 ml/min, 5.02 ml/min to 5.04 ml/min, 5.04 ml/min to 5.06 ml/min, 5.06 ml/min to 5.08 ml/min, 5.08 ml/min to 5.10 ml/min, 5.10 ml/min to 5.12 ml/min, 5.12 ml/min to 5.14 ml/min, 5.14 ml/min to 5.16 ml/min, 5.16 ml/min to 5.18 ml/min, 5.18 ml/min to 5.20 ml/min, 5.20 ml/min to 5.22 ml/min, 5.22 ml/min to 5.24 ml/min, 5.24 ml/min to 5.26 ml/min, 5.26 ml/min to 5.28 ml/min, 5.28 ml/min to 5.30 ml/min, 5.30 ml/min to 5.32 ml/min, 5.32 ml/min to 5.34 ml/min, 5.34 ml/min to 5.36 ml/min, 5.36 ml/min to 5.38 ml/min, 5.38 ml/min to 5.40 ml/min, 5.40 ml/min to 5.42 ml/min, 5.42 ml/min to 5.44 ml/min, 5.44 ml/min to 5.46 ml/min, 5.46 ml/min to 5.48 ml/min, 5.48 ml/min to 5.50 ml/min, 5.50 ml/min to 5.52 ml/min, 5.52 ml/min to 5.54 ml/min, 5.54 ml/min to 5.56 ml/min, 5.56 ml/min to 5.58 ml/min, 5.58 ml/min to 5.60 ml/min, 5.60 ml/min to 5.62 ml/min, 5.62 ml/min to 5.64 ml/min, 5.64 ml/min to 5.66 ml/min, 5.66 ml/min to 5.68 ml/min, 5.68 ml/min to 5.70 ml/min, 5.70 ml/min to 5.72 ml/min, 5.72 ml/min to 5.74 ml/min, 5.74 ml/min to 5.76 ml/min, 5.76 ml/min to 5.78 ml/min, 5.78 ml/min to 5.80 ml/min, 5.80 ml/min to 5.82 ml/min, 5.82 ml/min to 5.84 ml/min, 5.84 ml/min to 5.86 ml/min, 5.86 ml/min to 5.88 ml/min, 5.88 ml/min to 5.90 ml/min, 5.90 ml/min to 5.92 ml/min, 5.92 ml/min to 5.94 ml/min, 5.94 ml/min to 5.96 ml/min, 5.96 ml/min to 5.98 ml/min, 5.98 ml/min to 6.00 ml/min, 6.00 ml/min to 6.02 ml/min, 6.02 ml/min to 6.04 ml/min, 6.04 ml/min to 6.06 ml/min, 6.06 ml/min to 6.08 ml/min, 6.08 ml/min to 6.10 ml/min, 6.10 ml/min to 6.12 ml/min, 6.12 ml/min to 6.14 ml/min, 6.14 ml/min to 6.16 ml/min, 6.16 ml/min to 6.18 ml/min, 6.18 ml/min to 6.20 ml/min, 6.20 ml/min to 6.22 ml/min, 6.22 ml/min to 6.24 ml/min, 6.24 ml/min to 6.26 ml/min, 6.26 ml/min to 6.28 ml/min, 6.28 ml/min to 6.30 ml/min, 6.30 ml/min to 6.32 ml/min, 6.32 ml/min to 6.34 ml/min, 6.34 ml/min to 6.36 ml/min, 6.36 ml/min to 6.38 ml/min, 6.38 ml/min to 6.40 ml/min, 6.40 ml/min to 6.42 ml/min, 6.42 ml/min to 6.44 ml/min, 6.44 ml/min to 6.46 ml/min, 6.46 ml/min to 6.48 ml/min, 6.48 ml/min to 6.50 ml/min, 6.50 ml/min to 6.52 ml/min, 6.52 ml/min to 6.54 ml/min, 6.54 ml/min to 6.56 ml/min, 6.56 ml/min to 6.58 ml/min, 6.58 ml/min to 6.60 ml/min, 6.60 ml/min to 6.62 ml/min, 6.62 ml/min to 6.64 ml/min, 6.64 ml/min to 6.66 ml/min, 6.66 ml/min to 6.68 ml/min, 6.68 ml/min to 6.70 ml/min, 6.70 ml/min to 6.72 ml/min, 6.72 ml/min to 6.74 ml/min, 6.74 ml/min to 6.76 ml/min, 6.76 ml/min to 6.78 ml/min, 6.78 ml/min to 6.80 ml/min, 6.80 ml/min to 6.82 ml/min, 6.82 ml/min to 6.84 ml/min, 6.84 ml/min to 6.86 ml/min, 6.86 ml/min to 6.88 ml/min, 6.88 ml/min to 6.90 ml/min, 6.90 ml/min to 6.92 ml/min, 6.92 ml/min to 6.94 ml/min, 6.94 ml/min to 6.96 ml/min, 6.96 ml/min to 6.98 ml/min, 6.98 ml/min to 7.00 ml/min, 7.00 ml/min to 7.02 ml/min, 7.02 ml/min to 7.04 ml/min, 7.04 ml/min to 7.06 ml/min, 7.06 ml/min to 7.08 ml/min, 7.08 ml/min to 7.10 ml/min, 7.10 ml/min to 7.12 ml/min, 7.12 ml/min to 7.14 ml/min, 7.14 ml/min to 7.16 ml/min, 7.16 ml/min to 7.18 ml/min, 7.18 ml/min to 7.20 ml/min, 7.20 ml/min to 7.22 ml/min, 7.22 ml/min to 7.24 ml/min, 7.24 ml/min to 7.26 ml/min, 7.26 ml/min to 7.28 ml/min, 7.28 ml/min to 7.30 ml/min, 7.30 ml/min to 7.32 ml/min, 7.32 ml/min to 7.34 ml/min, 7.34 ml/min to 7.36 ml/min, 7.36 ml/min to 7.38 ml/min, 7.38 ml/min to 7.40 ml/min, 7.40 ml/min to 7.42 ml/min, 7.42 ml/min to 7.44 ml/min, 7.44 ml/min to 7.46 ml/min, 7.46 ml/min to 7.48 ml/min, 7.48 ml/min to 7.50 ml/min, 7.50 ml/min to 7.52 ml/min, 7.52 ml/min to 7.54 ml/min, 7.54 ml/min to 7.56 ml/min, 7.56 ml/min to 7.58 ml/min, 7.58 ml/min to 7.60 ml/min, 7.60 ml/min to 7.62 ml/min, 7.62 ml/min to 7.64 ml/min, 7.64 ml/min to 7.66 ml/min, 7.66 ml/min to 7.68 ml/min, 7.68 ml/min to 7.70 ml/min, 7.70 ml/min to 7.72 ml/min, 7.72 ml/min to 7.74 ml/min, 7.74 ml/min to 7.76 ml/min, 7.76 ml/min to 7.78 ml/min, 7.78 ml/min to 7.80 ml/min, 7.80 ml/min to 7.82 ml/min, 7.82 ml/min to 7.84 ml/min, 7.84 ml/min to 7.86 ml/min, 7.86 ml/min to 7.88 ml/min, 7.88 ml/min to 7.90 ml/min, 7.90 ml/min to 7.92 ml/min, 7.92 ml/min to 7.94 ml/min, 7.94 ml/min to 7.96 ml/min, 7.96 ml/min to 7.98 ml/min, 7.98 ml/min to 8.00 ml/min, 8.00 ml/min to 9.00 ml/min, 9.00 ml/min to 10.00 ml/min, 10.00 ml/min to 12.00 ml/min, and 12.00 ml/min to 15.00 ml/min, or any combination of these flow rate intervals.

### Flow Rate 2

In one embodiment, the second flow rate (Flow rate 2) regarding the pharmaceutical composition delivered to spray nozzle 2 can be 1.4 ml/min or 5.37 ml/min.

The first flow rate and the second flow rate can be identical or different to each other.

The second flow rate (Flow rate 2) can in one embodiment be selected from the group consisting of 0.02 ml/min to 0.04 ml/min, 0.04 ml/min to 0.06 ml/min, 0.06 ml/min to 0.08 ml/min, 0.08 ml/min to 0.10 ml/min, 0.10 ml/min to 0.12 ml/min, 0.12 ml/min to 0.14 ml/min, 0.14 ml/min to 0.16 ml/min, 0.16 ml/min to 0.18 ml/min, 0.18 ml/min to 0.20 ml/min, 0.20 ml/min to 0.22 ml/min, 0.22 ml/min to 0.24 ml/min, 0.24 ml/min to 0.26 ml/min, 0.26 ml/min to 0.28 ml/min, 0.28 ml/min to 0.30 ml/min, 0.30 ml/min to 0.32 ml/min, 0.32 ml/min to 0.34 ml/min, 0.34 ml/min to 0.36 ml/min, 0.36 ml/min to 0.38 ml/min, 0.38 ml/min to 0.40 ml/min, 0.40 ml/min to 0.42 ml/min, 0.42 ml/min to 0.44 ml/min, 0.44 ml/min to 0.46 ml/min, 0.46 ml/min to 0.48 ml/min, 0.48 ml/min to 0.50 ml/min, 0.50 ml/min to 0.52 ml/min, 0.52 ml/min to 0.54 ml/min, 0.54 ml/min to 0.56 ml/min, 0.56 ml/min to 0.58 ml/min, 0.58 ml/min to 0.60 ml/min, 0.60 ml/min to 0.62 ml/min, 0.62 ml/min to 0.64 ml/min, 0.64 ml/min to 0.66 ml/min, 0.66 ml/min to 0.68 ml/min, 0.68 ml/min to 0.70 ml/min, 0.70 ml/min to 0.72 ml/min, 0.72 ml/min to 0.74 ml/min, 0.74 ml/min to 0.76 ml/min, 0.76 ml/min to 0.78 ml/min, 0.78 ml/min to 0.80 ml/min, 0.80 ml/min to 0.82 ml/min, 0.82 ml/min to 0.84 ml/min, 0.84 ml/min to 0.86 ml/min, 0.86 ml/min to 0.88 ml/min, 0.88 ml/min to 0.90 ml/min, 0.90 ml/min to 0.92 ml/min, 0.92 ml/min to 0.94 ml/min, 0.94 ml/min to 0.96 ml/min, 0.96 ml/min to 0.98 ml/min, 0.98 ml/min to 1.00 ml/min, 1.00 ml/min to 1.02 ml/min, 1.02 ml/min to 1.04 ml/min, 1.04 ml/min to 1.06 ml/min, 1.06 ml/min to 1.08 ml/min, 1.08 ml/min to 1.10 ml/min, 1.10 ml/min to 1.12 ml/min, 1.12 ml/min to 1.14 ml/min, 1.14 ml/min to 1.16 ml/min, 1.16 ml/min to 1.18 ml/min, 1.18 ml/min to 1.20 ml/min, 1.20 ml/min to 1.22 ml/min, 1.22 ml/min to 1.24 ml/min, 1.24 ml/min to 1.26 ml/min, 1.26 ml/min to 1.28 ml/min, 1.28 ml/min to 1.30 ml/min, 1.30 ml/min to 1.32 ml/min, 1.32 ml/min to 1.34 ml/min, 1.34 ml/min to 1.36 ml/min, 1.36 ml/min to 1.38 ml/min, 1.38 ml/min to 1.40 ml/min, 1.40 ml/min to 1.42 ml/min, 1.42 ml/min to 1.44 ml/min, 1.44 ml/min to 1.46 ml/min, 1.46 ml/min to 1.48 ml/min, 1.48 ml/min to 1.50 ml/min, 1.50 ml/min to 1.52 ml/min, 1.52 ml/min to 1.54 ml/min, 1.54 ml/min to 1.56 ml/min, 1.56 ml/min to 1.58 ml/min, 1.58 ml/min to 1.60 ml/min, 1.60 ml/min to 1.62 ml/min, 1.62 ml/min to 1.64 ml/min, 1.64 ml/min to 1.66 ml/min, 1.66 ml/min to 1.68 ml/min, 1.68 ml/min to 1.70 ml/min, 1.70 ml/min to 1.72 ml/min, 1.72 ml/min to 1.74 ml/min, 1.74 ml/min to 1.76 ml/min, 1.76 ml/min to 1.78 ml/min, 1.78 ml/min to 1.80 ml/min, 1.80 ml/min to 1.82 ml/min, 1.82 ml/min to 1.84 ml/min, 1.84 ml/min to 1.86 ml/min, 1.86 ml/min to 1.88 ml/min, 1.88 ml/min to 1.90 ml/min, 1.90 ml/min to 1.92 ml/min, 1.92 ml/min to 1.94 ml/min, 1.94 ml/min to 1.96 ml/min, 1.96 ml/min to 1.98 ml/min, 1.98 ml/min to 2.00 ml/min, 2.00 ml/min to 2.02 ml/min, 2.02 ml/min to 2.04 ml/min, 2.04 ml/min to 2.06 ml/min, 2.06 ml/min to 2.08 ml/min, 2.08 ml/min to 2.10 ml/min, 2.10 ml/min to 2.12 ml/min, 2.12 ml/min to 2.14 ml/min, 2.14 ml/min to 2.16 ml/min, 2.16 ml/min to 2.18 ml/min, 2.18 ml/min to 2.20 ml/min, 2.20 ml/min to 2.22 ml/min, 2.22 ml/min to 2.24 ml/min, 2.24 ml/min to 2.26 ml/min, 2.26 ml/min to 2.28 ml/min, 2.28 ml/min to 2.30 ml/min, 2.30 ml/min to 2.32 ml/min, 2.32 ml/min to 2.34 ml/min, 2.34 ml/min to 2.36 ml/min, 2.36 ml/min to 2.38 ml/min, 2.38 ml/min to 2.40 ml/min, 2.40 ml/min to 2.42 ml/min, 2.42 ml/min to 2.44 ml/min, 2.44 ml/min to 2.46 ml/min, 2.46 ml/min to 2.48 ml/min, 2.48 ml/min to 2.50 ml/min, 2.50 ml/min to 2.52 ml/min, 2.52 ml/min to 2.54 ml/min, 2.54 ml/min to 2.56 ml/min, 2.56 ml/min to 2.58 ml/min, 2.58 ml/min to 2.60 ml/min, 2.60 ml/min to 2.62 ml/min, 2.62 ml/min to 2.64 ml/min, 2.64 ml/min to 2.66 ml/min, 2.66 ml/min to 2.68 ml/min, 2.68 ml/min to 2.70 ml/min, 2.70 ml/min to 2.72 ml/min, 2.72 ml/min to 2.74 ml/min, 2.74 ml/min to 2.76 ml/min, 2.76 ml/min to 2.78 ml/min, 2.78 ml/min to 2.80 ml/min, 2.80 ml/min to 2.82 ml/min, 2.82 ml/min to 2.84 ml/min, 2.84 ml/min to 2.86 ml/min, 2.86 ml/min to 2.88 ml/min, 2.88 ml/min to 2.90 ml/min, 2.90 ml/min to 2.92 ml/min, 2.92 ml/min to 2.94 ml/min, 2.94 ml/min to 2.96 ml/min, 2.96 ml/min to 2.98 ml/min, 2.98 ml/min to 3.00 ml/min, 3.00 ml/min to 3.02 ml/min, 3.02 ml/min to 3.04 ml/min, 3.04 ml/min to 3.06 ml/min, 3.06 ml/min to 3.08 ml/min, 3.08 ml/min to 3.10 ml/min, 3.10 ml/min to 3.12 ml/min, 3.12 ml/min to 3.14 ml/min, 3.14 ml/min to 3.16 ml/min, 3.16 ml/min to 3.18 ml/min, 3.18 ml/min to 3.20 ml/min, 3.20 ml/min to 3.22 ml/min, 3.22 ml/min to 3.24 ml/min, 3.24 ml/min to 3.26 ml/min, 3.26 ml/min to 3.28 ml/min, 3.28 ml/min to 3.30 ml/min, 3.30 ml/min to 3.32 ml/min, 3.32 ml/min to 3.34 ml/min, 3.34 ml/min to 3.36 ml/min, 3.36 ml/min to 3.38 ml/min, 3.38 ml/min to 3.40 ml/min, 3.40 ml/min to 3.42 ml/min, 3.42 ml/min to 3.44 ml/min, 3.44 ml/min to 3.46 ml/min, 3.46 ml/min to 3.48 ml/min, 3.48 ml/min to 3.50 ml/min, 3.50 ml/min to 3.52 ml/min, 3.52 ml/min to 3.54 ml/min, 3.54 ml/min to 3.56 ml/min, 3.56 ml/min to 3.58 ml/min, 3.58 ml/min to 3.60 ml/min, 3.60 ml/min to 3.62 ml/min, 3.62 ml/min to 3.64 ml/min, 3.64 ml/min to 3.66 ml/min, 3.66 ml/min to 3.68 ml/min, 3.68 ml/min to 3.70 ml/min, 3.70 ml/min to 3.72 ml/min, 3.72 ml/min to 3.74 ml/min, 3.74 ml/min to 3.76 ml/min, 3.76 ml/min to 3.78 ml/min, 3.78 ml/min to 3.80 ml/min, 3.80 ml/min to 3.82 ml/min, 3.82 ml/min to 3.84 ml/min, 3.84 ml/min to 3.86 ml/min, 3.86 ml/min to 3.88 ml/min, 3.88 ml/min to 3.90 ml/min, 3.90 ml/min to 3.92 ml/min, 3.92 ml/min to 3.94 ml/min, 3.94 ml/min to 3.96 ml/min, 3.96 ml/min to 3.98 ml/min, 3.98 ml/min to 4.00 ml/min, 4.00 ml/min to 4.02 ml/min, 4.02 ml/min to 4.04 ml/min, 4.04 ml/min to 4.06 ml/min, 4.06 ml/min to 4.08 ml/min, 4.08 ml/min to 4.10 ml/min, 4.10 ml/min to 4.12 ml/min, 4.12 ml/min to 4.14 ml/min, 4.14 ml/min to 4.16 ml/min, 4.16 ml/min to 4.18 ml/min, 4.18 ml/min to 4.20 ml/min, 4.20 ml/min to 4.22 ml/min, 4.22 ml/min to 4.24 ml/min, 4.24 ml/min to 4.26 ml/min, 4.26 ml/min to 4.28 ml/min, 4.28 ml/min to 4.30 ml/min, 4.30 ml/min to 4.32 ml/min, 4.32 ml/min to 4.34 ml/min, 4.34 ml/min to 4.36 ml/min, 4.36 ml/min to 4.38 ml/min, 4.38 ml/min to 4.40 ml/min, 4.40 ml/min to 4.42 ml/min, 4.42 ml/min to 4.44 ml/min, 4.44 ml/min to 4.46 ml/min, 4.46 ml/min to 4.48 ml/min, 4.48 ml/min to 4.50 ml/min, 4.50 ml/min to 4.52 ml/min, 4.52 ml/min to 4.54 ml/min, 4.54 ml/min to 4.56 ml/min, 4.56 ml/min to 4.58 ml/min, 4.58 ml/min to 4.60 ml/min, 4.60 ml/min to 4.62 ml/min, 4.62 ml/min to 4.64 ml/min, 4.64 ml/min to 4.66 ml/min, 4.66 ml/min to 4.68 ml/min, 4.68 ml/min to 4.70 ml/min, 4.70 ml/min to 4.72 ml/min, 4.72 ml/min to 4.74 ml/min, 4.74 ml/min to 4.76 ml/min, 4.76 ml/min to 4.78 ml/min, 4.78 ml/min to 4.80 ml/min, 4.80 ml/min to 4.82 ml/min, 4.82 ml/min to 4.84 ml/min, 4.84 ml/min to 4.86 ml/min, 4.86 ml/min to 4.88 ml/min, 4.88 ml/min to 4.90 ml/min, 4.90 ml/min to 4.92 ml/min, 4.92 ml/min to 4.94 ml/min, 4.94 ml/min to 4.96 ml/min, 4.96 ml/min to 4.98 ml/min, 4.98 ml/min to 5.00 ml/min, 5.00 ml/min to 5.02 ml/min, 5.02 ml/min to 5.04 ml/min, 5.04 ml/min to 5.06 ml/min, 5.06 ml/min to 5.08 ml/min, 5.08 ml/min to 5.10 ml/min, 5.10 ml/min to 5.12 ml/min, 5.12 ml/min to 5.14 ml/min, 5.14 ml/min to 5.16 ml/min, 5.16 ml/min to 5.18 ml/min, 5.18 ml/min to 5.20 ml/min, 5.20 ml/min to 5.22 ml/min, 5.22 ml/min to 5.24 ml/min, 5.24 ml/min to 5.26 ml/min, 5.26 ml/min to 5.28 ml/min, 5.28 ml/min to 5.30 ml/min, 5.30 ml/min to 5.32 ml/min, 5.32 ml/min to 5.34 ml/min, 5.34 ml/min to 5.36 ml/min, 5.36 ml/min to 5.38 ml/min, 5.38 ml/min to 5.40 ml/min, 5.40 ml/min to 5.42 ml/min, 5.42 ml/min to 5.44 ml/min, 5.44 ml/min to 5.46 ml/min, 5.46 ml/min to 5.48 ml/min, 5.48 ml/min to 5.50 ml/min, 5.50 ml/min to 5.52 ml/min, 5.52 ml/min to 5.54 ml/min, 5.54 ml/min to 5.56 ml/min, 5.56 ml/min to 5.58 ml/min, 5.58 ml/min to 5.60 ml/min, 5.60 ml/min to 5.62 ml/min, 5.62 ml/min to 5.64 ml/min, 5.64 ml/min to 5.66 ml/min, 5.66 ml/min to 5.68 ml/min, 5.68 ml/min to 5.70 ml/min, 5.70 ml/min to 5.72 ml/min, 5.72 ml/min to 5.74 ml/min, 5.74 ml/min to 5.76 ml/min, 5.76 ml/min to 5.78 ml/min, 5.78 ml/min to 5.80 ml/min, 5.80 ml/min to 5.82 ml/min, 5.82 ml/min to 5.84 ml/min, 5.84 ml/min to 5.86 ml/min, 5.86 ml/min to 5.88 ml/min, 5.88 ml/min to 5.90 ml/min, 5.90 ml/min to 5.92 ml/min, 5.92 ml/min to 5.94 ml/min, 5.94 ml/min to 5.96 ml/min, 5.96 ml/min to 5.98 ml/min, 5.98 ml/min to 6.00 ml/min, 6.00 ml/min to 6.02 ml/min, 6.02 ml/min to 6.04 ml/min, 6.04 ml/min to 6.06 ml/min, 6.06 ml/min to 6.08 ml/min, 6.08 ml/min to 6.10 ml/min, 6.10 ml/min to 6.12 ml/min, 6.12 ml/min to 6.14 ml/min, 6.14 ml/min to 6.16 ml/min, 6.16 ml/min to 6.18 ml/min, 6.18 ml/min to 6.20 ml/min, 6.20 ml/min to 6.22 ml/min, 6.22 ml/min to 6.24 ml/min, 6.24 ml/min to 6.26 ml/min, 6.26 ml/min to 6.28 ml/min, 6.28 ml/min to 6.30 ml/min, 6.30 ml/min to 6.32 ml/min, 6.32 ml/min to 6.34 ml/min, 6.34 ml/min to 6.36 ml/min, 6.36 ml/min to 6.38 ml/min, 6.38 ml/min to 6.40 ml/min, 6.40 ml/min to 6.42 ml/min, 6.42 ml/min to 6.44 ml/min, 6.44 ml/min to 6.46 ml/min, 6.46 ml/min to 6.48 ml/min, 6.48 ml/min to 6.50 ml/min, 6.50 ml/min to 6.52 ml/min, 6.52 ml/min to 6.54 ml/min, 6.54 ml/min to 6.56 ml/min, 6.56 ml/min to 6.58 ml/min, 6.58 ml/min to 6.60 ml/min, 6.60 ml/min to 6.62 ml/min, 6.62 ml/min to 6.64 ml/min, 6.64 ml/min to 6.66 ml/min, 6.66 ml/min to 6.68 ml/min, 6.68 ml/min to 6.70 ml/min, 6.70 ml/min to 6.72 ml/min, 6.72 ml/min to 6.74 ml/min, 6.74 ml/min to 6.76 ml/min, 6.76 ml/min to 6.78 ml/min, 6.78 ml/min to 6.80 ml/min, 6.80 ml/min to 6.82 ml/min, 6.82 ml/min to 6.84 ml/min, 6.84 ml/min to 6.86 ml/min, 6.86 ml/min to 6.88 ml/min, 6.88 ml/min to 6.90 ml/min, 6.90 ml/min to 6.92 ml/min, 6.92 ml/min to 6.94 ml/min, 6.94 ml/min to 6.96 ml/min, 6.96 ml/min to 6.98 ml/min, 6.98 ml/min to 7.00 ml/min, 7.00 ml/min to 7.02 ml/min, 7.02 ml/min to 7.04 ml/min, 7.04 ml/min to 7.06 ml/min, 7.06 ml/min to 7.08 ml/min, 7.08 ml/min to 7.10 ml/min, 7.10 ml/min to 7.12 ml/min, 7.12 ml/min to 7.14 ml/min, 7.14 ml/min to 7.16 ml/min, 7.16 ml/min to 7.18 ml/min, 7.18 ml/min to 7.20 ml/min, 7.20 ml/min to 7.22 ml/min, 7.22 ml/min to 7.24 ml/min, 7.24 ml/min to 7.26 ml/min, 7.26 ml/min to 7.28 ml/min, 7.28 ml/min to 7.30 ml/min, 7.30 ml/min to 7.32 ml/min, 7.32 ml/min to 7.34 ml/min, 7.34 ml/min to 7.36 ml/min, 7.36 ml/min to 7.38 ml/min, 7.38 ml/min to 7.40 ml/min, 7.40 ml/min to 7.42 ml/min, 7.42 ml/min to 7.44 ml/min, 7.44 ml/min to 7.46 ml/min, 7.46 ml/min to 7.48 ml/min, 7.48 ml/min to 7.50 ml/min, 7.50 ml/min to 7.52 ml/min, 7.52 ml/min to 7.54 ml/min, 7.54 ml/min to 7.56 ml/min, 7.56 ml/min to 7.58 ml/min, 7.58 ml/min to 7.60 ml/min, 7.60 ml/min to 7.62 ml/min, 7.62 ml/min to 7.64 ml/min, 7.64 ml/min to 7.66 ml/min, 7.66 ml/min to 7.68 ml/min, 7.68 ml/min to 7.70 ml/min, 7.70 ml/min to 7.72 ml/min, 7.72 ml/min to 7.74 ml/min, 7.74 ml/min to 7.76 ml/min, 7.76 ml/min to 7.78 ml/min, 7.78 ml/min to 7.80 ml/min, 7.80 ml/min to 7.82 ml/min, 7.82 ml/min to 7.84 ml/min, 7.84 ml/min to 7.86 ml/min, 7.86 ml/min to 7.88 ml/min, 7.88 ml/min to 7.90 ml/min, 7.90 ml/min to 7.92 ml/min, 7.92 ml/min to 7.94 ml/min, 7.94 ml/min to 7.96 ml/min, 7.96 ml/min to 7.98 ml/min, 7.98 ml/min to 8.00 ml/min, 8.00 ml/min to 9.00 ml/min, 9.00 ml/min to 10.00 ml/min, 10.00 ml/min to 12.00 ml/min, and 12.00 ml/min to 15.00 ml/min, or any combination of these flow rate intervals.

### Cooling of Spray Liquid (Pharmaceutical Composition)

In one embodiment the pharmaceutical composition(s) to be applied by ultrasonic spray technology onto the matrices/sponges is cooled prior to application onto the matrices/sponges. The liquid—such as a thrombin solution—can be cooled to a temperature in the range of from 0° C. to 10° C., such as to from 0° C. to 1° C., for example from 1° C. to 2° C., such as to from 2° C. to 3° C., for example from 3° C. to 4° C., such as to from 4° C. to 5° C., for example from 5° C. to 6° C., such as to from 6° C. to 7° C., for example from 7° C. to 8° C. such as to from 8° C. to 9° C., or for example from 9° C. to 10° C.

In one embodiment the pharmaceutical composition(s) to be coated onto the matrices/sponges is not subjected to cooling but applied at ambient temperature in the range of from 17° C. to 25° C., for example 17° C. to 18° C., such as 18° C. to 19° C., for example 19° C. to 20° C., such as 20° C. to 21° C., for example 21° C. to 22° C., such as 22° C. to 23° C., for example 23° C. to 24° C., such as 24° C. to 25° C.

### Degassing

In one embodiment the pharmaceutical composition(s) supplied to the ultrasonic spray nozzles 1 and 2 have been subjected to one or more degassing treatments. In one embodiment no degassing procedure has been performed on the pharmaceutical composition(s) before supplying it or them to the ultrasonic spray nozzles.

### Jet Force

During operation i.e. active spray coating, the spray mist is in one embodiment ejected horizontally from the atomizing surface of the ultrasonic spray nozzles in a nozzle assembly (FIG. 9). In order to reorient the spray mist 80-85° downwards air streams are generated by a “spray redirector” (FIG. 9) to bend each of the originally horizontal spray beams. These generated air streams are characterized by a “jet force”, which can be the same or different for two or more nozzles in a spray nozzle assembly.

In one preferred embodiment the jet force is 25 l/min. Alternatively, the jet force can be selected from the group of intervals consisting of from 2 l/min to 4 l/min, from 4 l/min to 6 l/min, from 6 l/min to 8 l/min, from 8 l/min to 10 l/min, from 10 l/min to 12 l/min, from 12 l/min to 14 l/min, from 14 l/min to 16 l/min, from 16 l/min to 18 l/min, from 18 l/min to 20 l/min, from 20 l/min to 22 l/min, from 22 l/min to 24 l/min, from 24 l/min to 26 l/min, from 26 l/min to 28 l/min, from 28 l/min to 30 l/min, from 30l/min to 32 l/min, from 32 l/min to 34 l/min, from 34 l/min to 36 l/min, from 36 l/min to 38 l/min, from 38 l/min to 40 l/min, from 40 l/min to 42 l/min, from 42 l/min to 44 l/min, from 44 l/min to 46 l/min, from 46 l/min to 48 l/min, from 48 l/min to 50 l/min, from 50 l/min to 55 l/min, from 55 l/min to 60 l/min, from 65 l/min to 70 l/min, from 75 l/min to 80 l/min, and from 80 l/min to 100 l/min, or any combination of these jet force intervals.

### Nozzle Input Power

During operation i.e. active spray coating, each of the ultrasonic spray nozzles is supplied with—and independently consumes energy in order to atomize the supplied pharmaceutical composition. The energy consumption of two nozzles in an assembly may be identical or non-identical.

In one embodiment the energy consumption “nozzle input power” is 2.8 W or 4 W. Alternatively, the nozzle power can be selected from the group of intervals consisting of from 0.02 W to 0.04 W, from 0.04 W to 0.06 W, from 0.06 W to 0.08 W, from 0.08 W to 0.10 W, from 0.10 W to 0.12 W, from 0.12 W to 0.14 W, from 0.14 W to 0.16 W, from 0.16 W to 0.18 W, from 0.18 W to 0.20 W, from 0.20 W to 0.22 W, from 0.22 W to 0.24 W, from 0.24 W to 0.26 W, from 0.26 W to 0.28 W, from 0.28 W to 0.30 W, from 0.30 W to 0.32 W, from 0.32 W to 0.34 W, from 0.34 W to 0.36 W, from 0.36 W to 0.38 W, from 0.38 W to 0.40 W, from 0.40 W to 0.42 W, from 0.42 W to 0.44 W, from 0.44 W to 0.46 W, from 0.46 W to 0.48 W, from 0.48 W to 0.50 W, from 0.50 W to 0.52 W, from 0.52 W to 0.54 W, from 0.54 W to 0.56 W, from 0.56 W to 0.58 W, from 0.58 W to 0.60 W, from 0.60 W to 0.62 W, from 0.62 W to 0.64 W, from 0.64 W to 0.66 W, from 0.66 W to 0.68 W, from 0.68 W to 0.70 W, from 0.70 W to 0.72 W, from 0.72 W to 0.74 W, from 0.74 W to 0.76 W, from 0.76 W to 0.78 W, from 0.78 W to 0.80 W, from 0.80 W to 0.82 W, from 0.82 W to 0.84 W, from 0.84 W to 0.86 W, from 0.86 W to 0.88 W, from 0.88 W to 0.90 W, from 0.90 W to 0.92 W, from 0.92 W to 0.94 W, from 0.94 W to 0.96 W, from 0.96 W to 0.98 W, from 0.98 W to 1.00 W, from 1.00 W to 1.02 W, from 1.02 W to 1.04 W, from 1.04 W to 1.06 W, from 1.06 W to 1.08 W, from 1.08 W to 1.10 W, from 1.10 W to 1.12 W, from 1.12 W to 1.14 W, from 1.14 W to 1.16 W, from 1.16 W to 1.18 W, from 1.18 W to 1.20 W, from 1.20 W to 1.22 W, from 1.22 W to 1.24 W, from 1.24 W to 1.26 W, from 1.26 W to 1.28 W, from 1.28 W to 1.30 W, from 1.30 W to 1.32 W, from 1.32 W to 1.34 W, from 1.34 W to 1.36 W, from 1.36 W to 1.38 W, from 1.38 W to 1.40 W, from 1.40 W to 1.42 W, from 1.42 W to 1.44 W, from 1.44 W to 1.46 W, from 1.46 W to 1.48 W, from 1.48 W to 1.50 W, from 1.50 W to 1.52 W, from 1.52 W to 1.54 W, from 1.54 W to 1.56 W, from 1.56 W to 1.58 W, from 1.58 W to 1.60 W, from 1.60 W to 1.62 W, from 1.62 W to 1.64 W, from 1.64 W to 1.66 W, from 1.66 W to 1.68 W, from 1.68 W to 1.70 W, from 1.70 W to 1.72 W, from 1.72 W to 1.74 W, from 1.74 W to 1.76 W, from 1.76 W to 1.78 W, from 1.78 W to 1.80 W, from 1.80 W to 1.82 W, from 1.82 W to 1.84 W, from 1.84 W to 1.86 W, from 1.86 W to 1.88 W, from 1.88 W to 1.90 W, from 1.90 W to 1.92 W, from 1.92 W to 1.94 W, from 1.94 W to 1.96 W, from 1.96 W to 1.98 W, from 1.98 W to 2.00 W, from 2.00 W to 2.02 W, from 2.02 W to 2.04 W, from 2.04 W to 2.06 W, from 2.06 W to 2.08 W, from 2.08 W to 2.10 W, from 2.10 W to 2.12 W, from 2.12 W to 2.14 W, from 2.14 W to 2.16 W, from 2.16 W to 2.18 W, from 2.18 W to 2.20 W, from 2.20 W to 2.22 W, from 2.22 W to 2.24 W, from 2.24 W to 2.26 W, from 2.26 W to 2.28 W, from 2.28 W to 2.30 W, from 2.30 W to 2.32 W, from 2.32 W to 2.34 W, from 2.34 W to 2.36 W, from 2.36 W to 2.38 W, from 2.38 W to 2.40 W, from 2.40 W to 2.42 W, from 2.42 W to 2.44 W, from 2.44 W to 2.46 W, from 2.46 W to 2.48 W, from 2.48 W to 2.50 W, from 2.50 W to 2.52 W, from 2.52 W to 2.54 W, from 2.54 W to 2.56 W, from 2.56 W to 2.58 W, from 2.58 W to 2.60 W, from 2.60 W to 2.62 W, from 2.62 W to 2.64 W, from 2.64 W to 2.66 W, from 2.66 W to 2.68 W, from 2.68 W to 2.70 W, from 2.70 W to 2.72 W, from 2.72 W to 2.74 W, from 2.74 W to 2.76 W, from 2.76 W to 2.78 W, from 2.78 W to 2.80 W, from 2.80 W to 2.82 W, from 2.82 W to 2.84 W, from 2.84 W to 2.86 W, from 2.86 W to 2.88 W, from 2.88 W to 2.90 W, from 2.90 W to 2.92 W, from 2.92 W to 2.94 W, from 2.94 W to 2.96 W, from 2.96 W to 2.98 W, from 2.98 W to 3.00 W, from 3.00 W to 3.02 W, from 3.02 W to 3.04 W, from 3.04 W to 3.06 W, from 3.06 W to 3.08 W, from 3.08 W to 3.10 W, from 3.10 W to 3.12 W, from 3.12 W to 3.14 W, from 3.14 W to 3.16 W, from 3.16 W to 3.18 W, from 3.18 W to 3.20 W, from 3.20 W to 3.22 W, from 3.22 W to 3.24 W, from 3.24 W to 3.26 W, from 3.26 W to 3.28 W, from 3.28 W to 3.30 W, from 3.30 W to 3.32 W, from 3.32 W to 3.34 W, from 3.34 W to 3.36 W, from 3.36 W to 3.38 W, from 3.38 W to 3.40 W, from 3.40 W to 3.42 W, from 3.42 W to 3.44 W, from 3.44 W to 3.46 W, from 3.46 W to 3.48 W, from 3.48 W to 3.50 W, from 3.50 W to 3.52 W, from 3.52 W to 3.54 W, from 3.54 W to 3.56 W, from 3.56 W to 3.58 W, from 3.58 W to 3.60 W, from 3.60 W to 3.62 W, from 3.62 W to 3.64 W, from 3.64 W to 3.66 W, from 3.66 W to 3.68 W, from 3.68 W to 3.70 W, from 3.70 W to 3.72 W, from 3.72 W to 3.74 W, from 3.74 W to 3.76 W, from 3.76 W to 3.78 W, from 3.78 W to 3.80 W, from 3.80 W to 3.82 W, from 3.82 W to 3.84 W, from 3.84 W to 3.86 W, from 3.86 W to 3.88 W, from 3.88 W to 3.90 W, from 3.90 W to 3.92 W, from 3.92 W to 3.94 W, from 3.94 W to 3.96 W, from 3.96 W to 3.98 W, from 3.98 W to 4.00 W, from 4.00 W to 4.02 W, from 4.02 W to 4.04 W, from 4.04 W to 4.06 W, from 4.06 W to 4.08 W, from 4.08 W to 4.10 W, from 4.10 W to 4.12 W, from 4.12 W to 4.14 W, from 4.14 W to 4.16 W, from 4.16 W to 4.18 W, from 4.18 W to 4.20 W, from 4.20 W to 4.22 W, from 4.22 W to 4.24 W, from 4.24 W to 4.26 W, from 4.26 W to 4.28 W, from 4.28 W to 4.30 W, from 4.30 W to 4.32 W, from 4.32 W to 4.34 W, from 4.34 W to 4.36 W, from 4.36 W to 4.38 W, from 4.38 W to 4.40 W, from 4.40 W to 4.42 W, from 4.42 W to 4.44 W, from 4.44 W to 4.46 W, from 4.46 W to 4.48 W, from 4.48 W to 4.50 W, from 4.50 W to 4.52 W, from 4.52 W to 4.54 W, from 4.54 W to 4.56 W, from 4.56 W to 4.58 W, from 4.58 W to 4.60 W, from 4.60 W to 4.62 W, from 4.62 W to 4.64 W, from 4.64 W to 4.66 W, from 4.66 W to 4.68 W, from 4.68 W to 4.70 W, from 4.70 W to 4.72 W, from 4.72 W to 4.74 W, from 4.74 W to 4.76 W, from 4.76 W to 4.78 W, from 4.78 W to 4.80 W, from 4.80 W to 4.82 W, from 4.82 W to 4.84 W, from 4.84 W to 4.86 W, from 4.86 W to 4.88 W, from 4.88 W to 4.90 W, from 4.90 W to 4.92 W, from 4.92 W to 4.94 W, from 4.94 W to 4.96 W, from 4.96 W to 4.98 W, from 4.98 W to 5.00 W, from 5.00 W to 5.02 W, from 5.02 W to 5.04 W, from 5.04 W to 5.06 W, from 5.06 W to 5.08 W, from 5.08 W to 5.10 W, from 5.10 W to 5.12 W, from 5.12 W to 5.14 W, from 5.14 W to 5.16 W, from 5.16 W to 5.18 W, from 5.18 W to 5.20 W, from 5.20 W to 5.22 W, from 5.22 W to 5.24 W, from 5.24 W to 5.26 W, from 5.26 W to 5.28 W, from 5.28 W to 5.30 W, from 5.30 W to 5.32 W, from 5.32 W to 5.34 W, from 5.34 W to 5.36 W, from 5.36 W to 5.38 W, from 5.38 W to 5.40 W, from 5.40 W to 5.42 W, from 5.42 W to 5.44 W, from 5.44 W to 5.46 W, from 5.46 W to 5.48 W, from 5.48 W to 5.50 W, from 5.50 W to 5.52 W, from 5.52 W to 5.54 W, from 5.54 W to 5.56 W, from 5.56 W to 5.58 W, from 5.58 W to 5.60 W, from 5.60 W to 5.62 W, from 5.62 W to 5.64 W, from 5.64 W to 5.66 W, from 5.66 W to 5.68 W, from 5.68 W to 5.70 W, from 5.70 W to 5.72 W, from 5.72 W to 5.74 W, from 5.74 W to 5.76 W, from 5.76 W to 5.78 W, from 5.78 W to 5.80 W, from 5.80 W to 5.82 W, from 5.82 W to 5.84 W, from 5.84 W to 5.86 W, from 5.86 W to 5.88 W, from 5.88 W to 5.90 W, from 5.90 W to 5.92 W, from 5.92 W to 5.94 W, from 5.94 W to 5.96 W, from 5.96 W to 5.98 W, from 5.98 W to 6.00 W, from 6.00 W to 6.02 W, from 6.02 W to 6.04 W, from 6.04 W to 6.06 W, from 6.06 W to 6.08 W, from 6.08 W to 6.10 W, from 6.10 W to 6.12 W, from 6.12 W to 6.14 W, from 6.14 W to 6.16 W, from 6.16 W to 6.18 W, from 6.18 W to 6.20 W, from 6.20 W to 6.22 W, from 6.22 W to 6.24 W, from 6.24 W to 6.26 W, from 6.26 W to 6.28 W, from 6.28 W to 6.30 W, from 6.30 W to 6.32 W, from 6.32 W to 6.34 W, from 6.34 W to 6.36 W, from 6.36 W to 6.38 W, from 6.38 W to 6.40 W, from 6.40 W to 6.42 W, from 6.42 W to 6.44 W, from 6.44 W to 6.46 W, from 6.46 W to 6.48 W, from 6.48 W to 6.50 W, from 6.50 W to 6.52 W, from 6.52 W to 6.54 W, from 6.54 W to 6.56 W, from 6.56 W to 6.58 W, from 6.58 W to 6.60 W, from 6.60 W to 6.62 W, from 6.62 W to 6.64 W, from 6.64 W to 6.66 W, from 6.66 W to 6.68 W, from 6.68 W to 6.70 W, from 6.70 W to 6.72 W, from 6.72 W to 6.74 W, from 6.74 W to 6.76 W, from 6.76 W to 6.78 W, from 6.78 W to 6.80 W, from 6.80 W to 6.82 W, from 6.82 W to 6.84 W, from 6.84 W to 6.86 W, from 6.86 W to 6.88 W, from 6.88 W to 6.90 W, from 6.90 W to 6.92 W, from 6.92 W to 6.94 W, from 6.94 W to 6.96 W, from 6.96 W to 6.98 W, from 6.98 W to 7.00 W, from 7.00 W to 7.02 W, from 7.02 W to 7.04 W, from 7.04 W to 7.06 W, from 7.06 W to 7.08 W, from 7.08 W to 7.10 W, from 7.10 W to 7.12 W, from 7.12 W to 7.14 W, from 7.14 W to 7.16 W, from 7.16 W to 7.18 W, from 7.18 W to 7.20 W, from 7.20 W to 7.22 W, from 7.22 W to 7.24 W, from 7.24 W to 7.26 W, from 7.26 W to 7.28 W, from 7.28 W to 7.30 W, from 7.30 W to 7.32 W, from 7.32 W to 7.34 W, from 7.34 W to 7.36 W, from 7.36 W to 7.38 W, from 7.38 W to 7.40 W, from 7.40 W to 7.42 W, from 7.42 W to 7.44 W, from 7.44 W to 7.46 W, from 7.46 W to 7.48 W, from 7.48 W to 7.50 W, from 7.50 W to 7.52 W, from 7.52 W to 7.54 W, from 7.54 W to 7.56 W, from 7.56 W to 7.58 W, from 7.58 W to 7.60 W, from 7.60 W to 7.62 W, from 7.62 W to 7.64 W, from 7.64 W to 7.66 W, from 7.66 W to 7.68 W, from 7.68 W to 7.70 W, from 7.70 W to 7.72 W, from 7.72 W to 7.74 W, from 7.74 W to 7.76 W, from 7.76 W to 7.78 W, from 7.78 W to 7.80 W, from 7.80 W to 7.82 W, from 7.82 W to 7.84 W, from 7.84 W to 7.86 W, from 7.86 W to 7.88 W, from 7.88 W to 7.90 W, from 7.90 W to 7.92 W, from 7.92 W to 7.94 W, from 7.94 W to 7.96 W, from 7.96 W to 7.98 W, from 7.98 W to 8.00 W, from 8.00 W to 9.00 W, from 9.00 W to 10.00 W, from 10.00 W to 12.00 W, from 12.00 W to 15.00 W, or any combination of these nozzle power intervals.

### Operating Frequency of Ultrasonic Spray Nozzle

For an ultrasonic spray nozzle to be able to atomize the liquid supplied to said spray nozzle, the atomizing surface of said spray nozzle vibrates a distinct frequency dependent on the desired characteristics of the spray mist and characteristics of the supplied liquid. In one preferred embodiment of the present invention, the atomizing surface of each the ultrasonic spray nozzle of a spray nozzle assembly of the present invention vibrates with a frequency of 60 kHz during operation.

Alternatively, the ultrasonic spray technology according to the present invention comprises use of ultrasonic vibrations with a frequency in the range of from 20 kHz to 120 kHz, such as from 20 kHz to 22 kHz, for example from 22 kHz to 24 kHz, such as from 24 kHz to 26 kHz, for example from 26 kHz to 28 kHz, such as from 28 kHz to 30 kHz, for example from 30 kHz to 32 kHz, such as from 32 kHz to 34 kHz, for example from 34 kHz to 36 kHz, such as from 36 kHz to 38 kHz, for example from 38 kHz to 40 kHz, such as from 40 kHz to 42 kHz, for example from 42 kHz to 44 kHz, such as from 44 kHz to 46 kHz, for example from 46 kHz to 48 kHz, such as from 48 kHz to 50 kHz, for example from 50 kHz to 52 kHz, such as from 52 kHz to 54 kHz, for example from 54 kHz to 56 kHz, such as from 56 kHz to 58 kHz, for example from 58 kHz to 60 kHz, such as from 60 kHz to 62 kHz, for example from 62 kHz to 64 kHz, such as from 64 kHz to 66 kHz, for example from 66 kHz to 68 kHz, such as from 68 kHz to 70 kHz, for example from 70 kHz to 72 kHz, such as from 72 kHz to 74 kHz, for example from 74 kHz to 76 kHz, such as from 76 kHz to 78 kHz, for example from 78 kHz to 80 kHz, such as from 80 kHz to 82 kHz, for example from 82 kHz to 84 kHz, such as from 84 kHz to 86 kHz, for example from 86 kHz to 88 kHz, such as from 88 kHz to 90 kHz, for example from 90 kHz to 92 kHz, such as from 92 kHz to 94 kHz, for example from 94 kHz to 96 kHz, such as from 96 kHz to 98 kHz, for example from 98 kHz to 100 kHz, such as from 100 kHz to 102 kHz, for example from 102 kHz to 104 kHz, such as from 104 kHz to 106 kHz, for example from 106 kHz to 108 kHz, such as from 108 kHz to 110 kHz, for example from 110 kHz to 112 kHz, such as from 112 kHz to 114 kHz, for example from 114 kHz to 116 kHz, such as from 116 kHz to 118 kHz, for example from 118 kHz to 120 kHz, or any combination of these intervals.

### Spray Beam

In one embodiment, the one or more ultrasonic spray nozzles of a nozzle assembly such as ultrasonic spray nozzles 1 and 2 of a spray nozzle assembly illustrated in FIG. 10 produces a fan-like spray beam which is characterized in details below. Notice that FIG. 10 is a cross-section viewing the nozzle assembly head-on.

### Spray Width

As illustrated on FIG. 10, the two ultrasonic spray nozzles of the nozzle assemblies of the present invention has been configured to produce two non-intersecting but overlapping spray beams (in FIG. 10 designated spray mist 1 and 2). This counteracts the slight difference in spray density when comparing the centre of a fan-like spray beam with the periphery of the same fan-like spray beam from one individual ultrasonic spray nozzle, thereby resulting in a uniform coating of the matrix. By also configuring the nozzles of a nozzle assembly to produce a combined spray mist, which is a little wider than the matrix to be coated, the uniform coating extends all the way to the edge of the matrix.

The two (or more) overlapping spray beams (mist 1 and 2) together produce a “combined spray mist” hereafter simply referred to as “spray mist.” In one embodiment, the width of the spray mist generated during operation of the ultrasonic spray nozzles 1 and 2 in the nozzle assembly of the invention is e.g. 10 cm or 8 cm as measured at the level of the transport mechanism.

In one embodiment the spray width can be selected from the group of intervals consisting of from 1.0 cm to 1.2 cm, from 1.2 cm to 1.4 cm, from 1.4 cm to 1.6 cm, from 1.6 cm to 1.8 cm, from 1.8 cm to 2.0 cm, 2.0 cm to 2.2 cm, from 2.2 cm to 2.4 cm, from 2.4 cm to 2.6 cm, from 2.6 cm to 2.8 cm, from 2.8 cm to 3.0 cm, 3.0 cm to 3.2 cm, from 3.2 cm to 3.4 cm, from 3.4 cm to 3.6 cm, from 3.6 cm to 3.8 cm, from 3.8 cm to 4.0 cm, 4.0 cm to 4.2 cm, from 4.2 cm to 4.4 cm, from 4.4 cm to 4.6 cm, from 4.6 cm to 4.8 cm, from 4.8 cm to 5.0 cm, 5.0 cm to 5.2 cm, from 5.2 cm to 5.4 cm, from 5.4 cm to 5.6 cm, from 5.6 cm to 5.8 cm, from 5.8 cm to 6.0 cm, 6.0 cm to 6.2 cm, from 6.2 cm to 6.4 cm, from 6.4 cm to 6.6 cm, from 6.6 cm to 6.8 cm, from 6.8 cm to 7.0 cm, 7.0 cm to 7.2 cm, from 7.2 cm to 7.4 cm, from 7.4 cm to 7.6 cm, from 7.6 cm to 7.8 cm, from 7.8 cm to 8.0 cm, 8.0 cm to 8.2 cm, from 8.2 cm to 8.4 cm, from 8.4 cm to 8.6 cm, from 8.6 cm to 8.8 cm, from 8.8 cm to 9.0 cm, 9.0 cm to 9.2 cm, from 9.2 cm to 9.4 cm, from 9.4 cm to 9.6 cm, from 9.6 cm to 9.8 cm, from 9.8 cm to 10.0 cm, 10.0 cm to 10.2 cm, from 10.2 cm to 10.4 cm, from 10.4 cm to 10.6 cm, from 10.6 cm to 10.8 cm, from 10.8 cm to 11.0 cm, 11.0 cm to 11.2 cm, from 11.2 cm to 11.4 cm, from 11.4 cm to 11.6 cm, from 11.6 cm to 11.8 cm, from 11.8 cm to 12.0 cm, 12.0 cm to 12.2 cm, from 12.2 cm to 12.4 cm, from 12.4 cm to 12.6 cm, from 12.6 cm to 12.8 cm, from 12.8 cm to 13.0 cm, 13.0 cm to 13.2 cm, from 13.2 cm to 13.4 cm, from 13.4 cm to 13.6 cm, from 13.6 cm to 13.8 cm, from 13.8 cm to 14.0 cm, 14.0 cm to 14.2 cm, from 14.2 cm to 14.4 cm, from 14.4 cm to 14.6 cm, from 14.6 cm to 14.8 cm, from 14.8 cm to 15.0 cm, 15.0 cm to 15.2 cm, from 15.2 cm to 15.4 cm, from 15.4 cm to 15.6 cm, from 15.6 cm to 15.8 cm, from 15.8 cm to 16.0 cm, 16.0 cm to 16.2 cm, from 16.2 cm to 16.4 cm, from 16.4 cm to 16.6 cm, from 16.6 cm to 16.8 cm, from 16.8 cm to 17.0 cm, 17.0 cm to 17.2 cm, from 17.2 cm to 17.4 cm, from 17.4 cm to 17.6 cm, from 17.6 cm to 17.8 cm, from 17.8 cm to 18.0 cm, 18.0 cm to 18.2 cm, from 18.2 cm to 18.4 cm, from 18.4 cm to 18.6 cm, from 18.6 cm to 18.8 cm, from 18.8 cm to 19.0 cm, 19.0 cm to 19.2 cm, from 19.2 cm to 19.4 cm, from 19.4 cm to 19.6 cm, from 19.6 cm to 19.8 cm, from 19.8 cm to 20.0 cm, from 20.0 cm to 20.2 cm, from 20.2 cm to 20.4 cm, from 20.4 cm to 20.6 cm, from 20.6 cm to 20.8 cm, from 20.8 cm to 21.0 cm, from 21.0 cm to 21.2 cm, from 21.2 cm to 21.4 cm, from 21.4 cm to 21.6 cm, from 21.6 cm to 21.8 cm, from 21.8 cm to 22.0 cm, from 22.0 cm to 22.2 cm, from 22.2 cm to 22.4 cm, from 22.4 cm to 22.6 cm, from 22.6 cm to 22.8 cm, from 22.8 cm to 23.0 cm, from 23.0 cm to 23.2 cm, from 23.2 cm to 23.4 cm, from 23.4 cm to 23.6 cm, from 23.6 cm to 23.8 cm, from 23.8 cm to 24.0 cm, from 24.0 cm to 24.2 cm, from 24.2 cm to 24.4 cm, from 24.4 cm to 24.6 cm, from 24.6 cm to 24.8 cm, from 24.8 cm to 25.0 cm, from 25.0 cm to 25.2 cm, from 25.2 cm to 25.4 cm, from 25.4 cm to 25.6 cm, from 25.6 cm to 25.8 cm, from 25.8 cm to 26.0 cm, from 26.0 cm to 26.2 cm, from 26.2 cm to 26.4 cm, from 26.4 cm to 26.6 cm, from 26.6 cm to 26.8 cm, from 26.8 cm to 27.0 cm, from 27.0 cm to 27.2 cm, from 27.2 cm to 27.4 cm, from 27.4 cm to 27.6 cm, from 27.6 cm to 27.8 cm, from 27.8 cm to 28.0 cm, from 28.0 cm to 28.2 cm, from 28.2 cm to 28.4 cm, from 28.4 cm to 28.6 cm, from 28.6 cm to 28.8 cm, from 28.8 cm to 29.0 cm, from 29.0 cm to 29.2 cm, from 29.2 cm to 29.4 cm, from 29.4 cm to 29.6 cm, from 29.6 cm to 29.8 cm, from 29.8 cm to 30.0 cm, from 30.0 cm to 30.2 cm, from 30.2 cm to 30.4 cm, from 30.4 cm to 30.6 cm, from 30.6 cm to 30.8 cm, from 30.8 cm to 31.0 cm, from 31.0 cm to 31.2 cm, from 31.2 cm to 31.4 cm, from 31.4 cm to 31.6 cm, from 31.6 cm to 31.8 cm, from 31.8 cm to 32.0 cm, from 32.0 cm to 32.2 cm, from 32.2 cm to 32.4 cm, from 32.4 cm to 32.6 cm, from 32.6 cm to 32.8 cm, from 32.8 cm to 33.0 cm, from 33.0 cm to 33.2 cm, from 33.2 cm to 33.4 cm, from 33.4 cm to 33.6 cm, from 33.6 cm to 33.8 cm, from 33.8 cm to 34.0 cm, from 34.0 cm to 34.2 cm, from 34.2 cm to 34.4 cm, from 34.4 cm to 34.6 cm, from 34.6 cm to 34.8 cm, from 34.8 cm to 35.0 cm, from 35.0 cm to 35.2 cm, from 35.2 cm to 35.4 cm, from 35.4 cm to 35.6 cm, from 35.6 cm to 35.8 cm, from 35.8 cm to 36.0 cm, from 36.0 cm to 36.2 cm, from 36.2 cm to 36.4 cm, from 36.4 cm to 36.6 cm, from 36.6 cm to 36.8 cm, from 36.8 cm to 37.0 cm, from 37.0 cm to 37.2 cm, from 37.2 cm to 37.4 cm, from 37.4 cm to 37.6 cm, from 37.6 cm to 37.8 cm, from 37.8 cm to 38.0 cm, from 38.0 cm to 38.2 cm, from 38.2 cm to 38.4 cm, from 38.4 cm to 38.6 cm, from 38.6 cm to 38.8 cm, from 38.8 cm to 39.0 cm, from 39.0 cm to 39.2 cm, from 39.2 cm to 39.4 cm, from 39.4 cm to 39.6 cm, from 39.6 cm to 39.8 cm, from 39.8 cm to 40.0 cm, from 40 cm to 45 cm, and from 45 cm to 50 cm, or any combination thereof.

### Drop Size

During operation of the ultrasonic spray nozzles i.e. active spray coating, each ultrasonic spray nozzle in a nozzle assembly produces a spray mist of the supplied liquid. The spray mist can be further characterized by the size of the mean drop diameter of the drops in the spray mist.

In one embodiment of the invention, the mean drop diameter characterizing the spray mist produced by the ultrasonic spray nozzles in a spray nozzle assembly lies in the range of from 1 μm to 200 μm, such as from 1 μm to 2 μm, for example from 2 μm to 4 μm, such as from 4 μm to 6 μm, for example from 6 μm to 8 μm, such as from 8 μm to 10 μm, for example from 10 μm to 12 μm, such as from 12 μm to 14 μm, for example from 14 μm to 16 μm, such as from 16 μm to 18 μm, for example from 18 μm to 20 μm, such as from 20 μm to 22 μm, for example from 22 μm to 24 μm, such as from 24 μm to 26 μm, for example from 26 μm to 28 μm, such as from 28 μm to 30 μm, for example from 30 μm to 32 μm, such as from 32 μm to 34 μm, for example from 34 μm to 36 μm, such as from 36 μm to 38 μm, for example from 38 μm to 40 μm, such as from 40 μm to 42 μm, for example from 42 μm to 44 μm, such as from 44 μm to 46 μm, for example from 46 μm to 48 μm, such as from 48 μm to 50 μm, for example from 50 μm to 52 μm, such as from 52 μm to 54 μm, for example from 54 μm to 56 μm, such as from 56 μm to 58 μm, for example from 58 μm to 60 μm, such as from 60 μm to 62 μm, for example from 62 μm to 64 μm, such as from 64 μm to 66 μm, for example from 66 μm to 68 μm, such as from 68 μm to 70 μm, for example from 70 μm to 72 μm, such as from 72 μm to 74 μm, for example from 74 μm to 76 μm, such as from 76 μm to 78 μm, for example from 78 μm to 80 μm, such as from 80 μm to 82 μm, for example from 82 μm to 84 μm, such as from 84 μm to 86 μm, for example from 86 μm to 88 μm, such as from 88 μm to 90 μm, for example from 90 μm to 92 μm, such as from 92 μm to 94 μm, for example from 94 μm to 96 μm, such as from 96 μm to 98 μm, for example from 98 μm to 100 μm, such as from 100 μm to 102 μm, for example from 102 μm to 104 μm, such as from 104 μm to 106 μm, for example from 106 μm to 108 μm, such as from 108 μm to 110 μm, for example from 110 μm to 112 μm, such as from 112 μm to 114 μm, for example from 114 μm to 116 μm, such as from 116 μm to 118 μm, for example from 118 μm to 120 μm, such as from 120 μm to 122 μm, for example from 122 μm to 124 μm, such as from 124 μm to 126 μm, for example from 126 μm to 128 μm, such as from 128 μm to 130 μm, for example from 130 μm to 132 μm, such as from 132 μm to 134 μm, for example from 134 μm to 136 μm, such as from 136 μm to 138 μm, for example from 138 μm to 140 μm, such as from 140 μm to 142 μm, for example from 142 μm to 144 μm, such as from 144 μm to 146 μm, for example from 146 μm to 148 μm, such as from 148 μm to 150 μm, for example from 150 μm to 152 μm, such as from 152 μm to 154 μm, for example from 154 μm to 156 μm, such as from 156 μm to 158 μm, for example from 158 μm to 160 μm, such as from 160 μm to 162 μm, for example from 162 μm to 164 μm, such as from 164 μm to 166 μm, for example from 166 μm to 168 μm, such as from 168 μm to 170 μm, for example from 170 μm to 172 μm, such as from 172 μm to 174 μm, for example from 174 μm to 176 μm, such as from 176 μm to 178 μm, for example from 178 μm to 180 μm, such as from 180 μm to 182 μm, for example from 182 μm to 184 μm, such as from 184 μm to 186 μm, for example from 186 μm to 188 μm, such as from 188 μm to 190 μm, for example from 190 μm to 192 μm, such as from 192 μm to 194 μm, for example from 194 μm to 196 μm, such as from 196 μm to 198 μm, for example from 198 μm to 200 μm, or any combination of these intervals.

In one embodiment of the invention, the mean drop diameter of the ultrasonic spray nozzles such as ultrasonic spray nozzles 1 and 2 of the same nozzle assembly is identical. In one embodiment of the invention the mean drop diameter of the ultrasonic spray nozzles such as ultrasonic spray nozzles 1 and 2 of the same nozzle assembly differs.

Distance from Transport Mechanism to Nozzle Centre

The spray nozzle assembly is located above the transport mechanism on which the matrices/sponges travels. The transport mechanism may in one embodiment be a belt.

In one embodiment, the distance from the transport mechanism to the nozzle centre is about 4.5 cm, 8.2 cm or 13.0 cm.

The distance from the transport mechanism to the nozzle centre can in one embodiment be selected from the group of intervals consisting of from 2.0 cm to 2.2 cm, from 2.2 cm to 2.4 cm, from 2.4 cm to 2.6 cm, from 2.6 cm to 2.8 cm, from 2.8 cm to 3.0 cm, from 3.0 cm to 3.2 cm, from 3.2 cm to 3.4 cm, from 3.4 cm to 3.6 cm, from 3.6 cm to 3.8 cm, from 3.8 cm to 4.0 cm, from 4.0 cm to 4.2 cm, from 4.2 cm to 4.4 cm, from 4.4 cm to 4.6 cm, from 4.6 cm to 4.8 cm, from 4.8 cm to 5.0 cm, from 5.0 cm to 5.2 cm, from 5.2 cm to 5.4 cm, from 5.4 cm to 5.6 cm, from 5.6 cm to 5.8 cm, from 5.8 cm to 6.0 cm, from 6.0 cm to 6.2 cm, from 6.2 cm to 6.4 cm, from 6.4 cm to 6.6 cm, from 6.6 cm to 6.8 cm, from 6.8 cm to 7.0 cm, from 7.0 cm to 7.2 cm, from 7.2 cm to 7.4 cm, from 7.4 cm to 7.6 cm, from 7.6 cm to 7.8 cm, from 7.8 cm to 8.0 cm, from 8.0 cm to 8.2 cm, from 8.2 cm to 8.4 cm, from 8.4 cm to 8.6 cm, from 8.6 cm to 8.8 cm, from 8.8 cm to 9.0 cm, from 9.0 cm to 9.2 cm, from 9.2 cm to 9.4 cm, from 9.4 cm to 9.6 cm, from 9.6 cm to 9.8 cm, from 9.8 cm to 10.0 cm, from 10.0 cm to 10.2 cm, from 10.2 cm to 10.4 cm, from 10.4 cm to 10.6 cm, from 10.6 cm to 10.8 cm, from 10.8 cm to 11.0 cm, from 11.0 cm to 11.2 cm, from 11.2 cm to 11.4 cm, from 11.4 cm to 11.6 cm, from 11.6 cm to 11.8 cm, from 11.8 cm to 12.0 cm, from 12.0 cm to 12.2 cm, from 12.2 cm to 12.4 cm, from 12.4 cm to 12.6 cm, from 12.6 cm to 12.8 cm, from 12.8 cm to 13.0 cm, from 13.0 cm to 13.2 cm, from 13.2 cm to 13.4 cm, from 13.4 cm to 13.6 cm, from 13.6 cm to 13.8 cm, from 13.8 cm to 14.0 cm, from 14.0 cm to 14.2 cm, from 14.2 cm to 14.4 cm, from 14.4 cm to 14.6 cm, from 14.6 cm to 14.8 cm, from 14.8 cm to 15.0 cm, from 15.0 cm to 15.2 cm, from 15.2 cm to 15.4 cm, from 15.4 cm to 15.6 cm, from 15.6 cm to 15.8 cm, from 15.8 cm to 16.0 cm, from 16.0 cm to 16.2 cm, from 16.2 cm to 16.4 cm, from 16.4 cm to 16.6 cm, from 16.6 cm to 16.8 cm, from 16.8 cm to 17.0 cm, from 17.0 cm to 17.2 cm, from 17.2 cm to 17.4 cm, from 17.4 cm to 17.6 cm, from 17.6 cm to 17.8 cm, from 17.8 cm to 18.0 cm, from 18.0 cm to 18.2 cm, from 18.2 cm to 18.4 cm, from 18.4 cm to 18.6 cm, from 18.6 cm to 18.8 cm, from 18.8 cm to 19.0 cm, from 19.0 cm to 19.2 cm, from 19.2 cm to 19.4 cm, from 19.4 cm to 19.6 cm, from 19.6 cm to 19.8 cm, from 19.8 cm to 20.0 cm, from 20.0 cm to 20.2 cm, from 20.2 cm to 20.4 cm, from 20.4 cm to 20.6 cm, from 20.6 cm to 20.8 cm, from 20.8 cm to 21.0 cm, from 21.0 cm to 21.2 cm, from 21.2 cm to 21.4 cm, from 21.4 cm to 21.6 cm, from 21.6 cm to 21.8 cm, from 21.8 cm to 22.0 cm, from 22.0 cm to 22.2 cm, from 22.2 cm to 22.4 cm, from 22.4 cm to 22.6 cm, from 22.6 cm to 22.8 cm, from 22.8 cm to 23.0 cm, from 23.0 cm to 23.2 cm, from 23.2 cm to 23.4 cm, from 23.4 cm to 23.6 cm, from 23.6 cm to 23.8 cm, from 23.8 cm to 24.0 cm, from 24.0 cm to 24.2 cm, from 24.2 cm to 24.4 cm, from 24.4 cm to 24.6 cm, from 24.6 cm to 24.8 cm, from 24.8 cm to 25.0 cm, from 25.0 cm to 25.2 cm, from 25.2 cm to 25.4 cm, from 25.4 cm to 25.6 cm, from 25.6 cm to 25.8 cm, from 25.8 cm to 26.0 cm, from 26.0 cm to 26.2 cm, from 26.2 cm to 26.4 cm, from 26.4 cm to 26.6 cm, from 26.6 cm to 26.8 cm, from 26.8 cm to 27.0 cm, from 27.0 cm to 27.2 cm, from 27.2 cm to 27.4 cm, from 27.4 cm to 27.6 cm, from 27.6 cm to 27.8 cm, from 27.8 cm to 28.0 cm, from 28.0 cm to 28.2 cm, from 28.2 cm to 28.4 cm, from 28.4 cm to 28.6 cm, from 28.6 cm to 28.8 cm, from 28.8 cm to 29.0 cm, from 29.0 cm to 29.2 cm, from 29.2 cm to 29.4 cm, from 29.4 cm to 29.6 cm, from 29.6 cm to 29.8 cm, from 29.8 cm to 30.0 cm, from 30.0 cm to 30.2 cm, from 30.2 cm to 30.4 cm, from 30.4 cm to 30.6 cm, from 30.6 cm to 30.8 cm, from 30.8 cm to 31.0 cm, from 31.0 cm to 31.2 cm, from 31.2 cm to 31.4 cm, from 31.4 cm to 31.6 cm, from 31.6 cm to 31.8 cm, from 31.8 cm to 32.0 cm, from 32.0 cm to 32.2 cm, from 32.2 cm to 32.4 cm, from 32.4 cm to 32.6 cm, from 32.6 cm to 32.8 cm, from 32.8 cm to 33.0 cm, from 33.0 cm to 33.2 cm, from 33.2 cm to 33.4 cm, from 33.4 cm to 33.6 cm, from 33.6 cm to 33.8 cm, from 33.8 cm to 34.0 cm, from 34.0 cm to 34.2 cm, from 34.2 cm to 34.4 cm, from 34.4 cm to 34.6 cm, from 34.6 cm to 34.8 cm, from 34.8 cm to 35.0 cm, from 35.0 cm to 35.2 cm, from 35.2 cm to 35.4 cm, from 35.4 cm to 35.6 cm, from 35.6 cm to 35.8 cm, from 35.8 cm to 36.0 cm, from 36.0 cm to 36.2 cm, from 36.2 cm to 36.4 cm, from 36.4 cm to 36.6 cm, from 36.6 cm to 36.8 cm, from 36.8 cm to 37.0 cm, from 37.0 cm to 37.2 cm, from 37.2 cm to 37.4 cm, from 37.4 cm to 37.6 cm, from 37.6 cm to 37.8 cm, from 37.8 cm to 38.0 cm, from 38.0 cm to 38.2 cm, from 38.2 cm to 38.4 cm, from 38.4 cm to 38.6 cm, from 38.6 cm to 38.8 cm, from 38.8 cm to 39.0 cm, from 39.0 cm to 39.2 cm, from 39.2 cm to 39.4 cm, from 39.4 cm to 39.6 cm, from 39.6 cm to 39.8 cm, from 39.8 cm to 40.0 cm, from 40 cm to 45 cm, and from 45 cm to 50 cm, or any combination thereof.

### Temperature

In one preferred embodiment the coating of the sponges is performed at ambient temperature in the range of from 11° C. to 25° C., for example from 10° C. to 11° C., such as from 11° C. to 12° C., for example from 12° C. to 13° C., such as from 13° C. to 14° C., for example from 13° C. to 14° C., such as from 14° C. to 15° C., for example from 15° C. to 16° C., such as from 16° C. to 17° C., for example from 17° C. to 18° C., such as from 18° C. to 19° C., for example from 19° C. to 20° C., such as from 20° C. to 21° C., for example from 21° C. to 22° C., such as from 22° C. to 23° C., for example from 23° C. to 24° C., such as from 24° C. to 25° C.

In a similarly preferred embodiment, the coated sponges are subjected to a drying process at temperatures above ambient following coating. In one embodiment, the coated sponges are subjected to a drying process at ambient temperature following coating.

### Spillage

The present invention relates in one embodiment to a method for application of a pharmaceutical composition such as a solution comprising thrombin on to a matrix or sponge by ultrasonic spray technology wherein at least 90% of the input thrombin is found on the matrix or sponge after ultrasonic spraying and drying of said matrix or sponge such as at least 91%, at least 92%, at least 93%, at least 94%, at least 95%, at least 96%, at least 97%, at least 98%, or at least 99%.

### Drying

Following exit of the matrices/sponges out of the spray chamber, the matrices/sponges are transported further down the production line on transport mechanism 1 and reach the area of drying (“oven” on FIG. 8). In one embodiment, the matrices/sponges arrive at the transfer area and are transferred to load zone 2 manually, load zone 2 comprising one or more transport mechanisms running in parallel, for example 2 transport mechanisms, such as 3 transport mechanisms, for example 4 transport mechanisms. In one embodiment, the matrices/sponges arrive at the transfer area and are transferred to load zone 2 by a machine, load zone 2 comprising one or more transport mechanisms running in parallel, for example 2 transport mechanisms, such as 3 transport mechanisms, for example 4 transport mechanisms. In one embodiment, the matrices/sponges arrive at the area of drying without passing through a transfer area and load zone 2 area.

The transport mechanisms leading the one or more matrices/sponges to the drying area (“oven”) are designated “transport mechanism 2” and “transport mechanism 3” on FIG. 8.

On transport mechanisms 2 and 3, which are or are not in continuous operation, the matrices/sponges are transported to the oven for drying.

In the oven the spray coated matrices/sponges are dried by heating.

In one preferred embodiment the drying of the coated matrices/sponges is performed at 45° C.

In one embodiment the oven temperature for the drying step can be selected from the group of temperature intervals consisting of from 15° C. to 20° C., from 20° C. to 25° C., from 25° C. to 30° C., from 30° C. to 35° C., from 35° C. to 40° C., from 40° C. to 42° C., from 42° C. to 44° C., from 44° C. to 46° C., from 46° C. to 48° C., from 48° C. to 50° C., from 50° C. to 55° C., from 55° C. to 60° C., or any combination thereof.

In the description below and on FIG. 8, two transport mechanisms transport the spray coated matrices/sponges into the oven for drying. However, it is within the scope of the invention to employ several transport mechanisms operating in parallel.

The drying time, i.e. the time in which the matrix is subjected to a drying process in the oven, may be identical for matrices on the one or more transport mechanisms such as transport mechanism 2 and 3 on FIG. 8 or the drying time may be different for the matrices on the two or more transport mechanisms.

### Drying Time for the Matrix/Sponge on Transport Mechanism 2

In one embodiment the drying time for the matrix/sponge on transport mechanism 2 is 5.5 minutes, 6 minutes, 7.5 minutes, or 10.5 minutes.

In one embodiment the drying time for the matrix/sponge on transport mechanism 2 can be selected from the group of time intervals consisting of from 2.0 min to 2.2 min, from 2.2 min to 2.4 min, from 2.4 min to 2.6 min, from 2.6 min to 2.8 min, from 2.8 min to 3.0 min, from 3.0 min to 3.2 min, from 3.2 min to 3.4 min, from 3.4 min to 3.6 min, from 3.6 min to 3.8 min, from 3.8 min to 4.0 min, from 4.0 min to 4.2 min, from 4.2 min to 4.4 min, from 4.4 min to 4.6 min, from 4.6 min to 4.8 min, from 4.8 min to 5.0 min, from 5.0 min to 5.2 min, from 5.2 min to 5.4 min, from 5.4 min to 5.6 min, from 5.6 min to 5.8 min, from 5.8 min to 6.0 min, from 6.0 min to 6.2 min, from 6.2 min to 6.4 min, from 6.4 min to 6.6 min, from 6.6 min to 6.8 min, from 6.8 min to 7.0 min, from 7.0 min to 7.2 min, from 7.2 min to 7.4 min, from 7.4 min to 7.6 min, from 7.6 min to 7.8 min, from 7.8 min to 8.0 min, from 8.0 min to 8.2 min, from 8.2 min to 8.4 min, from 8.4 min to 8.6 min, from 8.6 min to 8.8 min, from 8.8 min to 9.0 min, from 9.0 min to 9.2 min, from 9.2 min to 9.4 min, from 9.4 min to 9.6 min, from 9.6 min to 9.8 min, from 9.8 min to 10.0 min, from 10.0 min to 10.2 min, from 10.2 min to 10.4 min, from 10.4 min to 10.6 min, from 10.6 min to 10.8 min, from 10.8 min to 11.0 min, from 11.0 min to 11.2 min, from 11.2 min to 11.4 min, from 11.4 min to 11.6 min, from 11.6 min to 11.8 min, from 11.8 min to 12.0 min, from 12.0 min to 12.2 min, from 12.2 min to 12.4 min, from 12.4 min to 12.6 min, from 12.6 min to 12.8 min, from 12.8 min to 13.0 min, from 13.0 min to 13.2 min, from 13.2 min to 13.4 min, from 13.4 min to 13.6 min, from 13.6 min to 13.8 min, from 13.8 min to 14.0 min, from 14.0 min to 14.2 min, from 14.2 min to 14.4 min, from 14.4 min to 14.6 min, from 14.6 min to 14.8 min, from 14.8 min to 15.0 min, from 15.0 min to 15.2 min, from 15.2 min to 15.4 min, from 15.4 min to 15.6 min, from 15.6 min to 15.8 min, from 15.8 min to 16.0 min, from 16.0 min to 16.2 min, from 16.2 min to 16.4 min, from 16.4 min to 16.6 min, from 16.6 min to 16.8 min, from 16.8 min to 17.0 min, from 17.0 min to 17.2 min, from 17.2 min to 17.4 min, from 17.4 min to 17.6 min, from 17.6 min to 17.8 min, from 17.8 min to 18.0 min, from 18.0 min to 18.2 min, from 18.2 min to 18.4 min, from 18.4 min to 18.6 min, from 18.6 min to 18.8 min, from 18.8 min to 19.0 min, from 19.0 min to 19.2 min, from 19.2 min to 19.4 min, from 19.4 min to 19.6 min, from 19.6 min to 19.8 min, from 19.8 min to 20.0 min, from 20.0 min to 20.2 min, from 20.2 min to 20.4 min, from 20.4 min to 20.6 min, from 20.6 min to 20.8 min, from 20.8 min to 21.0 min, from 21.0 min to 21.2 min, from 21.2 min to 21.4 min, from 21.4 min to 21.6 min, from 21.6 min to 21.8 min, from 21.8 min to 22.0 min, from 22.0 min to 22.2 min, from 22.2 min to 22.4 min, from 22.4 min to 22.6 min, from 22.6 min to 22.8 min, from 22.8 min to 23.0 min, from 23.0 min to 23.2 min, from 23.2 min to 23.4 min, from 23.4 min to 23.6 min, from 23.6 min to 23.8 min, from 23.8 min to 24.0 min, from 24.0 min to 24.2 min, from 24.2 min to 24.4 min, from 24.4 min to 24.6 min, from 24.6 min to 24.8 min, from 24.8 min to 25.0 min, or any combination thereof.

### Drying Time for the Matrix/Sponge on Transport Mechanism 3

In one embodiment the drying time for the matrix/sponge on transport mechanism 3 is 5.5 minutes, 6 minutes, 7.5 minutes, or 10.5 minutes.

In one embodiment the drying time for the matrix/sponge on oven transport mechanism 3 can be selected from the group of time intervals consisting of from 2.0 min to 2.2 min, from 2.2 min to 2.4 min, from 2.4 min to 2.6 min, from 2.6 min to 2.8 min, from 2.8 min to 3.0 min, from 3.0 min to 3.2 min, from 3.2 min to 3.4 min, from 3.4 min to 3.6 min, from 3.6 min to 3.8 min, from 3.8 min to 4.0 min, from 4.0 min to 4.2 min, from 4.2 min to 4.4 min, from 4.4 min to 4.6 min, from 4.6 min to 4.8 min, from 4.8 min to 5.0 min, from 5.0 min to 5.2 min, from 5.2 min to 5.4 min, from 5.4 min to 5.6 min, from 5.6 min to 5.8 min, from 5.8 min to 6.0 min, from 6.0 min to 6.2 min, from 6.2 min to 6.4 min, from 6.4 min to 6.6 min, from 6.6 min to 6.8 min, from 6.8 min to 7.0 min, from 7.0 min to 7.2 min, from 7.2 min to 7.4 min, from 7.4 min to 7.6 min, from 7.6 min to 7.8 min, from 7.8 min to 8.0 min, from 8.0 min to 8.2 min, from 8.2 min to 8.4 min, from 8.4 min to 8.6 min, from 8.6 min to 8.8 min, from 8.8 min to 9.0 min, from 9.0 min to 9.2 min, from 9.2 min to 9.4 min, from 9.4 min to 9.6 min, from 9.6 min to 9.8 min, from 9.8 min to 10.0 min, from 10.0 min to 10.2 min, from 10.2 min to 10.4 min, from 10.4 min to 10.6 min, from 10.6 min to 10.8 min, from 10.8 min to 11.0 min, from 11.0 min to 11.2 min, from 11.2 min to 11.4 min, from 11.4 min to 11.6 min, from 11.6 min to 11.8 min, from 11.8 min to 12.0 min, from 12.0 min to 12.2 min, from 12.2 min to 12.4 min, from 12.4 min to 12.6 min, from 12.6 min to 12.8 min, from 12.8 min to 13.0 min, from 13.0 min to 13.2 min, from 13.2 min to 13.4 min, from 13.4 min to 13.6 min, from 13.6 min to 13.8 min, from 13.8 min to 14.0 min, from 14.0 min to 14.2 min, from 14.2 min to 14.4 min, from 14.4 min to 14.6 min, from 14.6 min to 14.8 min, from 14.8 min to 15.0 min, from 15.0 min to 15.2 min, from 15.2 min to 15.4 min, from 15.4 min to 15.6 min, from 15.6 min to 15.8 min, from 15.8 min to 16.0 min, from 16.0 min to 16.2 min, from 16.2 min to 16.4 min, from 16.4 min to 16.6 min, from 16.6 min to 16.8 min, from 16.8 min to 17.0 min, from 17.0 min to 17.2 min, from 17.2 min to 17.4 min, from 17.4 min to 17.6 min, from 17.6 min to 17.8 min, from 17.8 min to 18.0 min, from 18.0 min to 18.2 min, from 18.2 min to 18.4 min, from 18.4 min to 18.6 min, from 18.6 min to 18.8 min, from 18.8 min to 19.0 min, from 19.0 min to 19.2 min, from 19.2 min to 19.4 min, from 19.4 min to 19.6 min, from 19.6 min to 19.8 min, from 19.8 min to 20.0 min, from 20.0 min to 20.2 min, from 20.2 min to 20.4 min, from 20.4 min to 20.6 min, from 20.6 min to 20.8 min, from 20.8 min to 21.0 min, from 21.0 min to 21.2 min, from 21.2 min to 21.4 min, from 21.4 min to 21.6 min, from 21.6 min to 21.8 min, from 21.8 min to 22.0 min, from 22.0 min to 22.2 min, from 22.2 min to 22.4 min, from 22.4 min to 22.6 min, from 22.6 min to 22.8 min, from 22.8 min to 23.0 min, from 23.0 min to 23.2 min, from 23.2 min to 23.4 min, from 23.4 min to 23.6 min, from 23.6 min to 23.8 min, from 23.8 min to 24.0 min, from 24.0 min to 24.2 min, from 24.2 min to 24.4 min, from 24.4 min to 24.6 min, from 24.6 min to 24.8 min, from 24.8 min to 25.0 min, or any combination thereof.

In one embodiment, the oven used for drying of the matrices/sponges is a vacuum oven.

Following drying of the spray coated matrices/sponges; the latter exit the drying area (“oven”), and can be transported on a transport mechanism (transport mechanism 2/3 in FIG. 8) to the buffer zone.

In one embodiment, after a brief and optional cooling period in the buffer zone each coated matrix/sponge is put into a tray, which is sealed (FIG. 8—“Tray sealing”).

In one embodiment, the tray sealing is carried out under sterile conditions, thus producing a sterile composition consisting of a sterile matrix/sponge in a sealed sterile tray.

In one embodiment, the tray sealing is followed by packaging of the sterile or non-sterile trays, each comprising a matrix/sponge, into pouches, which are then sealed (FIG. 8—“Pouch sealing”).

In one embodiment, the packaging of the sterile or trays with matrices/sponges into pouches is carried out under sterile conditions.

The detailed description herein above produces matrices/sponges which in a preferred embodiment has a thrombolytic activity of 40 IU/cm².

In one embodiment the thrombolytic activity of the coated matrices/sponges can be selected from the group of intervals consisting of from 5 IU/cm² to 6 IU/cm², from 6 IU/cm² to 7 IU/cm², from 7 IU/cm² to 8 IU/cm², from 8 IU/cm² to 9 IU/cm², from 9 IU/cm² to 10 IU/cm², 10 IU/cm² to 12 IU/cm², from 12 IU/cm² to 14 IU/cm², from 14 IU/cm² to 16 IU/cm², from 16 IU/cm² to 18 IU/cm², from 18 IU/cm² to 20 IU/cm², 20 IU/cm² to 22 IU/cm², from 22 IU/cm² to 24 IU/cm², from 24 IU/cm² to 26 IU/cm², from 26 IU/cm² to 28 IU/cm², from 28 IU/cm² to 30 IU/cm², from 30 IU/cm² to 32 IU/cm², from 32 IU/cm² to 34 IU/cm², from 34 IU/cm² to 36 IU/cm², from 36 IU/cm² to 38 IU/cm², from 38 IU/cm² to 40 IU/cm², from 40 IU/cm² to 42 IU/cm², from 42 IU/cm² to 44 IU/cm², from 44 IU/cm² to 46 IU/cm², from 46 IU/cm² to 48 IU/cm², from 48 IU/cm² to 50 IU/cm², from 50 IU/cm² to 52 IU/cm², from 52 IU/cm² to 54 IU/cm², from 54 IU/cm² to 56 IU/cm², from 56 IU/cm² to 58 IU/cm², from 58 IU/cm² to 60 IU/cm², from 60 IU/cm² to 62 IU/cm², from 62 IU/cm² to 64 IU/cm², from 64 IU/cm² to 66 IU/cm², from 66 IU/cm² to 68 IU/cm², from 68 IU/cm² to 70 IU/cm², from 70 IU/cm² to 72 IU/cm², from 72 IU/cm² to 74 IU/cm², from 74 IU/cm² to 76 IU/cm², from 76 IU/cm² to 78 IU/cm², from 32 IU/cm² to 34 IU/cm², from 34 IU/cm² to 36 IU/cm², from 36 IU/cm² to 38 IU/cm², from 38, from 78 IU/cm² to 80 IU/cm², from 80 IU/cm² to 82 IU/cm², from 82 IU/cm² to 84 IU/cm², from 84 IU/cm² to 86 IU/cm², from 86 IU/cm² to 88 IU/cm², from 88 IU/cm² to 90 IU/cm², from 92 IU/cm² to 54 IU/cm², from 54 IU/cm² to 56 IU/cm², from 56 IU/cm² to 58 IU/cm², from 98 IU/cm² to 100 IU/cm², or any combination thereof.

In one envisioned embodiment, the matrices are coated sequentially with two different pharmaceutical compositions using the described ultrasonic spray technique with a drying procedure following each spray coating procedure. In one such embodiment, the matrices are initially coated with a solution containing thrombin followed by a drying procedure e.g. as described herein above followed by an additional coating procedure with a solution containing fibrin followed by a final drying procedure. In one embodiment involving two different pharmaceutical compositions, spraying of either the first or the second or both of the solution is undertaken at a pH different from 7, thus minimizing enzymatic activity of the bioactive agents in the pharmaceutical compositions.

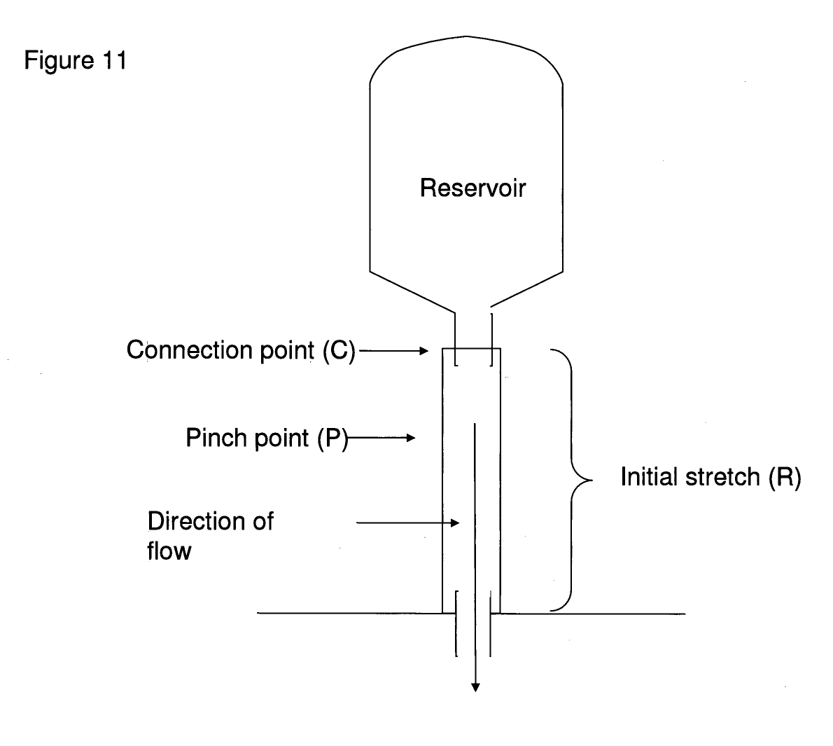

In one embodiment of the present invention, a procedure is employed to avoid entry of air bubbles into the liquid feeding system when renewing the reservoir-bags containing the pharmaceutical composition (FIG. 11). Avoiding entry of air bubbles in to the liquid feeding system is crucial, since presence of air bubbles will lead to uneven spray coating of the matrices/sponges. The procedure involves employing a large diameter (¼″) soft rubber tube for the initial stretch of supply line, denoted R on the illustration (FIG. 11). When exchanging the empty reservoir-bag for a full reservoir-bag, the soft rubber tube is pinched immediately below the connection point between rubber tube and reservoir bag (P=point of pinching, C=connection between reservoir bag and liquid feeding system). When the full reservoir-bag has been safely joined to the rubber tube, air and residual fluid from the now-removed previous reservoir-bag left standing over the pinch in the rubber tube, is pushed backwards up into the new reservoir-bag, where any air bubbles present travel to the surface of the liquid of the new reservoir-bag, thus avoiding entry of air bubbles into the supply line.

### Transducer Assemblies

In one embodiment the ultrasonic spray technology according to the present invention comprises use of one or more transducer assemblies, such as one or more transducer assemblies disclosed in U.S. Pat. No. 4,153,201 and/or one or more transducer assemblies described herein below. U.S. Pat. No. 4,153,201 is hereby incorporated into this patent application in its entirety.
A transducer assembly comprising: a first section in the form of a symmetrical double-dummy ultrasonic horn having a driving element sandwiched therein, said first section having an empirically measured characteristic resonant frequency and a second section including an amplification step, wherein the theoretical resonant frequency of the second section matches the empirically measured frequency of the first section.
An ultrasonic transducer including a first driver section and a second half-wavelength output section having a large diameter segment of length A extending from the driver section, a small diameter segment of length B extending from said large diameter segment, and a displacement antinode at the free end of the small diameter section comprising a flanged tip of thickness C, the improvement wherein A/B+C>1.
An ultrasonic transducer as described above wherein said flanged tip comprises an atomizing surface, said flange being of sufficient thickness to move as a rigid plane during vibration of the transducer.
An ultrasonic transducer assembly including a front ultrasonic horn section, a rear ultrasonic horn section, a driving element having at least one piezoelectric disc sandwiched between the front and rear ultrasonic horn sections, means for clamping the front and rear ultrasonic horn sections against the driving element, and an output section extending from the front ultrasonic horn section and terminating in an atomizing surface, wherein the improvement comprises: annular sealing means of compressible elastomeric material surrounding the at least one piezoelectric disc between the front and rear ultrasonic horn sections, said sealing means having an inner periphery which, in the unstressed condition, conforms to the shape of but is slightly greater than the periphery of the piezoelectric disc, and the compression exerted by the clamping means being sufficient to provide good acoustic coupling between the driving element and the front and rear ultrasonic horn sections when the inner periphery of the sealing means lightly contacts the outer periphery of the piezoelectric disc.
A transducer assembly comprising: a first section including a rear ultrasonic horn having a flanged portion at one end thereof, a front ultrasonic horn having a flanged portion at one end thereof, a driving element comprising a pair of piezoelectric discs and an electrode positioned there between, said driving element being positioned between the flanged portions of said front and rear horns, and means for clamping the flanged portions of said front and rear horns in compression against said driving element, said first section having an empirically measured characteristic resonant frequency; and a second section including a large diameter portion of length A integrally formed with the front horn of said first section, a small diameter portion of length B extending from said large diameter portion, the interface between said large diameter and small diameter portions constituting a step for amplifying vibratory motion at said atomizing surface, said second section having a theoretical resonant frequency matching the empirical resonant frequency of said first section.
An ultrasonic transducer as described above comprising a rigid flanged tip of thickness C on the forward end of said small diameter portion, said tip having an atomizing surface, wherein the second section is a half wavelength section and A>B+C.
An ultrasonic transducer as described above wherein the second section has a flanged tip comprising a vibrating surface capable of causing atomization in a liquid, and the transducer further comprises means for delivering liquid to said atomizing surface, said liquid delivery means including a passage extending through said second section to said atomizing surface and a decoupling sleeve mounted within said passage and extending to said atomizing surface for acoustically isolating the interior surface of said passage from liquid flowing therethrough.
A transducer assembly as described above wherein the means for clamping the flanged portions of said front and rear horns in compression against the driving element comprises a plurality of assembly bolts inserted in spaced relation through corresponding holes in the flanged portions of the front and rear horns.
A transducer assembly as described above further comprising: annular sealing means of compressible elastomeric material surrounding the piezoelectric discs between the flanges of the front and rear horns for preventing liquid from contacting the piezoelectric discs, said sealing means having an inner diameter which, in the unstressed condition, is larger than the outer diameter of each piezoelectric disc, such that predetermined compression exerted by the assembly bolts sufficient to provide good acoustic coupling between the driving element and the front and rear horns causes the inner circumference of the sealing means to lightly contact the outer circumference of each piezoelectric disc.
A transducer assembly as described above further comprising a mounting ring having a plurality of threaded holes aligned with the assembly bolt holes in the flanged portions of the front and rear horns, the mounting ring being clamped to the front face of the flanged portion of the front horn by engagement of the assembly bolts in the respective threaded holes.
A transducer assembly as described above wherein the first and second sections are half wavelength sections.

### Ultrasonic Atomizer

In one embodiment the ultrasonic spray technology according to the present invention comprises use of one or more ultrasonic atomizers such as one or more ultrasonic atomizers disclosed in U.S. Pat. No. 4,301,968 and/or one or more ultrasonic atomizers described herein below. U.S. Pat. No. 4,301,968 is hereby incorporated into this patent application in its entirety.
An ultrasonic atomizer having an atomizing surface, means for vibrating the atomizing surface with sufficient energy to atomize a liquid, and means for delivering a liquid to said atomizing surface, said liquid delivery means including a passage extending through said atomizer to said atomizing surface, wherein the improvement comprises a decoupling sleeve mounted within said passage and extending to said atomizing surface for isolating the liquid from contact with said passage, said decoupling sleeve being made of a material having different acoustical energy transmitting properties than the material of said atomizer, such that vibrational energy in the atomizer is attenuated by the sleeve.
An ultrasonic atomizer as described above wherein the decoupling sleeve is made of plastic and is press fit into the liquid passage.
An ultrasonic liquid atomizing transducer assembly having a driving element including a pair of piezoelectric discs and an electrode positioned therebetween; terminal means for feeding ultrasonic frequency electrical energy to said electrode; a rear dummy horn in the form of a first cylinder having a flanged portion at one end; and a front vibration amplifying horn in the form of a second cylinder having a flanged portion at one end and an amplifying portion extending from the other end, the second cylinder being equal in diameter to, but having a greater length than, the first cylinder, and the amplifying portion comprising an elongated segment having a diameter substantially smaller than the diameter of the second cylinder and a flanged tip, the outer face of which serves as an atomizing surface, an axial passage being provided through said front vibration amplifying horn for delivering liquid to said atomizing surface; delivery means for providing liquid to said passage; and means for clamping the driving element between the flanged ends of said first and second cylinders, said clamping means including a mounting ring, wherein the improvement comprises: said ultrasonic driving element, in combination with the rear dummy horn and a portion of the flanged end of said second cylinder equal in length to said rear dummy horn, define an equivalent symmetrical double-dummy first section having an empirically measurable characteristic resonant frequency different from its calculated theoretical resonant frequency, and the remainder of the second cylinder, having a length A, in addition to the elongated segment, having a length B, and the flanged atomizing tip, having an axial thickness C, define a second section having a calculated theoretical resonant frequency matching the empirically measured resonant frequency of said first section, and wherein said atomizing transducer assembly further comprises: first and second sealing gaskets surrounding said driving element piezoelectric discs and being compressed between said electrode and the flanged ends of the first and second cylinders, respectively, and a decoupling sleeve positioned within said passage and extending up to said atomizing surface for isolating the liquid from contact with the front vibration horn, said decoupling sleeve being made of a material having different acoustical energy transmitting properties than the material of said front vibration horn for attenuating vibrations transmitted from the front vibration horn to liquid in said passage.

### Ultrasonic Fuel Atomizer

In one embodiment the ultrasonic spray technology according to the present invention comprises use of one or more ultrasonic fuel atomizers such as one or more ultrasonic fuel atomizers disclosed in U.S. Pat. No. 4,337,896 and/or one or more ultrasonic atomizers described herein below. U.S. Pat. No. 4,337,896 is hereby incorporated into this patent application in its entirety.
An ultrasonic atomizer for producing a dispersed spray of finely divided liquid particles, the atomizer including a driver means having an output plane for providing longitudinal vibratory displacement at a predetermined ultrasonic operating frequency; a vibration amplifying means in the form of a stepped ultrasonic horn including a first cylindrical portion having an input end coincident with the output plane of the driver means, the length of the first cylindrical portion being equal to a quarter wavelength at said operating frequency, and a second cylindrical probe portion extending from the other end of the first cylindrical portion and having a diameter substantially smaller than the diameter of the first portion; a flanged tip on the outer end of the second cylindrical probe portion, the diameter of said flanged tip being substantially larger than the diameter of the probe portion but less than the diameter of the first cylindrical portion, and the outer face of said flanged tip forming an atomizing surface; and means for delivering a liquid to flow radially outward across said atomizing surface for atomization by the vibrations produced by said driving means, wherein the improvement comprises: said atomizing surface having a convexly conical shape that extends to the circumference of said flanged tip and produces a substantially conical spray pattern of finely divided droplets from liquid flowing thereover when the atomizer is driven at said operating frequency, the axis of said conical shape being parallel to the direction of longitudinal vibration, and the apex angle of said conical shape being supplementary to the spray cone angle of the atomized liquid; the flanged tip having a short cylindrical portion contiguous to and having the same diameter as the base of the conical atomizing surface for assuring that the atomizing surface vibrates only in the longitudinal mode; and the dimensions of said stepped ultrasonic horn conforming to dimensions calculated from the solution of the time-independent differential equation for the propagation of longitudinal waves in a solid medium at said predetermined ultrasonic operating frequency.
An ultrasonic atomizer as described above wherein said means for delivering liquid to said atomizing surface comprises a delivery passage extending axially through said probe portion and flanged tip and opening at the center of said atomizing surface.
An ultrasonic atomizer as described above wherein the flanged tip includes a thin annular planar surface surrounding the opening of the delivery passage, such that the atomizing surface comprises a frusto-conical surface.
An ultrasonic atomizer as described above wherein the first portion of the vibration amplifying means has a length A, the probe portion has a length B, and the flanged tip has an axial length C, and the sum of B and C is less than A.

Ultrasonic liquid atomizer having an axially-extendinq liquid feed passage In one embodiment the ultrasonic spray technology according to the present invention comprises use of one or more ultrasonic liquid atomizer having an axially-extending liquid feed passage such as one or more ultrasonic liquid atomizer having an axially-extending liquid feed passage disclosed in U.S. Pat. No. 4,352,459 and/or one or more ultrasonic liquid atomizer having an axially-extending liquid feed passage described herein below. U.S. Pat. No. 4,352,459 is hereby incorporated into this patent application in its entirety.
An ultrasonic transducer assembly for atomizing a liquid including a front ultrasonic horn section, a rear ultrasonic horn section, a driving means having at least on piezoelectric element and an electrode sandwiched between the front and rear sections, means for clamping the front and rear sections against the driving means, and an output section extending from the front section and terminating in an atomizing surface, wherein the improvement comprises a liquid passage axially extending through the front and rear sections and the driving means to the atomizing surface, the diameter of the driving means being less than the diameter of the front and rear sections adjacent the driving means, the means for clamping the front and rear sections comprising a plurality of fasteners connecting the front and rear sections and extending there between beyond the diameter of the driving means, and a tubular sleeve extending about each of the piezoelectric elements.
An ultrasonic transducer assembly for atomizing a liquid including a front ultrasonic horn section, a rear ultrasonic horn section, a driving means having at least one piezoelectric element and an electrode sandwiched between the front and rear ultrasonic horn sections, means for clamping the front and rear ultrasonic horn sections against the driving means, and an output section extending from the front ultrasonic horn section and terminating in an atomizing surface, wherein the improvement comprises a driving element of a diameter less than the diameter of the front and rear sections adjacent the driving means, and wherein the means for clamping comprises a plurality of fasteners connecting the front and rear sections and extending therebetween beyond the diameter of the driving means, the driving means comprising two said piezoelectric elements which are of annular configuration, each including an opening therethrough which forms part of the axially-extending passage, the electrode having an opening therethrough which forms part of the axially extending passage and being interposed between the piezoelectric elements, and a tubular sleeve disposed extending about each of the piezoelectric elements.
The improvement can be one or more of the following:
   the sleeves are of rubbery material
   the diameter of the piezoelectric elements is less than the diameter of the electrode and the outside diameter of the tubular sleeves is approximately equal to the diameter of the electrode.
   Inclusion of a liquid passage axially extending through the front and rear sections and the driving means to the atomizing surface.
An ultrasonic transducer assembly for atomizing a liquid including a front ultrasonic horn section, a rear ultrasonic horn section, a driving means having at least one piezoelectric element and an electrode sandwiched between the front and rear sections, means for clamping the front and rear sections against the driving means, and an output section extending from the front section and terminating in an atomizing surface, wherein the improvement comprises a liquid passage axially extending through the front and rear sections and the driving means to the atomizing surface, the output and the front and rear sections being of metal material, the ultrasonic transducer including a metal decoupling sleeve extending in the axially-extending passage within the output section to or adjacent to the atomizing surface, and the decoupling sleeve including a threaded end section and the front section including a threaded section, the decoupling sleeve being threadedly received in the front section.
The improvement can be one or more of the following:
   the axially-extending passage is adapted to receive a tubular member therein through which liquid is introduced into the passage.
   the tubular member includes a threaded end section adjacent the decoupling sleeve which is threadedly received in the threaded section in the front section.
   the decoupling sleeve and the tubular member constitute a single piece having threads which are threaded onto the threads of the front section.
   means are provided associated with the rear section and the tubular member for drawing the rear and front sections together upon threading the tubular member to the front section.
   means for drawing comprise mating annular flange portions on the tubular member and in the axially-extending passage in the rear section.
   threaded section in the front section is disposed at or adjacent to a nodal plane.
   Inclusion of a tubular member disposed at least in part in the axially-extending passage for introducing liquid into the transducer for delivery to the decoupling sleeve.
A transducer for atomizing liquids comprising an atomizing section having an atomizing surface, driving means disposed adjacent the atomizing section, the atomizing section and the driving means having a passage axially extending therethrough to the atomizing surface, a decoupling sleeve extending in the axially-extending passage within the atomizing section to or adjacent to the atomizing surface, the decoupling sleeve including a threaded end section and the atomizing section including a threaded section, the decoupling sleeve being threadedly received in the atomizing section, and means for coupling the driving means and the atomizing section to atomize liquid delivered to the atomizing surface through the axially-extending passage and decoupling sleeve in response to electrical excitation of the driving means.
The transducer as described above wherein the decoupling sleeve is metal.
The transducer as described above wherein the axially-extending passage is adapted to receive a tubular member therein through which liquid is introduced into the transducer.
The transducer as described above and including a tubular member disposed in the axially-extending passage for introducing liquid into the transducer for delivery to the decoupling sleeve.
The transducer as described above wherein means are provided in or adjacent to the atomizing section for securing the tubular member to the atomizing section.
The transducer as described above wherein the securing means is disposed at or adjacent to a nodal plane.
The transducer as described above wherein the securing means and the tubular member include threads, the threaded securing means threadedly receiving the tubular member.
The transducer as described above wherein the decoupling sleeve and the tubular member constitute a single piece having threads which are threaded onto the threads of the securing means.
The transducer as described above wherein the atomizing section and the decoupling sleeve are of metal material.
An ultrasonic fuel atomizer including driving means and an output section having an atomizing surface, the improvement comprising a fuel passage axially extending in the atomizer from one end thereof through the driving means to the atomizing surface and a fuel tube through which fuel is adapted to be supplied to the atomizer, the fuel tube extending in said passage and including a decoupling sleeve section extending within the output section to or adjacent to the atomizing surface, the fuel tube and decoupling sleeve section constituting a single piece, and means provided in or adjacent to the output section for securing the single piece to the output section.
The improvement can be one or more of the following:
   selected sections of the atomizer including the output section are of metal and the single piece fuel tube and decoupling sleeve is of metal.
   the selected sections including the output sections are of aluminum.
   the single piece fuel tube and decoupling sleeve is of aluminum.
   the single piece comprises a sole support for mounting the atomizer.
   the securing means includes threads in the axially-extending passage in the output section and the single piece includes threads, the threaded securing means threadedly receiving the single piece.
   the atomizer includes a rear section disposed adjacent to the driving means which with the output section sandwiches the driving means, the securing means being disposed in the output section, and including an annular flange portion on the single piece and a mating annular flange section in the axially-extending passage and the rear section, the flange sections engaging and drawing the rear and output sections together upon threading the single piece onto the securing means.
   the securing means is disposed at or adjacent to a nodal plane.
   the fuel tube includes means for connecting it to a fuel supply means.
An ultrasonic fuel atomizer including an atomizing section having an atomizing surface, driving means disposed adjacent to the atomizing section and means for coupling the driving means to the atomizing section, the improvement comprising a fuel passage axially extending in the atomizer from one end thereof through the driving means to the atomizing surface, a decoupling sleeve in the axially-extending passage in the atomizing section with one end thereof extending substantially to the atomizing surface, the axially-extending passage being adapted to receive a tubular member through which liquid can be introduced into the transducer and delivered through the decoupling sleeve to the atomizing surface, and means provided in or adjacent to the atomizing section adapted to secure the tubular member to the atomizing section with one end of the tubular member adjacent to the other end of the decoupling sleeve, the securing means being spaced radially inwardly of the coupling means.
An ultrasonic fuel atomizer including an atomizing section having an atomizing surface, driving means disposed adjacent to the atomizing section, a rear section disposed adjacent to the driving means which with the atomizing section sandwiches the driving means, and means for coupling the driving means to the atomizing section, the improvement comprising a fuel passage axially extending in the atomizer from one end thereof through the driving means and the rear means to the atomizing surface, a tubular member having a threaded portion disposed in the axially-extending passage through which liquid can be introduced into the transducer and delivered to the atomizing surface, means provided in or adjacent to the atomizing section for securing the tubular member to the atomizing section comprising threads in the axially-extending passage which receive the threaded portion of the tubular member, the securing means being spaced radially inwardly of the coupling means, and means associated with the rear section and the tubular member for drawing the rear and the atomizer sections together upon threading the tubular member to the atomizing section.
The improvement can be one or more of the following:
   inclusion of the tubular member which is secured to the atomizing section.
   the tubular member comprises a part of a fuel tube through which fuel is adapted to be supplied to the atomizer.
   including a decoupling sleeve extending in the output section of the atomizer to or adjacent to the atomizing surface.
   the decoupling sleeve is secured to the atomizing section by the securing means.
   the decoupling sleeve includes a threaded section received in the threaded section in the axially-extending passage in the atomizing section.
   the decoupling sleeve and the tubular member constitute a single metal piece.
   the decoupling sleeve and the tubular member constitute a single piece and the threads of the tubular member are located on the tubular member adjacent to the decoupling sleeve.
   the tubular means comprises a sole support for mounting the atomizer.
   the transducer includes a rear section disposed adjacent to the driving means which with the atomizing section sandwiches the driving means, the axially-extending passage extending through the rear section, and means associated with the rear section and the single piece for drawing the rear and atomizing sections together upon securing the tubular member to the atomizing section.
   including the tubular member which is secured to the atomizing section,
   wherein the tubular member includes threads and the securing means includes a threaded section in the axially-extending passage in the atomizing section, the threads of the tubular member being received by the threaded section of the securing means.
   the securing means is disposed at or adjacent to a nodal plane.
   the means for drawing comprise flanged portions on the tubular member and the rear section adapted to engage each other to draw the front and rear sections together upon threading the tubular member to the front section.
   the securing means is disposed at or adjacent to a nodal plane.
An ultrasonic transducer assembly for atomizing a liquid including a front ultrasonic horn section, a rear ultrasonic horn section, driving means having at least one piezoelectric element and an electrode sandwiched between the front and rear sections, means spaced radially outwardly of the axis of the transducer for clamping the front and rear sections against the driving means, and an output section extending from the front section and terminating in an atomizing surface, wherein the improvement comprises a liquid passage axially extending through the front and rear sections and the driving means to the atomizing surface, a decoupling sleeve in the axially-extending passage in the front section with one end thereof extending substantially to the atomizing surface, the axially-extending passage being adapted to receive a tubular member through which liquid can be introduced into the transducer and delivered through the decoupling sleeve to the atomizing surface, and means provided in or adjacent to the front section adapted to secure the tubular member to the front section with one end of the tubular member adjacent to the other end of the decoupling sleeve.
An ultrasonic transducer assembly for atomizing a liquid including a front ultrasonic horn section, a rear ultrasonic horn section, driving means having at least one piezoelectric element and an electrode sandwiched between the front and rear sections, means spaced radially outwardly of the axis of the transducer for clamping the front and rear sections against the driving means, and an output section extending from the front section and terminating in an atomizing surface, wherein the improvement comprises a liquid passage axially extending through the front and rear sections and the driving means to the atomizing surface, a tubular member having a threaded portion disposed in the axially-extending passage through which liquid can be introduced into the transducer and delivered to the atomizing surface, means provided in or adjacent to the front section for securing the tubular member to the front section comprising threads in the axially extending passage which receive the threaded portion of the tubular member, and means associated with the rear section and the tubular member for drawing the rear and the front sections together upon threading the tubular member to the front section.
The improvement can be one or more of the following:
   the at least one piezoelectric element is of annular configuration including an opening therein which forms part of the axially-extending passage.
   the driving means comprises two said piezoelectric elements, the electrode having an opening therethrough which forms part of the axially-extending passage and being interposed between the piezoelectric elements.
   the diameter of the driving means is less than the diameter of the front and rear sections adjacent the driving means, and the means for clamping the front and rear sections comprises a plurality of fasteners connecting the front and rear sections and extending therebetween beyond the diameter of the driving means.
   inclusion of a tubular sleeve extending about each of the piezoelectric elements.
   the sleeves are of rubbery material.
   the diameter of the piezoelectric elements is less than the diameter of the electrode and the outside diameter of the tubular sleeves is approximately equal to the diameter of the electrode.
   inclusion of the tubular member which is secured to the front section.
   the tubular member comprises a part of a liquid supply tube.
   including a decoupling sleeve extending in the front section substantially from the atomizing surface to the threads in the axially-extending passage which receive the threaded portion of the tubular member.
   including further means for securing the decoupling sleeve in the front section.
   the decoupling sleeve and the tubular member constitute a single piece.
   the decoupling sleeve and the tubular member are metal.
   the single piece decoupling sleeve and the tubular member comprise part of a liquid supply tube.
   the decoupling sleeve is metal.
   the means for drawing comprise mating annular flange portions on the tubular member and in the rear section, the decoupling sleeve and tubular member constituting a single piece.
   the securing means is disposed at or adjacent to a nodal plane.
   the decoupling sleeve includes a threaded end section threadedly received in the threaded section of the axially-extending passage.
   the output, front and rear sections, and the decoupling sleeve are of aluminum.
   the tubular member includes an externally threaded section and the securing means comprises an internally threaded section in the axially-extending passage in the front section, the externally-threaded tubular member section being threadedly received in the internally-threaded section.
   inclusion of means for insulating the electrode from the tubular member.
   the tubular member comprises a sole support for mounting the transducer.
   the tubular member extends exteriorly of the transducer and is adapted to be connected to a means for supplying liquid to the axially-extending passage.
   the tubular member includes means adjacent to the transducer for connecting the tubular member to the means for supplying liquid.
   the securing means is disposed at or adjacent to a nodal plane.
   the output and the front and rear sections, and the decoupling sleeve are of metal material.
   the decoupling sleeve and the tubular member constitute a single piece and the threaded portion of the tubular member is located adjacent to the decoupling sleeve.
   the rear and front ultrasonic horn sections form a symmetrical double-dummy ultrasonic horn.
   the means for drawing comprise mating annular flange portions on the tubualr member and in the rearsection.
   the securing means is disposed at or adjacent to a nodal plane.
A transducer for atomizing liquids comprising an atomizing section having an atomizing surface, driving means disposed adjacent to the atomizing section, the atomizing section and the driving means having a passage axially extending therethrough to the atomizing surface, a decoupling sleeve in the axially-extending passage in the atomizing section with one end thereof extending substantially to the atomizing surface, the axially-extending passage being adapted to receive a tubular member through which liquid can be introduced into the transducer and delivered through the decoupling sleeve to the atomizing surface, means provided in or adjacent to the atomizing section adapted to secure the tubular member to the atomizing section with one end of the tubular member adjacent to the other end of the decoupling sleeve, and means cooperating with the atomizing section spaced radially outwardly from the axially-extending passage for coupling the driving means and the atomizing section to atomize liquid delivered to the atomizing surface through the tubular member and the decoupling sleeve in response to electrical excitation of the driving means.
A transducer for atomizing liquids comprising an atomizing section having an atomizing surface, driving means disposed adjacent to the atomizing section, a rear section disposed adjacent to the driving means which with the atomizing section sandwiches the driving means, the atomizing section, the driving means and the rear section having a passage axially extending therethrough to the atomizing surface, a tubular member having a threaded portion disposed in the axially-extending passage through which liquid can be introduced into the transducer and delivered to the atomizing surface, means provided in or adjacent to the atomizing section for securing the tubular member to the atomizing section comprising threads in the axially-extending passage which receive the threaded portion of the tubular member, means associated with the rear section and the tubular member for drawing the rear and the atomizer sections together upon threading the tubular member to the atomizing section, and means for coupling the driving means and the atomizing section to atomize liquid delivered to the atomizing surface through the tubular member in response to electrical excitation of the driving means.
The transducer as described above wherein the driving means comprises at least one piezoelectric driving element having an axially-extending opening therethrough which forms part of the axially-extending passage.
The transducer as described above wherein the driving means comprises two said piezoelectric driving elements, and an electrode having an opening therethrough which forms part of the axially-extending passage, the electrode being interposed between the piezoelectric driving elements.
The transducer as described above and including the tubular member which is secured to the atomizing section.
The transducer as described above wherein the tubular member comprises a part of a liquid supply tube.
The transducer as described above and including a decoupling sleeve extending in the atomizing section substantially from the atomizing surface to the threads in the axially-extending passage which receive the threaded portion of the tubular member.
The transducer as described above and including further means for securing the decoupling sleeve in the atomizing section.
The transducer as described above wherein the decoupling sleeve and the tubular member constitute a single piece.
The transducer as described above wherein the decoupling sleeve and the tubular member are metal.
The transducer as described above wherein the single piece decoupling sleeve and the tubular member comprise part of a liquid supply tube.
The transducer as described above wherein the decoupling sleeve is metal.
The transducer as described above wherein the tubular member includes an externally threaded section and the securing means comprises an internally threaded section in the axially-extending passage in the atomizing section, the externally-threaded tubular member section being threadedly received in the internally-threaded section.
The transducer as described above wherein the securing means is disposed at or adjacent to a nodal plane.
The transducer as described above wherein the decoupling sleeve and the tubular member constitute a single piece and wherein the transducer includes a rear section disposed adjacent to the driving means which with the atomizing section sandwiches the driving means, the axially-extending passage extending through the rear section, and means associated with the rear section and the single piece for drawing the rear and atomizing sections together upon securing the single piece to the atomizing section.
The transducer as described above wherein the means for drawing comprise mating annular flange portions on the tubular member and in the axially-extending passage in the rear section.
The transducer as described above wherein the tubular member comprises a sole support for mounting the transducer.
The transducer as described above wherein the driving means comprises an electrode having an opening which forms part of the axially-extending passage and including means for insulating the electrode from the tubular member.
The transducer as described above wherein the tubular member extends exteriorly of the transducer and is adapted to be connected to a means for supplying liquid to the axially-extending passage.
The transducer as described above wherein the tubular member includes means adjacent to the transducer for connecting the tubular member to the means for supplying liquid.
The transducer as described above and including the tubular member which is secured to the atomizing section, wherein the securing means includes threads disposed in the axially-extending passage in the atomizing section and the tubular member includes threads, the threaded securing means threadedly receiving the tubular member.
The transducer as described above wherein the securing means is disposed at or adjacent to a nodal plane.
The transducer as described above wherein the atomizing section and the decoupling sleeve are of metal material.
The transducer as described above wherein the atomizing section and the decoupling sleeve are of aluminum.
The transducer as described above wherein the decoupling sleeve and the tubular member constitute a single piece and the threaded portion of the tubular member is located adjacent to the decoupling sleeve.
The transducer as described above wherein the means for drawing comprise mating annular flange portions on the tubular member and in the axially-extending passage in the rear section, the decoupling sleeve and the tubular member constituting a single piece.
The transducer as described above wherein the securing means is disposed at or adjacent to a nodal plane.
The transducer as described above wherein the decoupling sleeve includes a threaded portion received in the threads in the axially-extended passage.
The transducer as described above wherein the decoupling sleeve includes a threaded end section and the axially-extending passage in the atomizing section includes a threaded section, the decoupling sleeve being threadedly received in the threaded section of the atomizing section.
The transducer as described above wherein said coupling means cooperate with the atomizing section and are spaced radially outwardly from the axially-extending passage.
The transducer as described above wherein the means for drawing comprise mating annular flange portions on the tubular member and in the axially-extending passage in the rear section.
The transducer as described above wherein the securing means is disposed at or adjacent to a nodal plane.

### Ultrasonic Liquid Atomizer Tip

In one embodiment the ultrasonic spray technology according to the present invention comprises use of one or more features such as one or more ultrasonic liquid atomizer tips such as one or more features such as one or more ultrasonic liquid atomizer tips disclosed in U.S. Pat. No. 4,541,564 and/or one or more features such as one or more ultrasonic liquid atomizer tips described herein below. U.S. Pat. No. 4,541,564 is hereby incorporated into this patent application in its entirety.
An ultrasonic liquid atomizer tip for providing an atomized spray of liquid comprising an atomizing surface, a plurality of orifices in the atomizing surface through which liquid is delivered to the atomizing surface and a baffle disposed to be operative adjacent to that portion of the atomizing surface in which all of the orifices are disposed and spaced from the atomizing surface, and having a flat surface of predetermined area facing and substantially parallel to the atomizing surface, for preventing unatomized liquid from leaving the atomizer tip and entering the atomized spray through said surface of predetermined area adjacent the tip.
The atomizer tip as described above wherein the atomizing surface is circular, all the orifices are disposed within the circumference of a circle having a diameter less than that of the atomizing surface, and the baffle comprises a disc-shaped member supported concentrically with respect to said circle and having a diameter substantially equal to the diameter of said circle.
The atomizer tip as described above and comprising first means disposed to be operative about at least a portion of the periphery of the atomizing surface for preventing liquid from leaving the atomizing surface in substantially transverse directions.
The atomizer tip as described above wherein the first means comprises a lip disposed about and extending from at least a portion of the periphery of the atomizing surface.
An ultrasonic liquid atomizer tip for providing an atomized spray of liquid comprising a circular atomizing surface, a plurality of orifices in the atomizing surface through which liquid is delivered to the atomizing surface, a lip disposed about and extending from the complete circular periphery of the atomizing surface for preventing liquid from leaving the atomizing surface in substantially transverse directions, and a liquid impervious barrier of predetermined area disposed to be operative adjacent to and spaced from the atomizing surface for preventing at least unatomized liquid from leaving the atomizer tip through the predetermined area of the barrier adjacent the tip.
The atomizer tip as described above wherein the barrier is a disc-shaped member.
A front section of an ultrasonic liquid atomizer comprising a larger section, a stepped, smaller section coupled to the larger section and an enlarged tip coupled to the stepped section, the enlarged tip including an atomizing surface thereon, a plurality of orifices disposed in the atomizing surface through which liquid is delivered to the atomizing surface and a corresponding plurality of individual liquid feed passages axially extending in the stepped section each in communication with a respective orifice, a common liquid feed passage in the larger section which communicates with all of the individual passages, and a baffle disposed adjacent to and spaced from the atomizing surface for preventing unatomized liquid from leaving the atomizer tip through a surface of predetermined area adjacent the tip and entering an atomized spray produced by the front section.
The front section as described above the baffle being disposed to be operative adjacent to that portion of the atomizing surface in which the orifices are disposed.
The front section as described above wherein the front section is of generally stepped tubular configuration, the enlarged tip is disc-shaped and all the orifices are disposed within the circumference of a circle having a diameter less than that of the enlarged tip.
The front section as described above wherein the baffle is a disc-shaped member disposed concentrically with respect to said circle and having a diameter substantially equal to the diameter of said circle.
The front section as described above and comprising first means disposed to be operative about at least a portion of the periphery of the atomizing surface for preventing liquid from leaving the atomizing surface in substantially transverse directions.
The front section as described above wherein the first means comprises a lip disposed about and extending from a portion of the periphery of the atomizing surface.
The front section as described above and comprising a transition which gradually increases from the stepped section to enlarged tip.
The front section as described above wherein the front section is of generally tubular configuration and the enlarged tip is disc-shaped, the transition gradually increasing in diameter from the stepped section to the enlarged tip.
The front section as described above in which each individual passage excludes decoupling members.
The front section as described above and comprising a transition of gradually increasing diameter coupling a tubular stepped section and a disc-shaped enlarged tip.
A front section for an ultrasonic liquid atomizer comprising a larger generally tubular section, a stepped, smaller generally tubular section coupled to the larger section and an enlarged disc-shaped tip coupled to the stepped section, the enlarged tip including an atomizing surface thereon, a plurality of orifices in the atomizing surface through which liquid is delivered to the atomizing surface and a corresponding plurality of individual liquid feed passages axially extending through the stepped section, each in communication with a respective orifice, a common liquid feed passge in the larger section which communicates with all of the individual feed passages, a baffle disposed adjacent to and spaced from the atomizing surface, and having a flat surface of predetermined area facing and substantially parallel to the atomizing surface, for preventing unatomized liquid from leaving the atomizing tip and entering the atomized spray through said surface of predetermined area adjacent the tip, and a lip disposed completely about and extending from the periphery of the disc-shaped tip for preventing liquid from leaving the atomizing surface in substantially transverse directions.
The front section as described above and comprising a transition which gradually increases from the stepped section to the enlarged tip.
An ultrasonic liquid atomizer comprising a front section, a rear section and driving means disposed between the two sections for imparting ultrasonic vibrations to the front section, the front section comprising a larger generally tubular section, a stepped, generally tubular smaller section coupled to the larger section and an enlarged tip coupled to the stepped section, the enlarged tip including an atomizing surface thereon, a plurality of orifices in the atomizing surface through which liquid is delivered to the atomizing surface, a corresponding plurality of individual liquid feed passages axially extending through the stepped section each in communication with a respective orifice, a common liquid feed passage in the larger section which communicates with all of the individual passages, and a baffle disposed to be operative adjacent to that portion of the atomizing surface in which the orifices are disposed and spaced from the atomizing surface, and having a flat surface of predetermined area facing and substantially parallel to the atomizing surface, for preventing unatomized liquid from leaving the atomizer tip through a surface of predetermined area adjacent the tip and entering an atomized spray produced by the front section.
The ultrasonic liquid atomizer as described above wherein the enlarged tip is disc-shaped and all the orifices are disposed within the circumference of a circle having a diameter less than that of the disc-shaped tip, and the baffle is a disc-shaped member disposed concentically with respect to said circle and having a diameter substantially equal to the diameter of said circle.
The ultrasonic liquid atomizer as described above and comprising first means disposed to be operative about at least a portion of the periphery of the atomizing surface for preventing liquid from leaving the atomizing surface in substantially tramsverse directions.
The ultrasonic liquid atomizer as described above wherein the first means comprises a lip disposed about and extending from at least a portion of the periphery of the atomizing surface.

Ultrasonic Transducer Drive Circuit In one embodiment the ultrasonic spray technology according to the present invention comprises use of one or more features such as one or more Ultrasonic transducer drive circuits such as one or more features such as one or more Ultrasonic transducer drive circuits disclosed in U.S. Pat. No. 4,642,581 and/or one or more features such as one or more Ultrasonic transducer drive circuits described herein below. U.S. Pat. No. 4,642,581 is hereby incorporated into this patent application in its entirety.
An ultrasonic transducer drive circuit comprising: (a) variable power driving means for supplying power to and driving the transducer; (b) oscillating means for generating and supplying a drive signal, with a frequency proportional to the phase response of the transducer during operation, to the power driving means, said drive signal fixing the frequency of the power supplied to the transducer substantially at the frequency of the transducer; (c) phase detecting and locking means for detecting the phase response of the transducer during operation and inputting a signal proportional thereto to the oscillating means such that the frequency of the oscillating means is shifted proportional to the phase response of the transducer; and (d) low pass filter means, coupled between the oscillating means and the phase detecting and locking means, for controlling the rate of the frequency shift of the oscillating means in response to said inputted signal from the phase detecting and locking means.
The drive circuit as described above wherein the oscillating means, the phase detecting and locking means and the low pass filter means combination is a positive feedback driver for the driving means and the phase detecting and locking means detects, and is responsive to, a voltage outputted by the driving means and proportional to the phase of the current in the transducer.
The drive circuit as described above wherein the oscillating means, the phase detecting and locking means and the low pass filter means combination composes an integrated circuit phase-locked loop oscillator circuit.
The drive circuit as described above wherein the driving means comprises a transformer-coupled output of a MOSFET power transistor to a resonant power transfer network.
The drive circuit as described above wherein the driving means comprises a transformer-coupled output of a MOSFET power transistor to a resonant power transfer network.
An ultrasonic generator comprising: (a) transducing means for generating ultrasonic waves; (b) variable power driving means for supplying power to and driving the transducer; (c) oscillating means for generating and supplying a drive signal, with a frequency proportional to the phase response of the transducer during operation, to the power driving means, said drive signal fixing the frequency of the power supplied to the transducer substantially at the frequency of the transducer; (d) phase detecting and locking means for detecting the phase response of the transducer during operation and inputting a signal proportional thereto to the oscillating means such that the frequency of the oscillating means is shifted proportional to the phase response of the transducer; and (e) low pass filter means, coupled between the oscillating means and the phase detecting and locking means, for controlling the rate of the frequency shift of the oscillating means in response to said inputted signal for the phase detecting and locking means.
The ultrasonic generator as described above wherein the oscillating means, the phase detecting and locking means and the low pass filter means combination is a positive feedback driver for the driving means and the phase detecting and locking means detects, and is responsive to, a voltage outputted by the driving means and proportional to the phase of the current in the transducer.
The ultrasonic generator as described above wherein the oscillating means, the phase detecting and locking means and the low pass filter means combination composes an integrated circuit phase-locked loop oscillator circuit.
The ultrasonic generator as described above wherein the driving means comprises a transformer-coupled output of a MOSFET power transistor to a resonant power transfer circuit.
The ultrasonic generator as described above wherein the driving means comprises a transformer-coupled output of a MOSFET power transistor to a resonant power transfer network.

### Ultrasonic Liquid Atomizing Transducer Assembly

In one embodiment the ultrasonic spray technology according to the present invention comprises use of one or more features such as one or more ultrasonic liquid atomizing transducer assemblies such as one or more features such as one or more ultrasonic liquid atomizing transducer assemblies disclosed in U.S. Pat. No. 4,723,708 and/or one or more features such as one or more ultrasonic liquid atomizing transducer assemblies described herein below. U.S. Pat. No. 4,723,708 is hereby incorporated into this patent application in its entirety.
An ultrasonic liquid atomizing transducer assembly comprising: a driving element including a pair of annular piezoelectric disks and an annular electrode coaxially positioned therebetween; terminal means for feeding ultrasonic frequency electrical energy to said electrode; a cylindrical rear dummy section having a front end contacting one piezoelectric disk of the driving element, a rear end, and a constant outside diameter from the front end to the rear end; a front section having a cylindrical portion, the cylindrical portion having a rear end contacting the other piezoelectric disk of the driving element and a front end, and an amplifying portion extending from the front end of the cylindrical portion, the amplifying portion comprising a probe having a tip that forms an atomizing surface, an axial passage being provided through the length of the transducer assembly from the rear end of the rear dummy section to the atomizing surface, and a portion of the passage adjacent the driving element in both the front atomizing section and the rear dummy section being enlarged and internally threaded; a tubular central bolt having an externally threaded portion engaging said internally threaded portion of the passage in both the front atomizing section and the rear dummy section with sufficient torque to connect the front atomizing section and the rear dummy section under a tension that provides all of a predetermined total compressive preload on the driving element, the externally threaded portion extending from a front end portion of the bolt located in the front atomizing section and formed with a smooth cylindrical sealing surface to a rear feed tube portion of the bolt located in the rear dummy section and extending axially beyond the rear end of the dummy section; and means for sealing the piezoelectric disks from contact with the liquid being atomized, said means comprising a resilient annular sealing member disposed between said sealing surface and the axial passage in the front section to prevent liquid flowing in the passage from reaching the inner circumferential surfaces of the piezoelectric disks.
An atomizing transducer assembly as described above wherein the annular sealing member comprises an O-ring.
An atomizing transducer assembly as described above wherein the means for sealing the piezoelectric disks comprises an additional annular sealing member disposed between the smooth exterior surface of said liquid feed tube and the axial passage to prevent moisture in the environment surrounding the transducer assembly from reaching the inner circumferential surfaces of the piezoelectric disks.
An atomizing transducer assembly as described above wherein the additional annular sealing member comprises an O-ring.
An atomizing transducer assembly comprising: a driving element including a pair of annular piezoelectric disks and an annular electrode coaxially positioned therebetween; terminal means for feeding ultrasonic frequency electrical energy to said electrode; a cylindrical rear dummy section having a front face contacting one piezoelectric disk of the driving element, a rear face, the dummy section having a constant outside diameter from the front face to the rear face, and a concentric portion having a smooth cylindrical outer sealing surface of reduced diameter extending from said rear face; a front section having a cylindrical portion, the cylindrical portion having a rear face contacting the other piezoelectric disk of the driving element and a front face, and an amplifying portion extending from the front face of the cylindrical portion, the amplifying portion comprising a probe having a tip that forms an atomizing surface, an axial passage being provided through the length of the transducer assembly from the rear face of the rear dummy section to the atomizing surface, and a portion of the passage adjacent the driving element in both the front atomizing section and the rear dummy section being enlarged and internally threaded; a tubular central bolt having an externally threaded portion engaging said internally threaded portion of the passage in both the front atomizing section and the rear dummy section with sufficient torque to connect the front atomizing section and the rear dummy section under a tension that provides all of a predetermined total compressive preload on the driving element, the externally threaded portion extending from a front end portion of the bolt located in the front atomizing section and formed with a smooth cylindrical sealing surface to a rear feed tube portion of the bolt located in the rear dummy section and extending axially beyond the rear end of the dummy section; and means for sealing the piezoelectric disks from contact with the liquid being atomized, said means comprising a resilient first annular sealing member disposed between said sealing surface and the axial passage in the front section, to prevent liquid flowing in the passage from reaching the inner circumferential surfaces of the piezoelectric disks, and an enclosed circular cylindrical shell surrounding the transducer assembly, the cylindrical shell having a front end wall provided with a first cylindrical passage that loosely receives the cylindrical portion of the front section, a rear wall provided with a second cylindrical passage that loosely surrounds the concentric portion extending from the rear face of the dummy section, a resilient second annular sealing means disposed between the inner surface of the first cylindrical passage and the circumference of the cylindrical portion of the front section, and a resilient third annular sealing means disposed between the inner surface of the second cylindrical passage and the outer sealing surface of the concentric portion, the radial spacing between the cylindrical portion of the front section and the first cylindrical passage and the radial spacing between the concentric portion of the rear dummy section and the second cylindrical passage being respectively less than the radial thicknesses of the second and the third annular sealing means when unconstrained, so that the second and third annular sealing means are radially compressed between said passages and said cylindrical and concentric portions, respectively, and wherein said first and second annular sealing means are unconstrained in the axial direction, with no axial pressure exerted thereon.
An atomizing transducer assembly as described above wherein said enclosed shell comprises a cylindrical cup and a cylindrical cap threadedly fitting on said cup.
   Ultrasonic Liquid Atomizing Transducer Assembly with Enhanced Sealing Against External Fluids

In one embodiment the ultrasonic spray technology according to the present invention comprises use of one or more ultrasonic liquid atomizing transducer assemblies with enhanced sealing against external fluids such as one or more ultrasonic liquid atomizing transducer assemblies with enhanced sealing against external fluids disclosed in U.S. Pat. No. 4,978,067 and/or one or more ultrasonic liquid atomizing transducer assemblies with enhanced sealing against external fluids described herein below. U.S. Pat. No. 4,978,067 is hereby incorporated into this patent application in its entirety.
An ultrasonic liquid atomizing transducer assembly with enhanced sealing against external fluids comprising: a driving element including a pair of annular piezoelectric disks and an input electrode; means for feeding ultrasonic frequency electrical energy thereto; a cylindrical rear dummy section having a front end contacting one piezoelectric disk of the driving element, a rear end, a threaded bore, and a constant outside diameter from the front end to the rear end; a unitary axial feed tube and atomizing surface, comprising from front to rear: (a) an atomizing tip; (b) a conical quarter wavelength amplifying probe or horn extending to: (c) a disk section with front, rear, and circumferential surfaces, said rear surface comprising a circumferential flange sized for the retention of a sealing ring, and said circumferential surface of said disk having a groove cut thereinto to act as a receptacle for a sealing ring; (d) an axial flow tube of reduced diameter which bears threads on its outer mid-section for the threadable attachment of the dummy section thereto, and which bears at its rear end a groove cut thereon to receive a sealing ring.
An ultrasonic liquid atomizing transducer assembly with enhanced sealing against external fluids comprising: a driving element including a pair of annular piezoelectric disks and an input electrode; means for feeding ultrasonic frequency electrical energy thereto; a cylindrical rear dummy section having a front end contacting one piezoelectric disk of the driving element, a rear end, a threaded bore, and a constant outside diameter from the front end to the rear end; a unitary axial feed tube and atomizing surface, comprising from front to rear; (a) an atomizing tip; (b) a conical quarter wavelength amplifying probe or horn extending to: (c) a disk section with front, rear, and circumferential surfaces, said rear surface comprising a circumferential flange sized for the retention of a sealing ring, and said circumferential surface of said disk having a groove cut thereinto to act as a receptacle for a sealing ring; (d) an axial flow tube of reduced diameter which bears threads on its outer mid-section for the threadable attachment of the dummy section thereto, and which bears at its rear end a groove cut thereon to receive a sealing ring; (e) an axial through-bore for the passage of fluid; two piece cup-shaped housing elements threadably attached to each other so as to define a gap therebetween for the placement of a sealing ring, a sealing ring within said gap, front and rear end faces which contain holes sized to mate with the front disk and reduced diameter axial flow tube portion respectively, sealing rings placed along the outer portion of the front disk against the flange there situated and within the circumferential groove of the front disk which mate against the front face of the front housing element, sealing rings placed immediately adjacent the rear wall of the dummy section and within the groove along the axial flow tube to mate with the face of the rear housing element and act as rear and front bumpers to maintain the transducer structure in place inside the cups.

### Apparatus for Generating a Stream of Atomized Fluid

In one embodiment the ultrasonic spray technology according to the present invention comprises use of one or more apparatuses for generating a stream of atomized fluid such as one or more apparatuses for generating a stream of atomized fluid disclosed in U.S. Pat. No. 5,219,120 and/or one or more apparatuses for generating a stream of atomized fluid described herein below. U.S. Pat. No. 5,219,120 is hereby incorporated into this patent application in its entirety.
An apparatus for generating a stream of atomized fluid comprising: an atomizer for discharging an atomized stream of fluid; an air unit for discharging a stream of air intersecting the path of the atomized stream of fluid for entraining the atomized stream of fluid within the stream of air; and at least one air jet for discharging a stream of air into the atomized stream of fluid to shear the atomized stream of fluid into at least one plume of atomized fluid.
An apparatus as defined above comprising two air jets, each air jet being located on an opposite side of the atomizer relative to the other for discharging a jet of air in a substantially opposite direction relative to the other.
An apparatus as defined above wherein the air unit discharges a substantially uniform stream of air which entrains the atomized stream of fluid to form a substantially uniform moving sheet of atomized fluid.
An apparatus as defined above wherein the air unit defines a substantially rectangular discharge opening for discharging a substantially uniform moving stream of air.
An apparatus as defined above wherein the atomizer is an ultrasonic atomizer for discharging a substantially conical pattern of atomized fluid.
An apparatus as defined above wherein the atomized stream of fluid is flux for uniformly coating circuit boards.
An apparatus for generating a stream of atomized fluid comprising: an ultrasonic atomizer for discharging a substantially conical pattern of atomized fluid; an air unit for discharging a stream of air intersecting the path of the atomized stream of fluid for entraining the atomized stream of fluid within the stream of air; and a first air jet located on one side of the atomizer for discharging a first jet of air into the conical pattern of atomized fluid to form a first plume of atomized fluid, and a second air jet located on the other side of the atomizer relative to the first air jet for discharging a second jet of air into the conical pattern of atomized fluid in a direction substantially opposite the direction of the first air jet to form a second plume of atomized fluid.
An apparatus as defined above wherein the overall width of the first and second plumes of atomized fluid is selected by controlling the air pressure of the first and second air jets.
An apparatus as defined above wherein the first and second air jets are each directed in a direction substantially perpendicular to the longitudinal axis of the atomizer for shearing the conical pattern to form the first and second plumes, respectively.

Bioactive Agents of the Pharmaceutical Composition

In a preferred embodiment, the invention relates to a pharmaceutical composition initially in fluid or liquid form, comprising one or more bioactive agents, optionally in combination with further active agents or substances, thus comprising a pharmaceutical composition that includes a pharmaceutically acceptable carrier and one or more bioactive agents, such as thrombin or thrombin in combination with fibrinogen, or thrombin and fibrinogen in combination with Factor XIII, or thrombin and fibrinogen and Factor XIII in combination with tranexamic acid.

The pharmaceutical composition is in one embodiment applied onto a surface of the matrix of the device by ultrasonic spray technology, thereby depositing the agents of the composition onto the surface of the matrix in a controlled manner. One or more of said compositions may be applied each at one or more positions on the surface of the matrix material.

Non-limiting examples of useful biologically active agents which can be present alone or in combination with the above-cited bioactive agents selected from the group of thrombin or thrombin in combination with fibrinogen, or thrombin and fibrinogen in combination with Factor XIII, or thrombin and fibrinogen and Factor XIII in combination with tranexamic acid, include the following expanded therapeutic categories: hemostatic and anti-fibrinolytic agents, wound healing or promoting agents, adhesives and surfactants anabolic agents, antacids, anti-asthmatic agents, anti-cholesterolemic and anti-lipid agents, anti-coagulants, anti-convulsants, anti-diarrheals, anti-emetics, anti-infective agents, anti-inflammatory agents, anti-manic agents, anti-nauseants, anti-neoplastic agents, anti-obesity agents, anti-pyretic and analgesic agents, anti-spasmodic agents, anti-thrombotic agents, anti-uricemic agents, anti-anginal agents, anti-histamines, anti-tussives, appetite suppressants, biologicals, cerebral dilators, coronary dilators, decongestants, diuretics, diagnostic agents, erythropoietic agents, expectorants, gastrointestinal sedatives hyperglycemic agents, hypnotics, hypoglycemic agents, ion exchange resins, laxatives, mineral supplements, mucolytic agents, neuromuscular drugs, peripheral vasodilators, psychotropics, sedatives, stimulants, thyroid and anti-thyroid agents, uterine relaxants, vitamins, antigenic materials, analgetics and prodrugs.

Specific examples of useful biologically active substances from the above categories include: (a) anti-neoplastics such as androgen inhibitors, anti-metabolites, cytotoxic agents, immunomodulators; (b) anti-tussives such as dextromethorphan, dextromethorphan hydrobromide, noscapine, carbetapentane citrate, and chlophedianol hydrochloride; (c) antihistamines such aschlorpheniramine maleat, phenindamine tartrate, zyrilamine mafeate, doxylamine succinate, and phenyltcloxamine citrate; (d) decongestants such as phenylephrine hydrochloride, chenylpropanolamine hydrochloride, pseudoephedrine hydrochloride, and ephedrine; (e) various alkaloid such as codeine phosphate, codeine sulfate and morphine-(mineral supplements such as potassium chloride, zinc chloride, calcium carbonates, magnesium oxide, and other alkali metal and alkaline earth metal salts; (g) ion exchange resins such as cholestryramine; (h) anti-arrhythmics such as N-acetylprocainamide; (i) antipyretics and analgesics such as acetaminophen, aspirin and ibuprofen; (j) appetite suppressants such as phenyl-propanolamine hydrochloride or caffeine; (k) expectorants such as guaifenesin; (I) antacids such as aluminum hydroxide and magnesium hydroxide; (m) biologicals such as peptides, polypeptides, proteins and amino acids, hormones, interferons or cytokines and other bioactive peptidic compounds, such as hGH, tPA, calcitonin, ANF, EPO and insulin; (n) anti-infective agents such as anti-fungals, RTI anti-virals, antiseptics and antibiotics; and (o) antigenic materials, particularly those useful in vaccine applications.

Pharmaceutically acceptable carriers may be prepared from a wide range of materials. Without being limited thereto, such materials include diluents, binders and adhesives, lubricants, disintegrants, colorants, bulking agents (an additive that increases the bulk of a substance), flavorings, sweeteners, and miscellaneous materials such as buffers and absorbents in order to prepare a particular medicated suppository.

### Concentration of the Bioactive Agent of the Fluid or Liquid Composition

Bioactive agents of the fluid or liquid composition according to the present invention may be used in any suitable concentration, i.e. a pharmaceutical relevant concentration for achieving a biological effect.

In one embodiment, the bioactive agent is an enzyme, said enzyme being present in the fluid or liquid composition at a concentration of less than 1,000,000 IU/ml, such as less than 950,000 IU/ml, for example less than 900,000 IU/ml, such as less than 850,000 IU/ml, for example less than 800,000 IU/ml, such as less than 750,000 IU/ml, for example less than 700,000 IU/ml, such as less than 650,000 IU/ml, for example less than 600,000 IU/ml, such as less than 550,000 IU/ml, for example less than 500,000 IU/ml, such as less than 450,000 IU/ml, for example less than 400,000 IU/ml, such as less than 350,000 IU/ml, for example less than 300,000 IU/ml, such as less than 250,000 IU/ml, for example less than 200,000 IU/ml, such as less than 150,000 IU/ml, for example less than 100,000 IU/ml, such as less than 95,000 IU/ml, for example less than 90,000 IU/ml, such as less than 85,000 IU/ml, for example less than 80,000 IU/ml, such as less than 75,000 IU/ml, for example less than 70,000 IU/ml, such as less than 65,000 IU/ml, for example less than 60,000 IU/ml, such as less than 55,000 IU/ml, for example less than 50,000 IU/ml, such as less than 45,000 IU/ml, for example less than 40,000 IU/ml, such as less than 35,000 IU/ml, for example less than 30,000 IU/ml, such as less than 25,000 IU/ml, for example less than 20,000 IU/ml, such as less than 15,000 IU/ml, for example less than 10,000 IU/ml, such as less than 9,500 IU/ml, for example less than 9,000 IU/ml, such as less than 8,500 IU/ml, for example less than 8,000 IU/ml, such as less than 7,500 IU/ml, for example less than 7,000 IU/ml, such as less than 6,500 IU/ml, for example less than 6,000 IU/ml, such as less than 5,500 IU/ml, for example less than 5,000 IU/ml, such as less than 4,500 IU/ml, for example less than 4,000 IU/ml, such as less than 3,500 IU/ml, for example less than 3,000 IU/ml, such as less than 2,500 IU/ml, for example less than 2,000 IU/ml, such as less than 1,500 IU/ml, for example less than 1,000 IU/ml, such as less than 750 IU/ml, for example less than 500 IU/ml, such as less than 450 IU/ml, for example less than 400 IU/ml, such as less than 350 IU/ml, for example less than 300 IU/ml, such as less than 250 IU/ml, for example less than 200 IU/ml, such as less than 150 IU/ml, for example less than 100 IU/ml, such as less than 50 IU/ml, for example less than 10 IU/ml, such as less than 1 IU/ml.

In one embodiment, the bioactive agent is an enzyme, said enzyme being present in the fluid or liquid composition at a concentration in the range of 1 IU/ml to 1,000,000 IU/ml; such as in the range of 1-10 IU/ml, for example in the range of 10-50 IU/ml, such as in the range of 50-100 IU/ml, for example in the range of 100-150 IU/ml, such as in the range of 150-200 IU/ml, for example in the range of 200-250 IU/ml, such as in the range of 250-300 IU/ml, for example in the range of 300-350 IU/ml, such as in the range of 350-400 IU/ml, for example in the range of 400-450 IU/ml, such as in the range of 450-500 IU/ml, for example in the range of 500-750 IU/ml, such as in the range of 750-1000 IU/ml, for example in the range of 1000-1500 IU/ml, such as in the range of 1500-2000 IU/ml, for example in the range of 2000-2500 IU/ml, such as in the range of 2500-3000 IU/ml, for example in the range of 3000-3500 IU/ml, such as in the range of 3500-4000 IU/ml, for example in the range of 4000-4500 IU/ml, such as in the range of 4500-5000 IU/ml, for example in the range of 5000-5500 IU/ml, such as in the range of 5500-6000 IU/ml, for example in the range of 6000-6500 IU/ml, such as in the range of 6500-7000 IU/ml, for example in the range of 7000-7500 IU/ml, such as in the range of 7500-8000 IU/ml, for example in the range of 8000-8500 IU/ml, such as in the range of 8500-9000 IU/ml, for example in the range of 9000-9500 IU/ml, such as in the range of 9500-10,000 IU/ml, for example in the range of 10,000-11,000 IU/ml, such as in the range of 11,000-12,000 IU/ml, for example in the range of 12,000-13,000 IU/ml, such as in the range of 13,000-14,000 IU/ml, for example in the range of 14,000-15,000 IU/ml, such as in the range of 15,000-16,000 IU/ml, for example in the range of 16,000-17,000 IU/ml, such as in the range of 17,000-18,000 IU/ml, for example in the range of 18,000-19,000 IU/ml, such as in the range of 19,000-20,000 IU/ml, for example in the range of 20,000-25,000 IU/ml, such as in the range of 25,000-30,000 IU/ml, for example in the range of 30,000-35,000 IU/ml, such as in the range of 35,000-40,000 IU/ml, for example in the range of 40,000-45,000 IU/ml, such as in the range of 45,000-50,000 IU/ml, for example in the range of 50,000-55,000 IU/ml, such as in the range of 55,000-60,000 IU/ml, for example in the range of 60,000-65,000 IU/ml, such as in the range of 65,000-70,000 IU/ml, for example in the range of 70,000-75,000 IU/ml, such as in the range of 75,000-80,000 IU/ml, for example in the range of 80,000-85,000 IU/ml, such as in the range of 85,000-90,000 IU/ml, for example in the range of 90,000-95,000 IU/ml, such as in the range of 95,000-100,000 IU/ml, for example in the range of 100,000-150,000 IU/ml, such as in the range of 150,000-200,000 IU/ml, for example in the range of 200,000-250,000 IU/ml, such as in the range of 250,000-300,000 IU/ml, for example in the range of 300,000-350,000 IU/ml, such as in the range of 350,000-400,000 IU/ml, for example in the range of 400,000-450,000 IU/ml, such as in the range of 450,000-500,000 IU/ml, for example in the range of 500,000-550,000 IU/ml, such as in the range of 550,000-600,000 IU/ml, for example in the range of 600,000-650,000 IU/ml, such as in the range of 650,000-700,000 IU/ml, for example in the range of 700,000-750,000 IU/ml, such as in the range of 750,000-800,000 IU/ml, for example in the range of 800,000-850,000 IU/ml, such as in the range of 850,000-900,000 IU/ml, for example in the range of 900,000-950,000 IU/ml, such as in the range of 950,000-1,000,000 IU/ml, or any combination of these ranges.

In one embodiment, the bioactive agent is an enzyme, said enzyme being present in the fluid or liquid composition at a concentration in the range of 1 ng/ml to 1,000,000 mg/ml; such as in the range of 1-10 ng/ml, for example in the range of 10-100 ng/ml, such as in the range of 100-200 ng/ml, for example in the range of 300-400 ng/ml, such as in the range of 400-500 ng/ml, for example in the range of 500-600 ng/ml, such as in the range of 600-700 ng/ml, for example in the range of 700-800 ng/ml, such as in the range of 800-900 ng/ml, for example in the range of 900-1000 ng/ml, such as in the range of 1-10 ug/ml, for example in the range of 10-100 ug/ml, such as in the range of 100-200 ug/ml, for example in the range of 200-300 ug/ml, such as in the range of 300-400 ug/ml, for example in the range of 400-500 ug/ml, such as in the range of 500-600 ug/ml, for example in the range of 600-700 ug/ml, such as in the range of 700-800 ug/ml, for example in the range of 800-900 ug/ml, such as in the range of 900-1000 ug/ml, for example in the range of 1-10 mg/ml, such as in the range of 10-100 mg/ml, for example in the range of 100-200 mg/ml, such as in the range of 200-300 mg/ml, for example in the range of 300-400 mg/ml, such as in the range of 400-500 mg/ml, for example in the range of 500-600 mg/ml, such as in the range of 600-700 mg/ml, for example in the range of 700-800 mg/ml, such as in the range of 800-900 mg/ml, for example in the range of 900-1000 mg/ml, such as in the range of 1000-2000 mg/ml, for example in the range of 2000-3000 mg/ml, such as in the range of 3000-4000 mg/ml, for example in the range of 4000-5000 mg/ml, such as in the range of 5000-6000 mg/ml, for example in the range of 6000-7000 mg/ml, such as in the range of 7000-8000 mg/ml, for example in the range of 8000-9000 mg/ml, such as in the range of 9000-10,000 mg/ml, for example in the range of 10,000-20,000 mg/ml, such as in the range of 20,000-30,000 mg/ml, for example in the range of 30,000-40,000 mg/ml, such as in the range of 40,000-50,000 mg/ml, for example in the range of 50,000-60,000 mg/ml, such as in the range of 60,000-70,000 mg/ml, for example in the range of 70,000-80,000 mg/ml, such as in the range of 80,000-90,000 mg/ml, for example in the range of 90,000-100,000 mg/ml, such as in the range of 100,000-200,000 mg/ml, for example in the range of 200,000-300,000 mg/ml, such as in the range of 300,000-400,000 mg/ml, for example in the range of 400,000-500,000 mg/ml, such as in the range of 500,000-600,000 mg/ml, for example in the range of 600,000-700,000 mg/ml, such as in the range of 700,000-800,000 mg/ml, for example in the range of 800,000-900,000 mg/ml, such as in the range of 900,000-1,000,000 mg/ml, or any combination of these ranges.

In one embodiment, the bioactive agent is an enzyme, said enzyme being present in the fluid or liquid composition at a concentration in the range of such as 1-10 IU/ml, for example 1-50 IU/ml, such as 1-100 IU/ml, for example 1-150 IU/ml, such as 1-200 IU/ml, for example 1-250 IU/ml, such as 1-300 IU/ml, for example 1-350 IU/ml, such as 1-400 IU/ml, for example 1-450 IU/ml, such as 1-500 IU/ml, for example 1-750 IU/ml, such as 1-1000 IU/ml, for example 1-1500 IU/ml, such as 1-2000 IU/ml, for example 1-2500 IU/ml, such as 1-3000 IU/ml, for example 1-3500 IU/ml, such as 1-4000 IU/ml, for example 1-4500 IU/ml, such as 1-5000 IU/ml, for example 1-5500 IU/ml, such as 1-6000 IU/ml, for example 1-6500 IU/ml, such as 1-7000 IU/ml, for example 1-7500 IU/ml, such as 1-8000 IU/ml, for example 1-8500 IU/ml, such as 1-9000 IU/ml, for example 1-9500 IU/ml, such as 1-10,000 IU/ml, for example 1-11,000 IU/ml, such as 1-12,000 IU/ml, for example 1-13,000 IU/ml, such as 1-14,000 IU/ml, for example 1-15,000 IU/ml, such as 1-16,000 IU/ml, for example 1-17,000 IU/ml, such as 1-18,000 IU/ml, for example 1-19,000 IU/ml, such as 1-20,000 IU/ml, for example 1-25,000 IU/ml, such as 1-30,000 IU/ml, for example 1-35,000 IU/ml, such as 1-40,000 IU/ml, for example 1-45,000 IU/ml, such as 1-50,000 IU/ml, for example 1-55,000 IU/ml, such as 1-60,000 IU/ml, for example 1-65,000 IU/ml, such as 1-70,000 IU/ml, for example 1-75,000 IU/ml, such as 1-80,000 IU/ml, for example 1-85,000 IU/ml, such as 1-90,000 IU/ml, for example 1-95,000 IU/ml, such as 1-100,000 IU/ml, for example 1-150,000 IU/ml, such as 1-200,000 IU/ml, for example 1-250,000 IU/ml, such as 1-300,000 IU/ml, for example 1-350,000 IU/ml, such as 1-400,000 IU/ml, for example 1-450,000 IU/ml, such as 1-500,000 IU/ml, for example 1-550,000 IU/ml, such as 1-600,000 IU/ml, for example 1-650,000 IU/ml, such as 1-700,000 IU/ml, for example 1-750,000 IU/ml, such as 1-800,000 IU/ml, for example 1-850,000 IU/ml, such as 1-900,000 IU/ml, for example 1-950,000 IU/ml, such as 1-1,000,000 IU/ml.

In one embodiment, the bioactive agent is present in the fluid or liquid composition at a concentration of less than 1,000,000 mg/ml, such as less than 900,000 mg/ml, for example less than 800,000 mg/ml, such as less than 700,000 mg/ml, for example less than 600,000 mg/ml, such as less than 500,000 mg/ml, for example less than 400,000 mg/ml, such as less than 300,000 mg/ml, for example less than 200,000 mg/ml, such as less than 100,000 mg/ml, for example less than 90,000 mg/ml, such as less than 80,000 mg/ml, for example less than 70,000 mg/ml, such as less than 60,000 mg/ml, for example less than 50,000 mg/ml, such as less than 40,000 mg/ml, for example less than 30,000 mg/ml, such as less than 20,000 mg/ml, for example less than 10,000 mg/ml, such as less than 9000 mg/ml, for example less than 8000 mg/ml, such as less than 7000 mg/ml, for example less than 6000 mg/ml, such as less than 5000 mg/ml, for example less than 4000 mg/ml, such as less than 3000 mg/ml, for example less than 2000 mg/ml, such as less than 1000 mg/ml, for example less than 900 mg/ml, such as less than 800 mg/ml, for example less than 700 mg/ml, such as less than 600 mg/ml, for example less than 500 mg/ml, such as less than 400 mg/ml, for example less than 300 mg/ml, such as less than 200 mg/ml, for example less than 100 mg/ml, such as less than 10 mg/ml, for example less than 1 mg/ml, such as less than 1000 ug/ml, for example less than 900 ug/ml, such as less than 800 ug/ml, for example less than 700 ug/ml, such as less than 600 ug/ml, for example less than 500 ug/ml, such as less than 400 ug/ml, for example less than 300 ug/ml, such as less than 200 ug/ml, for example less than 100 ug/ml, such as less than 10 ug/ml, for example less than 1 ug/ml, such as less than 1000 ng/ml, for example less than 900 ng/ml, such as less than 800 ng/ml, for example less than 700 ng/ml, such as less than 600 ng/ml, for example less than 500 ng/ml, such as less than 400 ng/ml, for example less than 300 ng/ml, such as less than 200 ng/ml, for example less than 100 ng/ml, such as less than 10 ng/ml, for example less than 1 ng/ml.

In one embodiment, the bioactive agent is present in the fluid or liquid composition at a concentration in the range of 1 ng/ml to 1,000,000 mg/ml; such as 1-10 ng/ml, for example 10-100 ng/ml, such as 100-200 ng/ml, for example 300-400 ng/ml, such as 400-500 ng/ml, for example 500-600 ng/ml, such as 600-700 ng/ml, for example 700-800 ng/ml, such as 800-900 ng/ml, for example 900-1000 ng/ml, such as 1-10 ug/ml, for example 10-100 ug/ml, such as 100-200 ug/ml, for example 200-300 ug/ml, such as 300-400 ug/ml, for example 400-500 ug/ml, such as 500-600 ug/ml, for example 600-700 ug/ml, such as 700-800 ug/ml, for example 800-900 ug/ml, such as 900-1000 ug/ml, for example 1-10 mg/ml, such as 10-100 mg/ml, for example 100-200 mg/ml, such as 200-300 mg/ml, for example 300-400 mg/ml, such as 400-500 mg/ml, for example 500-600 mg/ml, such as 600-700 mg/ml, for example 700-800 mg/ml, such as 800-900 mg/ml, for example 900-1000 mg/ml, such as 1000-2000 mg/ml, for example 2000-3000 mg/ml, such as 3000-4000 mg/ml, for example 4000-5000 mg/ml, such as 5000-6000 mg/ml, for example 6000-7000 mg/ml, such as 7000-8000 mg/ml, for example 8000-9000 mg/ml, such as 9000-10,000 mg/ml, for example 10,000-20,000 mg/ml, such as 20,000-30,000 mg/ml, for example 30,000-40,000 mg/ml, such as 40,000-50,000 mg/ml, for example 50,000-60,000 mg/ml, such as 60,000-70,000 mg/ml, for example 70,000-80,000 mg/ml, such as 80,000-90,000 mg/ml, for example 90,000-100,000 mg/ml, such as 100,000-200,000 mg/ml, for example 200,000-300,000 mg/ml, such as 300,000-400,000 mg/ml, for example 400,000-500,000 mg/ml, such as 500,000-600,000 mg/ml, for example 600,000-700,000 mg/ml, such as 700,000-800,000 mg/ml, for example 800,000-900,000 mg/ml, such as 900,000-1,000,000 mg/ml.

In one embodiment, the bioactive agent is present in the fluid or liquid composition at a concentration in the range of 1 ng/ml-1,000,000 mg/ml, for example 10 ng/ml-1,000,000 mg/ml, such as 100 ng/ml-1,000,000 mg/ml, for example 300 ng/ml-1,000,000 mg/ml, such as 400 ng/ml-1,000,000 mg/ml, for example 500 ng/ml-1,000,000 mg/ml, such as 600 ng/ml-1,000,000 mg/ml, for example 700 ng/ml-1,000,000 mg/ml, such as 800 ng/ml-1,000,000 mg/ml, for example 900 ng/ml-1,000,000 mg/ml, such as 1 ug/ml-1,000,000 mg/ml, for example 10 ug/ml-1,000,000 mg/ml, such as 100 ug/ml-1,000,000 mg/ml, for example 200 ug/ml-1,000,000 mg/ml, such as 300 ug/ml-1,000,000 mg/ml, for example 400 ug/ml-1,000,000 mg/ml, such as 500 ug/ml-1,000,000 mg/ml, for example 600 ug/ml-1,000,000 mg/ml, such as 700 ug/ml-1,000,000 mg/ml, for example 800 ug/ml-1,000,000 mg/ml, such as 900 ug/ml-1,000,000 mg/ml, for example 1-1,000,000 mg/ml, such as 10-1,000,000 mg/ml, for example 100-1,000,000 mg/ml, such as 200-1,000,000 mg/ml, for example 300-1,000,000 mg/ml, such as 400-1,000,000 mg/ml, for example 500-1,000,000 mg/ml, such as 600-1,000,000 mg/ml, for example 700-1,000,000 mg/ml, such as 800-1,000,000 mg/ml, for example 900-1,000,000 mg/ml, such as 1000-1,000,000 mg/ml, for example 2000-1,000,000 mg/ml, such as 3000-1,000,000 mg/ml, for example 4000-1,000,000 mg/ml, such as 5000-1,000,000 mg/ml, for example 6000-1,000,000 mg/ml, such as 7000-1,000,000 mg/ml, for example 8000-1,000,000 mg/ml, such as 9000-1,000,000 mg/ml, for example 10,000-1,000,000 mg/ml, such as 20,000-1,000,000 mg/ml, for example 30,000-1,000,000 mg/ml, such as 40,000-1,000,000 mg/ml, for example 50,000-1,000,000 mg/ml, such as 60,000-1,000,000 mg/ml, for example 70,000-1,000,000 mg/ml, such as 80,000-1,000,000 mg/ml, for example 90,000-1,000,000 mg/ml, such as 100,000-1,000,000 mg/ml, for example 200,000-1,000,000 mg/ml, such as 300,000-1,000,000 mg/ml, for example 400,000-1,000,000 mg/ml, such as 500,000-1,000,000 mg/ml, for example 600,000-1,000,000 mg/ml, such as 700,000-1,000,000 mg/ml, for example 800,000-1,000,000 mg/ml, such as 900,000-1,000,000 mg/ml.

In one embodiment, the bioactive agent is present in the fluid or liquid composition at a concentration in the range of 1-10 ng/ml, for example 1-100 ng/ml, such as 1-200 ng/ml, for example 1-400 ng/ml, such as 1-500 ng/ml, for example 1-600 ng/ml, such as 1-700 ng/ml, for example 1-800 ng/ml, such as 1-900 ng/ml, for example 1-1000 ng/ml, such as 1 ng/ml-10 ug/ml, for example 1 ng/ml-100 ug/ml, such as 1 ng/ml-200 ug/ml, for example 1 ng/ml-300 ug/ml, such as 1 ng/ml-400 ug/ml, for example 1 ng/ml-500 ug/ml, such as 1 ng/ml-600 ug/ml, for example 1 ng/ml-700 ug/ml, such as 1 ng/ml-800 ug/ml, for example 1 ng/ml-900 ug/ml, such as 1 ng/ml-1000 ug/ml, for example 1 ng/ml-10 mg/ml, such as 1 ng/ml-100 mg/ml, for example 1 ng/ml-200 mg/ml, such as 1 ng/ml-300 mg/ml, for example 1 ng/ml-400 mg/ml, such as 1 ng/ml-500 mg/ml, for example 1 ng/ml-600 mg/ml, such as 1 ng/ml-700 mg/ml, for example 1 ng/ml-800 mg/ml, such as 1 ng/ml-900 mg/ml, for example 1 ng/ml-1000 mg/ml, such as 1 ng/ml-2000 mg/ml, for example 1 ng/ml-3000 mg/ml, such as 1 ng/ml-4000 mg/ml, for example 1 ng/ml-5000 mg/ml, such as 1 ng/ml-6000 mg/ml, for example 1 ng/ml-7000 mg/ml, such as 1 ng/ml-8000 mg/ml, for example 1 ng/ml-9000 mg/ml, such as 1 ng/ml-10,000 mg/ml, for example 1 ng/ml-20,000 mg/ml, such as 1 ng/ml-30,000 mg/ml, for example 1 ng/ml-40,000 mg/ml, such as 1 ng/ml-50,000 mg/ml, for example 1 ng/ml-60,000 mg/ml, such as 1 ng/ml-70,000 mg/ml, for example 1 ng/ml-80,000 mg/ml, such as 1 ng/ml-90,000 mg/ml, for example 1 ng/ml-100,000 mg/ml, such as 1 ng/ml-200,000 mg/ml, for example 1 ng/ml-300,000 mg/ml, such as 1 ng/ml-400,000 mg/ml, for example 1 ng/ml-500,000 mg/ml, such as 1 ng/ml-600,000 mg/ml, for example 1 ng/ml-700,000 mg/ml, such as 1 ng/ml-800,000 mg/ml, for example 1 ng/ml-900,000 mg/ml, such as 1 ng/ml-1,000,000 mg/ml.

The concentration of the bioactive agent in each droplet is preferably essentially identical, wherein the concentration of any two droplets expelled from an ultrasonic spray device according to the present invention may vary less that 10%, such as less than 8%, for example less than 6%, such as less than 4%, for example less than 2%, such as less than 1%. The concentration of any two droplets may vary in the range of 0.1-10%, such as 0.1-1%, for example 1-2%, such as 2-3%, for example 3-4%, such as 4-5%, for example 5-6%, such as 6-7%, for example 7-8%, such as 8-9%, for example 9-10%.

### Uniform Distribution

When applying a fluid or liquid composition onto a matrix material by ultrasonic spray technology according to the present invention, the composition will be distributed in a uniform manner on the matrix material, i.e. there will be essentially no concentration gradient of the composition throughout the matrix material. This may be regarded as a uniform pattern arising from the uniform distribution.

The uniform distribution arises from the use of a predetermined and essentially fixed ratio between droplet volume, distance between every two droplets and the concentration of the bioactive material of the droplet. Achieving such a ratio is possible using the ultrasonic spray technology, and permits the deposition of an essentially identical amount or volume of fluid or liquid composition and/or bioactive agent per area unit of the matrix material. Achieving such a uniform distribution is not possible to obtain from conventional techniques such as spraying.

Specific and numeric values for droplet volume or size, distance between every two droplets and the droplet concentration of the bioactive material of the composition are given herein above. The predetermined values for use in any embodiment to determine the ratio between droplet volume, distance between every two droplets and the concentration of the droplet may be chosen from any of the herein disclosed values.

A uniform distribution of a pharmaceutical composition initially in fluid or liquid form may be defined as a distribution wherein any two area units differ in volume of the coated composition or concentration of bioactive agent by the most 10%, such as by the most 8%, for example by the most 6%, such as by the most 4%, for example by the most 2%, such as by the most 1%. Any two area units has a uniform distribution that may vary in the range of 0.1-10%, such as 0.1-1%, for example 1-2%, such as 2-3%, for example 3-4%, such as 4-5%, for example 5-6%, such as 6-7%, for example 7-8%, such as 8-9%, for example 9-10%.

A uniform distribution also arises from essentially all the fluid or liquid composition leaving the ultrasonic spray nozzle of the nozzle assembly head contacts the matrix material, whereby essentially no fluid or liquid composition is wasted in the process. The amount of fluid or liquid composition not contacting the matrix material is less that 10%, such as less than 8%, for example less than 6%, such as less than 4%, for example less than 2%, such as less than 1%.

### Hemostatic and Anti-Fibrinolytic Agents

Hemostatic agents, or pro-coagulants or thrombotic agents, are agents that induce hemostasis. Thus, they shift the balance in favor of blood coagulation or clotting. Anti-fibrinolytic agents are also hemostatic agents, in that they prevent the degradation of the formed blood clot.

In a preferred embodiment, the device according to the present invention is a hemostatic device. The hemostatic device may thus be coated with hemostatic agents.

The hemostatic device described herein may be used as a medicament. Accordingly, in a further aspect the present invention relates to a method of promoting hemostasis in a patient in need thereof, said method comprising coating a pharmaceutical composition as defined herein onto a device, and using the device to promote hemostasis.

Below are listed non-limiting examples of hemostatic agents that in one embodiment may be included in the composition that is applied by ultrasonic spray technology onto the device of the present invention.

Specific examples of hemostatic agents include coagulation factors selected from the group consisting of prothrombin and/or thrombin, fibrinogen and/or fibrin, Factor V and/or Va, Factor VII and/or Vila, Factor VIII and/or VIIIa, Factor 1× and/or IXa, Factor X and/or Xa, Factor XI and/or XIa, Factor XII and/or XIIa, Factor XIII and/or XIIIa, and combinations thereof. Such compounds may be of any mammalian origin, such as of porcine or human origin, or may be obtained by recombinant means by methods well-known to the skilled person.

Coagulation factor concentrates are used to treat hemophilia, to reverse the effects of anticoagulants, and to treat bleeding in patients with impaired coagulation factor synthesis or increased consumption. Prothrombin complex concentrate, cryoprecipitate and fresh frozen plasma are commonly-used coagulation factor products. Recombinant activated human factor VII is are increasingly popular in the treatment of major bleeding.

Fibronectin is excreted by fibroblasts in the proliferative pase of wound healing. Fibrin and fibronectin cross-link together and form a plug that traps proteins and particles and prevents further blood loss. This fibrin-fibronectin plug is also the main structural support for the wound until collagen is deposited.

Additional agents that may be comprised in the composition to promote hemostasis include calcium ions to aid coagulation, and desmopressin which improve platelet function by activating arginine vasopressin receptor 1 A.

Anti-fibrinolytic agents may be selected from the group consisting of tranexamic acid, aminocaproic acid, aprotinin, pepstatin, leupeptin, antipain, chymostatin, gabexate, and mixtures thereof. In a preferred embodiment of the present invention, tranexamic acid comprises part of the composition, if any anti-fibrinolytic agent is comprised in the composition.

Further, the use of adsorbent chemicals, such as zeolites, and other hemostatic agents is also being explored for use in sealing severe injuries quickly.

QuikClot® brand hemostatic agent is manufactured by Z-Medica Corporation. The original QuikClot® is a granular product that can be poured directly on wounds to stop bleeding. It stops bleeding by adsorbing water from the blood thereby concentrating the clotting factors, activating platelets and promoting steps in the coagulation cascade. It is composed of zeolite, a molecular sieve that traps molecules in a molecular “cage” and holding the trapped species by forming hydrogen bonds. The bond formation generates heat, which has been a drawback to the original QuikClot® brand hemostatic agent. Newer versions of the product have been developed by Z-Medica that have reduced and eliminated the exothermic reaction.

Other examples of suitable biologically absorbable materials with hemostatic or even wound healing effects include gelatin, collagen, chitin, chitosan, alginate, cellulose, polyglycolic acid, polyacetic acid and mixtures thereof. It will be understood that various forms thereof, such as linear or cross-linked forms, salts, esters and the like may also be used as the biologically absorbable material to be included in the haemostatic powder of the invention.

“Biologically absorbable” is a term which in the present context is used to describe that the materials of which the said powder are made can be degraded in the body to smaller molecules having a size which allows them to be transported into the blood stream. By said degradation and absorption the materials will gradually be removed from the site of application. For example, denatured gelatin can be degraded by proteolytic tissue enzymes to absorbable smaller molecules, whereby the denatured gelatin powder when applied in tissues typically is absorbed within about 3-6 weeks and when applied on bleeding surfaces and mucous membranes typically within 3-5 days.

TABLE 1
Hemostatic and anti-fibrinolytic agents
Wound healing promoting agents

| | | |
|---|---|---|
| Pro-thrombin and/or | Cryoprecipitate | Chymostatin |
| thrombin | | |
| Fibrinogen and/or fibrin | Fresh frozen plasma | Gabexate |
| Factor V and/or Va | Fibronectin | Zeolites |
| Factor VII and/or VIIa | Calcium ions | Gelatin |
| Factor VIII and/or VIIIa | Desmopressin | Collagen |
| Factor IX and/or IXa | Tranexamic acid | Chitin |
| Factor X and/or Xa | Aminocaproic acid | Chitosan |
| Factor XI and/or XIa | Aprotinin | Alginate |
| Factor XII and/or XIIa | Pepstatin | Cellulose |
| Factor XIII and/or XIIIa | Leupeptin | Polyglycolic acid |
| Prothrombin complex | Antipain | Polyacetic acid |
| concentrate | | |

In one embodiment, the device according to the present invention is a wound healing device. The wound healing device may thus be coated with wound healing or wound healing promoting agents. A wound healing agent may be an agent that accelerates the wound healing process.

The wound healing device described herein may be used as a medicament. Accordingly, in a further aspect the present invention relates to a method of promoting wound healing in a patient in need thereof, said method comprises application by ultrasonic spray technology of a pharmaceutical composition as defined herein onto a device, and using the device to promote wound healing.

Below are listed non-limiting examples of wound healing agents that in one embodiment may be included in the composition that is applied by ultrasonic spray technology onto the device of the present invention.

Wound healing agents may be present on the device alone, may be combined or used together or in coordination with e.g. an antibiotic, antifungal, or antiviral substance or substances to accelerate the healing of sores or other infection-damaged tissue simultaneously or sequentially with the treatment of the underlying infection.

Further, growth factors to promote healing may also be employed in the composition for application by ultrasonic spray technology onto the device to promote wound healing.

Adrenaline or other substances capable of constricting blood vessels thereby reducing local blood flow may also be employed in the composition for application by ultrasonic spray technology onto the device to promote wound healing. Factors that trigger vasoconstriction can be of exogenous origin, such as medication and endogenous as well, as a response from the body itself. Examples of medications include: anti-histamines such as H1 receptor antagonists including Diphenhydramine, Loratadine, Meclizine and Quetiapine; inhibitors of histamine release such as mast cell stabilizers including Cromoglicate (cromolyn) and Nedocromil; caffeine; decongestants such as Ephedrine, Oxymetazoline, Phenylephrine, Pseudoephedrine, Tramazoline, phenylpropanolamine (PPA) and Xylometazoline that work on adrenoreceptor a1.

Active wound healing compounds can be combined with or used simultaneously or sequentially with other tissue healing promoters, such as epidermal growth factor, fibroblast growth factor, platelet derived growth factor, transforming growth factor alpha, transforming growth factor beta, and insulin-like growth factor 1 (Brunt, J. V., and Tilansner, A., Biotechnology 6:25-30 (1988)) to promote a more rapid healing of damaged tissue.

It is also useful to coat the device according to the invention with corticosteroid and anti-inflammatory agents to accelerate the healing of lesions in patients suffering from allergic or inflammatory processes, since steroids are known to slow the healing of wounds.

The following compounds can be applied by ultrasonic spray technology onto the surface of the device according to the present invention in a method for the treatment of wounds. These include, but are not limited to: allantoin, retinoic acid, aloe vera, glycine, vitamin A, the B vitamins, especially nicotinamide, vitamins C and E, antibacterial agents (e.g., quaternary ammonium compounds, bacitracin, neomycin and polymyxin), comfrey root preparations, platelets and/or platelet extracts, ribonucleosides, proline, lysine, elastin, glycosaminoglycans, spermidine, spermine, putrescine, angiogenic factors, zinc, alpha-1 antitrypsin, SLPI (Secretory Leukocyte Protease Inhibitor), and various peptide growth factors such as the somatomedins, lamin, EGF (epidermal growth factor), IGF1/2 (insulin-like growth factor 1 or 2), PDGF (platelet derived growth factor), FGF (fibroblast growth factor), TGF (transforming growth factor), MDGF (macrophage-derived growth factor), NGF (neuron growth factor), PDECGF (Platelet Derived Endothelial Cell Growth Factor), KGF (Keratinocyte Growth Factor), and TNF (Tumor Necrosis Factor). The pharmaceutically active device of the invention may also be used in conjunction with synthetic skin in treating burns and other wounds, and in supporting the healing of skin or corneal transplants.

Antimicrobial agents may be selected from bactericidal or bacteriostatic agents, such as antibiotics and sulphonamides, antiviral compounds, antimycotic agents and anti-infectives. Antibiotics may be selected from e.g. β-lactams, penicillins, cephalosporins, monobactams, macrolides, polymyxins, tetracyclines, chloramphenicol, thrimethoprim, aminoglycosides, clindamycin, and metronidazole; sulphonamides may as an example be selected from sulphadimidine or sulphadimethoxin; antimycotic agents may be selected from amphotericin B, ketoconazol and miconazol; and antiviral agent from idoxuridine and azidothymidin. Suitable antiinfectives may as an example be selected from halogens, chlorohexidine and quarternary ammonium compounds. Other examples of bactericidal or bacteriostatic compounds include silver ions, in particular in the form of silver ion complexes.

Medical or veterinary indications for the use of the invention include, but are not limited to the following situations. The pharmaceutical compositions can be used to accelerate the healing of mechanical wounds or abrasions of the skin or other tissues which are exposed by mechanical injury to the skin or gastrointestinal mucosa of the body. The invention can also be used to accelerate the healing of burns inflicted upon the skin, and any underlying tissues which may be exposed by such injury. The burns may be those caused by heat, ionizing radiation, ultraviolet radiation including sunlight, electricity, or chemical substances.

In one embodiment, the pharmaceutically active device according to the present invention is also useful in conditions in which normal wound healing is impaired. Examples of types of wounds that heal poorly or slowly include venous stasis ulcers, decubitus ulcers, and cutaneous and alimentary tract wounds, or ulcers in patients with diabetes, and in patients subjected to irradiation, cancer chemotherapy (e.g. with adriamycin or cyclophosphamide), and topical or systemic anti-inflammatory glucocorticosteriods.

Further, the compositions may be used to accelerate the healing of surgical incisions in any part of the body, external or internal, into which device according to the present invention may be introduced. The compositions can also be used to accelerate the healing of ischemic ulcers, pressure sores, bed sores, or ulcers caused by diabetes or other disease processes.

TABLE 2
Wound healing agents

| | | |
|---|---|---|
| Adrenaline | Platelets and/or | β-lactams |
| | platelet extracts | |
| Diphenhydramine | Ribonucleosides | Penicillins |
| Loratadine | Proline | Cephalosporins |
| Meclizine | Lysine | Monobactams |
| Quetiapine | Elastin | Macrolides |
| Cromoglicate (cromolyn) | Glycosaminoglycans | Polymyxins |
| Nedocromil | Spermidine | Tetracyclines |
| Caffeine | Spermine | Chloramphenicol |
| Ephedrine | Putrescine | Thrimethoprim |
| Oxymetazoline | Angiogenic factors | Aminoglycosides |
| Phenylephrine, | Zinc | Clindamycin |
| Pseudoephedrine | Somatomedins | Metronidazole |
| Tramazoline | Lamin | Sulphadimidine |
| Phenylpropanolamine | FGF | Sulphadimethoxin |
| (PPA) | | |
| Xylometazoline | PDGF | Amphotericin B |
| Corticosteroid | TGF | Ketoconazol |
| Allantoin | IGF | Miconazol |
| Retinoic acid | EGF | Idoxuridine |
| Aloe vera | MDGF | Azidothymidin |
| Glycine | NGF | Halogens |
| Vitamin A | KGF | Chlorohexidine |
| The B vitamins, especially | TNF | Silver ions |
| nicotinamide | | |
| Vitamin C | PDECGF | alpha-1 antitrypsin |
| Vitamin E | Bacitracin | SLPI |
| Comfrey root preparations | Neomycin | |
| Quaternary ammonium | Polymyxin | |
| compounds | | |

### Adhesive Agents

Suitable agents, which may improve the adhesive properties (or the tackiness) of the composition are well-known to the person skilled in the art. One class of suitable agents includes saccharides, such as monosaccharides, disaccharides, oligosaccharides, polysaccharides, and combinations thereof.

When used herein the term “saccharide”, as well as the terms “monosaccharide”, “disaccharide”, “oligosaccharide” and “polysaccharide”, also encompasses derivatives thereof, such as saccharides comprising one or more aminosugar units. In the present context, an aminosugar unit is a sugar unit wherein at least one of the hydroxy groups available in the sugar unit has been substituted by an amino group or an alkanoylated amino group such as an acetylated amino group. Accordingly, it will be understood that saccharides containing one or more glucosamine and/or N-acetylglucosamine unit(s) are also encompassed by the above-mentioned terms. Apart from the aminosugar units, the saccharide may contain unsubstituted sugar units or sugar units substituted with e.g. alkoxy (such as 2,3-dimethylglucose) or acyloxy.

Specific examples of monosaccharides include glucose, mannose, fructose, threose, gulose, arabinose, ribose, erythrose, lyxose, galactose, sorbose, altrose, tallose, idose, rhamnose, allose, and derivatives thereof, e.g. pentosamines, hexosamines, such as glucosamine or N-acetylglucosamine, and glucoronic acid. In particular glucose is preferred.

Specific examples of disaccharides include sucrose, maltose, lactose, cellubiose as well as derivatives thererof. In particular sucrose is preferred.

Specific examples of polysaccharides include glycogen, chitin, chitosan, starch such as potato starch, as well as combinations thereof. Specific examples of polysaccharide derivatives include glycosaminoglycans such as chondroitin, chondroitin sulfate, hyaluronic acid, dermatan sulfate and keratan sulfate; aminated dextrans including DEAE-dextran; aminated starch, aminated glycogen, aminated cellulose, aminated pectin, and salts, complexes, derivatives and mixtures thereof.

In an interesting embodiment of the invention, the composition further comprises an agent which improves the adhesive properties of said composition, where said agent is selected from the group consisting of glucose, sucrose, and a mixture thereof.

Other examples of agents which improve the adhesive properties of the composition include hydrocarbon resins, rosin resins and terpene resins. Hydrocarbon resins are commercially available under the tradenames Escorez® from ExxonMobil; Regalite®, Piccotac® and Picco® from Eastman; Indopol® from BP or Arkon®. Examples of rosin esters include esters of hydrogenated wood rosin e.g. pentaerythritol ester of hydrogenated wood rosin, esters of partially hydrogenated wood rosin e.g. pentaerythritol esters of partially hydrogenated wood rosin, esters of wood rosin, esters of modified wood rosin, esters of partially dimerized rosin, esters of tall oil rosin, esters of dimerized rosin, and similar rosins, and combinations and mixtures thereof. Such rosin esters are commercially available under the tradenames Foral®, Foralyn®, Pentalyn®, Permalyn® and Staybelite®.

Further examples of agents which improve the adhesive properties of the composition include Gum Karaya, sometimes known as Sterculia gum, Gum Arabicum, Gum Karrageenan, celluloseethers, such as sodium carboxymethylcellulose, Manuba Honey, casein, alginates or fatty acid esters, such as the fatty acid esters disclosed in WO 95/26715, and gecko-like or gecko-inspired medical adhesives.

Thus, in an interesting embodiment of the invention, the composition comprises at least one agent which improves the adhesive properties of the composition. Evidently, the exact amount of agent may vary depending on what specific agent is being used, but the composition typically comprises 0.1-50% (w/w) of the agent, based on the total weight of the composition. Preferably, and in particular when the agent which improves the adhesive properties of the composition is a saccharide, the composition comprises 1-25% (w/w), such as 5-20% (w/w), e.g. 5-15% (w/w), 5-10% (w/w), or 10-15% (w/w), based on the total weight of the composition.

In one embodiment, the pharmaceutical composition according to the present invention is applied by ultrasonic spray technology onto an adhesive surface of a matrix material.

TABLE 3
Adhesive agents

| | | |
|---|---|---|
| Glucose | hexosamines | aminated dextrans |
| mannose | glucosamine | aminated starch |
| fructose | N-acetylglucosamine | aminated glycogen |
| threose | glucoronic acid | aminated cellulose |
| gulose | Sucrose | aminated pectin |
| arabinose | maltose | Hydrocarbon resins |
| ribose | lactose | Rosin resins |
| erythrose | cellubiose | Terpene resins |
| lyxose | glycogen | Gum Karaya |
| galactose | chitin | Gum Arabicum |
| sorbose | chitosan | Gum Karrageenan |
| altrose | starch | Sodium carboxymethylcellulose |
| tallose | chondroitin | Manuba Honey |
| idose | chondroitin sulfate | Casein |
| rhamnose | hyaluronic acid | Alginates |
| allose | dermatan sulfate | Fatty acid esters |
| pentosamines | keratan sulfate | Gecko-like adhesive |

### Surfactant Agents

In another interesting embodiment of the invention, the composition further comprises an agent which improves the surfactant properties of said composition, where said agent is selected from the group consisting of anionic surfactants, cationic surfactants, non-ionic surfactants and surface active biological modifiers.

Examples of anionic surfactants include surfactants selected from the group consisting of potassium laurate, triethanolamine stearate, sodium lauryl sulfate, sodium dodecylsulfate, alkyl polyoxyethylene sulfates, sodium alginate, dioctyl sodium sulfosuccinate, phosphatidyl glycerol, phosphatidyl inositol, phosphatidylserine, phosphatidic acid and their salts, glyceryl esters, sodium carboxymethylcellulose, bile acids and their salts, cholic acid, deoxycholic acid, glycocholic acid, taurocholic acid, glycodeoxycholic acid, and calcium carboxymethylcellulose. In particular sodium lauryl sulfate is preferred.

Examples of cationic surfactants include surfactants selected from the group consisting of quaternary ammonium compounds, benzalkonium chloride, cetyltrimethylammonium bromide, chitosans and lauryldimethylbenzylammonium chloride.

Examples of non-ionic surfactants include surfactants selected from the group consisting of polyoxyethylene fatty alcohol ethers, polyoxyethylene sorbitan fatty acid esters, polyoxyethylene fatty acid esters, sorbitan esters, polyoxyethylene sorbitan esters (such as Tween 80 or Tween 20), glycerol monostearate, polyethylene glycols, polypropylene glycols, cetyl alcohol, cetostearyl alcohol, stearyl alcohol, aryl alkyl polyether alcohols, polyoxyethylene-polyoxypropylene copolymers, polaxamines, methylcellulose, hydroxycellulose, hydroxy propylcellulose, hydroxy propylmethylcellulose, noncrystalline cellulose, polysaccharides, starch, starch derivatives, hydroxyethylstarch, polyvinyl alcohol, Pluronic F68 and polyvinylpyrrolidone.

TABLE 4
Surfactants

| | | |
|---|---|---|
| Potassium laurate | Glycodeoxycholic acid | Aryl alkyl |
| | | polyether alcohols |
| Triethanolamine | Calcium carboxymethyl- | Polyoxyethylene- |
| stearate | cellulose | polyoxypropylene |
| | | copolymers |
| Sodium lauryl sulfate | Benzalkonium chloride | Polaxamines |
| Sodium dodecylsulfate | Cetyltrimethylammonium | Methylcellulose |
| | bromide | |
| Alkyl polyoxyethylene | Chitosans | Hydroxycellulose |
| sulfates | | |
| Sodium alginate | Lauryldimethylbenzyl- | Hydroxy |
| | ammonium chloride | propylcellulose |
| Dioctyl sodium | Polyoxyethylene fatty | Hydroxy |
| sulfosuccinate | alcohol ethers | propylmethyl- |
| | | cellulose |
| Phosphatidyl glycerol | Polyoxyethylene sorbitan | Noncrystalline |
| | fatty acid esters | cellulose |
| Phosphatidyl inositol | Polyoxyethylene fatty acid | Polysaccharides |
| | esters | |
| Phosphatidylserine | Sorbitan esters | Starch |
| Phosphatidic acid | Polyoxyethylene sorbitan | Starch derivatives |
| | esters | |
| Glyceryl esters | Glycerol monostearate | Hydroxyethylstarch |
| Bile acids and their | Polyethylene glycols | Polyvinyl alcohol |
| salts | | |
| Cholic acid | Polypropylene glycols | Polyvinyl- |
| | | pyrrolidone |
| Deoxycholic acid | Cetyl alcohol | Albumin |
| Glycocholic acid | Cetostearyl alcohol | |
| Taurocholic acid | Stearyl alcohol | |

### Other Bioactive Agents

Below are listed further non-limiting examples of bioactive agents that in one embodiment may be included in the composition that is applied by ultrasonic spray technology onto the surface of the matrix of the present invention.

Analgetics are pharmaceutical that may be used to alleviate pain. In generalanalgetics may belong to one of 3 groups, i) opiodanalgetics, ii) weak non-opiod analgetics and iii) psychopharmacological drugs, lidocain analogues and antiepileptica. In a preferred embodiment of the present invention the analgetic is lidocain.

To further illustrate, antimetabolites which can be formulated in the subject polymers include, but are not limited to, methotrexate, 5-fluorouracil, cytosine arabinoside (ara-C), 5-azacytidine, 6-mercaptopurine, 6-thioguanine, and fludarabine phosphate.

Antitumor antibiotics may include but are not limited to doxorubicin, daunorubicin, dactinomycin, bleomycin, mitomycin C, plicamycin, idarubicin, and mitoxantrone.

Vinca alkaloid and epipodophyiotoxins may include, but are not limited to vincristine, vinblastine, vindesine, etoposide and teniposide.

Nitrosoureas can also be provided including carmustine, lomustine, semustine and streptozocin.

Hormonal therapeutics can also be included in the pharmaceutical composition, such as corticosteriods (cortisone acetate, hydrocortisone, prednisone, prednisolone, methylprednisolone and dexamethasone), estrogens, (diethylstibesterol, estradiol, esterified estrogens, conjugated estrogen, chlorotiasnene), progestins (medroxyprogesterone acetate, hydroxy progesterone caproate, megestrol acetate), antiestrogens (tamoxifen), aromastase inhibitors (aminoglutethimide), androgens (testosterone propionate, methyltestosterone, fluoxymesterone, testolactone), antiandrogens (flutamide), LHRH analogues (leuprolide acetate), and endocrines for prostate cancer (ketoconazole).

Other compounds which in one embodiment may be included in the composition of the present invention include those classified as e.g. investigational drugs, and can include, but are not limited to alkylating agents such as Nimustine AZQ, BZQ, cyclodisone, DADAG, CB10-227, CY233, DABIS maleat, EDMN, Fotemustine, Hepsulfam, Hexamethylmelamine, Mafosamide, MDMS, PCNU, Spiromustine, TA077, TCNU and Temozolomide; antimetabolites, such as acivicin, Azacytidine, 5-aza-deoxycytidine, A-TDA, Benzylidene glucose, Carbetimer, CB3717, Deazaguanine mesylate, DODOX, Doxifluridine, DUP-785,10-EDAM, Fazarabine, Fludarabine, MZPES, MMPR, PALA, PLAC, TCAR, TMQ, TNC-P and Piritrexim; antitumor antibodies, such as AMPAS, BWA770U, BWA773U, BWA502U, Amonafide, m-AMSA, CI-921, Datelliptium, Mitonafide, Piroxantrone, Aclarubicin, Cytorhodin, Epirubicin, esorubicin, ldarubicin, Iodo-doxorubicin, Marcellomycin, Menaril, Morpholinoanthracyclines, Pirarubicin, SM-5887; microtubule spindle inhibitors, such as Amphethinile, Navelbine, and Taxol; thealkyl-lysophospholipids, such as BM41-440, ET-18-0CH3, and Hexacyclophosphocholine; metallic compounds, such as Gallium Nitrate, CL286558, CL287110, Cycloplatam, DWA2114R, NK121, Iproplatin, Oxaliplatin, Spiroplatin, Spirogermanium, and Titanium compounds; novel compounds such as, for example Aphidoicolin glycinate, Ambazone, BSO, Caracemide, DSG, Didemnin, DMFO, Elsamicin, Espertatrucin, Flavone acetic acid, HMBA, HHT, ICRF-187, Iododeoxyuridine, Ipomeanol, Liblomycin, Lonidamine, LY186641, MAP, MTQ, Merabarone SK, F104864, Suramin, Tallysomycin, Teniposide, THU, 2721, Toremifene, Trilosane, and zindoxifene.

Antitumor drugs that are radiation enhancers can also be formulated in the subject controlled release formulation. Examples of such drugs include, for example, the chemotherapeutic agents 5′-fluorouracil, mitomycin, cisplatin and its derivatives, taxol, bleomycins, daunomycins, and methamycins.

In one embodiment, the biologically active agent is selected from the group consisting of polysaccharides, growth factors, hormones, anti-angiogenesis factors, interferons or cytokines, and pro-drugs. In a particularly preferred embodiment, the biologically active substance is a therapeutic drug or pro-drug, most preferably a drug selected from the group consisting of chemotherapeutic agents and other antineoplastics, antibiotics, anti-virals, anti-fungals, anti-inflammatories, anticoagulants, an antigenic materials.

Further examples of medicaments according to the present invention are antimicrobial agents, analgesics, antiinflammatory agents, counterirritants, coagulation modifying agents, diuretics, sympathomimetics, anorexics, antacids and other gastrointestinal agents, antiparasitics, antidepressants, antihypertensives, anticholinergics, stimulants, antihormones, central and respiratory stimulants, drug antagonists, lipid-regulating agents, uricosurics, cardiacglycosides, electrolytes, ergot and derivatives thereof, expectorants, hypnotics and sedatives, antidiabetic agents, dopaminergic agents, antiemetics, muscle relaxants, parasympathomimetics, anticonvulsants, antihistamines, (3-blockers, purgatives, antiarrhythmics, contrast materials, radiopharmaceuticals, antiallergic agents, tranquilizers, vasodilators, antiviral agents, andantineoplastic or cytostatic agents or other agents with anticancer properties, or a combination thereof. Other suitable medicaments may be selected from contraceptives and vitamins as well as micro and macronutrients.

Further bioactive agents which may be comprised in the composition in accordance with the present invention include, without limitation: antiinfectives such as antibiotics and antiviral agents; analgesics and analgesic combinations; anorexics; antihelmintics; antiarthritics; antiasthmatic agents; anticonvulsants; antidepressants; antidiuretic agents; antidiarrleals; antihistamines; antiinflammatory agents; antimigraine preparations; antinauseants; ahtineoplastics; antiparkinsonism drugs; antipruritics; antipsychotics; antipyretics, antispasmodics; anticholinergics; sympathomimetics; xanthine derivatives; cardiovascular preparations including calcium channel blockers and beta-blockers such as pindolol and antiarrhythmics; antihypertensives; diuretics; vasodilators including general coronary, peripheral and cerebral; central nervous system stimulants; cough and cold preparations, including decongestants; hormones such as estradiol and other steroids, including corticosteroids; hypnotics; immunosuppressives; muscle relaxants; parasympatholytics; psychostimulants; sedatives; and tranquilizers; and naturally derived or genetically engineered proteins, polysaccharides, glycoproteins, or lipoproteins.

Further specific examples of bioactive agents include acebutolol, acetaminophen, acetohydroxamic acid, acetophenazine, acyclovir, adrenocorticoids, allopurinol, alprazolam, aluminum hydroxide, amantadine, ambenonium, amiloride, aminobenzoate potassium, amobarbital, amoxicillin, amphetamine, ampicillin, androgens, anesthetics, anticoagulants, anticonvulsants-dione type, antithyroid medicine, appetite suppressants, aspirin, atenolol, atropine, azatadine, bacampicillin, baclofen, beclomethasone, belladonna, bendroflumethiazide, benzoyl peroxide, benzthiazide, benztropine, betamethasone, bethanechol, biperiden, bisacodyl, bromocriptine, bromodiphenhydramine, brompheniramine, buclizine, bumetanide, busulfan, butabarbital, butaperazine, caffeine, calcium carbonate, captopril, carbamazepine, carbenicillin, carbidopa & levodopa, carbinoxamine inhibitors, carbonic anhydsase, carisoprodol, carphenazine, cascara, cefaclor, cefadroxil, cephalexin, cephradine, chlophedianol, chloral hydrate, chlorambucil, chloramphenicol, chlordiazepoxide, chloroquine, chlorothiazide, chlorotrianisene, chlorpheniramine, chlorpromazine, chlorpropamide, chlorprothixene, chlorthalidone, chlorzoxazone, cholestyramine, cimetidine, cinoxacin, clemastine, clidinium, clindamycin, clofibrate, clomiphere, clonidine, clorazepate, cloxacillin, colochicine, coloestipol, conjugated estrogen, contraceptives, cortisone, cromolyn, cyclacillin, cyclandelate, cyclizine, cyclobenzaprine, cyclophosphamide, cyclothiazide, cycrimine, cyproheptadine, danazol, danthron, dantrolene, dapsone, dextroamphetamine, dexamethasone, dexchlorpheniramine, dextromethorphan, diazepan, dicloxacillin, dicyclomine, diethylstilbestrol, diflunisal, digitalis, diltiazen, dimenhydrinate, dimethindene, diphenhydramine, diphenidol, diphenoxylate & atrophive, diphenylopyraline, dipyradamole, disopyramide, disulfuram, divalporex, docusate calcium, docusate potassium, docusate sodium, doxyloamine, dronabinol ephedrine, epinephrine, ergoloidmesylates, ergonovine, ergotamine, erythromycins, esterified estrogens, estradiol, estrogen, estrone, estropipute, etharynic acid, ethchlorvynol, ethinyl estradiol, ethopropazine, ethosaximide, ethotoin, fenoprofen, ferrous fumarate, ferrous gluconate, ferrous sulfate, flavoxate, flecamide, fluphenazine, fluprednisolone, flurazepam, folic acid, furosemide, gemfibrozil, glipizide, glyburide, glycopyrrolate, gold compounds, griseofiwin, guaifenesin, guanabenz, guanadrel, guanethidine, halazepam, haloperidol, hetacillin, hexobarbital, hydralazine, hydrochlorothiazide, hydrocortisone (cortisol), hydroflunethiazide, hydroxychloroquine, hydroxyzine, hyoscyamine, ibuprofen, indapamide, indomethacin, insulin, iofoquinol, iron-polysaccharide, isoetharine, isoniazid, isopropamide isoproterenol, isotretinoin, isoxsuprine, kaolin & pectin, ketoconazole, lactulose, levodopa, lincomycin liothyronine, liotrix, lithium, loperamide, lorazepam, magnesium hydroxide, magnesium sulfate, magnesium trisilicate, maprotiline, meclizine, meclofenamate, medroxyproyesterone, melenamic acid, melphalan, mephenyloin, mephobarbital, meprobamate, mercaptopurine; mesoridazine, metaproterenol, <RTI metaxalone, methamphetamine, methaqualone, metharbital, methenamine, methicillin, methocarbamol, methotrexate, methsuximide, methyclothinzide, methylcellulos, methyldopa, methylergonovine, methylphenidate, methylprednisolone, methysergide, metoclopramide, metolazone, metoprolol, metronidazole, minoxidil, mitotane, monamine oxidase inhibitors, nadolol, nafcillin, nalidixic acid, naproxen, narcotic analgesics, neomycin, neostigmine, niacin, nicotine, nifedipine, nitrates, nitrofurantoin, nomifensine, norethindrone, norethindrone acetate, norgestrel, nylidrin, nystatin, orphenadrine, oxacillin, oxazepam, oxprenolol, oxymetazoline, oxyphenbutazone, pancrelipase, pantothenic acid, papaverine, para-aminosalicylic acid, paramethasone, paregoric, pemoline, penicillamine, penicillin, penicillin-v, pentobarbital, perphenazine, phenacetin, phenazopyridine, pheniramine, phenobarbital, phenolphthalein, phenprocoumon, phensuximide, phenylbutazone, phenylephrine, phenylpropanolamine, phenyltoloxamine, phenyloin, pilocarpine, pindolol, piper acetazine, piroxicam, poloxamer, polycarbophil calcium, polythiazide, potassium supplements, pruzepam, prazosin, prednisolone, prednisone, primidone, probenecid, probucol, procainamide, procarbazine, prochlorperazine, procyclidine, promazine, promethazine, propantheline, propranolol, pseudoephedrine, psoralens, syllium, pyridostigmine, pyrodoxine, pyrilamine, pyrvinium, quinestrol, quinethazone, uinidine, quinine, ranitidine, rauwolfia alkaloid, riboflavin, rifampin, ritodrine, alicylates, scopolamine, secobarbital, senna, sannosides a & b, simethicone, sodium bicarbonate, sodium phosphate, sodium fluoride, spironolactone, sucrulfate, sulfacytine, sulfamethoxazole, sulfasalazine, sulfinpyrazone, sulfisoxazole, sulindac, talbutal, tamazepam, terbutaline, terfenadine, terphinhydrate, teracyclines, thiabendazole, thiamine, thioridazine, thiothixene, thyroblobulin, thyroid, thyroxine, ticarcillin, timolol, tocamide, tolazamide, tolbutamide, tolmetin trozodone, tretinoin, triamcinolone, trianterene, triazolam, trichlormethiazide, tricyclic antidepressants, tridhexethyl, trifluoperazine, triflupromazine, trihexyphenidyl, trimeprazine, trimethobenzamine, trimethoprim, tripclennamine, triprolidine, valproic acid, verapamil, vitamin A, vitamin B-12, vitamin C, vitamin D, vitamin E, vitamin K, xanthine, and the like.

Further examples of medicaments include, but are not limited to, antihistamines (e.g., dimenhydrinate, diphenhydramine, chlorpheniramine and dexchlorpheniramine maleate), analgesics (e.g., aspirin, codeine, morphine, dihydromorphone, oxycodone, etc.), anti-inflammatory agents (e.g., naproxyn, diclofenac, indomethacin, ibuprofen, acetaminophen, aspirin, sulindac), gastrointestinals. and anti-emetics (e.g., metoclopramide), anti-epileptics (e.g., phenyloin, meprobamate and nitrazepam), vasodilators (e.g., nifedipine, papaverine, diltiazem and nicardipine), anti-tussive agents and expectorants (e.g., codeine phosphate), anti-asthmatics (e.g. theophylline), anti-spasmodics (e.g. atropine, scopolamine), hormones (e.g., insulin, heparin), diuretics (e.g., ethacrynic acid, bendroflumethiazide), anti-hypotensives (e. g., propranolol, clonidine), bronchodilators (e.g., albuterol), anti-inflammatory steroids (e.g., hydrocortisone, triamcinolone, prednisone), antibiotics (e.g., tetracycline), antihemorrhoidals, hypnotics, psychotropics, antidiarrheals, mucolytics, sedatives, decongestants, laxatives, antacids, vitamins, stimulants (including apetite suppressants such as phenylpropanolamine). The above list is not meant to be exclusive.

Other types of medicaments include flurazepam, nimetazepam, nitrazepam, perlapine, estazolam, haloxazolam, sodium valproate, sodium cromoglycate, primidone, alclofenac, perisoxal citrate, clidanac, indomethacin, sulpyrine, flufenamic acid, ketoprofen, sulindac, metiazinic acid, tolmetin sodium, fentiazac, naproxen, fenbufen, protizinic acid, pranoprofen, flurbiprofen, diclofenac sodium, mefenamic acid, ibuprofen, aspirin, dextran sulfate, carindacillin sodium, and the like.

The medicament may be in the form of a physiologically active polypeptide, which is selected from the group consisting of insulin, somatostatin, somatostatin derivatives, growth hormone, prolactin, adrenocorticotrophic hormone, melanocyte stimulating hormone, thyrotropin releasing hormone, its salts or its derivatives, thyroid stimulating hormone, luteinizing hormone, follicle stimulating hormone, vasopressin, vasopressin derivatives, oxytocin, carcitonin, parathyroid hormone, glucagon, gastrin, secretin, pancreozymin, cholecystokinin, angiotensin, human placentalactogen, human chorionic gonadotropin, enkephalin, enkephalin derivatives, endorphin, interferon (in one or more of the forms alpha, beta, and gamma), urokinase, kallikrein, thymopoietin, thymosin, motilin, dynorphin, bombesin, neurotensin, caerulein, bradykinin, substance P, kyotorophin, nerve growth factor, polymyxin B, colistin, gramicidin, bacitracin, bleomycin and neocarzinostatin.

Furthermore, the bioactive agent may be a polysaccharide, such as heparin, an antitumor agent such as lentinan, zymosan and PS-K (krestin), anaminoglycoside such as e.g. gentamycin, streptomycin, kanamycin, dibekacin, paromomycin, kanendomycin, lipidomycin, tobramycin, amikacin, fradiomycin and sisomicin, a beta-lactam antibiotic, such as e.g. a penicillin, such as e.g. sulbenicillin, mecillinam, carbenicillin, piperacillin and ticarcillin, thienamycin, and cephalosporins such ascefotiam, cefsulodine, cefinenoxime, cefinetazole, cefazolin, cefotaxime, cefoperazone, ceftizoxime andmoxalactam, or a nucleic acid drug such as e.g. citicoline and similar antitumor agents, for example cytarabine and 5-FU (5-fluorouracil).

Certain monomericsubunits of the present invention may exist in particular geometric or stereoisomeric forms. The present invention contemplates all such compounds, including cis- and trans-isomers, R- and S-enantiomers, diastereomers, (D)-isomers, (L)-isomers, the racemic mixtures thereof, and other mixtures thereof, as falling within the scope of the invention. Additional asymmetric carbon atoms may be present in a substituent such as an alkyl group. All such isomers, as well as mixtures thereof, are intended to be included in this invention.

For the purposes of this application, unless expressly noted to the contrary, a named amino acid shall be construed to include both the D or L stereoisomers, preferably the L stereoisomer.

If, for instance, a particular enantiomer of a compound of the present invention is desired, it may be prepared by asymmetric synthesis, or by derivation with a chiral auxiliary, where the resulting diastereomeric mixture is separated and the auxiliary group cleaved to provide the pure desired enantiomers. Alternatively, where the molecule contains a basic functional group, such as amino, or an acidic functional group, such ascarboxyl, diastereomeric salts are formed with an appropriate optically-active acid or base, followed by resolution of the diastereomers thus formed by fractional crystallization or chromatographic means well known in the art, and subsequent recovery of the pure enantiomers.

### Antibiotic Agents

An antibiotic is a chemotherapeutic agent that inhibits or abolishes the growth of micro-organisms, such as bacteria, fungi, or protozoa. Below is a list of antibiotic agents that in one embodiment may be comprised in the pharmaceutical composition to be applied by ultrasonic spray technology onto the surface of a matrix material.

Antibiotics are well known to those of skill in the art, and include, for example, penicillins, cephalosporins, tetracyclines, ampiciflin, aureothicin, bacitracin, chloramphenicol, cycloserine, erythromycin, gentamicin, gramacidins, kanamycins, neomycins, streptomycins, tobramycin, and vancomycin. Further antibiotic agents are listed in Table 5 below:

TABLE 5
Antibiotic agents

Amikacin, Anisomycin, Apramycin, Azithromycin, Blasticidine, Brefeldin A, Butirosin,
Butirosin A, Chloramphenicol, Chlortetracycline hydrochloride, Clindamycin 2-phosphate,
Clindamycin hydrochloride, Clotrimazole, Cycloheximide, Demeclocycline hydrochloride,
Dibekacin sulfate salt, Dihydrostreptomycin sesquisulfate, Dihydrostreptomycin solution,
Doxycycline hyclate, Duramycin, Emetine dihydrochloride hydrate, Erythromycin, Temephos
PESTANAL ®, Erythromycin estolate, Erythromycin ethyl succinate, Erythromycin stearate,
Fusidic acid sodium salt, Fusidic acid sodium salt, G 418 disulfate salt, Gentamicin solution,
Gentamicin sulfate, Gentamicin-Glutamine solution, Helvolic acid, Hygromycin B, Hygromycin
B solution, Josamycin, Josamycin solution, Kanamycin B sulfate salt, Kanamycin disulfate salt,
Kanamycin monosulfate, Kanamycin solution, Kirromycin, Lincomycin hydrochloride,
Lincomycin standard solution, Meclocycline sulfosalicylate salt, Mepartricin, Midecamycin,
Minocycline hydrochloride, Neomycin solution, Neomycin trisulfate salt hydrate, Neomycin B,
Netilmicin sulfate salt, Nitrofurantoin crystalline, Nourseothricin sulfate, Oleandomycin
phosphate salt, Oleandomycin triacetate, Oxytetracycline dehydrate, Oxytetracycline
hemicalcium salt, Oxytetracycline hydrochloride, Paromomycin sulfate salt, Puromycin
dihydrochloride, Rapamycin, Ribostamycin sulfate salt, Rifampicin, Rifamycin SV sodium salt,
Rosamicin, Sisomicin sulfate salt, Spectinomycin dihydrochloride hydrate, Spectinomycin
dihydrochloride pentahydrate, Spectinomycin standard solution, Spiramycin, Spiramycin
solution (mixture of spiramycin I, II and III), Streptomycin solution, Streptomycin sulfate salt,
Tetracycline, Tetracycline hydrochloride, Thiamphenicol, Tobramycin, Tobramycin sulfate salt,
Tunicamycin A₁, Tunicamycin C₂, Tunicamycin, Tylosin solution, Tylosin tartrate, Viomycin
sulfate salt, Virginiamycin M₁, (S)-(+)-Camptothecin, 10-Deacetylbaccatin III, 5-Azacytidine, 7-
Aminoactinomycin D, 8-Quinolinol crystalline, 8-Quinolinol hemisulfate salt crystalline, 9-
Dihydro-13-acetylbaccatin III, Aclarubicin, Aclarubicin hydrochloride, Actinomycin D,
Actinomycin \tilde{D}Mannitol, Actinomycin I, Actinomycin V, Aphidicolin, Bafilomycin A1, Bleomycin
sulfate, Capreomycin sulfate, Chromomycin A₃, Cinoxacin, Ciprofloxacin, cis-
Diammineplatinum(II)dichloride, Coumermycin A1, Cytochalasin B, Cytochalasin,
Dacarbazine, Daunorubicin hydrochloride, Distamycin A hydrochloride, Doxorubicin
hydrochloride, Echinomycin, Enrofloxacin, Etoposide, Flumequine, Formycin A, Fumagillin,
Ganciclovir, Gliotoxin, Lomefloxacin hydrochloride, Metronidazole, Mithramycin A, Mitomycin
C, Nalidixic acid, Nalidixic acid sodium salt, Netropsin dihydrochloride hydrate, Nitrofurantoin,
Nogalamycin, Nonactin, Novobiocin sodium salt, Ofloxacin, Oxolinic acid, Paclitaxel,
Phenazine methosulfate, Phleomycin, Pipemidic acid, Rebeccamycin, Sinefungin,
Streptonigrin, Streptozocin, Succinylsulfathiazole, Sulfadiazine, Sulfadimethoxine,
Sulfaguanidine, Sulfamethazine, Sulfamonomethoxine, Sulfanilamide, Sulfaquinoxaline sodium
salt, Sulfasalazine, Sulfathiazole sodium salt, Trimethoprim, Trimethoprim lactate salt,
Tubercidin, 5-Azacytidine, Cordycepin, Formycin A, Tubercidin, (+)-6-Aminopenicillanic acid, 7-
Aminodesacetoxycephalosporanic acid, Amoxicillin, Ampicillin, Ampicillin sodium salt,
Ampicillin trihydrate, Azlocillin sodium salt, Bacitracin, Bacitracin zinc salt, Carbenicillin
disodium salt, Cefaclor, Cefamandole lithium salt, Cefamandole nafate, Cefamandole sodium
salt, Cefmetazole sodium salt, Cefoperazone sodium salt, Cefotaxime sodium salt, Cefsulodin
sodium salt, Cefsulodin sodium salt hydrate, Ceftriaxone sodium salt, Cephalexin hydrate,
Cephalosporin C zinc salt, Cephalothin sodium salt, Cephapirin sodium salt, Cephradine,
Cloxacillin sodium salt, Cloxacillin sodium salt monohydrate, D{tilde over (-()} )-Penicillamine hydrochloride,
D-Cycloserine, Dicloxacillin sodium salt monohydrate, D-Penicillamine, Econazole nitrate salt,
Ethambutol dihydrochloride, Lysostaphin, Moxalactam sodium salt, Nafcillin sodium salt
monohydrate, Nikkomycin, Nikkomycin Z, Nitrofurantoin, Oxacillin sodium salt, Penicillic acid,
Penicillin G potassium salt, Penicillin G sodium salt hydrate, Penicillin G sodium salt,
Phenethicillin potassium salt, Phenoxymethylpenicillinic acid potassium salt, Phosphomycin
disodium salt, Pipemidic acid, Piperacillin sodium salt, Piperacillin sodium salt, Ristomycin
monosulfate, ristocetin A, Ristocetin B, Ristomycin monosulfate, Vancomycin hydrochloride, 2-
Mercaptopyridine N-oxide sodium salt, 4-Bromocalcimycin A23187, Alamethicin,
Amphotericin B, Calcimycin A23187, Calcimycin A23187 hemi(calcium-magnesium) salt,
Calcimycin A23187 hemicalcium salt, Calcimycin A23187 hemimagnesium salt, Chlorhexidine
diacetate salt monohydrate, Chlorhexidine diacetate salt hydrate, Chlorhexidine digluconate,
Clotrimazole, Colistin sodium methanesulfonate, Colistin sulfate salt, Econazole nitrate salt,
Hydrocortisone 21-acetate VETRANAL ®, Filipin complex, Gliotoxin, Gramicidin A, Gramicidin,
Gramicidin, mixture of gramicidins A, B, C, and D, Ionomycin calcium salt, Lasalocid A sodium
salt, Lonomycin A sodium salt, Monensin sodium salt, N-(6-Aminohexyl)-5-chloro-1-
naphthalenesulfonamide hydrochloride, Narasin, Nigericin sodium salt, Nisin, Nonactin,
Nystatin, Phenazine methosulfate, Pimaricin, Polymyxin B, Polymyxin B sulfate salt, DL-
Penicillamine acetone adduct hydrochloride monohydrate, Praziquantel, Salinomycin,
Surfactin, Valinomycin, (+)-Usnic acid, (±)-Miconazole nitrate salt, (S)-(+)-Camptothecin, 1-
Deoxymannojirimycin hydrochloride, 1-Deoxymannojirimycin hydrochloride, 1-Deoxynojirimycin
hydrochloride, 2-Heptyl-4-hydroxyquinoline N-oxide, Cordycepin, 1,10-Phenanthroline
hydrochloride monohydrate, 6-Diazo-5-oxo-L-norleucine, 8-Quinolinol, 8-Quinolinol hemisulfate
salt, Antimycin A, Antimycin A₁, Antimycin A₂, Antimycin A₃, Antipain, Ascomycin, Azaserine,
Bafilomycin A1, Bafilomycin B1, Cerulenin, Chloroquine diphosphate salt, Cinoxacin,
Ciprofloxacin, Mevastatin, Concanamycin A, Concanamycin C, Coumermycin A1 , L(+)-Lactic
acid, Cyclosporin A, Econazole nitrate salt, Enrofloxacin, Etoposide, Flumequine, Formycin A,
Furazolidone, Fusaric acid, Geldanamycin, Gliotoxin, Gramicidin A, Gramicidin C, Gramicidin,
mixture of gramicidins A, B, C, and D, Herbimycin A, Indomethacin, Irgasan Lomefloxacin
hydrochloride, Mycophenolic acid, Myxothiazol, N-(6-Aminohexyl)-5-chloro-1-
naphthalenesulfonamide hydrochloride, Nalidixic acid, Nalidixic acid sodium salt, Netropsin
dihydrochloride hydrate, Niclosamide, Nikkomycin, N-Methyl-1-deoxynojirimycin, Nogalamycin,
Nonactin, Novobiocin sodium salt, Ofloxacin, Oleandomycin triacetate, Oligomycin, Oligomycin
A, Oligomycin B, Oligomycin C, Oxolinic acid, Piericidin A, Pipemidic acid, Radicicol,
Rapamycin, Rebeccamycin, Sinefungin, Staurosporine, Stigmatellin, Succinylsulfathiazole,
Sulfadiazine, Sulfadimethoxine, Sulfaguanidine, Sulfamethazine, Sulfamonomethoxine,
Sulfanilamide, Sulfaquinoxaline sodium salt, Sulfasalazine, Sulfathiazole sodium salt,
Sulfathiazole sodium salt, Triacsin C, Trimethoprim, Trimethoprim, Trimethoprim lactate salt,
Vineomycin A₁, Tectorigenin, Paracelsin.

### Indicators Contained in the Pharmaceutical Composition

In one embodiment, the fluid or liquid composition to be applied by ultrasonic spray technology onto a matrix material according to the present invention comprises one or more indicators. An indicator as used herein means a detector such as a chemical detector capable of detecting the presence of a condition or another chemical.

Detection of a condition by the indicator as applied by ultrasonic spray technology onto the sponge may occur by e.g. a colour reaction, whereby one condition causes the composition comprising the indicator to acquire a certain colour change and another condition causes the composition comprising the indicator to acquire another certain colour change or alternatively no colour change. A colour change or the absence of a colour change is thus indicative of a certain condition. A colour reaction is a type of a visual indicator.

Thus, the indicator may in one embodiment be a visual indicator, such as a colour indicator.

In one embodiment, the indicator is a pH indicator, capable of revealing the pH condition in the skin or wound contacting area of the matrix material according to the present invention, selected from the non-limiting group of Bicarbonate indicator, Gentian violet (Methyl violet), Leucomalachite green, Thymol blue, Methyl yellow, Bromophenol blue, Congo red, Methyl orange, Bromocresol green, Methyl red, Methyl red/Bromocresol green, Azolitmin, Bromocresol purple, Bromothymol blue, Phenol red, Neutral red, Naphtholphthalein, Cresol Red, Phenolphthalein, Thymolphthalein, Alizarine Yellow R, and a universal indicator. A universal indicator is a pH indicator that transitions through numbers 3-12 on the pH chart. A universal indicator is typically composed of water, methanol, propan-1-ol, phenolphthalein sodium salt, methyl red sodium salt, bromothymol blue monosodium salt, and thymol blue monosodium salt.

It follows that any pH indicators may be used alone or in combination in the composition according to the present invention.

A blood type (also called a blood group) is a classification of blood based on the presence or absence of inherited antigenic substances on the surface of red blood cells (RBCS). These antigens may be proteins, carbohydrates, glycoproteins, or glycolipids, depending on the blood group system, and some of these antigens are also present on the surface of other types of cells of various tissues. Several of these red blood cell surface antigens, that stem from one allele (or very closely linked genes), collectively form a blood group system. Blood types are inherited and represent contributions from both parents. A total of 30 human blood group systems are now recognized by the International Society of Blood Transfusion (ISBT).

The indicator may an indicator of the blood type of an individual, capable of detecting the blood type of the ABO-system. According to this system, a person has the blood type of either type A (AO or AA), B (BO or BB), AB or O(O). Type A has the A antigen, and anti-B antibodies; Type B has the B antigen, and anti-A antibodies; Type AB has the A and B antigens, and no antibodies; Type O has no antigens, and both anti-A and anti-B antibodies.

The indicator may also be an indicator of the blood type of an individual, capable of detecting the blood type of the rhesus-system. According to this system, a person has the blood type of either rhesus negative or rhesus positive.

In one embodiment, the indicator is a blood type indicator, capable of revealing the blood type of an individual by contacting a wound area with the matrix material according to the present invention, such as an agglutination-type reaction. Agglutination-type reactions are known from e.g. the Coombs test.

An indicator may also one that is capale of detecting any type of disease or condition, such as the following non-limiting examples: Allergy, Autoimmune Diseases, Blood Diseases, Cancer, Blood Cholesterol, Diabetes, Genetic Testing, Drug Screening, Environmental Toxins, Nutrition, Gastrointestinal Diseases, Heart Diseases, Hormones, Metabolism (sodium, potassium, chloride, bicarbonate, blood urea nitrogen (BUN), magnesium, creatinine, glucose and/or calcium), Infectious Diseases, Kidney Diseases, Liver Diseases, Sexually Transmitted Diseases (STD's) and Thyroid Disease.

The one or more bioactive agents disclosed herein above may be comprised in the same fluid or liquid composition contained in the same reservoir and expelled from the same nozzle assembly head comprising one or more ultrasonic spray nozzles, or the one or more bioactive agents may be comprised in separate fluid or liquid compositions contained in separate reservoirs and expelled from separate nozzle assembly heads each comprising one or more ultrasonic spray nozzles or expelled from different channels of the same nozzle assembly head.

In one embodiment, two or more fluid or liquid compositions each comprising one or more bioactive agents may be applied by ultrasonic spray technology at the same or different positions on the surface of said matrix material.

### Incompatible Agents or Bioactive Agents in Separate Compositions

In one embodiment, the present invention relates to a matrix material comprising a surface and a plurality of open and interconnected cells, wherein the surface of said matrix comprises two different pharmaceutical compositions, wherein the two pharmaceutical compositions comprises different agents or bioactive agents which are incompatible, and wherein said two pharmaceutical compositions are applied by ultrasonic spray technology onto said surface in non-overlapping locations.

Two or more different fluid or liquid compositions each comprising at least one agent or bioactive agent may thus be applied by ultrasonic spray technology at different positions on the surface of a matrix material. This is especially relevant when said agents or bioactive agents are not compatible when comprised in the same fluid or liquid composition for various reasons, and when said incompatible agents or bioactive agents may be applied by ultrasonic spray technology separately but in close proximity to each other, for example in alternating positions on the surface of a matrix material.

Incompatibility may arise from the two agents or bioactive agents inappropriately interacting when in contact in the same position in either a fluid or liquid composition or on the surface of a matrix material. Thus, interaction between substances or bioactive agent may be controlled and postponed until desired with the ultrasonic spray technology.

In one embodiment, interaction of two agents or bioactive agents capable of interacting with each other, which are applied by ultrasonic spray technology in close proximity to each other on the surface of a matrix material according to the present invention, is initiated by wetting of the matrix material, by compression of the matrix material, by contacting or rubbing the surface of the matrix material against another surface or any other means.

The two or more fluid or liquid compositions may each comprise one agent or bioactive agent which may be an enzyme and its substrate, respectively; an enzyme, its substrate and a catalyst, respectively; one component of a two-component glue and another component of said two-component glue; or thrombin and fibrinogen.

In a particular embodiment the two individual compositions each comprise one component of a two-component glue, such as a surgical glue, which constitute two different fluid or liquid compositions that are applied by ultrasonic spray technology onto separate positions of the surface of a matrix material.

### The Matrix Material of the Device

The device according to the present invention in a preferred embodiment comprises a matrix consisting of a matrix material, onto which a composition is applied by ultrasonic spray technology on the surface of the matrix material.

In one embodiment, the matrix material comprises one or more polymers selected form the group consisting of collagen, gelatin, polyurethane, polysiloxanes (silicone), hydrogels, polyacrylamides, chitosan, sodium polyacrylate, agarose, alginates, xanthan gum, guar gum, arabic gum, agar gum, Locust Bean gum, Carrageenan gum, Xanthan gum, Karaya gum, tragacanth gum, Ghatti gum, Furcelleran gum, chitin, cellulose, methylcellulose, carboxymethyl cellulose, hydroxymethyl cellulose, hydroxypropyl methylcellulose, hydroxypropyl cellulose, hyaluronic acid, pectin, starch, glycogen, pentosans, polyoxyethylene, polyAMPS (poly(2-acrylamido-2-methyl-1-propanesulfonic acid), polyvinylpyrrolidone, polyvinyl alcohol, polyglycolic acid, polyacetic acid, acrylate polymers, polyhydroxyalkyl acrylates, methacrylates, polyvinyl lactams, polyvinyl alcohols, polyoxyalkylenes, polyacrylamides, polyacrylic acid, polystyrene sulfonates, synthetic hydrocolloids such as N-vinyl-2-pyrrolidone, 5-methyl-N-vinyl-2-pyrrolidone, 5-ethyl-N-vinyl-2-pyrrolidone, 3,3-dimethyl-N-vinyl-2-pyrrolidone, 3-methyl-N-vinyl-2-pyrrolidone, 3-ethyl-N-vinyl-2-pyrrolidone, 4-methyl-N-vinyl-2-pyrrolidone, 4-ethyl-N-vinyl-2-pyrrolidone, N-vinyl-2-valerolactam, N-vinyl-2-caprolactam, hydroxyalkyl acrylates and methacrylates, (such as 2-hydroxyethyl acrylate, 2-hydroxyethyl methacrylate, 2-hydroxypropyl acrylate, 2-hydroxypropyl methacrylate, 2,3-dihydroxypropyl methacrylate), acrylic acid, methacrylic acid, tertiary amino-methacrylimide, (e.g. trimethylamino-methacrylimide), crotonic acid, pyridine, water soluble amides, (such as N-(hydroxymethyl)acrylamide and -methacrylamide, N-(3-hydroxpropyl)acrylamide, N-(2-hydroxyethyl) methacrylamide, N-(1,1-dimethyl-3-oxabutyl)acrylamide N-[2-(dimethylamine)ethyl]acrylamide and -methacrylamide, N-[3-(dimethylamino)-2-hydroxylpropyl]methacrylamide, and N-[1,1-dimethyl-2-(hydroxymethyl)-3-oxabutyl]acrylamide); water-soluble hydrazine derivatives, (such as trialkylamine methacrylimide, and dimethyl-(2-hydroxypropyl)amine methacrylimide); mono-olefinic sulfonic acids and their salts, (such as sodium ethylene sulfonate, sodium styrene sulfonate, 2-acrylamideo-2-methylpropanesulfonic acid), 1-vinyl-imidazole, 1-vinyl-indole, 2-vinyl imidazole, 4(5)-vinyl-imidazole, 2-vinyl-1-methyl-imidazole, 5-vinyl-pyrazoline, 3-methyl-5-isopropenyl-pyrazole, 5-methylene-hydantoin, 3-vinyl-2-oxazolidone, 3-methacrylyl-2-oxazolidone, 3-methacrylyl-5-methyl-2-oxazolidone, 3-vinyl-5-methyl-2-oxazolidone, 2- and 4-vinyl-pyridine, 5-vinyl-2-methyl-pyridine, 2-vinyl-pyridine-1-oxide, 3-isopropenyl-pyridine, 2- and 4-vinyl-piperidine, 2- and 4-vinyl-quinoline, 2,4-dimethyl-6-vinyl-s-triazine, 4-acrylyl-morpholine, Oxidized Regenerated Cellulose (ORC), poly(lactic-co-glycolic acid) (PLGA), Polylactic acid (PLA), Extracellular matrix (ECM), and mixtures thereof.

In a preferred embodiment of the present invention, the matrix of the device is a sponge. In yet another preferred embodiment, the sponge is a gelatin-sponge or a collagen-sponge or a gelatin- or collagen-comprising sponge.

The gelatin typically originates from a porcine source, but may originate from other animal sources, such as from bovine or fish sources. The gelatin may also be synthetically made, i.e. made by recombinant means.

The collagen typically originates from a bovine source, but may originate from other animal sources. The collagen may also be synthetically made, i.e. made by recombinant means.

The gelatin or collagen matrix may be commercially available. Non-limiting examples of commercially available gelatin or collagen matrixes include Spongostan, Surgifoam, Surgiflo (all Ferrosan NS), Collastat (Kendall Co.), Avitene (Avicon Inc.), Surgicel (Johnson & Johnson) and Gelfoam (Pfizer).

In one embodiment of the present invention, the material comprising the matrix has some defined physical characteristics relating to the reconformation rate. The reconformation rate of the matrix material refers to the elasticity of the matrix material, and is typically determined by a method based on the rate at which the sponge regains its original size and shape, as described in Example 1. In one embodiment of the invention, the matrix material has a reconformation rate of no more than 10 seconds, such as no more than 9 seconds, for example no more than 8 seconds, such as no more than 7 seconds, for example no more than 6 seconds, such as no more than 5 seconds, for example no more than 4 seconds, such as no more than 3 seconds, for example no more than 3 seconds, such as no more than 1 second.

The physical characteristics defining the matrix material may also relate to the Compression modulus (or Young's modulus). The modulus is a measure of the hardness or softness of a material and is equal to stress divided by strain. Stress is equal to pressure. Strain or deflection is equal to the ratio of the change in thickness to the original thickness of the material. The lower the modulus, the softer the material. In short; the ratio of stress to strain in compression. To test this property, ASTM D695 is the standard test method in the USA, and the analogous test to measure compressive strength in the ISO system is ISO 604.

The modulus of the matrix material according to the present invention may be in the range of 0.1-50 GPa, such as 0.1-1, for example 1-2, such as 2-3, such as 3-4, for example 4-5, such as 5-6, for example, 6-7, such as 7-8, for example 8-9, such as 9-10, for example 10-20, such as 20-30, for example 30-40, such as 40-50 GPa.

In one embodiment of the present invention, the pore size of the matrix material has a normal distribution around 0.1-1.0 mm. The pore size may be less than 10 mm, such as less than 9 mm, for example less than 8 mm, such as less than 7 mm, for example less than 6 mm, such as less than 5 mm, for example less than 4 mm, such as less than 3 mm, for example less than 2.9 mm, such as less than 2.8 mm, for example less than 2.7 mm, such as less than 2.6 mm, for example less than 2.5 mm, such as less than 2.4 mm, for example less than 2.3 mm, such as less than 2.2 mm, for example less than 2.1 mm, such as less than 2 mm, for example less than 1.9 mm, such as less than 1.8 mm, for example less than 1.7 mm, such as less than 1.6 mm, for example less than 1.5 mm, such as less than 1.4 mm, for example less than 1.3 mm, such as less than 1.2 mm, for example less than 1.1 mm, such as less than 1.0 mm, for example less than 0.9 mm, such as less than 0.8 mm, for example less than 0.7 mm, such as less than 0.6 mm, for example less than 0.5 mm, such as less than 0.4 mm, for example less than 0.3 mm, such as less than 0.2 mm, for example less than 0.1 mm, such as less tan 0.05, for example less than 0.01 mm.

In yet an embodiment, the pore size of the matrix material is in the range of 0.01-0.1 mm, such as 0.1-0.2 mm, for example 0.2-0.3 mm, such as 0.3-0.4 mm, for example 0.4-0.5 mm, such as 0.5-0.6 mm, for example 0.6-0.7 mm, such as 0.7-0.8 mm, for example 0.8-0.9 mm, such as 0.9-1 mm, for example 1-1.1 mm, such as 1.1-1.2 mm, for example 1.2-1.3 mm, such as 1.3-1.4 mm, for example 1.4-1.5 mm, such as 1.5-1.6 mm, for example 1.6-1.7 mm, such as 1.-1.8 mm, for example 1.8-1.9 mm, such as 2-2.1 mm, for example 2.1-2.2 mm, such as 2.2-2.3 mm, for example 2.3-2.4 mm, such as 2.4-2.5 mm, for example 2.5-2.6 mm, such as 2.6-2.7 mm, for example 2.7-2.8 mm, such as 2.8-2.9 mm, for example 2.9-3 mm, such as 3-4 mm, for example 4-5 mm, such as 5-6 mm, for example 6-7 mm, such as 7-8 mm, for example 8-9 mm, such as 9-10 mm, or any combination of these intervals.

In one embodiment of the present invention, the surface of the matrix material has some defined properties relating to the porous or uneven surface of the matrix material. Porosity is a measure of the void spaces in a material, and is measured as a fraction, between 0-1, or as a percentage between 0-100%. The porosity of the surface may thus rely on the pore size of the material of the matrix.

By modifying the surface properties of the underlying matrix material (hydrophobicity, chemical heterogeneity, roughness), the evaporation process of the tiny droplets can be tuned in a definite way.

In one embodiment, the hydrophobicity of the surface of the matrix material may be modulated to increase evaporation. In chemistry, hydrophobicity refers to the physical property of a molecule (known as a hydrophobe) that is repelled from a mass of water. Hydrophobic molecules tend to be non-polar and thus prefer other neutral molecules and nonpolar solvents. Hydrophobic molecules in water often cluster together forming micelles. Water on hydrophobic surfaces will exhibit a high contact angle (meaning that the droplet will make the least possible contact area with the surface).

In one embodiment, the roughness of the surface of the matrix material can be modulated to increase evaporation. This may depend on pore size.

In one embodiment, the pharmaceutical composition of the present invention comprises the bioactive agent thrombin, as described in detail below. The composition is applied by ultrasonic spray technology onto the surface of the matrix. In a preferred embodiment, the surface of the matrix contains less than 300 IU/cm² (international units per square centimeter), such as less than 290, for example less than 280, such as 270, for example less than 260, such as less than 250, for example less than 240, such as 230, for example less than 220, such as less than 210, for example less than 200, such as 190, for example less than 180, such as less than 170, for example less than 160, such as 150, for example less than 140, such as less than 130, for example less than 120, such as 110, for example less than 100 IU/cm², such as less than 95, for example less than 90, such as 85, for example less than 80, such as less than 75, for example less than 70, such as 65, for example less than 60, such as less than 55, for example less than 50, such as 45, for example less than 40, such as less than 35, for example less than 30, such as 25, for example less than 20, such as less than 15, for example less than 10, such as 5, for example less than 1 IU/cm².

In another preferred embodiment, the surface of the matrix contains between 1-5 IU/cm², such as 5-10 IU/cm², for example 10-15 IU/cm², such as 15-20 IU/cm², for example 20-25 IU/cm², such as 25-30 IU/cm², for example 30-35 IU/cm², such as 35-40 IU/cm², for example 40-45 IU/cm², such as 45-50 IU/cm², for example 50-55 IU/cm², such as 55-60 IU/cm², for example 60-65 IU/cm², such as 65-70 IU/cm², for example 70-75 IU/cm², such as 75-80 IU/cm², for example 80-85 IU/cm², such as 85-90 IU/cm², for example 90-95 IU/cm², such as 95-100 IU/cm², or any combination of these intervals, of the pharmaceutical composition.

In one embodiment of the present invention, different dimensions of the device comprising a matrix material may be engaged. Thus, the dimensions of the matrix material (length, width and height) may be less than 15 cm long, less than 10 cm wide and less than 2 cm high.

Furthermore, different shapes of the device comprising a matrix material may be engaged. Non-limiting examples include a square form, circular form, rectangular form, cubic form, spherical form and pyramid-shaped forms.

Different colors of the device comprising a matrix material may be engaged. Non-limiting examples include red, pink, yellow, blue, green, white, black, brown, purple, orange, grey and turquoise.

In one embodiment, these colours may aide in identifying the device according to the composition that has been applied by ultrasonic spray technology onto the surface of the matrix material of the device. Thus, for example a purple device may signal that thrombin is applied by ultrasonic spray technology onto the gelatin-based sponge of the matrix material of said device.

Different types of the device comprising a matrix material may be engaged. Thus, the device may comprise a sponge, a gel, a bandage, a swab, a dressing and a patch.

The temperature of the matrix material employed in the present invention may be adjusted to be within the range of 5-70° C., such as 5-10, for example 10-15, such as 15-20, for example 20-25, such as 25-30, for example 30-40, such as 40-50, for example 50-60, such as 60-70° C.

### Sterilization of the Matrix or the Device

In one embodiment of the present invention, the device according to the present invention comprises a matrix and a pharmaceutical composition that has been applied by ultrasonic spray technology onto the surface of a matrix or a device. The matrix or the device is preferably sterile and contained in a sterile, pre-packaged, ready-to-use container.

The sterilization preferably occurs after the packaging step. Sterilization refers to any process that effectively kills or eliminates transmissible agents (such as fungi, bacteria, viruses, prions and spore forms etc.) from e.g. a surface or equipment. Sterilization can be achieved through application of heat, chemicals, irradiation, high pressure or filtration. Heat sterilization include autoclaving (uses steam at high temperatures); radiation sterilization include X-rays, gamma rays, UV light and subatomic particles; chemical sterilization include using ethylene oxide gas, ozone, chlorine bleach, glutaraldehyde, formaldehyde, ortho phthalaldehyde, hydrogen peroxide and peracetic acid.

The Composition to be Applied by Ultrasonic Spray Technology onto the Matrix of Device

Besides comprising at least one agent or bioactive agent as discussed below, the composition subject to application by ultrasonic spray technology will in a preferred embodiment have certain characteristics, which makes it compatible for the ultrasonic spray technology.

The composition can also be referred to as the spray medium. The composition may in one embodiment comprise a solvent and at least one agent or bioactive agent.

The solvent or fluid component of the composition may be an aqueous medium. The aqueous medium may contain salts, such as sodium chloride, dissolved therein, and thus the aqueous medium may be saline.

In one embodiment, the solvent or fluid component of the composition is a volatile fluid. A volatile liquid is a liquid with a high vapor pressure or low boiling point. In other words, a volatile liquid may evaporate at room temperature or vaporize easily.

In one embodiment, a water content stabilizer such as sorbitol, polysaccaharides or polyols may be added to the composition.

### Viscosity

The viscosity of a liquid may be increased by adding a substance that increases the viscosity of the liquid. Such substances may be long chain molecules (polymers) that are soluble in that liquid; and gelatin, starch, polyethlyleneoxide, polyvinylalcohol and polyethyleneglycols (macrogol) are examples hereof.

In one embodiment, a substance that increases the viscosity of the liquid may be added to the composition, selected from the non-limiting list of acacia, alginic acid, bentonite, carbomer, carboxymethylcellulose calcium, carboxymethylcellulose sodium, cetostearyl alcohol, colloidal silicon dioxide, guar gum, hydroxyethyl cellulose, hydroxypropyl cellulose, hydroxypropyl methylcellulose, hydroxypropyl methylcellulose phtalate, magnesium aluminium silicate, methylcellulose, microcrystalline cellulose, polyvinyl alcohol, povidone, sodium alginate, sucrose, tragacanth, gelatin, starch, albumin, casein, polyethlyleneoxide, polyvinylalcohol, polyethyleneglycols (macrogol), glycerine (1,2,3-propanetriol) and glycol (1,2-propanediol).

The viscosity of the composition to be applied by ultrasonic spray technology onto the surface of the matrix must be compatible with the ultrasonic spray technology, and therefore must have its viscosity within a specific range.

Viscosity is a measure of the resistance of a fluid to being deformed by either shear stress or extensional stress. It is commonly perceived as “thickness”, or resistance to flow. Viscosity describes a fluid's internal resistance to flow and may be thought of as a measure of fluid friction. Thus, water is “thin”, having a lower viscosity, while vegetable oil is “thick” having a higher viscosity. All real fluids (except superfluids) have some resistance to stress, but a fluid which has no resistance to shear stress is known as an ideal fluid or inviscid fluid.

The SI physical unit of dynamic viscosity is the pascal-second (Pa·s), which is identical to 1 kg·m⁻¹·s⁻¹. If a fluid with a viscosity of one Pa·s is placed between two plates, and one plate is pushed sideways with a shear stress of one pascal, it moves a distance equal to the thickness of the layer between the plates in one second.

The cgs physical unit for dynamic viscosity is the poise (P), named after Jean Louis Marie Poiseuille. It is more commonly expressed, particularly in ASTM standards, as centipoise (cps). The centipoise is commonly used because water has a viscosity of 1.0020 cps (at 20° C.; the closeness to one is a convenient coincidence). The relation between poise and pascal-seconds is:

1P=1 g·cm⁻¹·s⁻¹

10 P=1 kg·m⁻¹·s⁻¹=1 Pa·s

1 cps=0.001 Pa·s=1 mPa·s

In one embodiment of the invention, the viscosity of the composition to be deposited by ultrasonic spray technology onto the surface of the matrix is more than 1 cps, such as more than 5 cps, for example more than 10 cps, such as more than 20 cps, for example more than 30 cps, such as more than 40 cps, for example more than 50 cps, such as more than 60 cps, for example more than 70 cps, such as more than 80 cps, for example more than 90 cps, such as more than 100 cps, for example more than 150 cps, such as more than 200 cps, for example more than 250 cps, such as more than 300 cps, for example more than 350 cps, such as more than 400 cps, for example more than 500 cps, such as more than 550 cps, for example more than 600 cps, such as more than 650 cps, for example more than 700 cps, such as more than 750 cps, for example more than 800 cps, such as more than 850 cps, for example more than 900 cps, such as more than 950 cps, for example more than 1000 cps, such as more than 1100 cps, for example more than 1200 cps, such as more than 1300 cps, for example more than 1400 cps, such as more than 1500 cps, for example more than 1600 cps, such as more than 1700 cps, for example more than 1800 cps, such as more than 1900 cps, for example more than 2000 cps, such as more than 2250 cps, for example more than 2500 cps, such as more than 2750 cps, for example more than 3000 cps.

In one embodiment of the invention, the viscosity of the composition to be deposited or apllied by ultrasonic spray technology onto the surface of the matrix is in the range 1-5 cps, such as 5-10 cps, for example 10-15 cps, such as 15-20 cps, for example 20-30 cps, such as 30-40 cps, for example 40-50 cps, such as 50-60 cps, for example 60-70 cps, such as 70-80 cps, for example 80-90 cps, such as 90-100 cps, for example 100-150 cps, such as 150-200 cps, for example 200-250 cps, such as 250-300 cps, for example 300-350 cps, such as 350-400 cps, for example 400-450 cps, such as 450-500 cps, for example 500-550 cps, such as 550-600 cps, for example 600-650 cps, such as 700-750 cps, for example 750-800 cps, such as 800-850 cps, for example 850-900 cps, such as 900-950 cps, for example 950-1000 cps, such as 1000-1100 cps, for example 1100-1200 cps, such as 1200-1300 cps, for example 1300-1400 cps, such as 1400-1500 cps, for example 1500-1600 cps, such as 1600-1700 cps, for example 1700-1800 cps, such as 1800-1900 cps, for example 1900-2000 cps, such as 2000-2250 cps, for example 2250-2500 cps, such as 2500-2750 cps, for example 2750-3000 cps.

In a preferred embodiment of the invention, the viscosity of the composition is in the range of 0.1-20 cps; for example 0.1-1 cps, such as 1-2 cps, for example 2-3 cps, such as 3-4 cps, for example 4-5 cps, such as 5-6 cps, for example 6-7 cps, such as 7-8 cps, for example 8-9 cps, such as 9-10 cps, for example 10-11 cps, such as 11-12 cps, for example 12-13 cps, such as 13-14 cps, for example 14-15 cps, such as 15-16 cps, for example 16-17 cps, such as 17-18 cps, for example 18-19 cps, such as 19-20 cps.

### Surface Tension

Surface tension is an attractive property of the surface of a liquid. It is what causes the surface portion of liquid to be attracted to another surface, such as that of another portion of liquid. Applying Newtonian physics to the forces that arise due to surface tension accurately predicts many liquid behaviors that are so commonplace that most people take them for granted. Applying thermodynamics to those same forces further predicts other more subtle liquid behaviors. Surface tension has the dimension of force per unit length (N/m or Newton per meter), or of energy per unit area (dyn/cm² or dyne per square centimeter).

In physics, dyne (meaning power, force) is a unit of force specified in the centimetre-gram-second (CGS) system of units, a predecessor of the modern SI. One dyne is equal to exactly 10 micronewtons. Equivalently, the dyne is defined as “the force required to accelerate a mass of one gram at a rate of one centimetre per second squared”: 1 dyn=1 g·cm/s²=10⁻⁵ kg·m/s²=10 μN

In a preferred embodiment of the invention, the surface tension of the composition is in the range of 0.020 to 0.050 N/m; for example 0.020-0.022 N/m, such as 0.022-0.024 N/m, for example 0.024-0.026 N/m, such as 0.026-0.028 N/m, for example 0.028-0.030 N/m, such as 0.030-0.032 N/m, for example 0.032-0.034 N/m, such as 0.034-0.036 N/m, for example 0.036-0.038 N/m, such as 0.038-0.040 N/m, for example 0.040-0.042 N/m, such as 0.042-0.044 N/m, for example 0.044-0.046 N/m, such as 0.046-0.048 N/m, for example 0.048-0.050 N/m.

pH

pH is a measure of the acidity or alkalinity of a solution. Aqueous solutions at 25° C. with a pH less than seven are considered acidic, while those with a pH greater than seven are considered basic (alkaline). When a pH level is 7.0, it is defined as ‘neutral’ at 25° C. because at this pH the concentration of H₃O⁺ equals the concentration of OH⁻ in pure water. The normal pH of blood is in the range of 7.35-7.45. pH is formally dependent upon the activity of hydronium ions (H₃O⁺); pH=−log₁₀ (aH⁺).

The pH of the compositions employed in the invention may be adjusted by the addition of organic or inorganic acids or bases. Useful compositions may have a preferred pH of from about 2 to 10, depending upon the type of composition being used. Typical inorganic acids include hydrochloric, phosphoric, and sulfuric acids. Typical organic acids include methanesulfonic, acetic, and lactic acids. Typical inorganic bases include alkali metal hydroxides and carbonates. Typical organic bases include ammonia, triethanolamine and tetramethylethlenediamine.

### Formulation of the Bioactive Agent of the Composition

The composition applied by ultrasonic spray technology onto the surface of a matrix material may be further adapted to comprise controlled release formulation, incorporation into microspheres and/or aerogels or the like.

### Controlled Release

Time release technology, also known as Sustained-release (SR), extended-release (ER, XR, or XL), time-release or timed-release, controlled-release (CR), or continuous-release (CR); refers to a composition formulated to dissolve slowly and release a drug or agent over time. The advantages of sustained-release compositions are that they can often be used less frequently than instant-release formulations of the same drug or agent, and that they keep steadier levels of the drug in the bloodstream. Sustained-release compositions are formulated so that the active ingredient is embedded in a matrix of insoluble substance so that the dissolving drug or agent has to find its way out through the holes in the matrix. In some CR formulations the matrix physically swells up to form a gel, so that the drug has first to dissolve in matrix, then exit through the outer surface.

In one embodiment, the composition according to the present invention is a controlled release composition, wherein the bioactive agent(s) of the composition is released from said composition in a prolonged manner. The bioactive agent may be released from the composition applied by ultrasonic spray technology onto the surface of a matrix during a period of between 1 minute to 14 days; such as 1 to 5 minutes, for example 5 to 15 minutes, such as 15 to 30 minutes, for example 30 to 45 minutes, such as 45 to 60 minutes, for example 60 to 75 minutes, such as 75 to 90 minutes, for example 90 to 120 minutes, such as 120 to 150 minutes, for example 150 to 180 minutes, such as 180 to 210 minutes, for example 210 to 240 minutes, such as 4 hours to 5 hours, for example 5 to 6 hours, such as 6 to 7 hours, for example 7 to 8 hours, such as 8 to 9 hours, for example 9 to 10 hours, such as 10 to 11 hours, for example 11 to 12 hours, such as 12 to 13 hours, for example 13 to 14 hours, such as 14 to 15 hours, for example 15 to 16 hours, such as 16 to 17 hours, for example 17 to 18 hours, such as 18 to 19 hours, for example 19 to 20 hours, such as 20 to 21 hours, for example 21 to 22 hours, such as 22 to 23 hours, for example 23 to 24 hours, such as 24 to 30 hours, for example 30 to 36 hours, such as 36 to 42 hours, for example 42 to 48 hours, such as 48 to 54 hours, for example 54 to 60 hours, such as 60 to 66 hours, for example 66 to 72 hours, such as 3 days to 3.5 days, for example 3.5 to 4 days, such as 4 to 4.5 days, for example 4.5 to 5 days, such as 5 to 5.5 days, for example 5.5 to 6 days, such as 6 to 6.5 days, for example 6.5 to 7 days, such as 7 to 8 days, for example 8 to 9 days, such as 8 to 10 days, for example 10 to 11 days, such as 11 to 12 days, for example 12 to 13 days, such as 13 to 14 days.

The controlled release formulation may be any controlled release formulation known to the skilled person, such as those disclosed in WO 99/051208, WO 04/084869, WO 06/128471, WO 03/024429, WO 05/107713 and WO 03/024426 (Egalet as Applicant).

### Aerogels

An aerogel is a low-density solid-state material derived from gel in which the liquid component of the gel has been replaced with gas. The result is an extremely low-density solid with several remarkable properties, most notably its effectiveness as a thermal insulator. Aerogels are produced by extracting the liquid component of a gel through supercritical drying. This allows the liquid to be slowly drawn off without causing the solid matrix in the gel to collapse from capillary action, as would happen with conventional evaporation. Aerogels may be produced from silica gels (Silaca aerosols), alumina (Alumina aerogels), chromia, tin oxide, agar (SEAgel), sulfur, chalcogens (Chalcogel), metals, cadmium selenide and carbon (Carbon aerogels).

In one embodiment, the composition according to the present invention is capable of forming an aerogel, wherein the bioactive agent(s) of the composition is retained or encapsulated in the aerogel composition on the surface of the matric material. The one or more encapsulated bioactive agents can in one preferred embodiment be released from the aerogel over time. In one embodiment the encapsulated bioactive agents comprises enzymes.

### Microsperes

Microspheres are spherical particles composed of various natural and synthetic materials with diameters in the micrometer range

In one embodiment, the composition comprising bioactive agent(s) according to the present invention is retained or encapsulated in microspheres on the surface of the matric material. The one or more encapsulated bioactive agents can in one preferred embodiment be released from the microsphere over time.

In one embodiment, the microspheres are biodegradable. Biodegradation is the process by which organic substances are broken down by the enzymes produced by living organisms.

### Matrix Comprising Thrombin

In one embodiment the present invention relates to a kit-of-parts comprising a matrix comprising thrombin, wherein said thrombin has been applied onto said matrix by ultrasonic spray technology. The matrix comprising thrombin may also comprise further thrombin-stabilizing agents.

The matrix comprising thrombin comprises in one embodiment one or more of the compositions listed herein below:
A matrix according to the present invention wherein thrombin and/or any other pharmaceutically active compound is applied by ultrasonic spray technology onto said matrix
Thrombi-Gel, Thrombi-Pad or ThrombiGel hemostatic foam (Vascular Solutions, Inc.)
D-Stat Dry product (D-Stat Dry, D-Stat 2 Dry) (Vascular Solutions, Inc.)
a gelatin foam pad and/or a gauze pad that provide a unique, premixed, sterile, gelatin/thrombin haemostat
a premixed thrombin/gelatin pad
thrombin freeze-dried into a gelatin foam
any standard gelatin pad with thrombin
A hemostatic paste composition comprising a hemostatic effective amount of thrombin in a polyethylene glycol base which is preferably prepared by admixing an aqueous solution of thrombin and polyethylene glycol and freeze-drying the mixture to remove substantially all of the water to yield a viscous water soluble paste of fine particles of thrombin uniformly dispersed throughout the polyethylene glycol base (as described in U.S. Pat. No. 5,595,735)
collagen paste hemostats comprising thrombin e.g. as described in U.S. Pat. No. 4,891,359
a stable collagen sponge having thrombin therein e.g. as described in U.S. Pat. No. 4,515,637.
a collagen sponge having thrombin therein e.g. as described in U.S. Pat. No. 6,649,162
FloSeal Matrix Hemostatic Sealant
Gelfoam comprising thrombin
Surgifoam comprising thrombin
Surgiflo comprising thrombin
Sponge comprising thrombin
biologically absorbable material comprising thrombin
Fibrinpaste based on e.g. a collagen sponge coated with fibrinogen and/or thrombin
TachoSil (Nycomed)
a collagen material (such as Avitene, Actifoam, Helistat, Inistat) comprising thrombin
CoStasis hemostatic device
a cellulose material (such as Surgicel Oxycel or Tabotamp) comprising thrombin

The thrombin may be any thrombin, such as Thrombostat, Thrombin-JMI (King Pharmaceuticals), Recothrom (Bayer/Zymogenetics), Evithrom (OMRIX Biopharmaceuticals/Ethicon), Evicel or any other commercially available thrombin. Thrombin may also be produced from plasma using the Thrombin Activation Device (TAD) (Thermogenesis)

### Hemostasis

The present invention is directed in one aspect to regulating or controlling or promoting hemostasis.

Coagulation is a complex process by which blood forms solid clots. It is an important part of hemostasis (the cessation of blood loss from a damaged vessel) whereby a damaged blood vessel wall is covered by a platelet- and fibrin-containing clot to stop bleeding and begin repair of the damaged vessel. Disorders of coagulation can lead to an increased risk of bleeding and/or clotting and embolism.

Coagulation is highly conserved throughout biology; in all mammals, coagulation involves both a cellular (platelet) and a protein (coagulation factor) component. Coagulation is initiated almost instantly after an injury to the blood vessel damages the endothelium (lining of the vessel). Platelets immediately form a hemostatic plug at the site of injury; this is called primary hemostasis. Secondary hemostasis occurs simultaneously—proteins in the blood plasma, called coagulation factors, respond in a complex cascade to form fibrin strands which strengthen the platelet plug. Later, as wound healing occurs, the platelet aggregate and fibrin clot are broken down.

Damage to blood vessel walls exposes collagen normally present under the endothelium. Circulating platelets bind to the collagen with the surface collagen-specific glycoprotein Ia/IIa receptor. This adhesion is strengthened further by the large multimeric circulating protein von Willebrand factor (vWF), which forms links between the platelet glycoprotein Ib/IX/V and collagen fibrils.

The platelets are then activated and release the contents of their granules into the plasma, in turn activating other platelets. The platelets undergo a change in their shape which exposes a phospholipid surface for those coagulation factors that require it. Fibrinogen links adjacent platelets by forming links via the glycoprotein IIb/IIIa. In addition, thrombin activates platelets.

The coagulation cascade of secondary hemostasis has two pathways, the contact activation pathway (formerly known as the intrinsic pathway) and the tissue factor pathway (formerly known as the extrinsic pathway) that lead to fibrin formation. It was previously thought that the coagulation cascade consisted of two pathways of equal importance joined to a common pathway. It is now known that the primary pathway for the initiation of blood coagulation is the tissue factor pathway. The pathways are a series of reactions, in which a zymogen (inactive enzyme precursor) of a serine protease and its glycoprotein co-factor are activated to become active components that then catalyze the next reaction in the cascade, ultimately resulting in cross-linked fibrin. Coagulation factors are generally indicated by Roman numerals, with a lowercase a appended to indicate an active form.

The coagulation factors are generally serine proteases (enzymes). There are some exceptions. For example, FVIII and FV are glycoproteins and Factor XIII is a transglutaminase. Serine proteases act by cleaving other proteins at specific sites. The coagulation factors circulate as inactive zymogens.

The coagulation cascade is classically divided into three pathways. The tissue factor and contact activation pathways both activate the “final common pathway” of factor X, thrombin and fibrin.

The main role of the tissue factor pathway is to generate a “thrombin burst”, a process by which thrombin, the most important constituent of the coagulation cascade in terms of its feedback activation roles, is released instantaneously. FVIIa circulates in a higher amount than any other activated coagulation factor.

Following damage to the blood vessel, endothelium Tissue Factor (TF) is released, forming a complex with FVII and in so doing, activating it (TF-FVIIa). TF-FVIIa then activates FIX and FX. FVII is itself activated by thrombin, FXIa, plasmin, FXII and FXa. The activation of FXa by TF-FVIIa is almost immediately inhibited by tissue factor pathway inhibitor (TFPI). FXa and its co-factor FVa form the prothrombinase complex which activates prothrombin to thrombin. Thrombin then activates other components of the coagulation cascade, including FV and FVII (which activates FXI, which in turn activates FIX), and activates and releases FVIII from being bound to vWF. FVIIIa is the co-factor of FIXa and together they form the tenase complex which activates FX and so the cycle continues.

In one embodiment of the present invention, thrombin may be a bioactive agent comprised in the pharmaceutical composition of the present invention.

The contact activation pathway begins with formation of the primary complex on collagen by high-molecular weight kininogen (HMWK), prekallikrein, and FXII (Hageman factor). Prekallikrein is converted to kallikrein and FXII becomes FXIIa. FXIIa converts FXI into FXIa. Factor XIa activates FIX, which with its co-factor FVIIIa form the tenase complex, which activates FX to FXa. The minor role that the contact activation pathway has in initiating clot formation can be illustrated by the fact that patients with severe deficiencies of FXII, HMWK, and prekallikrein do not have a bleeding disorder.

The final common pathway. Thrombin has a large array of functions. Its primary role is the conversion of fibrinogen to fibrin, the building block of a hemostatic plug. In addition, it activates Factors VIII and V and their inhibitor protein C (in the presence of thrombomodulin), and it activates Factor XIII (denoted XIIIa in its activated form), which forms covalent bonds that crosslink the fibrin polymers that form from activated monomers. Following activation by the contact factor or tissue factor pathways the coagulation cascade is maintained in a prothrombotic state by the continued activation of FVIII and FIX to form the tenase complex, until it is down-regulated by the anticoagulant pathways.

In one embodiment of the present invention, thrombin may be a bioactive agent comprised in the pharmaceutical composition of the present invention. In a further embodiment, fibrinogen may be a bioactive agent comprised in the pharmaceutical composition of the present invention. In yet a further embodiment, Factor XIII and/or XIIIa may be a bioactive agent comprised in the pharmaceutical composition of the present invention.

Three mechanisms keep the coagulation cascade in check. Abnormalities can lead to an increased tendency toward thrombosis. 1) Protein C is a major physiological anticoagulant. It is a vitamin K-dependent serine protease enzyme that is activated by thrombin into activated protein C (APC). The activated form (with protein S and phospholipid as a cofactor) degrades Factor Va and Factor VIIIa. Quantitative or qualitative deficiency of either may lead to thrombophilia (a tendency to develop thrombosis). Impaired action of Protein C (activated Protein C resistance), for example by having the “Leiden” variant of Factor V or high levels of Factor VIII also may lead to a thrombotic tendency. 2) Antithrombin is a serine protease inhibitor (serpin) that degrades the serine proteases; thrombin and FXa, as well as Factor XIIa, and Factor IXa. It is constantly active, but its adhesion to these factors is increased by the presence of heparan sulfate (a glycosaminoglycan) or the administration of heparins (different heparinoids increase affinity to Factor Xa, thrombin, or both). Quantitative or qualitative deficiency of antithrombin (inborn or acquired, e.g. in proteinuria) leads to thrombophilia. 3) Tissue factor pathway inhibitor (TFPI) inhibits Factor Vila-related activation of Factor IX and Factor X after its original initiation.

Various substances are required for the proper functioning of the coagulation cascade. Calcium and phospholipid (a platelet membrane constituent) are required for the tenase and prothrombinase complexes to function. Calcium mediates the binding of the complexes via the terminal gamma-carboxy residues on Factor Xa and Factor IXa to the phospholipid surfaces expressed by platelets as well as procoagulant microparticles or microvesicles shedded from them. Calcium is also required at other points in the coagulation cascade. Vitamin K is an essential factor to a hepatic gamma-glutamyl carboxylase that adds a carboxyl group to glutamic acid residues on Factors II, VII, IX and X, as well as Protein S, Protein C and Protein Z. Deficiency of vitamin K (e.g. in malabsorption), use of inhibiting anticoagulants (warfarin, acenocoumarol and phenprocoumon) or disease (hepatocellular carcinoma) impairs the function of the enzyme and leads to the formation of PIVKAs (proteins formed in vitamin K absence) this causes partial or non gamma carboxylation and affects the coagulation factors ability to bind to expressed phospholipid.

### Wound Healing

The present invention is directed in one aspect to regulating or controlling or promoting wound healing.

The outer layer of skin surrounding the body performs an important protective function as a barrier against infection, and serves as a means of regulating the exchange of heat, fluid and gas between the body and external environment.

Wounds to the skin and the underlying tissues of animals may be caused by e.g. friction, abrasion, laceration, burning or chemical irritation. Tissue damage may also result from internal metabolic or physical dysfunction, including, but not limited to, bone protrudence, diabetes, circulatory insufficiencies, or inflammatory processes.

A wound to the skin and/or damage to the underlying tissues significantly reduce the protective function of the skin. Consequently, damaged skin results in an increased risk of infection of the underlying tissue by infectious agents such as bacteria and vira.

Areas of damaged skin are conventionally protected by the application of a wound or tissue dressing which facilitates wound healing. Wound or tissue dressings generally provide a suitable environment for wound healing, they absorb drainage, immobilize the wound, promote hemostasis and protect the wound and new tissue growth from bacterial contamination.

The healing of wounds or related forms of tissue damage generally depends on cellular proliferation and the formation of new connective, endothelial, and epithelial tissue as explained briefly herein below.

Several agents have been reported to favorably influence the cellular processes involved in wound healing, e.g., polypeptid growth factors, allantoin, Vitamin A (and derivatives), zinc, exogenous DNA, and aloe vera preparations. These compounds operate through various poorly defined mechanisms and display varying degrees of effectiveness in particular applications

When an injury occurs, cell damage comes from the precipitating event, such as a cut, resulting in ruptured cells and severed or crushed capillaries and other blood vessels. The interruption of blood flow produces anoxia, causing the death of additional cells. Within 15 minutes of injury the wound is filled with dead and dying cells, extracellular substances collagen, elastic fibers, fat and ground substances, extravasated blood, and possibly bacteria and viruses introduced by the injurious agent. Tissue damage is not restricted to the initial area of injury; it may increase over the next several hours or days as a result of the release of lysomal enzymes from the injured cells or as a consequence of swelling and infection. (See Reese et al., Role of Fibronectin in Wound Healing, the subject matter of which is hereby incorporated by reference).

Coagulation, the first phase of the healing process, bridges the gap between the injury and the inflammatory response, the second phase of wound healing. It stops the loss of blood and restores some of the mechanical and physical integrity to the damaged tissue. The coagulation cascade is described in detail elsewhere herein.

The second phase of wound repair is the inflammatory response, which is necessary for subsequent phases of healing. It is initiated by the release of histamine and serotonin from platelets and mast cells and by kinins. Histamine and kinins act to increase capillary dilation, opening previously closed capillaries in the area of injury. The increased blood flow through the capillary beds produces two of the characteristics of the inflammatory response: redness and heat. Prostaglandin release within a few hours of injury results in the full development of the inflammatory response, which may last from 3 to 5 days depending on the extent of the injury. The extreme vasodilation produced by the factors just discussed causes a widening of the endothelial cell junctions lining the capillaries. Fluid and macromolecular components of blood escape into the tissues through the gaps, producing swelling, the third characteristic of the inflammatory response. If the swelling is extensive, it may interrupt blood flow, increasing the extent of injury as a result of anoxia. Pain, the final characteristic of inflammation, results from a combination of the kinins as well as the direct effect of lysosomal enzymes and pressure from the swelling on nerve endings.

Control of infection at the wound site is of critical importance in successful wound repair. Infections delay healing, enlarge the wound lesion, may lead to systemic infection, and greatly increase the likelihood of disfiguring and physically debilitating scars. Vasodilation of the capillary beds reduces the velocity of blood through the capillaries. This, along with the production of potent chemotactic factors from the complement fixation and the release of chemotactic agents from the damaged tissue, cause the accumulation of polymorphonuclear leukocytes (“PMN's”) along the walls of the capillaries which are the host's major cellular defense against infection. The PMN's subsequently pass through the endothelial junctions of the capillary wall into the site of the injury. If bacteria are present in the wound, they may release soluble chemotactic factors and/or activate complement with the subsequent generation of chemotactic fragments. PMN's at the site of an infection or injury release substance that affect the PMNs' mobility, keeping them at the site. Fibronectin facilitates the attachment of the bacterium to the membrane of the phagocyte.

Dead cells, cellular debris, and extracellular proteins must then be removed or readsorbed to allow revascularization and repair to continue. Macrophages are primarily responsible for the clearance of wound debris. Wound macrophages, like wound PMN's, are actively phagocytic. They migrate into the wound using the fibers of the fibrin clot as a scaffold to move within the clot, attaching to the fibers through fibronectin. The macrophages encounter, engulf, and destroy the dead cells trapped in the clot matrix, as well as the damaged cells from the wound margin. The fibrin clot itself is resolved primarily by the activation of the plasminogen that was incorporated into the fibers during their formation. Some of the fibrin fragments are engulfed by macrophages in the area. Since most of the clot fragments are released away from the area of the most intense macrophage activity, many of the fragments are removed by lymphatic drainage and thus enter the circulation. These soluble complexes are removed by the sessile cells of the RES, primarily those of the spleen and liver. Also, PMN's trapped in the clot die as a result of anoxia, releasing their lysosomal contents. These enzymes attack the surrounding clot and dissolve it. Although the release of lysosomal enzymes by PMN's may be considered beneficial to the host in most cases, they may also increase tissue destruction and delay healing. If the PMN's accumulate rapidly within the wound and remain there (as in an infection), their lysosomal enzymes dissolve significant portions of the clot, removing the framework used by the macrophages and fibroblasts to move into the wound and re-colonize it. These areas of destruction must eventually be drained or slowly removed by the macrophages. The dissolved portion of the clot is then replaced as part of the chronic inflammatory response.

Repair, or fibroplasia, of the damaged tissue occurs during some of the above stages. Within 12 to 24 hours of injury, fibroblasts, including those at some distance from the wound margins, begin to move toward the area of injury and to proliferate. This response is apparently due to factors released by the injured tissue and platelets and possibly to factors released by the kinin, complement or coagulation cascades. The proliferating fibroblasts derive part of their nutrients from the components of tissue debris and cells released by macrophages. The fibroblast phase may last 2 to 4 weeks in a skin wound, whereas it may persist several months in an injury to the stomach or intestines. Fibroblasts, as the macrophages did, use the fibers of the fibrin clot as a scaffold to move into and within the damages area. The Fibroblasts synthesize and secrete sufficient quantities of fibronectin to promote their own attachment to fibronectin deficient substrates.

Angiogenesis, or revascularization, begins with the growth of capillary beds into the area directly behind the fibroblasts. In the early phases of wound repair, the capillaries are much more numerous than in normal tissue, which probably reflects the high oxygen and nutrient requirements of the rapidly regenerating tissue. The capillaries are very leaky, which facilitates the movement of cells and macromolecules into the wound site. Eventually, the capillaries originating from one side of the wound grow into contact with capillaries originating from the other sides and fuse, reestablishing complete circulation within the wound.

By the end of the fifth day after the injury, fibroblasts begin laying down large quantities of collagen. The collagen molecule is synthesized on the membrane of the endoplastic reticulum. It then undergoes extensive postranslational modification, hydroxylation, glycosylation, and further steps to form the procollagen molecule. The procollagen molecule is then secreted and is further modified to tropocollagen by specific serum peptidases. These activated tropocollagen molecules quickly polymerize to form increasingly large collagen fibers. Thereafter, crosslinking among the collagen fibers occurs. The collagen network in effect replaces the fibrin clot as the major structural element of the wound. This becomes particularly important during the remodeling phase of wound healing.

Reepithelialization begins to occur within a few hours of injury as the attachment of the epithelial cells to the dermis loosened near the margin of the wound, and the cells begin to migrate over the defect, always maintaining contact with the mesenchymal tissue. By 48 hours after the injury, the cells are also beginning to proliferate to replace the lost cells. The epithelial cells continue to divide after the bridge is complete to form a thicker epithelium. Wound contracture aids reepithelialization insofar as it reduces the size of the defect to be reepithelialized by as much as 50%. Contracture is believed to occur as a result of the cellular element of the granulation tissue in the wound—the fibroblasts and myofibroblasts.

Remodeling is the last step of wound healing. Scar tissue continues to gain tensile strength for several months after collagen content stabilizes. This gain in strength comes from the rearrangement of the collagen in the wound and perhaps from increased crosslinking of the collagen. Collagen accumulation is the sum of synthesis and destruction, and both occur simultaneously during the wound healing process. After about 14 days, a balance between collagen synthesis and degradation is reached. The collagenase involved in the remodeling comes from epithelial cells, from fibroblasts encountering new epithelium, and from macrophages that contain collagenase in their lysosomes.

Typical wound healing takes anywhere from 5 to 21 days. This time period is of course longer for the immune compromised patient because such patients are frequently unable to sufficiently stabilize the wound and ward off infection which prevents the proper adherence of fibrin, fibronectin or collagen at an acceptable rate at the locus of the wound. For example, those with vasculitis or other rheumatic or diabetic diseases frequently experience wound healing times far in excess of several weeks. Diabetics frequently develop lesions that take weeks to heal.

Others, such as those with artificial limbs, have continuous injuries at the point of contact between the limb and the point of attachment to the body. Burns also present healing problems insofar as the burned tissue is incapable of timely production of fibrin. Accordingly, there is a great need to shorten the duration of time necessary for wound or burn healing to occur.

### Wound or Tissue Dressings

When referring to a wound or tissue dressing, it is understood that said wound or tissue dressings may be coated with the fluid or liquid composition according to the present invention primarily in the wound or tissue contacting area of said wound or tissue dressing.

### Types of Wound and Tissue Dressings

“Wound” refers broadly to injuries to the skin and underlying (subcutaneous) tissue initiated in different ways (e.g., pressure sores from extended bed rest and wounds induced by trauma) and with varying characteristics. Wounds may be classified into one of four grades depending on the depth of the wound: i) Grade I: wounds limited to the epithelium; ii) Grade II: wounds extending into the dermis; iii) Grade III: wounds extending into the subcutaneous tissue; and iv) Grade IV (or full-thickness wounds): wounds wherein bones are exposed (e.g., a bony pressure point such as the greater trochanter or the sacrum). The present invention relates to treatment of any type of wound mentioned above using one or more types of wound and/or tissue dressings as described below.

Several types of wound or tissue dressings exist. Most wound or tissue dressings are designed to maintain a moist wound bed. The most commonly used wound or tissue dressing are briefly introduced below. The present invention relates to one or more types of wound and/or tissue dressings included the ones mentioned below coated by ultrasonic spray technology with one or more pharmaceutical compositions.

Synthetic wound dressings originally consisted of two types; gauze-based dressings and paste bandages such as zinc paste bandages. In the mid-1980s the first modern wound dressings were introduced which delivered important characteristics of an ideal wound dressing: moisture keeping and absorbing (e.g. polyurethane foams, hydrocolloids) and moisture keeping and antibacterial (e.g. iodine-containing gels).

During the mid 1990s, synthetic wound dressings expanded into e.g. the following groups of products: 1) vapor-permeable adhesive films, 2) hydrogels, 3) hydrocolloids, 4) alginates, 5) synthetic foam dressings, 6) silicone meshes, 7) tissue adhesives, 8) barrier films and 9) silver- or collagen-containing dressings.

Synthetic wound dressings can be broadly categorized into the following types as indicated in the table below.

| Type | Properties |
|---|---|
| Passive | Traditional dressings that provide cover over the |
| products | wound, e.g. gauze and tulle dressings |
| Interactive | Polymeric films and forms which are mostly |
| products | transparent, permeable to water vapour and oxygen, |
| | non-permeable to bacteria, e.g. hyaluronic acid, |
| | hydrogels, foam dressings |
| Bioactive | Dressings which deliver substances active in wound |
| products | healing, e.g. hydrocolloids, alginates, collagens, chitosan |

Alginate dressings are highly absorbent, biodegradable dressings derived from seaweed. They are used for wounds with moderate to large amounts of exudate, and for wounds requiring packing. These dressings work by combining with the wound exudate to form a hydrophilic gel that creates a moist healing environment.

Hydrocolloid dressings are among the oldest and most frequently used wound or tissue dressings. They are indicated for partial thickness wounds, Stage III, granulating Stage IV pressure ulcers, and can be used in the treatment of venous stasis ulcers. Hydrocolloid dressings are either occlusive (i.e. they do not allow air to escape through the dressing), or semi-occlusive (i.e. they do allow some air to escape through the dressing) and they are designed to seal the wound bed to retain and interact with exudate to promote healing. While absorbing exudate, the hydrocolloid dressing forms a gel.

Hydrogel dressings are either sheets of cross-linked polymers or hydrogel impregnated gauze, or non-wowen sponge, used to cover a wound. The hydrogel dressing can be in the form of a hydrogel sheet dressing or in the form of an amorphous hydrogel dressing. Hydrogel sheet dressings are indicated for partial and full thickness wounds, wounds with necrosis or slough, and burns. An amorphous hydrogel dressing is a soft, formless gel comprised of either polymers or copolymers and up to 95 percent water, whereas a hydrogel sheet dressing is a firm sheet. Amorphous hydrogels carry the same indications as hydrogel sheets and they can also be used to lightly pack full-thickness wounds.

Foam dressings are semipermeable sheets of a polymer, such as polyurethane, that provide a specific, controlled moisture and temperature environment for wound healing. They are indicated for full-thickness wounds with moderate to heavy exudate. Foam dressings are non-adherent and can repel contaminants.

Transparent film dressings are made of e.g. polyurethane, polyamide or gelatin. Although they are waterproof, transparent film dressings are somewhat porous allowing for oxygen and moisture to cross through their barriers. They are non-absorptive so they must be changed often for wounds with exudate. They are generally effective on dry wounds with necrotic tissue in need of autolytic debridement. Transparent film dressings are also used as a secondary material to secure e.g. non-adhesive gauzes and other types of dry dressings.

Composite dressings combine physically distinct components into a single dressing, and provide bacterial protection, absorption, and adhesion.

Gauze dressings are available in a number of forms including sponges, pads, ropes, strips, and rolls, gauze can also be impregnated with petroleum, antimicrobials, and saline. With removal of a dried dressing, there is a risk of wound damage to the healing skin surrounding the wound.

The following table describes some of the many different types of wound dressings and their main properties:

| Type | Properties |
|---|---|
| Gauze | Dressings can stick to the wound surface and disrupt the |
| | wound bed when removed. Only use on minor wounds or as |
| | secondary dressings |
| Tulle | Dressing does not stick to wound surface. Suitable for flat, |
| | shallow wound. Useful in patient with sensitive skin. E.g. |
| | Jelonet ®, Paranet ® |
| Semipermeable film | Sterile sheet of polyurethane coated with acrylic adhesive. |
| | Transparent allowing wound checks. Suitable for shallow |
| | wound with low exudate. E.g. OpSite ®, Tegaderm ® |
| Hydrocolloids | Composed of carboxymethylcellulose, gelatin, pectin, |
| | elastomers and adhesives that turn into a gel when exudate is |
| | absorbed. This creates a warm, moist environment that |
| | promotes debridement and healing. Depending on the |
| | hydrocolloid dressing chosen can be used in wounds with light |
| | to heavy exudate, sloughing or granulating wounds. Available |
| | in many forms (adhesive or non-adhesive pad, paste, powder) |
| | but most commonly as self-adhesive pads. E.g. DuoDERM ®, |
| | Tegasorb ® |
| Hydrogels | Composed mainly of water in a complex network or fibres that |
| | keep the polymer gel intact. Water is released to keep the |
| | wound moist. Used for necrotic or sloughy wound beds to |
| | rehydrate and remove dead tissue. Do not use for moderate to |
| | heavily exudating wounds. E.g. Tegagel ®, Intrasite ® |
| Alginates | Composed of calcium alginate (a seaweed component). When |
| | in contact with wound, calcium in the dressing is exchanged |
| | with sodium from wound fluid and this turns dressing into a gel |
| | that maintains a moist wound environment. Good for exudating |
| | wounds and helps in debridement of sloughing wounds. Do not |
| | use on low exudating wounds as this will cause dryness and |
| | scabbing. Dressing should be changed daily. E.g. Kaltostat ®, |
| | Sorbsan ® |
| Polyurethane or | Designed to absorb large amounts of exudates. Maintain a |
| silicone foams | moist wound environment but are not as useful as alginates or |
| | hydrocolloids for debridement. Do not use on low exudating |
| | wounds as this will cause dryness and scabbing. E.g. |
| | Allevyn ®, Lyofoam ® |
| Hydrofibre | Soft non-woven pad or ribbon dressing made from sodium |
| | carboxymethylcellulose fibres. Interact with wound drainage to |
| | form a soft gel. Absorb exudate and provide a moist |
| | environment in a deep wound that needs packing. |
| Collagens | Dressings come in pads, gels or particles. Promote the deposit |
| | of newly formed collagen in the wound bed. Absorb exudate |
| | and provide a moist environment |

No single dressing is suitable for all types of wounds. Often a number of different types of dressings will be used during the healing process of a single wound. The present invention relates in one embodiment to dressings with one or more of the following functions: 1) Maintain a moist environment at the wound/dressing interface; 2) Absorb excess exudate without leakage to the surface of the dressing; 3) Provide thermal insulation and mechanical protection; 4) Provide bacterial protection; 5) Allow gaseous and fluid exchange; 6) Absorb wound odor; 7) Be non-adherent to the wound and easily removed without trauma; 8) Provide some debridement action (remove dead tissue and/or foreign particles); 9) Be non-toxic, non-allergenic and non-sensitizing (to both patient and medical staff); 10) Sterile.

### Wound or Tissue Dressings Comprising an Absorbent Compound

In another aspect there is provided a wound or tissue dressing comprising an absorbent compound for absorbing wound exudate, wherein said wound or tissue dressing has been coated by ultrasonic spray technology with one or more pharmaceutical compositions. None limiting examples of absorbent compound is given below.

The absorbent compound in one embodiment comprises or consists of a hydrogel forming material. The hydrogel forming material can form an amorphous hydrogel, but the hydrogel forming material can also be in the form of e.g. a sheet—in which case the dressing will be a hydrogel sheet dressing.

In other embodiments, the absorbent compound of the wound or tissue dressing comprises or consists of a hydrocolloid forming material.

The absorbent compound can comprises or consist of a porous polymer suitable for entry of wound extrudate therein, i.e. the capillary force allows wound extrudate to enter into the porous polymer. The porous polymer is often hydrophilic or sufficiently hydrophilic to allow transport of wound extrudate.

In a still further embodiment the absorbent compound comprises or consists of a foam forming material.

It is important that the absorbent compound is in fluid contact with the wound e.g. through a gel or a matrix, such as a scaffold, or, alternatively, that the absorbent compound can contact the wound directly.

The bioabsorbable and/or porous material of the absorbent compound can be adapted for serving as scaffold for new cells to attach and proliferate. Such a “connective” absorbent compound can remain in place on the wound bed throughout the healing process, and later be absorbed and replaced by new tissue. During the wound healing process, the connective absorbent compound will transmit wound exudate from the wound bed to the bioabsorbable and/or porous material of the absorbent compound.

The absorbent compound can be a material that is absorbent to liquid while at the same time serves as a barrier for cell adhesion and penetration by growing cells and larger proteins in wound exudate. Such an absorbent compound can be referred to as an “absorbent barrier material”. An absorbent barrier material can e.g. prevent bacteria present in the bioabsorbable and/or porous material of the absorbent compound from entering the wound itself. However, bioactive agents produced said bacteria and having wound healing promoting abilities are allowed to enter the wound area.

Besides absorbing wound exudate and inhibiting the loss of beneficial growth factors from the scaffold material, the absorbent compound can also act as a reservoir for liquids to hydrate the wound. The features of non-adhesion and resistance to penetration by cells provide the important advantage that the absorbent barrier material —and any subsequent connective compound—is easily removed and/or replaced as needed without causing trauma to growing cells or tissue.

If desirable, the absorbent compound can be in contact with a further compound, such as a breathable film that can serve as a barrier to the entry of contaminants into the wound bed. One example of such a barrier is a topfilm.

The absorbent compound can be any of the materials used in wound care. Materials that can be used as an absorbent compound include fabrics, foams or fibers of e.g. polyester, polypropylenes, polyethylenes and the which are optionally bonded to polyester film (such as Kendall's Novenette). Other suitable materials include, but are not limited to, natural and synthetic polymeric absorbents, hydrocolloids, superabsorbents, and cellulosic absorbents. Cellulosic materials include cotton, rayon, wood and cellulose.

The superabsorbent compound may be in any suitable form. Typical superabsorbents include starch grafted copolymers of acrylate salts, starch grafted copolymers of acrylamide salts, polyacrylate salts and the like, including mixtures thereof.

Superabsorbent compounds and composites are easily prepared or commercially available. Once such product is the composite air laid superabsorbent pad (dry forming process and the superabsorbent fiber flock SAFF) sold by Hanfspinnern Steen & Company. The superabsorbent may also be a delayed released web superabsorbent.

Superabsorbent webs that may be used in the present invention to serve as, or to be incorporated into, the absorbent compound can also include carded or random webs made from, for example, cotton, rayon, polyethylene, polyester, or wool. Another suitable web is a spun-laced web made from polyester, polypropylene, or polyethylene. The superabsorbent webs may also be in the form of tissues either single ply or multiple ply and either creped or uncreped. Delnet, a product of Applied Extrusion Technologies which consists of a range of materials manufactured from polyethylene or polypropylene using extrusion embossing and orientation processes may also be used as a web for preparing a superabsorbent web.

Superabsorbent webs can be formed by any convenient means, e.g., by slightly moistening or misting a web. After misting, a powdered superabsorbent may be applied followed by running the web through a dry oven or heating the roll. The powder adjacent to the moistened web will become tacky and adhere to the adjacent material (fibre, surface), and the loose powder would then be vacuumed off.

Alternatively, superabsorbent powder can be sandwiched between non-woven webs/paper and subjected to moist steam which would make the superabsorbent tacky so that it would then stick to adjacent surfaces. The sandwiched superabsorbent and web would then be dried, creating a two-ply web with superabsorbent between them. The superabsorbent connective compound can also be heat bonded to the other connective compounds.

The wound or tissue dressing according to the present invention can contain from about 5% to about 50% by weight of water, such as from about 5% to about 40% by weight of water, for example from about 5% to about 30% by weight of water, such as from about 5% to about 25% by weight of water, for example from about 5% to about 20% by weight of water, such as from about 5% to about 15% by weight of water, for example from about 5% to about 10% by weight of water, such as from about 10% to about 40% by weight of water, for example from about 10% to about 30% by weight of water, such as from about 10% to about 25% by weight of water, for example from about 10% to about 20% by weight of water, such as from about 10% to about 15% by weight of water, such as from about 15% to about 40% by weight of water, for example from about 15% to about 30% by weight of water, such as from about 15% to about 25% by weight of water, for example from about 15% to about 20% by weight of water.

### Absorbent Compound Comprising an Adhesive Surface

In a further embodiment the present invention relates one or more wound or tissue dressings comprising one or more absorbent compound(s) for absorbing wound exudate, wherein said wound or tissue dressing has been coated by ultrasonic spray technology with one or more pharmaceutical compositions and wherein said absorbent compound comprises an adhesive surface. Non-limiting examples of an adhesive surface are given below.

The absorbent compound can comprise at least one adhesive surface suitable for contacting a wound or the absorbent compound can be attached to at least one adhesive surface suitable for contacting a wound. When the absorbent compound is attached to at least one adhesive surface suitable for contacting a wound the absorbent compound and the adhesive surface are most often manufactured separately and only brought together during the manufacturing of the wound or tissue dressing according to the present invention. The adhesive surface can simply be positioned on or spread out over the corresponding surface of the absorbent compound, such as the absorbent compound surface which is going to be aligned with the surface of a wound.

The at least one adhesive surface can be separated from the absorbent compound by a permeable or semi-permeable barrier allowing wound extrudate to be diverted from the wound to the absorbent compound. Alternatively, the at least one adhesive surface can itself comprise a barrier acting as a permeable or semi-permeable barrier that allows wound extrudate to be diverted from the wound to the absorbent compound.

The absorbent compound can also be attached to a topfilm at least partly sealing the absorbent compound from the external environment. Alternatively, the absorbent compound itself comprises a functionality acting as a topfilm at least partly sealing the absorbent compound from the external environment.

The topfilm is often porous and the topfilm can comprise an oxygen- and vapor-permeable layer permitting transpiration of liquid from the absorbent compound.

### Gelatin and Collagen Absorbent Compounds

In some embodiments the wound or tissue dressing according to the present invention comprises an absorbent compound comprising or consisting of gelatin and/or collagen, including a combination of gelatin and collagen.

When the absorbent compound comprises or consists of gelatin the gelatin can be cross-linked and form a matrix, such as a matrix in the form of a hydrogel.

Alternatively, the wound or tissue dressing can comprise or consist of gelatin which is not crosslinked. The gelatin can be in granulated or particulated form and most often such dressings employ hydrocolloids.

When the absorbent compound comprises or consists of collagen the collagen can be cross-linked and form a matrix, such as a matrix in the form of a hydrogel.

Alternatively, the wound or tissue dressing can comprise or consist of collagen which is not crosslinked. The collagen can be in granulated or particulated form and most often such dressings employ hydrocolloids.

Hyaluronic acid can be present in the dressing in a haemostasis promoting amount in combination with any or both of gelatin and collagen.

### Alginate Absorbent Compounds

In one embodiment the absorbent compound comprises an optionally cross-linked alginate compound, such as an alginate ester, for example an alginate ester comprising propylene glycol alginate.

The degree of esterification of the alginate ester is typically from 35% to 95% and the absorbent compound can contain from 10% to 25% by weight of the alginate ester.

### Wound or Tissue Dressings Comprising Hydrocolloids

The wound or tissue dressing can comprise a hydrocolloid, but in some embodiments the hydrocolloid can be omitted. In embodiments wherein a hydrocolloid is used, the hydrocolloid comprises about 20 to about 60 weight percent of the wound or tissue dressing, based on total weight.

The hydrocolloid can comprise e.g. from about 25 to about 55 weight percent of the composition, such as from about 30 to about 50 weight percent of the composition. In one embodiment, the hydrocolloid comprises about 40 weight percent of the composition.

The hydrocolloid used in the present invention can be synthetically prepared or naturally occurring. Varieties of hydrocolloids within the scope of the present invention include synthetic polymers prepared from single or multiple monomers, naturally occurring hydrophilic polymers, or chemically modified naturally occurring hydrophilic polymers. It is preferred that the hydrocolloid is dermatologically acceptable and non-reactive with the skin of the patient or other components of the composition. Preferred examples are hydrocolloids comprising gelatin and/or collagen.

Further specific examples include hydrocolloids comprising e.g. polyhydroxyalkyl acrylates and methacrylates, polyvinyl lactams, polyvinyl alcohols, polyoxyalkylenes, polyacrylamides, polyacrylic acid, polystyrene sulfonates, natural or synthetically modified polysaccharides, alginates, gums, and cellulosics and modified celluloses.

Representative polysaccharides include e.g. starch, glycogen, hemicelluloses, pentosans, celluloses, pectin, chitosan, and chitin.

Representative gums include e.g. Arabic, Locust Bean, Guar, Agar, Carrageenan, Xanthan, Karaya, tragacanth, Ghatti, and Furcelleran gums.

Representative modified celluloses include methyl cellulose, hydroxypropyl methyl cellulose, carboxymethylcellulose, and hydroxypropyl cellulose.

Hydrocolloids which are water soluble or swellable hydrocolloids can be selected e.g. from the group consisting of polyvinyl alcohols, powdered pectin, methyl cellulose, hydroxypropyl methyl cellulose, carboxymethylcellulose, hydroxypropyl cellulose and mixtures thereof.

Further examples of suitable hydrocolloids include synthetic polymers that may be either linear or crosslinked. Non-limiting examples of synthetic hydrocolloids include e.g. polymers prepared from N-vinyl lactams, e.g. N-vinyl-2-pyrrolidone, 5-methyl-N-vinyl-2-pyrrolidone, 5-ethyl-N-vinyl-2-pyrrolidone, 3,3-dimethyl-N-vinyl-2-pyrrolidone, 3-methyl-N-vinyl-2-pyrrolidone, 3-ethyl-N-vinyl-2-pyrrolidone, 4-methyl-N-vinyl-2-pyrrolidone, 4-ethyl-N-vinyl-2-pyrrolidone, N-vinyl-2-valerolactam, and N-vinyl-2-caprolactam.

Other monomers useful to prepare a synthetic hydrocolloid include hydroxyalkyl acrylates and methacrylates, (such as 2-hydroxyethyl acrylate, 2-hydroxyethyl methacrylate, 2-hydroxypropyl acrylate, 2-hydroxypropyl methacrylate, 2,3-dihydroxypropyl methacrylate), acrylic acid, methacrylic acid and a tertiary amino-methacrylimide, (e.g. trimethylamino-methacrylimide), crotonic acid, and pyridine. Additional monomers useful to prepare a synthetic hydrocolloid include water soluble amides, (such as N-(hydroxymethyl)acrylamide and -methacrylamide, N-(3-hydroxpropyl)acrylamide, N-(2-hydroxyethyl) methacrylamide, N-(1,1-dimethyl-3-oxabutyl)acrylamide N-[2-(dimethylamine)ethyl]acrylamide and -methacrylamide, N-[3-(dimethylamino)-2-hydroxylpropyl]methacrylamide, and N-[1,1-dimethyl-2-(hydroxymethyl)-3-oxabutyl]acrylamide); water-soluble hydrazine derivatives, (such as trialkylamine methacrylimide, and dimethyl-(2-hydroxypropyl)amine methacrylimide); mono-olefinic sulfonic acids and their salts, (such as sodium ethylene sulfonate, sodium styrene sulfonate and 2-acrylamideo-2-methylpropanesulfonic acid); and the following monomers containing nitrogen in the non-cyclic or cyclic backbone of the monomer: 1-vinyl-imidazole, 1-vinyl-indole, 2-vinyl imidazole, 4(5)-vinyl-imidazole, 2-vinyl-1-methyl-imidazole, 5-vinyl-pyrazoline, 3-methyl-5-isopropenyl-pyrazole, 5-methylene-hydantoin, 3-vinyl-2-oxazolidone, 3-methacrylyl-2-oxazolidone, 3-methacrylyl-5-methyl-2-oxazolidone, 3-vinyl-5-methyl-2-oxazolidone, 2- and 4-vinyl-pyridine, 5-vinyl-2-methyl-pyridine, 2-vinyl-pyridine-1-oxide, 3-isopropenyl-pyridine, 2- and 4-vinyl-piperidine, 2- and 4-vinyl-quinoline, 2,4-dimethyl-6-vinyl-s-triazine, and 4-acrylyl-morpholine.

### Hydrogels

Cross-linking of the linear polymer chains of the hydrocolloid may be desired to improve cohesive properties of the gel dispersed in the pressure sensitive adhesive matrix. When such crosslinking is desired for polymers made from vinyl monomers discussed above, a multi-ethylenically unsaturated compound with the ethylenic groups being vinyl, allyl, or methallyl groups bonded to nitrogen, oxygen or carbon atoms can be used.

Non-limiting examples of cross-linking agents for vinyl containing polymers include divinyl, diallyl, or dimethallyl esters (e.g. ethylene glycol dimethacrylate, divinyl succinate, divinyl adipate, divinyl maleate, divinyl oxalate, divinyl malonate, divinyl glutarate, diallyl itaconate, diallyl maleate, diallyl fumarate, diallyl diglycolate, diallyl oxalate, diallyl adipate, diallyl succinate, diallyl azelate, diallyl malonate, diallyl glutarate, dimethallyl maleate, dimethallyl oxalate, dimethallyl malonate, dimethallyl succinate, dimethallyl glutarate, and dimethallyl adipate); divinyl, diallyl or dimethallyl ethers (e.g. diethyleneglycol divinyl ether, butane diol divinyl ether, ethylene glycol divinyl ether, ethylene glycol diallyl ether, diethylene glycol diallyl ether, butane diol diallyl ether, ethylene glycol dimethallyl ether, diethylene glycol dimethallyl ether, and butane diol dimethallyl ether); divinyl, diallyl or dimethallyl amides including bis(N-vinyl lactams), (e.g., 3,3′-ethylene bis(N-vinyl-2-pyrrolidone) and methylene-bis-acrylamide); and divinyl, diallyl and dimethallyl ureas.

Preferred cross-linking agents include ethylene glycol dimethacrylate, methylene-bis-acrylamide, diallyl maleate, and 3,3′-ethylidene bis(N-vinyl-2-pyrrolidone). For n-vinyl lactams, the preferred crosslinking agents are diallyl maleate and 3,3′-ethylidene bis (N-vinyl-2-pyrrolidone). For acrylates and methacrylates, the preferred crosslinking agents are ethylene glycol dimethacrylate and methylene-bis-acrylamide.

### Wound or Tissue Dressings Comprising Humectants

The dressing can also contain a humectant to reduce the partial vapor pressure of the water in the wound or tissue dressing or to reduce the rate at which the wound or tissue dressing dries out. Suitable humectants are miscible with water to a large extent and are generally suitable for application to the skin.

The humectant can be e.g. glycerol and propylene glycol and the absorbent compound typically contains from about 10% to about 90% by weight of the humectant.

Polyols are especially suitable for the purpose and suitable polyols may include monopropylene glycol or glycerin (glycerol). The polyol may be present in proportions of 20 to 50% (by weight) of the total formulation; alternatively the range is 30 to 40%. This relatively high proportion of polyol also ensures that if the paste should dry out to any degree, the resulting paste remains soft and flexible because the glycerin may act as a plasticiser for the polymer. When the paste is applied on a bandage, for example, it may therefore still be removed easily from the skin when the paste has lost water without the need to cut the bandage off. The polyol also has the advantage of functioning to prevent the proliferation of bacteria in the paste when it is in contact with the skin or wound, particularly infected wounds.

### Method for Manufacturing Wound or Tissue Dressings According to the Invention

The present method is also directed to a method for manufacturing the wound or tissue dressing according to the invention, said method comprising the steps of providing one or more pharmaceutical compositions, and applying by ultrasonic spray technology said one or more pharmaceutical compositions onto the wound or tissue dressing and/or with the absorbent compound of the wound or tissue dressing, thereby obtaining the wound or tissue dressing according to the invention.

The method can comprise the further step of providing the absorbent compound with at least one adhesive surface suitable for contacting a wound, or the further step of attaching at least one adhesive surface suitable for contacting a wound to the absorbent compound.

In another further step there is provided a permeable or semi-permeable barrier for separating the at least one adhesive surface from the absorbent compound by introducing said permeable or semi-permeable barrier between the absorbent compound and the at least one adhesive surface, wherein said permeable or semi-permeable barrier allows wound extrudate to be diverted from the wound to the absorbent compound.

In a yet further step the method comprises providing a permeable or semi-permeable barrier capable of partly separating—during use—the at least one adhesive surface from the wound by introducing said permeable or semi-permeable barrier on the surface of the adhesive surface, wherein said permeable or semi-permeable barrier—during use—allows wound extrudate to be diverted from the wound to the absorbent compound through the adhesive surface.

In yet further step a topfilm can be provided and attached to the absorbent compound, wherein said topfilm seals at least partly the absorbent compound from the external environment. The absorbent compound can also comprise a topfilm as an integrated part, wherein said topfilm at least partly seals the absorbent compound from the external environment. The topfilm can be porous or non-porous. In one embodiment, the topfilm comprises an oxygen- and vapor-permeable layer permitting transpiration of liquid from the absorbent compound.

### Wound Treatment Methods

Various uses of the wound or tissue dressings according to the present invention are envisaged. In one embodiment there is provided a method for treating a wound in an individual, said method comprising the steps of contacting said wound with the wound or tissue dressing according to the present invention, and treating the wound.

The treatment can in principle result in healing of the wound or in accelerated healing of the wound. The accelerated healing can be a result of e.g. administration of a wound-healing promoting substance. Alternatively, the wound healing can be promoted by preventing bacterial or viral infection, or by reducing the risk of such an infection which would otherwise have prolonged the wound treatment process.

In one embodiment there is provided a method for treating damaged tissue in an individual, said method comprising the steps of contacting said damaged tissue with the wound or tissue dressing according to the invention, and treating the damaged tissue.

Likewise, the treatment can in principle result in healing of the damaged tissue or in accelerated healing of the damaged tissue. The accelerated healing can be a result a e.g. administration of a tissue-healing promoting substance. Alternatively, the healing of damaged tissue can be promoted by preventing bacterial or viral infection, or by reducing the risk of such an infection which would otherwise have prolonged the treatment of the damaged tissue.

The tissue damage can e.g. be caused by bone protrudence, by diabetes, by circulatory insufficiencies or by undesirable inflammatory processes in an individual.

There is also provided a method for preventing or reducing the risk of wound or tissue infection in an individual having suffered a wound or damaged tissue, said method comprising the steps of contacting said wound or tissue with the wound or tissue dressing according to the invention, and treating the wound or tissue at risk of being infected. The infectious agent at risk of infecting the wound or tissue can be a bacteria or a virus.

As e.g. gelatin and hyaluronic acid independently and in combination have a haemostatic effect, there is also provided a method for promoting haemostasis in a wound in an individual, said method comprising the steps of contacting said wound with the wound dressing coated by ultrasonic spray technology with one or more pharmaceutical compositions according to the invention, and promoting haemostasis in the wound.

In addition to contacting a wound or damaged tissue with the wound or tissue dressing according to the invention, there is also provided combination methods wherein one or more wound or tissue healing-promoting substance(s) are administered simultaneously or sequentially in any order one or more at the same time as the wound or tissue to be treated is contacted with the wound or tissue dressing according to the invention. This may be of particular importance when treating slow-healing wounds, partial thickness wound, deep wounds and chronic wounds.

Method for Manufacturing of Wound and/or Tissue Dressings

In a further aspect there is provided a method for manufacturing a wound or tissue dressing coated by ultrasonic spray technology with one or more pharmaceutical compositions according to the present invention, said method comprising the steps of providing one or more pharmaceutical compositions, applying by ultrasonic spray technology said one or more pharmaceutical compositions onto the wound or tissue dressing and/or onto the absorbent compound of the wound or tissue dressing, thereby obtaining a wound or tissue dressing according to the present invention.

There is also provided the use of applying by ultrasonic spray technology one or more pharmaceutical compositions for the manufacture of a wound or tissue dressing for treating or accelerating the healing of a wound in an individual.

In yet another aspect there is provided the use of applying by ultrasonic spray technology one or more pharmaceutical compositions for the manufacture of an absorbent compound for use in a wound or tissue dressing for treating or accelerating the healing of a wound in an individual.

The present invention also relates to the use of application by ultrasonic spray technology of one or more pharmaceutical compositions for the manufacture of an absorbent compound for use in a wound or tissue dressing for treating a wound or tissue or accelerating the healing of a wound or tissue in an individual.

In a further embodiment the present invention relates to the use of application by ultrasonic spray technology of one or more pharmaceutical compositions in the manufacture of a wound or tissue dressing for preventing or reducing the risk of wound or tissue infection in an individual having suffered a wound.

The present invention also relates to the use of application by ultrasonic spray technology of one or more pharmaceutical compositions in the manufacture of a wound or tissue dressing for promoting haemostasis in a wound in an individual.

A Container for Storage and/or Preparation of a Matrix Material

The present invention also relates to a container, box or packaging means e.g. for storage and/or preparation of a matrix material. In one embodiment this container, box or packaging provides a sterile environment for storage and/or preparation of the matrix material.

The container comprises an (one) inner cavity (hollow space) for storage of a (one) matrix material. In one embodiment the container comprises more than one inner cavity for storage of more than one matrix material such as 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 41, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100 inner cavities, for storage of more than one matrix material such as 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 41, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100 matrix materials.

In one embodiment, the container comprises one inner cavity for storage of more than one matrix material such as 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 41, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100 matrix materials.

The inner cavity is made of a bottom with defined dimensions, and one or more sidewall(s) with a defined height. The one or more sidewalls of the cavity comprise in one embodiment a mark for the maximum volume that should be added to the cavity containing the matrix material. This mark can be any type of mark such as a line, dot or the one or more sides can comprise a bend e.g. the angle between the bottom and the side differ between the sidewall below and above the mark—i.e. one or more bevelled edges as a guiding tool for maximum amount of liquid/moisture to be added to the inner cavity containing the one or more matrix material(s). One advantage of the container is that the one or more mark(s) on the one or more sidewall(s) decreases the risk of addition of excess liquid to the container comprising one or more matrix materials.

The cavity should generally circumvent the matrix material. Accordingly, the shape of the cavity should be adjusted to fit or surround the shape of the matrix material.

The cavity defined by the size of the bottom of the inner cavity and the height of one or more sidewalls measured from the bottom of the inner cavity to the mark for maximum filling is reffered to as the maximum volume of liquid to be added to the container comprising the matrix material.

In one embodiment the maximum volume of liquid to be added to the container comprising the matrix material is in the range of from 1 mL to 60 mL, such as from 1 mL to 2 mL, for example from 2 to 3 mL, such as from 3 mL to 4 mL, for example from 4 to 5 mL, such as from 5 mL to 6 mL, for example from 6 to 7 mL, such as from 7 mL to 8 mL, for example from 8 to 9 mL, such as from 9 mL to 10 mL, for example from 10 to 11 mL, such as from 11 mL to 12 mL, for example from 12 to 13 mL, such as from 13 mL to 14 mL, for example from 14 to 15 mL, such as from 15 mL to 16 mL, for example from 16 to 17 mL, such as from 17 mL to 18 mL, for example from 18 to 19 mL, such as from 19 mL to 20 mL, for example from 20 to 21 mL, such as from 21 mL to 22 mL, for example from 22 to 23 mL, such as from 23 mL to 24 mL, for example from 24 to 25 mL, such as from 25 mL to 26 mL, for example from 26 to 27 mL, such as from 27 mL to 28 mL, for example from 28 to 29 mL, such as from 29 mL to 30 mL, for example from 30 to 31 mL, such as from 31 mL to 32 mL, for example from 32 to 33 mL, such as from 33 mL to 34 mL, for example from 34 to 35 mL, such as from 35 mL to 36 mL, for example from 36 to 37 mL, such as from 37 mL to 38 mL, for example from 38 to 39 mL, such as from 39 mL to 40 mL, for example from 40 to 41 mL, such as from 41 mL to 42 mL, for example from 42 to 43 mL, such as from 43 mL to 44 mL, for example from 44 to 45 mL, such as from 45 mL to 46 mL, for example from 46 to 47 mL, such as from 47 mL to 48 mL, for example from 48 to 49 mL, such as from 49 mL to 50 mL, for example from 50 to 51 mL, such as from 51 mL to 52 mL, for example from 52 to 53 mL, such as from 53 mL to 54 mL, for example from 54 to 55 mL, such as from 55 mL to 56 mL, for example from 56 to 57 mL, such as from 57 mL to 58 mL, for example from 58 to 59 mL, such as from 59 mL to 60 mL. The maximum volume of liquid to be added to the container comprising the matrix material will depend on factors such as size of the cavity of the container and the liquid absorbability of the matrix material used.

In one embodiment the maximum volume of liquid to be added to the container should be in range of from 5% to 50% of the volume of the matrix material such as from 5% to 6%, for example from 6% to 7%, such as from 7% to 8%, for example from 8% to 9%, such as from 9% to 10%, for example from 10% to 11%, such as from 11% to 12%, for example from 12% to 13%, such as from 13% to 14%, for example from 14% to 15%, such as from 15% to 16%, for example from 16% to 17%, such as from 17% to 18%, for example from 18% to 19%, such as from 19% to 20%, for example from 20% to 21%, such as from 21% to 22%, for example from 22% to 23%, such as from 23% to 24%, for example from 24% to 25%, such as from 25% to 26%, for example from 26% to 27%, such as from 27% to 28%, for example from 28% to 29%, such as from 29% to 30%, for example from 30% to 31%, such as from 31% to 32%, for example from 32% to 33%, such as from 33% to 34%, for example from 34% to 35%, such as from 35% to 36%, for example from 36% to 37%, such as from 37% to 38%, for example from 38% to 39%, such as from 39% to 40%, for example from 40% to 41%, such as from 41% to 42%, for example from 42% to 43%, such as from 43% to 44%, for example from 44% to 45%, such as from 45% to 46%, for example from 46% to 47%, such as from 47% to 48%, for example from 48% to 49%, or such as from 49% to 50%.

In one embodiment the preferred volume of liquid to be added to the container should be in range of from 5% to 50% of the volume of the inner cavity such as from 5% to 6%, for example from 6% to 7%, such as from 7% to 8%, for example from 8% to 9%, such as from 9% to 10%, for example from 10% to 11%, such as from 11% to 12%, for example from 12% to 13%, such as from 13% to 14%, for example from 14% to 15%, such as from 15% to 16%, for example from 16% to 17%, such as from 17% to 18%, for example from 18% to 19%, such as from 19% to 20%, for example from 20% to 21%, such as from 21% to 22%, for example from 22% to 23%, such as from 23% to 24%, for example from 24% to 25%, such as from 25% to 26%, for example from 26% to 27%, such as from 27% to 28%, for example from 28% to 29%, such as from 29% to 30%, for example from 30% to 31%, such as from 31% to 32%, for example from 32% to 33%, such as from 33% to 34%, for example from 34% to 35%, such as from 35% to 36%, for example from 36% to 37%, such as from 37% to 38%, for example from 38% to 39%, such as from 39% to 40%, for example from 40% to 41%, such as from 41% to 42%, for example from 42% to 43%, such as from 43% to 44%, for example from 44% to 45%, such as from 45% to 46%, for example from 46% to 47%, such as from 47% to 48%, for example from 48% to 49%, or such as from 49% to 50%.

In one embodiment the preferred volume of liquid to be added to the container should be in range of from 1 mL to 60 mL, such as from 1 mL to 2 mL, for example from 2 to 3 mL, such as from 3 mL to 4 mL, for example from 4 to 5 mL, such as from 5 mL to 6 mL, for example from 6 to 7 mL, such as from 7 mL to 8 mL, for example from 8 to 9 mL, such as from 9 mL to 10 mL, for example from 10 to 11 mL, such as from 11 mL to 12 mL, for example from 12 to 13 mL, such as from 13 mL to 14 mL, for example from 14 to 15 mL, such as from 15 mL to 16 mL, for example from 16 to 17 mL, such as from 17 mL to 18 mL, for example from 18 to 19 mL, such as from 19 mL to 20 mL, for example from 20 to 21 mL, such as from 21 mL to 22 mL, for example from 22 to 23 mL, such as from 23 mL to 24 mL, for example from 24 to 25 mL, such as from 25 mL to 26 mL, for example from 26 to 27 mL, such as from 27 mL to 28 mL, for example from 28 to 29 mL, such as from 29 mL to 30 mL, for example from 30 to 31 mL, such as from 31 mL to 32 mL, for example from 32 to 33 mL, such as from 33 mL to 34 mL, for example from 34 to 35 mL, such as from 35 mL to 36 mL, for example from 36 to 37 mL, such as from 37 mL to 38 mL, for example from 38 to 39 mL, such as from 39 mL to 40 mL, for example from 40 to 41 mL, such as from 41 mL to 42 mL, for example from 42 to 43 mL, such as from 43 mL to 44 mL, for example from 44 to 45 mL, such as from 45 mL to 46 mL, for example from 46 to 47 mL, such as from 47 mL to 48 mL, for example from 48 to 49 mL, such as from 49 mL to 50 mL, for example from 50 to 51 mL, such as from 51 mL to 52 mL, for example from 52 to 53 mL, such as from 53 mL to 54 mL, for example from 54 to 55 mL, such as from 55 mL to 56 mL, for example from 56 to 57 mL, such as from 57 mL to 58 mL, for example from 58 to 59 mL, such as from 59 mL to 60 mL.

In one embodiment the container is made of plastic and has an exterior, an interior and a sealed outer periphery, the sealed outer periphery forming a sterile interior region which isolates the interior from a surrounding environment. A matrix material is located within the interior and is initially isolated from the surrounding environment by the sealed periphery.

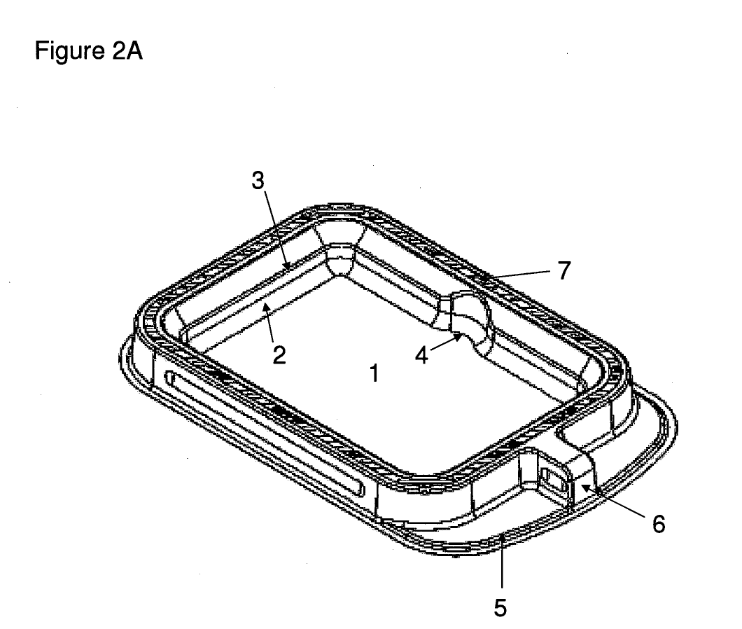

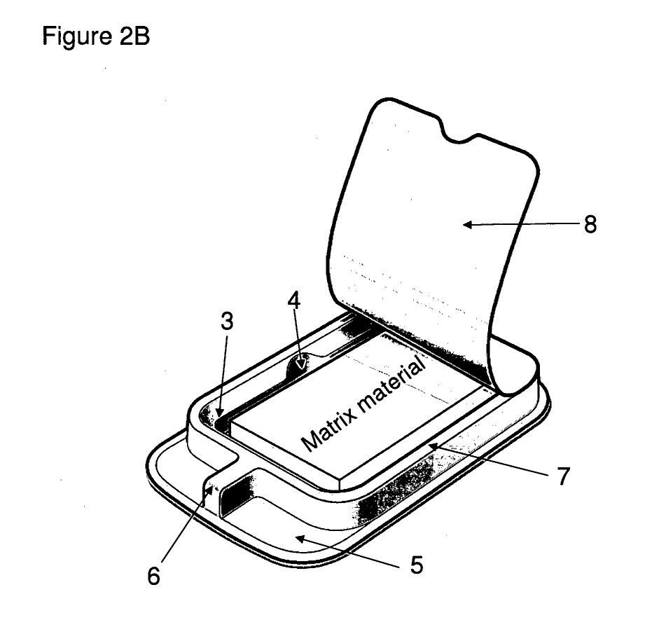

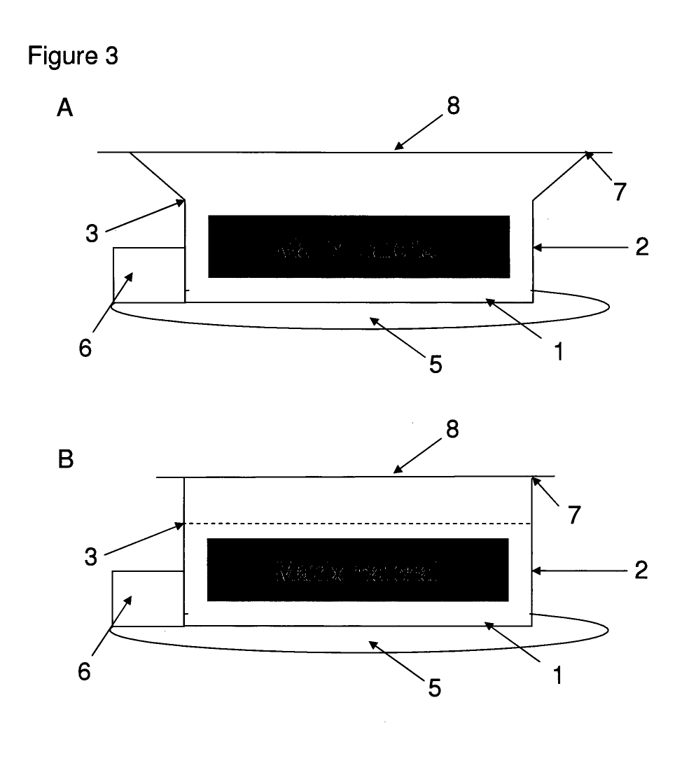

In one embodiment the container comprises a bottom, one or more sidewalls, a mark for maximum filling of the container on one or more of the sidewalls, a sealing surface for a lid and a lid (e.g. as shown in FIGS. 2A and 2B, FIGS. 3A and 3B, FIG. 4, FIG. 5 and FIG. 6). The container can comprise one or more inner tray notches that make it easy to handle the matrix material without destroying the structure of the matrix material (e.g. as shown in FIGS. 2A and 2B, FIG. 4, and FIG. 5). In one embodiment the container has a base to provide stabile placement on all possible surfaces such as even or uneven surfaces including a sterile field, a mayo stand, a tray of instruments or on the chest of the patient (e.g. as shown in FIGS. 2A and 2B, FIGS. 3A and 3B, FIG. 4, FIG. 5 and FIG. 6). The base can provide stability during handling to minimize the risk of spilling. The container optionally also has a handle (e.g. as shown in FIGS. 2A and 2B, FIGS. 3A and 3B, FIG. 4, FIG. 5 and FIG. 6).

In one embodiment the bottom, base, sidewalls and optionally handle of the container is cast or moulded in one piece of e.g. plastic. The bottom, base, sidewalls and optionally handle of the container can also be cast or moulded in more than one piece of e.g. plastic such as 2, 3, 4, 5, 6, 7, 8, 9, 10, 11, 12 or more than 12 pieces of e.g. plastic. In one preferred embodiment, the container contains a handle and the bottom, base, sidewalls and handle are cast or moulded in one piece.

In one embodiment the bottom and lid and/or the bottom and the base and/or the base and the lid are parallel. In one embodiment the bottom and lid and/or the bottom and the base and/or the base and the lid are not parallel. In one embodiment the lid and/or the base and/or the bottom of the container is perpendicular to the one or more sidewalls of the container. In one embodiment the lid and/or the base and/or the bottom of the container is not perpendicular to the one or more sidewalls of the container. The angle between the lid and/or the base and/or the bottom of the container and the one or more sidewalls can be in the range of from 20 degrees to 160 degrees, such as from 20 degrees to 25 degrees, for example from 25 degrees to 30 degrees, such as from 30 degrees to 35 degrees, for example from 35 degrees to 40 degrees, such as from 40 degrees to 45 degrees, for example from 45 degrees to 50 degrees, such as from 50 degrees to 55 degrees, for example from 55 degrees to 60 degrees, such as from 60 degrees to 65 degrees, for example from 65 degrees to 70 degrees, such as from 70 degrees to 75 degrees, for example from 75 degrees to 80 degrees, such as from 80 degrees to 85 degrees, for example from 85 degrees to 90 degrees, such as from 90 degrees to 95 degrees, for example from 95 degrees to 100 degrees, such as from 100 degrees to 105 degrees, for example from 105 degrees to 110 degrees, such as from 110 degrees to 115 degrees, for example from 115 degrees to 120 degrees, such as from 120 degrees to 125 degrees, for example from 125 degrees to 130 degrees, such as from 130 degrees to 135 degrees, for example from 135 degrees to 140 degrees, such as from 140 degrees to 145 degrees, for example from 145 degrees to 150 degrees, such as from 150 degrees to 155 degrees, for example from 155 degrees to 160 degrees.

The bottom of the cavity of the container can be any shape such as a square, rectangle, triangle, circle, or oval:

In one embodiment the bottom is formed as a square e.g. with the dimensions of 1 cm×1 cm, 1 cm×2 cm, 1 cm×3 cm, 1 cm×4 cm, 1 cm×5 cm, 1 cm×6 cm, 1 cm×7 cm, 1 cm×8 cm, 1 cm×9 cm, 1 cm×10 cm, 1 cm×15 cm, 1 cm×20 cm, 2 cm×1 cm, 2 cm×2 cm, 2 cm×3 cm, 2 cm×4 cm, 2 cm×5 cm, 2 cm×6 cm, 2 cm×7 cm, 2 cm×8 cm, 2 cm×9 cm, 2 cm×10 cm, 2 cm×15 cm, 2 cm×20 cm, 3 cm×1 cm, 3 cm×2 cm, 3 cm×3 cm, 3 cm×4 cm, 3 cm×5 cm, 3 cm×6 cm, 3 cm×7 cm, 3 cm×8 cm, 3 cm×9 cm, 3 cm×10 cm, 3 cm×15 cm, 3 cm×20 cm, 4 cm×1 cm, 4 cm×2 cm, 4 cm×3 cm, 4 cm×4 cm, 4 cm×5 cm, 4 cm×6 cm, 4 cm×7 cm, 4 cm×8 cm, 4 cm×9 cm, 4 cm×10 cm, 4 cm×15 cm, 4 cm×20 cm, 5 cm×1 cm, 5 cm×2 cm, 5 cm×3 cm, 5 cm×4 cm, 5 cm×5 cm, 5 cm×6 cm, 5 cm×7 cm, 5 cm×8 cm, 5 cm×9 cm, 5 cm×10 cm, 5 cm×15 cm, 5 cm×20 cm, 6 cm×1 cm, 6 cm×2 cm, 6 cm×3 cm, 6 cm×4 cm, 6 cm×5 cm, 6 cm×6 cm, 6 cm×7 cm, 6 cm×8 cm, 6 cm×9 cm, 6 cm×10 cm, 6 cm×15 cm, 6 cm×20 cm, 7 cm×1 cm, 7 cm×2 cm, 7 cm×3 cm, 7 cm×4 cm, 7 cm×5 cm, 7 cm×6 cm, 7 cm×7 cm, 7 cm×8 cm, 7 cm×9 cm, 7 cm×10 cm, 7 cm×15 cm, 7 cm×20 cm, 8 cm×1 cm, 8 cm×2 cm, 8 cm×3 cm, 8 cm×4 cm, 8 cm×5 cm, 8 cm×6 cm, 8 cm×7 cm, 8 cm×8 cm, 8 cm×9 cm, 8 cm×10 cm, 8 cm×15 cm, 8 cm×20 cm, 9 cm×1 cm, 9 cm×2 cm, 9 cm×3 cm, 9 cm×4 cm, 9 cm×5 cm, 9 cm×6 cm, 9 cm×7 cm, 9 cm×8 cm, 9 cm×9 cm, 9 cm×10 cm, 9 cm×15 cm, 9 cm×20 cm, 10 cm×1 cm, 10 cm×2 cm, 10 cm×3 cm, 10 cm×4 cm, 10 cm×5 cm, 10 cm×6 cm, 10 cm×7 cm, 10 cm×8 cm, 10 cm×9 cm, 10 cm×10 cm, 10 cm×15 cm, 10 cm×20 cm, 11 cm×1 cm, 11 cm×2 cm, 11 cm×3 cm, 11 cm×4 cm, 11 cm×5 cm, 11 cm×6 cm, 11 cm×7 cm, 11 cm×8 cm, 11 cm×9 cm, 11 cm×10 cm, 11 cm×15 cm, 11 cm×20 cm, 12 cm×1 cm, 12 cm×2 cm, 12 cm×3 cm, 12 cm×4 cm, 12 cm×5 cm, 12 cm×6 cm, 12 cm×7 cm, 12 cm×8 cm, 12 cm×9 cm, 12 cm×10 cm, 12 cm×15 cm, 12 cm×20 cm, 13 cm×1 cm, 13 cm×2 cm, 13 cm×3 cm, 13 cm×4 cm, 13 cm×5 cm, 13 cm×6 cm, 13 cm×7 cm, 13 cm×8 cm, 13 cm×9 cm, 13 cm×10 cm, 13 cm×15 cm, 13 cm×20 cm, 14 cm×1 cm, 14 cm×2 cm, 14 cm×3 cm, 14 cm×4 cm, 14 cm×5 cm, 14 cm×6 cm, 14 cm×7 cm, 14 cm×8 cm, 14 cm×9 cm, 14 cm×10 cm, 14 cm×15 cm, 14 cm×20 cm, 15 cm×1 cm, 15 cm×2 cm, 15 cm×3 cm, 15 cm×4 cm, 15 cm×5 cm, 15 cm×6 cm, 15 cm×7 cm, 15 cm×8 cm, 15 cm×9 cm, 15 cm×10 cm, 15 cm×15 cm, 15 cm×20 cm, 16 cm×1 cm, 16 cm×2 cm, 16 cm×3 cm, 16 cm×4 cm, 16 cm×5 cm, 16 cm×6 cm, 16 cm×7 cm, 16 cm×8 cm, 16 cm×9 cm, 16 cm×10 cm, 16 cm×15 cm, 16 cm×20 cm, 17 cm×1 cm, 17 cm×2 cm, 17 cm×3 cm, 17 cm×4 cm, 17 cm×5 cm, 17 cm×6 cm, 17 cm×7 cm, 17 cm×8 cm, 17 cm×9 cm, 17 cm×10 cm, 17 cm×15 cm, 17 cm×20 cm, 18 cm×1 cm, 18 cm×2 cm, 18 cm×3 cm, 18 cm×4 cm, 18 cm×5 cm, 18 cm×6 cm, 18 cm×7 cm, 18 cm×8 cm, 18 cm×9 cm, 18 cm×10 cm, 18 cm×15 cm, 18 cm×20 cm, 19 cm×1 cm, 19 cm×2 cm, 19 cm×3 cm, 19 cm×4 cm, 19 cm×5 cm, 19 cm×6 cm, 19 cm×7 cm, 19 cm×8 cm, 19 cm×9 cm, 19 cm×10 cm, 19 cm×15 cm, 19 cm×20 cm, 20 cm×1 cm, 20 cm×2 cm, 20 cm×3 cm, 20 cm×4 cm, 20 cm×5 cm, 20 cm×6 cm, 20 cm×7 cm, 20 cm×8 cm, 20 cm×9 cm, 20 cm×10 cm, 20 cm×15 cm, 20 cm×20 cm, 25 cm×1 cm, 25 cm×2 cm, 25 cm×3 cm, 25 cm×4 cm, 25 cm×cm, 25 cm×6 cm, 25 cm×7 cm, 25 cm×8 cm, 25 cm×9 cm, 25 cm×10 cm, 25 cm×15 cm, 25 cm×20 cm, 30 cm×1 cm, 30 cm×2 cm, 30 cm×3 cm, 30 cm×4 cm, 30 cm×5 cm, 30 cm×6 cm, 30 cm×7 cm, 30 cm×8 cm, 30 cm×9 cm, 30 cm×10 cm, 30 cm×15 cm, 30 cm×20 cm, 40 cm×1 cm, 40 cm×2 cm, 40 cm×3 cm, 40 cm×4 cm, 40 cm×5 cm, 40 cm×6 cm, 40 cm×7 cm, 40 cm×8 cm, 40 cm×9 cm, 40 cm×cm, 40 cm×15 cm, 40 cm×20 cm, 50 cm×1 cm, 50 cm×2 cm, 50 cm×3 cm, 50 cm×4 cm, 50 cm×5 cm, 50 cm×6 cm, 50 cm×7 cm, 50 cm×8 cm, 50 cm×9 cm, 50 cm×10 cm, 50 cm×15 cm, or 50 cm×20 cm.

The dimensions of the bottom of the container may also be any decimal number, for example 13.035 cm×9.74 cm (small), such as 13.035 cm×13.73 cm (medium) or for example 13.035 cm×20.04 cm (large).

In one embodiment the bottom is formed as a square e.g. with the dimensions of between 1 cm² to 500 cm², such as 1 cm² to 5 cm², for example 5 cm² to 10 cm², such as 10 cm² to 20 cm², for example 20 cm² to 30 cm², such as 30 cm² to 40 cm², for example 40 cm² to 50 cm², such as 50 cm² to 60 cm², for example 60 cm² to 70 cm², such as 70 cm² to 80 cm², for example 80 cm² to 90 cm², such as 90 cm² to 100 cm², for example 100 cm² to 110 cm², such as 110 cm² to 120 cm², for example 120 cm² to 130 cm², such as 130 cm² to 140 cm², for example 140 cm² to 150 cm², such as 150 cm² to 160 cm², for example 160 cm² to 170 cm², such as 170 cm² to 180 cm², for example 180 cm² to 190 cm², such as 190 cm² to 200 cm², for example 200 cm² to 210 cm², such as 210 cm² to 220 cm², for example 220 cm² to 230 cm², such as 230 cm² to 240 cm², for example 240 cm² to 250 cm², such as 250 cm² to 260 cm², for example 260 cm² to 270 cm², such as 270 cm² to 280 cm², for example 280 cm² to 290 cm², such as 290 cm² to 300 cm², for example 300 cm² to 320 cm², such as 320 cm² to 340 cm², for example 340 cm² to 360 cm², such as 360 cm² to 380 cm², for example 380 cm² to 400 cm², such as 400 cm² to 420 cm², for example 420 cm² to 440 cm², such as 440 cm² to 460 cm², for example 460 cm² to 480 cm², such as 480 cm² to 500 cm².

It follows that the dimension of the square bottom need not be a whole or counting number, but may also be any decimal number.

In one embodiment the bottom is formed to circumvent a matrix material shaped as a square with one of the dimensions selected grom the group consisting of 1 cm×1 cm, 1 cm×2 cm, 1 cm×3 cm, 1 cm×4 cm, 1 cm×5 cm, 1 cm×6 cm, 1 cm×7 cm, 1 cm×8 cm, 1 cm×9 cm, 1 cm×10 cm, 1 cm×15 cm, 1 cm×20 cm, 2 cm×1 cm, 2 cm×2 cm, 2 cm×3 cm, 2 cm×4 cm, 2 cm×5 cm, 2 cm×6 cm, 2 cm×7 cm, 2 cm×8 cm, 2 cm×9 cm, 2 cm×10 cm, 2 cm×15 cm, 2 cm×20 cm, 3 cm×1 cm, 3 cm×2 cm, 3 cm×3 cm, 3 cm×4 cm, 3 cm×5 cm, 3 cm×6 cm, 3 cm×7 cm, 3 cm×8 cm, 3 cm×9 cm, 3 cm×10 cm, 3 cm×15 cm, 3 cm×20 cm, 4 cm×1 cm, 4 cm×2 cm, 4 cm×3 cm, 4 cm×4 cm, 4 cm×5 cm, 4 cm×6 cm, 4 cm×7 cm, 4 cm×8 cm, 4 cm×9 cm, 4 cm×10 cm, 4 cm×15 cm, 4 cm×20 cm, 5 cm×1 cm, 5 cm×2 cm, 5 cm×3 cm, 5 cm×4 cm, 5 cm×5 cm, 5 cm×6 cm, 5 cm×7 cm, 5 cm×8 cm, 5 cm×9 cm, 5 cm×10 cm, 5 cm×15 cm, 5 cm×20 cm, 6 cm×1 cm, 6 cm×2 cm, 6 cm×3 cm, 6 cm×4 cm, 6 cm×5 cm, 6 cm×6 cm, 6 cm×7 cm, 6 cm×8 cm, 6 cm×9 cm, 6 cm×10 cm, 6 cm×15 cm, 6 cm×20 cm, 7 cm×1 cm, 7 cm×2 cm, 7 cm×3 cm, 7 cm×4 cm, 7 cm×5 cm, 7 cm×6 cm, 7 cm×7 cm, 7 cm×8 cm, 7 cm×9 cm, 7 cm×10 cm, 7 cm×15 cm, 7 cm×20 cm, 8 cm×1 cm, 8 cm×2 cm, 8 cm×3 cm, 8 cm×4 cm, 8 cm×5 cm, 8 cm×6 cm, 8 cm×7 cm, 8 cm×8 cm, 8 cm×9 cm, 8 cm×10 cm, 8 cm×15 cm, 8 cm×20 cm, 9 cm×1 cm, 9 cm×2 cm, 9 cm×3 cm, 9 cm×4 cm, 9 cm×5 cm, 9 cm×6 cm, 9 cm×7 cm, 9 cm×8 cm, 9 cm×9 cm, 9 cm×10 cm, 9 cm×15 cm, 9 cm×20 cm, 10 cm×1 cm, 10 cm×2 cm, 10 cm×3 cm, 10 cm×4 cm, 10 cm×5 cm, 10 cm×6 cm, 10 cm×7 cm, 10 cm×8 cm, 10 cm×9 cm, 10 cm×10 cm, 10 cm×15 cm, 10 cm×20 cm, 11 cm×1 cm, 11 cm×2 cm, 11 cm×3 cm, 11 cm×4 cm, 11 cm×5 cm, 11 cm×6 cm, 11 cm×7 cm, 11 cm×8 cm, 11 cm×9 cm, 11 cm×10 cm, 11 cm×15 cm, 11 cm×20 cm, 12 cm×1 cm, 12 cm×2 cm, 12 cm×3 cm, 12 cm×4 cm, 12 cm×5 cm, 12 cm×6 cm, 12 cm×7 cm, 12 cm×8 cm, 12 cm×9 cm, 12 cm×10 cm, 12 cm×15 cm, 12 cm×20 cm, 13 cm×1 cm, 13 cm×2 cm, 13 cm×3 cm, 13 cm×4 cm, 13 cm×5 cm, 13 cm×6 cm, 13 cm×7 cm, 13 cm×8 cm, 13 cm×9 cm, 13 cm×10 cm, 13 cm×15 cm, 13 cm×20 cm, 14 cm×1 cm, 14 cm×2 cm, 14 cm×3 cm, 14 cm×4 cm, 14 cm×5 cm, 14 cm×6 cm, 14 cm×7 cm, 14 cm×8 cm, 14 cm×9 cm, 14 cm×10 cm, 14 cm×15 cm, 14 cm×20 cm, 15 cm×1 cm, 15 cm×2 cm, 15 cm×3 cm, 15 cm×4 cm, 15 cm×5 cm, 15 cm×6 cm, 15 cm×7 cm, 15 cm×8 cm, 15 cm×9 cm, 15 cm×10 cm, 15 cm×15 cm, 15 cm×20 cm, 16 cm×1 cm, 16 cm×2 cm, 16 cm×3 cm, 16 cm×4 cm, 16 cm×5 cm, 16 cm×6 cm, 16 cm×7 cm, 16 cm×8 cm, 16 cm×9 cm, 16 cm×10 cm, 16 cm×15 cm, 16 cm×20 cm, 17 cm×1 cm, 17 cm×2 cm, 17 cm×3 cm, 17 cm×4 cm, 17 cm×5 cm, 17 cm×6 cm, 17 cm×7 cm, 17 cm×8 cm, 17 cm×9 cm, 17 cm×10 cm, 17 cm×15 cm, 17 cm×20 cm, 18 cm×1 cm, 18 cm×2 cm, 18 cm×3 cm, 18 cm×4 cm, 18 cm×5 cm, 18 cm×6 cm, 18 cm×7 cm, 18 cm×8 cm, 18 cm×9 cm, 18 cm×10 cm, 18 cm×15 cm, 18 cm×20 cm, 19 cm×1 cm, 19 cm×2 cm, 19 cm×3 cm, 19 cm×4 cm, 19 cm×5 cm, 19 cm×6 cm, 19 cm×7 cm, 19 cm×8 cm, 19 cm×9 cm, 19 cm×10 cm, 19 cm×15 cm, 19 cm×20 cm, 20 cm×1 cm, 20 cm×2 cm, 20 cm×3 cm, 20 cm×4 cm, 20 cm×5 cm, 20 cm×6 cm, 20 cm×7 cm, 20 cm×8 cm, 20 cm×9 cm, 20 cm×10 cm, 20 cm×15 cm, 20 cm×20 cm, 25 cm×1 cm, 25 cm×2 cm, 25 cm×3 cm, 25 cm×4 cm, 25 cm×5 cm, 25 cm×6 cm, 25 cm×7 cm, 25 cm×8 cm, 25 cm×9 cm, 25 cm×10 cm, 25 cm×15 cm, 25 cm×20 cm, 30 cm×1 cm, 30 cm×2 cm, 30 cm×3 cm, 30 cm×4 cm, 30 cm×5 cm, 30 cm×6 cm, 30 cm×7 cm, 30 cm×8 cm, 30 cm×9 cm, 30 cm×10 cm, 30 cm×15 cm, 30 cm×20 cm, 40 cm×1 cm, 40 cm×2 cm, 40 cm×3 cm, 40 cm×4 cm, 40 cm×5 cm, 40 cm×6 cm, 40 cm×7 cm, 40 cm×8 cm, 40 cm×9 cm, 40 cm×10 cm, 40 cm×15 cm, 40 cm×20 cm, 50 cm×1 cm, 50 cm×2 cm, 50 cm×3 cm, 50 cm×4 cm, 50 cm×5 cm, 50 cm×6 cm, 50 cm×7 cm, 50 cm×8 cm, 50 cm×9 cm, 50 cm×10 cm, 50 cm×15 cm, or 50 cm×20 cm.

In one embodiment the bottom is formed to circumvent a matrix material shaped as a square with a dimension of between 1 cm² to 500 cm², such as 1 cm² to 5 cm², for example 5 cm² to 10 cm², such as 10 cm² to 20 cm², for example 20 cm² to 30 cm², such as 30 cm² to 40 cm², for example 40 cm² to 50 cm², such as 50 cm² to 60 cm², for example 60 cm² to 70 cm², such as 70 cm² to 80 cm², for example 80 cm² to 90 cm², such as 90 cm² to 100 cm², for example 100 cm² to 110 cm², such as 110 cm² to 120 cm², for example 120 cm² to 130 cm², such as 130 cm² to 140 cm², for example 140 cm² to 150 cm², such as 150 cm² to 160 cm², for example 160 cm² to 170 cm², such as 170 cm² to 180 cm², for example 180 cm² to 190 cm², such as 190 cm² to 200 cm², for example 200 cm² to 210 cm², such as 210 cm² to 220 cm², for example 220 cm² to 230 cm², such as 230 cm² to 240 cm², for example 240 cm² to 250 cm², such as 250 cm² to 260 cm², for example 260 cm² to 270 cm², such as 270 cm² to 280 cm², for example 280 cm² to 290 cm², such as 290 cm² to 300 cm², for example 300 cm² to 320 cm², such as 320 cm² to 340 cm², for example 340 cm² to 360 cm², such as 360 cm² to 380 cm², for example 380 cm² to 400 cm², such as 400 cm² to 420 cm², for example 420 cm² to 440 cm², such as 440 cm² to 460 cm², for example 460 cm² to 480 cm², such as 480 cm² to 500 cm².

It follows that the dimension of the square matrix material need not be a whole or counting number, but may also be any decimal number.

In one embodiment the bottom is formed as a circle e.g. with a diameter in the range of from 1 cm to 40 cm, such as from 1 cm to 2 cm, for example from 2 cm to 4 cm, such as from 4 cm to 6 cm, for example from 6 cm to 8 cm, such as from 8 cm to 10 cm, for example from 10 cm to 12 cm, such as from 12 cm to 14 cm, for example from 14 cm to 16 cm, such as from 16 cm to 18 cm, for example from 18 cm to 20 cm, such as from 20 cm to 22 cm, for example from 22 cm to 24 cm, such as from 24 cm to 26 cm, for example from 26 cm to 28 cm, such as from 28 cm to 30 cm, for example from 30 cm to 32 cm, such as from 32 cm to 34 cm, for example from 34 cm to 36 cm, such as from 36 cm to 38 cm, for example from 38 cm to 40 cm.

In one embodiment the bottom is formed as a circle e.g. with a diameter of 1 cm, 1.5 cm, 2 cm, 2.5 cm, 3 cm, 3.5 cm, 4 cm, 4.5 cm, 5 cm, 5.5 cm, 6 cm, 6.5 cm, 7 cm, 7.5 cm, 8 cm, 8.5 cm, 9 cm, 9.5 cm, 10 cm, 11 cm, 12 cm, 13 cm, 14 cm, 15 cm, 16 cm, 17 cm, 18 cm, 19 cm, 20 cm, 21 cm, 22 cm, 23 cm, 24 cm, 25 cm, 26 cm, 27 cm, 28 cm, 29 cm, 30 cm, 31 cm, 32 cm, 33 cm, 34 cm, 35 cm, 36 cm, 37 cm, 38 cm, 39 cm or 40 cm.

In one embodiment the bottom is formed as a circle e.g. with the dimensions of between 1 cm² to 500 cm², such as 1 cm² to 5 cm², for example 5 cm² to 10 cm², such as 10 cm² to 20 cm², for example 20 cm² to 30 cm², such as 30 cm² to 40 cm², for example 40 cm² to 50 cm², such as 50 cm² to 60 cm², for example 60 cm² to 70 cm², such as 70 cm² to 80 cm², for example 80 cm² to 90 cm², such as 90 cm² to 100 cm², for example 100 cm² to 110 cm², such as 110 cm² to 120 cm², for example 120 cm² to 130 cm², such as 130 cm² to 140 cm², for example 140 cm² to 150 cm², such as 150 cm² to 160 cm², for example 160 cm² to 170 cm², such as 170 cm² to 180 cm², for example 180 cm² to 190 cm², such as 190 cm² to 200 cm², for example 200 cm² to 210 cm², such as 210 cm² to 220 cm², for example 220 cm² to 230 cm², such as 230 cm² to 240 cm², for example 240 cm² to 250 cm², such as 250 cm² to 260 cm², for example 260 cm² to 270 cm², such as 270 cm² to 280 cm², for example 280 cm² to 290 cm², such as 290 cm² to 300 cm², for example 300 cm² to 320 cm², such as 320 cm² to 340 cm², for example 340 cm² to 360 cm², such as 360 cm² to 380 cm², for example 380 cm² to 400 cm², such as 400 cm² to 420 cm², for example 420 cm² to 440 cm², such as 440 cm² to 460 cm², for example 460 cm² to 480 cm², such as 480 cm² to 500 cm².

It follows that the dimension of the circular bottom need not be a whole or counting number, but may also be any decimal number.

In one embodiment the bottom is formed as a circle e.g. with a diameter that can circumvent a matrix material such as a circular matrix material with a diameter in the range of from 1 cm to 40 cm, such as from 1 cm to 2 cm, for example from 2 cm to 4 cm, such as from 4 cm to 6 cm, for example from 6 cm to 8 cm, such as from 8 cm to 10 cm, for example from 10 cm to 12 cm, such as from 12 cm to 14 cm, for example from 14 cm to 16 cm, such as from 16 cm to 18 cm, for example from 18 cm to 20 cm, such as from 20 cm to 22 cm, for example from 22 cm to 24 cm, such as from 24 cm to 26 cm, for example from 26 cm to 28 cm, such as from 28 cm to 30 cm, for example from 30 cm to 32 cm, such as from 32 cm to 34 cm, for example from 34 cm to 36 cm, such as from 36 cm to 38 cm, for example from 38 cm to 40 cm.

In one embodiment the bottom is formed as a circle e.g. with a diameter that can circumvent a matrix material such as a circular matrix material with a diameter of from of 1 cm, 2, cm, 3, cm, 4, cm, 5, cm, 6 cm, 7 cm, 8 cm, 9 cm, 10 cm, 11 cm, 12 cm, 13 cm, 14 cm, 15 cm, 16 cm, 17 cm, 18 cm, 19 cm, 20 cm, 21 cm, 22 cm, 23 cm, 24 cm, 25 cm, 26 cm, 27 cm, 28 cm, 29 cm, 30 cm, 31 cm, 32 cm, 33 cm, 34 cm, 35 cm, 36 cm, 37 cm, 38 cm, 39 cm or 40 cm.

In one embodiment the bottom is formed as a circle e.g. with a diameter that can circumvent a matrix material such as a circular matrix material with a dimension of between 1 cm² to 500 cm², such as 1 cm² to 5 cm², for example 5 cm² to 10 cm², such as 10 cm² to 20 cm², for example 20 cm² to 30 cm², such as 30 cm² to 40 cm², for example 40 cm² to 50 cm², such as 50 cm² to 60 cm², for example 60 cm² to 70 cm², such as 70 cm² to 80 cm², for example 80 cm² to 90 cm², such as 90 cm² to 100 cm², for example 100 cm² to 110 cm², such as 110 cm² to 120 cm², for example 120 cm² to 130 cm², such as 130 cm² to 140 cm², for example 140 cm² to 150 cm², such as 150 cm² to 160 cm², for example 160 cm² to 170 cm², such as 170 cm² to 180 cm², for example 180 cm² to 190 cm², such as 190 cm² to 200 cm², for example 200 cm² to 210 cm², such as 210 cm² to 220 cm², for example 220 cm² to 230 cm², such as 230 cm² to 240 cm², for example 240 cm² to 250 cm², such as 250 cm² to 260 cm², for example 260 cm² to 270 cm², such as 270 cm² to 280 cm², for example 280 cm² to 290 cm², such as 290 cm² to 300 cm², for example 300 cm² to 320 cm², such as 320 cm² to 340 cm², for example 340 cm² to 360 cm², such as 360 cm² to 380 cm², for example 380 cm² to 400 cm², such as 400 cm² to 420 cm², for example 420 cm² to 440 cm², such as 440 cm² to 460 cm², for example 460 cm² to 480 cm², such as 480 cm² to 500 cm².

It follows that the dimension of the circular matrix material need not be a whole or counting number, but may also be any decimal number.

In one embodiment the height of the sidewalls (from the bottom to the mark for maximum filling) is selected from the groups consisting of 0 mm to 2 mm, 2 mm to 4 mm, 4 mm to 6 mm, 6 mm to 8 mm, 8 mm to 10 mm, 10 mm to 12 mm, 12 mm to 14 mm, 14 mm to 16 mm, 16 mm to 18 mm, 18 mm to 20 mm, 20 mm to 22 mm, 22 mm to 24 mm, 24 mm to 26 mm, 26 mm to 28 mm, 28 mm to 30 mm, 30 mm to 32 mm, 32 mm to 34 mm, 34 mm to 36 mm, 36 mm to 38 mm, 38 mm to 40 mm, 40 mm to 42 mm, 42 mm to 44 mm, 44 mm to 46 mm, 46 mm to 48 mm or 48 mm to 50 mm.

In one embodiment the width of the sidewall(s) is in the range of 0 to 20 mm, preferably selected from the groups consisting of 0 mm to 2 mm, 2 mm to 4 mm, 4 mm to 6 mm, 6 mm to 8 mm, 8 mm to 10 mm, 10 mm to 12 mm, 12 mm to 14 mm, 14 mm to 16 mm, 16 mm to 18 mm, 18 mm to 20 mm.

In one embodiment the height from the mark for maximum filling to the lid can be selected from the group consisting of 0 mm to 2 mm, 2 mm to 4 mm, 4 mm to 6 mm, 6 mm to 8 mm, 8 mm to 10 mm, 10 mm to 12 mm, 12 mm to 14 mm, 14 mm to 16 mm, 16 mm to 18 mm, 18 mm to 20 mm, 20 mm to 22 mm, 22 mm to 24 mm, 24 mm to 26 mm, 26 mm to 28 mm, 28 mm to 30 mm, 30 mm to 32 mm, 32 mm to 34 mm, 34 mm to 36 mm, 36 mm to 38 mm, 38 mm to 40 mm, 40 mm to 42 mm, 42 mm to 44 mm, 44 mm to 46 mm, 46 mm to 48 mm or 48 mm to 50 mm.

In one embodiment the height from the bottom of the container to the lid of the container is selected from the groups consisting of 0 mm to 2 mm, 2 mm to 4 mm, 4 mm to 6 mm, 6 mm to 8 mm, 8 mm to 10 mm, 10 mm to 12 mm, 12 mm to 14 mm, 14 mm to 16 mm, 16 mm to 18 mm, 18 mm to 20 mm, 20 mm to 22 mm, 22 mm to 24 mm, 24 mm to 26 mm, 26 mm to 28 mm, 28 mm to 30 mm, 30 mm to 32 mm, 32 mm to 34 mm, 34 mm to 36 mm, 36 mm to 38 mm, 38 mm to 40 mm, 40 mm to 42 mm, 42 mm to 44 mm, 44 mm to 46 mm, 46 mm to 48 mm or 48 mm to 50 mm.

In one embodiment the cavity of the container also comprise space for contacting the matrix material e.g. with scissors, tweezers, forceps, another device or one or more fingers (inner tray notches). The container can comprise 1, 2, 3, 4, 5, 6, 7, 8, 9, 10 or more than 10 inner tray notches. These inner tray notches can have any size or form to provide easy contact with the matrix material. The one or more inner tray notches may be associated with the one or more sidewall(s) of the container.

The base of the container can have any shape such as a square, rectangle, triangle, circle, or oval.

In one embodiment the base is formed as a square e.g. with the dimensions 1 cm×1 cm, 1 cm×2 cm, 1 cm×3 cm, 1 cm×4 cm, 1 cm×5 cm, 1 cm×6 cm, 1 cm×7 cm, 1 cm×8 cm, 1 cm×9 cm, 1 cm×10 cm, 1 cm×15 cm, 1 cm×20 cm, 2 cm×1 cm, 2 cm×2 cm, 2 cm×3 cm, 2 cm×4 cm, 2 cm×5 cm, 2 cm×6 cm, 2 cm×7 cm, 2 cm×8 cm, 2 cm×9 cm, 2 cm×10 cm, 2 cm×15 cm, 2 cm×20 cm, 3 cm×1 cm, 3 cm×2 cm, 3 cm×3 cm, 3 cm×4 cm, 3 cm×5 cm, 3 cm×6 cm, 3 cm×7 cm, 3 cm×8 cm, 3 cm×9 cm, 3 cm×10 cm, 3 cm×15 cm, 3 cm×20 cm, 4 cm×1 cm, 4 cm×2 cm, 4 cm×3 cm, 4 cm×4 cm, 4 cm×5 cm, 4 cm×6 cm, 4 cm×7 cm, 4 cm×8 cm, 4 cm×9 cm, 4 cm×10 cm, 4 cm×15 cm, 4 cm×20 cm, 5 cm×1 cm, 5 cm×2 cm, 5 cm×3 cm, 5 cm×4 cm, 5 cm×5 cm, 5 cm×6 cm, 5 cm×7 cm, 5 cm×8 cm, 5 cm×9 cm, 5 cm×10 cm, 5 cm×15 cm, 5 cm×20 cm, 6 cm×1 cm, 6 cm×2 cm, 6 cm×3 cm, 6 cm×4 cm, 6 cm×5 cm, 6 cm×6 cm, 6 cm×7 cm, 6 cm×8 cm, 6 cm×9 cm, 6 cm×10 cm, 6 cm×15 cm, 6 cm×20 cm, 7 cm×1 cm, 7 cm×2 cm, 7 cm×3 cm, 7 cm×4 cm, 7 cm×5 cm, 7 cm×6 cm, 7 cm×7 cm, 7 cm×8 cm, 7 cm×9 cm, 7 cm×10 cm, 7 cm×15 cm, 7 cm×20 cm, 8 cm×1 cm, 8 cm×2 cm, 8 cm×3 cm, 8 cm×4 cm, 8 cm×5 cm, 8 cm×6 cm, 8 cm×7 cm, 8 cm×8 cm, 8 cm×9 cm, 8 cm×10 cm, 8 cm×15 cm, 8 cm×20 cm, 9 cm×1 cm, 9 cm×2 cm, 9 cm×3 cm, 9 cm×4 cm, 9 cm×5 cm, 9 cm×6 cm, 9 cm×7 cm, 9 cm×8 cm, 9 cm×9 cm, 9 cm×10 cm, 9 cm×15 cm, 9 cm×20 cm, 10 cm×1 cm, 10 cm×2 cm, 10 cm×3 cm, 10 cm×4 cm, 10 cm×5 cm, 10 cm×6 cm, 10 cm×7 cm, 10 cm×8 cm, 10 cm×9 cm, 10 cm×10 cm, 10 cm×15 cm, 10 cm×20 cm, 11 cm×1 cm, 11 cm×2 cm, 11 cm×3 cm, 11 cm×4 cm, 11 cm×5 cm, 11 cm×6 cm, 11 cm×7 cm, 11 cm×8 cm, 11 cm×9 cm, 11 cm×10 cm, 11 cm×15 cm, 11 cm×20 cm, 12 cm×1 cm, 12 cm×2 cm, 12 cm×3 cm, 12 cm×4 cm, 12 cm×5 cm, 12 cm×6 cm, 12 cm×7 cm, 12 cm×8 cm, 12 cm×9 cm, 12 cm×10 cm, 12 cm×15 cm, 12 cm×20 cm, 13 cm×1 cm, 13 cm×2 cm, 13 cm×3 cm, 13 cm×4 cm, 13 cm×5 cm, 13 cm×6 cm, 13 cm×7 cm, 13 cm×8 cm, 13 cm×9 cm, 13 cm×10 cm, 13 cm×15 cm, 13 cm×20 cm, 14 cm×1 cm, 14 cm×2 cm, 14 cm×3 cm, 14 cm×4 cm, 14 cm×5 cm, 14 cm×6 cm, 14 cm×7 cm, 14 cm×8 cm, 14 cm×9 cm, 14 cm×10 cm, 14 cm×15 cm, 14 cm×20 cm, 15 cm×1 cm, 15 cm×2 cm, 15 cm×3 cm, 15 cm×4 cm, 15 cm×5 cm, 15 cm×6 cm, 15 cm×7 cm, 15 cm×8 cm, 15 cm×9 cm, 15 cm×10 cm, 15 cm×15 cm, 15 cm×20 cm, 16 cm×1 cm, 16 cm×2 cm, 16 cm×3 cm, 16 cm×4 cm, 16 cm×5 cm, 16 cm×6 cm, 16 cm×7 cm, 16 cm×8 cm, 16 cm×9 cm, 16 cm×10 cm, 16 cm×15 cm, 16 cm×20 cm, 17 cm×1 cm, 17 cm×2 cm, 17 cm×3 cm, 17 cm×4 cm, 17 cm×5 cm, 17 cm×6 cm, 17 cm×7 cm, 17 cm×8 cm, 17 cm×9 cm, 17 cm×10 cm, 17 cm×15 cm, 17 cm×20 cm, 18 cm×1 cm, 18 cm×2 cm, 18 cm×3 cm, 18 cm×4 cm, 18 cm×5 cm, 18 cm×6 cm, 18 cm×7 cm, 18 cm×8 cm, 18 cm×9 cm, 18 cm×10 cm, 18 cm×15 cm, 18 cm×20 cm, 19 cm×1 cm, 19 cm×2 cm, 19 cm×3 cm, 19 cm×4 cm, 19 cm×5 cm, 19 cm×6 cm, 19 cm×7 cm, 19 cm×8 cm, 19 cm×9 cm, 19 cm×10 cm, 19 cm×15 cm, 19 cm×20 cm, 20 cm×1 cm, 20 cm×2 cm, 20 cm×3 cm, 20 cm×4 cm, 20 cm×5 cm, 20 cm×6 cm, 20 cm×7 cm, 20 cm×8 cm, 20 cm×9 cm, 20 cm×10 cm, 20 cm×15 cm, 20 cm×20 cm, 25 cm×1 cm, 25 cm×2 cm, 25 cm×3 cm, 25 cm×4 cm, 25 cm×5 cm, 25 cm×6 cm, 25 cm×7 cm, 25 cm×8 cm, 25 cm×9 cm, 25 cm×10 cm, 25 cm×15 cm, 25 cm×20 cm, 30 cm×1 cm, 30 cm×2 cm, 30 cm×3 cm, 30 cm×4 cm, 30 cm×cm, 30 cm×6 cm, 30 cm×7 cm, 30 cm×8 cm, 30 cm×9 cm, 30 cm×10 cm, 30 cm×15 cm, 30 cm×20 cm, 40 cm×1 cm, 40 cm×2 cm, 40 cm×3 cm, 40 cm×4 cm, 40 cm×5 cm, 40 cm×6 cm, 40 cm×7 cm, 40 cm×8 cm, 40 cm×9 cm, 40 cm×10 cm, 40 cm×15 cm, 40 cm×20 cm, 50 cm×1 cm, 50 cm×2 cm, 50 cm×3 cm, 50 cm×4 cm, 50 cm×5 cm, 50 cm×6 cm, 50 cm×7 cm, 50 cm×8 cm, 50 cm×9 cm, 50 cm×cm, 50 cm×15 cm, or 50 cm×20 cm.

In one embodiment the bottom is formed as a square e.g. with the dimensions of between 1 cm² to 500 cm², such as 1 cm² to 5 cm², for example 5 cm² to 10 cm², such as 10 cm² to 20 cm², for example 20 cm² to 30 cm², such as 30 cm² to 40 cm², for example 40 cm² to 50 cm², such as 50 cm² to 60 cm², for example 60 cm² to 70 cm², such as 70 cm² to 80 cm², for example 80 cm² to 90 cm², such as 90 cm² to 100 cm², for example 100 cm² to 110 cm², such as 110 cm² to 120 cm², for example 120 cm² to 130 cm², such as 130 cm² to 140 cm², for example 140 cm² to 150 cm², such as 150 cm² to 160 cm², for example 160 cm² to 170 cm², such as 170 cm² to 180 cm², for example 180 cm² to 190 cm², such as 190 cm² to 200 cm², for example 200 cm² to 210 cm², such as 210 cm² to 220 cm², for example 220 cm² to 230 cm², such as 230 cm² to 240 cm², for example 240 cm² to 250 cm², such as 250 cm² to 260 cm², for example 260 cm² to 270 cm², such as 270 cm² to 280 cm², for example 280 cm² to 290 cm², such as 290 cm² to 300 cm², for example 300 cm² to 320 cm², such as 320 cm² to 340 cm², for example 340 cm² to 360 cm², such as 360 cm² to 380 cm², for example 380 cm² to 400 cm², such as 400 cm² to 420 cm², for example 420 cm² to 440 cm², such as 440 cm² to 460 cm², for example 460 cm² to 480 cm², such as 480 cm² to 500 cm².

It follows that the dimension of the square base need not be a whole or counting number, but may also be any decimal number.

In one embodiment the base of the container is formed as a circle e.g. with a diameter in the range of from 1 cm to 40 cm, such as from 1 cm to 2 cm, for example from 2 cm to 4 cm, such as from 4 cm to 6 cm, for example from 6 cm to 8 cm, such as from 8 cm to 10 cm, for example from 10 cm to 12 cm, such as from 12 cm to 14 cm, for example from 14 cm to 16 cm, such as from 16 cm to 18 cm, for example from 18 cm to 20 cm, such as from 20 cm to 22 cm, for example from 22 cm to 24 cm, such as from 24 cm to 26 cm, for example from 26 cm to 28 cm, such as from 28 cm to 30 cm, for example from 30 cm to 32 cm, such as from 32 cm to 34 cm, for example from 34 cm to 36 cm, such as from 36 cm to 38 cm, for example from 38 cm to 40 cm.

In one embodiment the base of the container is formed as a circle e.g. with a diameter of 1 cm, 2, cm, 3, cm, 4, cm, 5, cm, 6 cm, 7 cm, 8 cm, 9 cm, 10 cm, 11 cm, 12 cm, 13 cm, 14 cm, 15 cm, 16 cm, 17 cm, 18 cm, 19 cm, 20 cm, 21 cm, 22 cm, 23 cm, 24 cm, 25 cm, 26 cm, 27 cm, 28 cm, 29 cm, 30 cm, 31 cm, 32 cm, 33 cm, 34 cm, 35 cm, 36 cm, 37 cm, 38 cm, 39 cm or 40 cm.

In one embodiment the bottom is formed as a circle e.g. with the dimensions of between 1 cm² to 500 cm², such as 1 cm² to 5 cm², for example 5 cm² to 10 cm², such as 10 cm² to 20 cm², for example 20 cm² to 30 cm², such as 30 cm² to 40 cm², for example 40 cm² to 50 cm², such as 50 cm² to 60 cm², for example 60 cm² to 70 cm², such as 70 cm² to 80 cm², for example 80 cm² to 90 cm², such as 90 cm² to 100 cm², for example 100 cm² to 110 cm², such as 110 cm² to 120 cm², for example 120 cm² to 130 cm², such as 130 cm² to 140 cm², for example 140 cm² to 150 cm², such as 150 cm² to 160 cm², for example 160 cm² to 170 cm², such as 170 cm² to 180 cm², for example 180 cm² to 190 cm², such as 190 cm² to 200 cm², for example 200 cm² to 210 cm², such as 210 cm² to 220 cm², for example 220 cm² to 230 cm², such as 230 cm² to 240 cm², for example 240 cm² to 250 cm², such as 250 cm² to 260 cm², for example 260 cm² to 270 cm², such as 270 cm² to 280 cm², for example 280 cm² to 290 cm², such as 290 cm² to 300 cm², for example 300 cm² to 320 cm², such as 320 cm² to 340 cm², for example 340 cm² to 360 cm², such as 360 cm² to 380 cm², for example 380 cm² to 400 cm², such as 400 cm² to 420 cm², for example 420 cm² to 440 cm², such as 440 cm² to 460 cm², for example 460 cm² to 480 cm², such as 480 cm² to 500 cm².

It follows that the dimension of the circular base need not be a whole or counting number, but may also be any decimal number.

The base of the container can comprise an extended base portion at on or more sides. In one embodiment the extended base portion is placed at the same side as the handle of the container. The handle and extended base portion can be casted or moulded in one or more pieces.

The lid of the container can have any shape such as a square, rectangle, triangle, circle, or oval.

In one embodiment the lid of the container is formed as a square e.g. with the dimensions 1 cm×1 cm, 1 cm×2 cm, 1 cm×3 cm, 1 cm×4 cm, 1 cm×5 cm, 1 cm×6 cm, 1 cm×7 cm, 1 cm×8 cm, 1 cm×9 cm, 1 cm×10 cm, 1 cm×15 cm, 1 cm×20 cm, 2 cm×1 cm, 2 cm×2 cm, 2 cm×3 cm, 2 cm×4 cm, 2 cm×5 cm, 2 cm×6 cm, 2 cm×7 cm, 2 cm×8 cm, 2 cm×9 cm, 2 cm×10 cm, 2 cm×15 cm, 2 cm×20 cm, 3 cm×1 cm, 3 cm×2 cm, 3 cm×3 cm, 3 cm×4 cm, 3 cm×5 cm, 3 cm×6 cm, 3 cm×7 cm, 3 cm×8 cm, 3 cm×9 cm, 3 cm×10 cm, 3 cm×15 cm, 3 cm×20 cm, 4 cm×1 cm, 4 cm×2 cm, 4 cm×3 cm, 4 cm×4 cm, 4 cm×5 cm, 4 cm×6 cm, 4 cm×7 cm, 4 cm×8 cm, 4 cm×9 cm, 4 cm×10 cm, 4 cm×15 cm, 4 cm×20 cm, 5 cm×1 cm, 5 cm×2 cm, 5 cm×3 cm, 5 cm×4 cm, 5 cm×5 cm, 5 cm×6 cm, 5 cm×7 cm, 5 cm×8 cm, 5 cm×9 cm, 5 cm×10 cm, 5 cm×15 cm, 5 cm×20 cm, 6 cm×1 cm, 6 cm×2 cm, 6 cm×3 cm, 6 cm×4 cm, 6 cm×5 cm, 6 cm×6 cm, 6 cm×7 cm, 6 cm×8 cm, 6 cm×9 cm, 6 cm×10 cm, 6 cm×15 cm, 6 cm×20 cm, 7 cm×1 cm, 7 cm×2 cm, 7 cm×3 cm, 7 cm×4 cm, 7 cm×5 cm, 7 cm×6 cm, 7 cm×7 cm, 7 cm×8 cm, 7 cm×9 cm, 7 cm×10 cm, 7 cm×15 cm, 7 cm×20 cm, 8 cm×1 cm, 8 cm×2 cm, 8 cm×3 cm, 8 cm×4 cm, 8 cm×5 cm, 8 cm×6 cm, 8 cm×7 cm, 8 cm×8 cm, 8 cm×9 cm, 8 cm×10 cm, 8 cm×15 cm, 8 cm×20 cm, 9 cm×1 cm, 9 cm×2 cm, 9 cm×3 cm, 9 cm×4 cm, 9 cm×5 cm, 9 cm×6 cm, 9 cm×7 cm, 9 cm×8 cm, 9 cm×9 cm, 9 cm×10 cm, 9 cm×15 cm, 9 cm×20 cm, 10 cm×1 cm, 10 cm×2 cm, 10 cm×3 cm, 10 cm×4 cm, 10 cm×5 cm, 10 cm×6 cm, 10 cm×7 cm, 10 cm×8 cm, 10 cm×9 cm, 10 cm×10 cm, 10 cm×15 cm, 10 cm×20 cm, 11 cm×1 cm, 11 cm×2 cm, 11 cm×3 cm, 11 cm×4 cm, 11 cm×5 cm, 11 cm×6 cm, 11 cm×7 cm, 11 cm×8 cm, 11 cm×9 cm, 11 cm×10 cm, 11 cm×15 cm, 11 cm×20 cm, 12 cm×1 cm, 12 cm×2 cm, 12 cm×3 cm, 12 cm×4 cm, 12 cm×5 cm, 12 cm×6 cm, 12 cm×7 cm, 12 cm×8 cm, 12 cm×9 cm, 12 cm×10 cm, 12 cm×15 cm, 12 cm×20 cm, 13 cm×1 cm, 13 cm×2 cm, 13 cm×3 cm, 13 cm×4 cm, 13 cm×5 cm, 13 cm×6 cm, 13 cm×7 cm, 13 cm×8 cm, 13 cm×9 cm, 13 cm×10 cm, 13 cm×15 cm, 13 cm×20 cm, 14 cm×1 cm, 14 cm×2 cm, 14 cm×3 cm, 14 cm×4 cm, 14 cm×5 cm, 14 cm×6 cm, 14 cm×7 cm, 14 cm×8 cm, 14 cm×9 cm, 14 cm×10 cm, 14 cm×15 cm, 14 cm×20 cm, 15 cm×1 cm, 15 cm×2 cm, 15 cm×3 cm, 15 cm×4 cm, 15 cm×5 cm, 15 cm×6 cm, 15 cm×7 cm, 15 cm×8 cm, 15 cm×9 cm, 15 cm×10 cm, 15 cm×15 cm, 15 cm×20 cm, 16 cm×1 cm, 16 cm×2 cm, 16 cm×3 cm, 16 cm×4 cm, 16 cm×5 cm, 16 cm×6 cm, 16 cm×7 cm, 16 cm×8 cm, 16 cm×9 cm, 16 cm×10 cm, 16 cm×15 cm, 16 cm×20 cm, 17 cm×1 cm, 17 cm×2 cm, 17 cm×3 cm, 17 cm×4 cm, 17 cm×5 cm, 17 cm×6 cm, 17 cm×7 cm, 17 cm×8 cm, 17 cm×9 cm, 17 cm×10 cm, 17 cm×15 cm, 17 cm×20 cm, 18 cm×1 cm, 18 cm×2 cm, 18 cm×3 cm, 18 cm×4 cm, 18 cm×5 cm, 18 cm×6 cm, 18 cm×7 cm, 18 cm×8 cm, 18 cm×9 cm, 18 cm×10 cm, 18 cm×15 cm, 18 cm×20 cm, 19 cm×1 cm, 19 cm×2 cm, 19 cm×3 cm, 19 cm×4 cm, 19 cm×cm, 19 cm×6 cm, 19 cm×7 cm, 19 cm×8 cm, 19 cm×9 cm, 19 cm×10 cm, 19 cm×15 cm, 19 cm×20 cm, 20 cm×1 cm, 20 cm×2 cm, 20 cm×3 cm, 20 cm×4 cm, 20 cm×5 cm, 20 cm×6 cm, 20 cm×7 cm, 20 cm×8 cm, 20 cm×9 cm, 20 cm×10 cm, 20 cm×15 cm, 20 cm×20 cm, 25 cm×1 cm, 25 cm×2 cm, 25 cm×3 cm, 25 cm×4 cm, 25 cm×5 cm, 25 cm×6 cm, 25 cm×7 cm, 25 cm×8 cm, 25 cm×9 cm, 25 cm×cm, 25 cm×15 cm, 25 cm×20 cm, 30 cm×1 cm, 30 cm×2 cm, 30 cm×3 cm, 30 cm×4 cm, 30 cm×5 cm, 30 cm×6 cm, 30 cm×7 cm, 30 cm×8 cm, 30 cm×9 cm, 30 cm×10 cm, 30 cm×15 cm, 30 cm×20 cm, 40 cm×1 cm, 40 cm×2 cm, 40 cm×3 cm, 40 cm×4 cm, 40 cm×5 cm, 40 cm×6 cm, 40 cm×7 cm, 40 cm×8 cm, 40 cm×9 cm, 40 cm×10 cm, 40 cm×15 cm, 40 cm×20 cm, 50 cm×1 cm, 50 cm×2 cm, 50 cm×3 cm, 50 cm×4 cm, 50 cm×5 cm, 50 cm×6 cm, 50 cm×7 cm, 50 cm×8 cm, 50 cm×9 cm, 50 cm×10 cm, 50 cm×15 cm, or 50 cm×20 cm.

In one embodiment the lid is formed as a square e.g. with the dimensions of between 1 cm² to 500 cm², such as 1 cm² to 5 cm², for example 5 cm² to 10 cm², such as 10 cm² to 20 cm², for example 20 cm² to 30 cm², such as 30 cm² to 40 cm², for example 40 cm² to 50 cm², such as 50 cm² to 60 cm², for example 60 cm² to 70 cm², such as 70 cm² to 80 cm², for example 80 cm² to 90 cm², such as 90 cm² to 100 cm², for example 100 cm² to 110 cm², such as 110 cm² to 120 cm², for example 120 cm² to 130 cm², such as 130 cm² to 140 cm², for example 140 cm² to 150 cm², such as 150 cm² to 160 cm², for example 160 cm² to 170 cm², such as 170 cm² to 180 cm², for example 180 cm² to 190 cm², such as 190 cm² to 200 cm², for example 200 cm² to 210 cm², such as 210 cm² to 220 cm², for example 220 cm² to 230 cm², such as 230 cm² to 240 cm², for example 240 cm² to 250 cm², such as 250 cm² to 260 cm², for example 260 cm² to 270 cm², such as 270 cm² to 280 cm², for example 280 cm² to 290 cm², such as 290 cm² to 300 cm², for example 300 cm² to 320 cm², such as 320 cm² to 340 cm², for example 340 cm² to 360 cm², such as 360 cm² to 380 cm², for example 380 cm² to 400 cm², such as 400 cm² to 420 cm², for example 420 cm² to 440 cm², such as 440 cm² to 460 cm², for example 460 cm² to 480 cm², such as 480 cm² to 500 cm².

It follows that the dimension of the square lid need not be a whole or counting number, but may also be any decimal number.

In one embodiment the lid of the container is formed as a circle e.g. with a diameter in the range of from 1 cm to 40 cm, such as from 1 cm to 2 cm, for example from 2 cm to 4 cm, such as from 4 cm to 6 cm, for example from 6 cm to 8 cm, such as from 8 cm to 10 cm, for example from 10 cm to 12 cm, such as from 12 cm to 14 cm, for example from 14 cm to 16 cm, such as from 16 cm to 18 cm, for example from 18 cm to 20 cm, such as from 20 cm to 22 cm, for example from 22 cm to 24 cm, such as from 24 cm to 26 cm, for example from 26 cm to 28 cm, such as from 28 cm to 30 cm, for example from 30 cm to 32 cm, such as from 32 cm to 34 cm, for example from 34 cm to 36 cm, such as from 36 cm to 38 cm, for example from 38 cm to 40 cm.

In one embodiment the lid of the container is formed as a circle e.g. with a diameter of 1 cm, 2, cm, 3, cm, 4, cm, 5, cm, 6 cm, 7 cm, 8 cm, 9 cm, 10 cm, 11 cm, 12 cm, 13 cm, 14 cm, 15 cm, 16 cm, 17 cm, 18 cm, 19 cm, 20 cm, 21 cm, 22 cm, 23 cm, 24 cm, 25 cm, 26 cm, 27 cm, 28 cm, 29 cm, 30 cm, 31 cm, 32 cm, 33 cm, 34 cm, 35 cm, 36 cm, 37 cm, 38 cm, 39 cm or 40 cm.

In one embodiment the lid is formed as a circle e.g. with the dimensions of between 1 cm² to 500 cm², such as 1 cm² to 5 cm², for example 5 cm² to 10 cm², such as 10 cm² to 20 cm², for example 20 cm² to 30 cm², such as 30 cm² to 40 cm², for example 40 cm² to 50 cm², such as 50 cm² to 60 cm², for example 60 cm² to 70 cm², such as 70 cm² to 80 cm², for example 80 cm² to 90 cm², such as 90 cm² to 100 cm², for example 100 cm² to 110 cm², such as 110 cm² to 120 cm², for example 120 cm² to 130 cm², such as 130 cm² to 140 cm², for example 140 cm² to 150 cm², such as 150 cm² to 160 cm², for example 160 cm² to 170 cm², such as 170 cm² to 180 cm², for example 180 cm² to 190 cm², such as 190 cm² to 200 cm², for example 200 cm² to 210 cm², such as 210 cm² to 220 cm², for example 220 cm² to 230 cm², such as 230 cm² to 240 cm², for example 240 cm² to 250 cm², such as 250 cm² to 260 cm², for example 260 cm² to 270 cm², such as 270 cm² to 280 cm², for example 280 cm² to 290 cm², such as 290 cm² to 300 cm², for example 300 cm² to 320 cm², such as 320 cm² to 340 cm², for example 340 cm² to 360 cm², such as 360 cm² to 380 cm², for example 380 cm² to 400 cm², such as 400 cm² to 420 cm², for example 420 cm² to 440 cm², such as 440 cm² to 460 cm², for example 460 cm² to 480 cm², such as 480 cm² to 500 cm².

It follows that the dimension of the circular lid need not be a whole or counting number, but may also be any decimal number.

The lid of the container can comprise one or more flaps to facilitate opening of the lid of the container, i.e. for easier handling of the lid when opening the container. The flap(s) can have any shape and size that would facilitate opening of the lid.

The container can further comprise one or more handles such as 1, 2, 3, 4, 5, 6, 7, 8, 9, 10 or more than 10 handles. The one or more handle(s) of the container can have any size and shape that provide easy handling of the container.

The one or more handles may be associated with the bottom of the container, the one or more sidewall(s) of the container or the base of the container.

The one or more handles, the one or more sidewall(s) or the base of the container according to the present invention may comprise one or more recesses or indentations for improved grip.

In one embodiment the container and/or the lid and/or the base and/or the bottom and/or the sidewall(s) is made of plastic such as any suitable plastic known in the art such as medical grade plastic and/or a transparent plastic and/or a non-transparent plastic. The plastic can be a flexible or rigid plastic material with a thickness and strength properties which allow the container to be opened by simply tearing the lid from the sealing surface for the lid. Alternatively, a thicker or stronger material may be utilized and the container may be opened by cutting with scissors or otherwise puncturing the container.

In one embodiment the container and/or the lid and/or the base and/or the bottom and/or the sidewall(s) is made of or comprises plastic such as one or more types of flexible plastic and/or one or more types of transparent plastic and/or non-transparent plastic and/or biodegradable plastic.

In one embodiment the container and/or the lid and/or the base and/or the bottom and/or the sidewall(s) is made of or comprises one or more materials selected from the group consisting of TECAFORM™ AH MT, CELCON® (Acetal Copolymer), RADEL®, TECASON™ P XRO (Polyphenylsulfone, also Radio Opacifer), UDEL® Polysulfone, ULTEM® (Polyetherimide), UHMW Lot Controlled, LENNITE® UHME-PE, TECANAT™ PC (USP Class VI Polycarbonate Rod), ZELUX® GS (Gamma Stabilized Polycarbonate), ACRYLIC (Medical grade Cast Acrylic), TECAMAX™ SRP (Ultra High Performance Thermoplastic), TECAPRO™ MT (Polypropylene Heat Stabilized), TECAPEEK™ MT (USP Class VI compliant), TECAFORM™ AH SAN, ANTIMICROBIAL filled plastics, TECASON™ P XRO (Biocompatible Radio Opacifer PPSU), TECAPEEK™ CLASSIX, POLYSULFONE® (Medical grade), TECANYL™ (Medical grade Noryl®), TYGON® (Medical grade Tubing), TEXOLON™ Medical Grade PTFE (USP CLASS VI), PROPYLUX HS and HS2, ABS (FDA Approved Medical Grades), TOPAS® (Medical grade), and other Medical Grade/FDA approved plastic products.

In one embodiment the container and/or the lid and/or the base and/or the bottom and/or the sidewall(s) is made of or comprises one or more types of medical grade polymer such as plastic.

Plastic is the general common term for a wide range of synthetic or semisynthetic organic solid materials suitable for the manufacture of industrial products. Plastics are typically polymers of high molecular weight, and may contain other substances to improve performance and/or reduce costs. Types of plastic includes Rubber, Cellulose-based plastics, Bakelite, Polystyrene, PVC, Nylon, Synthetic rubber. Plastics can be classified by their chemical structure. Some important groups in these classifications are the acrylics, polyesters, silicones, polyurethanes, and halogenated plastics. Plastics can also be classified by the chemical process used in their synthesis, e.g. as condensation, polyaddition, cross-linking. Other classifications are based on qualities that are relevant for manufacturing or product design. Examples of such classes are the thermoplastic and thermoset, elastomer, structural, biodegradable, electrically conductive. Plastics can also be ranked by various physical properties, such as density, tensile strength, glass transition temperature, resistance to various chemical products, etc. In one embodiment the container and/or the lid and/or the base is made of or comprises one or more types of plastic mention herein above or below.

Common thermoplastics range from 20,000 to 500,000 in molecular mass, while thermosets are assumed to have infinite molecular weight. In one embodiment the container and/or the lid and/or the base is made of or comprises one or more types of polymers and/or plastics with a molecular weight in the range from 10,000 to 1,000,000 Da, such as from 10,000 to 50,000 Da, for example 50,000 to 100,000 Da, such as from 100,000 to 150,000 Da, for example 150,000 to 200,000 Da, such as from 200,000 to 250,000 Da, for example 250,000 to 300,000 Da, such as from 300,000 to 350,000 Da, for example 350,000 to 400,000 Da, such as from 400,000 to 450,000 Da, for example 450,000 to 500,000 Da, such as from 500,000 to 550,000 Da, for example 550,000 to 600,000 Da, such as from 600,000 to 650,000 Da, for example 650,000 to 700,000 Da, such as from 700,000 to 750,000 Da, for example 750,000 to 800,000 Da, such as from 800,000 to 850,000 Da, for example 850,000 to 900,000 Da, such as from 900,000 to 950,000 Da, for example 950,000 to 1,000,000 Da.

These chains are made up of many repeating molecular units, known as “repeat units”, derived from “monomers”; each polymer chain will have several thousand repeat units.

The vast majority of plastics are composed of polymers of carbon and hydrogen alone or with oxygen, nitrogen, chlorine, or sulfur in the backbone.

In one embodiment the container and/or the lid and/or the base and/or the bottom and/or the sidewall(s) is made of or comprises one or more materials selected from the group consisting of Biodegradable plastic, Bioplastics obtained from biomass e.g. from pea starch or from biopetroleum, Polypropylene (PP), Polystyrene (PS), High impact polystyrene (HIPS), Acrylonitrile butadiene styrene (ABS), Polyethylene terephthalate (PET), Amorphous PET (APET), Polyester (PES), Fibers, textiles, Polyamides (PA), (Nylons), Poly(vinyl chloride) (PVC), Polyurethanes (PU), Polycarbonate (PC), Polyvinylidene chloride (PVDC) (Saran), Polyvinylidene Fluoride (PVDF), Polyethylene (PE), Polymethyl methacrylate (PMMA), Polytetrafluoroethylene (PTFE) (trade name Teflon), Fluorinated ethylene propylene (FEP), Polyetheretherketone (PEEK) (Polyetherketone), Polyetherimide (PEI) (Ultem), Phenolics (PF), (phenol formaldehydes), Perfluoroalkoxy (PFA), Poly(methyl methacrylate) (PMMA), Urea-formaldehyde (UF), Melamine formaldehyde (MF), Polylactic acid and Plastarch material or any mixture thereof.

The container and/or the lid and/or the base and/or the bottom and/or the sidewall(s) can be made of any suitable material such as plastic, rubber or glas.

The lid and/or the base and/or the bottom and/or the sidewall(s) can be plane, curved, arched upwardsor downwards or any other shape.

The sealing surface for the lid can have any size or shape that facilitates sealing of the lid to and/or removement of the lid from the container.

In one embodiment the container comprises a reclosable lid such as a lid that can be resealed by e.g. the glue on the sealing surface for the lid or by a screw, click or snap mechanism. In one embodiment the container comprises a lid that can not be reclosed after opening of the lid.

The container can comprise any type of lid such as a sealing foil, a screw top, a screw cap, a snap cap, a lid glued to or by any other means fastened to the sealing surface of the container.

The sealing surface for the lid may be comprised in the upper portion of the one or more sidewall(s) or the base.

In one particular embodiment, the lid of the container is peelable (a peel-off lid). It follows that the lid may be made of or comprise a peelable material, such as a polyethylene (PE)-based material, a thermoplastic elastomer, a thermoset elastomer, Tyvek, Teslin, paper, foil (plastic foil or metal foil such as alufoil) or any other peelable material.

The lid may be reinforced with a coating, such as a synthetic coating selected from the group consisting of Perfluorooctanoic acid (PFOA), hydrocarbon based petrochemicals, zein or others.

For the purpose of the present invention, peelability will be defined as the ability to separate two materials in the course of opening a package without compromising the integrity of either of the two. In medical packaging, a peelable system provides a controlled, reliable, aseptic means of opening a package and presenting a device. The sealant layer of one or both webs is responsible for bonding the two materials together, which is accomplished via the application of heat, pressure or glue.

The force required to pull a seal apart is called its seal strength. Seal strength in a peelable system is controlled by the composition of either the heat seal coating or the sealant layer. Typical medical packages have a seal strength of 1-3 lb per in. of seal width, as measured via a standard test such as ASTM F88-94.

Peelable films are generally based on polybutylene-polyolefin technology first pioneered by Shell in the mid-1970s. The incompatibility of the two polymers inhibits the sealant layer from forming a complete bond by reducing the number of available bonding sites. These peelable systems provide seal transfer by internal cohesive splitting between the polyethylene and polybutylene layers because of poor interfacial adhesion, which reduces internal bond strength. This is in contrast to heat-sealed coated (HSC) materials, which undergo the cohesive failure that occurs when the internal strength of the adhesive is less than the strength of the bonds between the adhesive and sealed materials.

Peelable films are generally limited to similar-type materials that are primarily polyethylene (PE) based, and tend to have a narrower sealing window and/or a steeper peel-strength slope compared with HSC materials. However, new peelable technologies are being introduced that can provide increased sealing windows with smaller variations in peel strength over their useful range. These new peelable resin systems are being developed to seal to a wide variety of materials, including but not limited to PETG, HIPS, and PVC.

Thermoplastic elastomers (TPE), sometimes referred to as thermoplastic rubbers, are a class of copolymers or a physical mix of polymers (usually a plastic and a rubber) which consist of materials with both thermoplastic and elastomeric properties. The principal difference between thermoset elastomers and thermoplastic elastomers is the type of crosslinking bond in their structures. There are six generic classes of TPEs generally considered to exist commercially. They are styrenic block copolymers, polyolefin blends, elastomeric alloys, thermoplastic polyurethanes, thermoplastic copolyester and thermoplastic polyamides.

Paper is thin material mainly used for writing upon, printing upon or packaging. It is produced by pressing together moist fibers, typically cellulose pulp derived from wood, rags or grasses, and drying them into flexible sheets. Synthetic coatings (such as PFOA), hydrocarbon based petrochemicals, and zein (corn protein) may be used as a coating for paper. Also, synthetics such as Tyvek (a brand of flashspun high-density polyethylene/olefin fibers) and Teslin have been introduced for medical packaging as a more durable material than paper.

The container described in the present invention has the following advantages:
It is very stable—even on uneven surfaces (allows stabile placement on all possible positions: on sterile field, on mayo stand, on tray of instruments or on the chest of the patient) minimizing the risk of spilling
It eliminates any need for other mixing bowls/specimen cups
It has superior ergonomic handling making handling and presentation easier and faster from all directions
The inner tray notches make it easy to grasp the sponge and thus not destroying the structure of the matrix material
Embossed brand name in tray reduces need to spend additional time on writing labels for sterile field documentation
Dwelling for easier handling of the sponge
Bevelled edges to ensure that e.g. the saline volume stays inside the tray thus not dripping onto the sterile field
Bevelled edges or other indication as a guiding tool for maximum amount of moisture to add

In one embodiment addition of liquid to the container results in that the liquid/moisture is evenly distributed throughout the matrix material. The even distribution of liquid/moisture can be obtained by manual massage of the matrix material (e.g. with the fingers).

In one embodiment the liquid added to the container does not cover the matrix material before and/or after the absorption of liquid into the matrix material. In one embodiment the liquid added to the matrix material in the container reaches from ½-⅔ of the height from the bottom of the inner tray to the mark for maximum filling of the tray before absorption of liquid into the matrix material.

In one embodiment the liquid added to the matrix material in the container reaches from 10% to 100% of the height from the bottom of the inner tray to the mark for maximum filling of the tray before absorption of liquid into the matrix material, such as from 10% to 12%, for example from 12% to 14%, such as from 14% to 16%, for example from 16% to 18%, such as from 18% to 20%, for example from 20% to 22%, such as from 22% to 24%, for example from 24% to 26%, such as from 26% to 28%, for example from 28% to 30%, such as from 30% to 32%, for example from 32% to 34%, such as from 34% to 36%, for example from 36% to 38%, such as from 38% to 40%, for example from 40% to 42%, such as from 42% to 44%, for example from 44% to 46%, such as from 46% to 48%, for example from 48% to 50%, such as from 50% to 52%, for example from 52% to 54%, such as from 54% to 56%, for example from 56% to 58%, such as from 58% to 60%, for example from 60% to 62%, such as from 62% to 64%, for example from 64% to 66%, such as from 66% to 68%, for example from 68% to 70%, such as from 70% to 72%, for example from 72% to 74%, such as from 74% to 76%, for example from 76% to 78%, such as from 78% to 80%, for example from 80% to 82%, such as from 82% to 84%, for example from 84% to 86%, such as from 86% to 88%, for example from 88% to 90%, such as from 90% to 92%, for example from 92% to 94%, such as from 94% to 96%, for example from 96% to 98%, such as from 98% to 100% of the height from the bottom of the inner tray to the mark for maximum filling.

In one embodiment the liquid added to the matrix material in the container reaches from 10% to 100% of the height from the bottom of the inner tray to the mark for maximum filling of the tray after absorption of liquid into the matrix material, such as from 10% to 12%, for example from 12% to 14%, such as from 14% to 16%, for example from 16% to 18%, such as from 18% to 20%, for example from 20% to 22%, such as from 22% to 24%, for example from 24% to 26%, such as from 26% to 28%, for example from 28% to 30%, such as from 30% to 32%, for example from 32% to 34%, such as from 34% to 36%, for example from 36% to 38%, such as from 38% to 40%, for example from 40% to 42%, such as from 42% to 44%, for example from 44% to 46%, such as from 46% to 48%, for example from 48% to 50%, such as from 50% to 52%, for example from 52% to 54%, such as from 54% to 56%, for example from 56% to 58%, such as from 58% to 60%, for example from 60% to 62%, such as from 62% to 64%, for example from 64% to 66%, such as from 66% to 68%, for example from 68% to 70%, such as from 70% to 72%, for example from 72% to 74%, such as from 74% to 76%, for example from 76% to 78%, such as from 78% to 80%, for example from 80% to 82%, such as from 82% to 84%, for example from 84% to 86%, such as from 86% to 88%, for example from 88% to 90%, such as from 90% to 92%, for example from 92% to 94%, such as from 94% to 96%, for example from 96% to 98%, such as from 98% to 100% of the height from the bottom of the inner tray to the mark for maximum filling.

The mark for maximum filling of the inner tray helps to ensure that too much liquid can not be added to the matrix material in the container. If too much liquid has been added to the matrix material in the container, the liquid that remains in the tray after absorption of liquid into the matrix material will comprise the pharmaceutical composition from the matrix material (e.g. Thrombin).

One advantage of using a matrix material with added liquid is that the matrix material becomes more mouldable and softer than a dry matrix material.

In one embodiment the pharmaceutical composition such as Thrombin is only applied e.g. by ultrasonic spray technology on one or more of the surfaces of the matrix material. In one embodiment the pharmaceutical composition such as Thrombin is applied throughout the matrix matrial. However, after liquid has been added to the matrix material and after absorption of liquid into the matrix material has occurred—the pharmaceutical composition such as Thrombin will often be distributed thoughout the matrix material.

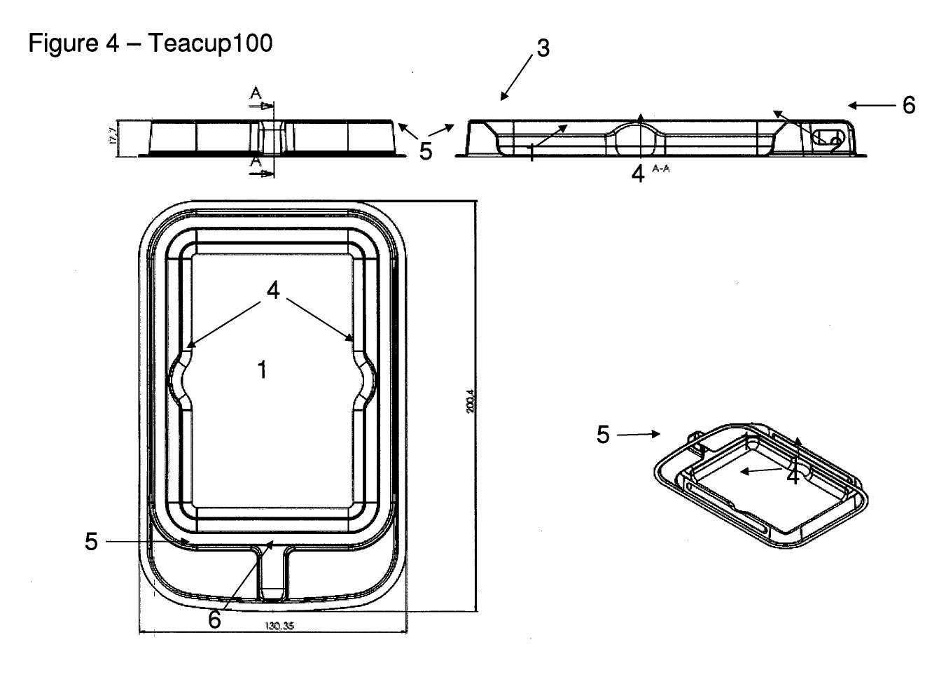

In one preferred embodiment the container with the matrix material according to the present invention has the shape and size shown in FIG. 4—termed Teacup100. Teacup100 is made for addition of a volume of liquid of maximum 20 mL.

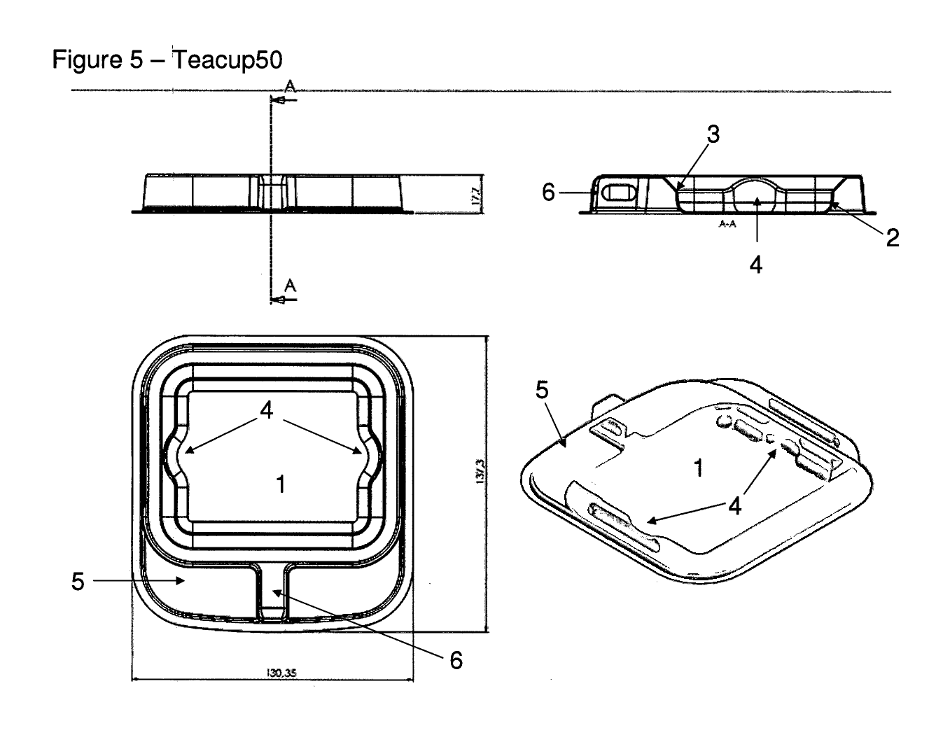

In one preferred embodiment the container with the matrix material according to the present invention has the shape and size shown in FIG. 5—termed Teacup50. Teacup50 is made for addition of a volume of liquid of maximum 10 mL.

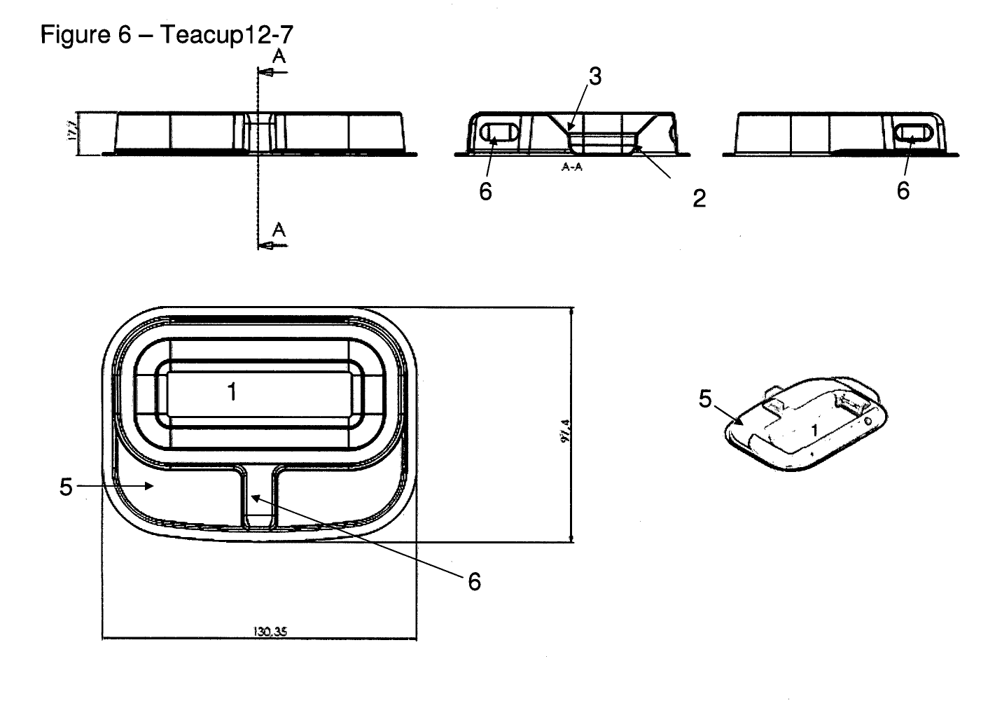

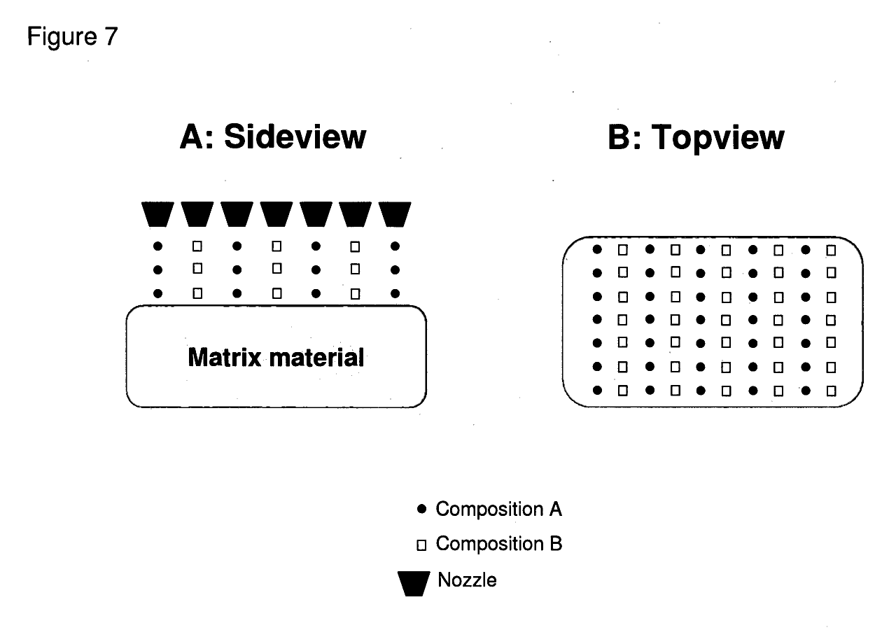

In one preferred embodiment the container with the matrix material according to the present invention has the shape and size shown in FIG. 6-termed Teacup12-7. Teacup12-7 is made for addition of a volume of liquid of maximum 2 mL.

The liquid to be added to the container used for wetting the matrix material may be selected from the group consisting of an aqueous solution; a saline solution such as NaCl 0.9% (normal saline); medical-grade water; water for injection; water for irrigation; saline for injection; saline for irrigation; an antibiotic solution comprising an antibiotic selected from those listed in Table 5 above including penicillins, cephalosporins, tetracyclines, ampiciflin, aureothicin, bacitracin, chloramphenicol, cycloserine, erythromycin, gentamicin, gramacidins, kanamycins, neomycins, streptomycins, tobramycin, and vancomycin; an anaesthetic solution comprising a local anaesthetic selected from Lidocaine/prilocalne (EMLA), Articaine, Bupivacaine, Carticaine, Cinchocaine/Dibucaine, Etidocaine, Levobupivacaine, Lidocaine/Lignocaine, Mepivacaine, Piperocaine, Prilocalne, Ropivacaine, Trimecaine, Benzocaine, Chloroprocaine, Cocaine, Cyclomethycaine, Dimethocaine/Larocaine, Propoxycaine, Procaine/Novocaine, Proparacaine, Tetracaine/Amethocaine; a solution comprising adrenaline (epinephrine), and others.

### A Kit of Parts

The present invention also relates to a kit of parts and use of said kit of parts. In one embodiment the kit of parts comprises a matrix material as described elsewhere herein such as a matrix material coated with one or more pharmaceutical compositions by ultrasonic spray technology or a matrix material coated with thrombin by ultrasonic spray technology. In one embodiment the kit of parts comprises the container for storage of a matrix material as described herein above.

The kit of parts can be used to apply a matrix material e.g. a matrix material comprising thrombin such as a matrix material with thrombin applied by ultrasonic spray technology onto one or more surfaces of the matrix material onto an injured portion of a mammalian body such a wound on a human being.

The kit of parts can be used to treat a wound, to accelerate or promote hemostasis or accelerate or promote wound healing in an individual in need thereof. The kit of parts comprising the container and a matrix material comprising a pharmaceutical composition such as thrombin provides a sterile storage of said matrix material. The appropriate medical personnel decide which pharmaceutical composition is appropriate for the wound in question.

The container is opened either completely or partly by removement of the lid e.g. by cutting, peeling or tearing of the lid from the lid sealing surface. The matrix material can then optionally be removed and cut into pieces of relevant size(s) and be placed in the container again. A predetermined volume of liquid/moisture such as water or saline is added to the container e.g. up to the mark on the one or more sidewalls. After absorption of liquid into the matrix material, the matrix material is placed on the wound. Alternatively, the matrix material can be cut into pieces of relevant sizes after liquid has been added to the matrix material.

### Combination Therapy

The fluid or liquid composition according to the present invention may contain substances selected form the group consisting of hemostatic or anti-fibrinolytic agents, wound healing agents, adhesive agents and surfactants, as disclosed above.

In a preferred embodiment of the invention, the pharmaceutical composition according to the present invention may comprise more than one agent, selected from tables 1 to 4.

Thus, the composition may comprise more than 1, such as 2, for example 3, such as 4, for example 5, such as 6, for example 7, such as 8 different agents selected from tables 1 to 4. Table 1 comprises examples of hemostatic or anti-fibrinolytic agents; table 2 comprises examples of wound healing agents; table 3 comprises examples of adhesive agents and table 4 comprises examples of surfactants.

In one embodiment, the composition comprises at least 1, such as 2, for example 3, such as 4, for example 5, such as 6, for example 7, such as 8 different agents selected from table 1, further comprising at least 1, such as 2, for example 3, such as 4, for example 5, such as 6, for example 7, such as 8 different agents selected from table 2.

In one embodiment, the composition comprises at least 1, such as 2, for example 3, such as 4, for example 5, such as 6, for example 7, such as 8 different agents selected from table 1, further comprising at least 1, such as 2, for example 3, such as 4, for example 5, such as 6, for example 7, such as 8 different agents selected from table 3.

In one embodiment, the composition comprises at least 1, such as 2, for example 3, such as 4, for example 5, such as 6, for example 7, such as 8 different agents selected from table 1, further comprising at least 1, such as 2, for example 3, such as 4, for example 5, such as 6, for example 7, such as 8 different agents selected from table 4.

In one embodiment, the composition comprises at least 1, such as 2, for example 3, such as 4, for example 5, such as 6, for example 7, such as 8 different agents selected from table 2, further comprising at least 1, such as 2, for example 3, such as 4, for example 5, such as 6, for example 7, such as 8 different agents selected from table 3.

In one embodiment, the composition comprises at least 1, such as 2, for example 3, such as 4, for example 5, such as 6, for example 7, such as 8 different agents selected from table 2, further comprising at least 1, such as 2, for example 3, such as 4, for example 5, such as 6, for example 7, such as 8 different agents selected from table 4.

In one embodiment, the composition comprises at least 1, such as 2, for example 3, such as 4, for example 5, such as 6, for example 7, such as 8 different agents selected from table 1, further comprising at least 1, such as 2, for example 3, such as 4, for example 5, such as 6, for example 7, such as 8 different agents selected from table 2, still further comprising at least 1, such as 2, for example 3, such as 4, for example 5, such as 6, for example 7, such as 8 different agents selected from table 3.

In one embodiment, the composition comprises at least 1, such as 2, for example 3, such as 4, for example 5, such as 6, for example 7, such as 8 different agents selected from table 1, further comprising at least 1, such as 2, for example 3, such as 4, for example 5, such as 6, for example 7, such as 8 different agents selected from table 2, still further comprising at least 1, such as 2, for example 3, such as 4, for example 5, such as 6, for example 7, such as 8 different agents selected from table 4.

In one embodiment, the composition comprises at least 1, such as 2, for example 3, such as 4, for example 5, such as 6, for example 7, such as 8 different agents selected from table 1, further comprising at least 1, such as 2, for example 3, such as 4, for example 5, such as 6, for example 7, such as 8 different agents selected from table 2, further comprising at least 1, such as 2, for example 3, such as 4, for example 5, such as 6, for example 7, such as 8 different agents selected from table 3, and also further comprising at least 1, such as 2, for example 3, such as 4, for example 5, such as 6, for example 7, such as 8 different agents selected from table 4.

According to the preferred embodiments cited here above, agents may be administered onto the matrix of the device of the invention by ultrasonic spray technology, by applying a pharmaceutical composition containing agents from either 1, 2, 3 or 4 classes of agents, as cited in tables 1 to 4.

### Items

The present invention is in one embodiment characterized by one or more of the items in item set number 1 herein below.

### Item Set Number 1:

1. A matrix material comprising a surface and a plurality of open and interconnected cells, wherein the surface of said matrix comprises at least one pharmaceutical composition applied by ultrasonic spray technology onto said surface.
2. The matrix material according to item 1, wherein the matrix comprises one or more polymers.
3. The matrix material according to item 2, wherein said polymers are cross-linked.
4. The matrix material according to item 2, wherein said polymers are not cross-linked.
5. The matrix material according to item 2, wherein said polymers are selected from the group consisting of collagen, gelatin, polyurethane, polysiloxanes (silicone), hydrogels, polyacrylamides, chitosan, sodium polyacrylate, agarose, alginates, xanthan gum, guar gum, arabic gum, agar gum, Locust Bean gum, Carrageenan gum, Xanthan gum, Karaya gum, tragacanth gum, Ghatti gum, Furcelleran gum, chitin, cellulose, methylcellulose, carboxymethyl cellulose, hydroxymethyl cellulose, hydroxypropyl methylcellulose, hydroxypropyl cellulose, hyaluronic acid, pectin, starch, glycogen, pentosans, polyoxyethylene, polyAMPS (poly(2-acrylamido-2-methyl-1-propanesulfonic acid), polyvinylpyrrolidone, polyvinyl alcohol, polyglycolic acid, polyacetic acid, acrylate polymers, polyhydroxyalkyl acrylates, methacrylates, polyvinyl lactams, polyvinyl alcohols, polyoxyalkylenes, polyacrylamides, polyacrylic acid, polystyrene sulfonates, synthetic hydrocolloids such as N-vinyl-2-pyrrolidone, 5-methyl-N-vinyl-2-pyrrolidone, 5-ethyl-N-vinyl-2-pyrrolidone, 3,3-dimethyl-N-vinyl-2-pyrrolidone, 3-methyl-N-vinyl-2-pyrrolidone, 3-ethyl-N-vinyl-2-pyrrolidone, 4-methyl-N-vinyl-2-pyrrolidone, 4-ethyl-N-vinyl-2-pyrrolidone, N-vinyl-2-valerolactam, N-vinyl-2-caprolactam, hydroxyalkyl acrylates and methacrylates, (such as 2-hydroxyethyl acrylate, 2-hydroxyethyl methacrylate, 2-hydroxypropyl acrylate, 2-hydroxypropyl methacrylate, 2,3-dihydroxypropyl methacrylate), acrylic acid, methacrylic acid, tertiary amino-methacrylimide, (e.g. trimethylamino-methacrylimide), crotonic acid, pyridine, water soluble amides, (such as N-(hydroxymethyl)acrylamide and -methacrylamide, N-(3-hydroxpropyl)acrylamide, N-(2-hydroxyethyl) methacrylamide, N-(1,1-dimethyl-3-oxabutyl)acrylamide N-[2-(dimethylamine)ethyl]acrylamide and -methacrylamide, N-[3-(dimethylamino)-2-hydroxylpropyl]methacrylamide, and N-[1,1-dimethyl-2-(hydroxymethyl)-3-oxabutyl]acrylamide); water-soluble hydrazine derivatives, (such as trialkylamine methacrylimide, and dimethyl-(2-hydroxypropyl)amine methacrylimide); mono-olefinic sulfonic acids and their salts, (such as sodium ethylene sulfonate, sodium styrene sulfonate, 2-acrylamideo-2-methylpropanesulfonic acid), 1-vinyl-imidazole, 1-vinyl-indole, 2-vinyl imidazole, 4(5)-vinyl-imidazole, 2-vinyl-1-methyl-imidazole, 5-vinyl-pyrazoline, 3-methyl-5-isopropenyl-pyrazole, 5-methylene-hydantoin, 3-vinyl-2-oxazolidone, 3-methacrylyl-2-oxazolidone, 3-methacrylyl-5-methyl-2-oxazolidone, 3-vinyl-5-methyl-2-oxazolidone, 2- and 4-vinyl-pyridine, 5-vinyl-2-methyl-pyridine, 2-vinyl-pyridine-1-oxide, 3-isopropenyl-pyridine, 2- and 4-vinyl-piperidine, 2- and 4-vinyl-quinoline, 2,4-dimethyl-6-vinyl-s-triazine, 4-acrylyl-morpholine, Oxidized Regenerated Cellulose (ORC), poly(lactic-co-glycolic acid) (PLGA), Polylactic acid (PLA), Extracellular matrix (ECM), and mixtures thereof.
6. The matrix material according to item 2, wherein the polymers originates from an animal source such as porcine, bovine or fish sources.
7. The matrix material according to item 2, wherein the polymers are synthetically made i.e. by recombinant means.
8. The matrix material according to item 2, wherein the polymers are selected from collagen and gelatin.
9. The matrix material according to item 2, wherein the polymers comprise gelatin.
10. The matrix material according to item 2, wherein the polymers comprise collagen.
11. The matrix material according to item 1, wherein the interconnected open cells form pores having a diameter of from about 0.1 mm to about 5.0 mm.
12. The matrix material according to item 1, wherein the matrix has the dimensions (length, width and height) of less than 15 cm long, less than 10 cm wide and less than 2 cm high.
13. The matrix material according to item 1, wherein the matrix is a shape selected from the group consisting of square form, circular form, rectangular form, cubic form, cylinder form, spherical or pyramid-shaped.
14. The matrix material according to item 1, wherein the matrix has a colour selected from the group consisting of red, pink, yellow, blue, green, white, black, brown, purple, orange, grey and turquoise.
15. The matrix material according to item 1, wherein the matrix material has a reconformation rate of no more than 10 seconds, such as no more than 9 seconds, for example no more than 8 seconds, such as no more than 7 seconds, for example no more than 6 seconds, such as no more than 5 seconds, for example no more than 4 seconds, such as no more than 3 seconds, for example no more than 3 seconds, such as no more than 1 second.
16. The matrix material according to item 1, wherein the matrix material has a pore size with a normal distribution around 0.1-1.0 mm.
17. The matrix material according to item 1, wherein the matrix material has a pore size of less than 10 mm, such as less than 9 mm, for example less than 8 mm, such as less than 7 mm, for example less than 6 mm, such as less than 5 mm, for example less than 4 mm, such as less than 3 mm, for example less than 2.9 mm, such as less than 2.8 mm, for example less than 2.7 mm, such as less than 2.6 mm, for example less than 2.5 mm, such as less than 2.4 mm, for example less than 2.3 mm, such as less than 2.2 mm, for example less than 2.1 mm, such as less than 2 mm, for example less than 1.9 mm, such as less than 1.8 mm, for example less than 1.7 mm, such as less than 1.6 mm, for example less than 1.5 mm, such as less than 1.4 mm, for example less than 1.3 mm, such as less than 1.2 mm, for example less than 1.1 mm, such as less than 1.0 mm, for example less than 0.9 mm, such as less than 0.8 mm, for example less than 0.7 mm, such as less than 0.6 mm, for example less than 0.5 mm, such as less than 0.4 mm, for example less than 0.3 mm, such as less than 0.2 mm, for example less than 0.1 mm, such as less tan 0.05, for example less than 0.01 mm.
18. The matrix material according to item 1, wherein the matrix material has a pore size in the range of 0.01-0.1 mm, such as 0.1-0.2 mm, for example 0.2-0.3 mm, such as 0.3-0.4 mm, for example 0.4-0.5 mm, such as 0.5-0.6 mm, for example 0.6-0.7 mm, such as 0.7-0.8 mm, for example 0.8-0.9 mm, such as 0.9-1 mm, for example 1-1.1 mm, such as 1.1-1.2 mm, for example 1.2-1.3 mm, such as 1.3-1.4 mm, for example 1.4-1.5 mm, such as 1.5-1.6 mm, for example 1.6-1.7 mm, such as 1.-1.8 mm, for example 1.8-1.9 mm, such as 2-2.1 mm, for example 2.1-2.2 mm, such as 2.2-2.3 mm, for example 2.3-2.4 mm, such as 2.4-2.5 mm, for example 2.5-2.6 mm, such as 2.6-2.7 mm, for example 2.7-2.8 mm, such as 2.8-2.9 mm, for example 2.9-3 mm, such as 3-4 mm, for example 4-5 mm, such as 5-6 mm, for example 6-7 mm, such as 7-8 mm, for example 8-9 mm, such as 9-10 mm.
19. The matrix material according to item 1, wherein the matrix material has a modulus in the range of 0.1-50 GPa, such as 0.1-1, for example 1-2, such as 2-3, such as 3-4, for example 4-5, such as 5-6, for example, 6-7, such as 7-8, for example 8-9, such as 9-10, for example 10-20, such as 20-30, for example 30-40, such as 40-50 GPa.
20. The matrix material according to item 1, wherein the surface of the matrix contains less than 100 IU/cm², such as less than 95, for example less than 90, such as 85, for example less than 80, such as less than 75, for example less than 70, such as 65, for example less than 60, such as less than 55, for example less than 50, such as 45, for example less than 40, such as less than 35, for example less than 30, such as 25, for example less than 20, such as less than 15, for example less than 10, such as 5, for example less than 1 IU/cm² of the pharmaceutical composition.
21. The matrix material according to item 1, wherein the surface of the matrix contains between 1-5 IU/cm², such as 5-10, for example 10-15, such as 15-20, for example 20-25, such as 25-30, for example 30-35, such as 35-40, for example 40-45, such as 45-50, for example 50-55, such as 55-60, for example 60-65, such as 65-70, for example 70-75, such as 75-80, for example 80-85, such as 85-90, for example 90-95, such as 95-100 IU/cm² of the pharmaceutical composition.
22. The matrix material according to item 1, wherein the matrix material is a sponge.
23. The matrix material according to item 22, wherein the sponge is a gelatin or collagen sponge.
24. The matrix material according to item 23, wherein the gelatin or collagen sponge is selected from the group consisting of Spongostan, Surgifoam, Surgiflo (all Ferrosan NS), Collastat (Kendall Co.), Avitene (Avicon Inc.), Surgicel, Surgifoam (both Johnson & Johnson) and Gelfoam (Phizer).
25. The matrix material according to item 1, wherein the matrix material is a patch.
26. The matrix material according to item 1, wherein the matrix material is a swab.
27. The matrix material according to item 1, wherein the matrix material is a bandage.
28. The matrix material according to item 1, wherein the matrix material is a wound dressing.
29. The matrix material according to item 1, wherein the matrix material is a tissue dressing.
30. The matrix material according to item 1, wherein the matrix material is sterile.
31. The matrix material according to item 1, wherein the matrix material is sterile and contained in a sterile, pre-packaged, ready-to-use container.
32. The matrix material according to item 1, wherein the matrix material is sterilized.
33. The matrix material according to item 1, wherein the matrix material is sterilized by application of heat.
34. The matrix material according to item 1, wherein the matrix material is sterilized by application of one or more chemicals.
35. The matrix material according to item 1, wherein the matrix material is sterilized by application of high pressure.
36. The matrix material according to item 1, wherein the matrix material is sterilized by application of filtration.
37. The matrix material according to item 1, wherein the matrix material is sterilized by application of autoclaving.
38. The matrix material according to item 1, wherein the matrix material is sterilized by application of radiation sterilization such as sterilization using X-rays, gamma rays, UV light and/or subatomic particles.
39. The matrix material according to item 1, wherein the matrix material is sterilized by application of chemical sterilization include use of one or more of the chemicals selected from the group consisting of ethylene oxide gas, ozone, chlorine bleach, glutaraldehyde, formaldehyde, ortho phthalaldehyde, hydrogen peroxide and peracetic acid.
40. The matrix material according to item 30, wherein the matrix material is contained in a sterile container and separated from an external, non-sterile environment.
41. The matrix material according to item 1, wherein the pharmaceutical composition comprises one or more bioactive agent(s).
42. The pharmaceutical composition according to item 41, wherein said bioactive agent is of a concentration in the range of 1 IU/ml to 1,000,000 IU/ml; such as 1-10 IU/ml, for example 10-50 IU/ml, such as 50-100 IU/ml, for example 100-150 IU/ml, such as 150-200 IU/ml, for example 200-250 IU/ml, such as 250-300 IU/ml, for example 300-350 IU/ml, such as 350-400 IU/ml, for example 400-450 IU/ml, such as 450-500 IU/ml, for example 500-750 IU/ml, such as 750-1000 IU/ml, for example 1000-1500 IU/ml, such as 1500-2000 IU/ml, for example 2000-2500 IU/ml, such as 2500-3000 IU/ml, for example 3000-3500 IU/ml, such as 3500-4000 IU/ml, for example 4000-4500 IU/ml, such as 4500-5000 IU/ml, for example 5000-5500 IU/ml, such as 5500-6000 IU/ml, for example 6000-6500 IU/ml, such as 6500-7000 IU/ml, for example 7000-7500 IU/ml, such as 7500-8000 IU/ml, for example 8000-8500 IU/ml, such as 8500-9000 IU/ml, for example 9000-9500 IU/ml, such as 9500-10,000 IU/ml, for example 10,000-11,000 IU/ml, such as 11,000-12,000 IU/ml, for example 12,000-13,000 IU/ml, such as 13,000-14,000 IU/ml, for example 14,000-15,000 IU/ml, such as 15,000-16,000 IU/ml, for example 16,000-17,000 IU/ml, such as 17,000-18,000 IU/ml, for example 18,000-19,000 IU/ml, such as 19,000-20,000 IU/ml, for example 20,000-25,000 IU/ml, such as 25,000-30,000 IU/ml, for example 30,000-35,000 IU/ml, such as 35,000-40,000 IU/ml, for example 40,000-45,000 IU/ml, such as 45,000-50,000 IU/ml, for example 50,000-55,000 IU/ml, such as 55,000-60,000 IU/ml, for example 60,000-65,000 IU/ml, such as 65,000-70,000 IU/ml, for example 70,000-75,000 IU/ml, such as 75,000-80,000 IU/ml, for example 80,000-85,000 IU/ml, such as 85,000-90,000 IU/ml, for example 90,000-95,000 IU/ml, such as 95,000-100,000 IU/ml, for example 100,000-150,000 IU/ml, such as 150,000-200,000 IU/ml, for example 200,000-250,000 IU/ml, such as 250,000-300,000 IU/ml, for example 300,000-350,000 IU/ml, such as 350,000-400,000 IU/ml, for example 400,000-450,000 IU/ml, such as 450,000-500,000 IU/ml, for example 500,000-550,000 IU/ml, such as 550,000-600,000 IU/ml, for example 600,000-650,000 IU/ml, such as 650,000-700,000 IU/ml, for example 700,000-750,000 IU/ml, such as 750,000-800,000 IU/ml, for example 800,000-850,000 IU/ml, such as 850,000-900,000 IU/ml, for example 900,000-950,000 IU/ml, such as 950,000-1,000,000 IU/ml.
43. The pharmaceutical composition according to item 41, wherein said bioactive agent is of a concentration in the range of 1 ng/ml to 1,000,000 mg/ml; such as 1-10 ng/ml, for example 10-100 ng/ml, such as 100-200 ng/ml, for example 300-400 ng/ml, such as 400-500 ng/ml, for example 500-600 ng/ml, such as 600-700 ng/ml, for example 700-800 ng/ml, such as 800-900 ng/ml, for example 900-1000 ng/ml, such as 1-10 ug/ml, for example 10-100 ug/ml, such as 100-200 ug/ml, for example 200-300 ug/ml, such as 300-400 ug/ml, for example 400-500 ug/ml, such as 500-600 ug/ml, for example 600-700 ug/ml, such as 700-800 ug/ml, for example 800-900 ug/ml, such as 900-1000 ug/ml, for example 1-10 mg/ml, such as 10-100 mg/ml, for example 100-200 mg/ml, such as 200-300 mg/ml, for example 300-400 mg/ml, such as 400-500 mg/ml, for example 500-600 mg/ml, such as 600-700 mg/ml, for example 700-800 mg/ml, such as 800-900 mg/ml, for example 900-1000 mg/ml, such as 1000-2000 mg/ml, for example 2000-3000 mg/ml, such as 3000-4000 mg/ml, for example 4000-5000 mg/ml, such as 5000-6000 mg/ml, for example 6000-7000 mg/ml, such as 7000-8000 mg/ml, for example 8000-9000 mg/ml, such as 9000-10,000 mg/ml, for example 10,000-20,000 mg/ml, such as 20,000-30,000 mg/ml, for example 30,000-40,000 mg/ml, such as 40,000-50,000 mg/ml, for example 50,000-60,000 mg/ml, such as 60,000-70,000 mg/ml, for example 70,000-80,000 mg/ml, such as 80,000-90,000 mg/ml, for example 90,000-100,000 mg/ml, such as 100,000-200,000 mg/ml, for example 200,000-300,000 mg/ml, such as 300,000-400,000 mg/ml, for example 400,000-500,000 mg/ml, such as 500,000-600,000 mg/ml, for example 600,000-700,000 mg/ml, such as 700,000-800,000 mg/ml, for example 800,000-900,000 mg/ml, such as 900,000-1,000,000 mg/ml.
44. The matrix material according to item 41, wherein the concentration of the bioactive agent of any two droplets expelled from a nozzle assembly head vary less that 10%, such as less than 8%, for example less than 6%, such as less than 4%, for example less than 2%, such as less than 1%.
45. The matrix material according to item 44, wherein the concentration of the bioactive agent of any two droplets is essentially identical.
46. The matrix material according to item 1, wherein the pharmaceutical composition comprises one or more bioactive agent(s) that stimulates hemostasis.
47. The matrix material according to item 1, wherein the pharmaceutical composition comprises one or more bioactive agent(s) that stimulates wound healing.
48. The matrix material according to item 1, wherein the pharmaceutical composition comprises one or more bioactive agent(s) that stimulates wound healing by inhibition of one or more infections of the wound.
49. The matrix material according to item 1, wherein the pharmaceutical composition comprises one or more bioactive agent(s) which comprises one or more anti-fibrinolytic agents.
50. The matrix material according to item 1, wherein the pharmaceutical composition comprises one or more bioactive agent(s) which comprises one or more pro-coagulants.
51. The matrix material according to item 1, wherein the pharmaceutical composition comprises one or more bioactive agent(s) that stimulates platelets.
52. The matrix material according to item 1, wherein the pharmaceutical composition comprises one or more bioactive agent(s) that stimulate formation of a hemostatic plug.
53. The matrix material according to item 1, wherein the pharmaceutical composition comprises one or more bioactive agent(s) that stimulates one or more coagulation factors.
54. The matrix material according to item 1, wherein the pharmaceutical composition comprises one or more bioactive agent(s) selected from the group consisting of endothelium Tissue Factor (TF), Factor VII, TF-Factor Vila, Factor IX, Factor X, thrombin, Factor XIa, plasmin, Factor XII, Factor Xa, TFPI, Factor Va, prothrombinase complex, prothrombin, Factor V, Factor XI, Factor VIII, vWF, Factor VIIIa, Factor IXa and the tenase complex.
55. The matrix material according to item 1, wherein the pharmaceutical composition comprises one or more bioactive agent(s) that stimulates the formation of fibrin strands.
56. The matrix material according to item 1, wherein the pharmaceutical composition comprises one or more bioactive agent(s) that stimulates platelate aggregation.
57. The matrix material according to item 1, wherein the pharmaceutical composition comprises one or more bioactive agent(s) which comprises thrombin.
58. The matrix material according to items 1 and 57, wherein the pharmaceutical composition comprises one or more bioactive agent(s) which comprises fibrinogen.
59. The matrix material according to items 1 and 57, wherein the pharmaceutical composition comprises one or more bioactive agent(s) which comprises Factor XIII and/or XIIIa.
60. The matrix material according to items 1 and 57, wherein the pharmaceutical composition comprises one or more bioactive agent(s) which comprises tranexamic acid.
61. The matrix material according to items 1 and 57, wherein the pharmaceutical composition comprises one or more bioactive agent(s) which comprises Willebrand factor (vWF).
62. The matrix material according to item 1, wherein the pharmaceutical composition comprises one or more bioactive agent(s) that stimulates the contact activation pathway.
63. The matrix material according to item 1, wherein the pharmaceutical composition comprises one or more bioactive agent(s) that stimulates the tissue factor pathway.
64. The matrix material according to item 1, wherein the pharmaceutical composition comprises one or more bioactive agent(s) that stimulates fibrin formation.
65. The matrix material according to item 1, wherein the pharmaceutical composition comprises one or more bioactive agent(s) that stimulates fibrin cross-linking.
66. The matrix material according to item 1, wherein the pharmaceutical composition comprises one or more bioactive agent(s) which comprises Factor VIII.
67. The matrix material according to item 1, wherein the pharmaceutical composition comprises one or more bioactive agent(s) which comprises Factor V.
68. The matrix material according to item 1, wherein the pharmaceutical composition comprises one or more bioactive agent(s) which comprises Factor XIII.
69. The matrix material according to item 1, wherein the pharmaceutical composition comprises one or more bioactive agent(s) which comprises Factor VII.
70. The matrix material according to item 1, wherein the pharmaceutical composition comprises one or more bioactive agent(s) which stimulates the coagulation cascade.
71. The matrix material according to item 1, wherein the pharmaceutical composition comprises thrombin.
72. The matrix material according to item 71, wherein the matrix contains less than 300 IU thrombin per square cm (cm²) surface area, such as less than 290, for example less than 280, such as 270, for example less than 260, such as less than 250, for example less than 240, such as 230, for example less than 220, such as less than 210, for example less than 200, such as 190, for example less than 180, such as less than 170, for example less than 160, such as 150, for example less than 140, such as less than 130, for example less than 120, such as 110, for example less than 100 IU/cm², such as less than 95, for example less than 90, such as 85, for example less than 80, such as less than 75, for example less than 70, such as 65, for example less than 60, such as less than 55, for example less than 50, such as 45, for example less than 40, such as less than 35, for example less than 30, such as 25, for example less than 20, such as less than 15, for example less than 10, such as 5, for example less than 1 IU/cm².
73. The matrix material according to item 71, wherein the surface of the matrix contains from 1 IU/cm² to 300 IU/cm² of thrombin, for example 1-5 IU/cm² thrombin, such as 5-10 IU/cm², for example 10-15 IU/cm², such as 15-20 IU/cm², for example 20-25 IU/cm², such as 25-30 IU/cm², for example 30-35 IU/cm², such as 35-40 IU/cm², for example 40-45 IU/cm², such as 45-50 IU/cm², for example 50-55 IU/cm², such as 55-60 IU/cm², for example 60-65 IU/cm², such as 65-70 IU/cm², for example 70-75 IU/cm², such as 75-80 IU/cm², for example 80-85 IU/cm², such as 85-90 IU/cm², for example 90-95 IU/cm², such as 95-100 IU/cm², for example 100-110 IU/cm², such as 110-120 IU/cm², for example 120-130 IU/cm², such as 130-140 IU/cm², for example 140-150 IU/cm², such as 150-160

IU/cm², for example 160-170 IU/cm², such as 170-180 IU/cm², for example 180-190 IU/cm², such as 190-200 IU/cm², for example 200-210 IU/cm², such as 210-220 IU/cm², for example 220-230 IU/cm², such as 230-240 IU/cm², for example 240-250 IU/cm², such as 250-260 IU/cm², for example 260-270 IU/cm², such as 270-280 IU/cm², for example 280-290 IU/cm², such as 290-300 IU/cm².
74. The matrix material according to item 1, wherein the pharmaceutical composition is applied by ultrasonic spray technology onto the surface of the matrix material by deposition of an amount of liquid per position of less than 100 nL, such as less than 90 nL, for example less than 80 nL, such as less than 70 nL, for example less than 60 nL, such as less than 50 nL, for example less than 40 nL, such as less than 30 nL, for example less than 20 nL, such as less than 10 nL, for example less than 1 nL or 1000 pL, such as less than 900 pL, for example less than 800 pL, such as less than 700 pL, for example less than 600 pL, such as less than 500 pL, for example less than 400 pL, such as less than 300 pL, for example less than 250 pL, such as less than 200 pL, for example less than 150 pL, such as less than 100 pL, for example less than 90 pL, such as less than 80 pL, for example less than 70 pL, such as less than 60 pL, for example less than 50 pL, such as less than 40 pL, for example less than 30 pL, such as less than 20 pL, for example less than 10 pL, such as less than 9 pL, for example less than 8 pL, such as less than 7 pL, for example less than 6 pL, such as less than 5 pL, for example less than 4 pL, such as less than 3 pL, for example less than 2 pL, such as less than 1 pL per position.
75. The matrix material according to item 1, wherein the pharmaceutical composition is applied by ultrasonic spray technology onto the surface of the matrix material by deposition of an amount of liquid per position in pico litre (pL) to nano litre (nL) range, such as 1-10 pL, for example 10-20 pL, such as 20-30 pL, for example 30-40 pL, such as 40-50 pL, for example 50-60 pL, such as 60-70 pL, for example 70-80 pL, such as 80-90 pL, for example 100-150 pL, such as 150-200 pL, for example 200-250 pL, such as 250-300 pL, for example 300-400 pL, such as 400-500 pL, for example 500-600 pL, such as 600-700 pL, for example 700-800 pL, such as 800-900 pL, for example 900-1000 pL or 1 nL, such as 1-10 nL, for example 10-20 nL, such as 20-30 nL, for example 30-40 nL, such as 40-50 nL, for example 50-60 nL, such as 60-70 nL, for example 70-80 nL, such as 80-90 mL, for example 90-100 nL.
76. The matrix material according to item 1, wherein the pharmaceutical composition comprises one or more adhesive agents.
77. The matrix material according to item 76, wherein the one or more adhesive agents can be selected from the group consisting of saccharides, monosaccharides, disaccharides, oligosaccharides, polysaccharides, glucose, mannose, fructose, threose, gulose, arabinose, ribose, erythrose, lyxose, galactose, sorbose, altrose, tallose, idose, rhamnose, allose, pentosamines, hexosamines, glucosamine, N-acetylglucosamine, glucoronic acid, sucrose, maltose, lactose, cellubiose, glycogen, chitin, chitosan, starch, potato starch, glycosaminoglycans, chondroitin, chondroitin sulfate, hyaluronic acid, dermatan sulphate, keratan sulphate, aminated dextrans, DEAE-dextran, aminated starch, aminated glycogen, aminated cellulose, aminated pectin, and salts, complexes, derivatives and mixtures thereof.
78. The matrix material according to item 76, wherein the one or more adhesive agents can be selected from the group consisting of hydrocarbon resins, rosin resins, terpene resins, Escorez® from ExxonMobil; Regalite®, Piccotac® and Picco® from Eastman; Indopol® from BP or Arkon®, esters of hydrogenated wood rosin, pentaerythritol ester of hydrogenated wood rosin, esters of partially hydrogenated wood rosin, pentaerythritol esters of partially hydrogenated wood rosin, esters of wood rosin, esters of modified wood rosin, esters of partially dimerized rosin, esters of tall oil rosin, esters of dimerized rosin, Foral®, Foralyn®, Pentalyn®, Permalyn® and Staybelite®.
79. The matrix material according to item 76, wherein the one or more adhesive agents can be selected from the group consisting of Gum Karaya, Sterculia gum, Gum Arabicum, Gum Karrageenan, celluloseethers, sodium carboxymethylcellulose, Manuba Honey, casein, alginates and fatty acid esters.
80. The matrix material according to item 76, wherein the one or more adhesive agents comprises between 0.1-50% (w/w) of the pharmaceutical composition, based on the total weight of the composition such as 1-25% (w/w), such as 5-20% (w/w), e.g. 5-15% (w/w), 5-10% (w/w), or 10-15% (w/w), based on the total weight of the composition.
81. The matrix material according to item 1, wherein the pharmaceutical composition comprises one or more surfactant agents.
82. The matrix material according to item 81, wherein the one or more surfactant agents can be selected from the group consisting of anionic surfactants, cationic surfactants, non-ionic surfactants and surface active biological modifiers.
83. The matrix material according to item 81, wherein the one or more surfactant agents can be selected from the group consisting of potassium laurate, triethanolamine stearate, sodium lauryl sulfate, sodium dodecylsulfate, alkyl polyoxyethylene sulfates, sodium alginate, dioctyl sodium sulfosuccinate, phosphatidyl glycerol, phosphatidyl inositol, phosphatidylserine, phosphatidic acid and their salts, glyceryl esters, sodium carboxymethylcellulose, bile acids and their salts, cholic acid, deoxycholic acid, glycocholic acid, taurocholic acid, glycodeoxycholic acid, and calcium carboxymethylcellulose.
84. The matrix material according to item 81, wherein the one or more surfactant agents can be selected from the group consisting of samples of cationic surfactants include surfactants selected from the group consisting of quaternary ammonium compounds, benzalkonium chloride, cetyltrimethylammonium bromide, chitosans and lauryldimethylbenzylammonium chloride.
85. The matrix material according to item 81, wherein the one or more surfactant agents can be selected from the group consisting of polyoxyethylene fatty alcohol ethers, polyoxyethylene sorbitan fatty acid esters, polyoxyethylene fatty acid esters, sorbitan esters, polyoxyethylene sorbitan esters (such as Tween 80 or Tween 20), glycerol monostearate, polyethylene glycols, polypropylene glycols, cetyl alcohol, cetostearyl alcohol, stearyl alcohol, aryl alkyl polyether alcohols, polyoxyethylene-polyoxypropylene copolymers, polaxamines, methylcellulose, hydroxycellulose, hydroxy propylcellulose, hydroxy propylmethylcellulose, noncrystalline cellulose, polysaccharides, starch, starch derivatives, hydroxyethylstarch, polyvinyl alcohol, Pluronic F68, and polyvinylpyrrolidone.
86. The matrix material according to item 1, wherein the pharmaceutical composition comprises a solvent component and/or a fluid component.
87. The matrix material according to item 86, wherein the solvent component and/or fluid component is an aqueous medium.
88. The matrix material according to item 87, wherein the aqueous medium contains one or more salts such as sodium chloride.
89. The matrix material according to item 87, wherein the solvent component and/or fluid component is a volatile fluid.
90. The matrix material according to item 1, wherein the pharmaceutical composition comprises one or more water content stabilizer such as sorbitol, polysaccaharides or polyols.
91. The matrix material according to item 1, wherein the pharmaceutical composition comprises one or more long chain molecules (polymers) such as gelatin, starch, polyethlyleneoxide, polyvinylalcohol and polyethyleneglycols (macrogol).
92. The matrix material according to item 1, wherein the pharmaceutical composition comprises one or more substances that increases the viscosity of the composition, selected from acacia, alginic acid, bentonite, carbomer, carboxymethylcellulose calcium, carboxymethylcellulose sodium, cetostearyl alcohol, colloidal silicon dioxide, guar gum, hydroxyethyl cellulose, hydroxypropyl cellulose, hydroxypropyl methylcellulose, hydroxypropyl methylcellulose phtalate, magnesium aluminium silicate, methylcellulose, microcrystalline cellulose, polyvinyl alcohol, povidone, sodium alginate, sucrose, tragacanth, gelatin, starch, albumin, casein, polyethlyleneoxide, polyvinylalcohol, polyethyleneglycols (macrogol), glycerine (1,2,3-propanetriol) and glycol (1,2-propanediol).
93. The matrix material according to item 1, wherein the pharmaceutical composition has a viscosity in the range of 0.1-20 cps; for example 0.1-1 cps, such as 1-2 cps, for example 2-3 cps, such as 3-4 cps, for example 4-5 cps, such as 5-6 cps, for example 6-7 cps, such as 7-8 cps, for example 8-9 cps, such as 9-10 cps, for example 10-11 cps, such as 11-12 cps, for example 12-13 cps, such as 13-14 cps, for example 14-15 cps, such as 15-16 cps, for example 16-17 cps, such as 17-18 cps, for example 18-19 cps, such as 19-20 cps.
94. The matrix material according to item 1, wherein the pharmaceutical composition has a surface tension in the range of 0.020 to 0.050 N/m; for example 0.020-0.022 N/m, such as 0.022-0.024 N/m, for example 0.024-0.026 N/m, such as 0.026-0.028 N/m, for example 0.028-0.030 N/m, such as 0.030-0.032 N/m, for example 0.032-0.034 N/m, such as 0.034-0.036 N/m, for example 0.036-0.038 N/m, such as 0.038-0.040 N/m, for example 0.040-0.042 N/m, such as 0.042-0.044 N/m, for example 0.044-0.046 N/m, such as 0.046-0.048 N/m, for example 0.048-0.050 N/m.
95. The matrix material according to item 1, wherein the pharmaceutical composition has a temperature in the range from sub-zero degrees celcius to 150 degrees celcius; such as −100° C. to −50° C., for example−50° C. to 0° C., such as 0-10° C., for example 10-20° C., such as 20-30° C., for example 30-40° C., such as 40-50° C., for example 50-60° C., such as 60-70° C., for example 70-80° C., such as 80-90° C., for example 90-100° C., such as 100-125° C., for example 125-150° C.
96. The matrix material according to item 1, wherein the pharmaceutical composition comprises one bioactive agent.
97. The matrix material according to item 1, wherein the pharmaceutical composition comprises two or more agents or bioactive agents.
98. The matrix material according to item 1, wherein the surface of the matrix material comprises one pharmaceutical composition comprising one or more bioactive agents.
99. The matrix material according to item 1, wherein the surface of the matrix material comprises two or more different pharmaceutical compositions each comprising one or more agents or bioactive agents.
100. The matrix material according to item 99, wherein the two or more different pharmaceutical compositions are each applied by ultrasonic spray technology onto the surface of the matrix material in non-overlapping positions of said surface.
101. The matrix material according to item 100, wherein the two or more different pharmaceutical compositions are incompatible if contained in the same pharmaceutical composition.
102. The matrix material according to item 101, wherein the two or more different pharmaceutical compositions are separate components of a two-component glue.
103. The matrix material according to item 102, wherein said two-component glue is a surgical glue.
104. The matrix material according to item 100, wherein the two or more pharmaceutical compositions comprise thrombin and fibrinogen, respectively
105. The matrix according to item 1, wherein said pharmaceutical composition is uniformly distributed.
106. The matrix according to item 105, wherein a predetermined ratio of droplet volume of the pharmaceutical composition, distance between any two droplets deposited on the surface of said matrix material and the concentration of a bioactive agent in said pharmaceutical composition is used.
107. The matrix material according to item 105, wherein any two area units of said matrix material differ in volume of the pharmaceutical composition or concentration of bioactive agent of the pharmaceutical composition by the most 10%, such as by the most 8%, for example by the most 6%, such as by the most 4%, for example by the most 2%, such as by the most 1%.
108. A matrix according to any of items 1 to 107, said matrix being obtained by a method comprising the steps of providing a matrix material and applying by ultrasonic spray technology said at least one pharmaceutical composition onto the surface of said matrix material.
109. The matrix according to item 108, wherein said method does not employ a drying step.
110. The matrix according to item 108, wherein said method essentially does not alter the physical characteristics and appearence of the matrix.
111. The matrix according to item 108, wherein said method essentially does not alter the physical characteristics of the surface of said matrix.
112. The matrix according to item 108, wherein said method essentially does not cause any swelling of the matrix.
113. The matrix according to item 108, wherein said method essentially does not cause any swelling of the surface of said matrix.
114. The matrix according to item 108, wherein said method essentially does not alter the initial absorption rate of the matrix.
115. The matrix according to item 108, wherein said method essentially does not lower the initial absorption rate of the surface of said matrix.
116. The matrix according to item 108, wherein said method essentially does not generate aerosols.
117. The matrix according to item 108, wherein the amount of fluid or liquid composition not contacting the matrix material is less that 10%, such as less than 8%, for example less than 6%, such as less than 4%, for example less than 2%, such as less than 1%.
118. The matrix according to item 108, wherein application by ultrasonic spray technology of the pharmaceutical composition occurs essentially perpendicular to the surface of said matrix material.
119. The matrix according to item 108, wherein said application by ultrasonic spray technology of said pharmaceutical composition onto the surface of said matrix material results in the generation of droplets that evaporate within maximum 30 seconds, such as less than 25 seconds, for example less than 20 seconds, such as less than 15 seconds, for example less than 10 seconds, such as less than 5 seconds, for example less than 1 second after being applied by ultrasonic spray technology onto the surface of the matrix.
120. The matrix according to item 108, wherein said application by ultrasonic spray technology of said pharmaceutical composition onto the surface of said matrix material results in the generation of droplets each with a volume of less than 100 nL, such as less than 90 nL, for example less than 80 nL, such as less than 70 nL, for example less than 60 nL, such as less than 50 nL, for example less than 40 nL, such as less than 30 nL, for example less than 20 nL, such as less than 10 nL, for example less than 1 nL or 1000 pL, such as less than 900 pL, for example less than 800 pL, such as less than 700 pL, for example less than 600 pL, such as less than 500 pL, for example less than 400 pL, such as less than 300 pL, for example less than 250 pL, such as less than 200 pL, for example less than 150 pL, such as less than 100 pL, for example less than 90 pL, such as less than 80 pL, for example less than 70 pL, such as less than 60 pL, for example less than 50 pL, such as less than 40 pL, for example less than 30 pL, such as less than 20 pL, for example less than 10 pL, such as less than 9 pL, for example less than 8 pL, such as less than 7 pL, for example less than 6 pL, such as less than 5 pL, for example less than 4 pL, such as less than 3 pL, for example less than 2 pL, such as less than 1 pL per droplet.
121. The matrix according to item 120, wherein the droplet size of any two droplets vary less that 10%, such as less than 8%, for example less than 6%, such as less than 4%, for example less than 2%, such as less than 1%.
122. The matrix according to item 121, wherein the droplet size of any two droplets is essentially identical.
123. The matrix according to item 99, wherein the distance between every two droplets deposited by ultrasonic spray technology onto the matrix surface is less than 2 mm, such as less than 1.9 mm, for example less than 1.8 mm, such as less than 1.7 mm, for example less than 1.6 mm L, such as less than 1.5 mm, for example less than 1.4 mm, such as less than 1.3 mm, for example less than 1.3 mm, such as less than 1.2 mm, for example less than 1.1 mm, such as less than 1.0 mm, for example less than 0.9 mm, such as less than 0.8 mm, for example less than 0.7 mm, such as less than 0.6 mm, for example less than 0.5 mm, such as less than 0.4 mm, for example less than 0.3 mm, such as less than 0.2 mm, for example less than 0.1 mm, such as less than 0.09 mm, for example less than 0.08 mm, such as less than 0.07 mm, for example less than 0.06 mm, such as less than 0.05 mm, for example less than 0.04 mm, such as less than 0.03 mm, for example less than 0.02 mm, such as less than 0.01 mm.
124. The matrix according to item 123, wherein the distance between every two droplets deposited by ultrasonic spray technology onto the matrix surface vary less that 10%, such as less than 8%, for example less than 6%, such as less than 4%, for example less than 2%, such as less than 1%.
125. The matrix according to item 124, wherein the distance between every two droplets deposited by ultrasonic spray technology onto the matrix surface is essentially identical.
126. The matrix according to item 108, wherein said application by ultrasonic spray technology of said pharmaceutical composition onto the surface of said matrix material results in the generation of droplets, wherein the distance traversed by any droplet from the nozzle assembly head to the surface of the matrix material is less than 0.01 mm, such as less than 0.02 mm, for example less than 0.03 mm, such as less than 0.04 mm, for example less than 0.05 mm, such as less than 0.06 mm, for example less than 0.07 mm, such as less than 0.08 mm, for example less than 0.09 mm, such as less than 0.1 mm, for example less than 0.2 mm, such as less than 0.3 mm, for example less than 0.4 mm, such as less than 0.5 mm, for example less than 0.6 mm, such as less than 0.7 mm, for example less than 0.8 mm, such as less than 0.9 mm, for example less than 1.0 mm, such as less than 1.1 mm, for example less than 1.2 mm, such as less than 1.3 mm, for example less than 1.4 mm, such as less than 1.5 mm, for example less than 1.6 mm, such as less than 1.7 mm, for example less than 1.8 mm, such as less than 1.9 mm, for example less than 2.0 mm, such as less than 2.1 mm, for example less than 2.2 mm, such as less than 2.3 mm, for example less than 2.4 mm, such as less than 2.5 mm, for example less than 2.6 mm, such as less than 2.7 mm, for example less than 2.8 mm, such as less than 2.8 mm, for example less than 3.0 mm, such as less than 3.5 mm, for example less than 4.0 mm, such as less than 4.5 mm, for example less than 5.0 mm, such as less than 6.0 mm, for example less than 7.0 mm, such as less than 8.0 mm, for example less than 9.0 mm, such as less than 10.0 mm.
127. The matrix according to item 126, wherein each droplet traverses a distance from nozzle assembly head to the surface of a matrix material that varies between each droplet within a range of 0.01% to a maximum of 10%; such as 0.01 to 0.1%, for example 0.1 to 1%, such as 1 to 2%, for example 2 to 3%, such as 3 to 4%, for example 4 to 5%, such as 5 to 6%, for example 6 to 7%, such as 7 to 8%, for example 8 to 9%, such as 9 to 10%.
128. The matrix according to item 127, wherein the distance each droplet traverses from nozzle assembly head to the surface of a matrix material is essentially identical.
129. The matrix according to item 108, wherein a nozzle assembly head ejects droplets at a velocity in the range of 0.1-100 m/sec; such as 0.1-1 m/sec, for example 1-2 m/sec, such as 2-3 m/sec, for example 3-4 m/sec, such as 4-5 m/sec, for example 5-6 m/sec, such as 6-7 m/sec, for example 7-8 m/sec, such as 8-9 m/sec, for example 9-10 m/sec, such as 10-15 m/sec, for example 15-20 m/sec, such as 20-30 m/sec, for example 30-40 m/sec, such as 40-50 m/sec, for example 50-60 m/sec, such as 60-70 m/sec, for example 70-80 m/sec, such as 80-90 m/sec, for example 90-100 m/sec.
130. The matrix according to item 129, wherein the velocity between each droplet varies within a range of 0.01% to a maximum of 10%; such as 0.01 to 0.1%, for example 0.1 to 1%, such as 1 to 2%, for example 2 to 3%, such as 3 to 4%, for example 4 to 5%, such as 5 to 6%, for example 6 to 7%, such as 7 to 8%, for example 8 to 9%, such as 9 to 10%.
131. The matrix according to item 130, wherein the velocity of each droplet from nozzle assembly head to the surface of a matrix material is essentially identical.
132. The matrix material according to item 108, wherein said pharmaceutical composition is applied by ultrasonic spray technology onto said surface of said matrix by an ultrasonic spray device.
133. The matrix material according to item 132, wherein the ultrasonic spray device comprises one or more ultrasonic spray nozzles.
134. The matrix material according to item 132, wherein the ultrasonic spray device comprises one or more nozzle assembly heads.
135. The matrix material according to item 132, wherein the ultrasonic spray device comprises more than two nozzle assembly heads and/or more than two nozzles.
136. The matrix material according to item 132, wherein the ultrasonic spray device comprises at least one nozzle assembly head comprising at least one nozzle.
137. The matrix material according to item 136, wherein the nozzle diameter is in the range of 1-1000 microns; such as 1-5 microns, for example 5-10 microns, such as 10-20 microns, for example 20-30 microns, such as 30-40 microns, for example 40-50 microns, such as 50-60 microns, for example 60-70 microns, such as 70-80 microns, for example 80-90 microns, such as 90-100 microns, for example 100-200 microns, such as 200-300 microns, for example 300-400 microns, such as 400-500 microns, for example 500-600 microns, such as 600-700 microns, for example 700-800 microns, such as 800-900 microns, for example 900-1000 microns.
138. The matrix material according to item 136, wherein the at least one nozzle assembly head comprises between 1-50, 50-100, 100-150, 150-200, 200-250, 250-300, 300-350, 350-400, 400-450, 450-500, 500-600, 600-700, 700-800, 800-900, 900-1000, 1000-1100, 1100-1200, 1200-1300, 1300-1400, 1400-1500, 1500-1600, 1600-1700, 1700-1800, 1800-1900, 1900-2000, 2000-2500, 2500-3000, 3000-4000, 4000-5000, 5000-10,000 nozzles per nozzle assembly head.
139. A device comprising the matrix material coated with a pharmaceutical composition according to items 1-138 by ultrasonic spray technology.
140. A kit of parts comprising the device according to item 139 and at least one additional component.
141. A method for making the device according to item 139 comprising the steps of
   a. providing a matrix material, and
   b. applying a pharmaceutical composition onto the surface of said matrix material by ultrasonic spray technology.
142. Use of the device according to item 139 to promote wound healing in an individual in need thereof
143. Use of the device according to item 139 to promote hemostasis in an individual in need thereof
144. A matrix material comprising a surface and a plurality of open and interconnected cells, wherein one or more pharmaceutical compositions have been applied onto said matrix material.
145. The matrix material according to item 144, wherein the matrix comprises one or more polymers.
146. The matrix material according to item 144, wherein said polymers are cross-linked.
147. The matrix material according to item 144, wherein said polymers are not cross-linked.
148. The matrix material according to item 145, wherein said polymers are selected from the group consisting of collagen, gelatin, polyurethane, polysiloxanes (silicone), hydrogels, polyacrylamides, chitosan, sodium polyacrylate, agarose, alginates, xanthan gum, guar gum, arabic gum, agar gum, Locust Bean gum, Carrageenan gum, Xanthan gum, Karaya gum, tragacanth gum, Ghatti gum, Furcelleran gum, chitin, cellulose, methylcellulose, carboxymethyl cellulose, hydroxymethyl cellulose, hydroxypropyl methylcellulose, hydroxypropyl cellulose, hyaluronic acid, pectin, starch, glycogen, pentosans, polyoxyethylene, polyAMPS (poly(2-acrylamido-2-methyl-1-propanesulfonic acid), polyvinylpyrrolidone, polyvinyl alcohol, polyglycolic acid, polyacetic acid, acrylate polymers, polyhydroxyalkyl acrylates, methacrylates, polyvinyl lactams, polyvinyl alcohols, polyoxyalkylenes, polyacrylamides, polyacrylic acid, polystyrene sulfonates, synthetic hydrocolloids such as N-vinyl-2-pyrrolidone, 5-methyl-N-vinyl-2-pyrrolidone, 5-ethyl-N-vinyl-2-pyrrolidone, 3,3-dimethyl-N-vinyl-2-pyrrolidone, 3-methyl-N-vinyl-2-pyrrolidone, 3-ethyl-N-vinyl-2-pyrrolidone, 4-methyl-N-vinyl-2-pyrrolidone, 4-ethyl-N-vinyl-2-pyrrolidone, N-vinyl-2-valerolactam, N-vinyl-2-caprolactam, hydroxyalkyl acrylates and methacrylates, (such as 2-hydroxyethyl acrylate, 2-hydroxyethyl methacrylate, 2-hydroxypropyl acrylate, 2-hydroxypropyl methacrylate, 2,3-dihydroxypropyl methacrylate), acrylic acid, methacrylic acid, tertiary amino-methacrylimide, (e.g. trimethylamino-methacrylimide), crotonic acid, pyridine, water soluble amides, (such as N-(hydroxymethyl)acrylamide and -methacrylamide, N-(3-hydroxpropyl)acrylamide, N-(2-hydroxyethyl) methacrylamide, N-(1,1-dimethyl-3-oxabutyl)acrylamide N-[2-(dimethylamine)ethyl]acrylamide and -methacrylamide, N-[3-(dimethylamino)-2-hydroxylpropyl]methacrylamide, and N-[1,1-dimethyl-2-(hydroxymethyl)-3-oxabutyl]acrylamide); water-soluble hydrazine derivatives, (such as trialkylamine methacrylimide, and dimethyl-(2-hydroxypropyl)amine methacrylimide); mono-olefinic sulfonic acids and their salts, (such as sodium ethylene sulfonate, sodium styrene sulfonate, 2-acrylamideo-2-methylpropanesulfonic acid), 1-vinyl-imidazole, 1-vinyl-indole, 2-vinyl imidazole, 4(5)-vinyl-imidazole, 2-vinyl-1-methyl-imidazole, 5-vinyl-pyrazoline, 3-methyl-5-isopropenyl-pyrazole, 5-methylene-hydantoin, 3-vinyl-2-oxazolidone, 3-methacrylyl-2-oxazolidone, 3-methacrylyl-5-methyl-2-oxazolidone, 3-vinyl-5-methyl-2-oxazolidone, 2- and 4-vinyl-pyridine, 5-vinyl-2-methyl-pyridine, 2-vinyl-pyridine-1-oxide, 3-isopropenyl-pyridine, 2- and 4-vinyl-piperidine, 2- and 4-vinyl-quinoline, 2,4-dimethyl-6-vinyl-s-triazine, 4-acrylyl-morpholine, Oxidized Regenerated Cellulose (ORC), poly(lactic-co-glycolic acid) (PLGA), Polylactic acid (PLA), Extracellular matrix (ECM) and mixtures thereof.
149. The matrix material according to item 145, wherein the polymers originates from an animal source such as porcine, bovine or fish sources.
150. The matrix material according to item 145, wherein the polymers are synthetically made i.e. by recombinant means.
151. The matrix material according to item 145, wherein the polymers are selected from collagen and gelatin.
152. The matrix material according to item 145, wherein the polymers comprise gelatin.
153. The matrix material according to item 145, wherein the polymers comprise collagen.
154. The matrix material according to item 144, wherein the interconnected open cells form pores having a diameter of from about 0.1 mm to about 5.0 mm.
155. The matrix material according to item 144, wherein the matrix has the dimensions
(length, width and height) of less than 15 cm long, less than 10 cm wide and less than 2 cm high.
156. The matrix material according to item 144, wherein the matrix is a shape selected from the group consisting of square form, circular form, rectangular form, cubic form, cylinder form, spherical or pyramid-shaped.
157. The matrix material according to item 144, wherein the matrix has a colour selected from the group consisting of red, pink, yellow, blue, green, white, black, brown, purple, orange, grey and turquoise.
158. The matrix material according to item 144, wherein the matrix material has a reconformation rate of no more than 10 seconds, such as no more than 9 seconds, for example no more than 8 seconds, such as no more than 7 seconds, for example no more than 6 seconds, such as no more than 5 seconds, for example no more than 4 seconds, such as no more than 3 seconds, for example no more than 3 seconds, such as no more than 1 second.
159. The matrix material according to item 144, wherein the matrix material has a pore size with a normal distribution around 0.1-1.0 mm.
160. The matrix material according to item 144, wherein the matrix material has a pore size of less than 10 mm, such as less than 9 mm, for example less than 8 mm, such as less than 7 mm, for example less than 6 mm, such as less than 5 mm, for example less than 4 mm, such as less than 3 mm, for example less than 2.9 mm, such as less than 2.8 mm, for example less than 2.7 mm, such as less than 2.6 mm, for example less than 2.5 mm, such as less than 2.4 mm, for example less than 2.3 mm, such as less than 2.2 mm, for example less than 2.1 mm, such as less than 2 mm, for example less than 1.9 mm, such as less than 1.8 mm, for example less than 1.7 mm, such as less than 1.6 mm, for example less than 1.5 mm, such as less than 1.4 mm, for example less than 1.3 mm, such as less than 1.2 mm, for example less than 1.1 mm, such as less than 1.0 mm, for example less than 0.9 mm, such as less than 0.8 mm, for example less than 0.7 mm, such as less than 0.6 mm, for example less than 0.5 mm, such as less than 0.4 mm, for example less than 0.3 mm, such as less than 0.2 mm, for example less than 0.1 mm, such as less tan 0.05, for example less than 0.01 mm.
161. The matrix material according to item 144, wherein the matrix material has a pore size in the range of 0.01-0.1 mm, such as 0.1-0.2 mm, for example 0.2-0.3 mm, such as 0.3-0.4 mm, for example 0.4-0.5 mm, such as 0.5-0.6 mm, for example 0.6-0.7 mm, such as 0.7-0.8 mm, for example 0.8-0.9 mm, such as 0.9-1 mm, for example 1-1.1 mm, such as 1.1-1.2 mm, for example 1.2-1.3 mm, such as 1.3-1.4 mm, for example 1.4-1.5 mm, such as 1.5-1.6 mm, for example 1.6-1.7 mm, such as 1.-1.8 mm, for example 1.8-1.9 mm, such as 2-2.1 mm, for example 2.1-2.2 mm, such as 2.2-2.3 mm, for example 2.3-2.4 mm, such as 2.4-2.5 mm, for example 2.5-2.6 mm, such as 2.6-2.7 mm, for example 2.7-2.8 mm, such as 2.8-2.9 mm, for example 2.9-3 mm, such as 3-4 mm, for example 4-5 mm, such as 5-6 mm, for example 6-7 mm, such as 7-8 mm, for example 8-9 mm, such as 9-10 mm.
162. The matrix material according to item 144, wherein the matrix material has a modulus in the range of 0.1-50 GPa, such as 0.1-1, for example 1-2, such as 2-3, such as 3-4, for example 4-5, such as 5-6, for example, 6-7, such as 7-8, for example 8-9, such as 9-10, for example 10-20, such as 20-30, for example 30-40, such as 40-50 GPa.
163. The matrix material according to item 144, wherein the matrix contains less than 100 IU/cm² (units per square centimeter), such as less than 95, for example less than 90, such as 85, for example less than 80, such as less than 75, for example less than 70, such as 65, for example less than 60, such as less than 55, for example less than 50, such as 45, for example less than 40, such as less than 35, for example less than 30, such as 25, for example less than 20, such as less than 15, for example less than 10, such as 5, for example less than 1 IU/cm² of the pharmaceutical composition.
164. The matrix material according to item 144, wherein the surface of the matrix contains between 1-5 IU/cm², such as 5-10, for example 10-15, such as 15-20, for example 20-25, such as 25-30, for example 30-35, such as 35-40, for example 40-45, such as 45-50, for example 50-55, such as 55-60, for example 60-65, such as 65-70, for example 70-75, such as 75-80, for example 80-85, such as 85-90, for example 90-95, such as 95-100 IU/cm² of the pharmaceutical composition.
165. The matrix material according to item 144, wherein the matrix material is a sponge.
166. The matrix material according to item 144, wherein the sponge is a gelatin or collagen sponge.
167. The matrix material according to item 166, wherein the gelatin or collagen sponge is selected from the group consisting of Spongostan, Surgifoam, Surgiflo (all Ferrosan NS), Collastat (Kendall Co.), Avitene (Avicon Inc.), Surgicel, Surgifoam (both Johnson & Johnson) and Gelfoam (Phizer).
168. The matrix material according to item 144, wherein the matrix material is a patch.
169. The matrix material according to item 144, wherein the matrix material is a swab.
170. The matrix material according to item 144, wherein the matrix material is a bandage.
171. The matrix material according to item 144, wherein the matrix material is a wound dressing.
172. The matrix material according to item 144, wherein the matrix material is a tissue dressing.
173. The matrix material according to item 144, wherein the matrix material is sterile.
174. The matrix material according to item 144, wherein the matrix material is sterile and contained in a sterile, pre-packaged, ready-to-use container.
175. The matrix material according to item 144, wherein the matrix material is sterilized.
176. The matrix material according to item 144, wherein the matrix material is sterilized by application of heat.
177. The matrix material according to item 144, wherein the matrix material is sterilized by application of one or more chemicals.
178. The matrix material according to item 144, wherein the matrix material is sterilized by application of high pressure.
179. The matrix material according to item 144, wherein the matrix material is sterilized by application of filtration.
180. The matrix material according to item 144, wherein the matrix material is sterilized by application of autoclaving.
181. The matrix material according to item 144, wherein the matrix material is sterilized by application of radiation sterilization such as sterilization using X-rays, gamma rays, UV light and/or subatomic particles.
182. The matrix material according to item 144, wherein the matrix material is sterilized by application of chemical sterilization include use of one or more of the chemicals selected from the group consisting of ethylene oxide gas, ozone, chlorine bleach, glutaraldehyde, formaldehyde, ortho phthalaldehyde, hydrogen peroxide and peracetic acid.
183. The matrix material according to item 175, wherein the sterile matrix material is contained in a sterile container and separated from an external, non-sterile environment.
184. The matrix material according to item 144, wherein the pharmaceutical composition comprises one or more bioactive agent(s) that stimulates hemostasis.
185. The matrix material according to item 144, wherein the pharmaceutical composition comprises one or more bioactive agent(s) that stimulates wound healing.
186. The matrix material according to item 144, wherein the pharmaceutical composition comprises one or more bioactive agent(s) that stimulates wound healing by inhibition of one or more infections of the wound.
187. The matrix material according to item 144, wherein the pharmaceutical composition comprises one or more bioactive agent(s) which comprises one or more anti-fibrinolytic agents.
188. The matrix material according to item 144, wherein the pharmaceutical composition comprises one or more bioactive agent(s) which comprises one or more pro-coagulants.
189. The matrix material according to item 144, wherein the pharmaceutical composition comprises one or more bioactive agent(s) that stimulates platelets.
190. The matrix material according to item 144, wherein the pharmaceutical composition comprises one or more bioactive agent(s) that stimulate formation of a hemostatic plug.
191. The matrix material according to item 144, wherein the pharmaceutical composition comprises one or more bioactive agent(s) that stimulates one or more coagulation factors.
192. The matrix material according to item 144, wherein the pharmaceutical composition comprises one or more bioactive agent(s) selected from the group consisting of endothelium Tissue Factor (TF), Factor VII, TF-Factor VIIa, Factor IX, Factor X, thrombin, Factor XIa, plasmin, Factor XII, Factor Xa, TFPI, Factor Va, prothrombinase complex, prothrombin, Factor V, Factor XI, Factor VIII, vWF, Factor VIIIa, Factor IXa and the tenase complex.
193. The matrix material according to item 144, wherein the pharmaceutical composition comprises one or more bioactive agent(s) that stimulates the formation of fibrin strands.
194. The matrix material according to item 144, wherein the pharmaceutical composition comprises one or more bioactive agent(s) that stimulates platelate aggregation.
195. The matrix material according to item 144, wherein the pharmaceutical composition comprises one or more bioactive agent(s) which comprises thrombin.
196. The matrix material according to items 144 and 195, wherein the pharmaceutical composition comprises one or more bioactive agent(s) which comprises fibrinogen.
197. The matrix material according to items 144 and 195, wherein the pharmaceutical composition comprises one or more bioactive agent(s) which comprises Factor XIII and/or XIIIa.
198. The matrix material according to items 144 and 195, wherein the pharmaceutical composition comprises one or more bioactive agent(s) which comprises tranexamic acid.
199. The matrix material according to items 144 and 195, wherein the pharmaceutical composition comprises one or more bioactive agent(s) which comprises Willebrand factor (vWF).
200. The matrix material according to item 144, wherein the pharmaceutical composition comprises one or more bioactive agent(s) that stimulates the contact activation pathway.
201. The matrix material according to item 144, wherein the pharmaceutical composition comprises one or more bioactive agent(s) that stimulates the tissue factor pathway.
202. The matrix material according to item 144, wherein the pharmaceutical composition comprises one or more bioactive agent(s) that stimulates fibrin formation.
203. The matrix material according to item 144, wherein the pharmaceutical composition comprises one or more bioactive agent(s) that stimulates fibrin cross-linking.
204. The matrix material according to item 144, wherein the pharmaceutical composition comprises one or more bioactive agent(s) which comprises Factor VIII.
205. The matrix material according to item 144, wherein the pharmaceutical composition comprises one or more bioactive agent(s) which comprises Factor V.
206. The matrix material according to item 144, wherein the pharmaceutical composition comprises one or more bioactive agent(s) which comprises Factor XIII.
207. The matrix material according to item 144, wherein the pharmaceutical composition comprises one or more bioactive agent(s) which comprises Factor VII.
208. The matrix material according to item 144, wherein the pharmaceutical composition comprises one or more bioactive agent(s) which stimulates the coagulation cascade.
209. The matrix material according to item 144, wherein the pharmaceutical composition comprises thrombin.
210. The matrix material according to item 209, wherein the matrix contains less than 300 IU thrombin per square cm (cm²) surface area, such as less than 290, for example less than 280, such as 270, for example less than 260, such as less than 250, for example less than 240, such as 230, for example less than 220, such as less than 210, for example less than 200, such as 190, for example less than 180, such as less than 170, for example less than 160, such as 150, for example less than 140, such as less than 130, for example less than 120, such as 110, for example less than 100 IU/cm², such as less than 95, for example less than 90, such as 85, for example less than 80, such as less than 75, for example less than 70, such as 65, for example less than 60, such as less than 55, for example less than 50, such as 45, for example less than 40, such as less than 35, for example less than 30, such as 25, for example less than 20, such as less than 15, for example less than 10, such as 5, for example less than 1 IU/cm².
211. The matrix material according to item 209, wherein the surface of the matrix contains between 1-5 IU/cm², such as 5-10, for example 10-15, such as 15-20, for example 20-25, such as 25-30, for example 30-35, such as 35-40, for example 40-45, such as 45-50, for example 50-55, such as 55-60, for example 60-65, such as 65-70, for example 70-75, such as 75-80, for example 80-85, such as 85-90, for example 90-95, such as 95-100, for example 100-110, such as 110-120, for example 120-130, such as 130-140, for example 140-150, such as 150-160, for example 160-170, such as 170-180, for example 180-190, such as 190-200, for example 200-210, such as 210-220, for example 220-230, such as 230-240, for example 240-250, such as 250-260, for example 260-270, such as 270-280, for example 280-290, such as 290-300 IU/cm².
212. The matrix material according to item 144, wherein the pharmaceutical composition comprises one or more adhesive agents.
213. The matrix material according to item 212, wherein the one or more adhesive agents can be selected from the group consisting of saccharides, monosaccharides, disaccharides, oligosaccharides, polysaccharides, glucose, mannose, fructose, threose, gulose, arabinose, ribose, erythrose, lyxose, galactose, sorbose, altrose, tallose, idose, rhamnose, allose, pentosamines, hexosamines, glucosamine, N-acetylglucosamine, glucoronic acid, sucrose, maltose, lactose, cellubiose, glycogen, chitin, chitosan, starch, potato starch, glycosaminoglycans, chondroitin, chondroitin sulfate, hyaluronic acid, dermatan sulphate, keratan sulphate, aminated dextrans, DEAE-dextran, aminated starch, aminated glycogen, aminated cellulose, aminated pectin, and salts, complexes, derivatives and mixtures thereof.
214. The matrix material according to item 212, wherein the one or more adhesive agents can be selected from the group consisting of hydrocarbon resins, rosin resins, terpene resins, Escorez® from ExxonMobil; Regalite®, Piccotac® and Picco® from Eastman; Indopol® from BP or Arkon®, esters of hydrogenated wood rosin, pentaerythritol ester of hydrogenated wood rosin, esters of partially hydrogenated wood rosin, pentaerythritol esters of partially hydrogenated wood rosin, esters of wood rosin, esters of modified wood rosin, esters of partially dimerized rosin, esters of tall oil rosin, esters of dimerized rosin, Foral®, Foralyn®, Pentalyn®, Permalyn® and Staybelite®.
215. The matrix material according to item 212, wherein the one or more adhesive agents can be selected from the group consisting of Gum Karaya, Sterculia gum, Gum Arabicum, Gum Karrageenan, celluloseethers, sodium carboxymethylcellulose, Manuba Honey, casein, alginates and fatty acid esters.
216. The matrix material according to item 212, wherein the one or more adhesive agents comprises between 0.1-50% (w/w) of the pharmaceutical composition, based on the total weight of the composition such as 1-25% (w/w), such as 5-20% (w/w), e.g. 5-15% (w/w), 5-10% (w/w), or 10-15% (w/w), based on the total weight of the composition.
217. The matrix material according to item 144, wherein the pharmaceutical composition comprises one or more surfactant agents.
218. The matrix material according to item 217, wherein the one or more surfactant agents can be selected from the group consisting of anionic surfactants, cationic surfactants, non-ionic surfactants and surface active biological modifiers.
219. The matrix material according to item 217, wherein the one or more surfactant agents can be selected from the group consisting of potassium laurate, triethanolamine stearate, sodium lauryl sulfate, sodium dodecylsulfate, alkyl polyoxyethylene sulfates, sodium alginate, dioctyl sodium sulfosuccinate, phosphatidyl glycerol, phosphatidyl inositol, phosphatidylserine, phosphatidic acid and their salts, glyceryl esters, sodium carboxymethylcellulose, bile acids and their salts, cholic acid, deoxycholic acid, glycocholic acid, taurocholic acid, glycodeoxycholic acid, and calcium carboxymethylcellulose.
220. The matrix material according to item 217, wherein the one or more surfactant agents is a cationic surfactant selected from the group consisting of quaternary ammonium compounds, benzalkonium chloride, cetyltrimethylammonium bromide, chitosans and lauryldimethylbenzylammonium chloride.
221. The matrix material according to item 217, wherein the one or more surfactant agents can be selected from the group consisting of polyoxyethylene fatty alcohol ethers, polyoxyethylene sorbitan fatty acid esters, polyoxyethylene fatty acid esters, sorbitan esters, polyoxyethylene sorbitan esters (such as Tween 80 or Tween 20), glycerol monostearate, polyethylene glycols, polypropylene glycols, cetyl alcohol, cetostearyl alcohol, stearyl alcohol, aryl alkyl polyether alcohols, polyoxyethylene-polyoxypropylene copolymers, polaxamines, methylcellulose, hydroxycellulose, hydroxy propylcellulose, hydroxy propylmethylcellulose, noncrystalline cellulose, polysaccharides, starch, starch derivatives, hydroxyethylstarch, polyvinyl alcohol, Pluronic F68 and polyvinylpyrrolidone.
222. The matrix material according to item 144, wherein the pharmaceutical composition comprises a solvent component and/or a fluid component.
223. The matrix material according to item 222, wherein the solvent component and/or fluid component is an aqueous medium.
224. The matrix material according to item 223, wherein the aqueous medium contains one or more salts such as sodium chloride.
225. The matrix material according to item 222, wherein the solvent component and/or fluid component is a volatile fluid.
226. The matrix material according to item 144, wherein the pharmaceutical composition comprises one or more water content stabilizer such as sorbitol, polysaccaharides or polyols.
227. The matrix material according to item 144, wherein the pharmaceutical composition comprises one or more substances that increases the viscosity of the composition, selected from acacia, alginic acid, bentonite, carbomer, carboxymethylcellulose calcium, carboxymethylcellulose sodium, cetostearyl alcohol, colloidal silicon dioxide, guar gum, hydroxyethyl cellulose, hydroxypropyl cellulose, hydroxypropyl methylcellulose, hydroxypropyl methylcellulose phtalate, magnesium aluminium silicate, methylcellulose, microcrystalline cellulose, polyvinyl alcohol, povidone, sodium alginate, sucrose, tragacanth, gelatin, starch, albumin, casein, polyethlyleneoxide, polyvinylalcohol, polyethyleneglycols (macrogol), glycerine (1,2,3-propanetriol) and glycol (1,2-propanediol).
228. The matrix material according to item 144, wherein the pharmaceutical composition has a viscosity in the range of 0.1-20 cps; for example 0.1-1 cps, such as 1-2 cps, for example 2-3 cps, such as 3-4 cps, for example 4-5 cps, such as 5-6 cps, for example 6-7 cps, such as 7-8 cps, for example 8-9 cps, such as 9-10 cps, for example 10-11 cps, such as 11-12 cps, for example 12-13 cps, such as 13-14 cps, for example 14-15 cps, such as 15-16 cps, for example 16-17 cps, such as 17-18 cps, for example 18-19 cps, such as 19-20 cps.
229. The matrix material according to item 144, wherein the pharmaceutical composition has a surface tension in the range of 0.020 to 0.050 N/m; for example 0.020-0.022 N/m, such as 0.022-0.024 N/m, for example 0.024-0.026 N/m, such as 0.026-0.028 N/m, for example 0.028-0.030 N/m, such as 0.030-0.032 N/m, for example 0.032-0.034 N/m, such as 0.034-0.036 N/m, for example 0.036-0.038 N/m, such as 0.038-0.040 N/m, for example 0.040-0.042 N/m, such as 0.042-0.044 N/m, for example 0.044-0.046 N/m, such as 0.046-0.048 N/m, for example 0.048-0.050 N/m.
230. The matrix material according to item 144, wherein the pharmaceutical composition has a temperature is in the range from sub-zero degrees celcius to 150 degrees celcius; such as −100° C. to −50° C., for example −50° C. to 0° C., such as 0-10° C., for example 10-20° C., such as 20-30° C., for example 30-40° C., such as 40-50° C., for example 50-60° C., such as 60-70° C., for example 70-80° C., such as 80-90° C., for example 90-100° C., such as 100-125° C., for example 125-150° C.
231. The matrix material according to item 144, wherein the one or more pharmaceutical compositions are deposited into and/or onto said matrix material by spraying of the one or more pharmaceutical compositions into and/or onto said matrix.
232. The matrix material according to item 144, wherein the one or more pharmaceutical compositions are deposited into and/or onto said matrix material by sprinkling of the one or more pharmaceutical compositions into and/or onto said matrix.
233. The matrix material according to item 144, wherein the one or more pharmaceutical compositions are deposited into and/or onto said matrix material by pouring of the one or more pharmaceutical compositions into and/or onto said matrix.
234. The matrix material according to item 144, wherein the one or more pharmaceutical compositions are deposited into and/or onto said matrix material by dipping of said matrix into the one or more pharmaceutical compositions.
235. The matrix material according to item 144, wherein the one or more pharmaceutical compositions are deposited into or onto the matrix during preparation of said matrix.
236. A device comprising the matrix material and a pharmaceutical composition according to items 144-235.
237. A kit of parts comprising the device according to item 236 and at least one additional component.
238. A method for making the device according to item 236 comprising the steps of
   a. providing a matrix material, and
   b. applying a pharmaceutical composition onto the surface of said matrix material.
239. Use of the device according to item 236 to promote wound healing in an individual in need thereof
240. Use of the device according to item 236 to promote hemostasis in an individual in need thereof.
241. A matrix material comprising a surface and a plurality of open and interconnected cells, wherein said matrix material comprises a haemostatically effective amount of thrombin or a precursor thereof.
242. The matrix material according to item 241, wherein said matrix further comprises one or more thrombin-stabilizing agents.
243. The matrix material according to item 241, wherein said thrombin is applied to the matrix material by ultrasonic spraying.
244. The matrix material according to item 241, wherein the matrix material comprises a biologically absorbable material comprising thrombin.
245. The matrix material according to item 241, wherein the matrix material comprises a sponge comprising thrombin.
246. The matrix material according to item 241, wherein the matrix material comprises a gelatin foam pad and/or a gauze pad that provide a unique, premixed, sterile, gelatin/thrombin haemostat.
247. The matrix material according to item 241, wherein the matrix material comprises a premixed thrombin/gelatin pad.
248. The matrix material according to item 241, wherein the matrix material comprises thrombin freeze-dried into a gelatin foam.
249. The matrix material according to item 241, wherein the matrix material comprises any standard gelatin pad with thrombin.
250. The matrix material according to item 241, wherein the matrix material comprises a fibrin paste based on e.g. a collagen sponge coated with fibrinogen and/or thrombin.
251. The matrix material according to item 241, wherein the matrix material comprises Thrombi-Gel® (Vascular Solutions, Inc.).
252. The matrix material according to item 241, wherein the matrix material comprises Thrombi-Pad™ (Vascular Solutions, Inc.).
253. The matrix material according to item 241, wherein the matrix material comprises D-Stat Dry product (such as D-Stat Dry, D-Stat 2 Dry) (Vascular Solutions, Inc.).
254. The matrix material according to item 241, wherein the matrix material comprises ThrombiGel hemostatic foam (Vascular Solutions, Inc.).
255. The matrix material according to item 241, wherein the matrix material comprises Gelfoam (Pfizer).
256. The matrix material according to item 241, wherein the matrix material comprises Surgifoam (Johnson & Johnson).
257. The matrix material according to item 241, wherein the matrix material comprises Surgiflo (Johnson & Johnson).
258. The matrix material according to item 241, wherein the matrix material comprises FloSeal Matrix Hemostatic Sealant (Baxter International Inc.).
259. The matrix material according to item 241, wherein the matrix material comprises TachoSil (Nycomed).
260. The matrix material according to item 241, wherein the matrix material comprises a collagen material such as Avitene, Actifoam, Helistat, Inistat, or CoStasis hemostatic device.
261. The matrix material according to item 241, wherein the matrix material comprises a cellulose material such as Surgicel (Ethicon/Johnson & Johnson), Oxycel or Tabotamp.
262. The matrix material according to item 241, wherein the thrombin is Thrombostat, Thrombin-JMI (King Pharmaceuticals), Recothrom (Bayer/Zymogenetics), Evithrom (OMRIX Biopharmaceuticals/Ethicon), or any other commercially available thrombin.
263. The matrix material according to item 241, wherein the thrombin is produced from plasma using the Thrombin Activation Device (TAD) (Thermogenesis).
264. The matrix material according to item 241, wherein the matrix material comprises a hemostatic paste composition comprising a hemostatic effective amount of thrombin in a polyethylene glycol base which is preferably prepared by admixing an aqueous solution of thrombin and polyethylene glycol and freeze-drying the mixture to remove substantially all of the water to yield a viscous water soluble paste of fine particles of thrombin uniformly dispersed throughout the polyethylene glycol base (as described in U.S. Pat. No. 5,595,735).
265. The matrix material according to item 241, wherein the matrix material comprises a collagen paste hemostat comprising thrombin e.g. as described in U.S. Pat. No. 4,891,359.
266. The matrix material according to item 241, wherein the matrix material comprises a stable collagen sponge having thrombin therein e.g. as described in U.S. Pat. No. 4,515,637.
267. The matrix material according to item 241, wherein the matrix material comprises a collagen sponge having thrombin therein e.g. as described in U.S. Pat. No. 6,649,162.
268. A device comprising the matrix material and thrombin according to items 241-267.
269. A kit of parts comprising the device according to item 268 and at least one additional component.
270. A method for making the device according to item 268 comprising the steps of
   a. providing a matrix material, and
   b. applying thrombin by ultrasonic spray technology onto the surface of said matrix material.
271. Use of the device according to item 268 to promote wound healing in an individual in need thereof
272. Use of the device according to item 268 to promote hemostasis in an individual in need thereof.
273. A container for storage and/or preparation of a matrix material comprising
   i) a bottom,
   ii) one or more sidewall(s) continuously surrounding said bottom,
   iii) a sealing surface for a lid, and
   iv) a lid,
   wherein the one or more sidewall(s) and the bottom defines an inner cavity suitable for storage and/or preparation of a matrix material.
274. The container according to item 273, wherein the one or more sidewalls comprises one or more marks for maximum filling of the container with a liquid.
275. The container according to item 274, wherein the mark for maximum filling is a bevelled edge on the one or more sidewalls.
276. The container according to item 274, wherein the mark for maximum filling is a line.
277. The container according to item 274, wherein the mark for maximum filling is a dot.
278. The container according to item 274, wherein the mark for maximum filling is a dent in the one or more sidewalls.
279. The container according to item 274, wherein said liquid is selected from the group consisting of an aqueous solution, a saline solution, medical-grade water or others.
280. The container according to item 273, wherein the inner cavity comprises one or more matrix materials.
281. The container according to item 273, wherein the inner cavity can circumvent a matrix material.
282. The container according to item 273, wherein the inner cavity comprises one or more matrix materials according to items 1 to 103 (matrix material coated with a pharmaceutical composition by ultrasonic spray technology).
283. The container according to item 273, wherein the inner cavity comprises one or more matrix materials according to items 109 to 201 (matrix material with a pharmaceutical composition).
284. The container according to item 273, wherein the inner cavity comprises one or more matrix materials according to items 207 to 233 (matrix material with thrombin).
285. The container according to item 273, wherein the container comprises one or more handles.
286. The container according to item 285, wherein the container comprises one handle.
287. The container according to item 285, wherein the container comprises two handles.
288. The container according to item 285, wherein the one or more handles are associated with the bottom of the container.
289. The container according to item 285, wherein the one or more handles are associated with the one or more sidewall(s) of the container.
290. The container according to item 285, wherein the one or more handles comprises one or more recesses or indentations for improved grip.
291. The container according to item 273, wherein the one or more sidewall(s) comprises one or more recesses or indentations for improved grip.
292. The container according to item 273, wherein the container comprises one or more inner tray notches for easy handling of product.
293. The container according to item 292, wherein the container comprises one inner tray notches.
294. The container according to item 292, wherein the container comprises two inner tray notches.
295. The container according to item 292, wherein the container comprises three inner tray notches.
296. The container according to item 292, wherein the container comprises four inner tray notches.
297. The container according to item 292, wherein the one or more inner tray notches are associated with the one or more sidewall(s) of the container.
298. The container according to item 273, wherein the lid is peelable (a peel-off lid).
299. The container according to item 273, wherein the lid is reclosable.
300. The container according to item 273, wherein the inner cavity is a sterile environment.
301. The container according to item 273, wherein the container is sterilized by application of dry heat.
302. The container according to item 273, wherein the container is sterilized by application of one or more chemicals.
303. The container according to item 302, wherein the container is sterilized by application of chemical sterilization including use of one or more of the chemicals selected from the group consisting of ethylene oxide gas, ozone, chlorine bleach, glutaraldehyde, formaldehyde, ortho phthalaldehyde, hydrogen peroxide and peracetic acid.
304. The container according to item 273, wherein the container is sterilized by application of high pressure.
305. The container according to item 273, wherein the container is sterilized by application of radiation sterilization such as sterilization using X-rays, gamma rays, UV light, microwaves, electron beam and/or subatomic particles.
306. The container according to item 273, wherein the bottom of the inner cavity is formed as a square.
307. The container according to item 273, wherein the bottom of the inner cavity is formed as a rectangle.
308. The container according to item 273, wherein the bottom of the inner cavity is formed as a triangle.
309. The container according to item 273, wherein the bottom of the inner cavity is formed as a circle.
310. The container according to item 273, wherein the bottom of the inner cavity is formed as an oval.
311. The container according to item 273, wherein the bottom of the inner cavity is formed as a square with dimensions selected from the group consisting of 1 cm×1 cm, 1 cm×2 cm, 1 cm×3 cm, 1 cm×4 cm, 1 cm×5 cm, 1 cm×6 cm, 1 cm×7 cm, 1 cm×8 cm, 1 cm×9 cm, 1 cm×10 cm, 1 cm×15 cm, 1 cm×20 cm, 2 cm×1 cm, 2 cm×2 cm, 2 cm×3 cm, 2 cm×4 cm, 2 cm×5 cm, 2 cm×6 cm, 2 cm×7 cm, 2 cm×8 cm, 2 cm×9 cm, 2 cm×10 cm, 2 cm×15 cm, 2 cm×20 cm, 3 cm×1 cm, 3 cm×2 cm, 3 cm×3 cm, 3 cm×4 cm, 3 cm×5 cm, 3 cm×6 cm, 3 cm×7 cm, 3 cm×8 cm, 3 cm×9 cm, 3 cm×10 cm, 3 cm×15 cm, 3 cm×20 cm, 4 cm×1 cm, 4 cm×2 cm, 4 cm×3 cm, 4 cm×4 cm, 4 cm×5 cm, 4 cm×6 cm, 4 cm×7 cm, 4 cm×8 cm, 4 cm×9 cm, 4 cm×10 cm, 4 cm×15 cm, 4 cm×20 cm, 5 cm×1 cm, 5 cm×2 cm, 5 cm×3 cm, 5 cm×4 cm, 5 cm×5 cm, 5 cm×6 cm, 5 cm×7 cm, 5 cm×8 cm, 5 cm×9 cm, 5 cm×10 cm, 5 cm×15 cm, 5 cm×20 cm, 6 cm×1 cm, 6 cm×2 cm, 6 cm×3 cm, 6 cm×4 cm, 6 cm×5 cm, 6 cm×6 cm, 6 cm×7 cm, 6 cm×8 cm, 6 cm×9 cm, 6 cm×10 cm, 6 cm×15 cm, 6 cm×20 cm, 7 cm×1 cm, 7 cm×2 cm, 7 cm×3 cm, 7 cm×4 cm, 7 cm×5 cm, 7 cm×6 cm, 7 cm×7 cm, 7 cm×8 cm, 7 cm×9 cm, 7 cm×10 cm, 7 cm×15 cm, 7 cm×20 cm, 8 cm×1 cm, 8 cm×2 cm, 8 cm×3 cm, 8 cm×4 cm, 8 cm×5 cm, 8 cm×6 cm, 8 cm×7 cm, 8 cm×8 cm, 8 cm×9 cm, 8 cm×10 cm, 8 cm×15 cm, 8 cm×20 cm, 9 cm×1 cm, 9 cm×2 cm, 9 cm×3 cm, 9 cm×4 cm, 9 cm×5 cm, 9 cm×6 cm, 9 cm×7 cm, 9 cm×8 cm, 9 cm×9 cm, 9 cm×10 cm, 9 cm×15 cm, 9 cm×20 cm, 10 cm×1 cm, 10 cm×2 cm, 10 cm×3 cm, 10 cm×4 cm, 10 cm×5 cm, 10 cm×6 cm, 10 cm×7 cm, 10 cm×8 cm, 10 cm×9 cm, 10 cm×10 cm, 10 cm×15 cm, 10 cm×20 cm, 11 cm×1 cm, 11 cm×2 cm, 11 cm×3 cm, 11 cm×4 cm, 11 cm×5 cm, 11 cm×6 cm, 11 cm×7 cm, 11 cm×8 cm, 11 cm×9 cm, 11 cm×10 cm, 11 cm×15 cm, 11 cm×20 cm, 12 cm×1 cm, 12 cm×2 cm, 12 cm×3 cm, 12 cm×4 cm, 12 cm×5 cm, 12 cm×6 cm, 12 cm×7 cm, 12 cm×8 cm, 12 cm×9 cm, 12 cm×10 cm, 12 cm×15 cm, 12 cm×20 cm, 13 cm×1 cm, 13 cm×2 cm, 13 cm×3 cm, 13 cm×4 cm, 13 cm×5 cm, 13 cm×6 cm, 13 cm×7 cm, 13 cm×8 cm, 13 cm×9 cm, 13 cm×10 cm, 13 cm×15 cm, 13 cm×20 cm, 14 cm×1 cm, 14 cm×2 cm, 14 cm×3 cm, 14 cm×4 cm, 14 cm×5 cm, 14 cm×6 cm, 14 cm×7 cm, 14 cm×8 cm, 14 cm×9 cm, 14 cm×10 cm, 14 cm×15 cm, 14 cm×20 cm, 15 cm×1 cm, 15 cm×2 cm, 15 cm×3 cm, 15 cm×4 cm, 15 cm×5 cm, 15 cm×6 cm, 15 cm×7 cm, 15 cm×8 cm, 15 cm×9 cm, 15 cm×10 cm, 15 cm×15 cm, 15 cm×20 cm, 16 cm×1 cm, 16 cm×2 cm, 16 cm×3 cm, 16 cm×4 cm, 16 cm×5 cm, 16 cm×6 cm, 16 cm×7 cm, 16 cm×8 cm, 16 cm×9 cm, 16 cm×10 cm, 16 cm×15 cm, 16 cm×20 cm, 17 cm×1 cm, 17 cm×2 cm, 17 cm×3 cm, 17 cm×4 cm, 17 cm×5 cm, 17 cm×6 cm, 17 cm×7 cm, 17 cm×8 cm, 17 cm×9 cm, 17 cm×10 cm, 17 cm×15 cm, 17 cm×20 cm, 18 cm×1 cm, 18 cm×2 cm, 18 cm×3 cm, 18 cm×4 cm, 18 cm×5 cm, 18 cm×6 cm, 18 cm×7 cm, 18 cm×8 cm, 18 cm×9 cm, 18 cm×10 cm, 18 cm×15 cm, 18 cm×20 cm, 19 cm×1 cm, 19 cm×2 cm, 19 cm×3 cm, 19 cm×4 cm, 19 cm×5 cm, 19 cm×6 cm, 19 cm×7 cm, 19 cm×8 cm, 19 cm×9 cm, 19 cm×10 cm, 19 cm×15 cm, 19 cm×20 cm, 20 cm×1 cm, 20 cm×2 cm, 20 cm×3 cm, 20 cm×4 cm, 20 cm×5 cm, 20 cm×6 cm, 20 cm×7 cm, 20 cm×8 cm, 20 cm×9 cm, 20 cm×10 cm, 20 cm×15 cm, 20 cm×20 cm, 25 cm×1 cm, 25 cm×2 cm, 25 cm×3 cm, 25 cm×4 cm, 25 cm×5 cm, 25 cm×6 cm, 25 cm×7 cm, 25 cm×8 cm, 25 cm×9 cm, 25 cm×10 cm, 25 cm×15 cm, 25 cm×20 cm, 30 cm×1 cm, 30 cm×2 cm, 30 cm×3 cm, 30 cm×4 cm, 30 cm×5 cm, 30 cm×6 cm, 30 cm×7 cm, 30 cm×8 cm, 30 cm×9 cm, 30 cm×10 cm, 30 cm×15 cm, 30 cm×20 cm, 40 cm×1 cm, 40 cm×2 cm, 40 cm×3 cm, 40 cm×4 cm, 40 cm×5 cm, 40 cm×6 cm, 40 cm×7 cm, 40 cm×8 cm, 40 cm×9 cm, 40 cm×10 cm, 40 cm×15 cm, 40 cm×20 cm, 50 cm×1 cm, 50 cm×2 cm, 50 cm×3 cm, 50 cm×4 cm, 50 cm×5 cm, 50 cm×6 cm, 50 cm×7 cm, 50 cm×8 cm, 50 cm×9 cm, 50 cm×10 cm, 50 cm×15 cm, or 50 cm×20 cm.
312. The container according to item 273, wherein the bottom of the inner cavity is formed as a square with dimensions of between 1 cm² to 500 cm², such as 1 cm² to 5 cm², for example 5 cm² to 10 cm², such as 10 cm² to 20 cm², for example 20 cm² to 30 cm², such as 30 cm² to 40 cm², for example 40 cm² to 50 cm², such as 50 cm² to 60 cm², for example 60 cm² to 70 cm², such as 70 cm² to 80 cm², for example 80 cm² to 90 cm², such as 90 cm² to 100 cm², for example 100 cm² to 110 cm², such as 110 cm² to 120 cm², for example 120 cm² to 130 cm², such as 130 cm² to 140 cm², for example 140 cm² to 150 cm², such as 150 cm² to 160 cm², for example 160 cm² to 170 cm², such as 170 cm² to 180 cm², for example 180 cm² to 190 cm², such as 190 cm² to 200 cm², for example 200 cm² to 210 cm², such as 210 cm² to 220 cm², for example 220 cm² to 230 cm², such as 230 cm² to 240 cm², for example 240 cm² to 250 cm², such as 250 cm² to 260 cm², for example 260 cm² to 270 cm², such as 270 cm² to 280 cm², for example 280 cm² to 290 cm², such as 290 cm² to 300 cm², for example 300 cm² to 320 cm², such as 320 cm² to 340 cm², for example 340 cm² to 360 cm², such as 360 cm² to 380 cm², for example 380 cm² to 400 cm², such as 400 cm² to 420 cm², for example 420 cm² to 440 cm², such as 440 cm² to 460 cm², for example 460 cm² to 480 cm², such as 480 cm² to 500 cm².
313. The container according to item 273, wherein the bottom is formed to circumvent a matrix material shaped as a square with one of the dimensions selected from the group consisting of 1 cm×1 cm, 1 cm×2 cm, 1 cm×3 cm, 1 cm×4 cm, 1 cm×5 cm, 1 cm×6 cm, 1 cm×7 cm, 1 cm×8 cm, 1 cm×9 cm, 1 cm×10 cm, 1 cm×15 cm, 1 cm×20 cm, 2 cm×1 cm, 2 cm×2 cm, 2 cm×3 cm, 2 cm×4 cm, 2 cm×5 cm, 2 cm×6 cm, 2 cm×7 cm, 2 cm×8 cm, 2 cm×9 cm, 2 cm×10 cm, 2 cm×15 cm, 2 cm×20 cm, 3 cm×1 cm, 3 cm×2 cm, 3 cm×3 cm, 3 cm×4 cm, 3 cm×5 cm, 3 cm×6 cm, 3 cm×7 cm, 3 cm×8 cm, 3 cm×9 cm, 3 cm×10 cm, 3 cm×15 cm, 3 cm×20 cm, 4 cm×1 cm, 4 cm×2 cm, 4 cm×3 cm, 4 cm×4 cm, 4 cm×5 cm, 4 cm×6 cm, 4 cm×7 cm, 4 cm×8 cm, 4 cm×9 cm, 4 cm×10 cm, 4 cm×15 cm, 4 cm×20 cm, 5 cm×1 cm, 5 cm×2 cm, 5 cm×3 cm, 5 cm×4 cm, 5 cm×5 cm, 5 cm×6 cm, 5 cm×7 cm, 5 cm×8 cm, 5 cm×9 cm, 5 cm×10 cm, 5 cm×15 cm, 5 cm×20 cm, 6 cm×1 cm, 6 cm×2 cm, 6 cm×3 cm, 6 cm×4 cm, 6 cm×5 cm, 6 cm×6 cm, 6 cm×7 cm, 6 cm×8 cm, 6 cm×9 cm, 6 cm×10 cm, 6 cm×15 cm, 6 cm×20 cm, 7 cm×1 cm, 7 cm×2 cm, 7 cm×3 cm, 7 cm×4 cm, 7 cm×5 cm, 7 cm×6 cm, 7 cm×7 cm, 7 cm×8 cm, 7 cm×9 cm, 7 cm×10 cm, 7 cm×15 cm, 7 cm×20 cm, 8 cm×1 cm, 8 cm×2 cm, 8 cm×3 cm, 8 cm×4 cm, 8 cm×5 cm, 8 cm×6 cm, 8 cm×7 cm, 8 cm×8 cm, 8 cm×9 cm, 8 cm×10 cm, 8 cm×15 cm, 8 cm×20 cm, 9 cm×1 cm, 9 cm×2 cm, 9 cm×3 cm, 9 cm×4 cm, 9 cm×5 cm, 9 cm×6 cm, 9 cm×7 cm, 9 cm×8 cm, 9 cm×9 cm, 9 cm×10 cm, 9 cm×15 cm, 9 cm×20 cm, 10 cm×1 cm, 10 cm×2 cm, 10 cm×3 cm, 10 cm×4 cm, 10 cm×5 cm, 10 cm×6 cm, 10 cm×7 cm, 10 cm×8 cm, 10 cm×9 cm, 10 cm×10 cm, 10 cm×15 cm, 10 cm×20 cm, 11 cm×1 cm, 11 cm×2 cm, 11 cm×3 cm, 11 cm×4 cm, 11 cm×5 cm, 11 cm×6 cm, 11 cm×7 cm, 11 cm×8 cm, 11 cm×9 cm, 11 cm×10 cm, 11 cm×15 cm, 11 cm×20 cm, 12 cm×1 cm, 12 cm×2 cm, 12 cm×3 cm, 12 cm×4 cm, 12 cm×5 cm, 12 cm×6 cm, 12 cm×7 cm, 12 cm×8 cm, 12 cm×9 cm, 12 cm×10 cm, 12 cm×15 cm, 12 cm×20 cm, 13 cm×1 cm, 13 cm×2 cm, 13 cm×3 cm, 13 cm×4 cm, 13 cm×5 cm, 13 cm×6 cm, 13 cm×7 cm, 13 cm×8 cm, 13 cm×9 cm, 13 cm×10 cm, 13 cm×15 cm, 13 cm×20 cm, 14 cm×1 cm, 14 cm×2 cm, 14 cm×3 cm, 14 cm×4 cm, 14 cm×5 cm, 14 cm×6 cm, 14 cm×7 cm, 14 cm×8 cm, 14 cm×9 cm, 14 cm×10 cm, 14 cm×15 cm, 14 cm×20 cm, 15 cm×1 cm, 15 cm×2 cm, 15 cm×3 cm, 15 cm×4 cm, 15 cm×5 cm, 15 cm×6 cm, 15 cm×7 cm, 15 cm×8 cm, 15 cm×9 cm, 15 cm×10 cm, 15 cm×15 cm, 15 cm×20 cm, 16 cm×1 cm, 16 cm×2 cm, 16 cm×3 cm, 16 cm×4 cm, 16 cm×5 cm, 16 cm×6 cm, 16 cm×7 cm, 16 cm×8 cm, 16 cm×9 cm, 16 cm×10 cm, 16 cm×15 cm, 16 cm×20 cm, 17 cm×1 cm, 17 cm×2 cm, 17 cm×3 cm, 17 cm×4 cm, 17 cm×5 cm, 17 cm×6 cm, 17 cm×7 cm, 17 cm×8 cm, 17 cm×9 cm, 17 cm×10 cm, 17 cm×15 cm, 17 cm×20 cm, 18 cm×1 cm, 18 cm×2 cm, 18 cm×3 cm, 18 cm×4 cm, 18 cm×5 cm, 18 cm×6 cm, 18 cm×7 cm, 18 cm×8 cm, 18 cm×9 cm, 18 cm×10 cm, 18 cm×15 cm, 18 cm×20 cm, 19 cm×1 cm, 19 cm×2 cm, 19 cm×3 cm, 19 cm×4 cm, 19 cm×5 cm, 19 cm×6 cm, 19 cm×7 cm, 19 cm×8 cm, 19 cm×9 cm, 19 cm×10 cm, 19 cm×15 cm, 19 cm×20 cm, 20 cm×1 cm, 20 cm×2 cm, 20 cm×3 cm, 20 cm×4 cm, 20 cm×5 cm, 20 cm×6 cm, 20 cm×7 cm, 20 cm×8 cm, 20 cm×9 cm, 20 cm×10 cm, 20 cm×15 cm, 20 cm×20 cm, 25 cm×1 cm, 25 cm×2 cm, 25 cm×3 cm, 25 cm×4 cm, 25 cm×5 cm, 25 cm×6 cm, 25 cm×7 cm, 25 cm×8 cm, 25 cm×9 cm, 25 cm×10 cm, 25 cm×15 cm, 25 cm×20 cm, 30 cm×1 cm, 30 cm×2 cm, 30 cm×3 cm, 30 cm×4 cm, 30 cm×5 cm, 30 cm×6 cm, 30 cm×7 cm, 30 cm×8 cm, 30 cm×9 cm, 30 cm×10 cm, 30 cm×15 cm, 30 cm×20 cm, 40 cm×1 cm, 40 cm×2 cm, 40 cm×3 cm, 40 cm×4 cm, 40 cm×5 cm, 40 cm×6 cm, 40 cm×7 cm, 40 cm×8 cm, 40 cm×9 cm, 40 cm×10 cm, 40 cm×15 cm, 40 cm×20 cm, 50 cm×1 cm, 50 cm×2 cm, 50 cm×3 cm, 50 cm×4 cm, 50 cm×5 cm, 50 cm×6 cm, 50 cm×7 cm, 50 cm×8 cm, 50 cm×9 cm, 50 cm×10 cm, 50 cm×15 cm, or 50 cm×20 cm.
314. The container according to item 273, wherein the bottom is formed to circumvent a matrix material shaped as a square with dimensions of between 1 cm² to 500 cm², such as 1 cm² to 5 cm², for example 5 cm² to 10 cm², such as 10 cm² to 20 cm², for example 20 cm² to 30 cm², such as 30 cm² to 40 cm², for example 40 cm² to 50 cm², such as 50 cm² to 60 cm², for example 60 cm² to 70 cm², such as 70 cm² to 80 cm², for example 80 cm² to 90 cm², such as 90 cm² to 100 cm², for example 100 cm² to 110 cm², such as 110 cm² to 120 cm², for example 120 cm² to 130 cm², such as 130 cm² to 140 cm², for example 140 cm² to 150 cm², such as 150 cm² to 160 cm², for example 160 cm² to 170 cm², such as 170 cm² to 180 cm², for example 180 cm² to 190 cm², such as 190 cm² to 200 cm², for example 200 cm² to 210 cm², such as 210 cm² to 220 cm², for example 220 cm² to 230 cm², such as 230 cm² to 240 cm², for example 240 cm² to 250 cm², such as 250 cm² to 260 cm², for example 260 cm² to 270 cm², such as 270 cm² to 280 cm², for example 280 cm² to 290 cm², such as 290 cm² to 300 cm², for example 300 cm² to 320 cm², such as 320 cm² to 340 cm², for example 340 cm² to 360 cm², such as 360 cm² to 380 cm², for example 380 cm² to 400 cm², such as 400 cm² to 420 cm², for example 420 cm² to 440 cm², such as 440 cm² to 460 cm², for example 460 cm² to 480 cm², such as 480 cm² to 500 cm².
315. The container according to item 273, wherein the bottom is flat.
316. The container according to item 273, wherein the bottom is plane.
317. The container according to item 273, wherein the bottom is curved.
318. The container according to item 273, wherein the bottom is concave.
319. The container according to item 273, wherein the bottom is convex.
320. The container according to item 273, wherein the bottom is not plane.
321. The container according to item 273, wherein the bottom is irregular and/or non-uniform.
322. The container according to item 273, wherein the bottom is rough.
323. The container according to item 273, wherein the height of the sidewall(s) (from the bottom to the mark for maximum filling) is selected from the groups consisting of 0 mm to 2 mm, 2 mm to 4 mm, 4 mm to 6 mm, 6 mm to 8 mm, 8 mm to 10 mm, 10 mm to 12 mm, 12 mm to 14 mm, 14 mm to 16 mm, 16 mm to 18 mm, 18 mm to 20 mm, 20 mm to 22 mm, 22 mm to 24 mm, 24 mm to 26 mm, 26 mm to 28 mm, 28 mm to 30 mm, 30 mm to 32 mm, 32 mm to 34 mm, 34 mm to 36 mm, 36 mm to 38 mm, 38 mm to 40 mm, 40 mm to 42 mm, 42 mm to 44 mm, 44 mm to 46 mm, 46 mm to 48 mm or 48 mm to 50 mm.
324. The container according to item 273, wherein the width of the sidewall(s) is selected from the groups consisting of 0 mm to 2 mm, 2 mm to 4 mm, 4 mm to 6 mm, 6 mm to 8 mm, 8 mm to 10 mm, 10 mm to 12 mm, 12 mm to 14 mm, 14 mm to 16 mm, 16 mm to 18 mm, 18 mm to 20 mm.
325. The container according to item 273, wherein the height from the bottom to the lid is selected from the groups consisting of 0 mm to 2 mm, 2 mm to 4 mm, 4 mm to 6 mm, 6 mm to 8 mm, 8 mm to 10 mm, 10 mm to 12 mm, 12 mm to 14 mm, 14 mm to 16 mm, 16 mm to 18 mm, 18 mm to 20 mm, 20 mm to 22 mm, 22 mm to 24 mm, 24 mm to 26 mm, 26 mm to 28 mm, 28 mm to 30 mm, 30 mm to 32 mm, 32 mm to 34 mm, 34 mm to 36 mm, 36 mm to 38 mm, 38 mm to 40 mm, 40 mm to 42 mm, 42 mm to 44 mm, 44 mm to 46 mm, 46 mm to 48 mm or 48 mm to 50 mm.
326. The container according to item 273, wherein the sealing surface for a lid is comprised in the upper portion of the one or more sidewall(s).
327. The container according to item 273, wherein the container comprises a base.
328. The container according to item 327, wherein the base of the container is formed as a square.
329. The container according to item 327, wherein the base of the container is formed as a rectangle.
330. The container according to item 327, wherein the base of the container is formed as a triangle.
331. The container according to item 327, wherein the base of the container is formed as a circle.
332. The container according to item 327, wherein the base of the container is formed as an oval.
333. The container according to item 327, wherein the base of the container is formed as a square with dimensions selected from the group consisting of 1 cm×1 cm, 1 cm×2 cm, 1 cm×3 cm, 1 cm×4 cm, 1 cm×5 cm, 1 cm×6 cm, 1 cm×7 cm, 1 cm×8 cm, 1 cm×9 cm, 1 cm×10 cm, 1 cm×15 cm, 1 cm×20 cm, 2 cm×1 cm, 2 cm×2 cm, 2 cm×3 cm, 2 cm×4 cm, 2 cm×5 cm, 2 cm×6 cm, 2 cm×7 cm, 2 cm×8 cm, 2 cm×9 cm, 2 cm×10 cm, 2 cm×15 cm, 2 cm×20 cm, 3 cm×1 cm, 3 cm×2 cm, 3 cm×3 cm, 3 cm×4 cm, 3 cm×5 cm, 3 cm×6 cm, 3 cm×7 cm, 3 cm×8 cm, 3 cm×9 cm, 3 cm×10 cm, 3 cm×15 cm, 3 cm×20 cm, 4 cm×1 cm, 4 cm×2 cm, 4 cm×3 cm, 4 cm×4 cm, 4 cm×5 cm, 4 cm×6 cm, 4 cm×7 cm, 4 cm×8 cm, 4 cm×9 cm, 4 cm×10 cm, 4 cm×15 cm, 4 cm×20 cm, 5 cm×1 cm, 5 cm×2 cm, 5 cm×3 cm, 5 cm×4 cm, 5 cm×5 cm, 5 cm×6 cm, 5 cm×7 cm, 5 cm×8 cm, 5 cm×9 cm, 5 cm×10 cm, 5 cm×15 cm, 5 cm×20 cm, 6 cm×1 cm, 6 cm×2 cm, 6 cm×3 cm, 6 cm×4 cm, 6 cm×5 cm, 6 cm×6 cm, 6 cm×7 cm, 6 cm×8 cm, 6 cm×9 cm, 6 cm×10 cm, 6 cm×15 cm, 6 cm×20 cm, 7 cm×1 cm, 7 cm×2 cm, 7 cm×3 cm, 7 cm×4 cm, 7 cm×5 cm, 7 cm×6 cm, 7 cm×7 cm, 7 cm×8 cm, 7 cm×9 cm, 7 cm×10 cm, 7 cm×15 cm, 7 cm×20 cm, 8 cm×1 cm, 8 cm×2 cm, 8 cm×3 cm, 8 cm×4 cm, 8 cm×5 cm, 8 cm×6 cm, 8 cm×7 cm, 8 cm×8 cm, 8 cm×9 cm, 8 cm×10 cm, 8 cm×15 cm, 8 cm×20 cm, 9 cm×1 cm, 9 cm×2 cm, 9 cm×3 cm, 9 cm×4 cm, 9 cm×5 cm, 9 cm×6 cm, 9 cm×7 cm, 9 cm×8 cm, 9 cm×9 cm, 9 cm×10 cm, 9 cm×15 cm, 9 cm×20 cm, 10 cm×1 cm, 10 cm×2 cm, 10 cm×3 cm, 10 cm×4 cm, 10 cm×5 cm, 10 cm×6 cm, 10 cm×7 cm, 10 cm×8 cm, 10 cm×9 cm, 10 cm×10 cm, 10 cm×15 cm, 10 cm×20 cm, 11 cm×1 cm, 11 cm×2 cm, 11 cm×3 cm, 11 cm×4 cm, 11 cm×5 cm, 11 cm×6 cm, 11 cm×7 cm, 11 cm×8 cm, 11 cm×9 cm, 11 cm×10 cm, 11 cm×15 cm, 11 cm×20 cm, 12 cm×1 cm, 12 cm×2 cm, 12 cm×3 cm, 12 cm×4 cm, 12 cm×5 cm, 12 cm×6 cm, 12 cm×7 cm, 12 cm×8 cm, 12 cm×9 cm, 12 cm×10 cm, 12 cm×15 cm, 12 cm×20 cm, 13 cm×1 cm, 13 cm×2 cm, 13 cm×3 cm, 13 cm×4 cm, 13 cm×5 cm, 13 cm×6 cm, 13 cm×7 cm, 13 cm×8 cm, 13 cm×9 cm, 13 cm×10 cm, 13 cm×15 cm, 13 cm×20 cm, 14 cm×1 cm, 14 cm×2 cm, 14 cm×3 cm, 14 cm×4 cm, 14 cm×5 cm, 14 cm×6 cm, 14 cm×7 cm, 14 cm×8 cm, 14 cm×9 cm, 14 cm×10 cm, 14 cm×15 cm, 14 cm×20 cm, 15 cm×1 cm, 15 cm×2 cm, 15 cm×3 cm, 15 cm×4 cm, 15 cm×5 cm, 15 cm×6 cm, 15 cm×7 cm, 15 cm×8 cm, 15 cm×9 cm, 15 cm×10 cm, 15 cm×15 cm, 15 cm×20 cm, 16 cm×1 cm, 16 cm×2 cm, 16 cm×3 cm, 16 cm×4 cm, 16 cm×5 cm, 16 cm×6 cm, 16 cm×7 cm, 16 cm×8 cm, 16 cm×9 cm, 16 cm×10 cm, 16 cm×15 cm, 16 cm×20 cm, 17 cm×1 cm, 17 cm×2 cm, 17 cm×3 cm, 17 cm×4 cm, 17 cm×5 cm, 17 cm×6 cm, 17 cm×7 cm, 17 cm×8 cm, 17 cm×9 cm, 17 cm×10 cm, 17 cm×15 cm, 17 cm×20 cm, 18 cm×1 cm, 18 cm×2 cm, 18 cm×3 cm, 18 cm×4 cm, 18 cm×5 cm, 18 cm×6 cm, 18 cm×7 cm, 18 cm×8 cm, 18 cm×9 cm, 18 cm×10 cm, 18 cm×15 cm, 18 cm×20 cm, 19 cm×1 cm, 19 cm×2 cm, 19 cm×3 cm, 19 cm×4 cm, 19 cm×5 cm, 19 cm×6 cm, 19 cm×7 cm, 19 cm×8 cm, 19 cm×9 cm, 19 cm×10 cm, 19 cm×15 cm, 19 cm×20 cm, 20 cm×1 cm, 20 cm×2 cm, 20 cm×3 cm, 20 cm×4 cm, 20 cm×5 cm, 20 cm×6 cm, 20 cm×7 cm, 20 cm×8 cm, 20 cm×9 cm, 20 cm×10 cm, 20 cm×15 cm, 20 cm×20 cm, 25 cm×1 cm, 25 cm×2 cm, 25 cm×3 cm, 25 cm×4 cm, 25 cm×5 cm, 25 cm×6 cm, 25 cm×7 cm, 25 cm×8 cm, 25 cm×9 cm, 25 cm×10 cm, 25 cm×15 cm, 25 cm×20 cm, 30 cm×1 cm, 30 cm×2 cm, 30 cm×3 cm, 30 cm×4 cm, 30 cm×5 cm, 30 cm×6 cm, 30 cm×7 cm, 30 cm×8 cm, 30 cm×9 cm, 30 cm×10 cm, 30 cm×15 cm, 30 cm×20 cm, 40 cm×1 cm, 40 cm×2 cm, 40 cm×3 cm, 40 cm×4 cm, 40 cm×5 cm, 40 cm×6 cm, 40 cm×7 cm, 40 cm×8 cm, 40 cm×9 cm, 40 cm×10 cm, 40 cm×15 cm, 40 cm×20 cm, 50 cm×1 cm, 50 cm×2 cm, 50 cm×3 cm, 50 cm×4 cm, 50 cm×5 cm, 50 cm×6 cm, 50 cm×7 cm, 50 cm×8 cm, 50 cm×9 cm, 50 cm×10 cm, 50 cm×15 cm, or 50 cm×20 cm.
334. The container according to item 327, wherein the base of the container is formed as a square with dimensions of between 1 cm² to 500 cm², such as 1 cm² to 5 cm², for example 5 cm² to 10 cm², such as 10 cm² to 20 cm², for example 20 cm² to 30 cm², such as 30 cm² to 40 cm², for example 40 cm² to 50 cm², such as 50 cm² to 60 cm², for example 60 cm² to 70 cm², such as 70 cm² to 80 cm², for example 80 cm² to 90 cm², such as 90 cm² to 100 cm², for example 100 cm² to 110 cm², such as 110 cm² to 120 cm², for example 120 cm² to 130 cm², such as 130 cm² to 140 cm², for example 140 cm² to 150 cm², such as 150 cm² to 160 cm², for example 160 cm² to 170 cm², such as 170 cm² to 180 cm², for example 180 cm² to 190 cm², such as 190 cm² to 200 cm², for example 200 cm² to 210 cm², such as 210 cm² to 220 cm², for example 220 cm² to 230 cm², such as 230 cm² to 240 cm², for example 240 cm² to 250 cm², such as 250 cm² to 260 cm², for example 260 cm² to 270 cm², such as 270 cm² to 280 cm², for example 280 cm² to 290 cm², such as 290 cm² to 300 cm², for example 300 cm² to 320 cm², such as 320 cm² to 340 cm², for example 340 cm² to 360 cm², such as 360 cm² to 380 cm², for example 380 cm² to 400 cm², such as 400 cm² to 420 cm², for example 420 cm² to 440 cm², such as 440 cm² to 460 cm², for example 460 cm² to 480 cm², such as 480 cm² to 500 cm².
335. The container according to item 327, wherein the base is contacting the one or more sidewall(s) at one or more points, such as 1, 2, 3, 4, 5, 6, 7, 8, 9 or 10 points.
336. The container according to item 327, wherein the base is contacting the bottom at one or more points, such as 1, 2, 3, 4, 5, 6, 7, 8, 9 or 10 points.
337. The container according to item 327, wherein the base comprises a flat bottom.
338. The container according to item 327, wherein the base comprises one or more handles.
339. The container according to item 327, wherein the base comprises one or more recesses or indentations.
340. The container according to item 327, wherein the base comprises the sealing surface for a lid.
341. The container according to item 327, wherein the base comprises a flat portion.
342. The container according to item 327, wherein the base comprises a plane portion.
343. The container according to item 327, wherein the base comprises a curved portion.
344. The container according to item 327, wherein the base comprises a concave portion.
345. The container according to item 327, wherein the base comprises a convex portion.
346. The container according to item 327, wherein the base is not plane.
347. The container according to item 327, wherein the base is irregular and/or non-uniform.
348. The container according to item 327, wherein the base is rough.
349. The container according to item 327, wherein the base comprises one or more extended base plate(s).
350. The container according to item 327, wherein the base comprises a vertical portion.
351. The container according to item 327, wherein the base comprises a horizontal portion.
352. The container according to item 273, wherein the container is made of or comprises plastic.
353. The container according to item 273, wherein the container is made of or comprises flexible plastic.
354. The container according to item 273, wherein the container is made of or comprises rigid plastic.
355. The container according to item 273, wherein the container is made of or comprises transparent plastic.
356. The container according to item 273, wherein the container is made of or comprises a medical grade polymer such as plastic.
357. The container according to item 273, wherein the container is made of or comprises one or more of the materials selected from the group consisting of Biodegradable plastic, Bioplastics obtained from biomass e.g. from pea starch or from biopetroleum, Polypropylene (PP), Polystyrene (PS), High impact polystyrene (HIPS), Acrylonitrile butadiene styrene (ABS), Polyethylene terephthalate (PET), Amorphous PET (APET), Polyester (PES), Fibers, textiles, Polyamides (PA), (Nylons), Poly(vinyl chloride) (PVC), Polyurethanes (PU), Polycarbonate (PC), Polyvinylidene chloride (PVDC) (Saran), Polyvinylidene Fluoride (PVDF), Polyethylene (PE), Polymethyl methacrylate (PMMA), Polytetrafluoroethylene (PTFE) (trade name Teflon), Fluorinated ethylene propylene (FEP), Polyetheretherketone (PEEK) (Polyetherketone), Polyetherimide (PEI) (Ultem), Phenolics (PF), (phenol formaldehydes), Perfluoroalkoxy (PFA), Poly(methyl methacrylate) (PMMA), Urea-formaldehyde (UF), Melamine formaldehyde (MF), Polylactic acid and Plastarch material or any mixture thereof.
358. The container according to item 273, wherein the container is made of or comprises one or more materials selected from the group consisting of TECAFORM™ AH MT, CELCON® (Acetal Copolymer), RADEL®, TECASON™ P XRO (Polyphenylsulfone, also Radio Opacifer), UDEL® Polysulfone, ULTEM® (Polyetherimide), UHMW Lot Controlled, LENNITE® UHME-PE, TECANAT™ PC (USP Class VI Polycarbonate Rod), ZELUX® GS (Gamma Stabilized Polycarbonate), ACRYLIC (Medical grade Cast Acrylic), TECAMAX™ SRP (Ultra High Performance Thermoplastic), TECAPRO™ MT (Polypropylene Heat Stabilized), TECAPEEK™ MT (USP Class VI compliant), TECAFORM™ AH SAN, ANTIMICROBIAL filled plastics, TECASON™ P XRO (Biocompatible Radio Opacifer PPSU), TECAPEEK™ CLASSIX, POLYSULFONE® (Medical grade), TECANYL™ (Medical grade Noryl®), TYGON® (Medical grade Tubing), TEXOLON™ Medical Grade PTFE (USP CLASS VI), PROPYLUX HS and HS2, ABS (FDA Approved Medical Grades), TOPAS® (Medical grade), and other Medical Grade/FDA approved plastic products.
359. The container according to item 273, wherein the container is made of or comprises one or more polymers of high molecular weight.
360. The container according to item 359, wherein the container is made of or comprises one or more polymers and/or plastics with a molecular weight in the range from 10,000 to 1,000,000 Da, such as from 10,000 to 50,000 Da, for example 50,000 to 100,000 Da, such as from 100,000 to 150,000 Da, for example 150,000 to 200,000 Da, such as from 200,000 to 250,000 Da, for example 250,000 to 238,000 Da, such as from 238,000 to 350,000 Da, for example 350,000 to 400,000 Da, such as from 400,000 to 450,000 Da, for example 450,000 to 500,000 Da, such as from 500,000 to 550,000 Da, for example 550,000 to 600,000 Da, such as from 600,000 to 650,000 Da, for example 650,000 to 700,000 Da, such as from 700,000 to 750,000 Da, for example 750,000 to 800,000 Da, such as from 800,000 to 850,000 Da, for example 850,000 to 900,000 Da, such as from 900,000 to 950,000 Da, for example 950,000 to 1,000,000 Da.
361. The container according to item 273, wherein the container is made of or comprises one or more types of Rubber.
362. The container according to item 273, wherein the container is made of or comprises one or more types of Cellulose-based plastics.
363. The container according to item 273, wherein the container is made of or comprises one or more types of Bakelite.
364. The container according to item 273, wherein the container is made of or comprises one or more types of Polystyrene.
365. The container according to item 273, wherein the container is made of or comprises one or more types of PVC.
366. The container according to item 273, wherein the container is made of or comprises one or more types of Nylon.
367. The container according to item 273, wherein the container is made of or comprises one or more types of Synthetic rubber.
368. The container according to item 273, wherein the container is made of or comprises one or more acrylics.
369. The container according to item 273, wherein the container is made of or comprises one or more polyesters.
370. The container according to item 273, wherein the container is made of or comprises one or more silicones.
371. The container according to item 273, wherein the container is made of or comprises one or more polyurethanes.
372. The container according to item 273, wherein the container is made of or comprises one or more halogenated plastics.
373. The container according to item 273, wherein the one or more sidewalls and/or bottom is made of or comprises plastic.
374. The container according to item 273, wherein the one or more sidewalls and/or bottom is made of or comprises flexible plastic.
375. The container according to item 273, wherein the one or more sidewalls and/or bottom is made of or comprises rigid plastic.
376. The container according to item 273, wherein the one or more sidewalls and/or bottom is made of or comprises transparent plastic.
377. The container according to item 273, wherein the one or more sidewalls and/or bottom is made of or comprises medical grade polymer such as plastic.
378. The container according to item 273, wherein the one or more sidewalls and/or bottom is made of or comprises one or more materials selected from the group consisting of Biodegradable plastic, Bioplastics obtained from biomass e.g. from pea starch or from biopetroleum, Polypropylene (PP), Polystyrene (PS), High impact polystyrene (HIPS), Acrylonitrile butadiene styrene (ABS), Polyethylene terephthalate (PET), Amorphous PET (APET), Polyester (PES), Fibers, textiles, Polyamides (PA), (Nylons), Poly(vinyl chloride) (PVC), Polyurethanes (PU), Polycarbonate (PC), Polyvinylidene chloride (PVDC) (Saran), Polyvinylidene Fluoride (PVDF), Polyethylene (PE), Polymethyl methacrylate (PMMA), Polytetrafluoroethylene (PTFE) (trade name Teflon), Fluorinated ethylene propylene (FEP), Polyetheretherketone (PEEK) (Polyetherketone), Polyetherimide (PEI) (Ultem), Phenolics (PF), (phenol formaldehydes), Perfluoroalkoxy (PFA), Poly(methyl methacrylate) (PMMA), Urea-formaldehyde (UF), Melamine formaldehyde (MF), Polylactic acid and Plastarch material or any mixture thereof.
379. The container according to item 273, wherein the one or more sidewalls and/or bottom is made of or comprises one or more of the materials selected from the group consisting of TECAFORM™ AH MT, CELCON® (Acetal Copolymer), RADEL®, TECASON™ P XRO (Polyphenylsulfone, also Radio Opacifer), UDEL® Polysulfone, ULTEM® (Polyetherimide), UHMW Lot Controlled, LENNITE® UHME-PE. TECANAT™ PC (USP Class VI Polycarbonate Rod), ZELUX® GS (Gamma Stabilized Polycarbonate), ACRYLIC (Medical grade Cast Acrylic), TECAMAX™ SRP (Ultra High Performance Thermoplastic), TECAPRO™ MT (Polypropylene Heat Stabilized), TECAPEEK™ MT (USP Class VI compliant), TECAFORM™ AH SAN, ANTIMICROBIAL filled plastics, TECASON™ P XRO (Biocompatible Radio Opacifer PPSU), TECAPEEK™ CLASSIX, POLYSULFONE® (Medical grade), TECANYL™ (Medical grade Noryl®), TYGON® (Medical grade Tubing), TEXOLON™ Medical Grade PTFE (USP CLASS VI), PROPYLUX HS and HS2, ABS (FDA Approved Medical Grades), TOPAS® (Medical grade), and other Medical Grade/FDA approved plastic products.
380. The container according to item 273, wherein the one or more sidewalls and/or bottom is made of or comprises one or more polymers of high molecular weight.
381. The container according to item 380, wherein the one or more sidewalls and/or bottom is made of or comprises one or more polymers and/or plastics with a molecular weight in the range from 10,000 to 1,000,000 Da, such as from 10,000 to 50,000 Da, for example 50,000 to 100,000 Da, such as from 100,000 to 150,000 Da, for example 150,000 to 200,000 Da, such as from 200,000 to 250,000 Da, for example 250,000 to 238,000 Da, such as from 238,000 to 350,000 Da, for example 350,000 to 400,000 Da, such as from 400,000 to 450,000 Da, for example 450,000 to 500,000 Da, such as from 500,000 to 550,000 Da, for example 550,000 to 600,000 Da, such as from 600,000 to 650,000 Da, for example 650,000 to 700,000 Da, such as from 700,000 to 750,000 Da, for example 750,000 to 800,000 Da, such as from 800,000 to 850,000 Da, for example 850,000 to 900,000 Da, such as from 900,000 to 950,000 Da, for example 950,000 to 1,000,000 Da.
382. The container according to item 273, wherein the one or more sidewalls and/or bottom is made of or comprises one or more types of Rubber.
383. The container according to item 273, wherein the one or more sidewalls and/or bottom is made of or comprises one or more types of Cellulose-based plastics.
384. The container according to item 273, wherein the one or more sidewalls and/or bottom is made of or comprises one or more types of Bakelite.
385. The container according to item 273, wherein the one or more sidewalls and/or bottom is made of or comprises one or more types of Polystyrene.
386. The container according to item 273, wherein the one or more sidewalls and/or bottom is made of or comprises one or more types of PVC.
387. The container according to item 273, wherein the one or more sidewalls and/or bottom is made of or comprises one or more types of Nylon.
388. The container according to item 273, wherein the one or more sidewalls and/or bottom is made of or comprises one or more types of Synthetic rubber.
389. The container according to item 273, wherein the one or more sidewalls and/or bottom is made of or comprises one or more acrylics.
390. The container according to item 273, wherein the one or more sidewalls and/or bottom is made of or comprises one or more polyesters.
391. The container according to item 273, wherein the one or more sidewalls and/or bottom is made of or comprises one or more silicones.
392. The container according to item 273, wherein the one or more sidewalls and/or bottom is made of or comprises one or more polyurethanes.
393. The container according to item 273, wherein the one or more sidewalls and/or bottom is made of or comprises one or more halogenated plastics.
394. The container according to item 273, wherein the lid is made of or comprises a peelable material.
395. The container according to item 394, wherein the peelable material is selected from the group consisting of polyethylene (PE), thermoplastic elastomer, thermoset elastomer, Tyvek, Teslin, paper, plastic foil or metal foil.
396. The container according to item 394, wherein the lid is reinforced with a coating, such as a synthetic coating.
397. The container according to item 396, wherein the synthetic coating is selected from the group consisting of Perfluorooctanoic acid (PFOA), hydrocarbon based petrochemicals, zein or others.
398. The container according to item 273, wherein the lid is made of or comprises plastic.
399. The container according to item 273, wherein the lid is made of or comprises flexible plastic.
400. The container according to item 273, wherein the lid is made of or comprises rigid plastic.
401. The container according to item 273, wherein the lid is made of or comprises transparent plastic.
402. The container according to item 273, wherein the lid is made of or comprises medical grade polymer such as plastic.
403. The container according to item 273, wherein the lid is made of or comprises one or more materials selected from the group consisting of Biodegradable plastic, Bioplastics obtained from biomass e.g. from pea starch or from biopetroleum, Polypropylene (PP), Polystyrene (PS), High impact polystyrene (HIPS), Acrylonitrile butadiene styrene (ABS), Polyethylene terephthalate (PET), Amorphous PET (APET), Polyester (PES), Fibers, textiles, Polyamides (PA), (Nylons), Poly(vinyl chloride) (PVC), Polyurethanes (PU), Polycarbonate (PC), Polyvinylidene chloride (PVDC) (Saran), Polyvinylidene Fluoride (PVDF), Polyethylene (PE), Polymethyl methacrylate (PMMA), Polytetrafluoroethylene (PTFE) (trade name Teflon), Fluorinated ethylene propylene (FEP), Polyetheretherketone (PEEK) (Polyetherketone), Polyetherimide (PEI) (Ultem), Phenolics (PF), (phenol formaldehydes), Perfluoroalkoxy (PFA), Poly(methyl methacrylate) (PMMA), Urea-formaldehyde (UF), Melamine formaldehyde (MF), Polylactic acid and Plastarch material or any mixture thereof.
404. The container according to item 273, wherein the lid is made of or comprises one or more of the materials selected from the group consisting of TECAFORM™ AH MT, CELCON® (Acetal Copolymer), RADEL®, TECASON™ P XRO (Polyphenylsulfone, also Radio Opacifer), UDEL® Polysulfone, ULTEM® (Polyetherimide), UHMW Lot Controlled, LENNITE® UHME-PE, TECANAT™ PC (USP Class VI Polycarbonate Rod), ZELUX® GS (Gamma Stabilized Polycarbonate), ACRYLIC (Medical grade Cast Acrylic), TECAMAX™ SRP (Ultra High Performance Thermoplastic), TECAPRO™ MT (Polypropylene Heat Stabilized), TECAPEEK™ MT (USP Class VI compliant), TECAFORM™ AH SAN, ANTIMICROBIAL filled plastics, TECASON™ P XRO (Biocompatible Radio Opacifer PPSU), TECAPEEK™ CLASSIX, POLYSULFONE® (Medical grade), TECANYL™ (Medical grade Noryl®), TYGON® (Medical grade Tubing), TEXOLON™ Medical Grade PTFE (USP CLASS VI), PROPYLUX HS and HS2, ABS (FDA Approved Medical Grades), TOPAS® (Medical grade), and other Medical Grade/FDA approved plastic products.
405. The container according to item 273, wherein the lid is made of or comprises one or more polymers of high molecular weight.
406. The container according to item 405, wherein the lid is made of or comprises one or more polymers and/or plastics with a molecular weight in the range from 10,000 to 1,000,000 Da, such as from 10,000 to 50,000 Da, for example 50,000 to 100,000 Da, such as from 100,000 to 150,000 Da, for example 150,000 to 200,000 Da, such as from 200,000 to 250,000 Da, for example 250,000 to 238,000 Da, such as from 238,000 to 350,000 Da, for example 350,000 to 400,000 Da, such as from 400,000 to 450,000 Da, for example 450,000 to 500,000 Da, such as from 500,000 to 550,000 Da, for example 550,000 to 600,000 Da, such as from 600,000 to 650,000 Da, for example 650,000 to 700,000 Da, such as from 700,000 to 750,000 Da, for example 750,000 to 800,000 Da, such as from 800,000 to 850,000 Da, for example 850,000 to 900,000 Da, such as from 900,000 to 950,000 Da, for example 950,000 to 1,000,000 Da.
407. The container according to item 273, wherein the lid is made of or comprises one or more types of Rubber.
408. The container according to item 273, wherein the lid is made of or comprises one or more types of Cellulose-based plastics.
409. The container according to item 273, wherein the lid is made of or comprises one or more types of Bakelite.
410. The container according to item 273, wherein the lid is made of or comprises one or more types of Polystyrene.
411. The container according to item 273, wherein the lid is made of or comprises one or more types of PVC.
412. The container according to item 273, wherein the lid is made of or comprises one or more types of Nylon.
413. The container according to item 273, wherein the lid is made of or comprises one or more types of Synthetic rubber.
414. The container according to item 273, wherein the lid is made of or comprises one or more acrylics.
415. The container according to item 273, wherein the lid is made of or comprises one or more polyesters.
416. The container according to item 273, wherein the lid is made of or comprises one or more silicones.
417. The container according to item 273, wherein the lid is made of or comprises one or more polyurethanes.
418. The container according to item 273, wherein the lid is made of or comprises one or more halogenated plastics.
419. The container according to item 327, wherein the base is made of or comprises plastic.
420. The container according to item 327, wherein the base is made of or comprises flexible plastic.
421. The container according to item 327, wherein the base is made of or comprises transparent plastic.
422. The container according to item 327, wherein the base is made of or comprises medical grade polymer such as plastic.
423. The container according to item 327, wherein the base is made of or comprises one or more materials selected from the group consisting of TECAFORM™ AH MT, CELCON® (Acetal Copolymer), RADEL®, TECASON™ P XRO (Polyphenylsulfone, also Radio Opacifer), UDEL® Polysulfone, ULTEM® (Polyetherimide), UHMW Lot Controlled, LENNITE® UHME-PE, TECANAT™ PC (USP Class VI Polycarbonate Rod), ZELUX® GS (Gamma Stabilized Polycarbonate), ACRYLIC (Medical grade Cast Acrylic), TECAMAX™ SRP (Ultra High Performance Thermoplastic), TECAPRO™ MT (Polypropylene Heat Stabilized), TECAPEEK™ MT (USP Class VI compliant), TECAFORM™ AH SAN, ANTIMICROBIAL filled plastics, TECASON™ P XRO (Biocompatible Radio Opacifer PPSU), TECAPEEK™ CLASSIX, POLYSULFONE® (Medical grade), TECANYL™ (Medical grade Noryl®), TYGON® (Medical grade Tubing), TEXOLON™ Medical Grade PTFE (USP CLASS VI), PROPYLUX HS and HS2, ABS (FDA Approved Medical Grades), TOPAS® (Medical grade), and other Medical Grade/FDA approved plastic products.
424. The container according to item 327, wherein the base is made of or comprises one or more of the materials selected from the group consisting of Biodegradable plastic, Bioplastics obtained from biomass e.g. from pea starch or from biopetroleum, Polypropylene (PP), Polystyrene (PS), High impact polystyrene (HIPS), Acrylonitrile butadiene styrene (ABS), Polyethylene terephthalate (PET), Amorphous PET (APET), Polyester (PES), Fibers, textiles, Polyamides (PA), (Nylons), Poly(vinyl chloride) (PVC), Polyurethanes (PU), Polycarbonate (PC), Polyvinylidene chloride (PVDC) (Saran), Polyvinylidene Fluoride (PVDF), Polyethylene (PE), Polymethyl methacrylate (PMMA), Polytetrafluoroethylene (PTFE) (trade name Teflon), Fluorinated ethylene propylene (FEP), Polyetheretherketone (PEEK) (Polyetherketone), Polyetherimide (PEI) (Ultem), Phenolics (PF), (phenol formaldehydes), Perfluoroalkoxy (PFA), Poly(methyl methacrylate) (PMMA), Urea-formaldehyde (UF), Melamine formaldehyde (MF), Polylactic acid and Plastarch material or any mixture thereof.
425. The container according to item 327, wherein the base is made of or comprises one or more polymers of high molecular weight.
426. The container according to item 425, wherein the base is made of or comprises one or more polymers and/or plastics with a molecular weight in the range from 10,000 to 1,000,000 Da, such as from 10,000 to 50,000 Da, for example 50,000 to 100,000 Da, such as from 100,000 to 150,000 Da, for example 150,000 to 200,000 Da, such as from 200,000 to 250,000 Da, for example 250,000 to 238,000 Da, such as from 238,000 to 350,000 Da, for example 350,000 to 400,000 Da, such as from 400,000 to 450,000 Da, for example 450,000 to 500,000 Da, such as from 500,000 to 550,000 Da, for example 550,000 to 600,000 Da, such as from 600,000 to 650,000 Da, for example 650,000 to 700,000 Da, such as from 700,000 to 750,000 Da, for example 750,000 to 800,000 Da, such as from 800,000 to 850,000 Da, for example 850,000 to 900,000 Da, such as from 900,000 to 950,000 Da, for example 950,000 to 1,000,000 Da.
427. The container according to item 327, wherein the base is made of or comprises one or more types of Rubber.
428. The container according to item 327, wherein the base is made of or comprises one or more types of Cellulose-based plastics.
429. The container according to item 327, wherein the base is made of or comprises one or more types of Bakelite.
430. The container according to item 327, wherein the base is made of or comprises one or more types of Polystyrene.
431. The container according to item 327, wherein the base is made of or comprises one or more types of PVC.
432. The container according to item 327, wherein the base is made of or comprises one or more types of Nylon.
433. The container according to item 327, wherein the base is made of or comprises one or more types of Synthetic rubber.
434. The container according to item 327, wherein the base is made of or comprises one or more acrylics.
435. The container according to item 327, wherein the base is made of or comprises one or more polyesters.
436. The container according to item 327, wherein the base is made of or comprises one or more silicones.
437. The container according to item 327, wherein the base is made of or comprises one or more polyurethanes.
438. The container according to item 327, wherein the base is made of or comprises one or more halogenated plastics.
439. The container according to item 273, wherein the container comprises an inner cavity where the maximum volume of liquid that can be added to the inner cavity comprising a matrix material is in range of from 5% to 50% of the volume of the matrix material such as from 5% to 6%, for example from 6% to 7%, such as from 7% to 8%, for example from 8% to 9%, such as from 9% to 10%, for example from 10% to 11%, such as from 11% to 12%, for example from 12% to 13%, such as from 13% to 14%, for example from 14% to 15%, such as from 15% to 16%, for example from 16% to 17%, such as from 17% to 18%, for example from 18% to 19%, such as from 19% to 20%, for example from 20% to 21%, such as from 21% to 22%, for example from 22% to 23%, such as from 23% to 24%, for example from 24% to 25%, such as from 25% to 26%, for example from 26% to 27%, such as from 27% to 28%, for example from 28% to 29%, such as from 29% to 30%, for example from 30% to 31%, such as from 31% to 32%, for example from 32% to 33%, such as from 33% to 34%, for example from 34% to 35%, such as from 35% to 36%, for example from 36% to 37%, such as from 37% to 38%, for example from 38% to 39%, such as from 39% to 40%, for example from 40% to 41%, such as from 41% to 42%, for example from 42% to 43%, such as from 43% to 44%, for example from 44% to 45%, such as from 45% to 46%, for example from 46% to 47%, such as from 47% to 48%, for example from 48% to 49%, or such as from 49% to 50%.
440. A kit of parts comprising a matrix material according to any of the items 1 to 138, 144 to 235 and 241 to 267 and at least one additional component.
441. The kit of part according to item 440, wherein the one additional component is the container according to items 273 to 439.
442. A kit of parts comprising the matrix material according to any of the items 1 to 138 and the container according to items 273 to 439.
443. A method for making the kit of parts according to any of items 440 to 442.
444. Use of the kit of parts according to any of items 440 to 442 in a method for promoting wound healing in an individual in need thereof.
445. Use of the kit of parts according to any of items 440 to 442 in a method for promoting hemostasis in an individual in need thereof.
446. A method for use of the kit of parts according to any of items 440 to 442 comprising the steps of
   i) storing of the matrix material in the container
   ii) opening of said container
   iii) optional addition of liquid/moisture to container comprising the matrix material
   iv) transfer of said matrix material to an individual in need thereof
   to promote wound healing in the individual in need thereof.
447. A method for use of the kit of parts according to any of items 440 to 442 comprising the steps of
   i) storing of the matrix material in the container
   ii) opening of said container
   iii) optional addition of liquid/moisture to container comprising the matrix material
   iv) transfer of said matrix material to an individual in need thereof
   to promote hemostasis in the individual in need thereof.
448. The method according to any of items 446 or 447, wherein the addition of liquid/moisture comprises addition of a volume of liquid/moisture in range of from 5% to 50% of the volume of the matrix material such as from 5% to 6%, for example from 6% to 7%, such as from 7% to 8%, for example from 8% to 9%, such as from 9% to 10%, for example from 10% to 11%, such as from 11% to 12%, for example from 12% to 13%, such as from 13% to 14%, for example from 14% to 15%, such as from 15% to 16%, for example from 16% to 17%, such as from 17% to 18%, for example from 18% to 19%, such as from 19% to 20%, for example from 20% to 21%, such as from 21% to 22%, for example from 22% to 23%, such as from 23% to 24%, for example from 24% to 25%, such as from 25% to 26%, for example from 26% to 27%, such as from 27% to 28%, for example from 28% to 29%, such as from 29% to 30%, for example from 30% to 31%, such as from 31% to 32%, for example from 32% to 33%, such as from 33% to 34%, for example from 34% to 35%, such as from 35% to 36%, for example from 36% to 37%, such as from 37% to 38%, for example from 38% to 39%, such as from 39% to 40%, for example from 40% to 41%, such as from 41% to 42%, for example from 42% to 43%, such as from 43% to 44%, for example from 44% to 45%, such as from 45% to 46%, for example from 46% to 47%, such as from 47% to 48%, for example from 48% to 49%, or such as from 49% to 50%.
449. The method according to any of items 446 or 447, wherein the liquid/moisture added to the container comprising the matrix material is a sterile saline solution.
450. The method according to item 449, wherein the sterile saline solution is a sterile sodium chloride solution.
451. The method according to item 450, wherein the sterile sodium chloride solution is a sterile sodium chloride 0.9% solution.
452. The method according to any of items 446 or 447, wherein the liquid/moisture added to the container comprising the matrix material is sterile water.

The present invention is in one embodiment characterized by one or more of the items in item set number 2 herein below.

### Item Set Number 2:

1. A matrix material comprising a surface and a plurality of open and interconnected cells, wherein the surface of said matrix comprises at least one pharmaceutical composition applied by ultrasonic spray technology onto said surface.
2. The matrix material according to item 1, wherein the matrix comprises one or more polymers.
3. The matrix material according to item 2, wherein the polymers are selected from collagen and gelatin.
4. The matrix material according to item 1, wherein the surface of the matrix contains less than 100 IU/cm² of the pharmaceutical composition, such as less than 95, for example less than 90, such as 85, for example less than 80, such as less than 75, for example less than 70, such as 65, for example less than 60, such as less than 55, for example less than 50, such as 45, for example less than 40, such as less than 35, for example less than 30, such as 25, for example less than 20, such as less than 15, for example less than 10, such as 5, for example less than 1 IU/cm² of the pharmaceutical composition.
5. The matrix material according to item 1, wherein the matrix material is a sponge.
6. The matrix material according to item 5, wherein the sponge is a gelatin or collagen sponge.
7. The matrix material according to item 1, wherein the matrix material is sterile and contained in a sterile, pre-packaged, ready-to-use container.
8. The matrix material according to item 1, wherein the pharmaceutical composition comprises one or more bioactive agent(s).
9. The matrix material according to item 1, wherein the pharmaceutical composition comprises one or more bioactive agent(s) that stimulates hemostasis.
10. The matrix material according to item 1, wherein the pharmaceutical composition comprises one or more bioactive agent(s) that stimulates wound healing.
11. The matrix material according to item 1, wherein the pharmaceutical composition comprises one or more bioactive agent(s) that stimulates wound healing by inhibition of one or more infections of the wound.
12. The matrix material according to item 1, wherein the pharmaceutical composition comprises one or more bioactive agent(s) which comprises one or more anti-fibrinolytic agents.
13. The matrix material according to item 1, wherein the pharmaceutical composition comprises one or more bioactive agent(s) which comprises one or more pro-coagulants.
14. The matrix material according to item 1, wherein the pharmaceutical composition comprises one or more bioactive agent(s) that stimulates one or more coagulation factors.
15. The matrix material according to item 1, wherein the pharmaceutical composition comprises thrombin.
16. The matrix material according to item 15, wherein the matrix contains less than 300 IU thrombin per square cm (cm²) surface area, such as less than 290, for example less than 280, such as 270, for example less than 260, such as less than 250, for example less than 240, such as 230, for example less than 220, such as less than 210, for example less than 200, such as 190, for example less than 180, such as less than 170, for example less than 160, such as 150, for example less than 140, such as less than 130, for example less than 120, such as 110, for example less than 100 IU/cm², such as less than 95, for example less than 90, such as 85, for example less than 80, such as less than 75, for example less than 70, such as 65, for example less than 60, such as less than 55, for example less than 50, such as 45, for example less than 40, such as less than 35, for example less than 30, such as 25, for example less than 20, such as less than 15, for example less than 10, such as 5, for example less than 1 IU/cm².
17. The matrix material according to item 1, wherein the pharmaceutical composition is applied by ultrasonic spray technology onto the surface of the matrix material by deposition of an amount of liquid per position of less than 100 nL, such as less than 90 nL, for example less than 80 nL, such as less than 70 nL, for example less than 60 nL, such as less than 50 nL, for example less than 40 nL, such as less than 30 nL, for example less than 20 nL, such as less than 10 nL, for example less than 1 nL or 1000 pL, such as less than 900 pL, for example less than 800 pL, such as less than 700 pL, for example less than 600 pL, such as less than 500 pL, for example less than 400 pL, such as less than 300 pL, for example less than 250 pL, such as less than 200 pL, for example less than 150 pL, such as less than 100 pL, for example less than 90 pL, such as less than 80 pL, for example less than 70 pL, such as less than 60 pL, for example less than 50 pL, such as less than 40 pL, for example less than 30 pL, such as less than 20 pL, for example less than 10 pL, such as less than 9 pL, for example less than 8 pL, such as less than 7 pL, for example less than 6 pL, such as less than 5 pL, for example less than 4 pL, such as less than 3 pL, for example less than 2 pL, such as less than 1 pL per position.
18. The matrix material according to item 1, wherein the pharmaceutical composition comprises one or more adhesive agents.
19. The matrix material according to item 1, wherein the pharmaceutical composition comprises a solvent component and/or a fluid component.
20. The matrix material according to item 19, wherein the solvent component and/or fluid component is an aqueous medium.
21. The matrix material according to item 1, wherein the pharmaceutical composition has a viscosity in the range of 0.1-20 cps; for example 0.1-1 cps, such as 1-2 cps, for example 2-3 cps, such as 3-4 cps, for example 4-5 cps, such as 5-6 cps, for example 6-7 cps, such as 7-8 cps, for example 8-9 cps, such as 9-10 cps, for example 10-11 cps, such as 11-12 cps, for example 12-13 cps, such as 13-14 cps, for example 14-15 cps, such as 15-16 cps, for example 16-17 cps, such as 17-18 cps, for example 18-19 cps, such as 19-20 cps.
22. The matrix material according to item 1, wherein the pharmaceutical composition has a surface tension in the range of 0.020 to 0.050 N/m; for example 0.020-0.022 N/m, such as 0.022-0.024 N/m, for example 0.024-0.026 N/m, such as 0.026-0.028 N/m, for example 0.028-0.030 N/m, such as 0.030-0.032 N/m, for example 0.032-0.034 N/m, such as 0.034-0.036 N/m, for example 0.036-0.038 N/m, such as 0.038-0.040 N/m, for example 0.040-0.042 N/m, such as 0.042-0.044 N/m, for example 0.044-0.046 N/m, such as 0.046-0.048 N/m, for example 0.048-0.050 N/m.
23. The matrix material according to item 1, wherein the pharmaceutical composition comprises one bioactive agent.
24. The matrix material according to item 1, wherein the pharmaceutical composition comprises two or more agents or bioactive agents.
25. The matrix material according to item 1, wherein the surface of the matrix material comprises two or more different pharmaceutical compositions each comprising one or more agents or bioactive agents.
26. A matrix according to any of items 1 to 25, said matrix being obtained by a method comprising the steps of providing a matrix material and applying by ultrasonic spray technology said at least one pharmaceutical composition onto the surface of said matrix material.
27. The matrix according to item 26, wherein said method essentially does not alter the physical characteristics of the surface of said matrix.
28. The matrix according to item 26, wherein said method essentially does not cause any swelling of the matrix.
29. The matrix according to item 26, wherein said method essentially does not cause any swelling of the surface of said matrix.
30. The matrix according to item 26, wherein said method essentially does not alter the initial absorption rate of the matrix.
31. The matrix according to item 26, wherein application of the pharmaceutical composition by ultrasonic spray technology occurs essentially perpendicular to the surface of said matrix material.
32. A device comprising the matrix material applied by ultrasonic spray technology with a pharmaceutical composition according to items 1-31.
33. A kit of parts comprising the device according to item 32 and at least one additional component.
34. A method for making the device according to item 32 comprising the steps of
   a. providing a matrix material, and
   b. applying by ultrasonic spray technology a pharmaceutical composition onto the surface of said matrix material.
35. Use of the device according to item 32 to promote wound healing in an individual in need thereof
36. Use of the device according to item 32 to promote hemostasis in an individual in need thereof
37. A matrix material comprising a surface and a plurality of open and interconnected cells, wherein one or more pharmaceutical compositions have been applied onto said matrix material.
38. A matrix material comprising a surface and a plurality of open and interconnected cells, wherein said matrix material comprises a hemostatically effective amount of thrombin or a precursor thereof.
39. A container for storage and/or preparation of a matrix material comprising
   i) a bottom,
   ii) one or more sidewall(s) continuously surrounding said bottom, iii) a sealing surface for a lid, and
   iv) a lid,
   wherein the one or more sidewall(s) and the bottom defines an inner cavity suitable for storage and/or preparation of a matrix material.
40. The container according to item 39, wherein the inner cavity comprises one or more matrix materials according to items 1 to 25 (matrix material coated with a pharmaceutical composition by ultrasonic spray technology).
41. The container according to item 39, wherein the inner cavity comprises one or more matrix materials according to item 37 (matrix material with a pharmaceutical composition).
42. The container according to item 39, wherein the inner cavity comprises one or more matrix materials according to item 38 (matrix material with thrombin).
43. A kit of parts comprising a matrix material according to any of the items 1 to 25, 37 and 38 and at least one additional component.
44. The kit of part according to item 43, wherein the one additional component is the container according to item 39.

The present invention is in one embodiment characterized by one or more of the items in item set number 3 herein below.

### Item Set Number 3:

1. A method for coating of a matrix or the surface of a matrix with a pharmaceutical composition comprising one or more bioactive agents, said method comprising use of ultrasonic spray technology.
2. The method of any of the preceding items, wherein said matrix or matrices have one or more surfaces to coat.
3. The method of any of the preceding items, wherein said one or more surfaces to be coated on said one or more matrices has a surface area of 7 cm², 12 cm², 50 cm² or 100 cm².
4. The method of any of the preceding items, wherein said one or more surfaces to be coated has a surface area in the range of 5 cm² to 150 cm², such as from 5 cm² to 10 cm², for example from 10 cm² to 15 cm², such as from 15 cm² to 20 cm², for example from 20 cm² to 25 cm² such as from 25 cm² to 30 cm², for example from 30 cm² to 35 cm² such as from 35 cm² to 40 cm², for example from 40 cm² to 45 cm² such as from 45 cm² to 50 cm², for example from 50 cm² to 55 cm² such as from 55 cm² to 60 cm², for example from 60 cm² to 65 cm² such as from 65 cm² to 70 cm², for example from 70 cm² to 75 cm² such as from 75 cm² to 80 cm², for example from 80 cm² to 85 cm² such as from 85 cm² to 90 cm², for example from 90 cm² to 95 cm² such as from 95 cm² to 100 cm², for example from 100 cm² to 105 cm², such as from 105 cm² to 110 cm², for example from 110 cm² to 115 cm², such as from 115 cm² to 120 cm², for example from 120 cm² to 125 cm², such as from 125 cm² to 130 cm², for example from 130 cm² to 135 cm², such as from 135 cm² to 140 cm², for example from 140 cm² to 145 cm², such as from 145 cm² to 150 cm².
5. The method of any of the preceding items, wherein said matrix or matrices comprise one or more polymers.
6. The method of item 5, wherein said polymers are cross-linked.
7. The method of item 5, wherein said polymers are not cross-linked.
8. The method of any of the preceding items 5-7, wherein said polymers are selected from the group consisting of collagen, gelatin, polyurethane, polysiloxanes (silicone), hydrogels, polyacrylamides, chitosan, sodium polyacrylate, agarose, alginates, xanthan gum, guar gum, arabic gum, agar gum, Locust Bean gum, Carrageenan gum, Xanthan gum, Karaya gum, tragacanth gum, Ghatti gum, Furcelleran gum, chitin, cellulose, methylcellulose, carboxymethyl cellulose, hydroxymethyl cellulose, hydroxypropyl methylcellulose, hydroxypropyl cellulose, hyaluronic acid, pectin, starch, glycogen, pentosans, polyoxyethylene, polyAMPS (poly(2-acrylamido-2-methyl-1-propanesulfonic acid), polyvinylpyrrolidone, polyvinyl alcohol, polyglycolic acid, polyacetic acid, acrylate polymers, polyhydroxyalkyl acrylates, methacrylates, polyvinyl lactams, polyvinyl alcohols, polyoxyalkylenes, polyacrylamides, polyacrylic acid, polystyrene sulfonates, synthetic hydrocolloids such as N-vinyl-2-pyrrolidone, 5-methyl-N-vinyl-2-pyrrolidone, 5-ethyl-N-vinyl-2-pyrrolidone, 3,3-dimethyl-N-vinyl-2-pyrrolidone, 3-methyl-N-vinyl-2-pyrrolidone, 3-ethyl-N-vinyl-2-pyrrolidone, 4-methyl-N-vinyl-2-pyrrolidone, 4-ethyl-N-vinyl-2-pyrrolidone, N-vinyl-2-valerolactam, N-vinyl-2-caprolactam, hydroxyalkyl acrylates and methacrylates, (such as 2-hydroxyethyl acrylate, 2-hydroxyethyl methacrylate, 2-hydroxypropyl acrylate, 2-hydroxypropyl methacrylate, 2,3-dihydroxypropyl methacrylate), acrylic acid, methacrylic acid, tertiary amino-methacrylimide, (e.g. trimethylamino-methacrylimide), crotonic acid, pyridine, water soluble amides, (such as N-(hydroxymethyl)acrylamide and -methacrylamide, N-(3-hydroxpropyl)acrylamide, N-(2-hydroxyethyl) methacrylamide, N-(1,1-dimethyl-3-oxabutyl)acrylamide N-[2-(dimethylamine)ethyl]acrylamide and -methacrylamide, N-[3-(dimethylamino)-2-hydroxylpropyl]methacrylamide, and N-[1,1-dimethyl-2-(hydroxymethyl)-3-oxabutyl]acrylamide); water-soluble hydrazine derivatives, (such as trialkylamine methacrylimide, and dimethyl-(2-hydroxypropyl)amine methacrylimide); mono-olefinic sulfonic acids and their salts, (such as sodium ethylene sulfonate, sodium styrene sulfonate, 2-acrylamideo-2-methylpropanesulfonic acid), 1-vinyl-imidazole, 1-vinyl-indole, 2-vinyl imidazole, 4(5)-vinyl-imidazole, 2-vinyl-1-methyl-imidazole, 5-vinyl-pyrazoline, 3-methyl-5-isopropenyl-pyrazole, 5-methylene-hydantoin, 3-vinyl-2-oxazolidone, 3-methacrylyl-2-oxazolidone, 3-methacrylyl-5-methyl-2-oxazolidone, 3-vinyl-5-methyl-2-oxazolidone, 2- and 4-vinyl-pyridine, 5-vinyl-2-methyl-pyridine, 2-vinyl-pyridine-1-oxide, 3-isopropenyl-pyridine, 2- and 4-vinyl-piperidine, 2- and 4-vinyl-quinoline, 2,4-dimethyl-6-vinyl-s-triazine, 4-acrylyl-morpholine, Oxidized Regenerated Cellulose (ORC), poly(lactic-co-glycolic acid) (PLGA), Polylactic acid (PLA), Extracellular matrix (ECM), and mixtures thereof.
9. The method of the preceding items 5-8, wherein the polymers originates from an animal source such as porcine, bovine or fish sources.
10. The method of any of the preceding items 5-8, wherein the polymers are synthetically made i.e. by recombinant means.
11. The method of any of the preceding items 5-10, wherein the polymers are selected from collagen and gelatin.
12. The method of any of the preceding items 5-11, wherein the polymers comprise gelatin.
13. The method of any of the preceding items 5-12, wherein the polymers comprise collagen.
14. The method of any of the preceding items, wherein the matrix material comprises a surface and a plurality of open and interconnected cells, wherein one or more pharmaceutical compositions have been applied onto said matrix material.
15. The method of any of the preceding items, wherein the interconnected open cells of the matrix form pores having a diameter of from about 0.1 mm to about 5.0 mm.
16. The method of any of the preceding items, wherein the matrix has the dimensions (length, width and height) of less than 15 cm long, less than 10 cm wide and less than 2 cm high.
17. The method of any of the preceding items, wherein the matrix is a shape selected from the group consisting of square form, circular form, rectangular form, cubic form, cylinder form, spherical or pyramid-shaped.
18. The method of any of the preceding items, wherein the matrix has a colour selected from the group consisting of red, pink, yellow, blue, green, white, black, brown, purple, orange, grey and turquoise.
19. The method of any of the preceding items, wherein the matrix material has a reconformation rate of no more than 10 seconds, such as no more than 9 seconds, for example no more than 8 seconds, such as no more than 7 seconds, for example no more than 6 seconds, such as no more than 5 seconds, for example no more than 4 seconds, such as no more than 3 seconds, for example no more than 3 seconds, such as no more than 1 second.
20. The method of any of the preceding items, wherein the matrix material has a pore size with a normal distribution around 0.1-1.0 mm.
21. The method of any of the preceding items, wherein the matrix material has a pore size of less than 10 mm, such as less than 9 mm, for example less than 8 mm, such as less than 7 mm, for example less than 6 mm, such as less than 5 mm, for example less than 4 mm, such as less than 3 mm, for example less than 2.9 mm, such as less than 2.8 mm, for example less than 2.7 mm, such as less than 2.6 mm, for example less than 2.5 mm, such as less than 2.4 mm, for example less than 2.3 mm, such as less than 2.2 mm, for example less than 2.1 mm, such as less than 2 mm, for example less than 1.9 mm, such as less than 1.8 mm, for example less than 1.7 mm, such as less than 1.6 mm, for example less than 1.5 mm, such as less than 1.4 mm, for example less than 1.3 mm, such as less than 1.2 mm, for example less than 1.1 mm, such as less than 1.0 mm, for example less than 0.9 mm, such as less than 0.8 mm, for example less than 0.7 mm, such as less than 0.6 mm, for example less than 0.5 mm, such as less than 0.4 mm, for example less than 0.3 mm, such as less than 0.2 mm, for example less than 0.1 mm, such as less tan 0.05, for example less than 0.01 mm.
22. The method of any of the preceding items, wherein the matrix material has a pore size in the range of 0.01-0.1 mm, such as 0.1-0.2 mm, for example 0.2-0.3 mm, such as 0.3-0.4 mm, for example 0.4-0.5 mm, such as 0.5-0.6 mm, for example 0.6-0.7 mm, such as 0.7-0.8 mm, for example 0.8-0.9 mm, such as 0.9-1 mm, for example 1-1.1 mm, such as 1.1-1.2 mm, for example 1.2-1.3 mm, such as 1.3-1.4 mm, for example 1.4-1.5 mm, such as 1.5-1.6 mm, for example 1.6-1.7 mm, such as 1.-1.8 mm, for example 1.8-1.9 mm, such as 2-2.1 mm, for example 2.1-2.2 mm, such as 2.2-2.3 mm, for example 2.3-2.4 mm, such as 2.4-2.5 mm, for example 2.5-2.6 mm, such as 2.6-2.7 mm, for example 2.7-2.8 mm, such as 2.8-2.9 mm, for example 2.9-3 mm, such as 3-4 mm, for example 4-5 mm, such as 5-6 mm, for example 6-7 mm, such as 7-8 mm, for example 8-9 mm, such as 9-10 mm, or any combination of these intervals.
23. The method of any of the preceding items, wherein the matrix material has a modulus in the range of 0.1-50 GPa, such as 0.1-1, for example 1-2, such as 2-3, such as 3-4, for example 4-5, such as 5-6, for example, 6-7, such as 7-8, for example 8-9, such as 9-10, for example 10-20, such as 20-30, for example 30-40, such as 40-50 GPa.
24. The method of any of the preceding items, wherein the surface of the matrix contains less than 100 IU/cm², such as less than 95, for example less than 90, such as 85, for example less than 80, such as less than 75, for example less than 70, such as 65, for example less than 60, such as less than 55, for example less than 50, such as 45, for example less than 40, such as less than 35, for example less than 30, such as 25, for example less than 20, such as less than 15, for example less than 10, such as 5, for example less than 1 IU/cm² of the pharmaceutical composition.
25. The method of any of the preceding items, wherein the surface of the matrix contains between 1-5 IU/cm², such as 5-10 IU/cm², for example 10-15 IU/cm², such as 15-20 IU/cm², for example 20-25 IU/cm², such as 25-30 IU/cm², for example 30-35 IU/cm², such as 35-40 IU/cm², for example 40-45 IU/cm², such as 45-50 IU/cm², for example 50-55 IU/cm², such as 55-60 IU/cm², for example 60-65 IU/cm², such as 65-70 IU/cm², for example 70-75 IU/cm², such as 75-80 IU/cm², for example 80-85 IU/cm², such as 85-90 IU/cm², for example 90-95 IU/cm², such as 95-100 IU/cm², or any combination of these intervals, of the pharmaceutical composition.
26. The method of any of the preceding items, wherein the matrix material is a sponge.
27. The method of item any of the preceding items, wherein the matrix material is a gelatin or collagen sponge.
28. The method of item 28, wherein the gelatin or collagen sponge is selected from the group consisting of Spongostan, Surgifoam, Surgiflo (all Ferrosan NS), Collastat (Kendall Co.), Avitene (Avicon Inc.), Surgicel, Surgifoam (both Johnson & Johnson) and Gelfoam (Phizer).
29. The method of any of the preceding items, wherein the matrix material is a patch.
30. The method of any of the preceding items, wherein the matrix material is a swab.
31. The method of any of the preceding items, wherein the matrix material is a bandage.
32. The method of any of the preceding items, wherein the matrix material is a wound dressing.
33. The method of any of the preceding items, wherein the matrix material is a tissue dressing.
34. The method of any of the preceding items, wherein the matrix material is sterile.
35. The method of any of the preceding items, wherein the matrix material is sterile and contained in a sterile, pre-packaged, ready-to-use container.
36. The method of any of the preceding items, wherein the matrix material is sterilized.
37. The method of any of the preceding items, wherein the matrix material is sterilized by application of heat.
38. The method of any of the preceding items, wherein the matrix material is sterilized by application of one or more chemicals.
39. The method of any of the preceding items, wherein the matrix material is sterilized by application of high pressure.
40. The method of any of the preceding items, wherein the matrix material is sterilized by application of filtration.
41. The method of any of the preceding items, wherein the matrix material is sterilized by application of autoclaving.
42. The method of any of the preceding items, wherein the matrix material is sterilized by application of radiation sterilization such as sterilization using X-rays, gamma rays, UV light and/or subatomic particles.
43. The method of any of the preceding items, wherein the matrix material is sterilized by application of chemical sterilization include use of one or more of the chemicals selected from the group consisting of ethylene oxide gas, ozone, chlorine bleach, glutaraldehyde, formaldehyde, ortho-phthalaldehyde, hydrogen peroxide and peracetic acid.
44. The method of any of the preceding items, wherein the matrix material is contained in a sterile container and separated from an external, non-sterile environment.
45. The method of any of the preceding items, wherein the pharmaceutical composition comprises one or more bioactive agent(s).
46. The method of any of the preceding items, wherein said one or more bioactive agents is of a concentration in the range of 1 IU/ml to 1,000,000 IU/ml; such as in the range of 1-10 IU/ml, for example in the range of 10-50 IU/ml, such as in the range of 50-100 IU/ml, for example in the range of 100-150 IU/ml, such as in the range of 150-200 IU/ml, for example in the range of 200-250 IU/ml, such as in the range of 250-300 IU/ml, for example in the range of 300-350 IU/ml, such as in the range of 350-400 IU/ml, for example in the range of 400-450 IU/ml, such as in the range of 450-500 IU/ml, for example in the range of 500-750 IU/ml, such as in the range of 750-1000 IU/ml, for example in the range of 1000-1500 IU/ml, such as in the range of 1500-2000 IU/ml, for example in the range of 2000-2500 IU/ml, such as in the range of 2500-3000 IU/ml, for example in the range of 3000-3500 IU/ml, such as in the range of 3500-4000 IU/ml, for example in the range of 4000-4500 IU/ml, such as in the range of 4500-5000 IU/ml, for example in the range of 5000-5500 IU/ml, such as in the range of 5500-6000 IU/ml, for example in the range of 6000-6500 IU/ml, such as in the range of 6500-7000 IU/ml, for example in the range of 7000-7500 IU/ml, such as in the range of 7500-8000 IU/ml, for example in the range of 8000-8500 IU/ml, such as in the range of 8500-9000 IU/ml, for example in the range of 9000-9500 IU/ml, such as in the range of 9500-10,000 IU/ml, for example in the range of 10,000-11,000 IU/ml, such as in the range of 11,000-12,000 IU/ml, for example in the range of 12,000-13,000 IU/ml, such as in the range of 13,000-14,000 IU/ml, for example in the range of 14,000-15,000 IU/ml, such as in the range of 15,000-16,000 IU/ml, for example in the range of 16,000-17,000 IU/ml, such as in the range of 17,000-18,000 IU/ml, for example in the range of 18,000-19,000 IU/ml, such as in the range of 19,000-20,000 IU/ml, for example in the range of 20,000-25,000 IU/ml, such as in the range of 25,000-30,000 IU/ml, for example in the range of 30,000-35,000 IU/ml, such as in the range of 35,000-40,000 IU/ml, for example in the range of 40,000-45,000 IU/ml, such as in the range of 45,000-50,000 IU/ml, for example in the range of 50,000-55,000 IU/ml, such as in the range of 55,000-60,000 IU/ml, for example in the range of 60,000-65,000 IU/ml, such as in the range of 65,000-70,000 IU/ml, for example in the range of 70,000-75,000 IU/ml, such as in the range of 75,000-80,000 IU/ml, for example in the range of 80,000-85,000 IU/ml, such as in the range of 85,000-90,000 IU/ml, for example in the range of 90,000-95,000 IU/ml, such as in the range of 95,000-100,000 IU/ml, for example in the range of 100,000-150,000 IU/ml, such as in the range of 150,000-200,000 IU/ml, for example in the range of 200,000-250,000 IU/ml, such as in the range of 250,000-300,000 IU/ml, for example in the range of 300,000-350,000 IU/ml, such as in the range of 350,000-400,000 IU/ml, for example in the range of 400,000-450,000 IU/ml, such as in the range of 450,000-500,000 IU/ml, for example in the range of 500,000-550,000 IU/ml, such as in the range of 550,000-600,000 IU/ml, for example in the range of 600,000-650,000 IU/ml, such as in the range of 650,000-700,000 IU/ml, for example in the range of 700,000-750,000 IU/ml, such as in the range of 750,000-800,000 IU/ml, for example in the range of 800,000-850,000 IU/ml, such as in the range of 850,000-900,000 IU/ml, for example in the range of 900,000-950,000 IU/ml, such as in the range of 950,000-1,000,000 IU/ml, or any combination of these ranges.
47. The method of any of the preceding items, wherein said bioactive agent is of a concentration in the range of 1 ng/ml to 1,000,000 mg/ml; such as in the range of 1-10 ng/ml, for example in the range of 10-100 ng/ml, such as in the range of 100-200 ng/ml, for example in the range of 300-400 ng/ml, such as in the range of 400-500 ng/ml, for example in the range of 500-600 ng/ml, such as in the range of 600-700 ng/ml, for example in the range of 700-800 ng/ml, such as in the range of 800-900 ng/ml, for example in the range of 900-1000 ng/ml, such as in the range of 1-10 ug/ml, for example in the range of 10-100 ug/ml, such as in the range of 100-200 ug/ml, for example in the range of 200-300 ug/ml, such as in the range of 300-400 ug/ml, for example in the range of 400-500 ug/ml, such as in the range of 500-600 ug/ml, for example in the range of 600-700 ug/ml, such as in the range of 700-800 ug/ml, for example in the range of 800-900 ug/ml, such as in the range of 900-1000 ug/ml, for example in the range of 1-10 mg/ml, such as in the range of 10-100 mg/ml, for example in the range of 100-200 mg/ml, such as in the range of 200-300 mg/ml, for example in the range of 300-400 mg/ml, such as in the range of 400-500 mg/ml, for example in the range of 500-600 mg/ml, such as in the range of 600-700 mg/ml, for example in the range of 700-800 mg/ml, such as in the range of 800-900 mg/ml, for example in the range of 900-1000 mg/ml, such as in the range of 1000-2000 mg/ml, for example in the range of 2000-3000 mg/ml, such as in the range of 3000-4000 mg/ml, for example in the range of 4000-5000 mg/ml, such as in the range of 5000-6000 mg/ml, for example in the range of 6000-7000 mg/ml, such as in the range of 7000-8000 mg/ml, for example in the range of 8000-9000 mg/ml, such as in the range of 9000-10,000 mg/ml, for example in the range of 10,000-20,000 mg/ml, such as in the range of 20,000-30,000 mg/ml, for example in the range of 30,000-40,000 mg/ml, such as in the range of 40,000-50,000 mg/ml, for example in the range of 50,000-60,000 mg/ml, such as in the range of 60,000-70,000 mg/ml, for example in the range of 70,000-80,000 mg/ml, such as in the range of 80,000-90,000 mg/ml, for example in the range of 90,000-100,000 mg/ml, such as in the range of 100,000-200,000 mg/ml, for example in the range of 200,000-300,000 mg/ml, such as in the range of 300,000-400,000 mg/ml, for example in the range of 400,000-500,000 mg/ml, such as in the range of 500,000-600,000 mg/ml, for example in the range of 600,000-700,000 mg/ml, such as in the range of 700,000-800,000 mg/ml, for example in the range of 800,000-900,000 mg/ml, such as in the range of 900,000-1,000,000 mg/ml, or any combination of these ranges.
48. The method of any of the preceding items, wherein the concentration of the bioactive agent of any two droplets expelled from a spray nozzle vary less that 10%, such as less than 8%, for example less than 6%, such as less than 4%, for example less than 2%, such as less than 1%.
49. The method of any of the preceding items, wherein the concentration of the bioactive agent of any two droplets is essentially identical.
50. The method of any of the preceding items, wherein the pharmaceutical composition comprises one or more bioactive agent(s) that stimulates hemostasis.
51. The method of any of the preceding items, wherein the pharmaceutical composition comprises one or more bioactive agent(s) that stimulates wound healing.
52. The method of any of the preceding items, wherein the pharmaceutical composition comprises one or more bioactive agent(s) that stimulates wound healing by inhibition of one or more infections of the wound.
53. The method of any of the preceding items, wherein the pharmaceutical composition comprises one or more bioactive agent(s) which comprises one or more anti-fibrinolytic agents.
54. The method of any of the preceding items, wherein the pharmaceutical composition comprises one or more bioactive agent(s) which comprises one or more pro-coagulants.
55. The method of any of the preceding items, wherein the pharmaceutical composition comprises one or more bioactive agent(s) that stimulates platelets.
56. The method of any of the preceding items, wherein the pharmaceutical composition comprises one or more bioactive agent(s) that stimulate formation of a hemostatic plug.
57. The method of any of the preceding items, wherein the pharmaceutical composition comprises one or more bioactive agent(s) that stimulates one or more coagulation factors.
58. The method of any of the preceding items, wherein the pharmaceutical composition comprises one or more bioactive agent(s) selected from the group consisting of endothelium Tissue Factor (TF), Factor VII, TF-Factor VIIa, Factor IX, Factor X, thrombin, activated Factor II (Factor IIa), Factor XIa, plasmin, Factor XII, Factor Xa, TFPI, Factor Va, prothrombinase complex, prothrombin, Factor V, Factor XI, Factor VIII, vWF, Factor VIIIa, Factor IXa and the tenase complex.
59. The method of any of the preceding items, wherein the pharmaceutical composition comprises one or more bioactive agent(s) that stimulates the formation of fibrin strands.
60. The method of any of the preceding items, wherein the pharmaceutical composition comprises one or more bioactive agent(s) that stimulates platelate aggregation.
61. The method of any of the preceding items, wherein the pharmaceutical composition comprises one or more bioactive agent(s) which comprises thrombin.
62. The method of any of the preceding items, wherein the pharmaceutical composition comprises one or more bioactive agent(s) which comprises fibrinogen.
63. The method of any of the preceding items, wherein the pharmaceutical composition comprises one or more bioactive agent(s) which comprises Factor XIII and/or XIIIa.
64. The method of any of the preceding items, wherein the pharmaceutical composition comprises one or more bioactive agent(s) which comprises tranexamic acid.
65. The method of any of the preceding items, wherein the pharmaceutical composition comprises one or more bioactive agent(s) which comprises Willebrand factor (vWF).
66. The method of any of the preceding items, wherein the pharmaceutical composition comprises one or more bioactive agent(s) that stimulates the contact activation pathway.
67. The method of any of the preceding items, wherein the pharmaceutical composition comprises one or more bioactive agent(s) that stimulates the tissue factor pathway.
68. The method of any of the preceding items, wherein the pharmaceutical composition comprises one or more bioactive agent(s) that stimulates fibrin formation.
69. The method of any of the preceding items, wherein the pharmaceutical composition comprises one or more bioactive agent(s) that stimulates fibrin cross-linking.
70. The method of any of the preceding items, wherein the pharmaceutical composition comprises one or more bioactive agent(s) which comprises Factor VIII.
71. The method of any of the preceding items, wherein the pharmaceutical composition comprises one or more bioactive agent(s) which comprises Factor V.
72. The method of any of the preceding items, wherein the pharmaceutical composition comprises one or more bioactive agent(s) which comprises Factor XIII.
73. The method of any of the preceding items, wherein the pharmaceutical composition comprises one or more bioactive agent(s) which comprises Factor VII.
74. The method of any of the preceding items, wherein the pharmaceutical composition comprises one or more bioactive agent(s) which stimulates the coagulation cascade.
75. The method of any of the preceding items, wherein the pharmaceutical composition comprises thrombin.
76. The method of item 75, wherein the matrix contains less than 300 IU thrombin per square cm (cm²) surface area, such as less than 290 IU/cm², for example less than 280 IU/cm², such as 270 IU/cm², for example less than 260 IU/cm², such as less than 250 IU/cm², for example less than 240 IU/cm², such as less than 230 IU/cm², for example less than 220 IU/cm², such as less than 210 IU/cm², for example less than 200 IU/cm², such as less than 190 IU/cm², for example less than 180 IU/cm², such as less than 170 IU/cm², for example less than 160 IU/cm², such as less than 150 IU/cm², for example less than 140 IU/cm², such as less than 130 IU/cm², for example less than 120 IU/cm², such as less than 110 IU/cm², for example less than 100 IU/cm², such as less than 95 IU/cm², for example less than 90 IU/cm², such as less than 85 IU/cm², for example less than 80 IU/cm², such as less than 75 IU/cm², for example less than 70 IU/cm², such as less than 65 IU/cm², for example less than 60 IU/cm², such as less than 55 IU/cm², for example less than 50 IU/cm², such as less than 45 IU/cm², for example less than 40 IU/cm², such as less than 35 IU/cm², for example less than 30 IU/cm², such as less than 25 IU/cm², for example less than 20 IU/cm², such as less than 15 IU/cm², for example less than 10 IU/cm², such as less than 5 IU/cm², for example less than 1 IU/cm².
77. The method of any of the preceding itemsFejl! Henvisningskilde ikke fundet., wherein the surface of the matrix contains from 1 IU/cm² to 300 IU/cm² of thrombin, for example 1-5 IU/cm² thrombin, such as 5-10 IU/cm², for example 10-15 IU/cm², such as 15-20 IU/cm², for example 20-25 IU/cm², such as 25-30 IU/cm², for example 30-35 IU/cm², such as 35-40 IU/cm², for example 40-45 IU/cm², such as 45-50 IU/cm², for example 50-55 IU/cm², such as 55-60 IU/cm², for example 60-65 IU/cm², such as 65-70 IU/cm², for example 70-75 IU/cm², such as 75-80 IU/cm², for example 80-85 IU/cm², such as 85-90 IU/cm², for example 90-95 IU/cm², such as 95-100 IU/cm², for example 100-110 IU/cm², such as 110-120 IU/cm², for example 120-130 IU/cm², such as 130-140 IU/cm², for example 140-150 IU/cm², such as 150-160 IU/cm², for example 160-170 IU/cm², such as 170-180 IU/cm², for example 180-190 IU/cm², such as 190-200 IU/cm², for example 200-210 IU/cm², such as 210-220 IU/cm², for example 220-230 IU/cm², such as 230-240 IU/cm², for example 240-250 IU/cm², such as 250-260 IU/cm², for example 260-270 IU/cm², such as 270-280 IU/cm², for example 280-290 IU/cm², such as 290-300 IU/cm².
78. The method of any of the preceding items, wherein the pharmaceutical composition is applied by ultrasonic spray technology onto the surface of the matrix material by deposition of an amount of liquid per position of less than 100 mL, such as less than 90 nL, for example less than 80 nL, such as less than 70 mL, for example less than 60 nL, such as less than 50 nL, for example less than 40 nL, such as less than 30 nL, for example less than 20 nL, such as less than 10 nL, for example less than 1 nL or 1000 pL, such as less than 900 pL, for example less than 800 pL, such as less than 700 pL, for example less than 600 pL, such as less than 500 pL, for example less than 400 pL, such as less than 300 pL, for example less than 250 pL, such as less than 200 pL, for example less than 150 pL, such as less than 100 pL, for example less than 90 pL, such as less than 80 pL, for example less than 70 pL, such as less than 60 pL, for example less than 50 pL, such as less than 40 pL, for example less than 30 pL, such as less than 20 pL, for example less than 10 pL, such as less than 9 pL, for example less than 8 pL, such as less than 7 pL, for example less than 6 pL, such as less than 5 pL, for example less than 4 pL, such as less than 3 pL, for example less than 2 pL, such as less than 1 pL per position.
   79. The method of any of the preceding items, wherein the pharmaceutical composition is applied by ultrasonic spray technology onto the surface of the matrix material by deposition of an amount of liquid per position in pico litre (pL) to nano litre (nL) range, such as 1-10 pL, for example 10-20 pL, such as 20-30 pL, for example 30-40 pL, such as 40-50 pL, for example 50-60 pL, such as 60-70 pL, for example 70-80 pL, such as 80-90 pL, for example 100-150 pL, such as 150-200 pL, for example 200-250 pL, such as 250-300 pL, for example 300-400 pL, such as 400-500 pL, for example 500-600 pL, such as 600-700 pL, for example 700-800 pL, such as 800-900 pL, for example 900-1000 pL or 1 nL, such as 1-10 nL, for example 10-20 nL, such as 20-30 nL, for example 30-40 mL, such as 40-50 nL, for example 50-60 nL, such as 60-70 nL, for example 70-80 nL, such as 80-90 nL, for example 90-100 nL.
   80. The method of any of the preceding items, wherein the pharmaceutical composition comprises one or more adhesive agents.
   81. The method of item 80, wherein said one or more adhesive agents can be selected from the group consisting of saccharides, monosaccharides, disaccharides, oligosaccharides, polysaccharides, glucose, mannose, fructose, threose, gulose, arabinose, ribose, erythrose, lyxose, galactose, sorbose, altrose, tallose, idose, rhamnose, allose, pentosamines, hexosamines, glucosamine, N-acetylglucosamine, glucoronic acid, sucrose, maltose, lactose, cellubiose, glycogen, chitin, chitosan, starch, potato starch, glycosaminoglycans, chondroitin, chondroitin sulfate, hyaluronic acid, dermatan sulphate, keratan sulphate, aminated dextrans, DEAE-dextran, aminated starch, aminated glycogen, aminated cellulose, aminated pectin, and salts, complexes, derivatives and mixtures thereof.
   82. The method of item 80, wherein said one or more adhesive agents can be selected from the group consisting of hydrocarbon resins, rosin resins, terpene resins, Escorez® from ExxonMobil; Regalite®, Piccotac® and Picco® from Eastman; Indopol® from BP or Arkon®, esters of hydrogenated wood rosin, pentaerythritol ester of hydrogenated wood rosin, esters of partially hydrogenated wood rosin, pentaerythritol esters of partially hydrogenated wood rosin, esters of wood rosin, esters of modified wood rosin, esters of partially dimerized rosin, esters of tall oil rosin, esters of dimerized rosin, Foral®, Foralyn®, Pentalyn®, Permalyn® and Staybelite®.
   83. The method of item 80, wherein said one or more adhesive agents can be selected from the group consisting of Gum Karaya, Sterculia gum, Gum Arabicum, Gum Karrageenan, celluloseethers, sodium carboxymethylcellulose, Manuba Honey, casein, alginates and fatty acid esters.
   84. The method of any of the preceding items 80-83, wherein the one or more adhesive agents comprises between 0.1-50% (w/w) of the pharmaceutical composition, based on the total weight of the composition such as 1-25% (w/w), such as 5-20% (w/w), e.g. 5-15% (w/w), 5-10% (w/w), or 10-15% (w/w), based on the total weight of the composition.
   85. The method of any of the preceding items, wherein the pharmaceutical composition comprises one or more surfactant agents.
   86. The method of item 85, wherein said one or more surfactant agents can be selected from the group consisting of anionic surfactants, cationic surfactants, non-ionic surfactants and surface active biological modifiers.
   87. The method of item 85, wherein said one or more surfactant agents can be selected from the group consisting of potassium laurate, triethanolamine stearate, sodium lauryl sulfate, sodium dodecylsulfate, alkyl polyoxyethylene sulfates, sodium alginate, dioctyl sodium sulfosuccinate, phosphatidyl glycerol, phosphatidyl inositol, phosphatidylserine, phosphatidic acid and their salts, glyceryl esters, sodium carboxymethylcellulose, bile acids and their salts, cholic acid, deoxycholic acid, glycocholic acid, taurocholic acid, glycodeoxycholic acid, and calcium carboxymethylcellulose.
   88. The method of item 85, wherein said one or more surfactant agents can be selected from the group consisting of samples of cationic surfactants include surfactants selected from the group consisting of quaternary ammonium compounds, benzalkonium chloride, cetyltrimethylammonium bromide, chitosans and lauryldimethylbenzylammonium chloride.
   89. The method of item 85, wherein said one or more surfactant agents can be selected from the group consisting of polyoxyethylene fatty alcohol ethers, polyoxyethylene sorbitan fatty acid esters, polyoxyethylene fatty acid esters, sorbitan esters, polyoxyethylene sorbitan esters (such as Tween 80 or Tween 20), glycerol monostearate, polyethylene glycols, polypropylene glycols, cetyl alcohol, cetostearyl alcohol, stearyl alcohol, aryl alkyl polyether alcohols, polyoxyethylene-polyoxypropylene copolymers, polaxamines, methylcellulose, hydroxycellulose, hydroxy propylcellulose, hydroxy propylmethylcellulose, noncrystalline cellulose, polysaccharides, starch, starch derivatives, hydroxyethylstarch, polyvinyl alcohol, Pluronic F68, and polyvinylpyrrolidone.
   90. The method of any of the preceding items, wherein said pharmaceutical composition comprises a solvent component and/or a fluid component.
   91. The method of item 90, wherein said solvent component and/or fluid component is an aqueous medium.
   92. The method of item 91, wherein the aqueous medium contains one or more salts such as sodium chloride.
   93. The method of item 90, wherein said solvent component and/or fluid component is a volatile fluid.
   94. The method of any of the preceding items, wherein the pharmaceutical composition comprises one or more water content stabilizer such as sorbitol, polysaccaharides or polyols.
   95. The method of any of the preceding items, wherein the pharmaceutical composition comprises one or more long chain molecules (polymers) such as gelatin, starch, polyethlyleneoxide, polyvinylalcohol and polyethyleneglycols (macrogol).
   96. The method of any of the preceding items, wherein the pharmaceutical composition comprises one or more substances that increases the viscosity of the composition, selected from acacia, alginic acid, bentonite, carbomer, carboxymethylcellulose calcium, carboxymethylcellulose sodium, cetostearyl alcohol, colloidal silicon dioxide, guar gum, hydroxyethyl cellulose, hydroxypropyl cellulose, hydroxypropyl methylcellulose, hydroxypropyl methylcellulose phtalate, magnesium aluminium silicate, methylcellulose, microcrystalline cellulose, polyvinyl alcohol, povidone, sodium alginate, sucrose, tragacanth, gelatin, starch, albumin, casein, polyethlyleneoxide, polyvinylalcohol, polyethyleneglycols (macrogol), glycerine (1,2,3-propanetriol) and glycol (1,2-propanediol).
   97. The method of any of the preceding items, wherein the pharmaceutical composition has a viscosity in the range of 0.1-20 cps; for example 0.1-1 cps, such as 1-2 cps, for example 2-3 cps, such as 3-4 cps, for example 4-5 cps, such as 5-6 cps, for example 6-7 cps, such as 7-8 cps, for example 8-9 cps, such as 9-10 cps, for example 10-11 cps, such as 11-12 cps, for example 12-13 cps, such as 13-14 cps, for example 14-15 cps, such as 15-16 cps, for example 16-17 cps, such as 17-18 cps, for example 18-19 cps, such as 19-20 cps.
   98. The method of any of the preceding items, wherein the pharmaceutical composition has a surface tension in the range of 0.020 to 0.050 N/m; for example in the range of 0.020-0.022 N/m, such as in the range of 0.022-0.024 N/m, for example in the range of 0.024-0.026 N/m, such as in the range of 0.026-0.028 N/m, for example in the range of 0.028-0.030 N/m, such as in the range of 0.030-0.032 N/m, for example in the range of 0.032-0.034 N/m, such as in the range of 0.034-0.036 N/m, for example in the range of 0.036-0.038 N/m, such as in the range of 0.038-0.040 N/m, for example in the range of 0.040-0.042 N/m, such as in the range of 0.042-0.044 N/m, for example in the range of 0.044-0.046 N/m, such as in the range of 0.046-0.048 N/m, for example in the range of 0.048-0.050 N/m, or any combination of these ranges.
   99. The method of any of the preceding items, wherein the pharmaceutical composition has a temperature in the range from sub-zero degrees celcius to 150 degrees celcius; such as −100° C. to −50° C., for example −50° C. to 0° C., such as 0-10° C., for example 10-20° C., such as 20-30° C., for example 30-40° C., such as 40-50° C., for example 50-60° C., such as 60-70° C., for example 70-80° C., such as 80-90° C., for example 90-100° C., such as 100-125° C., for example 125-150° C.
   100. The method of any of the preceding items, wherein the pharmaceutical composition comprises one bioactive agent.
   101. The method of any of the preceding items, wherein the pharmaceutical composition comprises two or more agents or bioactive agents.
   102. The method of any of the preceding items, wherein the surface of the matrix material comprises one pharmaceutical composition comprising one or more bioactive agents.
   103. The method of any of the preceding items, wherein the surface of the matrix material comprises two or more different pharmaceutical compositions each comprising one or more agents or bioactive agents.
   104. The method of item 103, wherein said two or more different pharmaceutical compositions are each applied by ultrasonic spray technology onto the surface of the matrix material in non-overlapping positions of said surface.
   105. The method of any of the preceding items 103 or 104, wherein the two or more different pharmaceutical compositions are incompatible if contained in the same pharmaceutical composition.
   106. The method of any of the preceding items 103 or 105, wherein the two or more different pharmaceutical compositions are separate components of a two-component glue.
   107. The method of item 106, wherein said two-component glue is a surgical glue.
   108. The method of any of the preceding items 103-107, wherein the two or more pharmaceutical compositions comprise thrombin and fibrinogen, respectively.
   109. The method of any of the preceding items, wherein said pharmaceutical composition is uniformly distributed on said matrix.
   110. The method of item 109, wherein a predetermined ratio of droplet volume of the pharmaceutical composition, distance between any two droplets deposited on the surface of said matrix material and the concentration of a bioactive agent in said pharmaceutical composition is used.
   111. The method of item 109, wherein any two area units of said matrix material differ in volume of the pharmaceutical composition or concentration of bioactive agent of the pharmaceutical composition by the most 10%, such as by the most 8%, for example by the most 6%, such as by the most 4%, for example by the most 2%, such as by the most 1%.
   112. The method of any of the preceding items, wherein said method essentially does not alter the physical characteristics and appearence of the matrix.
   113. The method of any of the preceding items, wherein said method essentially does not alter the physical characteristics and appearence of the surface of said matrix.
   114. The method of any of the preceding items, wherein said method essentially does not cause any swelling of the matrix.
   115. The method of any of the preceding items, wherein said method essentially does not cause any swelling of the surface of said matrix.
   116. The method of any of the preceding items, wherein said method essentially does not alter the initial absorption rate of the matrix.
   117. The method of any of the preceding items, wherein said method essentially does not lower the initial absorption rate of the surface of said matrix.
   118. The method of any of the preceding items, wherein said method essentially does not generate aerosols.
   119. The method of any of the preceding items, wherein the amount of fluid or liquid composition not contacting the matrix material is less that 10%, such as less than 8%, for example less than 6%, such as less than 4%, for example less than 2%, such as less than 1%.
   120. The method of any of the preceding items, wherein application by ultrasonic spray technology of the pharmaceutical composition occurs essentially perpendicular to the surface of said matrix material.
   121. The method of any of the preceding items, wherein said application by ultrasonic spray technology of said pharmaceutical composition onto the surface of said matrix material results in the generation of droplets that evaporate within maximum 30 seconds, such as less than 25 seconds, for example less than 20 seconds, such as less than 15 seconds, for example less than 10 seconds, such as less than 5 seconds, for example less than 1 second after being applied by ultrasonic spray technology onto the surface of the matrix.
   122. The method of any of the preceding items, wherein said application by ultrasonic spray technology of said pharmaceutical composition onto the surface of said matrix material results in the generation of droplets each with a volume of less than 100 nL, such as less than 90 nL, for example less than 80 nL, such as less than 70 nL, for example less than 60 nL, such as less than 50 nL, for example less than 40 nL, such as less than 30 nL, for example less than 20 nL, such as less than 10 nL, for example less than 1 nL or 1000 pL, such as less than 900 pL, for example less than 800 pL, such as less than 700 pL, for example less than 600 pL, such as less than 500 pL, for example less than 400 pL, such as less than 300 pL, for example less than 250 pL, such as less than 200 pL, for example less than 150 pL, such as less than 100 pL, for example less than 90 pL, such as less than 80 pL, for example less than 70 pL, such as less than 60 pL, for example less than 50 pL, such as less than 40 pL, for example less than 30 pL, such as less than 20 pL, for example less than 10 pL, such as less than 9 pL, for example less than 8 pL, such as less than 7 pL, for example less than 6 pL, such as less than 5 pL, for example less than 4 pL, such as less than 3 pL, for example less than 2 pL, such as less than 1 pL per droplet.
   123. The method of items 121 or 122, wherein the droplet size of any two droplets vary less that 10%, such as less than 8%, for example less than 6%, such as less than 4%, for example less than 2%, such as less than 1%.
   124. The method of any of the preceding items 121-123, wherein the droplet size of any two droplets is essentially identical.
   125. The method of any of the preceding items 121-124, wherein the distance between every two droplets deposited by ultrasonic spray technology onto the matrix surface is less than 2 mm, such as less than 1.9 mm, for example less than 1.8 mm, such as less than 1.7 mm, for example less than 1.6 mm L, such as less than 1.5 mm, for example less than 1.4 mm, such as less than 1.3 mm, for example less than 1.3 mm, such as less than 1.2 mm, for example less than 1.1 mm, such as less than 1.0 mm, for example less than 0.9 mm, such as less than 0.8 mm, for example less than 0.7 mm, such as less than 0.6 mm, for example less than 0.5 mm, such as less than 0.4 mm, for example less than 0.3 mm, such as less than 0.2 mm, for example less than 0.1 mm, such as less than 0.09 mm, for example less than 0.08 mm, such as less than 0.07 mm, for example less than 0.06 mm, such as less than 0.05 mm, for example less than 0.04 mm, such as less than 0.03 mm, for example less than 0.02 mm, such as less than 0.01 mm.
   126. The method of any of the preceding items 121-125, wherein the distance between every two droplets deposited by ultrasonic spray technology onto the matrix surface vary less that 10%, such as less than 8%, for example less than 6%, such as less than 4%, for example less than 2%, such as less than 1%.
   127. The method of any of the preceding items 121-126, wherein the distance between every two droplets deposited by ultrasonic spray technology onto the matrix surface is essentially identical.
   128. The method of any of the preceding items 121-127, wherein said application by ultrasonic spray technology of said pharmaceutical composition onto the surface of said matrix material results in the generation of droplets, wherein the distance traversed by any droplet from the nozzle to the surface of the matrix material is less than 0.01 mm, such as less than 0.02 mm, for example less than 0.03 mm, such as less than 0.04 mm, for example less than 0.05 mm, such as less than 0.06 mm, for example less than 0.07 mm, such as less than 0.08 mm, for example less than 0.09 mm, such as less than 0.1 mm, for example less than 0.2 mm, such as less than 0.3 mm, for example less than 0.4 mm, such as less than 0.5 mm, for example less than 0.6 mm, such as less than 0.7 mm, for example less than 0.8 mm, such as less than 0.9 mm, for example less than 1.0 mm, such as less than 1.1 mm, for example less than 1.2 mm, such as less than 1.3 mm, for example less than 1.4 mm, such as less than 1.5 mm, for example less than 1.6 mm, such as less than 1.7 mm, for example less than 1.8 mm, such as less than 1.9 mm, for example less than 2.0 mm, such as less than 2.1 mm, for example less than 2.2 mm, such as less than 2.3 mm, for example less than 2.4 mm, such as less than 2.5 mm, for example less than 2.6 mm, such as less than 2.7 mm, for example less than 2.8 mm, such as less than 2.8 mm, for example less than 3.0 mm, such as less than 3.5 mm, for example less than 4.0 mm, such as less than 4.5 mm, for example less than 5.0 mm, such as less than 6.0 mm, for example less than 7.0 mm, such as less than 8.0 mm, for example less than 9.0 mm, such as less than 10.0 mm.
   129. The method of any of the preceding items 121-128, wherein each droplet traverses a distance from nozzle to the surface of a matrix material that varies between each droplet within a range of 0.01% to a maximum of 10%; such as 0.01 to 0.1%, for example 0.1 to 1%, such as 1 to 2%, for example 2 to 3%, such as 3 to 4%, for example 4 to 5%, such as 5 to 6%, for example 6 to 7%, such as 7 to 8%, for example 8 to 9%, such as 9 to 10%.
   130. The method of any of the preceding items 121-129, wherein the distance each droplet traverses from nozzle to the surface of a matrix material is essentially identical.
   131. The method of any of the preceding items 121-130, wherein a nozzle ejects droplets at a velocity in the range of 0.1-100 m/sec; such as 0.1-1 m/sec, for example 1-2 m/sec, such as 2-3 m/sec, for example 3-4 m/sec, such as 4-5 m/sec, for example 5-6 m/sec, such as 6-7 m/sec, for example 7-8 m/sec, such as 8-9 m/sec, for example 9-10 m/sec, such as 10-15 m/sec, for example 15-20 m/sec, such as 20-30 m/sec, for example 30-40 m/sec, such as 40-50 m/sec, for example 50-60 m/sec, such as 60-70 m/sec, for example 70-80 m/sec, such as 80-90 m/sec, for example 90-100 m/sec.
   132. The method of any of the preceding items 121-131, wherein the velocity between each droplet varies within a range of 0.01% to a maximum of 10%; such as from 0.01% to 0.1%, for example from 0.1% to 1%, such as from 1% to 2%, for example from 2% to 3%, such as from 3% to 4%, for example from 4% to 5%, such as from 5% to 6%, for example from 6% to 7%, such as from 7% to 8%, for example from 8% to 9%, such as from 9% to 10%.
   133. The method of any of the preceding items 121-132, wherein the velocity of each droplet from nozzle to the surface of a matrix material is essentially identical.
   134. The method of any of the preceding items, wherein said matrix material further comprises one or more thrombin-stabilizing agents.
   135. The method of any of the preceding items, wherein said matrix material comprises a biologically absorbable material comprising thrombin.
   136. The method of any of the preceding items, wherein said matrix material comprises a sponge comprising thrombin.
   137. The method of any of the preceding items, wherein said matrix material comprises a gelatin foam pad and/or a gauze pad that provide a unique, premixed, sterile, gelatin/thrombin haemostat.
   138. The method of any of the preceding items, wherein said matrix material comprises a premixed thrombin/gelatin pad.
   139. The method of any of the preceding items, wherein said matrix material comprises thrombin freeze-dried into a gelatin foam.
   140. The method of any of the preceding items, wherein said matrix material comprises any standard gelatin pad with thrombin.
   141. The method of any of the preceding items, wherein said matrix material comprises a fibrin paste based on e.g. a collagen sponge coated with fibrinogen and/or thrombin.
   142. The method of any of the preceding items, wherein said matrix material comprises Thrombi-Gel® (Vascular Solutions, Inc.).
   143. The method of any of the preceding items, wherein said matrix material comprises Thrombi-Pad™ (Vascular Solutions, Inc.).
   144. The method of any of the preceding items, wherein said matrix material comprises D-Stat Dry product (such as D-Stat Dry, D-Stat 2 Dry) (Vascular Solutions, Inc.).
   145. The method of any of the preceding items, wherein said matrix material comprises ThrombiGel hemostatic foam (Vascular Solutions, Inc.).
   146. The method of any of the preceding items, wherein said matrix material comprises Gelfoam (Pfizer).
   147. The method of any of the preceding items, wherein said matrix material comprises Surgifoam (Johnson & Johnson).
   148. The method of any of the preceding items, wherein said matrix material comprises Surgiflo (Johnson & Johnson).
   149. The method of any of the preceding items, wherein said matrix material comprises FloSeal Matrix Hemostatic Sealant (Baxter International Inc.).
   150. The method of any of the preceding items, wherein said matrix material comprises TachoSil (Nycomed).
   151. The method of any of the preceding items, wherein said matrix material comprises a collagen material such as Avitene, Actifoam, Helistat, Inistat, or CoStasis hemostatic device.
   152. The method of any of the preceding items, wherein said matrix material comprises a cellulose material such as Surgicel (Ethicon/Johnson & Johnson), Oxycel or Tabotamp.
   153. The method of any of the preceding items 58-152, wherein said thrombin is Thrombostat, Thrombin-JMI (King Pharmaceuticals), Recothrom (Bayer/Zymogenetics), Evithrom (OMRIX Biopharmaceuticals/Ethicon), or any other commercially available thrombin.
   154. The method of any of the preceding items 58-153, wherein said thrombin is produced from plasma using the Thrombin Activation Device (TAD) (Thermogenesis).
   155. The method of any of the preceding items, wherein said matrix material comprises a hemostatic paste composition comprising a hemostatic effective amount of thrombin in a polyethylene glycol base which is preferably prepared by admixing an aqueous solution of thrombin and polyethylene glycol and freeze-drying the mixture to remove substantially all of the water to yield a viscous water soluble paste of fine particles of thrombin uniformly dispersed throughout the polyethylene glycol base (as described in U.S. Pat. No. 5,595,735).
   156. The method of any of the preceding items, wherein said matrix material comprises a collagen paste hemostat comprising thrombin e.g. as described in U.S. Pat. No. 4,891,359.
   157. The method of any of the preceding items, wherein said matrix material comprises a stable collagen sponge having thrombin therein e.g. as described in U.S. Pat. No. 4,515,637.
   158. The method of any of the preceding items, wherein said matrix material comprises a collagen sponge having thrombin therein e.g. as described in U.S. Pat. No. 6,649,162.
   159. The method of any of the preceding items, wherein said matrix or surface of a matrix is made of gelatin.
   160. The method of any of the preceding items, wherein said matrix or surface of a matrix is a gelatin sponge.
   161. The method of any of the preceding items, wherein said pharmaceutical composition contains one or more biologically active compounds selected from the group consisting of thrombin and fibrinogen.
   162. The method of any of the preceding items, wherein said pharmaceutical composition contains thrombin.
   163. The method of any of the preceding items, wherein said pharmaceutical composition contains compounds selected from the group consisting of thrombin, calcium, albumin, mannitol, and acetate.
   164. The method of any of the preceding items, wherein the concentration of thrombin in said pharmaceutical composition can be selected from group of intervals consisting of from 2000 IU/ml to 3000 IU/ml, from 3000 IU/ml to 4000 IU/ml, from 4000 IU/ml to 5000 IU/ml, from 5000 IU/ml to 6000 IU/ml, from 6000 IU/ml to 7000 IU/ml, from 7000 IU/ml to 8000 IU/ml, from 8000 IU/ml to 9000 IU/ml, from 9000 IU/ml to 10000 IU/ml, from 10000 IU/ml to 11000 IU/ml, from 11000 IU/ml to 12000 IU/ml, from 12000 IU/ml to 13000 IU/ml, from 13000 IU/ml to 14000 IU/ml, from 14000 IU/ml to 15000 IU/ml, from 15000 IU/ml to 16000 IU/ml, from 16000 IU/ml to 17000 IU/ml, from 17000 IU/ml to 18000 IU/ml, from 18000 IU/ml to 19000 IU/ml, from 19000 IU/ml to 20000 IU/ml, from 20000 IU/ml to 21000 IU/ml, from 21000 IU/ml to 22000 IU/ml, from 22000 IU/ml to 23000 IU/ml, from 23000 IU/ml to 24000 IU/ml, and from 24000 IU/ml to 25000 IU/ml or any combination of these intervals.
   165. The method of item 162, wherein said pharmaceutical composition contains thrombin formulated with L9 buffer solution (20 mM sodium acetate, 40 mM CaCl₂, 110 mM NaCl, 0.5% w/w human albumin, 2% w/w mannitol at pH 6.9-7.1).
   166. The method of any of the preceding items, wherein the concentration of calcium in said pharmaceutical composition can be selected from group of intervals consisting of from 20-25 mM, from 25-28 mM, from 28-31 mM, from 31-34 mM, from 34-36 mM, from 38-40 mM, from 40-42 mM, from 42-44 mM, from 44-47 mM, from 47-50 mM, from 50-53 mM, from 53-56 mM, from 53-59 mM, from 59-62 mM and from 62-66 mM or any combination of these intervals.
   167. The method of any of the items, wherein the concentration of albumin in said pharmaceutical composition can be selected from group of intervals consisting of from 5-8 mg/ml, from 8-11 mg/ml, from 11-14 mg/ml, from 14-17 mg/ml, from 17-20 mg/ml, from 20-23 mg/ml, from 23-26 mg/ml, from 26-29 mg/ml, from 39-32 mg/ml, from 32-35 mg/ml, from 35-38 mg/ml, from 35-42 mg/ml, from 42-46 mg/ml, and from 46-50 mg/ml or any combination of these intervals.
   168. The method of any of the preceding items, wherein the concentration of mannitol in said pharmaceutical composition can be selected from group of intervals consisting of from 3-5 mM, from 5-8 mg/ml, from 8-11 mg/ml, from 11-14 mg/ml, from 14-17 mg/ml, from 17-20 mg/ml, from 20-23 mg/ml, from 23-26 mg/ml, from 26-29 mg/ml, from 39-32 mg/ml, from 32-35 mg/ml, from 35-38 mg/ml, from 35-42 mg/ml, from 42-46 mg/ml, and from 46-50 mg/ml or any combination of these intervals.
   169. The method of any of the preceding items, wherein the concentration of acetate in said pharmaceutical composition can be selected from group of intervals consisting of from 5-8 mM, from 8-11 mM, from 11-14 mM, from 14-17 mM, from 17-20 mM, from 20-23 mM, from 23-26 mM, from 26-29 mM, from 39-32 mM, from 32-35 mM, from 35-38 mM, from 35-42 mM, from 42-46 mM, and from 46-50 mM or any combination of these intervals.
   170. The method of any of the preceding items, wherein the matrices/sponges to be spray coated are
      a. Loaded onto a transport mechanism
      b. Transported to the spray chamber
      c. Spray coated
      d. Transported to the spray chamber to the a drying area
      e. Dried
      f. Subjected to brief cooling
      g. Transported to an area for packaging
      h. Packaged
   171. The method of item 170, wherein said transport mechanism is one or more conveyor belts.
   172. The method of item 170, wherein said transport mechanism is one or more vacuum conveyor belts.
   173. The method of any of the preceding items, wherein said matrices/sponges to be spray coated are loaded onto the transport mechanism by hand.
   174. The method of any of the preceding items, wherein said matrices/sponges to be spray coated are loaded onto the transport mechanism by a machine.
   175. The method of any of the preceding items, wherein said one or more matrices/sponges to be spray coated are positioned on the transport mechanism in one single line or in several parallel lines, such as 2 parallel lines, for example 3 parallel lines, such as 4 parallel lines, for example 5 parallel lines.
   176. The method of item 175, wherein the matrices/sponges are positioned as described on the more than one transport mechanism running in parallel, for example 2 transport mechanisms, such as 3 transport mechanisms, for example 4 transport mechanisms.
   177. The method of any of the preceding items, wherein the optimal application zone is at the centre of the on or more transport mechanisms.
   178. The method of any of the preceding items, wherein the optimal application zone is as far as possible away from the centre of the belt.
   179. The method of any of the preceding items, wherein the position and orientation of the matrices/sponges on the transport mechanism is fixated by vacuum suction.
   180. The method of any of the preceding items, wherein the ultrasonic spray technology employed comprises
      i. A system for supplying the pharmaceutical composition(s) which is to be spray coated onto the matrices
      j. One or more spray nozzle assemblies for atomizing the supplied pharmaceutical composition and directing the atomized pharmaceutical composition towards the matrices
   181. The method of item 180, wherein said one or more spray nozzle assemblies are continuously active.
   182. The method of item 180, wherein said one or more spray nozzle assemblies are activated when a batch of sponges enters the spray chamber.
   183. The method of item 180, wherein said one or more spray nozzle assemblies are activated manually.
   184. The method of any of the items 170-184, wherein said spray chamber contains one or more spray nozzle assemblies.
   185. The method of any of the items 170-185, wherein each of the one or more spray nozzle assemblies generates a spray mist.
   186. The method of any of the items, wherein said matrices to be coated are exposed to the spray mist generated from one or more spray nozzle assemblies.
   187. The method of any of the items 170-187, wherein the velocity of the transport mechanism can be selected from the group consisting of 0.76 m/min, 1.2 m/min, 2.36 m/min and 3.75 m/min.
   188. The method of any of the items 170-188, wherein the velocity of the transport mechanism is the range of from 0.02 m/min to 15.00 m/min, such as from 0.02 m/min to 0.04 m/min, for example from 0.04 m/min to 0.06 m/min, such as from 0.06 m/min to 0.08 m/min, for example from 0.08 m/min to 0.10 m/min, such as from 0.10 m/min to 0.12 m/min, for example from 0.12 m/min to 0.14 m/min, such as from 0.14 m/min to 0.16 m/min, for example from 0.16 m/min to 0.18 m/min, such as from 0.18 m/min to 0.20 m/min, for example from 0.20 m/min to 0.22 m/min, such as from 0.22 m/min to 0.24 m/min, for example from 0.24 m/min to 0.26 m/min, such as from 0.26 m/min to 0.28 m/min, for example from 0.28 m/min to 0.30 m/min, such as from 0.30 m/min to 0.32 m/min, for example from 0.32 m/min to 0.34 m/min, such as from 0.34 m/min to 0.36 m/min, for example from 0.36 m/min to 0.38 m/min, such as from 0.38 m/min to 0.40 m/min, for example from 0.40 m/min to 0.42 m/min, such as from 0.42 m/min to 0.44 m/min, for example from 0.44 m/min to 0.46 m/min, such as from 0.46 m/min to 0.48 m/min, for example from 0.48 m/min to 0.50 m/min, such as from 0.50 m/min to 0.52 m/min, for example from 0.52 m/min to 0.54 m/min, such as from 0.54 m/min to 0.56 m/min, for example from 0.56 m/min to 0.58 m/min, such as from 0.58 m/min to 0.60 m/min, for example from 0.60 m/min to 0.62 m/min, such as from 0.62 m/min to 0.64 m/min, for example from 0.64 m/min to 0.66 m/min, such as from 0.66 m/min to 0.68 m/min, for example from 0.68 m/min to 0.70 m/min, such as from 0.70 m/min to 0.72 m/min, for example from 0.72 m/min to 0.74 m/min, such as from 0.74 m/min to 0.76 m/min, for example from 0.76 m/min to 0.78 m/min, such as from 0.78 m/min to 0.80 m/min, for example from 0.80 m/min to 0.82 m/min, such as from 0.82 m/min to 0.84 m/min, for example from 0.84 m/min to 0.86 m/min, such as from 0.86 m/min to 0.88 m/min, for example from 0.88 m/min to 0.90 m/min, such as from 0.90 m/min to 0.92 m/min, for example from 0.92 m/min to 0.94 m/min, such as from 0.94 m/min to 0.96 m/min, for example from 0.96 m/min to 0.98 m/min, such as from 0.98 m/min to 1.00 m/min, for example from 1.00 m/min to 1.02 m/min, such as from 1.02 m/min to 1.04 m/min, for example from 1.04 m/min to 1.06 m/min, such as from 1.06 m/min to 1.08 m/min, for example from 1.08 m/min to 1.10 m/min, such as from 1.10 m/min to 1.12 m/min, for example from 1.12 m/min to 1.14 m/min, such as from 1.14 m/min to 1.16 m/min, for example from 1.16 m/min to 1.18 m/min, such as from 1.18 m/min to 1.20 m/min, for example from 1.20 m/min to 1.22 m/min, such as from 1.22 m/min to 1.24 m/min, for example from 1.24 m/min to 1.26 m/min, such as from 1.26 m/min to 1.28 m/min, for example from 1.28 m/min to 1.30 m/min, such as from 1.30 m/min to 1.32 m/min, for example from 1.32 m/min to 1.34 m/min, such as from 1.34 m/min to 1.36 m/min, for example from 1.36 m/min to 1.38 m/min, such as from 1.38 m/min to 1.40 m/min, for example from 1.40 m/min to 1.42 m/min, such as from 1.42 m/min to 1.44 m/min, for example from 1.44 m/min to 1.46 m/min, such as from 1.46 m/min to 1.48 m/min, for example from 1.48 m/min to 1.50 m/min, such as from 1.50 m/min to 1.52 m/min, for example from 1.52 m/min to 1.54 m/min, such as from 1.54 m/min to 1.56 m/min, for example from 1.56 m/min to 1.58 m/min, such as from 1.58 m/min to 1.60 m/min, for example from 1.60 m/min to 1.62 m/min, such as from 1.62 m/min to 1.64 m/min, for example from 1.64 m/min to 1.66 m/min, such as from 1.66 m/min to 1.68 m/min, for example from 1.68 m/min to 1.70 m/min, such as from 1.70 m/min to 1.72 m/min, for example from 1.72 m/min to 1.74 m/min, such as from 1.74 m/min to 1.76 m/min, for example from 1.76 m/min to 1.78 m/min, such as from 1.78 m/min to 1.80 m/min, for example from 1.80 m/min to 1.82 m/min, such as from 1.82 m/min to 1.84 m/min, for example from 1.84 m/min to 1.86 m/min, such as from 1.86 m/min to 1.88 m/min, for example from 1.88 m/min to 1.90 m/min, such as from 1.90 m/min to 1.92 m/min, for example from 1.92 m/min to 1.94 m/min, such as from 1.94 m/min to 1.96 m/min, for example from 1.96 m/min to 1.98 m/min, such as from 1.98 m/min to 2.00 m/min, for example from 2.00 m/min to 2.02 m/min, such as from 2.02 m/min to 2.04 m/min, for example from 2.04 m/min to 2.06 m/min, such as from 2.06 m/min to 2.08 m/min, for example from 2.08 m/min to 2.10 m/min, such as from 2.10 m/min to 2.12 m/min, for example from 2.12 m/min to 2.14 m/min, such as from 2.14 m/min to 2.16 m/min, for example from 2.16 m/min to 2.18 m/min, such as from 2.18 m/min to 2.20 m/min, for example from 2.20 m/min to 2.22 m/min, such as from 2.22 m/min to 2.24 m/min, for example from 2.24 m/min to 2.26 m/min, such as from 2.26 m/min to 2.28 m/min, for example from 2.28 m/min to 2.30 m/min, such as from 2.30 m/min to 2.32 m/min, for example from 2.32 m/min to 2.34 m/min, such as from 2.34 m/min to 2.36 m/min, for example from 2.36 m/min to 2.38 m/min, such as from 2.38 m/min to 2.40 m/min, for example from 2.40 m/min to 2.42 m/min, such as from 2.42 m/min to 2.44 m/min, for example from 2.44 m/min to 2.46 m/min, such as from 2.46 m/min to 2.48 m/min, for example from 2.48 m/min to 2.50 m/min, such as from 2.50 m/min to 2.52 m/min, for example from 2.52 m/min to 2.54 m/min, such as from 2.54 m/min to 2.56 m/min, for example from 2.56 m/min to 2.58 m/min, such as from 2.58 m/min to 2.60 m/min, for example from 2.60 m/min to 2.62 m/min, such as from 2.62 m/min to 2.64 m/min, for example from 2.64 m/min to 2.66 m/min, such as from 2.66 m/min to 2.68 m/min, for example from 2.68 m/min to 2.70 m/min, such as from 2.70 m/min to 2.72 m/min, for example from 2.72 m/min to 2.74 m/min, such as from 2.74 m/min to 2.76 m/min, for example from 2.76 m/min to 2.78 m/min, such as from 2.78 m/min to 2.80 m/min, for example from 2.80 m/min to 2.82 m/min, such as from 2.82 m/min to 2.84 m/min, for example from 2.84 m/min to 2.86 m/min, such as from 2.86 m/min to 2.88 m/min, for example from 2.88 m/min to 2.90 m/min, such as from 2.90 m/min to 2.92 m/min, for example from 2.92 m/min to 2.94 m/min, such as from 2.94 m/min to 2.96 m/min, for example from 2.96 m/min to 2.98 m/min, such as from 2.98 m/min to 3.00 m/min, for example from 3.00 m/min to 3.02 m/min, such as from 3.02 m/min to 3.04 m/min, for example from 3.04 m/min to 3.06 m/min, such as from 3.06 m/min to 3.08 m/min, for example from 3.08 m/min to 3.10 m/min, such as from 3.10 m/min to 3.12 m/min, for example from 3.12 m/min to 3.14 m/min, such as from 3.14 m/min to 3.16 m/min, for example from 3.16 m/min to 3.18 m/min, such as from 3.18 m/min to 3.20 m/min, for example from 3.20 m/min to 3.22 m/min, such as from 3.22 m/min to 3.24 m/min, for example from 3.24 m/min to 3.26 m/min, such as from 3.26 m/min to 3.28 m/min, for example from 3.28 m/min to 3.30 m/min, such as from 3.30 m/min to 3.32 m/min, for example from 3.32 m/min to 3.34 m/min, such as from 3.34 m/min to 3.36 m/min, for example from 3.36 m/min to 3.38 m/min, such as from 3.38 m/min to 3.40 m/min, for example from 3.40 m/min to 3.42 m/min, such as from 3.42 m/min to 3.44 m/min, for example from 3.44 m/min to 3.46 m/min, such as from 3.46 m/min to 3.48 m/min, for example from 3.48 m/min to 3.50 m/min, such as from 3.50 m/min to 3.52 m/min, for example from 3.52 m/min to 3.54 m/min, such as from 3.54 m/min to 3.56 m/min, for example from 3.56 m/min to 3.58 m/min, such as from 3.58 m/min to 3.60 m/min, for example from 3.60 m/min to 3.62 m/min, such as from 3.62 m/min to 3.64 m/min, for example from 3.64 m/min to 3.66 m/min, such as from 3.66 m/min to 3.68 m/min, for example from 3.68 m/min to 3.70 m/min, such as from 3.70 m/min to 3.72 m/min, for example from 3.72 m/min to 3.74 m/min, such as from 3.74 m/min to 3.76 m/min, for example from 3.76 m/min to 3.78 m/min, such as from 3.78 m/min to 3.80 m/min, for example from 3.80 m/min to 3.82 m/min, such as from 3.82 m/min to 3.84 m/min, for example from 3.84 m/min to 3.86 m/min, such as from 3.86 m/min to 3.88 m/min, for example from 3.88 m/min to 3.90 m/min, such as from 3.90 m/min to 3.92 m/min, for example from 3.92 m/min to 3.94 m/min, such as from 3.94 m/min to 3.96 m/min, for example from 3.96 m/min to 3.98 m/min, such as from 3.98 m/min to 4.00 m/min, for example from 4.00 m/min to 4.02 m/min, such as from 4.02 m/min to 4.04 m/min, for example from 4.04 m/min to 4.06 m/min, such as from 4.06 m/min to 4.08 m/min, for example from 4.08 m/min to 4.10 m/min, such as from 4.10 m/min to 4.12 m/min, for example from 4.12 m/min to 4.14 m/min, such as from 4.14 m/min to 4.16 m/min, for example from 4.16 m/min to 4.18 m/min, such as from 4.18 m/min to 4.20 m/min, for example from 4.20 m/min to 4.22 m/min, such as from 4.22 m/min to 4.24 m/min, for example from 4.24 m/min to 4.26 m/min, such as from 4.26 m/min to 4.28 m/min, for example from 4.28 m/min to 4.30 m/min, such as from 4.30 m/min to 4.32 m/min, for example from 4.32 m/min to 4.34 m/min, such as from 4.34 m/min to 4.36 m/min, for example from 4.36 m/min to 4.38 m/min, such as from 4.38 m/min to 4.40 m/min, for example from 4.40 m/min to 4.42 m/min, such as from 4.42 m/min to 4.44 m/min, for example from 4.44 m/min to 4.46 m/min, such as from 4.46 m/min to 4.48 m/min, for example from 4.48 m/min to 4.50 m/min, such as from 4.50 m/min to 4.52 m/min, for example from 4.52 m/min to 4.54 m/min, such as from 4.54 m/min to 4.56 m/min, for example from 4.56 m/min to 4.58 m/min, such as from 4.58 m/min to 4.60 m/min, for example from 4.60 m/min to 4.62 m/min, such as from 4.62 m/min to 4.64 m/min, for example from 4.64 m/min to 4.66 m/min, such as from 4.66 m/min to 4.68 m/min, for example from 4.68 m/min to 4.70 m/min, such as from 4.70 m/min to 4.72 m/min, for example from 4.72 m/min to 4.74 m/min, such as from 4.74 m/min to 4.76 m/min, for example from 4.76 m/min to 4.78 m/min, such as from 4.78 m/min to 4.80 m/min, for example from 4.80 m/min to 4.82 m/min, such as from 4.82 m/min to 4.84 m/min, for example from 4.84 m/min to 4.86 m/min, such as from 4.86 m/min to 4.88 m/min, for example from 4.88 m/min to 4.90 m/min, such as from 4.90 m/min to 4.92 m/min, for example from 4.92 m/min to 4.94 m/min, such as from 4.94 m/min to 4.96 m/min, for example from 4.96 m/min to 4.98 m/min, such as from 4.98 m/min to 5.00 m/min, for example from 5.00 m/min to 5.02 m/min, such as from 5.02 m/min to 5.04 m/min, for example from 5.04 m/min to 5.06 m/min, such as from 5.06 m/min to 5.08 m/min, for example from 5.08 m/min to 5.10 m/min, such as from 5.10 m/min to 5.12 m/min, for example from 5.12 m/min to 5.14 m/min, such as from 5.14 m/min to 5.16 m/min, for example from 5.16 m/min to 5.18 m/min, for example from 5.18 m/min to 5.20 m/min, such as from 5.20 m/min to 5.22 m/min, for example from 5.22 m/min to 5.24 m/min, such as from 5.24 m/min to 5.26 m/min, for example from 5.26 m/min to 5.28 m/min, such as from 5.28 m/min to 5.30 m/min, for example from 5.30 m/min to 5.32 m/min, such as from 5.32 m/min to 5.34 m/min, for example from 5.34 m/min to 5.36 m/min, such as from 5.36 m/min to 5.38 m/min, for example from 5.38 m/min to 5.40 m/min, such as from 5.40 m/min to 5.42 m/min, for example from 5.42 m/min to 5.44 m/min, such as from 5.44 m/min to 5.46 m/min, for example from 5.46 m/min to 5.48 m/min, such as from 5.48 m/min to 5.50 m/min, for example from 5.50 m/min to 5.52 m/min, such as from 5.52 m/min to 5.54 m/min, for example from 5.54 m/min to 5.56 m/min, such as from 5.56 m/min to 5.58 m/min, for example from 5.58 m/min to 5.60 m/min, such as from 5.60 m/min to 5.62 m/min, for example from 5.62 m/min to 5.64 m/min, such as from 5.64 m/min to 5.66 m/min, for example from 5.66 m/min to 5.68 m/min, such as from 5.68 m/min to 5.70 m/min, for example from 5.70 m/min to 5.72 m/min, such as from 5.72 m/min to 5.74 m/min, for example from 5.74 m/min to 5.76 m/min, such as from 5.76 m/min to 5.78 m/min, for example from 5.78 m/min to 5.80 m/min, such as from 5.80 m/min to 5.82 m/min, for example from 5.82 m/min to 5.84 m/min, such as from 5.84 m/min to 5.86 m/min, for example from 5.86 m/min to 5.88 m/min, such as from 5.88 m/min to 5.90 m/min, for example from 5.90 m/min to 5.92 m/min, such as from 5.92 m/min to 5.94 m/min, for example from 5.94 m/min to 5.96 m/min, such as from 5.96 m/min to 5.98 m/min, for example from 5.98 m/min to 6.00 m/min, such as from 6.00 m/min to 6.02 m/min, for example from 6.02 m/min to 6.04 m/min, such as from 6.04 m/min to 6.06 m/min, for example from 6.06 m/min to 6.08 m/min, such as from 6.08 m/min to 6.10 m/min, for example from 6.10 m/min to 6.12 m/min, such as from 6.12 m/min to 6.14 m/min, for example from 6.14 m/min to 6.16 m/min, such as from 6.16 m/min to 6.18 m/min, for example from 6.18 m/min to 6.20 m/min, such as from 6.20 m/min to 6.22 m/min, for example from 6.22 m/min to 6.24 m/min, such as from 6.24 m/min to 6.26 m/min, for example from 6.26 m/min to 6.28 m/min, such as from 6.28 m/min to 6.30 m/min, for example from 6.30 m/min to 6.32 m/min, such as from 6.32 m/min to 6.34 m/min, for example from 6.34 m/min to 6.36 m/min, such as from 6.36 m/min to 6.38 m/min, for example from 6.38 m/min to 6.40 m/min, such as from 6.40 m/min to 6.42 m/min, for example from 6.42 m/min to 6.44 m/min, such as from 6.44 m/min to 6.46 m/min, for example from 6.46 m/min to 6.48 m/min, such as from 6.48 m/min to 6.50 m/min, for example from 6.50 m/min to 6.52 m/min, such as from 6.52 m/min to 6.54 m/min, for example from 6.54 m/min to 6.56 m/min, such as from 6.56 m/min to 6.58 m/min, for example from 6.58 m/min to 6.60 m/min, such as from 6.60 m/min to 6.62 m/min, for example from 6.62 m/min to 6.64 m/min, such as from 6.64 m/min to 6.66 m/min, for example from 6.66 m/min to 6.68 m/min, such as from 6.68 m/min to 6.70 m/min, for example from 6.70 m/min to 6.72 m/min, such as from 6.72 m/min to 6.74 m/min, for example from 6.74 m/min to 6.76 m/min, such as from 6.76 m/min to 6.78 m/min, for example from 6.78 m/min to 6.80 m/min, such as from 6.80 m/min to 6.82 m/min, for example from 6.82 m/min to 6.84 m/min, such as from 6.84 m/min to 6.86 m/min, for example from 6.86 m/min to 6.88 m/min, such as from 6.88 m/min to 6.90 m/min, for example from 6.90 m/min to 6.92 m/min, such as from 6.92 m/min to 6.94 m/min, for example from 6.94 m/min to 6.96 m/min, such as from 6.96 m/min to 6.98 m/min, for example from 6.98 m/min to 7.00 m/min, such as from 7.00 m/min to 7.02 m/min, for example from 7.02 m/min to 7.04 m/min, such as from 7.04 m/min to 7.06 m/min, for example from 7.06 m/min to 7.08 m/min, such as from 7.08 m/min to 7.10 m/min, for example from 7.10 m/min to 7.12 m/min, such as from 7.12 m/min to 7.14 m/min, for example from 7.14 m/min to 7.16 m/min, such as from 7.16 m/min to 7.18 m/min, for example from 7.18 m/min to 7.20 m/min, such as from 7.20 m/min to 7.22 m/min, for example from 7.22 m/min to 7.24 m/min, such as from 7.24 m/min to 7.26 m/min, for example from 7.26 m/min to 7.28 m/min, such as from 7.28 m/min to 7.30 m/min, for example from 7.30 m/min to 7.32 m/min, such as from 7.32 m/min to 7.34 m/min, for example from 7.34 m/min to 7.36 m/min, such as from 7.36 m/min to 7.38 m/min, for example from 7.38 m/min to 7.40 m/min, such as from 7.40 m/min to 7.42 m/min, for example from 7.42 m/min to 7.44 m/min, such as from 7.44 m/min to 7.46 m/min, for example from 7.46 m/min to 7.48 m/min, such as from 7.48 m/min to 7.50 m/min, for example from 7.50 m/min to 7.52 m/min, such as from 7.52 m/min to 7.54 m/min, for example from 7.54 m/min to 7.56 m/min, such as from 7.56 m/min to 7.58 m/min, for example from 7.58 m/min to 7.60 m/min, such as from 7.60 m/min to 7.62 m/min, for example from 7.62 m/min to 7.64 m/min, such as from 7.64 m/min to 7.66 m/min, for example from 7.66 m/min to 7.68 m/min, such as from 7.68 m/min to 7.70 m/min, for example from 7.70 m/min to 7.72 m/min, such as from 7.72 m/min to 7.74 m/min, for example from 7.74 m/min to 7.76 m/min, such as from 7.76 m/min to 7.78 m/min, for example from 7.78 m/min to 7.80 m/min, such as from 7.80 m/min to 7.82 m/min, for example from 7.82 m/min to 7.84 m/min, such as from 7.84 m/min to 7.86 m/min, for example from 7.86 m/min to 7.88 m/min, such as from 7.88 m/min to 7.90 m/min, for example from 7.90 m/min to 7.92 m/min, such as from 7.92 m/min to 7.94 m/min, for example from 7.94 m/min to 7.96 m/min, such as from 7.96 m/min to 7.98 m/min, for example from 7.98 m/min to 8.00 m/min, such as from 8.00 m/min to 9.00 m/min, for example from 9.00 m/min to 10.00 m/min, such as from 10.00 m/min to 12.00 m/min, for example from 12.00 m/min to 15.00 m/min, or any combination of these velocity intervals.
189. The method of any of the items, wherein the density and thickness of coating on the matrices is regulated by regulating the speed of the transport mechanism, thus regulating the time during which the surface of the matrices to be coated are exposed to spray mist.
190. The method of any of the items 180-189, wherein each spray nozzle assembly consists of one or more than one independent ultrasonic spray nozzle, for example two ultrasonic spray nozzles, such as three ultrasonic spray nozzles, for example four ultrasonic spray nozzles, such as five ultrasonic spray nozzles.
191. The method of any of the items 180-190, wherein each of the independent spray nozzles of a spray nozzle assembly has separate supply lines i.e. an independent liquid feed tube and an independent supply reservoir.
192. The method of item 191, wherein the two or more independent supply reservoirs supplying the ultrasonic spray nozzles of a spray nozzle assembly (e.g. ultrasonic spray nozzles 1 and 2) contain identical (liquid) pharmaceutical composition.
193. The method of any of items 192-193, wherein the two or more independent supply reservoirs supplying ultrasonic spray nozzles of a spray nozzle assembly (e.g. ultrasonic spray nozzles 1 and 2) contain different (liquid) pharmaceutical composition.
194. The method of any of the items 192-194, wherein each of the independent supply lines delivers the pharmaceutical composition separately to each independent spray nozzle of a nozzle assembly with a controlled flow rate by means of a pump.
195. The method of item 194, wherein each of the independent supply lines is acted upon by a separate pump.
196. The method of any of the items 190-195, wherein the first flow rate (Flow rate 1) regarding pharmaceutical composition delivered to spray nozzle 1 of a nozzle assembly can be 1.4 ml/min or 5.37 ml/min.
197. The method of any of the items 190-196, wherein the first flow rate (Flow rate 1) regarding liquid delivered to spray nozzle 1 of a nozzle assembly is selected from the group consisting of from 0.02 ml/min to 0.04 ml/min, from 0.04 ml/min to 0.06 ml/min, from 0.06 ml/min to 0.08 ml/min, from 0.08 ml/min to 0.10 ml/min, from 0.10 ml/min to 0.12 ml/min, from 0.12 ml/min to 0.14 ml/min, from 0.14 ml/min to 0.16 ml/min, from 0.16 ml/min to 0.18 ml/min, from 0.18 ml/min to 0.20 ml/min, from 0.20 ml/min to 0.22 ml/min, from 0.22 ml/min to 0.24 ml/min, from 0.24 ml/min to 0.26 ml/min, from 0.26 ml/min to 0.28 ml/min, from 0.28 ml/min to 0.30 ml/min, from 0.30 ml/min to 0.32 ml/min, from 0.32 ml/min to 0.34 ml/min, from 0.34 ml/min to 0.36 ml/min, from 0.36 ml/min to 0.38 ml/min, from 0.38 ml/min to 0.40 ml/min, from 0.40 ml/min to 0.42 ml/min, from 0.42 ml/min to 0.44 ml/min, from 0.44 ml/min to 0.46 ml/min, from 0.46 ml/min to 0.48 ml/min, from 0.48 ml/min to 0.50 ml/min, from 0.50 ml/min to 0.52 ml/min, from 0.52 ml/min to 0.54 ml/min, from 0.54 ml/min to 0.56 ml/min, from 0.56 ml/min to 0.58 ml/min, from 0.58 ml/min to 0.60 ml/min, from 0.60 ml/min to 0.62 ml/min, from 0.62 ml/min to 0.64 ml/min, from 0.64 ml/min to 0.66 ml/min, from 0.66 ml/min to 0.68 ml/min, from 0.68 ml/min to 0.70 ml/min, from 0.70 ml/min to 0.72 ml/min, from 0.72 ml/min to 0.74 ml/min, from 0.74 ml/min to 0.76 ml/min, from 0.76 ml/min to 0.78 ml/min, from 0.78 ml/min to 0.80 ml/min, from 0.80 ml/min to 0.82 ml/min, from 0.82 ml/min to 0.84 ml/min, from 0.84 ml/min to 0.86 ml/min, from 0.86 ml/min to 0.88 ml/min, from 0.88 ml/min to 0.90 ml/min, from 0.90 ml/min to 0.92 ml/min, from 0.92 ml/min to 0.94 ml/min, from 0.94 ml/min to 0.96 ml/min, from 0.96 ml/min to 0.98 ml/min, from 0.98 ml/min to 1.00 ml/min, from 1.00 ml/min to 1.02 ml/min, from 1.02 ml/min to 1.04 ml/min, from 1.04 ml/min to 1.06 ml/min, from 1.06 ml/min to 1.08 ml/min, from 1.08 ml/min to 1.10 ml/min, from 1.10 ml/min to 1.12 ml/min, from 1.12 ml/min to 1.14 ml/min, from 1.14 ml/min to 1.16 ml/min, from 1.16 ml/min to 1.18 ml/min, from 1.18 ml/min to 1.20 ml/min, from 1.20 ml/min to 1.22 ml/min, from 1.22 ml/min to 1.24 ml/min, from 1.24 ml/min to 1.26 ml/min, from 1.26 ml/min to 1.28 ml/min, from 1.28 ml/min to 1.30 ml/min, from 1.30 ml/min to 1.32 ml/min, from 1.32 ml/min to 1.34 ml/min, from 1.34 ml/min to 1.36 ml/min, from 1.36 ml/min to 1.38 ml/min, from 1.38 ml/min to 1.40 ml/min, from 1.40 ml/min to 1.42 ml/min, from 1.42 ml/min to 1.44 ml/min, from 1.44 ml/min to 1.46 ml/min, from 1.46 ml/min to 1.48 ml/min, from 1.48 ml/min to 1.50 ml/min, from 1.50 ml/min to 1.52 ml/min, from 1.52 ml/min to 1.54 ml/min, from 1.54 ml/min to 1.56 ml/min, from 1.56 ml/min to 1.58 ml/min, from 1.58 ml/min to 1.60 ml/min, from 1.60 ml/min to 1.62 ml/min, from 1.62 ml/min to 1.64 ml/min, from 1.64 ml/min to 1.66 ml/min, from 1.66 ml/min to 1.68 ml/min, from 1.68 ml/min to 1.70 ml/min, from 1.70 ml/min to 1.72 ml/min, from 1.72 ml/min to 1.74 ml/min, from 1.74 ml/min to 1.76 ml/min, from 1.76 ml/min to 1.78 ml/min, from 1.78 ml/min to 1.80 ml/min, from 1.80 ml/min to 1.82 ml/min, from 1.82 ml/min to 1.84 ml/min, from 1.84 ml/min to 1.86 ml/min, from 1.86 ml/min to 1.88 ml/min, from 1.88 ml/min to 1.90 ml/min, from 1.90 ml/min to 1.92 ml/min, from 1.92 ml/min to 1.94 ml/min, from 1.94 ml/min to 1.96 ml/min, from 1.96 ml/min to 1.98 ml/min, from 1.98 ml/min to 2.00 ml/min, from 2.00 ml/min to 2.02 ml/min, from 2.02 ml/min to 2.04 ml/min, from 2.04 ml/min to 2.06 ml/min, from 2.06 ml/min to 2.08 ml/min, from 2.08 ml/min to 2.10 ml/min, from 2.10 ml/min to 2.12 ml/min, from 2.12 ml/min to 2.14 ml/min, from 2.14 ml/min to 2.16 ml/min, from 2.16 ml/min to 2.18 ml/min, from 2.18 ml/min to 2.20 ml/min, from 2.20 ml/min to 2.22 ml/min, from 2.22 ml/min to 2.24 ml/min, from 2.24 ml/min to 2.26 ml/min, from 2.26 ml/min to 2.28 ml/min, from 2.28 ml/min to 2.30 ml/min, from 2.30 ml/min to 2.32 ml/min, from 2.32 ml/min to 2.34 ml/min, from 2.34 ml/min to 2.36 ml/min, from 2.36 ml/min to 2.38 ml/min, from 2.38 ml/min to 2.40 ml/min, from 2.40 ml/min to 2.42 ml/min, from 2.42 ml/min to 2.44 ml/min, from 2.44 ml/min to 2.46 ml/min, from 2.46 ml/min to 2.48 ml/min, from 2.48 ml/min to 2.50 ml/min, from 2.50 ml/min to 2.52 ml/min, from 2.52 ml/min to 2.54 ml/min, from 2.54 ml/min to 2.56 ml/min, from 2.56 ml/min to 2.58 ml/min, from 2.58 ml/min to 2.60 ml/min, from 2.60 ml/min to 2.62 ml/min, from 2.62 ml/min to 2.64 ml/min, from 2.64 ml/min to 2.66 ml/min, from 2.66 ml/min to 2.68 ml/min, from 2.68 ml/min to 2.70 ml/min, from 2.70 ml/min to 2.72 ml/min, from 2.72 ml/min to 2.74 ml/min, from 2.74 ml/min to 2.76 ml/min, from 2.76 ml/min to 2.78 ml/min, from 2.78 ml/min to 2.80 ml/min, from 2.80 ml/min to 2.82 ml/min, from 2.82 ml/min to 2.84 ml/min, from 2.84 ml/min to 2.86 ml/min, from 2.86 ml/min to 2.88 ml/min, from 2.88 ml/min to 2.90 ml/min, from 2.90 ml/min to 2.92 ml/min, from 2.92 ml/min to 2.94 ml/min, from 2.94 ml/min to 2.96 ml/min, from 2.96 ml/min to 2.98 ml/min, from 2.98 ml/min to 3.00 ml/min, from 3.00 ml/min to 3.02 ml/min, from 3.02 ml/min to 3.04 ml/min, from 3.04 ml/min to 3.06 ml/min, from 3.06 ml/min to 3.08 ml/min, from 3.08 ml/min to 3.10 ml/min, from 3.10 ml/min to 3.12 ml/min, from 3.12 ml/min to 3.14 ml/min, from 3.14 ml/min to 3.16 ml/min, from 3.16 ml/min to 3.18 ml/min, from 3.18 ml/min to 3.20 ml/min, from 3.20 ml/min to 3.22 ml/min, from 3.22 ml/min to 3.24 ml/min, from 3.24 ml/min to 3.26 ml/min, from 3.26 ml/min to 3.28 ml/min, from 3.28 ml/min to 3.30 ml/min, from 3.30 ml/min to 3.32 ml/min, from 3.32 ml/min to 3.34 ml/min, from 3.34 ml/min to 3.36 ml/min, from 3.36 ml/min to 3.38 ml/min, from 3.38 ml/min to 3.40 ml/min, from 3.40 ml/min to 3.42 ml/min, from 3.42 ml/min to 3.44 ml/min, from 3.44 ml/min to 3.46 ml/min, from 3.46 ml/min to 3.48 ml/min, from 3.48 ml/min to 3.50 ml/min, from 3.50 ml/min to 3.52 ml/min, from 3.52 ml/min to 3.54 ml/min, from 3.54 ml/min to 3.56 ml/min, from 3.56 ml/min to 3.58 ml/min, from 3.58 ml/min to 3.60 ml/min, from 3.60 ml/min to 3.62 ml/min, from 3.62 ml/min to 3.64 ml/min, from 3.64 ml/min to 3.66 ml/min, from 3.66 ml/min to 3.68 ml/min, from 3.68 ml/min to 3.70 ml/min, from 3.70 ml/min to 3.72 ml/min, from 3.72 ml/min to 3.74 ml/min, from 3.74 ml/min to 3.76 ml/min, from 3.76 ml/min to 3.78 ml/min, from 3.78 ml/min to 3.80 ml/min, from 3.80 ml/min to 3.82 ml/min, from 3.82 ml/min to 3.84 ml/min, from 3.84 ml/min to 3.86 ml/min, from 3.86 ml/min to 3.88 ml/min, from 3.88 ml/min to 3.90 ml/min, from 3.90 ml/min to 3.92 ml/min, from 3.92 ml/min to 3.94 ml/min, from 3.94 ml/min to 3.96 ml/min, from 3.96 ml/min to 3.98 ml/min, from 3.98 ml/min to 4.00 ml/min, from 4.00 ml/min to 4.02 ml/min, from 4.02 ml/min to 4.04 ml/min, from 4.04 ml/min to 4.06 ml/min, from 4.06 ml/min to 4.08 ml/min, from 4.08 ml/min to 4.10 ml/min, from 4.10 ml/min to 4.12 ml/min, from 4.12 ml/min to 4.14 ml/min, from 4.14 ml/min to 4.16 ml/min, from 4.16 ml/min to 4.18 ml/min, from 4.18 ml/min to 4.20 ml/min, from 4.20 ml/min to 4.22 ml/min, from 4.22 ml/min to 4.24 ml/min, from 4.24 ml/min to 4.26 ml/min, from 4.26 ml/min to 4.28 ml/min, from 4.28 ml/min to 4.30 ml/min, from 4.30 ml/min to 4.32 ml/min, from 4.32 ml/min to 4.34 ml/min, from 4.34 ml/min to 4.36 ml/min, from 4.36 ml/min to 4.38 ml/min, from 4.38 ml/min to 4.40 ml/min, from 4.40 ml/min to 4.42 ml/min, from 4.42 ml/min to 4.44 ml/min, from 4.44 ml/min to 4.46 ml/min, from 4.46 ml/min to 4.48 ml/min, from 4.48 ml/min to 4.50 ml/min, from 4.50 ml/min to 4.52 ml/min, from 4.52 ml/min to 4.54 ml/min, from 4.54 ml/min to 4.56 ml/min, from 4.56 ml/min to 4.58 ml/min, from 4.58 ml/min to 4.60 ml/min, from 4.60 ml/min to 4.62 ml/min, from 4.62 ml/min to 4.64 ml/min, from 4.64 ml/min to 4.66 ml/min, from 4.66 ml/min to 4.68 ml/min, from 4.68 ml/min to 4.70 ml/min, from 4.70 ml/min to 4.72 ml/min, from 4.72 ml/min to 4.74 ml/min, from 4.74 ml/min to 4.76 ml/min, from 4.76 ml/min to 4.78 ml/min, from 4.78 ml/min to 4.80 ml/min, from 4.80 ml/min to 4.82 ml/min, from 4.82 ml/min to 4.84 ml/min, from 4.84 ml/min to 4.86 ml/min, from 4.86 ml/min to 4.88 ml/min, from 4.88 ml/min to 4.90 ml/min, from 4.90 ml/min to 4.92 ml/min, from 4.92 ml/min to 4.94 ml/min, from 4.94 ml/min to 4.96 ml/min, from 4.96 ml/min to 4.98 ml/min, from 4.98 ml/min to 5.00 ml/min, from 5.00 ml/min to 5.02 ml/min, from 5.02 ml/min to 5.04 ml/min, from 5.04 ml/min to 5.06 ml/min, from 5.06 ml/min to 5.08 ml/min, from 5.08 ml/min to 5.10 ml/min, from 5.10 ml/min to 5.12 ml/min, from 5.12 ml/min to 5.14 ml/min, from 5.14 ml/min to 5.16 ml/min, from 5.16 ml/min to 5.18 ml/min, from 5.18 ml/min to 5.20 ml/min, from 5.20 ml/min to 5.22 ml/min, from 5.22 ml/min to 5.24 ml/min, from 5.24 ml/min to 5.26 ml/min, from 5.26 ml/min to 5.28 ml/min, from 5.28 ml/min to 5.30 ml/min, from 5.30 ml/min to 5.32 ml/min, from 5.32 ml/min to 5.34 ml/min, from 5.34 ml/min to 5.36 ml/min, from 5.36 ml/min to 5.38 ml/min, from 5.38 ml/min to 5.40 ml/min, from 5.40 ml/min to 5.42 ml/min, from 5.42 ml/min to 5.44 ml/min, from 5.44 ml/min to 5.46 ml/min, from 5.46 ml/min to 5.48 ml/min, from 5.48 ml/min to 5.50 ml/min, from 5.50 ml/min to 5.52 ml/min, from 5.52 ml/min to 5.54 ml/min, from 5.54 ml/min to 5.56 ml/min, from 5.56 ml/min to 5.58 ml/min, from 5.58 ml/min to 5.60 ml/min, from 5.60 ml/min to 5.62 ml/min, from 5.62 ml/min to 5.64 ml/min, from 5.64 ml/min to 5.66 ml/min, from 5.66 ml/min to 5.68 ml/min, from 5.68 ml/min to 5.70 ml/min, from 5.70 ml/min to 5.72 ml/min, from 5.72 ml/min to 5.74 ml/min, from 5.74 ml/min to 5.76 ml/min, from 5.76 ml/min to 5.78 ml/min, from 5.78 ml/min to 5.80 ml/min, from 5.80 ml/min to 5.82 ml/min, from 5.82 ml/min to 5.84 ml/min, from 5.84 ml/min to 5.86 ml/min, from 5.86 ml/min to 5.88 ml/min, from 5.88 ml/min to 5.90 ml/min, from 5.90 ml/min to 5.92 ml/min, from 5.92 ml/min to 5.94 ml/min, from 5.94 ml/min to 5.96 ml/min, from 5.96 ml/min to 5.98 ml/min, from 5.98 ml/min to 6.00 ml/min, from 6.00 ml/min to 6.02 ml/min, from 6.02 ml/min to 6.04 ml/min, from 6.04 ml/min to 6.06 ml/min, from 6.06 ml/min to 6.08 ml/min, from 6.08 ml/min to 6.10 ml/min, from 6.10 ml/min to 6.12 ml/min, from 6.12 ml/min to 6.14 ml/min, from 6.14 ml/min to 6.16 ml/min, from 6.16 ml/min to 6.18 ml/min, from 6.18 ml/min to 6.20 ml/min, from 6.20 ml/min to 6.22 ml/min, from 6.22 ml/min to 6.24 ml/min, from 6.24 ml/min to 6.26 ml/min, from 6.26 ml/min to 6.28 ml/min, from 6.28 ml/min to 6.30 ml/min, from 6.30 ml/min to 6.32 ml/min, from 6.32 ml/min to 6.34 ml/min, from 6.34 ml/min to 6.36 ml/min, from 6.36 ml/min to 6.38 ml/min, from 6.38 ml/min to 6.40 ml/min, from 6.40 ml/min to 6.42 ml/min, from 6.42 ml/min to 6.44 ml/min, from 6.44 ml/min to 6.46 ml/min, from 6.46 ml/min to 6.48 ml/min, from 6.48 ml/min to 6.50 ml/min, from 6.50 ml/min to 6.52 ml/min, from 6.52 ml/min to 6.54 ml/min, from 6.54 ml/min to 6.56 ml/min, from 6.56 ml/min to 6.58 ml/min, from 6.58 ml/min to 6.60 ml/min, from 6.60 ml/min to 6.62 ml/min, from 6.62 ml/min to 6.64 ml/min, from 6.64 ml/min to 6.66 ml/min, from 6.66 ml/min to 6.68 ml/min, from 6.68 ml/min to 6.70 ml/min, from 6.70 ml/min to 6.72 ml/min, from 6.72 ml/min to 6.74 ml/min, from 6.74 ml/min to 6.76 ml/min, from 6.76 ml/min to 6.78 ml/min, from 6.78 ml/min to 6.80 ml/min, from 6.80 ml/min to 6.82 ml/min, from 6.82 ml/min to 6.84 ml/min, from 6.84 ml/min to 6.86 ml/min, from 6.86 ml/min to 6.88 ml/min, from 6.88 ml/min to 6.90 ml/min, from 6.90 ml/min to 6.92 ml/min, from 6.92 ml/min to 6.94 ml/min, from 6.94 ml/min to 6.96 ml/min, from 6.96 ml/min to 6.98 ml/min, from 6.98 ml/min to 7.00 ml/min, from 7.00 ml/min to 7.02 ml/min, from 7.02 ml/min to 7.04 ml/min, from 7.04 ml/min to 7.06 ml/min, from 7.06 ml/min to 7.08 ml/min, from 7.08 ml/min to 7.10 ml/min, from 7.10 ml/min to 7.12 ml/min, from 7.12 ml/min to 7.14 ml/min, from 7.14 ml/min to 7.16 ml/min, from 7.16 ml/min to 7.18 ml/min, from 7.18 ml/min to 7.20 ml/min, from 7.20 ml/min to 7.22 ml/min, from 7.22 ml/min to 7.24 ml/min, from 7.24 ml/min to 7.26 ml/min, from 7.26 ml/min to 7.28 ml/min, from 7.28 ml/min to 7.30 ml/min, from 7.30 ml/min to 7.32 ml/min, from 7.32 ml/min to 7.34 ml/min, from 7.34 ml/min to 7.36 ml/min, from 7.36 ml/min to 7.38 ml/min, from 7.38 ml/min to 7.40 ml/min, from 7.40 ml/min to 7.42 ml/min, from 7.42 ml/min to 7.44 ml/min, from 7.44 ml/min to 7.46 ml/min, from 7.46 ml/min to 7.48 ml/min, from 7.48 ml/min to 7.50 ml/min, from 7.50 ml/min to 7.52 ml/min, from 7.52 ml/min to 7.54 ml/min, from 7.54 ml/min to 7.56 ml/min, from 7.56 ml/min to 7.58 ml/min, from 7.58 ml/min to 7.60 ml/min, from 7.60 ml/min to 7.62 ml/min, from 7.62 ml/min to 7.64 ml/min, from 7.64 ml/min to 7.66 ml/min, from 7.66 ml/min to 7.68 ml/min, from 7.68 ml/min to 7.70 ml/min, from 7.70 ml/min to 7.72 ml/min, from 7.72 ml/min to 7.74 ml/min, from 7.74 ml/min to 7.76 ml/min, from 7.76 ml/min to 7.78 ml/min, from 7.78 ml/min to 7.80 ml/min, from 7.80 ml/min to 7.82 ml/min, from 7.82 ml/min to 7.84 ml/min, from 7.84 ml/min to 7.86 ml/min, from 7.86 ml/min to 7.88 ml/min, from 7.88 ml/min to 7.90 ml/min, from 7.90 ml/min to 7.92 ml/min, from 7.92 ml/min to 7.94 ml/min, from 7.94 ml/min to 7.96 ml/min, from 7.96 ml/min to 7.98 ml/min, from 7.98 ml/min to 8.00 ml/min, from 8.00 ml/min to 9.00 ml/min, from 9.00 ml/min to 10.00 ml/min, from 10.00 ml/min to 12.00 ml/min, from 12.00 ml/min to 15.00 ml/min, or any combination of these flow rate intervals.
   198. The method of any of the items 190-195, wherein the second flow rate (Flow rate 2) regarding liquid delivered to spray nozzle 2 of a nozzle assembly can be 1.4 ml/min or 5.37 ml/min.
   199. The method of any of the items 190-195, wherein the second flow rate (Flow rate 2) is selected from the group consisting of from 0.02 ml/min to 0.04 ml/min, from 0.04 ml/min to 0.06 ml/min, from 0.06 ml/min to 0.08 ml/min, from 0.08 ml/min to 0.10 ml/min, from 0.10 ml/min to 0.12 ml/min, from 0.12 ml/min to 0.14 ml/min, from 0.14 ml/min to 0.16 ml/min, from 0.16 ml/min to 0.18 ml/min, from 0.18 ml/min to 0.20 ml/min, from 0.20 ml/min to 0.22 ml/min, from 0.22 ml/min to 0.24 ml/min, from 0.24 ml/min to 0.26 ml/min, from 0.26 ml/min to 0.28 ml/min, from 0.28 ml/min to 0.30 ml/min, from 0.30 ml/min to 0.32 ml/min, from 0.32 ml/min to 0.34 ml/min, from 0.34 ml/min to 0.36 ml/min, from 0.36 ml/min to 0.38 ml/min, from 0.38 ml/min to 0.40 ml/min, from 0.40 ml/min to 0.42 ml/min, from 0.42 ml/min to 0.44 ml/min, from 0.44 ml/min to 0.46 ml/min, from 0.46 ml/min to 0.48 ml/min, from 0.48 ml/min to 0.50 ml/min, from 0.50 ml/min to 0.52 ml/min, from 0.52 ml/min to 0.54 ml/min, from 0.54 ml/min to 0.56 ml/min, from 0.56 ml/min to 0.58 ml/min, from 0.58 ml/min to 0.60 ml/min, from 0.60 ml/min to 0.62 ml/min, from 0.62 ml/min to 0.64 ml/min, from 0.64 ml/min to 0.66 ml/min, from 0.66 ml/min to 0.68 ml/min, from 0.68 ml/min to 0.70 ml/min, from 0.70 ml/min to 0.72 ml/min, from 0.72 ml/min to 0.74 ml/min, from 0.74 ml/min to 0.76 ml/min, from 0.76 ml/min to 0.78 ml/min, from 0.78 ml/min to 0.80 ml/min, from 0.80 ml/min to 0.82 ml/min, from 0.82 ml/min to 0.84 ml/min, from 0.84 ml/min to 0.86 ml/min, from 0.86 ml/min to 0.88 ml/min, from 0.88 ml/min to 0.90 ml/min, from 0.90 ml/min to 0.92 ml/min, from 0.92 ml/min to 0.94 ml/min, from 0.94 ml/min to 0.96 ml/min, from 0.96 ml/min to 0.98 ml/min, from 0.98 ml/min to 1.00 ml/min, from 1.00 ml/min to 1.02 ml/min, from 1.02 ml/min to 1.04 ml/min, from 1.04 ml/min to 1.06 ml/min, from 1.06 ml/min to 1.08 ml/min, from 1.08 ml/min to 1.10 ml/min, from 1.10 ml/min to 1.12 ml/min, from 1.12 ml/min to 1.14 ml/min, from 1.14 ml/min to 1.16 ml/min, from 1.16 ml/min to 1.18 ml/min, from 1.18 ml/min to 1.20 ml/min, from 1.20 ml/min to 1.22 ml/min, from 1.22 ml/min to 1.24 ml/min, from 1.24 ml/min to 1.26 ml/min, from 1.26 ml/min to 1.28 ml/min, from 1.28 ml/min to 1.30 ml/min, from 1.30 ml/min to 1.32 ml/min, from 1.32 ml/min to 1.34 ml/min, from 1.34 ml/min to 1.36 ml/min, from 1.36 ml/min to 1.38 ml/min, from 1.38 ml/min to 1.40 ml/min, from 1.40 ml/min to 1.42 ml/min, from 1.42 ml/min to 1.44 ml/min, from 1.44 ml/min to 1.46 ml/min, from 1.46 ml/min to 1.48 ml/min, from 1.48 ml/min to 1.50 ml/min, from 1.50 ml/min to 1.52 ml/min, from 1.52 ml/min to 1.54 ml/min, from 1.54 ml/min to 1.56 ml/min, from 1.56 ml/min to 1.58 ml/min, from 1.58 ml/min to 1.60 ml/min, from 1.60 ml/min to 1.62 ml/min, from 1.62 ml/min to 1.64 ml/min, from 1.64 ml/min to 1.66 ml/min, from 1.66 ml/min to 1.68 ml/min, from 1.68 ml/min to 1.70 ml/min, from 1.70 ml/min to 1.72 ml/min, from 1.72 ml/min to 1.74 ml/min, from 1.74 ml/min to 1.76 ml/min, from 1.76 ml/min to 1.78 ml/min, from 1.78 ml/min to 1.80 ml/min, from 1.80 ml/min to 1.82 ml/min, from 1.82 ml/min to 1.84 ml/min, from 1.84 ml/min to 1.86 ml/min, from 1.86 ml/min to 1.88 ml/min, from 1.88 ml/min to 1.90 ml/min, from 1.90 ml/min to 1.92 ml/min, from 1.92 ml/min to 1.94 ml/min, from 1.94 ml/min to 1.96 ml/min, from 1.96 ml/min to 1.98 ml/min, from 1.98 ml/min to 2.00 ml/min, from 2.00 ml/min to 2.02 ml/min, from 2.02 ml/min to 2.04 ml/min, from 2.04 ml/min to 2.06 ml/min, from 2.06 ml/min to 2.08 ml/min, from 2.08 ml/min to 2.10 ml/min, from 2.10 ml/min to 2.12 ml/min, from 2.12 ml/min to 2.14 ml/min, from 2.14 ml/min to 2.16 ml/min, from 2.16 ml/min to 2.18 ml/min, from 2.18 ml/min to 2.20 ml/min, from 2.20 ml/min to 2.22 ml/min, from 2.22 ml/min to 2.24 ml/min, from 2.24 ml/min to 2.26 ml/min, from 2.26 ml/min to 2.28 ml/min, from 2.28 ml/min to 2.30 ml/min, from 2.30 ml/min to 2.32 ml/min, from 2.32 ml/min to 2.34 ml/min, from 2.34 ml/min to 2.36 ml/min, from 2.36 ml/min to 2.38 ml/min, from 2.38 ml/min to 2.40 ml/min, from 2.40 ml/min to 2.42 ml/min, from 2.42 ml/min to 2.44 ml/min, from 2.44 ml/min to 2.46 ml/min, from 2.46 ml/min to 2.48 ml/min, from 2.48 ml/min to 2.50 ml/min, from 2.50 ml/min to 2.52 ml/min, from 2.52 ml/min to 2.54 ml/min, from 2.54 ml/min to 2.56 ml/min, from 2.56 ml/min to 2.58 ml/min, from 2.58 ml/min to 2.60 ml/min, from 2.60 ml/min to 2.62 ml/min, from 2.62 ml/min to 2.64 ml/min, from 2.64 ml/min to 2.66 ml/min, from 2.66 ml/min to 2.68 ml/min, from 2.68 ml/min to 2.70 ml/min, from 2.70 ml/min to 2.72 ml/min, from 2.72 ml/min to 2.74 ml/min, from 2.74 ml/min to 2.76 ml/min, from 2.76 ml/min to 2.78 ml/min, from 2.78 ml/min to 2.80 ml/min, from 2.80 ml/min to 2.82 ml/min, from 2.82 ml/min to 2.84 ml/min, from 2.84 ml/min to 2.86 ml/min, from 2.86 ml/min to 2.88 ml/min, from 2.88 ml/min to 2.90 ml/min, from 2.90 ml/min to 2.92 ml/min, from 2.92 ml/min to 2.94 ml/min, from 2.94 ml/min to 2.96 ml/min, from 2.96 ml/min to 2.98 ml/min, from 2.98 ml/min to 3.00 ml/min, from 3.00 ml/min to 3.02 ml/min, from 3.02 ml/min to 3.04 ml/min, from 3.04 ml/min to 3.06 ml/min, from 3.06 ml/min to 3.08 ml/min, from 3.08 ml/min to 3.10 ml/min, from 3.10 ml/min to 3.12 ml/min, from 3.12 ml/min to 3.14 ml/min, from 3.14 ml/min to 3.16 ml/min, from 3.16 ml/min to 3.18 ml/min, from 3.18 ml/min to 3.20 ml/min, from 3.20 ml/min to 3.22 ml/min, from 3.22 ml/min to 3.24 ml/min, from 3.24 ml/min to 3.26 ml/min, from 3.26 ml/min to 3.28 ml/min, from 3.28 ml/min to 3.30 ml/min, from 3.30 ml/min to 3.32 ml/min, from 3.32 ml/min to 3.34 ml/min, from 3.34 ml/min to 3.36 ml/min, from 3.36 ml/min to 3.38 ml/min, from 3.38 ml/min to 3.40 ml/min, from 3.40 ml/min to 3.42 ml/min, from 3.42 ml/min to 3.44 ml/min, from 3.44 ml/min to 3.46 ml/min, from 3.46 ml/min to 3.48 ml/min, from 3.48 ml/min to 3.50 ml/min, from 3.50 ml/min to 3.52 ml/min, from 3.52 ml/min to 3.54 ml/min, from 3.54 ml/min to 3.56 ml/min, from 3.56 ml/min to 3.58 ml/min, from 3.58 ml/min to 3.60 ml/min, from 3.60 ml/min to 3.62 ml/min, from 3.62 ml/min to 3.64 ml/min, from 3.64 ml/min to 3.66 ml/min, from 3.66 ml/min to 3.68 ml/min, from 3.68 ml/min to 3.70 ml/min, from 3.70 ml/min to 3.72 ml/min, from 3.72 ml/min to 3.74 ml/min, from 3.74 ml/min to 3.76 ml/min, from 3.76 ml/min to 3.78 ml/min, from 3.78 ml/min to 3.80 ml/min, from 3.80 ml/min to 3.82 ml/min, from 3.82 ml/min to 3.84 ml/min, from 3.84 ml/min to 3.86 ml/min, from 3.86 ml/min to 3.88 ml/min, from 3.88 ml/min to 3.90 ml/min, from 3.90 ml/min to 3.92 ml/min, from 3.92 ml/min to 3.94 ml/min, from 3.94 ml/min to 3.96 ml/min, from 3.96 ml/min to 3.98 ml/min, from 3.98 ml/min to 4.00 ml/min, from 4.00 ml/min to 4.02 ml/min, from 4.02 ml/min to 4.04 ml/min, from 4.04 ml/min to 4.06 ml/min, from 4.06 ml/min to 4.08 ml/min, from 4.08 ml/min to 4.10 ml/min, from 4.10 ml/min to 4.12 ml/min, from 4.12 ml/min to 4.14 ml/min, from 4.14 ml/min to 4.16 ml/min, from 4.16 ml/min to 4.18 ml/min, from 4.18 ml/min to 4.20 ml/min, from 4.20 ml/min to 4.22 ml/min, from 4.22 ml/min to 4.24 ml/min, from 4.24 ml/min to 4.26 ml/min, from 4.26 ml/min to 4.28 ml/min, from 4.28 ml/min to 4.30 ml/min, from 4.30 ml/min to 4.32 ml/min, from 4.32 ml/min to 4.34 ml/min, from 4.34 ml/min to 4.36 ml/min, from 4.36 ml/min to 4.38 ml/min, from 4.38 ml/min to 4.40 ml/min, from 4.40 ml/min to 4.42 ml/min, from 4.42 ml/min to 4.44 ml/min, from 4.44 ml/min to 4.46 ml/min, from 4.46 ml/min to 4.48 ml/min, from 4.48 ml/min to 4.50 ml/min, from 4.50 ml/min to 4.52 ml/min, from 4.52 ml/min to 4.54 ml/min, from 4.54 ml/min to 4.56 ml/min, from 4.56 ml/min to 4.58 ml/min, from 4.58 ml/min to 4.60 ml/min, from 4.60 ml/min to 4.62 ml/min, from 4.62 ml/min to 4.64 ml/min, from 4.64 ml/min to 4.66 ml/min, from 4.66 ml/min to 4.68 ml/min, from 4.68 ml/min to 4.70 ml/min, from 4.70 ml/min to 4.72 ml/min, from 4.72 ml/min to 4.74 ml/min, from 4.74 ml/min to 4.76 ml/min, from 4.76 ml/min to 4.78 ml/min, from 4.78 ml/min to 4.80 ml/min, from 4.80 ml/min to 4.82 ml/min, from 4.82 ml/min to 4.84 ml/min, from 4.84 ml/min to 4.86 ml/min, from 4.86 ml/min to 4.88 ml/min, from 4.88 ml/min to 4.90 ml/min, from 4.90 ml/min to 4.92 ml/min, from 4.92 ml/min to 4.94 ml/min, from 4.94 ml/min to 4.96 ml/min, from 4.96 ml/min to 4.98 ml/min, from 4.98 ml/min to 5.00 ml/min, from 5.00 ml/min to 5.02 ml/min, from 5.02 ml/min to 5.04 ml/min, from 5.04 ml/min to 5.06 ml/min, from 5.06 ml/min to 5.08 ml/min, from 5.08 ml/min to 5.10 ml/min, from 5.10 ml/min to 5.12 ml/min, from 5.12 ml/min to 5.14 ml/min, from 5.14 ml/min to 5.16 ml/min, from 5.16 ml/min to 5.18 ml/min, from 5.18 ml/min to 5.20 ml/min, from 5.20 ml/min to 5.22 ml/min, from 5.22 ml/min to 5.24 ml/min, from 5.24 ml/min to 5.26 ml/min, from 5.26 ml/min to 5.28 ml/min, from 5.28 ml/min to 5.30 ml/min, from 5.30 ml/min to 5.32 ml/min, from 5.32 ml/min to 5.34 ml/min, from 5.34 ml/min to 5.36 ml/min, from 5.36 ml/min to 5.38 ml/min, from 5.38 ml/min to 5.40 ml/min, from 5.40 ml/min to 5.42 ml/min, from 5.42 ml/min to 5.44 ml/min, from 5.44 ml/min to 5.46 ml/min, from 5.46 ml/min to 5.48 ml/min, from 5.48 ml/min to 5.50 ml/min, from 5.50 ml/min to 5.52 ml/min, from 5.52 ml/min to 5.54 ml/min, from 5.54 ml/min to 5.56 ml/min, from 5.56 ml/min to 5.58 ml/min, from 5.58 ml/min to 5.60 ml/min, from 5.60 ml/min to 5.62 ml/min, from 5.62 ml/min to 5.64 ml/min, from 5.64 ml/min to 5.66 ml/min, from 5.66 ml/min to 5.68 ml/min, from 5.68 ml/min to 5.70 ml/min, from 5.70 ml/min to 5.72 ml/min, from 5.72 ml/min to 5.74 ml/min, from 5.74 ml/min to 5.76 ml/min, from 5.76 ml/min to 5.78 ml/min, from 5.78 ml/min to 5.80 ml/min, from 5.80 ml/min to 5.82 ml/min, from 5.82 ml/min to 5.84 ml/min, from 5.84 ml/min to 5.86 ml/min, from 5.86 ml/min to 5.88 ml/min, from 5.88 ml/min to 5.90 ml/min, from 5.90 ml/min to 5.92 ml/min, from 5.92 ml/min to 5.94 ml/min, from 5.94 ml/min to 5.96 ml/min, from 5.96 ml/min to 5.98 ml/min, from 5.98 ml/min to 6.00 ml/min, from 6.00 ml/min to 6.02 ml/min, from 6.02 ml/min to 6.04 ml/min, from 6.04 ml/min to 6.06 ml/min, from 6.06 ml/min to 6.08 ml/min, from 6.08 ml/min to 6.10 ml/min, from 6.10 ml/min to 6.12 ml/min, from 6.12 ml/min to 6.14 ml/min, from 6.14 ml/min to 6.16 ml/min, from 6.16 ml/min to 6.18 ml/min, from 6.18 ml/min to 6.20 ml/min, from 6.20 ml/min to 6.22 ml/min, from 6.22 ml/min to 6.24 ml/min, from 6.24 ml/min to 6.26 ml/min, from 6.26 ml/min to 6.28 ml/min, from 6.28 ml/min to 6.30 ml/min, from 6.30 ml/min to 6.32 ml/min, from 6.32 ml/min to 6.34 ml/min, from 6.34 ml/min to 6.36 ml/min, from 6.36 ml/min to 6.38 ml/min, from 6.38 ml/min to 6.40 ml/min, from 6.40 ml/min to 6.42 ml/min, from 6.42 ml/min to 6.44 ml/min, from 6.44 ml/min to 6.46 ml/min, from 6.46 ml/min to 6.48 ml/min, from 6.48 ml/min to 6.50 ml/min, from 6.50 ml/min to 6.52 ml/min, from 6.52 ml/min to 6.54 ml/min, from 6.54 ml/min to 6.56 ml/min, from 6.56 ml/min to 6.58 ml/min, from 6.58 ml/min to 6.60 ml/min, from 6.60 ml/min to 6.62 ml/min, from 6.62 ml/min to 6.64 ml/min, from 6.64 ml/min to 6.66 ml/min, from 6.66 ml/min to 6.68 ml/min, from 6.68 ml/min to 6.70 ml/min, from 6.70 ml/min to 6.72 ml/min, from 6.72 ml/min to 6.74 ml/min, from 6.74 ml/min to 6.76 ml/min, from 6.76 ml/min to 6.78 ml/min, from 6.78 ml/min to 6.80 ml/min, from 6.80 ml/min to 6.82 ml/min, from 6.82 ml/min to 6.84 ml/min, from 6.84 ml/min to 6.86 ml/min, from 6.86 ml/min to 6.88 ml/min, from 6.88 ml/min to 6.90 ml/min, from 6.90 ml/min to 6.92 ml/min, from 6.92 ml/min to 6.94 ml/min, from 6.94 ml/min to 6.96 ml/min, from 6.96 ml/min to 6.98 ml/min, from 6.98 ml/min to 7.00 ml/min, from 7.00 ml/min to 7.02 ml/min, from 7.02 ml/min to 7.04 ml/min, from 7.04 ml/min to 7.06 ml/min, from 7.06 ml/min to 7.08 ml/min, from 7.08 ml/min to 7.10 ml/min, from 7.10 ml/min to 7.12 ml/min, from 7.12 ml/min to 7.14 ml/min, from 7.14 ml/min to 7.16 ml/min, from 7.16 ml/min to 7.18 ml/min, from 7.18 ml/min to 7.20 ml/min, from 7.20 ml/min to 7.22 ml/min, from 7.22 ml/min to 7.24 ml/min, from 7.24 ml/min to 7.26 ml/min, from 7.26 ml/min to 7.28 ml/min, from 7.28 ml/min to 7.30 ml/min, from 7.30 ml/min to 7.32 ml/min, from 7.32 ml/min to 7.34 ml/min, from 7.34 ml/min to 7.36 ml/min, from 7.36 ml/min to 7.38 ml/min, from 7.38 ml/min to 7.40 ml/min, from 7.40 ml/min to 7.42 ml/min, from 7.42 ml/min to 7.44 ml/min, from 7.44 ml/min to 7.46 ml/min, from 7.46 ml/min to 7.48 ml/min, from 7.48 ml/min to 7.50 ml/min, from 7.50 ml/min to 7.52 ml/min, from 7.52 ml/min to 7.54 ml/min, from 7.54 ml/min to 7.56 ml/min, from 7.56 ml/min to 7.58 ml/min, from 7.58 ml/min to 7.60 ml/min, from 7.60 ml/min to 7.62 ml/min, from 7.62 ml/min to 7.64 ml/min, from 7.64 ml/min to 7.66 ml/min, from 7.66 ml/min to 7.68 ml/min, from 7.68 ml/min to 7.70 ml/min, from 7.70 ml/min to 7.72 ml/min, from 7.72 ml/min to 7.74 ml/min, from 7.74 ml/min to 7.76 ml/min, from 7.76 ml/min to 7.78 ml/min, from 7.78 ml/min to 7.80 ml/min, from 7.80 ml/min to 7.82 ml/min, from 7.82 ml/min to 7.84 ml/min, from 7.84 ml/min to 7.86 ml/min, from 7.86 ml/min to 7.88 ml/min, from 7.88 ml/min to 7.90 ml/min, from 7.90 ml/min to 7.92 ml/min, from 7.92 ml/min to 7.94 ml/min, from 7.94 ml/min to 7.96 ml/min, from 7.96 ml/min to 7.98 ml/min, from 7.98 ml/min to 8.00 ml/min, from 8.00 ml/min to 9.00 ml/min, from 9.00 ml/min to 10.00 ml/min, from 10.00 ml/min to 12.00 ml/min, from 12.00 ml/min to 15.00 ml/min, or any combination of these flow rate intervals.
   200. The method of any of the items 190-199, wherein the first flow rate and the second flow rate are identical.
   201. The method of any of the items 190-199, wherein the first flow rate and the second flow rate are different.
   202. The method of any of the preceding items, wherein the pharmaceutical composition to be applied by ultrasonic spray technology onto the matrices/sponges is cooled prior to application onto the matrices/sponges.
   203. The method of any of the preceding items, wherein the pharmaceutical composition to be applied by ultrasonic spray technology onto the matrices/sponges is cooled to a temperature in the range of from 0° C. to 10° C., such as to from 0° C. to 1° C., for example from 1° C. to 2° C., such as to from 2° C. to 3° C., for example from 3° C. to 4° C., such as to from 4° C. to 5° C., for example from 5° C. to 6° C., such as to from 6° C. to 7° C., for example from 7° C. to 8° C. such as to from 8° C. to 9° C., or for example from 9° C. to 10° C.
204. The method of any of the preceding items, wherein the pharmaceutical composition to be coated onto the matrices/sponges is not subjected to cooling but applied at ambient temperature in the range of from 17° C. to 25° C., for example 17° C. to 18° C., such as 18° C. to 19° C., for example 19° C. to 20° C., such as 20° C. to 21° C., for example 21° C. to 22° C., such as 22° C. to 23° C., for example 23° C. to 24° C., such as 24° C. to 25° C.
   205. The method of any of the preceding items, further comprising the step of subjecting the pharmaceutical composition to one or more degassing treatments before supplying said pharmaceutical composition to the one or more ultrasonic spray nozzles of a nozzle assembly.
   206. The method of any of the items 180-205, wherein no degassing procedure has been performed on the pharmaceutical composition before supplying it to the ultrasonic spray nozzles of a nozzle assembly.
   207. The method of any of the items 180-206, wherein the spray mist produced by the ultrasonic spray nozzles is ejected horizontally from the atomizing surface of the ultrasonic spray nozzles and subsequently reoriented approximately 90° downwards i.e. essentially perpendicular to the transport mechanism underneath the spray nozzles by focused air jets.
   208. The method of item 207, wherein said generated air jets are characterized by a “jet force”, which can be the same or different for two or more nozzles in a spray nozzle assembly.
   209. The method of any of the items 207 and 208, wherein the jet force generated by the air jets of one spray individual spray nozzle is 25 l/min.
   210. The method of any of the items 207 to 209, wherein the jet force generated by the air jets of one spray individual spray nozzle is selected from the group of intervals consisting of from 2 l/min to 4 l/min, from 4 l/min to 6 l/min, from 6 l/min to 8 l/min, from 8 l/min to 101/min, from 101/min to 12 l/min, from 12 l/min to 14 l/min, from 14 l/min to 16 l/min, from 16 l/min to 18 l/min, from 18 l/min to 201/min, from 201/min to 22 l/min, from 22 l/min to 24 l/min, from 24 l/min to 26 l/min, from 26 l/min to 28 l/min, from 28 l/min to 301/min, from 301/min to 32 l/min, from 32 l/min to 34 l/min, from 34 l/min to 36 l/min, from 36 l/min to 38 l/min, from 38 l/min to 401/min, from 401/min to 42 l/min, from 42 l/min to 44 l/min, from 44 l/min to 46 l/min, from 46 l/min to 48 l/min, from 48 l/min to 501/min, from 501/min to 55 l/min, from 55 l/min to 601/min, from 65 l/min to 701/min, from 75 l/min to 801/min, and from 801/min to 100 l/min, or any combination of these intervals.
   211. The method of any of the items 180-210, wherein the energy consumption of each ultrasonic spray nozzles in one nozzle assembly is identical.
   212. The method of any of the items 180-211, wherein the energy consumption of each ultrasonic spray nozzle in one nozzle assembly is non-identical.
   213. The method of any of the items 180-212, wherein the energy consumption (“nozzle input power”) of each ultrasonic spray nozzle in one nozzle assembly is 2.8 W or 4 W.
   214. The method of any of the items 180-213, wherein the energy consumption (“nozzle input power”) of each ultrasonic spray nozzle in one nozzle assembly is selected from the group of intervals consisting of from 0.02 W to 0.04 W, from 0.04 W to 0.06 W, from 0.06 W to 0.08 W, from 0.08 W to 0.10 W, from 0.10 W to 0.12 W, from 0.12 W to 0.14 W, from 0.14 W to 0.16 W, from 0.16 W to 0.18 W, from 0.18 W to 0.20 W, from 0.20 W to 0.22 W, from 0.22 W to 0.24 W, from 0.24 W to 0.26 W, from 0.26 W to 0.28 W, from 0.28 W to 0.30 W, from 0.30 W to 0.32 W, from 0.32 W to 0.34 W, from 0.34 W to 0.36 W, from 0.36 W to 0.38 W, from 0.38 W to 0.40 W, from 0.40 W to 0.42 W, from 0.42 W to 0.44 W, from 0.44 W to 0.46 W, from 0.46 W to 0.48 W, from 0.48 W to 0.50 W, from 0.50 W to 0.52 W, from 0.52 W to 0.54 W, from 0.54 W to 0.56 W, from 0.56 W to 0.58 W, from 0.58 W to 0.60 W, from 0.60 W to 0.62 W, from 0.62 W to 0.64 W, from 0.64 W to 0.66 W, from 0.66 W to 0.68 W, from 0.68 W to 0.70 W, from 0.70 W to 0.72 W, from 0.72 W to 0.74 W, from 0.74 W to 0.76 W, from 0.76 W to 0.78 W, from 0.78 W to 0.80 W, from 0.80 W to 0.82 W, from 0.82 W to 0.84 W, from 0.84 W to 0.86 W, from 0.86 W to 0.88 W, from 0.88 W to 0.90 W, from 0.90 W to 0.92 W, from 0.92 W to 0.94 W, from 0.94 W to 0.96 W, from 0.96 W to 0.98 W, from 0.98 W to 1.00 W, from 1.00 W to 1.02 W, from 1.02 W to 1.04 W, from 1.04 W to 1.06 W, from 1.06 W to 1.08 W, from 1.08 W to 1.10 W, from 1.10 W to 1.12 W, from 1.12 W to 1.14 W, from 1.14 W to 1.16 W, from 1.16 W to 1.18 W, from 1.18 W to 1.20 W, from 1.20 W to 1.22 W, from 1.22 W to 1.24 W, from 1.24 W to 1.26 W, from 1.26 W to 1.28 W, from 1.28 W to 1.30 W, from 1.30 W to 1.32 W, from 1.32 W to 1.34 W, from 1.34 W to 1.36 W, from 1.36 W to 1.38 W, from 1.38 W to 1.40 W, from 1.40 W to 1.42 W, from 1.42 W to 1.44 W, from 1.44 W to 1.46 W, from 1.46 W to 1.48 W, from 1.48 W to 1.50 W, from 1.50 W to 1.52 W, from 1.52 W to 1.54 W, from 1.54 W to 1.56 W, from 1.56 W to 1.58 W, from 1.58 W to 1.60 W, from 1.60 W to 1.62 W, from 1.62 W to 1.64 W, from 1.64 W to 1.66 W, from 1.66 W to 1.68 W, from 1.68 W to 1.70 W, from 1.70 W to 1.72 W, from 1.72 W to 1.74 W, from 1.74 W to 1.76 W, from 1.76 W to 1.78 W, from 1.78 W to 1.80 W, from 1.80 W to 1.82 W, from 1.82 W to 1.84 W, from 1.84 W to 1.86 W, from 1.86 W to 1.88 W, from 1.88 W to 1.90 W, from 1.90 W to 1.92 W, from 1.92 W to 1.94 W, from 1.94 W to 1.96 W, from 1.96 W to 1.98 W, from 1.98 W to 2.00 W, from 2.00 W to 2.02 W, from 2.02 W to 2.04 W, from 2.04 W to 2.06 W, from 2.06 W to 2.08 W, from 2.08 W to 2.10 W, from 2.10 W to 2.12 W, from 2.12 W to 2.14 W, from 2.14 W to 2.16 W, from 2.16 W to 2.18 W, from 2.18 W to 2.20 W, from 2.20 W to 2.22 W, from 2.22 W to 2.24 W, from 2.24 W to 2.26 W, from 2.26 W to 2.28 W, from 2.28 W to 2.30 W, from 2.30 W to 2.32 W, from 2.32 W to 2.34 W, from 2.34 W to 2.36 W, from 2.36 W to 2.38 W, from 2.38 W to 2.40 W, from 2.40 W to 2.42 W, from 2.42 W to 2.44 W, from 2.44 W to 2.46 W, from 2.46 W to 2.48 W, from 2.48 W to 2.50 W, from 2.50 W to 2.52 W, from 2.52 W to 2.54 W, from 2.54 W to 2.56 W, from 2.56 W to 2.58 W, from 2.58 W to 2.60 W, from 2.60 W to 2.62 W, from 2.62 W to 2.64 W, from 2.64 W to 2.66 W, from 2.66 W to 2.68 W, from 2.68 W to 2.70 W, from 2.70 W to 2.72 W, from 2.72 W to 2.74 W, from 2.74 W to 2.76 W, from 2.76 W to 2.78 W, from 2.78 W to 2.80 W, from 2.80 W to 2.82 W, from 2.82 W to 2.84 W, from 2.84 W to 2.86 W, from 2.86 W to 2.88 W, from 2.88 W to 2.90 W, from 2.90 W to 2.92 W, from 2.92 W to 2.94 W, from 2.94 W to 2.96 W, from 2.96 W to 2.98 W, from 2.98 W to 3.00 W, from 3.00 W to 3.02 W, from 3.02 W to 3.04 W, from 3.04 W to 3.06 W, from 3.06 W to 3.08 W, from 3.08 W to 3.10 W, from 3.10 W to 3.12 W, from 3.12 W to 3.14 W, from 3.14 W to 3.16 W, from 3.16 W to 3.18 W, from 3.18 W to 3.20 W, from 3.20 W to 3.22 W, from 3.22 W to 3.24 W, from 3.24 W to 3.26 W, from 3.26 W to 3.28 W, from 3.28 W to 3.30 W, from 3.30 W to 3.32 W, from 3.32 W to 3.34 W, from 3.34 W to 3.36 W, from 3.36 W to 3.38 W, from 3.38 W to 3.40 W, from 3.40 W to 3.42 W, from 3.42 W to 3.44 W, from 3.44 W to 3.46 W, from 3.46 W to 3.48 W, from 3.48 W to 3.50 W, from 3.50 W to 3.52 W, from 3.52 W to 3.54 W, from 3.54 W to 3.56 W, from 3.56 W to 3.58 W, from 3.58 W to 3.60 W, from 3.60 W to 3.62 W, from 3.62 W to 3.64 W, from 3.64 W to 3.66 W, from 3.66 W to 3.68 W, from 3.68 W to 3.70 W, from 3.70 W to 3.72 W, from 3.72 W to 3.74 W, from 3.74 W to 3.76 W, from 3.76 W to 3.78 W, from 3.78 W to 3.80 W, from 3.80 W to 3.82 W, from 3.82 W to 3.84 W, from 3.84 W to 3.86 W, from 3.86 W to 3.88 W, from 3.88 W to 3.90 W, from 3.90 W to 3.92 W, from 3.92 W to 3.94 W, from 3.94 W to 3.96 W, from 3.96 W to 3.98 W, from 3.98 W to 4.00 W, from 4.00 W to 4.02 W, from 4.02 W to 4.04 W, from 4.04 W to 4.06 W, from 4.06 W to 4.08 W, from 4.08 W to 4.10 W, from 4.10 W to 4.12 W, from 4.12 W to 4.14 W, from 4.14 W to 4.16 W, from 4.16 W to 4.18 W, from 4.18 W to 4.20 W, from 4.20 W to 4.22 W, from 4.22 W to 4.24 W, from 4.24 W to 4.26 W, from 4.26 W to 4.28 W, from 4.28 W to 4.30 W, from 4.30 W to 4.32 W, from 4.32 W to 4.34 W, from 4.34 W to 4.36 W, from 4.36 W to 4.38 W, from 4.38 W to 4.40 W, from 4.40 W to 4.42 W, from 4.42 W to 4.44 W, from 4.44 W to 4.46 W, from 4.46 W to 4.48 W, from 4.48 W to 4.50 W, from 4.50 W to 4.52 W, from 4.52 W to 4.54 W, from 4.54 W to 4.56 W, from 4.56 W to 4.58 W, from 4.58 W to 4.60 W, from 4.60 W to 4.62 W, from 4.62 W to 4.64 W, from 4.64 W to 4.66 W, from 4.66 W to 4.68 W, from 4.68 W to 4.70 W, from 4.70 W to 4.72 W, from 4.72 W to 4.74 W, from 4.74 W to 4.76 W, from 4.76 W to 4.78 W, from 4.78 W to 4.80 W, from 4.80 W to 4.82 W, from 4.82 W to 4.84 W, from 4.84 W to 4.86 W, from 4.86 W to 4.88 W, from 4.88 W to 4.90 W, from 4.90 W to 4.92 W, from 4.92 W to 4.94 W, from 4.94 W to 4.96 W, from 4.96 W to 4.98 W, from 4.98 W to 5.00 W, from 5.00 W to 5.02 W, from 5.02 W to 5.04 W, from 5.04 W to 5.06 W, from 5.06 W to 5.08 W, from 5.08 W to 5.10 W, from 5.10 W to 5.12 W, from 5.12 W to 5.14 W, from 5.14 W to 5.16 W, from 5.16 W to 5.18 W, from 5.18 W to 5.20 W, from 5.20 W to 5.22 W, from 5.22 W to 5.24 W, from 5.24 W to 5.26 W, from 5.26 W to 5.28 W, from 5.28 W to 5.30 W, from 5.30 W to 5.32 W, from 5.32 W to 5.34 W, from 5.34 W to 5.36 W, from 5.36 W to 5.38 W, from 5.38 W to 5.40 W, from 5.40 W to 5.42 W, from 5.42 W to 5.44 W, from 5.44 W to 5.46 W, from 5.46 W to 5.48 W, from 5.48 W to 5.50 W, from 5.50 W to 5.52 W, from 5.52 W to 5.54 W, from 5.54 W to 5.56 W, from 5.56 W to 5.58 W, from 5.58 W to 5.60 W, from 5.60 W to 5.62 W, from 5.62 W to 5.64 W, from 5.64 W to 5.66 W, from 5.66 W to 5.68 W, from 5.68 W to 5.70 W, from 5.70 W to 5.72 W, from 5.72 W to 5.74 W, from 5.74 W to 5.76 W, from 5.76 W to 5.78 W, from 5.78 W to 5.80 W, from 5.80 W to 5.82 W, from 5.82 W to 5.84 W, from 5.84 W to 5.86 W, from 5.86 W to 5.88 W, from 5.88 W to 5.90 W, from 5.90 W to 5.92 W, from 5.92 W to 5.94 W, from 5.94 W to 5.96 W, from 5.96 W to 5.98 W, from 5.98 W to 6.00 W, from 6.00 W to 6.02 W, from 6.02 W to 6.04 W, from 6.04 W to 6.06 W, from 6.06 W to 6.08 W, from 6.08 W to 6.10 W, from 6.10 W to 6.12 W, from 6.12 W to 6.14 W, from 6.14 W to 6.16 W, from 6.16 W to 6.18 W, from 6.18 W to 6.20 W, from 6.20 W to 6.22 W, from 6.22 W to 6.24 W, from 6.24 W to 6.26 W, from 6.26 W to 6.28 W, from 6.28 W to 6.30 W, from 6.30 W to 6.32 W, from 6.32 W to 6.34 W, from 6.34 W to 6.36 W, from 6.36 W to 6.38 W, from 6.38 W to 6.40 W, from 6.40 W to 6.42 W, from 6.42 W to 6.44 W, from 6.44 W to 6.46 W, from 6.46 W to 6.48 W, from 6.48 W to 6.50 W, from 6.50 W to 6.52 W, from 6.52 W to 6.54 W, from 6.54 W to 6.56 W, from 6.56 W to 6.58 W, from 6.58 W to 6.60 W, from 6.60 W to 6.62 W, from 6.62 W to 6.64 W, from 6.64 W to 6.66 W, from 6.66 W to 6.68 W, from 6.68 W to 6.70 W, from 6.70 W to 6.72 W, from 6.72 W to 6.74 W, from 6.74 W to 6.76 W, from 6.76 W to 6.78 W, from 6.78 W to 6.80 W, from 6.80 W to 6.82 W, from 6.82 W to 6.84 W, from 6.84 W to 6.86 W, from 6.86 W to 6.88 W, from 6.88 W to 6.90 W, from 6.90 W to 6.92 W, from 6.92 W to 6.94 W, from 6.94 W to 6.96 W, from 6.96 W to 6.98 W, from 6.98 W to 7.00 W, from 7.00 W to 7.02 W, from 7.02 W to 7.04 W, from 7.04 W to 7.06 W, from 7.06 W to 7.08 W, from 7.08 W to 7.10 W, from 7.10 W to 7.12 W, from 7.12 W to 7.14 W, from 7.14 W to 7.16 W, from 7.16 W to 7.18 W, from 7.18 W to 7.20 W, from 7.20 W to 7.22 W, from 7.22 W to 7.24 W, from 7.24 W to 7.26 W, from 7.26 W to 7.28 W, from 7.28 W to 7.30 W, from 7.30 W to 7.32 W, from 7.32 W to 7.34 W, from 7.34 W to 7.36 W, from 7.36 W to 7.38 W, from 7.38 W to 7.40 W, from 7.40 W to 7.42 W, from 7.42 W to 7.44 W, from 7.44 W to 7.46 W, from 7.46 W to 7.48 W, from 7.48 W to 7.50 W, from 7.50 W to 7.52 W, from 7.52 W to 7.54 W, from 7.54 W to 7.56 W, from 7.56 W to 7.58 W, from 7.58 W to 7.60 W, from 7.60 W to 7.62 W, from 7.62 W to 7.64 W, from 7.64 W to 7.66 W, from 7.66 W to 7.68 W, from 7.68 W to 7.70 W, from 7.70 W to 7.72 W, from 7.72 W to 7.74 W, from 7.74 W to 7.76 W, from 7.76 W to 7.78 W, from 7.78 W to 7.80 W, from 7.80 W to 7.82 W, from 7.82 W to 7.84 W, from 7.84 W to 7.86 W, from 7.86 W to 7.88 W, from 7.88 W to 7.90 W, from 7.90 W to 7.92 W, from 7.92 W to 7.94 W, from 7.94 W to 7.96 W, from 7.96 W to 7.98 W, from 7.98 W to 8.00 W, from 8.00 W to 9.00 W, from 9.00 W to 10.00 W, from 10.00 W to 12.00 W, from 12.00 W to 15.00 W, or any combination of these nozzle power intervals.
   215. The method of any of the preceding items, wherein said ultrasonic technology employs an atomizing surface of each the ultrasonic spray nozzles of a spray nozzle assembly of the present invention which vibrates with a frequency of 60 kHz during operation i.e. active spray coating.
   216. The method of item 215, wherein the atomizing surface of each the ultrasonic spray nozzle of a spray nozzle assembly of the present invention vibrates with a frequency in the range of from 20 kHz to 120 kHz, such as from 20 kHz to 22 kHz, for example from 22 kHz to 24 kHz, such as from 24 kHz to 26 kHz, for example from 26 kHz to 28 kHz, such as from 28 kHz to 30 kHz, for example from 30 kHz to 32 kHz, such as from 32 kHz to 34 kHz, for example from 34 kHz to 36 kHz, such as from 36 kHz to 38 kHz, for example from 38 kHz to 40 kHz, such as from 40 kHz to 42 kHz, for example from 42 kHz to 44 kHz, such as from 44 kHz to 46 kHz, for example from 46 kHz to 48 kHz, such as from 48 kHz to 50 kHz, for example from 50 kHz to 52 kHz, such as from 52 kHz to 54 kHz, for example from 54 kHz to 56 kHz, such as from 56 kHz to 58 kHz, for example from 58 kHz to 60 kHz, such as from 60 kHz to 62 kHz, for example from 62 kHz to 64 kHz, such as from 64 kHz to 66 kHz, for example from 66 kHz to 68 kHz, such as from 68 kHz to 70 kHz, for example from 70 kHz to 72 kHz, such as from 72 kHz to 74 kHz, for example from 74 kHz to 76 kHz, such as from 76 kHz to 78 kHz, for example from 78 kHz to 80 kHz, such as from 80 kHz to 82 kHz, for example from 82 kHz to 84 kHz, such as from 84 kHz to 86 kHz, for example from 86 kHz to 88 kHz, such as from 88 kHz to 90 kHz, for example from 90 kHz to 92 kHz, such as from 92 kHz to 94 kHz, for example from 94 kHz to 96 kHz, such as from 96 kHz to 98 kHz, for example from 98 kHz to 100 kHz, such as from 100 kHz to 102 kHz, for example from 102 kHz to 104 kHz, such as from 104 kHz to 106 kHz, for example from 106 kHz to 108 kHz, such as from 108 kHz to 110 kHz, for example from 110 kHz to 112 kHz, such as from 112 kHz to 114 kHz, for example from 114 kHz to 116 kHz, such as from 116 kHz to 118 kHz, for example from 118 kHz to 120 kHz, or any combination of these intervals.
   217. The method of any of the items 180-216, wherein each of the one or more ultrasonic spray nozzles in a nozzle assembly such as ultrasonic spray nozzles 1 and 2 produces a fan-like spray beam.
   218. The method of any of the items 180-217, wherein the one or more spray nozzles in one spray nozzle assembly generate overlapping spray beams which together produce a spray mist.
   219. The method of any of the items 180-218, wherein the width of the spray mist generated during operation of the ultrasonic spray nozzles 1 and 2 in one nozzle assembly of the invention is 30 cm as measured at the level of the transport mechanism.
   220. The method of any of the items 180-219, wherein the width—as measured at the level of the transport mechanism—of the spray mist generated during operation of the ultrasonic spray nozzles 1 and 2 in one nozzle assembly can be selected from the group of intervals consisting of from 1.0 cm to 1.2 cm, from 1.2 cm to 1.4 cm, from 1.4 cm to 1.6 cm, from 1.6 cm to 1.8 cm, from 1.8 cm to 2.0 cm, 2.0 cm to 2.2 cm, from 2.2 cm to 2.4 cm, from 2.4 cm to 2.6 cm, from 2.6 cm to 2.8 cm, from 2.8 cm to 3.0 cm, 3.0 cm to 3.2 cm, from 3.2 cm to 3.4 cm, from 3.4 cm to 3.6 cm, from 3.6 cm to 3.8 cm, from 3.8 cm to 4.0 cm, 4.0 cm to 4.2 cm, from 4.2 cm to 4.4 cm, from 4.4 cm to 4.6 cm, from 4.6 cm to 4.8 cm, from 4.8 cm to 5.0 cm, 5.0 cm to 5.2 cm, from 5.2 cm to 5.4 cm, from 5.4 cm to 5.6 cm, from 5.6 cm to 5.8 cm, from 5.8 cm to 6.0 cm, 6.0 cm to 6.2 cm, from 6.2 cm to 6.4 cm, from 6.4 cm to 6.6 cm, from 6.6 cm to 6.8 cm, from 6.8 cm to 7.0 cm, 7.0 cm to 7.2 cm, from 7.2 cm to 7.4 cm, from 7.4 cm to 7.6 cm, from 7.6 cm to 7.8 cm, from 7.8 cm to 8.0 cm, 8.0 cm to 8.2 cm, from 8.2 cm to 8.4 cm, from 8.4 cm to 8.6 cm, from 8.6 cm to 8.8 cm, from 8.8 cm to 9.0 cm, 9.0 cm to 9.2 cm, from 9.2 cm to 9.4 cm, from 9.4 cm to 9.6 cm, from 9.6 cm to 9.8 cm, from 9.8 cm to 10.0 cm, 10.0 cm to 10.2 cm, from 10.2 cm to 10.4 cm, from 10.4 cm to 10.6 cm, from 10.6 cm to 10.8 cm, from 10.8 cm to 11.0 cm, 11.0 cm to 11.2 cm, from 11.2 cm to 11.4 cm, from 11.4 cm to 11.6 cm, from 11.6 cm to 11.8 cm, from 11.8 cm to 12.0 cm, 12.0 cm to 12.2 cm, from 12.2 cm to 12.4 cm, from 12.4 cm to 12.6 cm, from 12.6 cm to 12.8 cm, from 12.8 cm to 13.0 cm, 13.0 cm to 13.2 cm, from 13.2 cm to 13.4 cm, from 13.4 cm to 13.6 cm, from 13.6 cm to 13.8 cm, from 13.8 cm to 14.0 cm, 14.0 cm to 14.2 cm, from 14.2 cm to 14.4 cm, from 14.4 cm to 14.6 cm, from 14.6 cm to 14.8 cm, from 14.8 cm to 15.0 cm, 15.0 cm to 15.2 cm, from 15.2 cm to 15.4 cm, from 15.4 cm to 15.6 cm, from 15.6 cm to 15.8 cm, from 15.8 cm to 16.0 cm, 16.0 cm to 16.2 cm, from 16.2 cm to 16.4 cm, from 16.4 cm to 16.6 cm, from 16.6 cm to 16.8 cm, from 16.8 cm to 17.0 cm, 17.0 cm to 17.2 cm, from 17.2 cm to 17.4 cm, from 17.4 cm to 17.6 cm, from 17.6 cm to 17.8 cm, from 17.8 cm to 18.0 cm, 18.0 cm to 18.2 cm, from 18.2 cm to 18.4 cm, from 18.4 cm to 18.6 cm, from 18.6 cm to 18.8 cm, from 18.8 cm to 19.0 cm, 19.0 cm to 19.2 cm, from 19.2 cm to 19.4 cm, from 19.4 cm to 19.6 cm, from 19.6 cm to 19.8 cm, from 19.8 cm to 20.0 cm, from 20.0 cm to 20.2 cm, from 20.2 cm to 20.4 cm, from 20.4 cm to 20.6 cm, from 20.6 cm to 20.8 cm, from 20.8 cm to 21.0 cm, from 21.0 cm to 21.2 cm, from 21.2 cm to 21.4 cm, from 21.4 cm to 21.6 cm, from 21.6 cm to 21.8 cm, from 21.8 cm to 22.0 cm, from 22.0 cm to 22.2 cm, from 22.2 cm to 22.4 cm, from 22.4 cm to 22.6 cm, from 22.6 cm to 22.8 cm, from 22.8 cm to 23.0 cm, from 23.0 cm to 23.2 cm, from 23.2 cm to 23.4 cm, from 23.4 cm to 23.6 cm, from 23.6 cm to 23.8 cm, from 23.8 cm to 24.0 cm, from 24.0 cm to 24.2 cm, from 24.2 cm to 24.4 cm, from 24.4 cm to 24.6 cm, from 24.6 cm to 24.8 cm, from 24.8 cm to 25.0 cm, from 25.0 cm to 25.2 cm, from 25.2 cm to 25.4 cm, from 25.4 cm to 25.6 cm, from 25.6 cm to 25.8 cm, from 25.8 cm to 26.0 cm, from 26.0 cm to 26.2 cm, from 26.2 cm to 26.4 cm, from 26.4 cm to 26.6 cm, from 26.6 cm to 26.8 cm, from 26.8 cm to 27.0 cm, from 27.0 cm to 27.2 cm, from 27.2 cm to 27.4 cm, from 27.4 cm to 27.6 cm, from 27.6 cm to 27.8 cm, from 27.8 cm to 28.0 cm, from 28.0 cm to 28.2 cm, from 28.2 cm to 28.4 cm, from 28.4 cm to 28.6 cm, from 28.6 cm to 28.8 cm, from 28.8 cm to 29.0 cm, from 29.0 cm to 29.2 cm, from 29.2 cm to 29.4 cm, from 29.4 cm to 29.6 cm, from 29.6 cm to 29.8 cm, from 29.8 cm to 30.0 cm, from 30.0 cm to 30.2 cm, from 30.2 cm to 30.4 cm, from 30.4 cm to 30.6 cm, from 30.6 cm to 30.8 cm, from 30.8 cm to 31.0 cm, from 31.0 cm to 31.2 cm, from 31.2 cm to 31.4 cm, from 31.4 cm to 31.6 cm, from 31.6 cm to 31.8 cm, from 31.8 cm to 32.0 cm, from 32.0 cm to 32.2 cm, from 32.2 cm to 32.4 cm, from 32.4 cm to 32.6 cm, from 32.6 cm to 32.8 cm, from 32.8 cm to 33.0 cm, from 33.0 cm to 33.2 cm, from 33.2 cm to 33.4 cm, from 33.4 cm to 33.6 cm, from 33.6 cm to 33.8 cm, from 33.8 cm to 34.0 cm, from 34.0 cm to 34.2 cm, from 34.2 cm to 34.4 cm, from 34.4 cm to 34.6 cm, from 34.6 cm to 34.8 cm, from 34.8 cm to 35.0 cm, from 35.0 cm to 35.2 cm, from 35.2 cm to 35.4 cm, from 35.4 cm to 35.6 cm, from 35.6 cm to 35.8 cm, from 35.8 cm to 36.0 cm, from 36.0 cm to 36.2 cm, from 36.2 cm to 36.4 cm, from 36.4 cm to 36.6 cm, from 36.6 cm to 36.8 cm, from 36.8 cm to 37.0 cm, from 37.0 cm to 37.2 cm, from 37.2 cm to 37.4 cm, from 37.4 cm to 37.6 cm, from 37.6 cm to 37.8 cm, from 37.8 cm to 38.0 cm, from 38.0 cm to 38.2 cm, from 38.2 cm to 38.4 cm, from 38.4 cm to 38.6 cm, from 38.6 cm to 38.8 cm, from 38.8 cm to 39.0 cm, from 39.0 cm to 39.2 cm, from 39.2 cm to 39.4 cm, from 39.4 cm to 39.6 cm, from 39.6 cm to 39.8 cm, from 39.8 cm to 40.0 cm, from 40 cm to 45 cm, and from 45 cm to 50 cm, or any combination thereof.
   221. The method of any of the items 180-220, wherein the mean drop diameter characterizing the spray mist produced by the ultrasonic spray nozzles in a spray nozzle assembly lies in the range of from 1 μm to 200 μm, such as from 1 μm to 2 μm, for example from 2 μm to 4 μm, such as from 4 μm to 6 μm, for example from 6 μm to 8 μm, such as from 8 μm to 10 μm, for example from 10 μm to 12 μm, such as from 12 μm to 14 μm, for example from 14 μm to 16 μm, such as from 16 μm to 18 μm, for example from 18 μm to 20 μm, such as from 20 μm to 22 μm, for example from 22 μm to 24 μm, such as from 24 μm to 26 μm, for example from 26 μm to 28 μm, such as from 28 μm to 30 μm, for example from 30 μm to 32 μm, such as from 32 μm to 34 μm, for example from 34 μm to 36 μm, such as from 36 μm to 38 μm, for example from 38 μm to 40 μm, such as from 40 μm to 42 μm, for example from 42 μm to 44 μm, such as from 44 μm to 46 μm, for example from 46 μm to 48 μm, such as from 48 μm to 50 μm, for example from 50 μm to 52 μm, such as from 52 μm to 54 μm, for example from 54 μm to 56 μm, such as from 56 μm to 58 μm, for example from 58 μm to 60 μm, such as from 60 μm to 62 μm, for example from 62 μm to 64 μm, such as from 64 μm to 66 μm, for example from 66 μm to 68 μm, such as from 68 μm to 70 μm, for example from 70 μm to 72 μm, such as from 72 μm to 74 μm, for example from 74 μm to 76 μm, such as from 76 μm to 78 μm, for example from 78 μm to 80 μm, such as from 80 μm to 82 μm, for example from 82 μm to 84 μm, such as from 84 μm to 86 μm, for example from 86 μm to 88 μm, such as from 88 μm to 90 μm, for example from 90 μm to 92 μm, such as from 92 μm to 94 μm, for example from 94 μm to 96 μm, such as from 96 μm to 98 μm, for example from 98 μm to 100 μm, such as from 100 μm to 102 μm, for example from 102 μm to 104 μm, such as from 104 μm to 106 μm, for example from 106 μm to 108 μm, such as from 108 μm to 110 μm, for example from 110 μm to 112 μm, such as from 112 μm to 114 μm, for example from 114 μm to 116 μm, such as from 116 μm to 118 μm, for example from 118 μm to 120 μm, such as from 120 μm to 122 μm, for example from 122 μm to 124 μm, such as from 124 μm to 126 μm, for example from 126 μm to 128 μm, such as from 128 μm to 130 μm, for example from 130 μm to 132 μm, such as from 132 μm to 134 μm, for example from 134 μm to 136 μm, such as from 136 μm to 138 μm, for example from 138 μm to 140 μm, such as from 140 μm to 142 μm, for example from 142 μm to 144 μm, such as from 144 μm to 146 μm, for example from 146 μm to 148 μm, such as from 148 μm to 150 μm, for example from 150 μm to 152 μm, such as from 152 μm to 154 μm, for example from 154 μm to 156 μm, such as from 156 μm to 158 μm, for example from 158 μm to 160 μm, such as from 160 μm to 162 μm, for example from 162 μm to 164 μm, such as from 164 μm to 166 μm, for example from 166 μm to 168 μm, such as from 168 μm to 170 μm, for example from 170 μm to 172 μm, such as from 172 μm to 174 μm, for example from 174 μm to 176 μm, such as from 176 μm to 178 μm, for example from 178 μm to 180 μm, such as from 180 μm to 182 μm, for example from 182 μm to 184 μm, such as from 184 μm to 186 μm, for example from 186 μm to 188 μm, such as from 188 μm to 190 μm, for example from 190 μm to 192 μm, such as from 192 μm to 194 μm, for example from 194 μm to 196 μm, such as from 196 μm to 198 μm, for example from 198 μm to 200 μm, or any combination of these intervals.
   222. The method of item 221, wherein the mean drop diameter of the ultrasonic spray nozzles such as ultrasonic spray nozzles 1 and 2 of the same spray nozzle assembly is identical.
   223. The method of any of the items 180-222, wherein the mean drop diameter of the ultrasonic spray nozzles such as ultrasonic spray nozzles 1 and 2 of the same spray nozzle assembly differs.
   224. The method of any of the preceding items, wherein the ultrasonic spray technology employs one or more spray nozzle assemblies located above the transport mechanism on which the matrices/sponges travels.
   225. The method of item 224, wherein the distance from the transport mechanism to the nozzle centre is preferably 4.5 cm, 8.2 cm or 13.0 cm
   226. The method of item 225, wherein the distance from the transport mechanism to the nozzle centre can be selected from the group of intervals consisting of from 2.0 cm to 2.2 cm, from 2.2 cm to 2.4 cm, from 2.4 cm to 2.6 cm, from 2.6 cm to 2.8 cm, from 2.8 cm to 3.0 cm, from 3.0 cm to 3.2 cm, from 3.2 cm to 3.4 cm, from 3.4 cm to 3.6 cm, from 3.6 cm to 3.8 cm, from 3.8 cm to 4.0 cm, from 4.0 cm to 4.2 cm, from 4.2 cm to 4.4 cm, from 4.4 cm to 4.6 cm, from 4.6 cm to 4.8 cm, from 4.8 cm to 5.0 cm, from 5.0 cm to 5.2 cm, from 5.2 cm to 5.4 cm, from 5.4 cm to 5.6 cm, from 5.6 cm to 5.8 cm, from 5.8 cm to 6.0 cm, from 6.0 cm to 6.2 cm, from 6.2 cm to 6.4 cm, from 6.4 cm to 6.6 cm, from 6.6 cm to 6.8 cm, from 6.8 cm to 7.0 cm, from 7.0 cm to 7.2 cm, from 7.2 cm to 7.4 cm, from 7.4 cm to 7.6 cm, from 7.6 cm to 7.8 cm, from 7.8 cm to 8.0 cm, from 8.0 cm to 8.2 cm, from 8.2 cm to 8.4 cm, from 8.4 cm to 8.6 cm, from 8.6 cm to 8.8 cm, from 8.8 cm to 9.0 cm, from 9.0 cm to 9.2 cm, from 9.2 cm to 9.4 cm, from 9.4 cm to 9.6 cm, from 9.6 cm to 9.8 cm, from 9.8 cm to 10.0 cm, from 10.0 cm to 10.2 cm, from 10.2 cm to 10.4 cm, from 10.4 cm to 10.6 cm, from 10.6 cm to 10.8 cm, from 10.8 cm to 11.0 cm, from 11.0 cm to 11.2 cm, from 11.2 cm to 11.4 cm, from 11.4 cm to 11.6 cm, from 11.6 cm to 11.8 cm, from 11.8 cm to 12.0 cm, from 12.0 cm to 12.2 cm, from 12.2 cm to 12.4 cm, from 12.4 cm to 12.6 cm, from 12.6 cm to 12.8 cm, from 12.8 cm to 13.0 cm, from 13.0 cm to 13.2 cm, from 13.2 cm to 13.4 cm, from 13.4 cm to 13.6 cm, from 13.6 cm to 13.8 cm, from 13.8 cm to 14.0 cm, from 14.0 cm to 14.2 cm, from 14.2 cm to 14.4 cm, from 14.4 cm to 14.6 cm, from 14.6 cm to 14.8 cm, from 14.8 cm to 15.0 cm, from 15.0 cm to 15.2 cm, from 15.2 cm to 15.4 cm, from 15.4 cm to 15.6 cm, from 15.6 cm to 15.8 cm, from 15.8 cm to 16.0 cm, from 16.0 cm to 16.2 cm, from 16.2 cm to 16.4 cm, from 16.4 cm to 16.6 cm, from 16.6 cm to 16.8 cm, from 16.8 cm to 17.0 cm, from 17.0 cm to 17.2 cm, from 17.2 cm to 17.4 cm, from 17.4 cm to 17.6 cm, from 17.6 cm to 17.8 cm, from 17.8 cm to 18.0 cm, from 18.0 cm to 18.2 cm, from 18.2 cm to 18.4 cm, from 18.4 cm to 18.6 cm, from 18.6 cm to 18.8 cm, from 18.8 cm to 19.0 cm, from 19.0 cm to 19.2 cm, from 19.2 cm to 19.4 cm, from 19.4 cm to 19.6 cm, from 19.6 cm to 19.8 cm, from 19.8 cm to 20.0 cm, from 20.0 cm to 20.2 cm, from 20.2 cm to 20.4 cm, from 20.4 cm to 20.6 cm, from 20.6 cm to 20.8 cm, from 20.8 cm to 21.0 cm, from 21.0 cm to 21.2 cm, from 21.2 cm to 21.4 cm, from 21.4 cm to 21.6 cm, from 21.6 cm to 21.8 cm, from 21.8 cm to 22.0 cm, from 22.0 cm to 22.2 cm, from 22.2 cm to 22.4 cm, from 22.4 cm to 22.6 cm, from 22.6 cm to 22.8 cm, from 22.8 cm to 23.0 cm, from 23.0 cm to 23.2 cm, from 23.2 cm to 23.4 cm, from 23.4 cm to 23.6 cm, from 23.6 cm to 23.8 cm, from 23.8 cm to 24.0 cm, from 24.0 cm to 24.2 cm, from 24.2 cm to 24.4 cm, from 24.4 cm to 24.6 cm, from 24.6 cm to 24.8 cm, from 24.8 cm to 25.0 cm, from 25.0 cm to 25.2 cm, from 25.2 cm to 25.4 cm, from 25.4 cm to 25.6 cm, from 25.6 cm to 25.8 cm, from 25.8 cm to 26.0 cm, from 26.0 cm to 26.2 cm, from 26.2 cm to 26.4 cm, from 26.4 cm to 26.6 cm, from 26.6 cm to 26.8 cm, from 26.8 cm to 27.0 cm, from 27.0 cm to 27.2 cm, from 27.2 cm to 27.4 cm, from 27.4 cm to 27.6 cm, from 27.6 cm to 27.8 cm, from 27.8 cm to 28.0 cm, from 28.0 cm to 28.2 cm, from 28.2 cm to 28.4 cm, from 28.4 cm to 28.6 cm, from 28.6 cm to 28.8 cm, from 28.8 cm to 29.0 cm, from 29.0 cm to 29.2 cm, from 29.2 cm to 29.4 cm, from 29.4 cm to 29.6 cm, from 29.6 cm to 29.8 cm, from 29.8 cm to 30.0 cm, from 30.0 cm to 30.2 cm, from 30.2 cm to 30.4 cm, from 30.4 cm to 30.6 cm, from 30.6 cm to 30.8 cm, from 30.8 cm to 31.0 cm, from 31.0 cm to 31.2 cm, from 31.2 cm to 31.4 cm, from 31.4 cm to 31.6 cm, from 31.6 cm to 31.8 cm, from 31.8 cm to 32.0 cm, from 32.0 cm to 32.2 cm, from 32.2 cm to 32.4 cm, from 32.4 cm to 32.6 cm, from 32.6 cm to 32.8 cm, from 32.8 cm to 33.0 cm, from 33.0 cm to 33.2 cm, from 33.2 cm to 33.4 cm, from 33.4 cm to 33.6 cm, from 33.6 cm to 33.8 cm, from 33.8 cm to 34.0 cm, from 34.0 cm to 34.2 cm, from 34.2 cm to 34.4 cm, from 34.4 cm to 34.6 cm, from 34.6 cm to 34.8 cm, from 34.8 cm to 35.0 cm, from 35.0 cm to 35.2 cm, from 35.2 cm to 35.4 cm, from 35.4 cm to 35.6 cm, from 35.6 cm to 35.8 cm, from 35.8 cm to 36.0 cm, from 36.0 cm to 36.2 cm, from 36.2 cm to 36.4 cm, from 36.4 cm to 36.6 cm, from 36.6 cm to 36.8 cm, from 36.8 cm to 37.0 cm, from 37.0 cm to 37.2 cm, from 37.2 cm to 37.4 cm, from 37.4 cm to 37.6 cm, from 37.6 cm to 37.8 cm, from 37.8 cm to 38.0 cm, from 38.0 cm to 38.2 cm, from 38.2 cm to 38.4 cm, from 38.4 cm to 38.6 cm, from 38.6 cm to 38.8 cm, from 38.8 cm to 39.0 cm, from 39.0 cm to 39.2 cm, from 39.2 cm to 39.4 cm, from 39.4 cm to 39.6 cm, from 39.6 cm to 39.8 cm, from 39.8 cm to 40.0 cm, from 40 cm to 45 cm, and from 45 cm to 50 cm, or any combination thereof.
   227. The method of any of the preceding items, wherein the distance between the surface of the matrix material and the ultrasonic spray nozzle(s) is in the range of 10.0 to 100.0 mm; for example 10.0-11.00 mm, such as 11.0-12.0 mm, for example 12.0-13.0 mm, such as 13.0-14.0 mm, for example 14.0-15.0 mm, such as 15.0-16.0 mm, for example 16.0-17.0 mm, such as 17.0-18.0 mm, for example 18.0-19.0 mm, such as 19.0-20.0 mm, for example 20.0-21.00 mm, such as 21.0-22.0 mm, for example 22.0-23.0 mm, such as 23.0-24.0 mm, for example 24.0-25.0 mm, such as 25.0-26.0 mm, for example 26.0-27.0 mm, such as 27.0-28.0 mm, for example 28.0-29.0 mm, such as 29.0-30.0 mm, for example 30.0-31.00 mm, such as 31.0-32.0 mm, for example 32.0-33.0 mm, such as 33.0-34.0 mm, for example 34.0-35.0 mm, such as 35.0-36.0 mm, for example 36.0-37.0 mm, such as 37.0-38.0 mm, for example 38.0-39.0 mm, such as 39.0-40.0 mm, for example 40.0-41.00 mm, such as 41.0-42.0 mm, for example 42.0-43.0 mm, such as 43.0-44.0 mm, for example 44.0-45.0 mm, such as 45.0-46.0 mm, for example 46.0-47.0 mm, such as 47.0-48.0 mm, for example 48.0-49.0 mm, such as 49.0-50.0 mm, for example 50.0-51.00 mm, such as 51.0-52.0 mm, for example 52.0-53.0 mm, such as 53.0-54.0 mm, for example 54.0-55.0 mm, such as 55.0-56.0 mm, for example 56.0-57.0 mm, such as 57.0-58.0 mm, for example 58.0-59.0 mm, such as 59.0-60.0 mm, for example 60.0-61.00 mm, such as 61.0-62.0 mm, for example 62.0-63.0 mm, such as 63.0-64.0 mm, for example 64.0-65.0 mm, such as 65.0-66.0 mm, for example 66.0-67.0 mm, such as 67.0-68.0 mm, for example 68.0-69.0 mm, such as 69.0-70.0 mm, for example 70.0-71.00 mm, such as 71.0-72.0 mm, for example 72.0-73.0 mm, such as 73.0-74.0 mm, for example 74.0-75.0 mm, such as 75.0-76.0 mm, for example 76.0-77.0 mm, such as 77.0-78.0 mm, for example 78.0-79.0 mm, such as 79.0-80.0 mm, for example 80.0-81.00 mm, such as 81.0-82.0 mm, for example 82.0-83.0 mm, such as 83.0-84.0 mm, for example 84.0-85.0 mm, such as 85.0-86.0 mm, for example 86.0-87.0 mm, such as 87.0-88.0 mm, for example 88.0-89.0 mm, such as 89.0-90.0 mm, for example 90.0-91.00 mm, such as 91.0-92.0 mm, for example 92.0-93.0 mm, such as 93.0-94.0 mm, for example 94.0-95.0 mm, such as 95.0-96.0 mm, for example 96.0-97.0 mm, such as 97.0-98.0 mm, for example 98.0-99.0 mm, such as 99.0-100.0 mm.
   228. The method of any of the preceding items, wherein the coating of the matrices/sponges is performed at ambient temperature in the range of from 11° C. to 25° C., for example from 10° C. to 11° C., such as from 11° C. to 12° C., for example from 12° C. to 13° C., such as from 13° C. to 14° C., for example from 13° C. to 14° C., such as from 14° C. to 15° C., for example from 15° C. to 16° C., such as from 16° C. to 17° C., for example from 17° C. to 18° C., such as from 18° C. to 19° C., for example from 19° C. to 20° C., such as from 20° C. to 21° C., for example from 21° C. to 22° C., such as from 22° C. to 23° C., for example from 23° C. to 24° C., such as from 24° C. to 25° C.
   229. The method of any of the preceding items, wherein at least 90% of the input bioactive agent is found on the matrix/sponge after ultrasonic spraying and drying of said matrix/sponge such as at least 91%, at least 92%, at least 93%, at least 94%, at least 95%, at least 96%, at least 97%, at least 98%, or at least 99%.
   230. The method of any of the preceding items, wherein at least 90% of the input thrombin is found on the matrix/sponge after ultrasonic spraying and drying of said matrix/sponge such as at least 91%, at least 92%, at least 93%, at least 94%, at least 95%, at least 96%, at least 97%, at least 98%, or at least 99%.
   231. The method of any of the preceding items, further comprising subjecting the coated matrices/sponges to a drying process at ambient temperature following coating.
   232. The method of any of the preceding items, further comprising subjecting the coated matrices/sponges to a drying process above ambient temperature following coating.
   233. The method of item 232, wherein said drying process at temperatures above ambient following coating is performed in a vacuum oven.
   234. The method of item 232, wherein said drying process at temperatures above ambient following coating is performed in at 45° C.
   235. The method of any of the preceding items, further comprising subjecting the coated matrices/sponges to a drying process following coating, wherein said drying process is performed at temperatures selected from the group of temperature intervals consisting of from 15° C. to 20° C., from 20° C. to 25° C., from 25° C. to 30° C., from 30° C. to 35° C., from 35° C. to 40° C., from 40° C. to 42° C., from 42° C. to 44° C., from 44° C. to 46° C., from 46° C. to 48° C., from 48° C. to 50° C., from 50° C. to 55° C., from 55° C. to 60° C., or any combination thereof.
   236. The method of any of the items 170-235, wherein two or more separate transport mechanisms the transport coated matrices/sponges to the oven for drying.
   237. The method of any of the items 170-236, wherein the drying time, i.e. the time in which the sponge is subjected to a drying process, is identical for sponges on the one or more transport mechanisms.
   238. The method of any of the items 170-237, wherein the drying time, i.e. the time in which the sponge is subjected to a drying process, is non-identical for sponges on the one or more transport mechanisms.
   239. The method of any of the items 170-238, wherein the drying time for the matrices/sponges on transport mechanism 1 of the one or more than one transport mechanisms is 5.5 minutes, 6 minutes, 7.5 minutes, 8 minutes or 10.5 minutes.
   240. The method of any of the items 170-239, wherein the drying time for the matrices/sponges on transport mechanism 1 of the one or more than one transport mechanisms, can be selected from the group of time intervals consisting of from 2.0 min to 2.2 min, from 2.2 min to 2.4 min, from 2.4 min to 2.6 min, from 2.6 min to 2.8 min, from 2.8 min to 3.0 min, from 3.0 min to 3.2 min, from 3.2 min to 3.4 min, from 3.4 min to 3.6 min, from 3.6 min to 3.8 min, from 3.8 min to 4.0 min, from 4.0 min to 4.2 min, from 4.2 min to 4.4 min, from 4.4 min to 4.6 min, from 4.6 min to 4.8 min, from 4.8 min to 5.0 min, from 5.0 min to 5.2 min, from 5.2 min to 5.4 min, from 5.4 min to 5.6 min, from 5.6 min to 5.8 min, from 5.8 min to 6.0 min, from 6.0 min to 6.2 min, from 6.2 min to 6.4 min, from 6.4 min to 6.6 min, from 6.6 min to 6.8 min, from 6.8 min to 7.0 min, from 7.0 min to 7.2 min, from 7.2 min to 7.4 min, from 7.4 min to 7.6 min, from 7.6 min to 7.8 min, from 7.8 min to 8.0 min, from 8.0 min to 8.2 min, from 8.2 min to 8.4 min, from 8.4 min to 8.6 min, from 8.6 min to 8.8 min, from 8.8 min to 9.0 min, from 9.0 min to 9.2 min, from 9.2 min to 9.4 min, from 9.4 min to 9.6 min, from 9.6 min to 9.8 min, from 9.8 min to 10.0 min, from 10.0 min to 10.2 min, from 10.2 min to 10.4 min, from 10.4 min to 10.6 min, from 10.6 min to 10.8 min, from 10.8 min to 11.0 min, from 11.0 min to 11.2 min, from 11.2 min to 11.4 min, from 11.4 min to 11.6 min, from 11.6 min to 11.8 min, from 11.8 min to 12.0 min, from 12.0 min to 12.2 min, from 12.2 min to 12.4 min, from 12.4 min to 12.6 min, from 12.6 min to 12.8 min, from 12.8 min to 13.0 min, from 13.0 min to 13.2 min, from 13.2 min to 13.4 min, from 13.4 min to 13.6 min, from 13.6 min to 13.8 min, from 13.8 min to 14.0 min, from 14.0 min to 14.2 min, from 14.2 min to 14.4 min, from 14.4 min to 14.6 min, from 14.6 min to 14.8 min, from 14.8 min to 15.0 min, from 15.0 min to 15.2 min, from 15.2 min to 15.4 min, from 15.4 min to 15.6 min, from 15.6 min to 15.8 min, from 15.8 min to 16.0 min, from 16.0 min to 16.2 min, from 16.2 min to 16.4 min, from 16.4 min to 16.6 min, from 16.6 min to 16.8 min, from 16.8 min to 17.0 min, from 17.0 min to 17.2 min, from 17.2 min to 17.4 min, from 17.4 min to 17.6 min, from 17.6 min to 17.8 min, from 17.8 min to 18.0 min, from 18.0 min to 18.2 min, from 18.2 min to 18.4 min, from 18.4 min to 18.6 min, from 18.6 min to 18.8 min, from 18.8 min to 19.0 min, from 19.0 min to 19.2 min, from 19.2 min to 19.4 min, from 19.4 min to 19.6 min, from 19.6 min to 19.8 min, from 19.8 min to 20.0 min, from 20.0 min to 20.2 min, from 20.2 min to 20.4 min, from 20.4 min to 20.6 min, from 20.6 min to 20.8 min, from 20.8 min to 21.0 min, from 21.0 min to 21.2 min, from 21.2 min to 21.4 min, from 21.4 min to 21.6 min, from 21.6 min to 21.8 min, from 21.8 min to 22.0 min, from 22.0 min to 22.2 min, from 22.2 min to 22.4 min, from 22.4 min to 22.6 min, from 22.6 min to 22.8 min, from 22.8 min to 23.0 min, from 23.0 min to 23.2 min, from 23.2 min to 23.4 min, from 23.4 min to 23.6 min, from 23.6 min to 23.8 min, from 23.8 min to 24.0 min, from 24.0 min to 24.2 min, from 24.2 min to 24.4 min, from 24.4 min to 24.6 min, from 24.6 min to 24.8 min, from 24.8 min to 25.0 min, or any combination thereof.
   241. The method of any of the items 170-240, wherein the drying time for the matrices/sponges on transport mechanism 2 of the more than one transport mechanisms is 5.5 minutes, 6 minutes, 7.5 minutes, 8 minutes or 10.5 minutes.
   242. The method of any of the items 170-241, wherein the drying time for the matrices/sponges on transport mechanism 2 of the more than one transport mechanisms, can be selected from the group of time intervals consisting of from 2.0 min to 2.2 min, from 2.2 min to 2.4 min, from 2.4 min to 2.6 min, from 2.6 min to 2.8 min, from 2.8 min to 3.0 min, from 3.0 min to 3.2 min, from 3.2 min to 3.4 min, from 3.4 min to 3.6 min, from 3.6 min to 3.8 min, from 3.8 min to 4.0 min, from 4.0 min to 4.2 min, from 4.2 min to 4.4 min, from 4.4 min to 4.6 min, from 4.6 min to 4.8 min, from 4.8 min to 5.0 min, from 5.0 min to 5.2 min, from 5.2 min to 5.4 min, from 5.4 min to 5.6 min, from 5.6 min to 5.8 min, from 5.8 min to 6.0 min, from 6.0 min to 6.2 min, from 6.2 min to 6.4 min, from 6.4 min to 6.6 min, from 6.6 min to 6.8 min, from 6.8 min to 7.0 min, from 7.0 min to 7.2 min, from 7.2 min to 7.4 min, from 7.4 min to 7.6 min, from 7.6 min to 7.8 min, from 7.8 min to 8.0 min, from 8.0 min to 8.2 min, from 8.2 min to 8.4 min, from 8.4 min to 8.6 min, from 8.6 min to 8.8 min, from 8.8 min to 9.0 min, from 9.0 min to 9.2 min, from 9.2 min to 9.4 min, from 9.4 min to 9.6 min, from 9.6 min to 9.8 min, from 9.8 min to 10.0 min, from 10.0 min to 10.2 min, from 10.2 min to 10.4 min, from 10.4 min to 10.6 min, from 10.6 min to 10.8 min, from 10.8 min to 11.0 min, from 11.0 min to 11.2 min, from 11.2 min to 11.4 min, from 11.4 min to 11.6 min, from 11.6 min to 11.8 min, from 11.8 min to 12.0 min, from 12.0 min to 12.2 min, from 12.2 min to 12.4 min, from 12.4 min to 12.6 min, from 12.6 min to 12.8 min, from 12.8 min to 13.0 min, from 13.0 min to 13.2 min, from 13.2 min to 13.4 min, from 13.4 min to 13.6 min, from 13.6 min to 13.8 min, from 13.8 min to 14.0 min, from 14.0 min to 14.2 min, from 14.2 min to 14.4 min, from 14.4 min to 14.6 min, from 14.6 min to 14.8 min, from 14.8 min to 15.0 min, from 15.0 min to 15.2 min, from 15.2 min to 15.4 min, from 15.4 min to 15.6 min, from 15.6 min to 15.8 min, from 15.8 min to 16.0 min, from 16.0 min to 16.2 min, from 16.2 min to 16.4 min, from 16.4 min to 16.6 min, from 16.6 min to 16.8 min, from 16.8 min to 17.0 min, from 17.0 min to 17.2 min, from 17.2 min to 17.4 min, from 17.4 min to 17.6 min, from 17.6 min to 17.8 min, from 17.8 min to 18.0 min, from 18.0 min to 18.2 min, from 18.2 min to 18.4 min, from 18.4 min to 18.6 min, from 18.6 min to 18.8 min, from 18.8 min to 19.0 min, from 19.0 min to 19.2 min, from 19.2 min to 19.4 min, from 19.4 min to 19.6 min, from 19.6 min to 19.8 min, from 19.8 min to 20.0 min, from 20.0 min to 20.2 min, from 20.2 min to 20.4 min, from 20.4 min to 20.6 min, from 20.6 min to 20.8 min, from 20.8 min to 21.0 min, from 21.0 min to 21.2 min, from 21.2 min to 21.4 min, from 21.4 min to 21.6 min, from 21.6 min to 21.8 min, from 21.8 min to 22.0 min, from 22.0 min to 22.2 min, from 22.2 min to 22.4 min, from 22.4 min to 22.6 min, from 22.6 min to 22.8 min, from 22.8 min to 23.0 min, from 23.0 min to 23.2 min, from 23.2 min to 23.4 min, from 23.4 min to 23.6 min, from 23.6 min to 23.8 min, from 23.8 min to 24.0 min, from 24.0 min to 24.2 min, from 24.2 min to 24.4 min, from 24.4 min to 24.6 min, from 24.6 min to 24.8 min, from 24.8 min to 25.0 min, or any combination thereof.
   243. The method of any of the preceding items, wherein the resulting activity on the coated surface of the matrices/sponges as measured immediately after drying and subsequent cooling to ambient temperature is 40 IU/cm².
   244. The method of any of the preceding items, wherein the resulting activity on the coated surface of the matrices/sponges as measured immediately after drying and subsequent cooling to ambient temperature can be selected from the group of intervals consisting of from 5 IU/cm² to 6 IU/cm², from 6 IU/cm² to 7 IU/cm², from 7 IU/cm² to 8 IU/cm², from 8 IU/cm² to 9 IU/cm², from 9 IU/cm² to 10 IU/cm², 10 IU/cm² to 12 IU/cm², from 12 IU/cm² to 14 IU/cm², from 14 IU/cm² to 16 IU/cm², from 16 IU/cm² to 18 IU/cm², from 18 IU/cm² to 20 IU/cm², 20 IU/cm² to 22 IU/cm², from 22 IU/cm² to 24 IU/cm², from 24 IU/cm² to 26 IU/cm², from 26 IU/cm² to 28 IU/cm², from 28 IU/cm² to 30 IU/cm², from 30 IU/cm² to 32 IU/cm², from 32 IU/cm² to 34 IU/cm², from 34 IU/cm² to 36 IU/cm², from 36 IU/cm² to 38 IU/cm², from 38 IU/cm² to 40 IU/cm², from 40 IU/cm² to 42 IU/cm², from 42 IU/cm² to 44 IU/cm², from 44 IU/cm² to 46 IU/cm², from 46 IU/cm² to 48 IU/cm², from 48 IU/cm² to 50 IU/cm², from 50 IU/cm² to 52 IU/cm², from 52 IU/cm² to 54 IU/cm², from 54 IU/cm² to 56 IU/cm², from 56 IU/cm² to 58 IU/cm², from 58 IU/cm² to 60 IU/cm², from 60 IU/cm² to 62 IU/cm², from 62 IU/cm² to 64 IU/cm², from 64 IU/cm² to 66 IU/cm², from 66 IU/cm² to 68 IU/cm², from 68 IU/cm² to 70 IU/cm², from 70 IU/cm² to 72 IU/cm², from 72 IU/cm² to 74 IU/cm², from 74 IU/cm² to 76 IU/cm², from 76 IU/cm² to 78 IU/cm², from 32 IU/cm² to 34 IU/cm², from 34 IU/cm² to 36 IU/cm², from 36 IU/cm² to 38 IU/cm², from 38, from 78 IU/cm² to 80 IU/cm², from 80 IU/cm² to 82 IU/cm², from 82 IU/cm² to 84 IU/cm², from 84 IU/cm² to 86 IU/cm², from 86 IU/cm² to 88 IU/cm², from 88 IU/cm² to 90 IU/cm², from 92 IU/cm² to 54 IU/cm², from 54 IU/cm² to 56 IU/cm², from 56 IU/cm² to 58 IU/cm², from 98 IU/cm² to 100 IU/cm², or any combination thereof.
   245. The method of any of the preceding items, wherein the resulting activity on the coated surface of the matrices/sponges as measured after 2 years of storage at ambient temperature is 25 IU/cm².
   246. The method of any of the preceding items, wherein the resulting activity on the coated surface of the sponges/matrices as measured after 2 years of storage at ambient temperature can be selected from the group of intervals consisting of from 5 IU/cm² to 6 IU/cm², from 6 IU/cm² to 7 IU/cm², from 7 IU/cm² to 8 IU/cm², from 8 IU/cm² to 9 IU/cm², from 9 IU/cm² to 10 IU/cm², 10 IU/cm² to 12 IU/cm², from 12 IU/cm² to 14 IU/cm², from 14 IU/cm² to 16 IU/cm², from 16 IU/cm² to 18 IU/cm², from 18 IU/cm² to 20 IU/cm², 20 IU/cm² to 22 IU/cm², from 22 IU/cm² to 24 IU/cm², from 24 IU/cm² to 26 IU/cm², from 26 IU/cm² to 28 IU/cm², from 28 IU/cm² to 30 IU/cm², from 30 IU/cm² to 32 IU/cm², from 32 IU/cm² to 34 IU/cm², from 34 IU/cm² to 36 IU/cm², from 36 IU/cm² to 38 IU/cm², from 38 IU/cm² to 40 IU/cm², from 40 IU/cm² to 42 IU/cm², from 42 IU/cm² to 44 IU/cm², from 44 IU/cm² to 46 IU/cm², from 46 IU/cm² to 48 IU/cm², from 48 IU/cm² to 50 IU/cm², from 50 IU/cm² to 52 IU/cm², from 52 IU/cm² to 54 IU/cm², from 54 IU/cm² to 56 IU/cm², from 56 IU/cm² to 58 IU/cm², from 58 IU/cm² to 60 IU/cm², from 60 IU/cm² to 62 IU/cm², from 62 IU/cm² to 64 IU/cm², from 64 IU/cm² to 66 IU/cm², from 66 IU/cm² to 68 IU/cm², from 68 IU/cm² to 70 IU/cm², from 70 IU/cm² to 72 IU/cm², from 72 IU/cm² to 74 IU/cm², from 74 IU/cm² to 76 IU/cm², from 76 IU/cm² to 78 IU/cm², from 32 IU/cm² to 34 IU/cm², from 34 IU/cm² to 36 IU/cm², from 36 IU/cm² to 38 IU/cm², from 38, from 78 IU/cm² to 80 IU/cm², from 80 IU/cm² to 82 IU/cm², from 82 IU/cm² to 84 IU/cm², from 84 IU/cm2 to 86 IU/cm2, from 86 IU/cm2 to 88 IU/cm2, from 88 IU/cm2 to 90 IU/cm2, from 92 IU/cm2 to 54 IU/cm2, from 54 IU/cm2 to 56 IU/cm2, from 56 IU/cm2 to 58 IU/cm2, from 98 IU/cm2 to 100 IU/cm2, or any combination thereof.
   247. The method of any of the preceding items, wherein the supply solutions i.e. the pharmaceutical composition can be changed completely without entry of air bubbles into the liquid feed system, thus ensuring a uniform coating on the matrices/sponges.
   248. The method of any of the preceding items, wherein the supply solutions i.e. the pharmaceutical composition can be changed essentially without entry of air bubble into the liquid feed system, thus ensuring a uniform coating on the matrices/sponges.
   249. The method of any of the preceding items, wherein the matrices are cooled to ambient temperature after drying.
   250. The method of any of the preceding items, wherein the matrices/sponges are coated sequentially with two different pharmaceutical compositions using the described ultrasonic spray technique with an oven-based drying procedure following each spray coating procedure.
   251. The method of any of the preceding items, wherein the matrices/sponges are coated sequentially with two different pharmaceutical compositions using the described ultrasonic spray technique without an oven-based drying procedure following each spray coating procedure.
   252. The method of any of items 180 to 251, wherein the one or more nozzle assemblies comprise two nozzles and wherein the ultrasonic spray method comprises two sequential rounds of application of a composition onto a matrix/sponge by ultrasonic spray technology.
   253. The method of item 252, wherein more than one round of application by ultrasonic spray technology is used, such as 2, for example 3, such as 4, for example 5, such as 6, for example 7, such as 8, for example 9, such as 10 sequential application rounds is used to apply a composition onto the surface of a matrix material.
   254. The method of item 252, wherein more than 10 sequential application rounds are used to apply a composition onto the surface of a matrix material.
   255. The method of items 251 and 252, wherein—prior to the next application round—the position of the one or more nozzles is shifted and/or the position of the matrix/sponge is shifted.
   256. The method of items 251 and 252, wherein the localization of the composition applied onto the matrix/sponge in the first round and in the second and/or further rounds differs.
   257. The method of items 251 and 252, wherein the areas of the matrix material that are covered by the composition in different application rounds overlap less than 50%, for example less than 40%, such as less than 30%, for example less than 20%, such as less than 10%, for example less than 5%, such as less than 1%.
   258. The method of items 251 and 252, wherein the nozzle assembly comprises more than 1 nozzle such as 2 nozzles, for example 3 nozzles, such as 4 nozzles, for example 5 nozzles, such as 6 nozzles, for example 7 nozzles, such as 8 nozzles, for example 9 nozzles, such as 10 nozzles.
   259. The method of items 251 and 252, wherein the nozzle assembly comprises more than 10 nozzles.
   260. The method of items 251 and 252, wherein distance between the nozzle centres of the two or more individual ultrasonic spray nozzles of the one or more nozzle assemblies is 41.5 mm.
   261. The method of items 251 and 252, wherein the distance between the nozzle centres of the two or more individual ultrasonic spray nozzles of the one or more nozzle assemblies is in the range of 1.0 to 100.0 mm; such as 1.0-1.5 mm, for example 1.5-2.0 mm, such as 2.0-2.5 mm, for example 2.5-3.0 mm, such as 3.0-3.5 mm, for example 3.5-4.0 mm, such as 4.0-4.5 mm, for example 4.5-5.0 mm, such as 5.0-6.0 mm, for example 6.0-7.0 mm, such as 7.0-8.0 mm, for example 8.0-9.0 mm, such as 9.0-10.0 mm, for example 10.0-11.00 mm, such as 11.0-12.0 mm, for example 12.0-13.0 mm, such as 13.0-14.0 mm, for example 14.0-15.0 mm, such as 15.0-16.0 mm, for example 16.0-17.0 mm, such as 17.0-18.0 mm, for example 18.0-19.0 mm, such as 19.0-20.0 mm, for example 20.0-21.00 mm, such as 21.0-22.0 mm, for example 22.0-23.0 mm, such as 23.0-24.0 mm, for example 24.0-25.0 mm, such as 25.0-26.0 mm, for example 26.0-27.0 mm, such as 27.0-28.0 mm, for example 28.0-29.0 mm, such as 29.0-30.0 mm, for example 30.0-31.00 mm, such as 31.0-32.0 mm, for example 32.0-33.0 mm, such as 33.0-34.0 mm, for example 34.0-35.0 mm, such as 35.0-36.0 mm, for example 36.0-37.0 mm, such as 37.0-38.0 mm, for example 38.0-39.0 mm, such as 39.0-40.0 mm, for example 40.0-41.00 mm, such as 41.0-42.0 mm, for example 42.0-43.0 mm, such as 43.0-44.0 mm, for example 44.0-45.0 mm, such as 45.0-46.0 mm, for example 46.0-47.0 mm, such as 47.0-48.0 mm, for example 48.0-49.0 mm, such as 49.0-50.0 mm, for example 50.0-51.00 mm, such as 51.0-52.0 mm, for example 52.0-53.0 mm, such as 53.0-54.0 mm, for example 54.0-55.0 mm, such as 55.0-56.0 mm, for example 56.0-57.0 mm, such as 57.0-58.0 mm, for example 58.0-59.0 mm, such as 59.0-60.0 mm, for example 60.0-61.00 mm, such as 61.0-62.0 mm, for example 62.0-63.0 mm, such as 63.0-64.0 mm, for example 64.0-65.0 mm, such as 65.0-66.0 mm, for example 66.0-67.0 mm, such as 67.0-68.0 mm, for example 68.0-69.0 mm, such as 69.0-70.0 mm, for example 70.0-71.00 mm, such as 71.0-72.0 mm, for example 72.0-73.0 mm, such as 73.0-74.0 mm, for example 74.0-75.0 mm, such as 75.0-76.0 mm, for example 76.0-77.0 mm, such as 77.0-78.0 mm, for example 78.0-79.0 mm, such as 79.0-80.0 mm, for example 80.0-81.00 mm, such as 81.0-82.0 mm, for example 82.0-83.0 mm, such as 83.0-84.0 mm, for example 84.0-85.0 mm, such as 85.0-86.0 mm, for example 86.0-87.0 mm, such as 87.0-88.0 mm, for example 88.0-89.0 mm, such as 89.0-90.0 mm, for example 90.0-91.00 mm, such as 91.0-92.0 mm, for example 92.0-93.0 mm, such as 93.0-94.0 mm, for example 94.0-95.0 mm, such as 95.0-96.0 mm, for example 96.0-97.0 mm, such as 97.0-98.0 mm, for example 98.0-99.0 mm, such as 99.0-100.0 mm.
   262. The method of any of the items, wherein the spillage/waste is less than 10% of the composition, such as less than 5%, for example less than 4%, such as less than 3%, for example less than 2%, such as less than 1%, for example less than 0.5% or such as less than 0.1%.
   263. The method of any of the preceding items, wherein the matrices/sponges are initially coated with a solution containing thrombin followed by a drying procedure e.g. as described herein above, followed by an additional coating procedure with a solution containing fibrin followed by a second drying procedure.
   264. The method of any of the preceding items, wherein the matrices/sponges are subjected to coating with two different pharmaceutical compositions, wherein spray coating of either the first or the second or both of the solution is undertaken at a pH different from 7, thus minimizing enzymatic activity of the pharmaceutical compositions.
   265. The method of any of the preceding items, wherein ultrasonic spray coating and drying of the matrices/sponges is followed by brief cooling of said sponge, where after each matrix/sponge is put into a tray, which is sealed.
   266. The method of any of the preceding items, wherein tray sealing is carried out under sterile conditions, thus producing a sterile composition consisting of a sterile matrix/sponge in a sealed sterile tray.
   267. The method of any of the preceding items, wherein tray sealing is followed by packaging of the sterile or non-sterile trays, each comprising a matrix/sponge, into pouches, which are then sealed.
   268. The method of any of the preceding items, wherein said pouch packaging is carried out under sterile conditions.
   269. A device coated by the method according to any of the items 1-268.
   270. A kit of parts comprising the device according to item 269 and at least one additional component.
   271. A method for making the device according to item 269 comprising the steps of
      k. providing a matrix material, and
      l. applying a pharmaceutical composition onto the surface of said matrix material by ultrasonic spray technology
   272. Use of the device according to item 269 to promote wound healing in an individual in need thereof.
   273. Use of the device according to item 269 to promote hemostasis in an individual in need thereof.

### EXAMPLES

The invention will be further described in the following examples, which do not limit the scope of the invention described in the claims.

### Example 1

### Determination of the Reconformation Rate of Gelatin-Based Sponges

The purpose of this method is to determine the reconformation rate of a gelatin-based sponge. The method comprises soaking the sponge, and subsequently squeezing it. The appearance of the native shape of the sponge is monitored as a function of time, and the time that lapses until the sponge has reached its native shape is termed the reconformation time.

The method comprises the following steps:

1. Cut a suitable piece of absorbable gelatin-based sponge, approximately 1×1 cm, and thoroughly soak it in water at room temperature.
2. Remove the sample from the water, and squeeze it until it is flat and no more air bubbles or drops of water can be pressed out.
3. Place the sample in a beaker filled with water at room temperature and measure the time (in seconds) until the sample has gained its former size and shape.
4. Repeat the test twice and report the result as the average of three determinations.

### Example 2

This gives an example of a possible spray medium or composition for application by ultrasonic spray technology onto a surface of a matrix. In this example, the bioactive agent comprised in the pharmaceutical composition is thrombin, and the matrix is a collagen-based sponge.

Spray media: sterile MQ-water, sterile saline or another appropriate sterile aqueous solvent is adjusted with a suitable biocompatible viscosity enhancer, such as gelatin, to 10 cps. Thrombin is reconstituted to a suitable concentration in the media. This concentration should be adjusted so that the final concentration of thrombin yields 30 IU/cm² on the surface of the matrix to be imprinted. The pH is kept within physiological ranges, and the temperature is held at ambient temperature (around 25° C.). If desired, a suitable surfactant may be added to the medium.

The matrix chosen is in one embodiment a gelatin-based sponge, such as the commercially available Spongostan®, Surgifoam® or Surgiflo® (Ferrosan A/S). The sponge may be cut into a suitable form and shape.

The accuracy of the nozzle assembly head and the control of the nozzle assembly head must be very high, since this controls the amount that is applied by ultrasonic spray technology and thus the dosage of thrombin on the fabricated sponge. This is important even at high rates of production (such as 60 sponges per minute).

### Example 3

### Hemostatic Effect for a Matrix Sprayed with Thrombin by Ultrasonic Spray Technology

A pig model is used to test the effect on hemostasis of different amounts of thrombin sprayed onto a matrix (Surgifoam™; Johnson and Jonhson). Wet and dry application of the thrombin matrix is compared.

The present invention relates in one embodiment to a matrix such as Surgifoam™ sprayed with an amount of thrombin resulting in a time of hemostasis after dry application (measured by the assay described above) below 200 seconds, such as below 190 seconds, for example below 180 seconds, such as below 170 seconds, for example below 160 seconds, such as below 150 seconds, for example below 140 seconds, such as below 130 seconds, for example below 120 seconds, such as below 110 seconds, for example below 100 seconds, such as below 90 seconds, for example below 80 seconds, such as below 70 seconds, for example below 60 seconds, such as below 50 seconds, for example below 48 seconds, such as below 46 seconds, for example below 44 seconds, such as below 42 seconds, for example below 40 seconds, such as below 38 seconds, for example below 36 seconds, such as below 34 seconds, for example below 32 seconds, such as below 30 seconds, for example below 28 seconds, such as below 26 seconds, for example below 24 seconds, such as below 22 seconds, for example below 20 seconds, such as below 18 seconds, for example below 16 seconds, such as below 14 seconds, for example below 12 seconds, such as below 10 seconds, for example below 8 seconds, such as below 6 seconds, for example below 4 seconds, such as below 2 seconds, for example below 1 second.

### Example 4

### Use of a Container with a Matrix Material in an Operating Room

This example describes one example of use of a container with a matrix material in an operating room. The matrix material is e.g. a gelatine sponge coated with thrombin by ultrasonic spray technology.

A person such as a scrub tech/RN places the container/tray on a sterile field, uses the handle to hold the container/tray while removing the lid e.g. a tyvek lid. In one embodiment everything on the sterile field is labelled to minimize any mistakes. The person such as the scrub tech/RN checks that the product name has been embossed on the container/tray thus giving confidence that no additional labeling needs to be done. The mixing preparation on the lid serves as a guiding to remind the person how to mix the product correctly. The scrub tech/RN uses the notches (inside dwellings) to take up the matrix material such as a sponge from the container/tray with the fingers, tweezers, forceps or an alternative device. The scrub tech/RN cuts the matrix material such as a sponge into the container/tray omitting the need for a bowl. When matrix material pieces have been cut, the scrub tech/RN applies the appropriate amount of liquid, such as sodium chloride, such as sodium chloride 0.9%, on top of the matrix material/sponge pieces. The Scrub tech may use for example fingers or a pair of forceps to poke the liquid/sodium chloride/sodium chloride 0.9% into the matrix materials/sponge pieces. When this is done, the scrub tech/RN optionally uses the handle on the tray to place the tray until needed by e.g. the surgeon: the tray may e.g. be placed on the sterile field, back table (sterile), on the mayo stand, on the chest of the patient (e.g. on sterile cover). The scrub tech/RN may hold the handle when presenting the product to the surgeon and while the surgeon picks up the sponges that be wants from the tray. Alternatively, the tray may be placed on e.g. the mayo stand and the scrub tech/RN gives the surgeon individual matrix materials/sponge pieces on a pair forceps. If surgeon desires to use soaked e.g. saline soaked patties or cottonoids on top of the matrix material/sponge pieces for compression, these can be placed on the flat part of the tray.

### Example 5

This example describes one example of spraying a fluid, pharmaceutical composition with thrombin onto a matrix material by ultra sonic spray technology; wherein the ratio of droplet volume, the distance between droplets deposited on the surface of the matrix material and the concentration of thrombin is fixed to achieve a uniform distribution pattern.

In this example, the bioactive agent comprised in the fluid or liquid composition is thrombin, and the matrix is a gelatin-based sponge.

Spray media: sterile MQ-water, sterile saline or another appropriate sterile aqueous solvent is adjusted with a suitable biocompatible viscosity enhancer, such as gelatin, to 10 cps. Thrombin is reconstituted to a concentration of 8-10,000 IU/ml in the media. The pH is kept within physiological ranges, and the temperature is held at ambient temperature (around 25° C.). If desired, a suitable surfactant may be added to the medium.

A fluid or liquid composition comprising thrombin at a concentration of 8-10,000 IU/ml is filled in a reservoir connected to a nozzle assembly head. The distance between the nozzle assembly head and the gelatin-sponge is adjusted to 2 mm.

### Example 6

In this Example a Thrombin solution is applied by ultrasonic spray technology onto a gelatine sponge. After the application of the Thrombin solution the gelatine sponge is dried.

The Thrombin solution consists of 12300-14800 IU/ml human Thrombin, 38-42 mmol/l Calcium, 16-26 mg/ml Albumin, 17.5-20-5 mg/ml Mannitol, 17-20 mmol/l Acetate, and 22-29 mg/ml total protein.

The table below provides an overview of the sponge dimensions of example 6:

| Matrix | Surface area of matrix | Dimensions of matrix (sponge) in cm |
|---|---|---|
| (sponge) | (sponge) in cm² | (length × width × depth) |
| 12-7 × 1 | 12 | 6 × 2 × 0.7 |
| 12-7 × 1.6 | 12 | 6 × 2 × 0.7 |
| 50 × 1 | 50 | 8 × 6.25 × 1.0 |
| 50 × 1.6 | 50 | 8 × 6.25 × 1.0 |
| 100 × 1 | 100 | 8 × 12.5 × 1.0 |
| 100 × 1.6 | 100 | 8 × 12.5 × 1.0 |

### Coating

The Thrombin solution was applied onto the gelatine sponge by use of a coating line. The setting of different parameters of the coating line depends on the size of the gelatine sponge. Examples of settings of the coating line for different sizes of gelatine sponges are given herein below.

The following settings were used for the coating line (entered prior to production start) for a gelatine sponge with the size 12-7×1.

| Parameter/Function | Setpoint | |
|---|---|---|
| Velocity of transport mechanism | 1.2 | m/min |
| Auto belt | On | |
| Air knifes | Off | |
| Spray | On | |
| Flow rate 1 | 1.4 | ml/min |
| Flow rate 2 | 1.4 | ml/min |
| Jet force | 25 | l/min |
| Conveyor | 1 | m/min |
| Nozzle power | 2.8 | W |
| Spray on | 23 | cm |
| Spray off | 0.8 | cm |
| Spray width | 30 | cm |
| Spray offset | 0 | cm |
| Nozzle fixture | 12-7 | |
| Distance from belt to nozzle centre | 82 | mm |
| Distance from fixture to cabin wall | 180 + 126 | mm |

| | |
|---|---|
| Guide position application zone | Directed towards the |
| | centre of the belt |

The following were registered for the coating line after end of the production of a gelatine sponge with the size 12-7×1.

| Parameter/Funktion | Setpoint |
|---|---|
| Velocity of transport mechanism | 1.2 m/min |
| Auto belt | On |
| Air knifes | Off |
| Spray | On |
| Guide position application zone | Directed towards the centre of the belt |

The following settings were used for the coating line (entered prior to production start) for a gelatine sponge with the size 12-7×1.6.

| Parameter/Function | Setpoint | |
|---|---|---|
| Velocity of transport mechanism | 0.76 | m/min |
| Auto belt | On | |
| Air knifes | Off | |
| Spray | On | |
| Flow rate 1 | 1.4 | ml/min |
| Flow rate 2 | 1.4 | ml/min |
| Jet force | 25 | l/min |
| Conveyor | 0.5 | m/min |
| Nozzle power | 2.8 | W |
| Spray on | 19 | cm |
| Spray off | 0.8 | cm |
| Spray width | 30 | cm |
| Spray offset | 0 | cm |
| Nozzle fixture | 12-7 | |
| Distance from belt to nozzle centre | 82 | mm |
| Distance from fixture to cabin wall | 180 + 126 | mm |

| | |
|---|---|
| Guide position application zone | Directed towards the |
| | centre of the belt |

The following were registered for the coating line after end of the production of a gelatine sponge with the size 12-7×1.6.

| Parameter/Funktion | Setpoint |
|---|---|
| Velocity of transport mechanism | 0.76 m/min |
| Auto belt | On |
| Air knifes | Off |
| Spray | On |
| Guide position application zone | Directed towards the centre of the belt |

The following settings were used for the coating line (entered prior to production start) for a gelatine sponge with the size 50×1.

| Parameter/Function | Setpoint | |
|---|---|---|
| Velocity of transport mechanism | 3.75 | m/min |
| Auto belt | On | |
| Air knifes | Off | |
| Spray | On | |
| Flow rate 1 | 5.37 | ml/min |
| Flow rate 2 | 5.37 | ml/min |
| Jet force | 25 | l/min |
| Conveyor | 1 | m/min |
| Nozzle power | 4 | W |
| Spray on | 8.4 | cm |
| Spray off | 0.8 | cm |
| Spray width | 30 | cm |
| Spray offset | 0 | cm |
| Nozzle fixture | 50/100 | |
| Distance from belt to nozzle centre | 130 | mm |
| Distance from fixture to cabin wall | 180 | mm |

| | |
|---|---|
| Guide position application zone | As far as possible from |
| | the centre of the belt |

The following were registered for the coating line after end of the production of a gelatine sponge with the size 50×1.

| Parameter/Funktion | Setpoint |
|---|---|
| Velocity of transport mechanism | 3.75 m/min |
| Auto belt | On |
| Air knifes | Off |
| Spray | On |
| Guide position application zone | As far as possible from |
| | the centre of the belt |

The following settings were used for the coating line (entered prior to production start) for a gelatine sponge with the size 50×1.6.

| Parameter/Function | Setpoint | |
|---|---|---|
| Velocity of transport mechanism | 2.36 | m/min |
| Auto belt | On | |
| Air knifes | Off | |
| Spray | On | |
| Flow rate 1 | 5.37 | ml/min |
| Flow rate 2 | 5.37 | ml/min |
| Jet force | 25 | l/min |
| Conveyor | 1 | m/min |
| Nozzle power | 4 | W |
| Spray on | 13.5 | cm |
| Spray off | 0.8 | cm |
| Spray width | 30 | cm |
| Spray offset | 0 | cm |
| Nozzle fixture | 50/100 | |
| Distance from belt to nozzle centre | 130 | mm |
| Distance from fixture to cabin wall | 180 | mm |

| | |
|---|---|
| Guide position application zone | As far as possible from |
| | the centre of the belt |

The following were registered for the coating line after end of the production of a gelatine sponge with the size 50×1.6.

| Parameter/Funktion | Setpoint |
|---|---|
| Velocity of transport mechanism | 2.36 m/min |
| Auto belt | On |
| Air knifes | Off |
| Spray | On |
| Guide position application zone | As far as possible from |
| | the centre of the belt |

The following settings were used for the coating line (entered prior to production start) for a gelatine sponge with the size 100×1.

| Parameter/Function | Setpoint | |
|---|---|---|
| Velocity of transport mechanism | 3.75 | m/min |
| Auto belt | On | |
| Air knifes | Off | |
| Spray | On | |
| Flow rate 1 | 5.37 | ml/min |
| Flow rate 2 | 5.37 | ml/min |
| Jet force | 25 | l/min |
| Conveyor | 1 | m/min |
| Nozzle power | 4 | W |
| Spray on | 8.4 | cm |
| Spray off | 0.8 | cm |
| Spray width | 30 | cm |
| Spray offset | 0 | cm |
| Nozzle fixture | 50/100 | |
| Distance from belt to nozzle centre | 130 | mm |
| Distance from fixture to cabin wall | 180 | mm |

| | |
|---|---|
| Guide position application zone | As far as possible from |
| | the centre of the belt |

The following were registered for the coating line after end of the production of a gelatine sponge with the size 100×1.

| Parameter/Funktion | Setpoint |
|---|---|
| Velocity of transport mechanism | 3.75 m/min |
| Auto belt | On |
| Air knifes | Off |
| Spray | On |
| Guide position application zone | As far as possible from |
| | the centre of the belt |

The following settings were used for the coating line (entered prior to production start) for a gelatine sponge with the size 100×1.6.

| Parameter/Function | Setpoint | |
|---|---|---|
| Velocity of transport mechanism | 2.36 | m/min |
| Auto belt | On | |
| Air knifes | Off | |
| Spray | On | |
| Flow rate 1 | 5.37 | ml/min |
| Flow rate 2 | 5.37 | ml/min |
| Jet force | 25 | l/min |
| Conveyor | 1 | m/min |
| Nozzle power | 4 | W |
| Spray on | 13.5 | cm |
| Spray off | 0.8 | cm |
| Spray width | 30 | cm |
| Spray offset | 0 | cm |
| Nozzle fixture | 50/100 | |
| Distance from belt to nozzle centre | 130 | mm |
| Distance from fixture to cabin wall | 180 | mm |

| | |
|---|---|
| Guide position application zone | As far as possible from |
| | the centre of the belt |

The following were registered for the coating line after end of the production of a gelatine sponge with the size 100×1.6.

| Parameter/Funktion | Setpoint |
|---|---|
| Velocity of transport mechanism | 2.36 m/min |
| Auto belt | On |
| Air knifes | Off |
| Spray | On |
| Guide position application zone | As far as possible from |
| | the centre of the belt |

### Drying

After the Thrombin solution has been applied onto the gelatine sponge the gelatine sponge is dried during a drying step. The drying time of the drying step depends on the size of the gelatine sponge. The drying temperature and drying time for gelatine sponges with different sizes are given herein below.

The following settings were used for the drying line (entered prior to production start) for a gelatine sponge with the size 12-7×1 cm.

| No. | Parameter/Function | Setpoint |
|---|---|---|
| 1 | Oven temperature | 45° C. |
| 2 | Drying time for the first production line | 5 min. 30 sec. |
| 3 | Drying time for the second production | 5 min. 30 sec. |
| | line | |

The following were registered for the drying line after end of the production for a gelatine sponge with the size 12-7×1.

| No. | Parameter/Function | Setpoint |
|---|---|---|
| 1 | Oven temperature | 45° C. |
| 2 | Drying time for the first production line | 5 min. 30 sec. |
| 3 | Drying time for the second production | 5 min. 30 sec. |
| | line | |

The following settings were used for the drying line (entered prior to production start) for a gelatine sponge with the size 12-7×1.6.

| No. | Parameter/Function | Setpoint |
|---|---|---|
| 1 | Oven temperature | 45° C. |
| 2 | Drying time for the first production line | 7 min. 30 sec. |
| 3 | Drying time for the second production | 7 min. 30 sec. |
| | line | |

The following were registered for the drying line after end of the production for a gelatine sponge with the size 12-7×1.6.

| No. | Parameter/Function | Setpoint |
|---|---|---|
| 1 | Oven temperature | 45° C. |
| 2 | Drying time for the first production line | 7 min. 30 sec. |
| 3 | Drying time for the second production | 7 min. 30 sec. |
| | line | |

The following settings were used for the drying line (entered prior to production start) for a gelatine sponge with the size 50×1.

| | | |
|---|---|---|
| No. | Parameter/Function | Setpoint |

| | | | |
|---|---|---|---|
| 1 | Oven temperature | 45° | C. |
| 2 | Drying time for the first production line | 6 | min. |
| 3 | Drying time for the second production | 6 | min. |
| | line | | |

The following were registered for the drying line after end of the production for a gelatine sponge with the size 50×1.

| | | |
|---|---|---|
| No. | Parameter/Function | Setpoint |

| | | | |
|---|---|---|---|
| 1 | Oven temperature | 45° | C. |
| 2 | Drying time for the first production line | 6 | min. |
| 3 | Drying time for the second production | 6 | min. |
| | line | | |

The following settings were used for the drying line (entered prior to production start) for a gelatine sponge with the size 50×1.6.

| No. | Parameter/Function | Setpoint |
|---|---|---|
| 1 | Oven temperature | 45° C. |
| 2 | Drying time for the first production line | 10 min. 30 sec. |
| 3 | Drying time for the second production | 10 min. 30 sec. |
| | line | |

The following were registered for the drying line after end of the production for a gelatine sponge with the size 50×1.6.

| No. | Parameter/Function | Setpoint |
|---|---|---|
| 1 | Oven temperature | 45° C. |
| 2 | Drying time for the first production line | 10 min. 30 sec. |
| 3 | Drying time for the second production | 10 min. 30 sec. |
| | line | |

The following settings were used for the drying line (entered prior to production start) for a gelatine sponge with the size 100×1.

| | | |
|---|---|---|
| No. | Parameter/Function | Setpoint |

| | | | |
|---|---|---|---|
| 1 | Oven temperature | 45° | C. |
| 2 | Drying time for the first production line | 6 | min. |
| 3 | Drying time for the second production | 6 | min. |
| | line | | |

The following were registered for the drying line after end of the production for a gelatine sponge with the size 100×1.

| | | |
|---|---|---|
| No. | Parameter/Function | Setpoint |

| | | | |
|---|---|---|---|
| 1 | Oven temperature | 45° | C. |
| 2 | Drying time for the first production line | 6 | min. |
| 3 | Drying time for the second production | 6 | min. |
| | line | | |

The following settings were used for the drying line (entered prior to production start) for a gelatine sponge with the size 100×1.6.

| No. | Parameter/Function | Setpoint |
|---|---|---|
| 1 | Oven temperature | 45° C. |
| 2 | Drying time for the first production line | 10 min. 30 sec. |
| 3 | Drying time for the second production | 10 min. 30 sec. |
| | line | |

The following were registered for the drying line after end of the production for a gelatine sponge with the size 100×1.6.

| No. | Parameter/Function | Setpoint |
|---|---|---|
| 1 | Oven temperature | 45° C. |
| 2 | Drying time for the first production line | 10 min. 30 sec. |
| 3 | Drying time for the second production | 10 min. 30 sec. |
| | line | |

### Example 7

In this example a Thrombin solution is applied by ultrasonic spray technology onto a gelatine sponge. After the application of the Thrombin solution, the gelatine sponge is dried.

Example 7 contains data from the specialised application procedure which involves two sequential application rounds. The positioning of the spray nozzles during this application procedure is illustrated in FIG. 12. During the first application round nozzle 1 and 2 are placed at position A and C, respectively. After spray coating of the matrices with the nozzle 1 and 2 in positions A and C, the matrices are reloaded for another application round and the positioning of the nozzles is shifted, so that the nozzles occupy positions B and D, respectively, during application round 2.

The Thrombin solution used throughout example 7 consists of 12300-14800 IU/ml human Thrombin, 38-42 mmol/l Calcium, 16-26 mg/ml Albumin, 17.5-20-5 mg/ml Mannitol, 17-20 mmol/l Acetate, and 22-29 mg/ml total protein.

The table below provides an overview of the sponge dimensions of example 7:

| Matrix | Surface area of matrix | Dimensions matrix (sponge) in cm |
|---|---|---|
| (sponge) | (sponge) in cm² | (length × width × depth) |
| 12-7 × 1 | 12 | 6 × 2 × 0.7 |
| 12-7 × 1.3 | 12 | 6 × 2 × 0.7 |
| 12-7 × 1.6 | 12 | 6 × 2 × 0.7 |
| 50 × 1 | 50 | 8 × 6.25 × 1.0 |
| 50 × 1.1 | 50 | 8 × 6.25 × 1.0 |
| 50 × 1.3 | 50 | 8 × 6.25 × 1.0 |
| 50 × 1.6 | 50 | 8 × 6.25 × 1.0 |
| 100 × 1 | 100 | 8 × 12.5 × 1.0 |
| 100 × 1.1 | 100 | 8 × 12.5 × 1.0 |
| 100 × 1.6 | 100 | 8 × 12.5 × 1.0 |

### Coating

The Thrombin solution was applied onto the gelatine sponge by use of a coating line. The setting of different parameters of the coating line depends on the size of the gelatine sponge. Examples of settings of the coating line for different sizes of gelatine sponges are given herein below.

The following settings were used for the coating line.

| Parameter/Function | Setpoint | |
|---|---|---|
| Velocity of transport mechanism | 10 steps in range | |
| | 6.5-8.5 m/min | |
| Flow rate 1 | 5.37 | ml/min |
| Flow rate 2 | 5.37 | ml/min |
| Jet force, left | 25 | l/min |
| Jet force, right | 25 | l/min |
| Nozzle power (left) | 2 | W |
| Nozzle power (right) | 2 | W |
| Distance from belt to nozzle centre | 45 | mm |
| Distance between centre of nozzles | 41.5 | mm |
| Horizontal alignment of nozzles | 0° | |
| Distance from product guide to centre of | 19.5 | mm |
| Nozzle 2 during the first part of a coating | | |
| sequence | | |
| Distance from product guide to centre of | 40.5 | mm |
| Nozzle 2 during the first part of a coating | | |
| sequence | | |

The following settings were used for the coating line (entered prior to production start) for a gelatine sponge with the size 50×1.

| Parameter/Function | Setpoint | |
|---|---|---|
| Velocity of transport mechanism | 7.5 | m/min |
| Flow rate 1 | 5.37 | ml/min |
| Flow rate 2 | 5.37 | ml/min |
| Jet force, left | 25 | l/min |
| Jet force, right | 25 | l/min |
| Nozzle power (left) | 2 | W |
| Nozzle power (right) | 2 | W |
| Distance from belt to nozzle centre | 45 | mm |
| Distance between centre of nozzles | 41.5 | mm |
| Horizontal alignment of nozzles | 0° | |
| Distance from product guide to centre of | 19.5 | mm |
| Nozzle 2 during the first part of a coating | | |
| sequence | | |
| Distance from product guide to centre of | 40.5 | mm |
| Nozzle 2 during the first part of a coating | | |
| sequence | | |

The following settings were used for the coating line (entered prior to production start) for a gelatine sponge with the size 50×1.3.

| Parameter/Function | Setpoint | |
|---|---|---|
| Velocity of transport mechanism | 6.82 | m/min |
| Flow rate 1 | 5.37 | ml/min |
| Flow rate 2 | 5.37 | ml/min |
| Jet force, left | 25 | l/min |
| Jet force, right | 25 | l/min |
| Nozzle power (left) | 2 | W |
| Nozzle power (right) | 2 | W |
| Distance from belt to nozzle centre | 45 | mm |
| Distance between centre of nozzles | 41.5 | mm |
| Horizontal alignment of nozzles | 0° | |
| Distance from product guide to centre of | 19.5 | mm |
| Nozzle 2 during the first part of a coating | | |
| sequence | | |
| Distance from product guide to centre of | 40.5 | mm |
| Nozzle 2 during the first part of a coating | | |
| sequence | | |

The following settings were used for the coating line (entered prior to production start) for a gelatine sponge with the size 50×1.6.

| Parameter/Function | Setpoint | |
|---|---|---|
| Velocity of transport mechanism | 4.69 | m/min |
| Flow rate 1 | 5.37 | ml/min |
| Flow rate 2 | 5.37 | ml/min |
| Jet force, left | 25 | l/min |
| Jet force, right | 25 | l/min |
| Nozzle power (left) | 2 | W |
| Nozzle power (right) | 2 | W |
| Distance from belt to nozzle centre | 45 | mm |
| Distance between centre of nozzles | 41.5 | mm |
| Horizontal alignment of nozzles | 0° | |
| Distance from product guide to centre of | 19.5 | mm |
| Nozzle 2 during the first part of a coating | | |
| sequence | | |
| Distance from product guide to centre of | 40.5 | mm |
| Nozzle 2 during the first part of a coating | | |
| sequence | | |

The following settings were used for the coating line (entered prior to production start) for a gelatine sponge with the size 12-7×1.

| Parameter/Function | Setpoint | |
|---|---|---|
| Velocity of transport mechanism | 7.5 | m/min |
| Flow rate 1 | 5.37 | ml/min |
| Flow rate 2 | 5.37 | ml/min |
| Jet force, left | 25 | l/min |
| Jet force, right | 25 | l/min |
| Nozzle power (left) | 2 | W |
| Nozzle power (right) | 2 | W |
| Distance from belt to nozzle centre | 45 | mm |
| Distance between centre of nozzles | 41.5 | mm |
| Horizontal alignment of nozzles | 0° | |
| Distance from product guide to centre of | 19.5 | mm |
| Nozzle 2 during the first part of a coating | | |
| sequence | | |
| Distance from product guide to centre of | 40.5 | mm |
| Nozzle 2 during the first part of a coating | | |
| sequence | | |

The following settings were used for the coating line (entered prior to production start) for a gelatine sponge with the size 12-7×1.3.

| Parameter/Function | Setpoint | |
|---|---|---|
| Velocity of transport mechanism | 5.77 | m/min |
| Flow rate 1 | 5.37 | ml/min |
| Flow rate 2 | 5.37 | ml/min |
| Jet force, left | 25 | l/min |
| Jet force, right | 25 | l/min |
| Nozzle power (left) | 2 | W |
| Nozzle power (right) | 2 | W |
| Distance from belt to nozzle centre | 45 | mm |
| Distance between centre of nozzles | 41.5 | mm |
| Horizontal alignment of nozzles | 0° | |
| Distance from product guide to centre of | 19.5 | mm |
| Nozzle 2 during the first part of a coating | | |
| sequence | | |
| Distance from product guide to centre of | 40.5 | mm |
| Nozzle 2 during the first part of a coating | | |
| sequence | | |

The following settings were used for the coating line (entered prior to production start) for a gelatine sponge with the size 12-7×1.6.

| Parameter/Function | Setpoint | |
|---|---|---|
| Velocity of transport mechanism | 4.69 | m/min |
| Flow rate 1 | 5.37 | ml/min |
| Flow rate 2 | 5.37 | ml/min |
| Jet force, left | 25 | l/min |
| Jet force, right | 25 | l/min |
| Nozzle power (left) | 2 | W |
| Nozzle power (right) | 2 | W |
| Distance from belt to nozzle centre | 45 | mm |
| Distance between centre of nozzles | 41.5 | mm |
| Horizontal alignment of nozzles | 0° | |
| Distance from product guide to centre of | 19.5 | mm |
| Nozzle 2 during the first part of a coating | | |
| sequence | | |
| Distance from product guide to centre of | 40.5 | mm |
| Nozzle 2 during the first part of a coating | | |
| sequence | | |

### Drying

After the Thrombin solution has been applied onto the gelatine sponge, the gelatine sponge is dried during a drying step. The drying time of the drying step depends on the size of the gelatine sponge. The drying temperature and drying time for gelatine sponges with different sizes are given herein below.

The following settings were used for the drying line (entered prior to production start) for a gelatine sponge with the size 12-7×1.

| No. | Parameter/Function | Setpoint |
|---|---|---|
| 1 | Oven temperature | 45° C. |
| 2 | Drying time for the first production line | 5 min. 30 sec. |
| 3 | Drying time for the second production | 5 min. 30 sec. |
| | line | |

The following settings were used for the drying line (entered prior to production start) for a gelatine sponge with the size 12-7×1.3.

| | | |
|---|---|---|
| No. | Parameter/Function | Setpoint |

| | | | |
|---|---|---|---|
| 1 | Oven temperature | 45° | C. |
| 2 | Drying time for the first production line | 6 | min. |
| 3 | Drying time for the second production | 6 | min. |
| | line | | |

The following were registered for the drying line after end of the production for a gelatine sponge with the size 12-7×1.6.

| | | |
|---|---|---|
| No. | Parameter/Function | Setpoint |

| | | | |
|---|---|---|---|
| 1 | Oven temperature | 45° | C. |
| 2 | Drying time for the first production line | 8 | min. |
| 3 | Drying time for the second production | 8 | min. |
| | line | | |

The following settings were used for the drying line (entered prior to production start) for a gelatine sponge with the size 50×1.

| | | |
|---|---|---|
| No. | Parameter/Function | Setpoint |

| | | | |
|---|---|---|---|
| 1 | Oven temperature | 45° | C. |
| 2 | Drying time for the first production line | 7 | min. |
| 3 | Drying time for the second production | 7 | min. |
| | line | | |

The following were registered for the drying line after end of the production for a gelatine sponge with the size 50×1.1.

| No. | Parameter/Function | Setpoint |
|---|---|---|
| 1 | Oven temperature | 45° C. |
| 2 | Drying time for the first production line | 7 min. 30 sec |
| 3 | Drying time for the second production | 7 min. 30 sec |
| | line | |

The following settings were used for the drying line (entered prior to production start) for a gelatine sponge with the size 50×1.6.

| No. | Parameter/Function | Setpoint |
|---|---|---|
| 1 | Oven temperature | 45° C. |
| 2 | Drying time for the first production line | 10 min. 30 sec. |
| 3 | Drying time for the second production | 10 min. 30 sec. |
| | line | |

The following settings were used for the drying line (entered prior to production start) for a gelatine sponge with the size 100×1.

| | | |
|---|---|---|
| No. | Parameter/Function | Setpoint |

| | | | |
|---|---|---|---|
| 1 | Oven temperature | 45° | C. |
| 2 | Drying time for the first production line | 7 | min. |
| 3 | Drying time for the second production | 7 | min. |
| | line | | |

The following were registered for the drying line after end of the production for a gelatine sponge with the size 100×1.1.

| No. | Parameter/Function | Setpoint |
|---|---|---|
| 1 | Oven temperature | 45° C. |
| 2 | Drying time for the first production line | 7 min. 30 sec |
| 3 | Drying time for the second production | 7 min. 30 sec |
| | line | |

The following settings were used for the drying line (entered prior to production start) for a gelatine sponge with the size 100×1.6.

| No. | Parameter/Function | Setpoint |
|---|---|---|
| 1 | Oven temperature | 45° C. |
| 2 | Drying time for the first production line | 10 min. 30 sec. |
| 3 | Drying time for the second production | 10 min. 30 sec. |
| | line | |

1. A method for coating of a matrix or the surface of a matrix with a pharmaceutical composition comprising one or more bioactive agents, said method comprising use of ultrasonic spray technology.

2. The method of any of the preceding claims, wherein said matrix or matrices comprise one or more polymers.

3. The method of claim 2, wherein the polymers are selected from collagen and gelatin.

4. The method of any of the preceding claims, wherein the pharmaceutical composition comprises one or more bioactive agent(s).

5. The method of any of the preceding claims, wherein the pharmaceutical composition comprises one or more bioactive agent(s) that stimulates hemostasis.

6. The method of any of the preceding claims, wherein the pharmaceutical composition comprises one or more bioactive agent(s) that stimulates wound healing.

7. The method of any of the preceding claims, wherein the pharmaceutical composition comprises one or more bioactive agent(s) selected from the group consisting of endothelium Tissue Factor (TF), Factor VII, TF-Factor VIIa, Factor IX, Factor X, thrombin, activated Factor II (Factor IIa), Factor XIa, plasmin, Factor XII, Factor Xa, TFPI, Factor Va, prothrombinase complex, prothrombin, Factor V, Factor XI, Factor VIII, vWF, Factor VIIIa, Factor IXa and the tenase complex.

8. The method of any of the preceding claims, wherein the pharmaceutical composition comprises one or more bioactive agent(s) which comprises thrombin.

9. The method of any of the preceding claims, wherein the pharmaceutical composition comprises one or more bioactive agent(s) which comprises fibrinogen.

10. The method of any of the preceding claims, wherein said pharmaceutical composition contains compounds selected from the group consisting of thrombin, calcium, albumin, mannitol, and acetate.

11. The method of any of the claims 7 to 10, wherein the concentration of thrombin in said pharmaceutical composition can be selected from group of intervals consisting of from 2000 IU/ml to 3000 IU/ml, from 3000 IU/ml to 4000 IU/ml, from 4000 IU/ml to 5000 IU/ml, from 5000 IU/ml to 6000 IU/ml, from 6000 IU/ml to 7000 IU/ml, from 7000 IU/ml to 8000 IU/ml, from 8000 IU/ml to 9000 IU/ml, from 9000 IU/ml to 10000 IU/ml, from 10000 IU/ml to 11000 IU/ml, from 11000 IU/ml to 12000 IU/ml, from 12000 IU/ml to 13000 IU/ml, from 13000 IU/ml to 14000 IU/ml, from 14000 IU/ml to 15000 IU/ml, from 15000 IU/ml to 16000 IU/ml, from 16000 IU/ml to 17000 IU/ml, from 17000 IU/ml to 18000 IU/ml, from 18000 IU/ml to 19000 IU/ml, from 19000 IU/ml to 20000 IU/ml, from 20000 IU/ml to 21000 IU/ml, from 21000 IU/ml to 22000 IU/ml, from 22000 IU/ml to 23000 IU/ml, from 23000 IU/ml to 24000 IU/ml, and from 24000 IU/ml to 25000 IU/ml or any combination of these intervals.

12. The method of any of the preceding claims, wherein the matrices/sponges to be spray coated are
a. Loaded onto a transport mechanism
b. Transported to the spray chamber
c. Spray coated
d. Transported to the spray chamber to the a drying area
e. Dried
f. Subjected to brief cooling
g. Transported to an area for packaging
h. Packaged

13. The method of any of the preceding claims, wherein the ultrasonic spray technology employed comprises
a. A system for supplying the pharmaceutical composition(s) which is to be spray coated onto the matrices
b. One or more spray nozzle assemblies for atomizing the supplied pharmaceutical composition and directing the atomized pharmaceutical composition towards the matrices

14. The method of any of the preceding claims, wherein the density and thickness of coating on the matrices is regulated by regulating the speed of the transport mechanism, thus regulating the time during which the surface of the matrices to be coated are exposed to spray mist.

15. The method of claim 13, wherein the one or more spray nozzles in one spray nozzle assembly generate overlapping spray beams which together produce a spray mist.

16. The method of claim 15, wherein the width—as measured at the level of the transport mechanism—of the spray mist generated during operation of the ultrasonic spray nozzles in one nozzle assembly can be selected from the group of intervals consisting of from 1.0 cm to 1.2 cm, from 1.2 cm to 1.4 cm, from 1.4 cm to 1.6 cm, from 1.6 cm to 1.8 cm, from 1.8 cm to 2.0 cm, 2.0 cm to 2.2 cm, from 2.2 cm to 2.4 cm, from 2.4 cm to 2.6 cm, from 2.6 cm to 2.8 cm, from 2.8 cm to 3.0 cm, 3.0 cm to 3.2 cm, from 3.2 cm to 3.4 cm, from 3.4 cm to 3.6 cm, from 3.6 cm to 3.8 cm, from 3.8 cm to 4.0 cm, 4.0 cm to 4.2 cm, from 4.2 cm to 4.4 cm, from 4.4 cm to 4.6 cm, from 4.6 cm to 4.8 cm, from 4.8 cm to 5.0 cm, 5.0 cm to 5.2 cm, from 5.2 cm to 5.4 cm, from 5.4 cm to 5.6 cm, from 5.6 cm to 5.8 cm, from 5.8 cm to 6.0 cm, 6.0 cm to 6.2 cm, from 6.2 cm to 6.4 cm, from 6.4 cm to 6.6 cm, from 6.6 cm to 6.8 cm, from 6.8 cm to 7.0 cm, 7.0 cm to 7.2 cm, from 7.2 cm to 7.4 cm, from 7.4 cm to 7.6 cm, from 7.6 cm to 7.8 cm, from 7.8 cm to 8.0 cm, 8.0 cm to 8.2 cm, from 8.2 cm to 8.4 cm, from 8.4 cm to 8.6 cm, from 8.6 cm to 8.8 cm, from 8.8 cm to 9.0 cm, 9.0 cm to 9.2 cm, from 9.2 cm to 9.4 cm, from 9.4 cm to 9.6 cm, from 9.6 cm to 9.8 cm, from 9.8 cm to 10.0 cm, 10.0 cm to 10.2 cm, from 10.2 cm to 10.4 cm, from 10.4 cm to 10.6 cm, from 10.6 cm to 10.8 cm, from 10.8 cm to 11.0 cm, 11.0 cm to 11.2 cm, from 11.2 cm to 11.4 cm, from 11.4 cm to 11.6 cm, from 11.6 cm to 11.8 cm, from 11.8 cm to 12.0 cm, 12.0 cm to 12.2 cm, from 12.2 cm to 12.4 cm, from 12.4 cm to 12.6 cm, from 12.6 cm to 12.8 cm, from 12.8 cm to 13.0 cm, 13.0 cm to 13.2 cm, from 13.2 cm to 13.4 cm, from 13.4 cm to 13.6 cm, from 13.6 cm to 13.8 cm, from 13.8 cm to 14.0 cm, 14.0 cm to 14.2 cm, from 14.2 cm to 14.4 cm, from 14.4 cm to 14.6 cm, from 14.6 cm to 14.8 cm, from 14.8 cm to 15.0 cm, 15.0 cm to 15.2 cm, from 15.2 cm to 15.4 cm, from 15.4 cm to 15.6 cm, from 15.6 cm to 15.8 cm, from 15.8 cm to 16.0 cm, 16.0 cm to 16.2 cm, from 16.2 cm to 16.4 cm, from 16.4 cm to 16.6 cm, from 16.6 cm to 16.8 cm, from 16.8 cm to 17.0 cm, 17.0 cm to 17.2 cm, from 17.2 cm to 17.4 cm, from 17.4 cm to 17.6 cm, from 17.6 cm to 17.8 cm, from 17.8 cm to 18.0 cm, 18.0 cm to 18.2 cm, from 18.2 cm to 18.4 cm, from 18.4 cm to 18.6 cm, from 18.6 cm to 18.8 cm, from 18.8 cm to 19.0 cm, 19.0 cm to 19.2 cm, from 19.2 cm to 19.4 cm, from 19.4 cm to 19.6 cm, from 19.6 cm to 19.8 cm, from 19.8 cm to 20.0 cm, from 20.0 cm to 20.2 cm, from 20.2 cm to 20.4 cm, from 20.4 cm to 20.6 cm, from 20.6 cm to 20.8 cm, from 20.8 cm to 21.0 cm, from 21.0 cm to 21.2 cm, from 21.2 cm to 21.4 cm, from 21.4 cm to 21.6 cm, from 21.6 cm to 21.8 cm, from 21.8 cm to 22.0 cm, from 22.0 cm to 22.2 cm, from 22.2 cm to 22.4 cm, from 22.4 cm to 22.6 cm, from 22.6 cm to 22.8 cm, from 22.8 cm to 23.0 cm, from 23.0 cm to 23.2 cm, from 23.2 cm to 23.4 cm, from 23.4 cm to 23.6 cm, from 23.6 cm to 23.8 cm, from 23.8 cm to 24.0 cm, from 24.0 cm to 24.2 cm, from 24.2 cm to 24.4 cm, from 24.4 cm to 24.6 cm, from 24.6 cm to 24.8 cm, from 24.8 cm to 25.0 cm, from 25.0 cm to 25.2 cm, from 25.2 cm to 25.4 cm, from 25.4 cm to 25.6 cm, from 25.6 cm to 25.8 cm, from 25.8 cm to 26.0 cm, from 26.0 cm to 26.2 cm, from 26.2 cm to 26.4 cm, from 26.4 cm to 26.6 cm, from 26.6 cm to 26.8 cm, from 26.8 cm to 27.0 cm, from 27.0 cm to 27.2 cm, from 27.2 cm to 27.4 cm, from 27.4 cm to 27.6 cm, from 27.6 cm to 27.8 cm, from 27.8 cm to 28.0 cm, from 28.0 cm to 28.2 cm, from 28.2 cm to 28.4 cm, from 28.4 cm to 28.6 cm, from 28.6 cm to 28.8 cm, from 28.8 cm to 29.0 cm, from 29.0 cm to 29.2 cm, from 29.2 cm to 29.4 cm, from 29.4 cm to 29.6 cm, from 29.6 cm to 29.8 cm, from 29.8 cm to 30.0 cm, from 30.0 cm to 30.2 cm, from 30.2 cm to 30.4 cm, from 30.4 cm to 30.6 cm, from 30.6 cm to 30.8 cm, from 30.8 cm to 31.0 cm, from 31.0 cm to 31.2 cm, from 31.2 cm to 31.4 cm, from 31.4 cm to 31.6 cm, from 31.6 cm to 31.8 cm, from 31.8 cm to 32.0 cm, from 32.0 cm to 32.2 cm, from 32.2 cm to 32.4 cm, from 32.4 cm to 32.6 cm, from 32.6 cm to 32.8 cm, from 32.8 cm to 33.0 cm, from 33.0 cm to 33.2 cm, from 33.2 cm to 33.4 cm, from 33.4 cm to 33.6 cm, from 33.6 cm to 33.8 cm, from 33.8 cm to 34.0 cm, from 34.0 cm to 34.2 cm, from 34.2 cm to 34.4 cm, from 34.4 cm to 34.6 cm, from 34.6 cm to 34.8 cm, from 34.8 cm to 35.0 cm, from 35.0 cm to 35.2 cm, from 35.2 cm to 35.4 cm, from 35.4 cm to 35.6 cm, from 35.6 cm to 35.8 cm, from 35.8 cm to 36.0 cm, from 36.0 cm to 36.2 cm, from 36.2 cm to 36.4 cm, from 36.4 cm to 36.6 cm, from 36.6 cm to 36.8 cm, from 36.8 cm to 37.0 cm, from 37.0 cm to 37.2 cm, from 37.2 cm to 37.4 cm, from 37.4 cm to 37.6 cm, from 37.6 cm to 37.8 cm, from 37.8 cm to 38.0 cm, from 38.0 cm to 38.2 cm, from 38.2 cm to 38.4 cm, from 38.4 cm to 38.6 cm, from 38.6 cm to 38.8 cm, from 38.8 cm to 39.0 cm, from 39.0 cm to 39.2 cm, from 39.2 cm to 39.4 cm, from 39.4 cm to 39.6 cm, from 39.6 cm to 39.8 cm, from 39.8 cm to 40.0 cm, from 40 cm to 45 cm, and from 45 cm to 50 cm, or any combination thereof.

17. The method of any of claims 13 to 16, wherein the distance between the surface of the matrix material and the ultrasonic spray nozzle(s) is in the range of 10.0 to 100.0 mm; for example 10.0-11.00 mm, such as 11.0-12.0 mm, for example 12.0-13.0 mm, such as 13.0-14.0 mm, for example 14.0-15.0 mm, such as 15.0-16.0 mm, for example 16.0-17.0 mm, such as 17.0-18.0 mm, for example 18.0-19.0 mm, such as 19.0-20.0 mm, for example 20.0-21.00 mm, such as 21.0-22.0 mm, for example 22.0-23.0 mm, such as 23.0-24.0 mm, for example 24.0-25.0 mm, such as 25.0-26.0 mm, for example 26.0-27.0 mm, such as 27.0-28.0 mm, for example 28.0-29.0 mm, such as 29.0-30.0 mm, for example 30.0-31.00 mm, such as 31.0-32.0 mm, for example 32.0-33.0 mm, such as 33.0-34.0 mm, for example 34.0-35.0 mm, such as 35.0-36.0 mm, for example 36.0-37.0 mm, such as 37.0-38.0 mm, for example 38.0-39.0 mm, such as 39.0-40.0 mm, for example 40.0-41.00 mm, such as 41.0-42.0 mm, for example 42.0-43.0 mm, such as 43.0-44.0 mm, for example 44.0-45.0 mm, such as 45.0-46.0 mm, for example 46.0-47.0 mm, such as 47.0-48.0 mm, for example 48.0-49.0 mm, such as 49.0-50.0 mm, for example 50.0-51.00 mm, such as 51.0-52.0 mm, for example 52.0-53.0 mm, such as 53.0-54.0 mm, for example 54.0-55.0 mm, such as 55.0-56.0 mm, for example 56.0-57.0 mm, such as 57.0-58.0 mm, for example 58.0-59.0 mm, such as 59.0-60.0 mm, for example 60.0-61.00 mm, such as 61.0-62.0 mm, for example 62.0-63.0 mm, such as 63.0-64.0 mm, for example 64.0-65.0 mm, such as 65.0-66.0 mm, for example 66.0-67.0 mm, such as 67.0-68.0 mm, for example 68.0-69.0 mm, such as 69.0-70.0 mm, for example 70.0-71.00 mm, such as 71.0-72.0 mm, for example 72.0-73.0 mm, such as 73.0-74.0 mm, for example 74.0-75.0 mm, such as 75.0-76.0 mm, for example 76.0-77.0 mm, such as 77.0-78.0 mm, for example 78.0-79.0 mm, such as 79.0-80.0 mm, for example 80.0-81.00 mm, such as 81.0-82.0 mm, for example 82.0-83.0 mm, such as 83.0-84.0 mm, for example 84.0-85.0 mm, such as 85.0-86.0 mm, for example 86.0-87.0 mm, such as 87.0-88.0 mm, for example 88.0-89.0 mm, such as 89.0-90.0 mm, for example 90.0-91.00 mm, such as 91.0-92.0 mm, for example 92.0-93.0 mm, such as 93.0-94.0 mm, for example 94.0-95.0 mm, such as 95.0-96.0 mm, for example 96.0-97.0 mm, such as 97.0-98.0 mm, for example 98.0-99.0 mm, such as 99.0-100.0 mm.

18. The method of any of the preceding claims, wherein at least 90% of the input bioactive agent is found on the matrix/sponge after ultrasonic spraying and drying of said matrix/sponge such as at least 91%, at least 92%, at least 93%, at least 94%, at least 95%, at least 96%, at least 97%, at least 98%, or at least 99%.

19. The method of any of the preceding claims, wherein the resulting activity on the coated surface of the matrices/sponges as measured immediately after drying and subsequent cooling to ambient temperature can be selected from the group of intervals consisting of from 5 IU/cm² to 6 IU/cm², from 6 IU/cm² to 7 IU/cm², from 7 IU/cm² to 8 IU/cm², from 8 IU/cm² to 9 IU/cm², from 9 IU/cm² to 10 IU/cm², 10 IU/cm² to 12 IU/cm², from 12 IU/cm² to 14 IU/cm², from 14 IU/cm² to 16 IU/cm², from 16 IU/cm² to 18 IU/cm², from 18 IU/cm² to 20 IU/cm², 20 IU/cm² to 22 IU/cm², from 22 IU/cm² to 24 IU/cm², from 24 IU/cm² to 26 IU/cm², from 26 IU/cm² to 28 IU/cm², from 28 IU/cm² to 30 IU/cm², from 30 IU/cm² to 32 IU/cm², from 32 IU/cm² to 34 IU/cm², from 34 IU/cm² to 36 IU/cm², from 36 IU/cm² to 38 IU/cm², from 38 IU/cm² to 40 IU/cm², from 40 IU/cm² to 42 IU/cm², from 42 IU/cm² to 44 IU/cm², from 44 IU/cm² to 46 IU/cm², from 46 IU/cm² to 48 IU/cm², from 48 IU/cm² to 50 IU/cm², from 50 IU/cm² to 52 IU/cm², from 52 IU/cm² to 54 IU/cm², from 54 IU/cm² to 56 IU/cm², from 56 IU/cm² to 58 IU/cm², from 58 IU/cm² to 60 IU/cm², from 60 IU/cm² to 62 IU/cm², from 62 IU/cm² to 64 IU/cm², from 64 IU/cm² to 66 IU/cm², from 66 IU/cm² to 68 IU/cm², from 68 IU/cm² to 70 IU/cm², from 70 IU/cm² to 72 IU/cm², from 72 IU/cm² to 74 IU/cm², from 74 IU/cm² to 76 IU/cm², from 76 IU/cm² to 78 IU/cm², from 32 IU/cm² to 34 IU/cm², from 34 IU/cm² to 36 IU/cm², from 36 IU/cm² to 38 IU/cm², from 38, from 78 IU/cm² to 80 IU/cm², from 80 IU/cm² to 82 IU/cm², from 82 IU/cm² to 84 IU/cm², from 84 IU/cm² to 86 IU/cm², from 86 IU/cm² to 88 IU/cm², from 88 IU/cm² to 90 IU/cm², from 92 IU/cm² to 54 IU/cm², from 54 IU/cm² to 56 IU/cm², from 56 IU/cm² to 58 IU/cm², from 98 IU/cm² to 100 IU/cm², or any combination thereof.

20. The method of any of the preceding claims, wherein the resulting activity on the coated surface of the sponges/matrices as measured after 2 years of storage at ambient temperature can be selected from the group of intervals consisting of from 5 IU/cm² to 6 IU/cm², from 6 IU/cm² to 7 IU/cm², from 7 IU/cm² to 8 IU/cm², from 8 IU/cm² to 9 IU/cm², from 9 IU/cm² to 10 IU/cm², 10 IU/cm² to 12 IU/cm², from 12 IU/cm² to 14 IU/cm², from 14 IU/cm² to 16 IU/cm², from 16 IU/cm² to 18 IU/cm², from 18 IU/cm² to 20 IU/cm², 20 IU/cm² to 22 IU/cm², from 22 IU/cm² to 24 IU/cm², from 24 IU/cm² to 26 IU/cm², from 26 IU/cm² to 28 IU/cm², from 28 IU/cm² to 30 IU/cm², from 30 IU/cm² to 32 IU/cm², from 32 IU/cm² to 34 IU/cm², from 34 IU/cm² to 36 IU/cm², from 36 IU/cm² to 38 IU/cm², from 38 IU/cm² to 40 IU/cm², from 40 IU/cm² to 42 IU/cm², from 42 IU/cm² to 44 IU/cm², from 44 IU/cm² to 46 IU/cm², from 46 IU/cm² to 48 IU/cm², from 48 IU/cm² to 50 IU/cm², from 50 IU/cm² to 52 IU/cm², from 52 IU/cm² to 54 IU/cm², from 54 IU/cm² to 56 IU/cm², from 56 IU/cm² to 58 IU/cm², from 58 IU/cm² to 60 IU/cm², from 60 IU/cm² to 62 IU/cm², from 62 IU/cm² to 64 IU/cm², from 64 IU/cm² to 66 IU/cm², from 66 IU/cm² to 68 IU/cm², from 68 IU/cm² to 70 IU/cm², from 70 IU/cm² to 72 IU/cm², from 72 IU/cm² to 74 IU/cm², from 74 IU/cm² to 76 IU/cm², from 76 IU/cm² to 78 IU/cm², from 32 IU/cm² to 34 IU/cm², from 34 IU/cm² to 36 IU/cm², from 36 IU/cm² to 38 IU/cm², from 38, from 78 IU/cm² to 80 IU/cm², from 80 IU/cm² to 82 IU/cm², from 82 IU/cm² to 84 IU/cm², from 84 IU/cm2 to 86 IU/cm2, from 86 IU/cm2 to 88 IU/cm2, from 88 IU/cm2 to 90 IU/cm2, from 92 IU/cm2 to 54 IU/cm2, from 54 IU/cm2 to 56 IU/cm2, from 56 IU/cm2 to 58 IU/cm2, from 98 IU/cm2 to 100 IU/cm2, or any combination thereof.

21. The method of any of the preceding claims, wherein the matrices/sponges are coated sequentially with two different pharmaceutical compositions using the described ultrasonic spray technique with an oven-based drying procedure following each spray coating procedure.

22. The method of any of the preceding claims, wherein the matrices/sponges are coated sequentially with two different pharmaceutical compositions using the described ultrasonic spray technique without an oven-based drying procedure following each spray coating procedure.

23. The method of any of claims 13 to 22, wherein the one or more nozzle assemblies comprise two nozzles and wherein the ultrasonic spray method comprises two sequential rounds of application of a composition onto a matrix/sponge by ultrasonic spray technology.

24. The method of any of the preceding claims, wherein more than one round of application by ultrasonic spray technology is used, such as 2, for example 3, such as 4, for example 5, such as 6, for example 7, such as 8, for example 9, such as 10 sequential application rounds is used to apply a composition onto the surface of a matrix material.

25. The method of any of the preceding claims, wherein more than 10 sequential application rounds are used to apply a composition onto the surface of a matrix material.

26. The method of any of claims 13 to 25, wherein—prior to the next application round—the position of the one or more nozzles is shifted and/or the position of the matrix/sponge is shifted.

27. The method of any of claims 22 to 26, wherein the areas of the matrix material that are covered by the composition in different application rounds overlap less than 50%, for example less than 40%, such as less than 30%, for example less than 20%, such as less than 10%, for example less than 5%, such as less than 1%.

28. The method of any of claims 13 to 27, wherein the nozzle assembly comprises more than 1 nozzle such as 2 nozzles, for example 3 nozzles, such as 4 nozzles, for example 5 nozzles, such as 6 nozzles, for example 7 nozzles, such as 8 nozzles, for example 9 nozzles, such as 10 nozzles.

29. The method of any of claims 13 to 28, wherein the nozzle assembly comprises more than 10 nozzles.

30. The method of any of claims 13 to 29, wherein the distance between the nozzle centres of the two or more individual ultrasonic spray nozzles of the one or more nozzle assemblies is in the range of 1.0 to 100.0 mm; such as 1.0-1.5 mm, for example 1.5-2.0 mm, such as 2.0-2.5 mm, for example 2.5-3.0 mm, such as 3.0-3.5 mm, for example 3.5-4.0 mm, such as 4.0-4.5 mm, for example 4.5-5.0 mm, such as 5.0-6.0 mm, for example 6.0-7.0 mm, such as 7.0-8.0 mm, for example 8.0-9.0 mm, such as 9.0-10.0 mm, for example 10.0-11.00 mm, such as 11.0-12.0 mm, for example 12.0-13.0 mm, such as 13.0-14.0 mm, for example 14.0-15.0 mm, such as 15.0-16.0 mm, for example 16.0-17.0 mm, such as 17.0-18.0 mm, for example 18.0-19.0 mm, such as 19.0-20.0 mm, for example 20.0-21.00 mm, such as 21.0-22.0 mm, for example 22.0-23.0 mm, such as 23.0-24.0 mm, for example 24.0-25.0 mm, such as 25.0-26.0 mm, for example 26.0-27.0 mm, such as 27.0-28.0 mm, for example 28.0-29.0 mm, such as 29.0-30.0 mm, for example 30.0-31.00 mm, such as 31.0-32.0 mm, for example 32.0-33.0 mm, such as 33.0-34.0 mm, for example 34.0-35.0 mm, such as 35.0-36.0 mm, for example 36.0-37.0 mm, such as 37.0-38.0 mm, for example 38.0-39.0 mm, such as 39.0-40.0 mm, for example 40.0-41.00 mm, such as 41.0-42.0 mm, for example 42.0-43.0 mm, such as 43.0-44.0 mm, for example 44.0-45.0 mm, such as 45.0-46.0 mm, for example 46.0-47.0 mm, such as 47.0-48.0 mm, for example 48.0-49.0 mm, such as 49.0-50.0 mm, for example 50.0-51.00 mm, such as 51.0-52.0 mm, for example 52.0-53.0 mm, such as 53.0-54.0 mm, for example 54.0-55.0 mm, such as 55.0-56.0 mm, for example 56.0-57.0 mm, such as 57.0-58.0 mm, for example 58.0-59.0 mm, such as 59.0-60.0 mm, for example 60.0-61.00 mm, such as 61.0-62.0 mm, for example 62.0-63.0 mm, such as 63.0-64.0 mm, for example 64.0-65.0 mm, such as 65.0-66.0 mm, for example 66.0-67.0 mm, such as 67.0-68.0 mm, for example 68.0-69.0 mm, such as 69.0-70.0 mm, for example 70.0-71.00 mm, such as 71.0-72.0 mm, for example 72.0-73.0 mm, such as 73.0-74.0 mm, for example 74.0-75.0 mm, such as 75.0-76.0 mm, for example 76.0-77.0 mm, such as 77.0-78.0 mm, for example 78.0-79.0 mm, such as 79.0-80.0 mm, for example 80.0-81.00 mm, such as 81.0-82.0 mm, for example 82.0-83.0 mm, such as 83.0-84.0 mm, for example 84.0-85.0 mm, such as 85.0-86.0 mm, for example 86.0-87.0 mm, such as 87.0-88.0 mm, for example 88.0-89.0 mm, such as 89.0-90.0 mm, for example 90.0-91.00 mm, such as 91.0-92.0 mm, for example 92.0-93.0 mm, such as 93.0-94.0 mm, for example 94.0-95.0 mm, such as 95.0-96.0 mm, for example 96.0-97.0 mm, such as 97.0-98.0 mm, for example 98.0-99.0 mm, such as 99.0-100.0 mm.

31. The method of any of the preceding claims, wherein the spillage/waste is less than 10% of the composition, such as less than 5%, for example less than 4%, such as less than 3%, for example less than 2%, such as less than 1%, for example less than 0.5% or such as less than 0.1%.

32. A device coated by the method according to any of the claims 1-31.

33. A kit of parts comprising the device according to claim 32 and at least one additional component.

34. A method for making the device according to claim 32 comprising the steps of
a. providing a matrix material, and
b. applying a pharmaceutical composition onto the surface of said matrix material by ultrasonic spray technology

35. Use of the device according to claim 32 to promote wound healing in an individual in need thereof.

36. Use of the device according to claim 32 to promote hemostasis in an individual in need thereof.
